(19) United States
(12) Patent Application Publication
(10) Pub. No.: US 2024/0095315 A1
(43) Pub. Date: Mar. 21, 2024

(54) LICENSE MANAGEMENT FOR SOFTWARE DEFINED SILICON

(71) Applicant: Intel Corporation, Santa Clara, CA (US)

(72) Inventors: Katalin Bartfai-Walcott, El Dorado Hills, CA (US); Mariusz Oriol, Gdynia (PL); Vasudevan Srinivasan, Portland, OR (US); Peggy Irelan, Chandler, AZ (US); Mariusz Stepka, Gdansk (PL); Kaitlin Murphy, Hillsboro, OR (US); Bharat Pillilli, El Dorado Hills, CA (US); Mark Baldwin, Hillsboro, OR (US); Mateusz Bronk, Gdansk (PL); Fariaz Karim, Gilbert, AZ (US); Arkadiusz Berent, Tuchom (PL); Vasuki Chilukuri, Hillsboro, OR (US)

(21) Appl. No.: 18/474,081

(22) Filed: Sep. 25, 2023

Related U.S. Application Data
(63) Continuation of application No. PCT/US2022/028632, filed on May 10, 2022.
(60) Provisional application No. 63/187,333, filed on May 11, 2021.

(51) Int. Cl. G06F 21/10; G06F 9/455

(52) U.S. Cl. CPC G06F 21/107; G06F 9/45558; G06F 2009/4557

(57) ABSTRACT

Methods, apparatus, systems and articles of manufacture (e.g., physical storage media) to implement license management solutions for software defined silicon (SDSi) products are disclosed. Example license management solutions disclosed herein include, but are not limited to, virtual resource migration using SDSi, resource configuration management using SDSi, hardware self-configuration using SDSi, reduced footprint agents using SDSi, performing SDSi usage evaluation and corresponding license transfer responsive to detected and/or predicted failures, transferring node locked SDSi licenses, transfer of SDSi licenses without a trusted license server, community license generation, expirable SDSi licenses via a reliable clock, non-node locked licenses via blockchain, and activating hardware features with a pre-generated hardware license.

### RELATED APPLICATION(S)

The patent claims the benefit of and priority to U.S. Provisional Application No. 63/187,333, which is titled “SOFTWARE DEFINED SILICON IMPLEMENTATION AND MANAGEMENT,” and which was filed on May 11, 2021. This patent is also related to U.S. Provisional Application No. 62/907,353, which is titled “SOFTWARE DEFINED SILICON IMPLEMENTATION AND MANAGEMENT,” and which was filed on Sep. 27, 2019, U.S. Provisional Application No. 62/937,032, which is titled “SOFTWARE DEFINED SILICON IMPLEMENTATION AND MANAGEMENT,” and which was filed on Nov. 18, 2019, U.S. Provisional Application No. 63/049,016, which is titled “SOFTWARE DEFINED SILICON IMPLEMENTATION AND MANAGEMENT,” and which was filed on Jul. 7, 2020, U.S. Provisional Application No. 63/049,017, which is titled “SYSTEMS, METHODS, AND APPARATUS FOR SOFTWARE DEFINED SILICON SECURITY,” and which was filed on Jul. 7, 2020, International Patent Application No. PCT/US20/52847, which is titled “SOFTWARE DEFINED SILICON IMPLEMENTATION AND MANAGEMENT,” and which was filed on Sep. 25, 2020, and International Patent Application No. PCT/US20/52848, which is titled “SYSTEMS, METHODS, AND APPARATUS FOR SOFTWARE DEFINED SILICON SECURITY,” and which was filed on Sep. 25, 2020, all of which are hereby incorporated by reference herein in their respective entireties.

### FIELD OF THE DISCLOSURE

This disclosure relates generally to semiconductor devices and, more particularly, to license management for software defined silicon products.

### BACKGROUND

In today's marketplace, semiconductor device manufacturers ship semiconductor devices, such as microprocessors, with hardware and firmware features fixed, or locked, at the factory. Even if additional, dormant hardware and/or firmware features are included in the shipped semiconductor devices, such dormant features are unable to be activated after the semiconductor devices leave the factory. To gain access to one or more of those dormant features, a customer would need to order, and a manufacturer would need to ship, new versions of the semiconductor devices that have the desired dormant feature(s) activated at the factory. To further complicate matters, the manufacturer may need to predefine and manage numerous different stock keeping units (SKUs) to track the various combinations of different features that are able to be activated on its semiconductor devices, even if some of those combinations are never realized.

### BRIEF DESCRIPTION OF THE DRAWINGS

FIG. 1 is a block diagram of an example system to implement and manage software defined silicon products in accordance with teachings of this disclosure.

FIG. 2 is a block diagram illustrating example implementations of an example software defined silicon agent, an example manufacturer enterprise system and an example customer enterprise system included in the example system of FIG. 1.

FIG. 3 illustrates an example software defined silicon management lifecycle implemented by the example systems of FIGS. 1 and/or 2.

FIG. 4 illustrates example certificates utilized in the example systems of FIGS. 1 and/or 2 to implement the example lifecycle of FIG. 4.

FIG. 5 illustrates an example process flow performed by the example systems of FIGS. 1 and/or 2 to enable initial feature activation in an example software defined silicon product.

FIG. 6 illustrates an example process flow performed by the example systems of FIGS. 1 and/or 2 to enable additional feature activation in an example software defined silicon product.

FIG. 7 illustrates an example process flow performed by the example systems of FIGS. 1 and/or 2 to enable feature deactivation in an example software defined silicon product.

FIG. 8 illustrates an example process flow performed by the example systems of FIGS. 1 and/or 2 to provide customer-initiated feature usage status and billing reconciliation.

FIG. 9 illustrates an example process flow performed by the example systems of FIGS. 1 and/or 2 to provide manufacturer-initiated feature usage status and billing reconciliation.

FIG. 10 is a block diagram of an example system to implement protection against misuse of software-defined silicon in accordance with teachings of this disclosure.

FIG. 11 illustrates a first example process flow performed by the example system of FIG. 10 to process entitlement requests.

FIG. 12 illustrates a second example process flow performed by the example system of FIG. 10 to process entitlement requests while setting a base state before a time of sale.

FIG. 13 illustrates a third example process flow performed by the example system of FIG. 10 to process entitlement requests using authentication keys.

FIG. 14 illustrates a fourth example process flow performed by the example system of FIG. 10 to process entitlement requests using completion certificates.

FIG. 15 is a block diagram of an example system to authorized delegated licensors to grant licenses on behalf of a manufacturer of a silicon structure in accordance with teachings of this disclosure.

FIG. 16 is a block diagram illustrating an example central licensor of an example manufacturer enterprise system that is delegate the ability to grant licenses to features of the silicon structure on behalf of the manufacturer.

FIG. 17 illustrates an authorized delegated licensor that can be given the ability to grant licenses on behalf of the central licensor of FIG. 16.

FIG. 18 illustrates an example system by which business rules can be hardcoded into the silicon structure.

FIG. 19 is a flowchart representative of example computer readable instructions that may be executed to implement the example manufacturer enterprise system of FIGS. 1 and/or 2.

FIG. 20 is a flowchart representative of example computer readable instructions that may be executed to implement the example customer enterprise system of FIGS. 1 and/or 2.

FIG. 21 is a flowchart representative of example computer readable instructions that may be executed to implement the example software defined silicon agent of FIGS. 1 and/or 2.

FIGS. 22A-22B are a flowchart representative of example computer readable instructions that may be executed to implement the example manufacturer enterprise system of FIG. 10.

FIG. 23 is a flowchart representative of example computer readable instructions that may be executed to implement the example SDSi asset agent of FIG. 10.

FIG. 24 is a flowchart representative of example computer readable instructions that may be executed to implement license reuse protection features of the example SDSi asset agent of FIG. 10.

FIG. 25 is a flowchart representative of example computer readable instructions that may be executed to implement license identification protection features of the example SDSi asset agent of FIG. 10.

FIG. 26 is a flowchart representative of example computer readable instructions that may be executed to implement license identification protection features of the example manufacturer enterprise system of FIG. 10.

FIG. 27 is flowchart representative of machine readable instructions which may be executed to implement an example license delegating authority of the example central licensor of FIG. 16.

FIG. 28 is a flowchart representative of machine readable instructions which may be executed to implement an example certificate handling feature of the example central licensor of FIG. 16.

FIG. 29 is a flowchart representative of machine readable instructions which may be executed to implement an example request for authorized delegated licensor status feature of the example authorized delegated licensor of FIG. 17.

FIG. 30 is a flowchart representative of machine readable instructions which may be executed to implement an example license granting feature of the example authorized delegated licensor of FIG. 17.

FIG. 31 is a flowchart representative of machine readable instructions which may be executed to implement an example business logic rules generating feature of the example central licensor of FIG. 16.

FIG. 32 is a flowchart representative of machine readable instructions which may be executed to implement an example business logic rules handling of the example hardware asset agent of FIG. 18.

FIG. 33 is a flowchart representative of machine readable instructions which may be executed to implement an example business logic rules handling feature of the example hardware asset of FIG. 18.

FIG. 34 is a flowchart representative of machine readable instructions which may be executed to implement an example compliance monitoring feature of the example hardware asset of FIG. 18.

FIG. 35 is a block diagram of an example processor platform structured to execute the example computer readable instructions of FIG. 19 to implement the example manufacturer enterprise system of FIGS. 1 and/or 2.

FIG. 36 is a block diagram of an example processor platform structured to execute the example computer readable instructions of FIG. 20 to implement the example customer enterprise system of FIGS. 1 and/or 2.

FIG. 37 is a block diagram of an example processor platform structured to execute the example computer readable instructions of FIG. 21 to implement the example software defined silicon agent of FIGS. 1 and/or 2.

FIG. 38 is a block diagram of an example processor platform structured to execute the example computer readable instructions of FIGS. 22A-22B and 26 to implement the example manufacturer enterprise system of FIG. 10.

FIG. 39 is a block diagram of an example processor platform structured to execute the example computer readable instructions of FIGS. 23-25 to implement the example SDSi asset agent of FIG. 10.

FIG. 40 is a block diagram of an example processor platform structured to execute the example computer readable instructions of FIG. 27 and FIG. 28 to implement the example central licensor of FIGS. 15, and 16.

FIG. 41 is a block diagram of an example processor platform structured to execute the example computer readable instructions of FIG. 29 and FIG. 30 to implement the example authorized delegated licensor of FIG. 3.

FIG. 42 is a block diagram of an example processor platform structured to execute the example computer readable instructions of FIG. 32 to implement the example hardware asset agent of FIG. 15 and FIG. 18.

FIG. 43 is a block diagram of an example processor platform structured to execute the example computer readable instructions of FIG. 33 and FIG. 34 to implement the example hardware asset of FIG. 15 and FIG. 18.

FIG. 44 is a block diagram of an example processor platform structured to execute the example computer readable instructions of FIG. 31 to implement a portion of the example central licensor of FIG. 15, FIG. 16 and FIG. 18.

FIG. 45 is a block diagram of an example software distribution platform to distribute software (e.g., software corresponding to the example computer readable instructions of FIGS. 19, 20, 21, 22A-22B, 23, 24, 25, 26, 27, 28, 29, 30, 31, 32, 33 and/or 34) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

FIG. 46 illustrates an overview of an edge cloud configuration for edge computing.

FIG. 47 illustrates operational layers among endpoints, an edge cloud, and cloud computing environments.

FIG. 48 illustrates an example approach for networking and services in an edge computing system.

FIG. 49 is a block diagram of another example system to implement and manage software defined silicon products in accordance with teachings of this disclosure.

FIG. 50 is a block diagram illustrating example implementations of another example software defined silicon agent, another example manufacturer enterprise system, and another example customer enterprise system included in the example system of FIG. 49.

FIG. 51 is a block diagram illustrating example implementations of another example software defined silicon agent, another example manufacturer enterprise system, and another example customer enterprise system included in the example system of FIG. 49.

FIG. 52 is a block diagram of another example system to implement and manage software defined silicon products in accordance with the teachings of this disclosure.

FIG. 53 is a block diagram of the example time calculator of FIG. 52.

FIG. 54 is a block diagram of the example feature group calculator of FIG. 52.

FIG. 55 is a flowchart representative of example computer readable instructions that may be executed to implement the example software defined silicon agent of FIGS. 49 and/or 50.

FIG. 56 is a flowchart representative of example computer readable instructions that may be executed to implement the example software defined silicon agent of FIGS. 49 and/or 50.

FIG. 57 is a flowchart representative of example computer readable instructions that may be executed to implement the example software defined silicon agent of FIGS. 49 and/or 50.

FIG. 58 is a flowchart representative of example computer readable instructions that may be executed to implement the example software defined silicon agent of FIGS. 49 and/or 50.

FIG. 59 is a flowchart representative of example computer readable instructions that may be executed to implement the example software defined silicon agent of FIGS. 49 and/or 51.

FIG. 60 is a flowchart representative of example computer readable instructions that may be executed to implement the example software defined silicon agent of FIGS. 49 and/or 51.

FIG. 61 is a flowchart representative of example computer readable instructions that may be executed to implement the example software defined silicon agent of FIGS. 49, 50, and/or 51.

FIG. 62 is a flowchart representative of example computer readable instructions that may be executed to implement the example time calculator of FIG. 53.

FIG. 63 is a flowchart representative of example computer readable instructions that may be executed to implement the example feature group calculator of FIG. 54.

FIG. 64 is a block diagram of an example processor platform structured to execute the example computer readable instructions of FIGS. 55, 56, 57, 58, and/or 61 to implement the example software defined silicon agent of FIGS. 49, 50, and/or 51.

FIG. 65 is a block diagram of an example processor platform structured to execute the example computer readable instructions of FIGS. 59, 60, and/or 61 to implement the example software defined silicon agent of FIGS. 49, 50, and/or 51.

FIG. 66 is a block diagram of an example processor platform structured to execute the example computer readable instructions of FIGS. 62 and/or 63 to implement the example system of FIGS. 52, 53, and/or 54.

FIG. 67 is a block diagram of an example system to implement and manage virtual resource migration in accordance with teachings of this disclosure.

FIG. 68 is a block diagram illustrating example implementations of example servers and the example manufacturer enterprise system and the example customer enterprise system included in the example system of FIG. 67.

FIG. 69 is a flowchart representative of example machine readable instructions and/or example operations that may be executed by example processor circuitry to implement the example customer enterprise system of FIGS. 67 and/or 68, and/or, more generally, the example system of FIGS. 67 and/or 68, to migrate an example virtual resource.

FIG. 70 is a flowchart representative of example machine readable instructions and/or example operations that may be executed by example processor circuitry to implement the example customer enterprise system of FIGS. 67 and/or 68, and/or, more generally, the example system of FIGS. 67 and/or 68, to temporarily migrate an example virtual resource.

FIG. 71 is a block diagram of an example processing platform including processor circuitry structured to execute the example machine readable instructions and/or the example operations of FIGS. 69 and/or 70 to implement the example customer enterprise system of FIGS. 67 and/or 68.

FIG. 72 is a block diagram of an example system including the example customer enterprise system of FIG. 1 to manage resource configurations based on a recommendation from a machine learning model in accordance with teachings of this disclosure.

FIG. 73 is a block diagram of an example workflow to manage resource configurations based on a recommendation from a machine learning model.

FIG. 74 is a flowchart representative of example machine readable instructions and/or example operations that may be executed by example processor circuitry to implement the example customer enterprise system of FIGS. 1 and/or 73, and/or, more generally, the example system of FIG. 72, to execute a workload based on a recommendation of feature(s) from machine learning model(s).

FIG. 75 is a flowchart representative of example machine readable instructions and/or example operations that may be executed by example processor circuitry to implement the example customer enterprise system of FIGS. 1 and/or 73, and/or, more generally, the example system of FIG. 72, to change feature(s) of semiconductor device(s) based on telemetry data associated with the semiconductor device(s).

FIG. 76 is a flowchart representative of example machine readable instructions and/or example operations that may be executed by example processor circuitry to implement the example customer enterprise system of FIGS. 1 and/or 73, and/or, more generally, the example system of FIG. 72, to collect telemetry data associated with the example system of FIG. 72.

FIG. 77 is a flowchart representative of example machine readable instructions and/or example operations that may be executed by example processor circuitry to implement the example customer enterprise system of FIGS. 1 and/or 73, and/or, more generally, the example system of FIG. 72, to activate dormant features of semiconductor device(s) based on telemetry data.

FIG. 78 is a block diagram of an example processing platform including processor circuitry structured to execute the example machine readable instructions and/or the example operations of FIGS. 74, 75, 76, and/or 77 to implement the example customer enterprise system of FIGS. 1 and/or 73.

FIG. 79 is a block diagram of an example system including an example coordination controller to manage hardware self-configuration based on a recommendation from a machine learning model in accordance with teachings of this disclosure.

FIG. 80 is a flowchart representative of example machine readable instructions and/or example operations that may be executed by example processor circuitry to implement the example coordination controller of FIG. 79, and/or, more generally, the example system of FIG. 79, to execute a workload based on a recommendation of feature change(s) from machine learning model(s).

FIG. 81 is a flowchart representative of example machine readable instructions and/or example operations that may be executed by example processor circuitry to implement the example coordination controller of FIG. 79, and/or, more generally, the example system of FIG. 79, to change feature(s) of semiconductor device(s) based on telemetry data associated with the semiconductor device(s).

FIG. 82 is a flowchart representative of example machine readable instructions and/or example operations that may be executed by example processor circuitry to implement the example coordination controller of FIG. 79, and/or, more generally, the example system of FIG. 79, to resume execution of a workload on a semiconductor device after an upgrade of the semiconductor device.

FIG. 83 is a flowchart representative of example machine readable instructions and/or example operations that may be executed by example processor circuitry to implement the example coordination controller of FIG. 79, and/or, more generally, the example system of FIG. 79, to manage consumption and/or generation of computational cost(s) of a semiconductor device.

FIG. 84 is a flowchart representative of example machine readable instructions and/or example operations that may be executed by example processor circuitry to implement the example coordination controller of FIG. 79, and/or, more generally, the example system of FIG. 79, to manage consumption and/or removal of token(s) of a semiconductor device.

FIG. 85 is a flowchart representative of example machine readable instructions and/or example operations that may be executed by example processor circuitry to implement the example manufacturer enterprise system of FIGS. 1, 49, and/or 79, and/or, more generally, the example system of FIG. 79, to manage generation and/or disbursement of non-fungible tokens associated with feature(s) of semiconductor device(s).

FIG. 86 is a block diagram of an example processing platform including processor circuitry structured to execute the example machine readable instructions and/or the example operations of FIGS. 80, 81, 82, 83, 84, and/or 85 to implement the example server of FIG. 79.

FIG. 87 is a block diagram of an example system including the example SDSi asset agent of FIGS. 1 and/or 49 to manage reduced footprint agents in accordance with teachings of this disclosure.

FIG. 88 is a flowchart representative of example machine readable instructions and/or example operations that may be executed by example processor circuitry to implement the example SDSi asset agent of FIGS. 1, 49, and/or 87, and/or, more generally, the example system of FIG. 87, to at least one of provision a license or execute a service with a reduced footprint agent.

FIG. 89 is a flowchart representative of example machine readable instructions and/or example operations that may be executed by example processor circuitry to implement the example SDSi asset agent of FIGS. 1, 49, and/or 87, and/or, more generally, the example system of FIG. 87, to at least one of provision a license or execute a service with a reduced footprint agent.

FIG. 90 is a flowchart representative of example machine readable instructions and/or example operations that may be executed by example processor circuitry to implement the example manufacturer enterprise system of FIGS. 1, 49, and/or 87, and/or, more generally, the example system of FIG. 87, to process a submission for at least one of a license or a reduced footprint agent.

FIG. 91 is a flowchart representative of example machine readable instructions and/or example operations that may be executed by example processor circuitry to implement the example SDSi asset agent and/or the example customer enterprise system of FIGS. 1, 49, and/or 87, and/or, more generally, the example system of FIG. 87, to at least one of provision a license or execute a service with a reduced footprint agent.

FIG. 92 is a flowchart representative of example machine readable instructions and/or example operations that may be executed by example processor circuitry to implement the example SDSi asset agent of FIGS. 1, 49, and/or 87, and/or, more generally, the example system of FIG. 87, to manage execution of a reduced footprint agent at a semiconductor device to execute a telemetry collection service.

FIG. 93 is another flowchart representative of example machine readable instructions and/or example operations that may be executed by example processor circuitry to implement the example SDSi asset agent of FIGS. 1, 49, and/or 87, and/or, more generally, the example system of FIG. 87, to manage execution of a reduced footprint agent at a semiconductor device to execute a service.

FIG. 94 is a block diagram of an example processing platform including processor circuitry structured to execute the example machine readable instructions and/or the example operations of FIGS. 88, 89, 90, 91, 92, 93, and/or 94 to implement the example SDSi asset agent of FIGS. 1, 49, and/or 87.

FIG. 95 is a block diagram of an example system to perform SDSi usage evaluation and corresponding license transfer(s) responsive to detected and predicted failures in accordance with teachings of this disclosure.

FIG. 96 is a flowchart representative of example machine readable instructions and/or example operations that may be executed by example processor circuitry to perform SDSi usage evaluation and corresponding license transfer(s) responsive to detected and predicted failures in the example system of FIG. 95.

FIG. 97 is a block diagram of an example processor platform including processor circuitry structured to execute the example machine readable instructions of FIG. 96 to implement one or more elements of the example system of FIG. 95.

FIG. 98 is a block diagram of another example processor platform including processor circuitry structured to execute the example machine readable instructions of FIG. 96 to implement one or more elements of the example system of FIG. 95.

FIG. 99 is a block diagram of an example system to perform transferring of node-locked SDSi licenses in accordance with teachings of this disclosure.

FIG. 100 depicts a ladder diagram illustrating an example polling-based license transfer operation implemented by the example system of FIG. 99.

FIG. 101 depicts a ladder diagram illustrating an example push-based license transfer operation implemented by the example system of FIG. 99.

FIG. 102 depicts a ladder diagram illustrating another example license transfer operation implemented by the example system of FIG. 99.

FIG. 103 is a flowchart representative of example machine readable instructions and/or example operations that may be executed by example processor circuitry to implement the example polling-based license transfer operation of FIG. 100.

FIG. 104 is a flowchart representative of example machine readable instructions and/or example operations that may be executed by example processor circuitry to implement the example push-based license transfer operation of FIG. 101.

FIG. 105 is a flowchart representative of example machine readable instructions and/or example operations that may be executed by example processor circuitry to implement the example license transfer operation of FIG. 102.

FIG. 106 is a flowchart representative of example machine readable instructions and/or example operations that may be executed by example processor circuitry to implement another example license transfer operation in the example system of FIG. 99.

FIG. 107 is a block diagram of an example processor platform including processor circuitry structured to execute the example machine readable instructions of FIGS. 103, 104, 105 and/or 106 to implement one or more elements of the example system of FIG. 99.

FIG. 108 is a block diagram of another example processor platform including processor circuitry structured to execute the example machine readable instructions of FIGS. 103, 104, 105 and/or 106 to implement one or more elements of the example system of FIG. 99.

FIG. 109 is a block diagram of an example system to perform flexible management of software defined silicon licenses in accordance with teachings of this disclosure.

FIG. 110 depicts a ladder diagram illustrating an example install license pool operation implemented by the example system of FIG. 109.

FIG. 111 depicts a ladder diagram illustrating an example acquire license pool operation implemented by the example system of FIG. 109.

FIG. 112 depicts a ladder diagram illustrating an example activate feature operation implemented by the example system of FIG. 109.

FIG. 113 depicts a ladder diagram illustrating an example deactivate feature operation implemented by the example system of FIG. 109.

FIG. 114 is a flowchart representative of example machine readable instructions and/or example operations that may be executed by example processor circuitry to implement the example install license pool operation of FIG. 110.

FIG. 115 is a flowchart representative of example machine readable instructions and/or example operations that may be executed by example processor circuitry to implement the example acquire license pool operation of FIG. 111.

FIG. 116 is a flowchart representative of example machine readable instructions and/or example operations that may be executed by example processor circuitry to implement the example activate feature operation of FIG. 112.

FIG. 117 is a flowchart representative of example machine readable instructions and/or example operations that may be executed by example processor circuitry to implement the example deactivate feature operation of FIG. 113.

FIG. 118 is a block diagram of an example processor platform including processor circuitry structured to execute the example machine readable instructions of FIGS. 114, 115, 116 and/or 117 to implement one or more elements of the example system of FIG. 109.

FIG. 119 is a block diagram of another example processor platform including processor circuitry structured to execute the example machine readable instructions of FIGS. 114, 115, 116 and/or 117 to implement one or more elements of the example system of FIG. 109.

FIG. 120 is a block diagram of an example system to perform community generation of SDSi licenses in accordance with teachings of this disclosure.

FIG. 121 is a flowchart representative of example machine readable instructions and/or example operations that may be executed by example processor circuitry to implement an example licensing community identification procedure in the example system of FIG. 120.

FIG. 122 is a flowchart representative of example machine readable instructions and/or example operations that may be executed by example processor circuitry to implement an example delegated authority agent election procedure in the example system of FIG. 120.

FIG. 123 is a flowchart representative of example machine readable instructions and/or example operations that may be executed by example processor circuitry to implement an example license verification procedure in the example system of FIG. 120.

FIG. 124 is a flowchart representative of example machine readable instructions and/or example operations that may be executed by example processor circuitry to implement an example license generation procedure in the example system of FIG. 120.

FIG. 125 is a block diagram of an example processor platform including processor circuitry structured to execute the example machine readable instructions of FIGS. 121, 122, 123 and/or 124 to implement one or more elements of the example system of FIG. 120.

FIG. 126 is a block diagram of another example processor platform including processor circuitry structured to execute the example machine readable instructions of FIGS. 121, 122, 123 and/or 124 to implement one or more elements of the example system of FIG. 120.

FIG. 127 is a block diagram of an example system that implements time-based expiration of SDSi licenses in accordance with teachings of this disclosure.

FIG. 128 is a block diagram of an example SDSi semiconductor device that implements time-based expiration of SDSi licenses in accordance with teachings of this disclosure.

FIG. 129 is a flowchart representative of example machine readable instructions and/or example operations that may be executed by example processor circuitry to implement time-based expiration of SDSi licenses in the example system of FIG. 127.

FIG. 130 is a flowchart representative of example machine readable instructions and/or example operations that may be executed by example processor circuitry to implement time-based expiration of SDSi licenses in the example SDSi semiconductor device of FIG. 128.

FIG. 131 is a flowchart representative of second example machine readable instructions and/or example operations that may be executed by example processor circuitry to implement time-based expiration of SDSi licenses in the example SDSi semiconductor device of FIG. 128.

FIG. 132 is a block diagram of an example processor platform including processor circuitry structured to execute the example machine readable instructions of FIG. 129, to implement one or more elements of the example system of FIG. 127.

FIG. 133 is a block diagram of an example processor platform including processor circuitry structured to execute the example machine readable instructions of FIGS. 130 and/or 131 to implement one or more elements of the example SDSi semiconductor device of FIG. 128.

FIG. 134 is a block diagram of an example system for converting provisional and non-node locked licenses to complete node locked licenses as implemented in accordance with teachings of this disclosure.

FIG. 135 is a block diagram of an example system for converting provisional licenses that are locked to a virtual platform to complete node-locked licenses as implemented in accordance with teachings of this disclosure.

FIG. 136 is a flowchart representative of example machine readable instructions and/or example operations that may be executed by example processor circuitry to implement the system of FIG. 134.

FIG. 137 is a flowchart representative of example machine readable instructions and/or example operations that may be executed by example processor circuitry to implement the system of FIG. 135.

FIG. 138 is a block diagram of an example processor platform including processor circuitry structured to execute the example machine readable instructions of FIGS. 136 and 137 to implement the example systems of FIGS. 134 and 135.

FIG. 139 is a block diagram of another example processor platform including processor circuitry structured to execute the example machine readable instructions of FIG. 136 to implement the example system of FIG. 134.

FIG. 140 is a block diagram of an example processor platform including processor circuitry structured to execute the example machine readable instructions of FIG. 137 to implement the example system of FIG. 135.

FIG. 141 is a block diagram of another example processor platform including processor circuitry structured to execute the example machine readable instructions of FIG. 137 to implement the example system of FIG. 135.

FIG. 142 is a block diagram of an example system to create and distribute non-node locked hardware licenses using blockchain in accordance with teachings of this disclosure.

FIGS. 143 and 144 is a flowchart representative of example machine readable instructions and/or example operations that may be executed by example processor circuitry to implement the system of FIG. 142.

FIG. 145 is a block diagram of an example processor platform including processor circuitry structured to execute the example machine readable instructions of FIGS. 143 and/or 144 to implement the example system of FIG. 142.

FIG. 146 is a block diagram of another example processor platform including processor circuitry structured to execute the example machine readable instructions of FIGS. 143 and/or 144 to implement the example system of FIG. 142.

FIG. 147 is a block diagram of an example system for activation of hardware features with pre-populated hardware licenses as implemented in accordance with teachings of this disclosure.

FIG. 148 is a flowchart representative of example machine readable instructions and/or example operations that may be executed by example processor circuitry to implement the system of FIG. 147.

FIG. 149 is a block diagram of an example processor platform including processor circuitry structured to execute the example machine readable instructions of FIG. 148 to implement the example system of FIG. 147.

FIG. 150 is a block diagram of an example implementation of the processor circuitry of FIGS. 35-44, 64-66, 71, 78, 86, 94, 97, 98, 107, 108, 118, 119, 125, 126, 132, 133, 138, 139, 140, 141, 145, 146, and/or 149.

FIG. 151 is a block diagram of another example implementation of the processor circuitry of FIGS. 35-44, 64-66, 71, 78, 86, 94, 97, 98, 107, 108, 118, 119, 125, 126, 132, 133, 138, 139, 140, 141, 145, 146, and/or 149.

FIG. 152 is a block diagram of an example software distribution platform (e.g., one or more servers) to distribute software (e.g., software corresponding to the example machine readable instructions of FIGS. 69, 70, 74-77, 80-85, 88-93, 96, 103-106, 114-117, 121-124, 129-131, 136, 137, 143, 144, 148) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. In general, the same reference numbers will be used throughout the drawing(s) and accompanying written description to refer to the same or like parts, elements, etc. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second.

### DETAILED DESCRIPTION

Software Defined Silicon Architecture

Methods, apparatus, systems and articles of manufacture (e.g., physical storage media) to implement and manage software defined silicon products, also referred to as silicon assets, are disclosed herein. Examples of silicon products include any type of semiconductor device, such as, computer processors, central processing unit(s) (CPUs), semiconductor chips, silicon hardware devices, etc., as well as circuit boards and/or systems employing such silicon products, etc. Software Defined Silicon (SDSi) as disclosed herein, which is also referred to as Software Defined Intelligent Silicon (SDISi), enables a hardware agnostic activation and entitlement management solution, which can realize additional market and monetization opportunities for silicon products. For example, silicon products can be released to the market with additional, dormant processing capacity and/or features (e.g., to support unexpected market shifts, future competitive pressures, etc.) SDSi provides a solution for customers to access those features and for the platform manufacturer to recover trapped revenue in shipped products post-sale.

As mentioned above, semiconductor device manufacturers currently ship semiconductor devices, such as microprocessors, with hardware and firmware features fixed, or locked, at the factory. For example, a semiconductor device manufacturer may implement a semiconductor device with one-time fuses that are activated, or blown, to disable some features at the factory, leaving those feature dormant and unusable in the shipped semiconductor device. Thus, even if additional, dormant hardware and/or firmware features are included in the shipped semiconductor devices, such dormant features are unable to be activated after the semiconductor devices leave the factory when such one-time fuse implementations are employed. To gain access to one or more of those dormant features, a customer would need to order, and a manufacturer would need to ship, new versions of the semiconductor devices that have the desired dormant feature(s) activated at the factory. To further complicate matters, the manufacturer may need to predefine and manage a numerous different stock keeping units (SKUs) to track the various combinations of different features that are able to be activated on its semiconductor devices, even if some of those combinations are never realized.

In contrast, SDSi provides a solution that enables activation, deactivation and management of silicon product features after the product has left the manufacturer's facility and control. Thus, for silicon product manufacturers, SDSi provides a monetization opportunity and an access to new routes to market. For example, SDSi enables manufacturers to capture additional revenue via one-time activation, on-demand activation and/or recurring subscription models that extend feature activation and entitlement management onto the customer premises, with the potential for income and profits beyond the initial product sale. Additionally or alternatively, SDSi enables manufacturers to take advantage of economies of scale by reducing the number of different silicon product versions that need to be manufactured. For example, through the use of SDSi, manufacturers can implement one version of a silicon product with a baseline set of features activated, and can then activate other dormant features as requested and purchased by customers for their particular applications. For customers, SDSi enables effective management of capital expenditures and operating expenditures through silicon-enabled intra-scalability and elasticity. For example, SDSi can streamline a customer's inventory by reducing the number of different silicon product versions that need to be stocked to support different applications.

SDSi systems, as disclosed herein, also enable efficient SKU management by providing the ability to activate SKUs permanently, semi-permanently and/or via capacity-on-demand, and to provide SKU assignments on a per-customer basis. SDSi systems, as disclosed herein, enable permanent or dynamic activation of dormant features (also referred to as “dark assets”) at a customer's premises without the need for a return merchandise authorization (RMA). In some examples, SDSI systems, as disclosed herein, also provide failure recovery solutions by activating dormant features to replace failed features on the silicon product.

These and other example methods, apparatus, systems and articles of manufacture (e.g., physical storage media) to implement and manage SDSi products are disclosed in greater detail below.

Protection Against Misuse of Software Defined Silicon

As noted above, SDSi systems as disclosed herein enable the activation and/or deactivation of features on an asset at a time after the initial distribution (e.g., sale) of the asset. However, by enabling adjustments of features available on the asset when it is no longer physically at the initial owner (e.g., the manufacturer), opportunities for misuse arise. For example, a bad actor may attempt to activate and/or deactivate functionality later in the asset's lifecycle without having the appropriate permissions to do so. Also, a manufacturer may sell an asset with a specific subset of features enabled, having tested the asset with only this specific subset of features enabled. The manufacturer may intend for the end-user of the asset to utilize this same subset of features. For example, the manufacturer may provide warranty coverage associated with the asset under the condition that a specified set of features remain activated or deactivated. In some examples, features available on an asset may correspond to specific payments made, or payments being made (i.e., using a subscription model) by customers. In these cases, de-activation of these features may result in the manufacturer needing to issue a refund. In some cases, the manufacturer may want to prevent de-activation of features after the transfer of ownership of the asset. Adjustments of features (e.g., activations, deactivations, etc.) that are not compliant with rules determined by the manufacturer can result in product malfunctions, financial loss to the manufacturer, misuse of the asset, etc.

Further, since SDSi features are enabled based on licenses, there is potential for misuse of a license at an unintended time, or by an unintended asset. A customer may request activation of a feature, and then decide to request a refund, without utilizing the license received to activate the feature. This customer may then utilize the license later to activate the feature, despite having been issued a refund for the unused activation request. A bad actor may additionally or alternatively transfer a license to another asset, thereby enabling or disabling a feature by using a license on an unintended asset.

Example techniques disclosed herein prevent or limit the ability for licenses to be used in violations of rules set by the manufacturer. For example, example techniques disclosed herein can prevent subsequent deactivation of features that were active at the time of the last sale. Example techniques disclosed herein enable a manufacturer to determine a state of an asset (e.g., a set of features active on the asset, a set of capabilities of the asset, etc.) and determine whether a license should be granted based on the state, a current owner of the asset, a completion certificate for a prior license activation, an authentication key, and/or one or more entitlement rules set by the manufacturer. Some example techniques disclosed herein provide for ownership tracking of the asset throughout its lifecycle, as well as tracking of the state of the asset. Example apparatus, methods, systems, and articles of manufacture (e.g., physical storage media) disclosed herein enable intelligent decision making when responding to entitlement requests, and ultimately when granting access to adjustments of SDSi features.

Example apparatus, methods, systems, and articles of manufacture (e.g., physical storage media) disclosed herein prevent unintended re-use or delayed use of licenses by tracking a license identifier and a version number associated with the silicon asset. Example techniques disclosed herein thereby limit the application of a license to its intended asset and an intended time period (e.g., prior to requesting a refund for the feature to be activated by the license, prior to making another feature adjustment to the asset, etc.).

Example apparatus, methods, systems, and articles of manufacture (e.g., physical storage media) disclosed herein reliably ensure licenses are utilized on intended target assets by implementing one or more hardware and/or entropy-based identifiers. Some example techniques disclosed herein utilize entropy-based identifiers on the asset to prevent the transfer of a license to another asset which will have its own unique entropy-based identifier. In some such examples, the manufacturer is aware of the specific entropy-based identifier for a given asset, and can ensure that when the license is applied to activate or deactivate a feature, the asset on which the license is to be executed has the correct entropy-based identifier.

These and other example methods, apparatus, systems, and articles of manufacture (e.g., physical storage media) to implement and manage the protection against misuse of SDSi products are disclosed in greater detail below.

Software Defined Silicon Security

Methods, apparatus, systems, and articles of manufacture (e.g., physical storage media) for SDSi security are also disclosed herein. In some disclosed examples, SDSi solutions effectuate security features through at least one of peer-to-peer attestation or trusted execution environment (TEE) deployment. Maintaining trust within an SDSi solution is advantageous for silicon product manufacturers to ensure security of data (e.g., silicon product manufacturer owned cryptographical data). For example, the data can allow the unlocking or activation of SDSi features and security thereof is advantageous to protect revenue streams and prevent SDSi systems from being compromised by malicious actors.

In some disclosed examples, SDSi solutions effectuates system security by deploying a peer-to-peer attestation schema in a mesh network. For example, SDSi systems can communicate with each other to determine reputation information. In such disclosed examples, SDSi systems query other SDSIs systems for runtime measurements and identify compromised SDSi systems based on a comparison of the runtime measurements to known validated runtime measurements. In some such disclosed examples, SDSi systems identify an SDSi system to execute system functions, such as to facilitate entitlement/license processing and telemetry reporting, based on the reputation score. In some disclosed examples, SDSi systems improve system security by implementing re-certification processes to identify rogue and/or malicious SDSi systems.

In some disclosed examples, SDSi solutions effectuate system security by deploying TEEs within the SDSi systems or associated with the SDSi systems. For example, SDSi systems can explore an environment of a semiconductor device to determine security capabilities of the semiconductor device. In such disclosed examples, the security capabilities can include whether the semiconductor device supports deployment of one or more known TEEs, whether the semiconductor device has a capability to deploy a TEE component (e.g., trusted execution, trusted memory, trusted storage, etc.), etc. In some disclosed examples, SDSi systems deploy one of the known TEEs while, in some disclosed examples, SDSi systems compose a TEE based on one or more TEE components of which the semiconductor supports deployment thereof. In some disclosed examples, SDSi systems facilitate deployment of a TEE by translating an intent to deploy the TEE to one or more features of an associated semiconductor device. In such disclosed examples, SDSi systems translate the intent using one or more artificial intelligence (AI)/machine learning (ML) models.

These and other example methods, apparatus, systems and articles of manufacture (e.g., physical storage media) to implement and manage SDSi products are disclosed in greater detail below.

Device Enhancements

Device enhancements for software defined silicon implementations are also disclosed herein. As used herein, “the absolute time” refers to a particular clock and date reading (e.g., 11:11 PM EST, Jan. 1, 2020, etc.). As used herein, “the relative time” refers to an elapsed time between a fixed event (e.g., a time of manufacture of a device, etc.) and the current time. As used, herein a “time reference” refers to a singular absolute time reading and/or a singular relative time reading and may be used to generate a timestamp and/or an odometer reading.

As used herein, a “feature configuration” of a silicon product refers to the hardware, firmware, and/or physical features enabled on the silicon products. Feature configurations can, for example, include the number of cores of a processor that have been activated and/or the speed at which each core runs. As disclosed in further detail below, a license can be used to change the feature configuration of a silicon product.

As least some prior silicon products, such as central processing units (CPUs) and other semiconductor devices, are not able to provide/determine relative or absolute time references. For example, some existing CPUs lack internal clocks. Also, in at least some silicon products that include clocks, the clocks can be set and/or adjusted by a user of the machine, and, thusly, may not be reliable for determining absolute and/or relative time references. Further, some internal clocks (e.g., monotonic clocks, etc.) require power and, accordingly, cannot measure time if the silicon product and/or machine including the silicon product is powered off. Example SDSi systems disclosed herein utilize absolute and/or relative time references to enable or prohibit certain actions to ensure business and financial viability of feature activation decisions associated with the silicon product. In some examples, some silicon product features can be available only before or after a particular date and/or time from the time of manufacture of the processor.

Examples disclosed herein overcome the above-noted problems by adding one or more features to the silicon product, such that the feature has electrical properties that are time-dependent. In some examples disclosed herein, the electrical properties of the feature change in a known or predetermined manner as a function of time. In some examples disclosed herein, the electrical properties of the feature change when the silicon product is not powered on. In some examples disclosed herein, by determining the electrical properties of the feature at two separate points of time, the relative time between those points can be determined. In some examples disclosed herein, the electrical properties of the time-dependent features are measured at the time of manufacture and are stored with the date and time of manufacture. In such examples, the absolute time can be determined by adding the determined relative time between the current time and the time of manufacture to the date and time of manufacture. In some examples disclosed herein, the feature is implemented by a radioisotope. In some examples disclosed herein, the feature is implemented by a physical unclonable function (PUF) with time-varying electrical properties. As such, the examples disclosed herein provide a reliable and unfalsifiable measures of absolute and relative time references that do not require constant power to the silicon product and/or machine in which the silicon product is used.

Examples disclosed herein enable users, customers, and/or machine-manufacturers flexibility of changing the configuration of a processor after the silicon product has been manufactured. In some examples, the changing of the configuration of a silicon product can affect the operating conditions (e.g., thermal design power (TDP), etc.) of the silicon product, and, thusly, affect the lifespan and/or condition of the processor. As such, in some examples, changing the configuration of the silicon product can cause the silicon product to have a combination of features that damage the silicon product and/or reduce the lifespan of a silicon product to an unacceptable level. In some examples, the features activated in a given configuration can affect the operating conditions of a silicon product in an interdependent manner. For example, the number of active cores in a semiconductor device such as a CPU impacts the maximum frequency those cores can operate at, as well as the thermal design power of the semiconductor device. As such, to prevent unacceptable device degradation and damage, examples disclosed herein account for the effect of each feature on the operating conditions of the device.

Existing silicon products, such as CPUs, have limited internal storage. In existing techniques, the allowed configurations of a CPU are hard-coded into the CPU when the CPU is manufactured as multi-dimensional matrices. In some examples, given the number of features that may be enabled after manufacture, millions of potential combinations could be potentially enabled in a CPU. As such, in some examples, storing each allowable configuration in CPU memory can consume a significant amount of storage space of the CPU and severely limit the amount of memory available on the CPU for other functions and/or data. Adding additional memory to the CPU would increase manufacturing cost and/or the size of the CPU.

Examples disclosed herein overcome the above-noted problems by creating groups of features based on assigning weight(s) and/or value metric(s) to each feature in order to calculate a group score associated with a requested configuration. In such examples, the calculated group score can be compared to one or more thresholds to determine if the requested configuration allows for nominal operation of the silicon product. In some examples disclosed herein, the group score is compared to an enablement threshold. In such examples, if the group score does not satisfy the enablement threshold, the requested configuration results in operating conditions that may result in unacceptable degradation and/or damage to the silicon product and is, thusly, prohibited from being implemented. In some examples disclosed herein, the group score is compared to a warranty threshold. In such examples, if the group score does not satisfy the warranty threshold, the requested configuration results in operating conditions that void the warranty of the silicon product. In some examples disclosed herein, environmental factors (e.g., ambient temperature, available machine cooling, humidity, radiation, etc.) are incorporated into the determination of the group score. In some examples disclosed herein, multiple group scores are calculated for different unrelated feature-groups. In such examples, each group score is compared to different threshold values. In some examples disclosed herein, a machine learning model to refine and update the group score algorithm and/or weights for each feature using historic silicon product operating data.

Further Enhancements

Example SDSi systems disclosed herein can also implement several technical solutions related to license management for software defined silicon products. Examples of such technical solutions include:
virtual resource migration using SDSi;
resource configuration management using SDSi;
hardware self-configuration using SDSi;
reduced footprint agents using SDSi;
performing SDSi usage evaluation and corresponding license transfer responsive to detected and/or predicted failures;
transferring node locked SDSi licenses;
transfer of SDSi licenses without a trusted license server;
community license generation;
expirable SDSi licenses via a reliable clock;
non-node locked licenses via blockchain; and
activating hardware features with a pre-generated hardware license

Software Defined Silicon Architecture

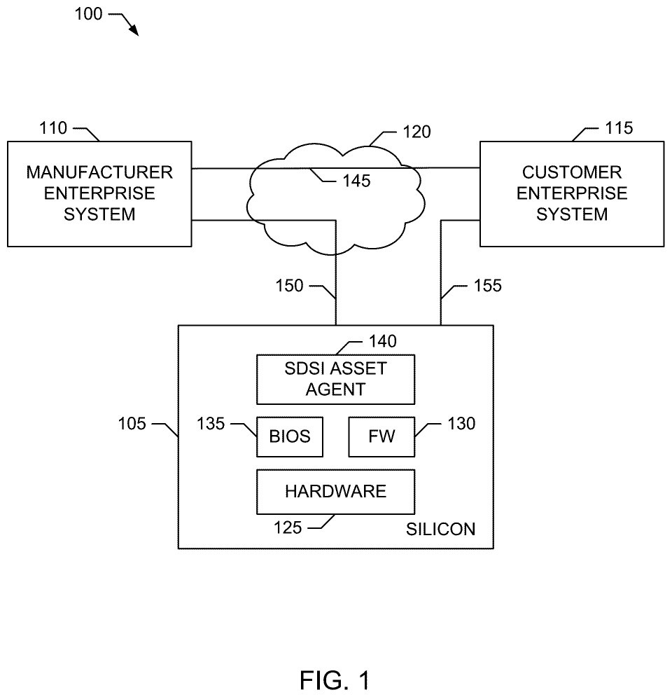

Turning to the figures, a block diagram of an example system 100 to implement and manage SDSi products in accordance with teachings of this disclosure is illustrated in FIG. 1. The example SDSi system 100 of FIG. 1 includes an example silicon product 105, such as an example semiconductor device 105 or any other silicon asset 105, that implement SDSi features as disclosed herein. Thus, the silicon product 105 of the illustrated example is referred to herein as an SDSi product 105, such as an SDSi semiconductor device 105 or SDSi silicon asset 105. The system 100 also includes an example manufacturer enterprise system 110 and an example customer enterprise system 115 to manage the SDSi product 105. In the illustrated example of FIG. 1, at least some aspects of the manufacturer enterprise system 110 are implemented as cloud services in an example cloud platform 120.

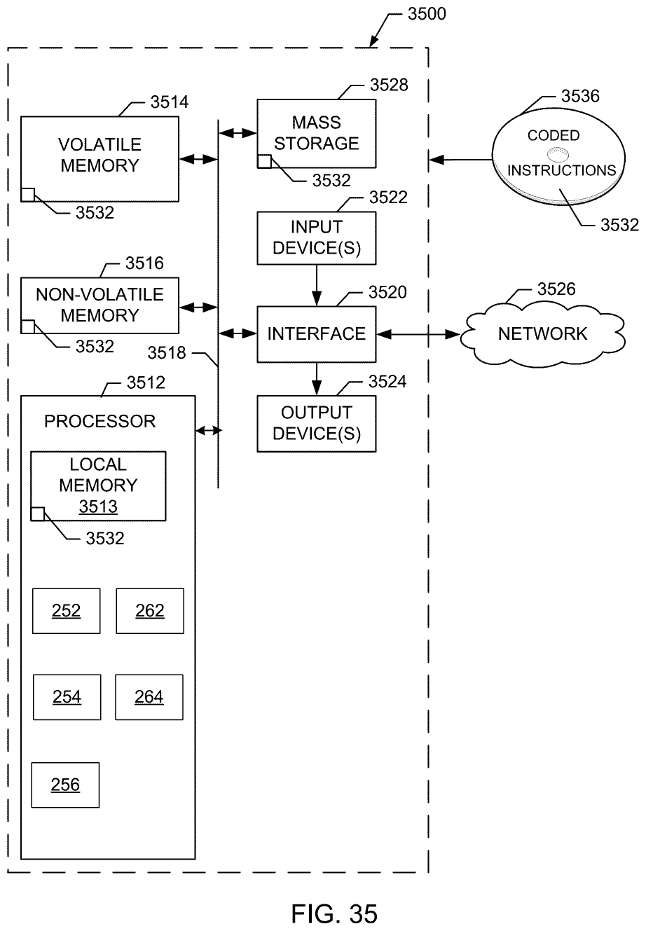

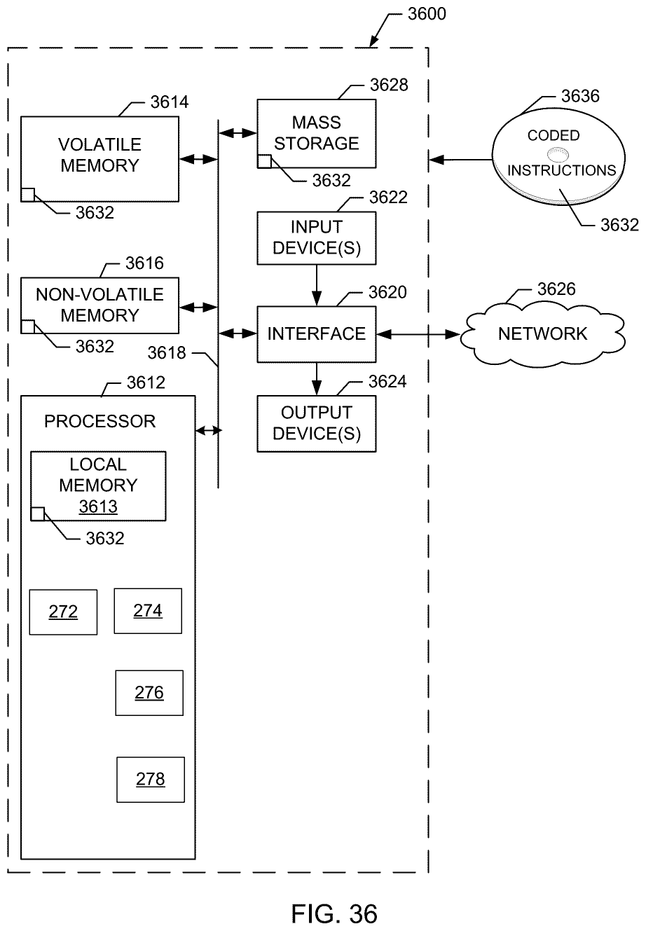

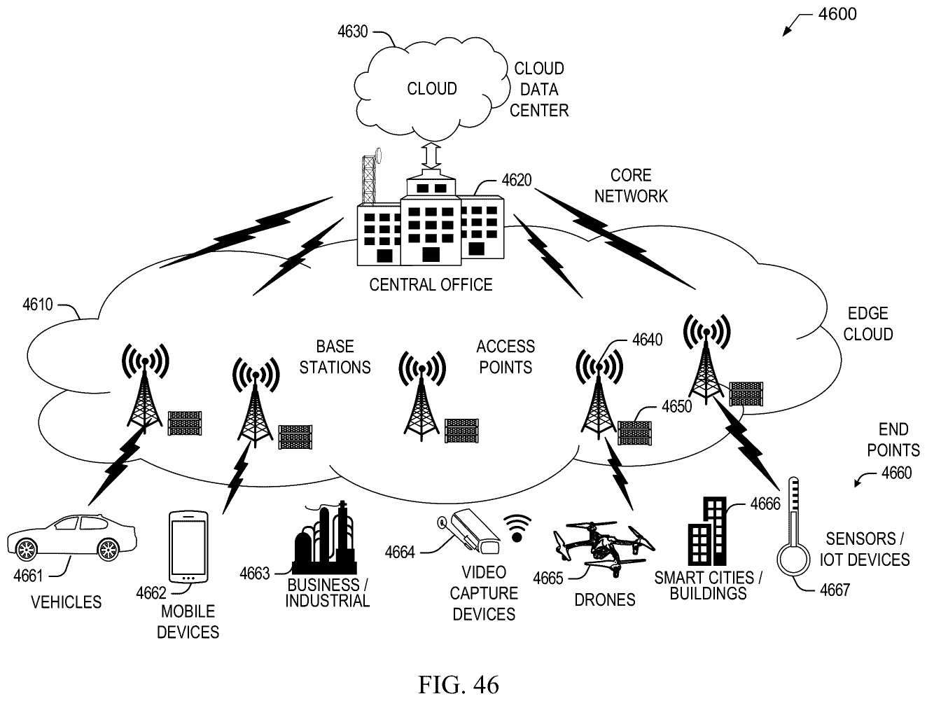

The example manufacturer enterprise system 110 can be implemented by any number(s) and/or type(s) of computing devices, servers, data centers, etc. In some examples, the manufacturer enterprise system 110 is implemented by a processor platform, such as the example processor platform 3500 of FIG. 35. Likewise, the example customer enterprise system 115 can be implemented by any number(s) and/or type(s) of computing devices, servers, data centers, etc. In some examples, the customer enterprise system 115 is implemented by a processor platform, such as the example processor platform 3600 of FIG. 36. The example cloud platform 120 can be implemented by any number(s) and/or type(s), such as Amazon Web Services (AWS®), Microsoft's Azure® Cloud, etc. In some examples, the cloud platform 120 is implemented by one or more edge clouds as described below in connection with FIGS. 46-48. Aspects of the manufacturer enterprise system 110, the customer enterprise system 115 and the cloud platform 120 are described in further detail below.

In the illustrated example of FIG. 1, the SDSi product 105 is an SDSi semiconductor device 105 that includes example hardware circuitry 125 that is configurable under the disclosed SDSi framework to provide one or more features. For example, such features can include a configurable number of processor cores, a configurable clock rate from a set of possible clock rates, a configurable cache topology from a set of possible cache topologies, configurable coprocessors, configurable memory tiering, etc. As such, the hardware circuitry 125 can include one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)), field programmable gate arrays (FPGAs), field programmable logic device(s) (FPLD(s)), etc., or any combination thereof. The SDSi semiconductor device 105 of FIG. 1 also includes example firmware 130 and an example basic input/output system (BIOS) 135 to, among other things, provide access to the hardware circuitry 125. In some examples, the firmware 130 and/or the BIOS 135 additionally or alternatively implement features that are configurable under the disclosed SDSi framework. The SDSi semiconductor device 105 of FIG. 1 further includes an example SDSi asset agent 140 to configure (e.g., activate, deactivate, etc.) the SDSi features provided by the hardware circuitry 125 (and/or the firmware 130 and/or the BIOS 135), confirm such configuration and operation of the SDSi features, report telemetry data associated with operation of the SDSi semiconductor device 105, etc. Aspects of the SDSi asset agent 140 are described in further detail below.

The system 100 allows a customer, such as an original equipment manufacturer (OEM) of computers, tablets, mobile phones, other electronic devices, etc., to purchase the SDSi semiconductor device 105 from a silicon manufacturer and later configure (e.g., activate, deactivate, etc.) one or more SDSi features of the SDSi semiconductor device 105 after it has left the silicon manufacturer's factory. In some examples, the system 100 allows the customer (OEM) to configure (e.g., activate, deactivate, etc.) the SDSi feature(s) of the SDSi semiconductor device 105 at the customer's facility (e.g., during manufacture of a product including the SDSi semiconductor device 105) or even downstream after customer's product containing the SDSi semiconductor device 105 has been purchased by a third party (e.g., a reseller, a consumer, etc.)

By way of example, consider an example implementation in which the semiconductor device 105 includes up to eight (8) processor cores. Previously, the number of cores activated on the semiconductor device 105 would be fixed, or locked, at the manufacturer's factory. Thus, if a customer wanted the semiconductor device 105 to have two (2) active cores, the customer would contract with the manufacturer to purchase the semiconductor device 105 with 2 active cores, and the manufacturer would ship the semiconductor device 105 with 2 cores activated, and identify the shipped device with a SKU indicating that 2 cores were active. However, the number of active cores (e.g., 2 in this example) could not be changed after the semiconductor device 105 left the manufacturer's factory. Thus, if the customer later determined that 4 (or 8) active cores were needed for its products, the customer would have to contract with the manufacturer to purchase new versions of the semiconductor device 105 with 4 (or 8) active cores, and the manufacturer would ship the new versions of the semiconductor device 105 with 4 (or 8) cores activated, and identify the shipped device with a different SKU indicating that 4 (or 8) cores were active. In such examples, the customer and/or the manufacturer may be left with excess inventory of the semiconductor device 105 with the 2-core configuration, which can incur economic losses, resource losses, etc.

In contrast, assume the number of processor cores activated on the semiconductor device 105 is an SDSi feature that can be configured in the example system 100 in accordance with teachings of this disclosure. In such an example, the customer could contract with the manufacturer to purchase the SDSi semiconductor device 105 with 2 active cores, and the manufacturer would ship the SDSi semiconductor device 105 with 2 cores activated, and identify the shipped device with a SKU indicating that 2 cores were active. After the device is shipped, if the customer determines that it would prefer that 4 cores were active, the customer management system 105 can contact the manufacturer enterprise system 110 via a cloud service implemented by the cloud platform 120 (represented by the line labeled 145 in FIG. 1) to request activation of 2 additional cores. Assuming the request is valid, the manufacturer enterprise system 110 generates a license (also referred to as a license key) to activate the 2 additional cores, and sends the license to the customer management system 115 via the cloud service implemented by the cloud platform 120 (represented by the line labeled 145 in FIG. 1) to confirm the grant of an entitlement to activate the 2 additional cores. The customer enterprise system 115 then sends the license (or license key) to the SDSi asset agent 140 of the SDSi semiconductor device 105 (via a network as represented by represented by the line labeled 155 in FIG. 1) to cause activation of 2 additional cores provided by the hardware circuitry 125 of the SDSi semiconductor device 105. In the illustrated example, the SDSi asset agent 140 reports a certificate back to the manufacturer enterprise system 110 (e.g., via an appropriate cloud service implemented by the cloud platform 120, as represented by the line labeled 150 in FIG. 1) to confirm activation of the 2 cores. In some examples, the SDSi asset agent 140 also reports the certificate back to the customer enterprise system 115 (e.g., via the network as represented by the line labeled 155 in FIG. 1) to confirm activation of the 2 cores. In some examples, the SDSi asset agent 140 also reports telemetry data associated with operation of the SDSi semiconductor device 105 to the manufacturer enterprise system 110 (e.g., via the appropriate cloud service implemented by the cloud platform 120, as represented by the line labeled 150 in FIG. 1) and/or the customer enterprise system 115 (e.g., via the network as represented by the line labeled 155 in FIG. 1). After successful activation is confirmed, the manufacturer then invoices the customer (e.g., via the manufacturer enterprise system 110 and the customer management system 115) for the newly activate features (e.g., 2 additional cores). In some examples, the manufacturer enterprise system 110 and/or the customer management system 115 determine a new SKU (e.g., a soft SKU) to identify the same SDSi semiconductor device 105 but with the new feature configuration (e.g., 4 cores instead of 2 cores).

If the customer later determines that it would prefer that 8 cores were active, the customer management system 115 can contact the manufacturer enterprise system 110 via the cloud service implemented by the cloud platform 120 (represented by the line labeled 145 in FIG. 1) to request activation of the remaining 4 additional cores. Assuming the request is valid, the manufacturer enterprise system 110 generates another license (or license key) to activate the 4 additional cores, and sends the license to the customer management system 115 via the cloud service implemented by the cloud platform 120 (represented by the line labeled 145 in FIG. 1) to confirm the grant of an entitlement to activate the 4 remaining cores. The customer enterprise system 115 then sends license (or license key) to the SDSi asset agent 140 of the SDSi semiconductor device 105 (e.g., via the network as represented by the line labeled 155 in FIG. 1) to cause activation of the 4 remaining cores provided by the hardware circuitry 125 of the SDSi semiconductor device 105. In the illustrated example, the SDSi asset agent 140 reports a certificate back to the manufacturer enterprise system 110 (e.g., via the appropriate cloud service implemented by the cloud platform 120, as represented by the line labeled 150 in FIG. 1) to confirm activation of the 4 remaining cores. In some examples, the SDSi asset agent 140 also reports the certificate back to the customer enterprise system 115 (e.g., via the network as represented by the line labeled 155 in FIG. 1) to confirm activation of the 4 remaining cores. In some examples, the SDSi asset agent 140 reports telemetry data associated with operation of the SDSi semiconductor device 105 to the manufacturer enterprise system 110 (e.g., via the appropriate cloud service implemented by the cloud platform 120, as represented by the line labeled 150 in FIG. 1) and/or the customer enterprise system 115 (e.g., via the network as represented by the line labeled 155 in FIG. 1). After successful activation is confirmed, the manufacturer then invoices the customer (e.g., via the manufacturer enterprise system 110 and the customer management system 115) for the newly activate features (e.g., the 4 additional cores). In some examples, the manufacturer enterprise system 110 and/or the customer management system 115 determine yet another new SKU (e.g., a soft SKU) to identify the same SDSi semiconductor device 105 but with the new feature configuration (e.g., 8 cores instead of 4 cores).

In the illustrated examples of FIG. 1, the communications between the manufacturer enterprise system 110 and the customer enterprise system 115, between the manufacturer enterprise system 110 and the SDSi asset agent 140 of the SDSi semiconductor device 105, and between the SDSi asset agent 140 of the SDSi semiconductor device 105 and the customer enterprise system 115 can be implemented by one or more networks. For example, such networks can include the Internet, one or more wireless (cellular, satellite, etc.) service provider networks, one or more wired (e.g., cable, digital subscriber line, optical fiber, etc.) networks, one or more communication links, busses, etc.

In some examples, the SDSi semiconductor device 105 is included in or otherwise implements an example edge node, edge server, etc., included in or otherwise implementing one or more edge clouds. In some examples, the SDSi semiconductor device 105 is included in or otherwise implements an appliance computing device. In some examples, the manufacturer enterprise system 110 is implemented by one or more edge node, edge server, etc., included in or otherwise implementing one or more edge clouds. In some examples, the manufacturer enterprise system 110 is implemented by one or more appliance computing devices. In some examples, the customer enterprise system 115 is implemented by one or more edge node, edge server, etc., included in or otherwise implementing one or more edge clouds. In some examples, the customer enterprise system 115 is implemented by one or more appliance computing devices. Examples of such edge nodes, edge servers, edge clouds and appliance computing devices are described in further detail below in connection with FIGS. 46-48. Furthermore, in some examples, such edge nodes, edge servers, edge clouds and appliance computing devices may themselves be implemented by SDSi semiconductor devices capable of being configured/managed in accordance with the teachings of this disclosure.

In some examples, the manufacturer enterprise system 110 communicates with multiple customer enterprise systems 115 and/or multiple SDSi semiconductor devices 105 via the cloud platform 120. In some examples, the manufacturer enterprise system 110 communicates with multiple customer enterprise systems 115 and/or multiple SDSi semiconductor device(s) 105 via the cloud platform 120 through one or more edge servers/nodes. In either such example, the customer enterprise system(s) 115 and/or SDSi semiconductor device(s) 105 can themselves correspond to one or more edge nodes, edge servers, edge clouds and appliance computing devices, etc.

In some examples, the manufacturer enterprise system 110 may delegate SDSi license generation and management capabilities to one or more remote edge nodes, edge servers, edge clouds, appliance computing devices, etc., located within a customer's network domain. For example, such remote edge nodes, edge servers, edge clouds, appliance computing devices, etc., may be included in the customer enterprise system 115. In some such examples, the manufacturer enterprise system 110 can delegate to such remote edge nodes, edge servers, edge clouds, appliance computing devices, etc., a full ability to perform SDSi license generation and management associated with the customer's SDSi semiconductor devices 105 provided the remote edge nodes, edge servers, edge clouds, appliance computing devices, etc., are able to communicate with manufacturer enterprise system 110. However, in some examples, if communication with the manufacturer enterprise system 110 is disrupted, the remote edge nodes, edge servers, edge clouds, appliance computing devices may have just a limited ability to perform SDSi license generation and management associated with the customer's SDSi semiconductor devices 105. For example, such limited ability may restrict the delegated SDSi license generation and management to supporting failure recovery associated with the SDSi semiconductor devices 105. Such failure recovery may be limited to generating and providing licenses to configure SDSi features of a client's SDSi semiconductor device 105 to compensate for failure of one or more components of the SDSi semiconductor device 105 (e.g., to maintain a previously contracted quality of service).

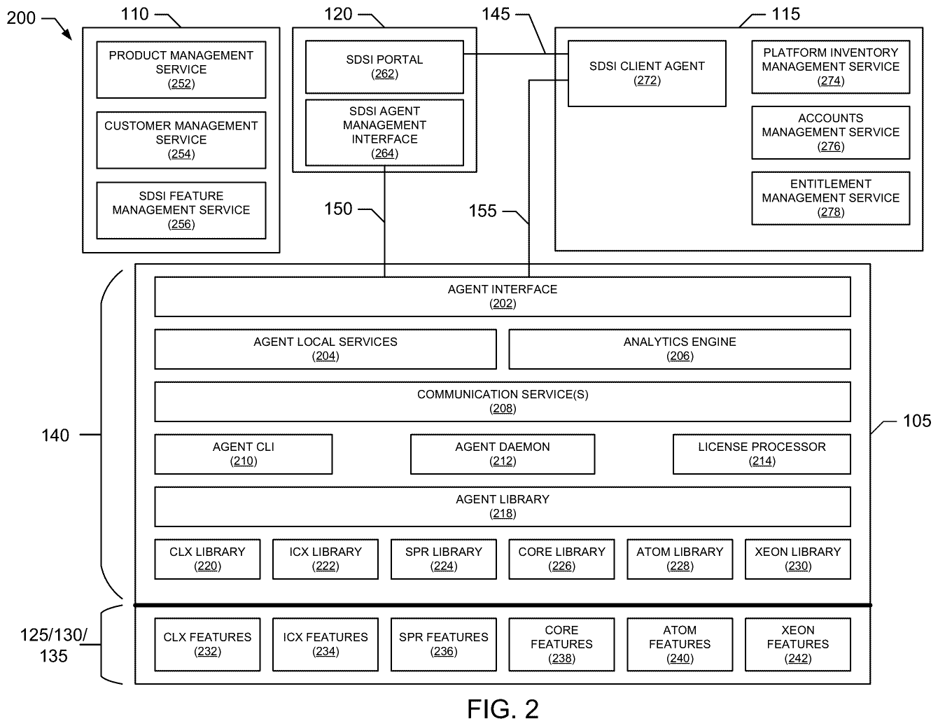

A block diagram of an example system 200 that illustrates example implementations of the SDSi asset agent 140 of the SDSi silicon product 105, the manufacturer enterprise system 110 and the customer enterprise system 115 included in the example system 100 of FIG. 1 is illustrated in FIG. 2. The example SDSi asset agent 140 of FIG. 2 includes an example agent interface 202, example agent local services 204, an example analytics engine 206, example communication services 208, an example agent command line interface (CLI) 210, an example agent daemon 212, an example license processor 214, and an example agent library 218. The example SDSi asset agent 140 of FIG. 2 also includes example feature libraries 220-230 corresponding to respective example feature sets 232-242 implemented by the hardware circuitry 125, firmware 130 and/or BIOS 135 of the SDSi semiconductor device 105. The example manufacturer enterprise system 110 of FIG. 2 includes an example product management service 252, an example customer management service 254, and an example SDSi feature management service 256. The example manufacturer enterprise system 110 of FIG. 2 also implements an example SDSi portal 262 and an example SDSi agent management interface 264 as cloud services in the cloud platform 120. The example customer enterprise system 115 of FIG. 2 includes an example SDSi client agent 272, an example platform inventory management service 274, an example accounts management service 276 and an example entitlement management service 278.

In the illustrated example of FIG. 2, the agent interface 202 implements an interface to process messages sent between the SDSi asset agent 140 and the manufacturer enterprise system 110, and between the SDSi asset agent 140 and the customer enterprise system 115. The SDSi asset agent 140 of the illustrated example includes the agent local services 204 to implement any local services used to execute the SDSi asset agent 140 on the semiconductor device 105. The SDSi asset agent 140 of the illustrated example includes the analytics engine 206 to generate telemetry data associated with operation of the semiconductor device 105. Accordingly, the analytics engine 206 is an example of means for reporting telemetry data associated with operation of the semiconductor device 105. The communication services 208 provided in the SDSi asset agent 140 of the illustrated example include a local communication service to enable the SDSi asset agent 140 to communicate locally with the other elements of the semiconductor device 105 and/or a product platform including the semiconductor device 105. The communication services 208 also include a remote communication service to enable the SDSi asset agent 140 to communicate remotely with the SDSi agent management interface 264 of the manufacturer enterprise system 110 and the SDSi client agent 272 of the customer enterprise system 115. The SDSi asset agent 140 of the illustrated example includes the agent CLI 210 to process commands entered locally to the semiconductor device 105 via a command line interface. The SDSi asset agent 140 of the illustrated example includes the license processor 214 to process license(s) received from the customer enterprise system 115 to configure (e.g., activate, deactivate, etc.) one or more SDSi features included in the feature sets 232-242 implemented by the hardware circuitry 125, firmware 130 and/or BIOS 135 of the SDSi semiconductor device 105. Accordingly, the license processor 214 is an example of means for activating or deactivating at least one feature of the semiconductor device 105 based on a license received via a network from a remote enterprise system. The SDSi asset agent 140 of the illustrated example includes the agent daemon 212 to securely execute the elements of the SDSi asset agent 140. For example, the agent daemon 212 can execute one or more of the agent interface 202, the agent local services 204, the analytics engine 206, the communication services 208, the agent CLI 210 and/or the license processor 214 in a protected environment, such as a trusted execution environment (TEE), implemented by the semiconductor device 105. The SDSi asset agent 140 of the illustrated example includes the agent library 218 to provide, among other things, hardware-agnostic application programming interfaces (APIs) to be used by the license processor 214 to invoke the respective, hardware-specific feature libraries 220-230 to configure (e.g., activate, deactivate, etc.), based on the received license data, one or more features in the corresponding example features sets 232-242 implemented by the hardware circuitry 125, firmware 130 and/or BIOS 135 of the SDSi semiconductor device 105. Accordingly, the hardware circuitry 125, firmware 130 and/or BIOS 135 are examples of means for providing SDSi features in the SDSi semiconductor device 105. In some examples, the agent library 218 and/or the hardware-specific feature libraries 220-230 also operate in a protected environment, such as a TEE, implemented by the semiconductor device 105. Further details concerning the elements of the SDSi asset agent 140 of FIG. 2 are described below.

In the illustrated example of FIG. 2, the manufacturer enterprise system 110 includes the example product management service 252 to manage the inventory, pricing, etc., of the products manufactured by the manufacturer of the SDSi semiconductor device 105. The manufacturer enterprise system 110 of the illustrated example includes the customer management service 254 to manage customer accounts, billing, reconciliation, etc., for the manufacturer of the SDSi semiconductor device 105. The manufacturer enterprise system 110 of the illustrated example includes the SDSi feature management service 256 to manage the configuration of SDSi feature(s) implemented by the silicon products manufactured by the manufacturer of the SDSi semiconductor device 105. The manufacturer enterprise system 110 of the illustrated example implements the SDSi portal 262 to communicate (e.g., via a network) with the customer enterprise system 115. The manufacturer enterprise system 110 of the illustrated example implements the SDSi agent management interface 264 to communicate (e.g., via a network) with the SDSi asset agent 140 of the SDSi semiconductor device 105. Further details concerning the elements of the manufacturer enterprise system 110 of FIG. 2 are described below.

In the illustrated example of FIG. 2, the customer enterprise system 115 includes the SDSi client agent 272 to communicate (e.g., via a network) with the manufacturer enterprise system 110 and the SDSi asset agent 140 of the SDSi semiconductor device 105. The customer enterprise system 115 of the illustrated example includes the platform inventory management service 274 to manage the platforms offered by the customer (OEM), such as platforms that include the SDSi semiconductor device 105. The customer enterprise system 115 of the illustrated example includes the accounts management service 276 to manage accounts, billings, reconciliations, etc., the customer has with manufacturers, downstream customers, etc., such as the manufacturer of the SDSi semiconductor device 105. The customer enterprise system 115 of the illustrated example includes the entitlement management service 278 to manage licenses granted by manufacturers of SDSi products, such as the manufacturer of the SDSi semiconductor device 105, to configure (e.g., activate, deactivate, etc.) SDSi features implemented by those products. Further details concerning the elements of the customer enterprise system 115 of FIG. 2 are described below.

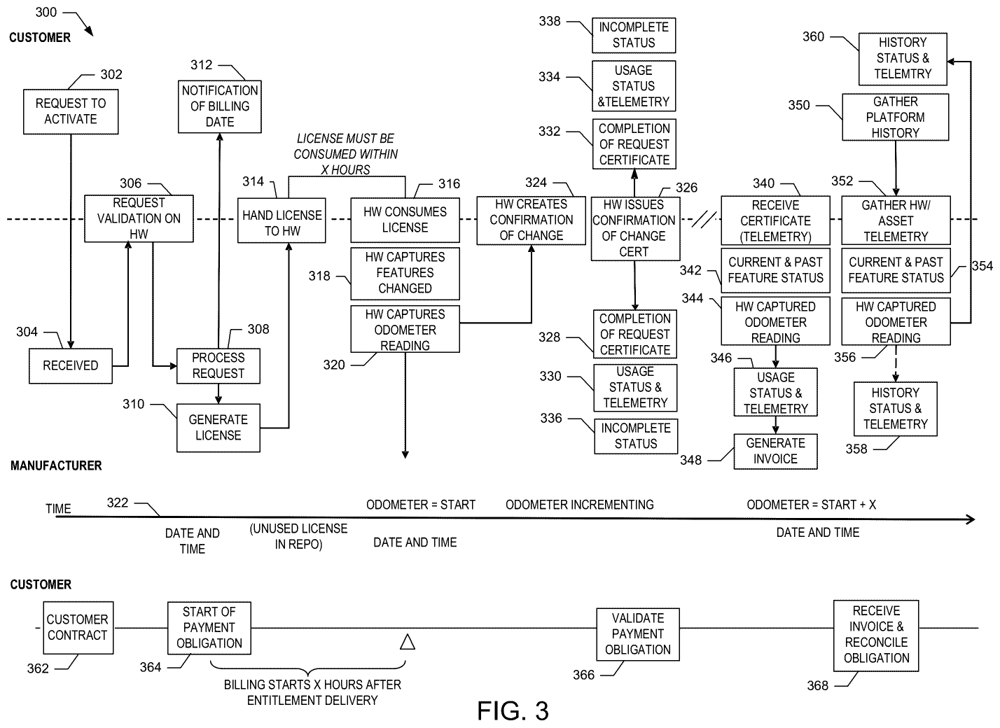

An example SDSi management lifecycle 300 capable of being implemented by the example systems 100 and/or 200 of FIGS. 1-2 is illustrated in FIG. 3. The lifecycle 300 is described from the perspective of activating or deactivating an SDSI feature provided by the SDSi semiconductor device 105, but also can be applied to any type of configuration change of an SDSI feature provided by the SDSi semiconductor device 105. The lifecycle 300 begins at block 302 at which the SDSi client agent 272 of the customer enterprise system 115 sends a request to the SDSi portal 262 of the manufacturer enterprise system 110 to activate (or deactivate) an SDSI feature provided by the SDSi semiconductor device 105. Accordingly, the SDSi portal 262 is an example of means for receiving a request to activate or deactivate a feature provided by the semiconductor device 105. For example, the customer may access a customer management record for the SDSi semiconductor device 105 maintained by the platform inventory management service 274, and modify the customer management record to invoke the SDSi client agent 272 to send the request. Accordingly, the SDSi client agent 272 is an example of means for sending a request to activate or deactivate an SDSi feature provided by the semiconductor device 105. At block 304, the SDSi portal 262 of the manufacturer enterprise system 110 receives the request sent by the SDSi client agent 272 of the customer enterprise system 115 to activate (or deactivate) the SDSI feature provided by the SDSi semiconductor device 105. At block 306, the SDSi agent management interface 264 sends a query to the SDSi asset agent 140 to confirm that the SDSi semiconductor device 105 supports the SDSi feature to be activated (or deactivated). For example, the SDSi feature management service 256 may process the customer request received via the SDSi portal 262 and invoke the SDSi agent management interface 264 to send the query. The agent interface 202 of the SDSi asset agent 140 receives the query and invokes the license processor 214 to generate a response. The license processor 214 analyzes the configuration of the hardware circuitry 125, the firmware 130 and/or the BIOS 135 of the semiconductor device 105, generates feature support verification information indicating whether the queried feature is supported by the semiconductor device 105, and reports, via the agent interface 202, a response including the feature support verification information to the SDSi agent management interface 264. In some examples, rather than querying the SDSi asset agent 140 of the SDSi semiconductor device 105, the SDSi agent management interface 264 accesses one or more databases and/or other data structures (e.g., based on device identifier and/or SKU information included in the feature request) that store specification/configuration data for the SDSi semiconductor device 105 to confirm whether the SDSi semiconductor device 105 supports the requested feature.

At block 308 of the lifecycle 300, the SDSi agent management interface 264 receives the query response from the SDSi asset agent 140 (or from the queries database(s) and/or data structure(s)), which is processed by the SDSi feature management service 256. If the response indicates the SDSi feature of interest is supported by the SDSi semiconductor device 105, at block 310 the SDSi feature management service 256 generates a license to activate (or deactivate) the SDSi feature as requested. Accordingly, the SDSi feature management service 256 is an example of means for generating a license to be processed by the semiconductor device 105 to activate or deactivate an SDSi feature. Also, at block 312, the SDSi feature management service 256 causes the license to be sent via the SDSi portal 262 to the SDSi client agent 272 of the customer enterprise system 115. Accordingly, the SDSi client agent 272 is an example of means for receive a license from an enterprise management system to authorize activation or deactivation of an SDSi feature provided by the semiconductor device 105 In the illustrated example, the license generated at block 310 is associated with a license key and/or license data that specifies, for example, an identifier of the semiconductor device 105, the SDSi feature to be activated (or deactivated), terms of the activation (or deactivation), such as whether this is a one-time feature activation (deactivation) or renewable activation subject to a subscription, a valid start window (e.g., X hours, where X is a numerical value, or some other duration) for invoking the license to activate (or deactivate) the SDSI feature, etc. At this point in the lifecycle 300, the license generated at block 310 is treated as an unused license to activate (or deactivate) the SDSi feature, which is stored in a repository at the customer enterprise system 115 until the customer triggers use of the license to activate (or deactivate) the requested feature. For example, the SDSi feature management service 256 of the manufacturer enterprise system 110 can update a manufacturer management record maintained by the manufacturer for the semiconductor device 105 to include the license and/or license data generated at block 310, Likewise, the entitlement management service 278 of the customer enterprise system 115 can update the customer management record maintained by the customer for the semiconductor device 105 to indicate receipt of the license along with the license details. Accordingly, the entitlement management service 278 is an example of means for updating a management record associated with the semiconductor device 105 based on a license. In some such examples, the entitlement management service 278 can be invoked by the customer to update the customer management record to trigger operation of the license to activate (or deactivate) the SDSi feature, which cause the SDSi client agent 272 of the customer enterprise system 115 to transmit (e.g., download) the license via the network 155 to the SDSi asset agent 140 of the semiconductor device 105.

For example, upon receipt of a request at the SDSi client agent 272 to invoke the license, at block 314 the SDSi client agent 272 sends the license to the SDSi asset agent 140. Accordingly, the SDSi client agent 272 is an example of means for sending a license to the semiconductor device 105. The license is received by the agent interface 202, which at block 316 invokes the license processor 214. At block 316, the license processor 214 processes the license data to identify the feature to be activated (or deactivated), and activates (or deactivates) the feature in accordance with the license data. For example, if the feature is a configurable number of processor cores, and the semiconductor device 105 was initialized to have a first number of the processor cores active (e.g., 2 of 8 cores are active) with remaining ones of the processor cores dormant (e.g., 6 of 8 cores are dormant), the license data may specify that a second number of dormant processor cores (e.g., 4 of the 6 dormant cores) are to be activated (e.g., in response to a request from the customer enterprise system 115 to activate the second number of dormant cores). The license data may also identify which of the dormant cores are to be activated. In such an example, the license processor 214 invokes the agent library 218 to activate the dormant cores specified in the license data. As another example, the SDSi asset agent 140 may later receive a second license from the SDSi client agent 272 of the customer enterprise system 115 that specifies a third number of the active processor cores (e.g., 2 of the 6 active cores) that are to be deactivated (e.g., with the second license being generated by the manufacturer enterprise system 110 in response to a request from the customer enterprise system 115 to deactivate the third number of active cores). The second license data may also identify which of the active cores are to be deactivated. In such an example, the license processor 214 invokes the agent library 218 to deactivate the active cores specified in the license data. In some examples, the license processor 214 may limit the number of cores able to be deactivated to not be greater the second number of dormant cores that were activated based on prior received license data. As yet another example, if the feature is a configurable clock rate, and the semiconductor device was initialized to activate a first clock rate from a set of possible clock rates, the license generated by the manufacturer enterprise system 110 and downloaded via the SDSi client agent 272 of the customer enterprise system 115 may identify a second clock rate different from the first clock rate that is to be activated (e.g., in response to a request from the customer enterprise system 115 to activate the second clock rate). In such an example, the license processor 214 invokes the agent library 218 to activate the second clock rate identified in the license data.

In some examples, a single license can configure multiple features across different feature categories. For example, a single license may include first license data to activate one or more additional cores, and second license to modify and/or otherwise adjust a clock rate of one or more cores. In such an example, the adjusted clock rate may be applied to one or more previously activated cores and/or one(s) of the one or more additional cores to be activated in response to the license processor 214 processing the license. Additionally or alternatively, in some examples, a single license can activate one or more features, and also deactivate one or more other features.

At block 318 of the lifecycle 300, the analytics engine 206 of the SDSi asset agent 140 logs the SDSi feature activation (or deactivation) performed on the semiconductor device 105. At block 320, the analytics engine 206 captures an odometer reading representative of a present, local time maintained by the circuitry 125 (in combination with the firmware 135 and/or BIOS 140) of the semiconductor device 105. For example, the circuitry 125 may utilize a counter, timer or other mechanism to implement an odometer to track the passage of time locally at the semiconductor device 105 (which is represented by the directed line 322 in FIG. 3). At block 320, the analytics engine 206 captures a value of the odometer to act as a timestamp of when the requested feature was activated (or deactivated). At block 324, the analytics engine 206 generates a certificate to confirm the successful activation (or deactivation) of the requested SDSi feature. In the illustrated example, the certificate includes telemetry data associated with operation of the semiconductor device 105 and generated by the analytics engine 206 in response to activation (or deactivation) of the requested SDSi feature. In some examples, the telemetry data includes an indication of whether the feature activation (or deactivation) was a success, a status of the SDSi feature affected by the activation (or deactivation) (e.g., such as the presently configured number of cores that are active, the presently active clock rate, etc.), a first odometer reading (e.g., first timestamp) indicating when the feature activation (or deactivation) occurred, a second odometer reading (e.g., a second timestamp) indicating whether the certificate was generated, etc.

At block 326 of the lifecycle 300, the analytics engine 206 reports, via the agent interface 202, the certificate with the telemetry data in response to the activation (or deactivation) of the SDSi feature based on the received license data. In the illustrated example, the analytics engine 206 reports the certificate with the telemetry data to both the manufacturer enterprise system 110 and the customer enterprise system 115. For example, at block 328, the example SDSi agent management interface 264 of the manufacturer enterprise system 110 receives the certificate, and at block 330 provides it to the SDSi feature management service 256 of the manufacturer enterprise system 110. Accordingly, the SDSi agent management interface 264 is an example of means for receiving a certificate from the semiconductor device 105 to confirm successful activation or deactivation of an SDSi feature. The SDSi feature management service 256 processes the certificate and included telemetry data to log the successful feature activation (or deactivation). Similarly, at block 332, the SDSi client agent 272 of the customer enterprise system 115 receives the certificate and at block 334 provides it to the entitlement management service 278 of the customer enterprise system 115. The entitlement management service 278 processes the certificate and included telemetry data to log the successful feature activation (or deactivation). In the illustrated example, at this point in the lifecycle 300, the status of the feature activation (or deactivation) may be considered incomplete until verified by a subsequent certificate from the SDSi asset agent 140 (see blocks 336 and 338).

At block 340 of the lifecycle 300, the SDSi agent management interface 264 of the manufacturer enterprise system 110 receives a subsequent certificate with updated telemetry data from the SDSi asset agent 140. At block 342, the subsequent certificate is provided to the SDSi feature management service 256 of the manufacturer enterprise system 110. The SDSi feature management service 256 processes the certificate to obtain the updated telemetry data, and also obtains the prior telemetry data included in the previous certificate. At block 344, the SDSi feature management service 256 accesses the odometer readings included in the telemetry data. At block 346, the SDSi feature management service 256 compares the telemetry data and odometer reading to confirm the successful activation (or deactivation) (or, more generally, the successful configuration change) of the SDSi feature of interest. Accordingly, the SDSi feature management service 256 is an example of means for validating the successful activation or deactivation of an SDSi feature based on telemetry data. At block 348, the customer management service 254 of the manufacturer enterprise system 110 generates an invoice for the successful activation (or deactivation) of the SDSi feature of interest, and sends it to the customer enterprise system 115 via the SDSi portal 262 for processing by the accounts management service 276. In some examples, assuming the semiconductor device 105 is associated with a present SKU (e.g., a first SKU), after the requested SDSi feature is activated (or deactivated), the product management service 252 of the manufacturer enterprise system 110 generates a new SKU (e.g., a second SKU) and updates the manufacturer management record maintained for the semiconductor device 105 to associate the new SKU (second SKU) with the semiconductor device 105. Accordingly, the product management service 252 is an example of means for updating a management record to associate a second SKU with the semiconductor device 105 after an SDSi feature is activated or deactivated. Additionally or alternatively, in some examples, assuming the semiconductor device 105 is associated with a present SKU (e.g., a first SKU), after the requested SDSi feature is activated (or deactivated), the platform inventory management service 274 of the customer enterprise system 115 generates a new SKU (e.g., a second SKU) and updates the customer management record maintained for the semiconductor device 105 to associate the new SKU (second SKU) with the semiconductor device 105. Accordingly, the platform inventory management service 274 is an example of means for updating a management record to associate a second SKU with the semiconductor device 105 after an SDSi feature is activated or deactivated.

At block 350 of the lifecycle 300, the entitlement management service 278 of the customer enterprise system 115 generates a request for status of the semiconductor device 105, and sends the request via the SDSi client agent 272 to the SDSi asset agent 140. Additionally or alternatively, the SDSi feature management service 256 of the manufacturer enterprise system 110 could generate the request for status of the semiconductor device 105, and send the request via the SDSi agent management interface 264 to the SDSi asset agent 140. In either case, at block 352, the agent interface 202 receives the request and invokes the analytics engine 206 to generate a certificate in response to the request. In the illustrated example, the certificate includes updated telemetry data associated with operation of the semiconductor device 105 generated by the analytics engine 206 in response to the request. The updated telemetry data is timestamped with a local time corresponding to an odometer reading captured in response to the request. At blocks 354 and 356, the SDSi agent management interface 264 receives the requested certificate with the updated telemetry data from the SDSi asset agent 140 and provides it to the SDSi feature management service 256 of the manufacturer enterprise system 110. The SDSi feature management service 256 obtains the updated telemetry data, and also obtains the prior telemetry data for the semiconductor device 105, and further accesses the odometer readings included in the telemetry data. At block 356, the example SDSi feature management service 256 updates a history of the operational status of the semiconductor device 105 and uses the telemetry data to determine whether the semiconductor device 105 is operating properly.

Similarly, at block 360 of the lifecycle 300, the SDSi client agent 272 receives the requested certificate with the updated telemetry data from the SDSi asset agent 140 and provides it to the entitlement management service 278 of the customer enterprise system 115. The entitlement management service 278 obtains the updated telemetry data, and also obtains any prior telemetry data for the semiconductor device 105, and further accesses the odometer readings included in the telemetry data. The entitlement management service 278 then updates a history of the operational status of the semiconductor device 105 and uses the telemetry data to determine whether the semiconductor device 105 is operating properly. In some examples, the accounts management service 276 of the customer enterprise system 115 updates, based on receipt of the certificate, the customer management record associated with the semiconductor device 105 to confirm establishment or conclusion of a payment obligation with the manufacturer of the semiconductor device 105, such as the payment obligation associated with the invoice received from the manufacturer enterprise system 110 at block 348. Accordingly, the accounts management service 276 is an example of means for updating a management record, based on a certificate, to confirm establishment or conclusion of a payment obligation with a manufacturer of the semiconductor device 105.

As illustrated in the example lifecycle 300 of FIG. 3, the request to activate (or deactivate) the SDSI feature sent by the customer enterprise system 115 at block 302 and received by the manufacturer enterprise system 110 at block 304 can initiate a contract between the customer and the manufacturer. Later, the sending of the license to the customer enterprise system 115 at block 312 can be a trigger to start a payment obligation (see block 364). In some examples, the start of the payment obligation can be delayed until the feature is activated (or deactivated) in the semiconductor device 105 based on the license at block 316. Later, the reporting at block 326 of the certificate in response to the activation (or deactivation) of the SDSi feature in the semiconductor device 105 can validate the payment obligation (see block 366). Later, the generation and receipt of the invoice at block 348 can trigger reconciliation of the payment obligation (see block 368).

The licenses generated by the manufacturer enterprise system 110 to activate (or deactivate) SDSi features in the semiconductor device 105 can support one-time activation, on-demand activation and/or recurring subscription models. For example, the license may include license data to instruct the license processor 214 of the SDSi asset agent 140 executing in the semiconductor device 105 to perform a one-time activation (or deactivation) of one or more features identified by the license data. In some examples, to support on-demand activation and/or recurring subscription models, the license generated by the manufacturer enterprise system 110 can include license data that instructs the license processor 214 to activate (or deactivate) the specified SDSi feature(s) in accordance with an express permit or an express deny control mechanism. For example, under an express permit control mechanism, the license processor 214 causes an SDSi feature that is activated based on the license to be deactivated upon expiration of a time period (e.g., tracked by a counter, clock, or other mechanism) unless an express permit control signal is received from the manufacturer enterprise system 110 (e.g., via the SDSi agent management interface 264) before the time period expires. Conversely, under an express deny control mechanism, the license processor 214 causes an SDSi feature that is activated based on the license to be remain active unless an express deny control signal is received from the manufacturer enterprise system 110 (e.g., via the SDSi agent management interface 264). In such an example, receipt of the express deny control signal causes the license processor 214 to deny access to the activated feature, such as, by deactivating the feature.

In some examples, the license processor 214 of the SDSi asset agent 140 executing in the semiconductor device 105 activates and deactivates SDSI features through the use of reprogrammable soft fuse(s), register(s), logic gate(s), etc. For example, such reprogrammable soft fuse(s), register(s), logic gate(s), etc., can be connected to control lines of the hardware blocks included in the hardware circuitry 125 of the semiconductor device 105 to implement the SDSi features, connected to control inputs read by the firmware 130 and/or BIOS 135 to enable/disable the SDSi features, etc. The license processor 214 can set and/or reset ones of the reprogrammable soft fuse(s), values of the register(s), input(s) of the logic gate(s), etc., to activate/deactivate different SDSi features of the semiconductor device 105.

In some examples, the license processor 214 writes received license(s) and/or the license data included therein to a protected license memory region of the semiconductor device 105. In some examples, the license data is encrypted and the license processor 214 decrypts the license data before writing it to the protected license memory region of the semiconductor device 105. In some such examples, SDSi feature activation/deactivation responsive to a received license does not occur until the semiconductor device 105 reboots (e.g., via a soft reset, a hard reset, etc.) and the license data in the protected license memory region is read upon start-up. In some examples, the license processor 214 sets one or more particular locations of the protected license memory region to activate one or more SDSi features, and erases or overwrites the license data contained in those location(s) of the protected license memory region to deactivate those SDSi feature(s). For example, to deactivate a given SDSi feature, the license processor 214 may write random or otherwise garbage data to the location(s) associated with that feature in the protected license memory region, and rely on an error checking capability of the semiconductor device 105 that causes the given SDSi feature to remain disabled in response to such random or otherwise garbage data.

In some examples, the location(s) of the protected license memory region for deactivated SDSi feature(s) is(are) not erased or overwritten. Rather, in some such examples, to deactivate an SDSi feature, a deactivation license is appended to the list of licenses already stored in the protected license memory region for that SDSi feature. The newly received deactivation license in such an example overrides the actions of previously received licenses for that SDSi feature. In that way, the history of SDSi configuration operations (activations and deactivations) performed on the SDSi feature are stored by the semiconductor device 105 in the order the SDSi licenses were applied. In some examples, this information could be read by the customer.

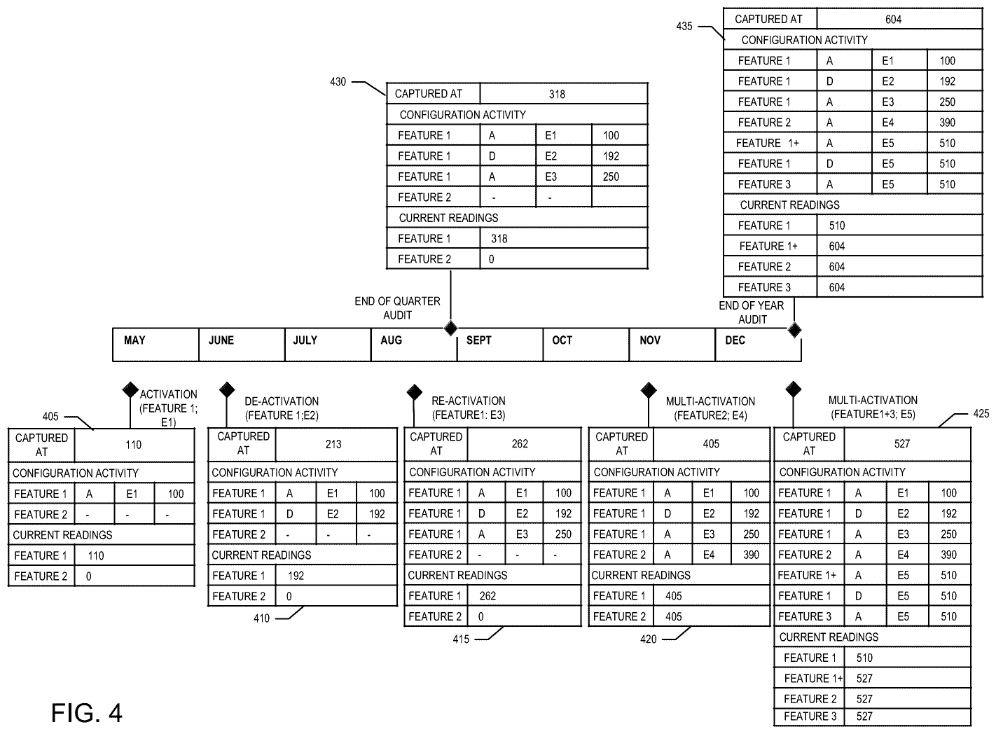

Example certificates utilized in the example systems 100 and/or 200 of FIGS. 1-2 to implement the example lifecycle 300 of FIG. 3 are illustrated in FIG. 4. In the illustrated example of FIG. 4, the SDSi asset agent 140 associated with the semiconductor device 105 generates and reports a first example certificate 405 to the manufacturer enterprise system 110 and/or the customer enterprise system 115 in response to a first event (labeled “E1” in FIG. 4). The first event corresponds to activation of a first SDSi feature of the semiconductor device 105 (labeled “Feature 1” in FIG. 4). In the illustrated example, the first certificate 405 identifies the first SDSi feature (“Feature 1”) and includes telemetry data. The telemetry data of the first certificate 405 indicates an activated status (labeled “A” in FIG. 4) for the first SDSi feature (“Feature 1”), and includes a first timestamp (e.g., first odometer reading) having a value of “100,” which represents a local time at which the first SDSi feature (“Feature 1”) was activated in the semiconductor device 105. The telemetry data of the first certificate 405 also indicates that another available SDSi feature (labeled “Feature 2” in FIG. 4) is dormant. The telemetry data of the first certificate 405 further includes a second timestamp (e.g., second odometer reading) having a value of “110,” which represents a local time at which the first certificate 405 was generated.

In the illustrated example of FIG. 4, the SDSi asset agent 140 associated with the semiconductor device 105 generates and reports a second example certificate 410 to the manufacturer enterprise system 110 and/or the customer enterprise system 115 in response to a second event (labeled “E2” in FIG. 4). The second event corresponds to deactivation of the first SDSi feature of the semiconductor device 105 (labeled “Feature 1” in FIG. 4). In the illustrated example, the second certificate 410 identifies the first SDSi feature (“Feature 1”) and includes updated telemetry data (in addition to the telemetry data included in the first certificate 405). The updated telemetry data of the second certificate 410 indicates a deactivated status (labeled “D” in FIG. 4) for the first SDSi feature (“Feature 1”), and includes a third timestamp (e.g., third odometer reading) having a value of “192,” which represents a local time at which the first SDSi feature (“Feature 1”) was deactivated in the semiconductor device 105. The updated telemetry data of the second certificate 410 also indicates that another available SDSi feature (labeled “Feature 2” in FIG. 4) is still dormant. The updated telemetry data of the second certificate 410 further includes a fourth timestamp (e.g., fourth odometer reading) having a value of “213,” which represents a local time at which the second certificate 410 was generated.

In the illustrated example of FIG. 4, the SDSi asset agent 140 associated with the semiconductor device 105 generates and reports a third example certificate 415 to the manufacturer enterprise system 110 and/or the customer enterprise system 115 in response to a third event (labeled “E3” in FIG. 4). The third event corresponds to re-activation of the first SDSi feature of the semiconductor device 105 (labeled “Feature 1” in FIG. 4). In the illustrated example, the third certificate 415 identifies the first SDSi feature (“Feature 1”) and includes updated telemetry data (in addition to the telemetry data included in the prior certificates 405 and 410). The updated telemetry data of the third certificate 415 indicates an activated status (labeled “A” in FIG. 4) for the first SDSi feature (“Feature 1”), and includes a fifth timestamp (e.g., fifth odometer reading) having a value of “250,” which represents a local time at which the first SDSi feature (“Feature 1”) was re-activated in the semiconductor device 105. The updated telemetry data of the third certificate 415 also indicates that another available SDSi feature (labeled “Feature 2” in FIG. 4) is still dormant. The updated telemetry data of the third certificate 415 further includes a sixth timestamp (e.g., sixth odometer reading) having a value of “262,” which represents a local time at which the third certificate 415 was generated.

In the illustrated example of FIG. 4, the SDSi asset agent 140 associated with the semiconductor device 105 generates and reports a fourth example certificate 420 to the manufacturer enterprise system 110 and/or the customer enterprise system 115 in response to a fourth event (labeled “E4” in FIG. 4). The fourth event corresponds to activation of a second SDSi feature of the semiconductor device 105 (labeled “Feature 2” in FIG. 4). In the illustrated example, the fourth certificate 420 identifies the second SDSi feature (“Feature 2”) and includes updated telemetry data (in addition to the telemetry data included in the prior certificates 405-415). The updated telemetry data of the fourth certificate 420 indicates an activated status (labeled “A” in FIG. 4) for the second SDSi feature (“Feature 2”), and includes a seventh timestamp (e.g., seventh odometer reading) having a value of “390,” which represents a local time at which the second SDSi feature (“Feature 2”) was activated in the semiconductor device 105. The updated telemetry data of the fourth certificate 420 further includes an eighth timestamp (e.g., eighth odometer reading) having a value of “405,” which represents a local time at which the fourth certificate 420 was generated.

In the illustrated example of FIG. 4, the SDSi asset agent 140 associated with the semiconductor device 105 generates and reports a fifth example certificate 425 to the manufacturer enterprise system 110 and/or the customer enterprise system 115 in response to a fifth event (labeled “E5” in FIG. 4). The fifth event corresponds to modification of the first SDSi feature (labeled “Feature 1+” in FIG. 4), and activation of a third SDSi feature of the semiconductor device 105 (labeled “Feature 3” in FIG. 4). In the illustrated example, the fifth certificate 425 identifies the modified first SDSi feature (“Feature 1+”) and the third SDSi feature (“Feature 3”), and includes updated telemetry data (in addition to the telemetry data included in the prior certificates 405-420). The updated telemetry data of the fifth certificate 425 indicates an activated status (labeled “A” in FIG. 4) for the modified first SDSi feature (“Feature 1+”), a de-activated status (labeled “D” in FIG. 4) for the prior version of the first SDSi feature (“Feature 1”), and an activated status (labeled “A” in FIG. 4) for the third SDSi feature (“Feature 3). The updated telemetry data includes a ninth timestamp (e.g., ninth odometer reading) having a value of “510,” which represents a local time at which the modified first SDSi feature (“Feature 1+”) was activated, the prior version of the first SDSi feature (“Feature 1”) was deactivated, and the third SDSi feature (“Feature 3”) was activated in the semiconductor device 105. The updated telemetry data of the fifth certificate 425 further includes a tenth timestamp (e.g., tenth odometer reading) having a value of “527,” which represents a local time at which the fifth certificate 425 was generated.

In the illustrated example of FIG. 4, the SDSi asset agent 140 associated with the semiconductor device 105 generates and reports a sixth example certificate 430 to the manufacturer enterprise system 110 and/or the customer enterprise system 115 in response to a first status request from the manufacturer enterprise system 110 and/or the customer enterprise system 115. In the illustrated example, the sixth certificate 430 identifies the status history of the SDSi features provided by the semiconductor device 105. For example, the sixth certificate 430 includes status and corresponding telemetry data to log the activation and de-activation events for the first SDSi feature (“Feature 1”) that occurred up to the time of the status request. The telemetry data of the sixth certificate 430 further includes a timestamp (e.g., odometer reading) having a value of “318,” which represents a local time at which the sixth certificate 430 was generated.

In the illustrated example of FIG. 4, the SDSi asset agent 140 associated with the semiconductor device 105 generates and reports a seventh example certificate 435 to the manufacturer enterprise system 110 and/or the customer enterprise system 115 in response to a second status request from the manufacturer enterprise system 110 and/or the customer enterprise system 115. In the illustrated example, the seventh certificate 435 identifies the status history of the SDSi features provided by the semiconductor device 105. For example, the seventh certificate 435 includes status and corresponding telemetry data to log the activation and de-activation events for the first SDSi feature (“Feature 1”), the modified first feature (Feature 1+”), the second feature (Feature 2”) and the third feature (Feature 3”) that occurred up to the time of the status request. The telemetry data of the seventh certificate 435 further includes a timestamp (e.g., odometer reading) having a value of “604,” which represents a local time at which the seventh certificate 435 was generated.

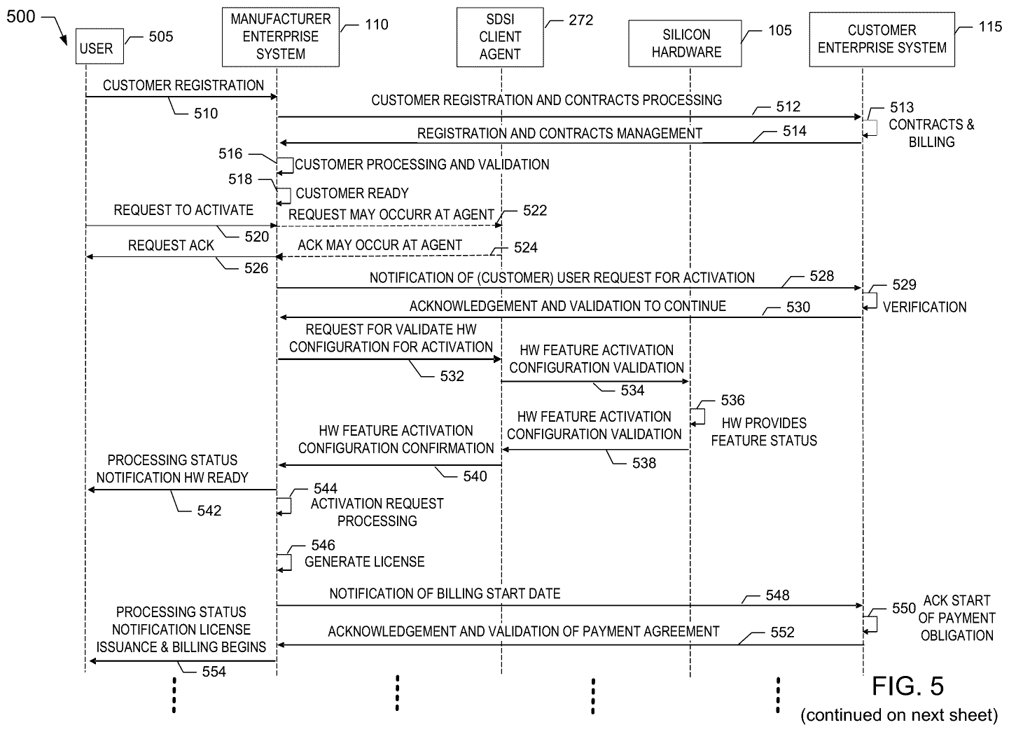

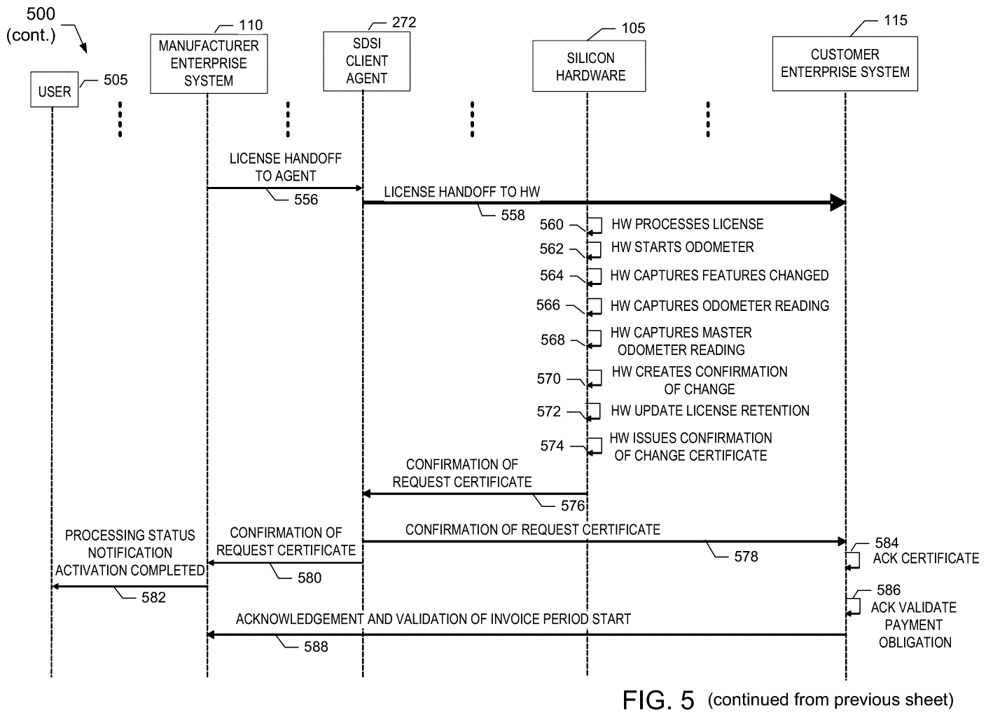

An example process flow 500 performed by the example systems 100 and/or 200 of FIGS. 1-2 to enable initial feature activation in the SDSi product 105 is illustrated in FIG. 5. The process flow 500 of the illustrated example begins with an example user 505 associated with a customer requesting registration of the customer for access to SDSi capabilities offered by a manufacturer of the SDSi product 105 (line 510). The manufacturer enterprise system 110 then engages with the customer enterprise system 115 to on-board the customer (lines 512-518). The manufacturer enterprise system 110 then receives a request to activate an SDSi feature of the SDSi product 105 and acknowledges the request (lines 520-526). As shown in the illustrated example, the feature activation request can be received from a source (e.g., computer device) separate from the customer enterprise system 115 or from the SDSi client agent 272 of the customer enterprise system 115. In the illustrated example, the manufacturer enterprise system 110 further confirms with the customer enterprise system 115 that the SDSi feature activation request is valid (lines 528-530).

Assuming the SDSi feature activation request is valid, the manufacturer enterprise system 110 queries the SDSi product 105 to determine whether the requested SDSi feature to be activated is supported by the SDSi product 105 (lines 532-542). In the illustrated example, the manufacturer enterprise system 110 sends the query to the SDSi client agent 272 of the customer enterprise system 115, which queries the SDSi product 105 for the status of the requested SDSi feature and returns a response to the manufacturer enterprise system 110. However, in other examples, the manufacturer enterprise system 110 queries the SDSi product 105 without involving the SDSi client agent 272 or, more generally, the customer enterprise system 115. For example, the SDSi agent management interface 264 of the manufacturer enterprise system 110 may send a query to the SDSi product 105 for the status of the requested SDSi feature and receive a response from the SDSi product 105.

Assuming the requested SDSi feature is supported, the manufacturer enterprise system 110 generates a license to activate the requested SDSi feature in the SDSi product 105 (lines 544-546). The manufacturer enterprise system 110 also communicates with the customer enterprise system 115 to establish billing terms and other contractual obligations associated with activation of the requested SDSi feature (lines 548-554). The manufacturer enterprise system 110 then sends the generated license to the SDSi client agent 272 of the customer enterprise system 115 (line 556). Sometime later (e.g., when the customer is ready for the requested feature to be activated), the SDSi client agent 272 sends the license to the SDSi asset agent 140 of the SDSi product 105 (line 558). The SDSi asset agent 140 invokes the license processor 214 to process the received license to activate the requested SDSi feature (line 560). The license processor 214 invokes the analytics engine 206 to capture one or more odometer readings (lines 562-568), and then creates a confirmation certificate to confirm activation of the requested feature (lines 570-574).

The SDSi asset agent 140 of the SDSi product 105 then reports the confirmation certificate to the manufacturer enterprise system 110 and the customer enterprise system 115 (e.g., via the SDSi client agent 272 in the illustrated example) (lines 576-580. The manufacturer enterprise system 110 and the customer enterprise system 115 process the received confirmation certificate, and the customer enterprise system 115 validates the start of a payment obligation responsive to activation of the requested SDSi feature (lines 582-588).

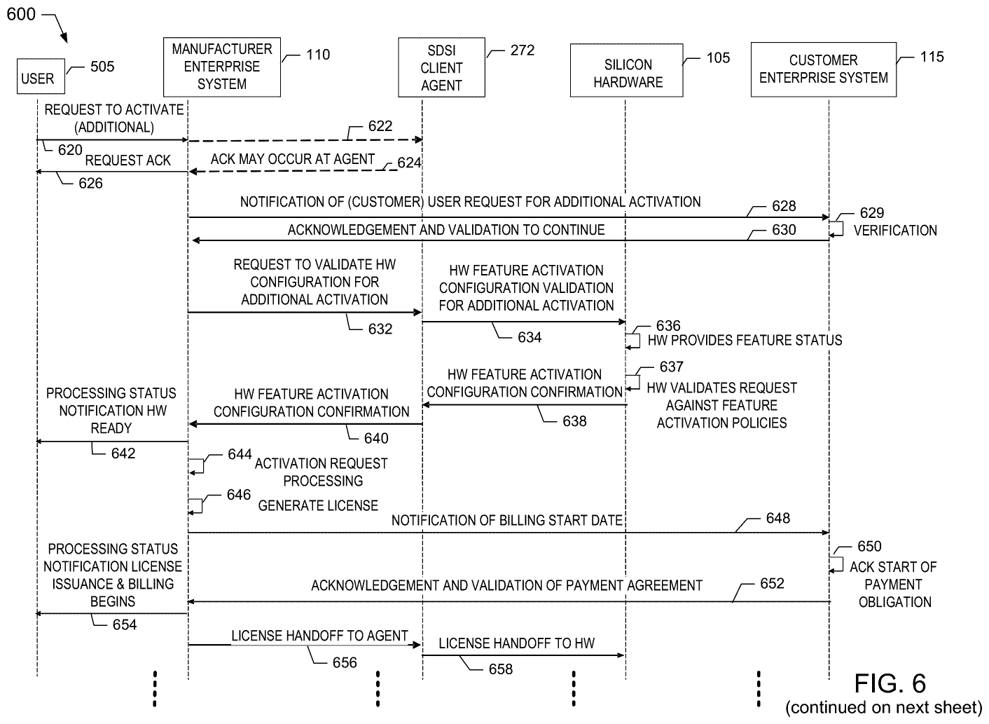

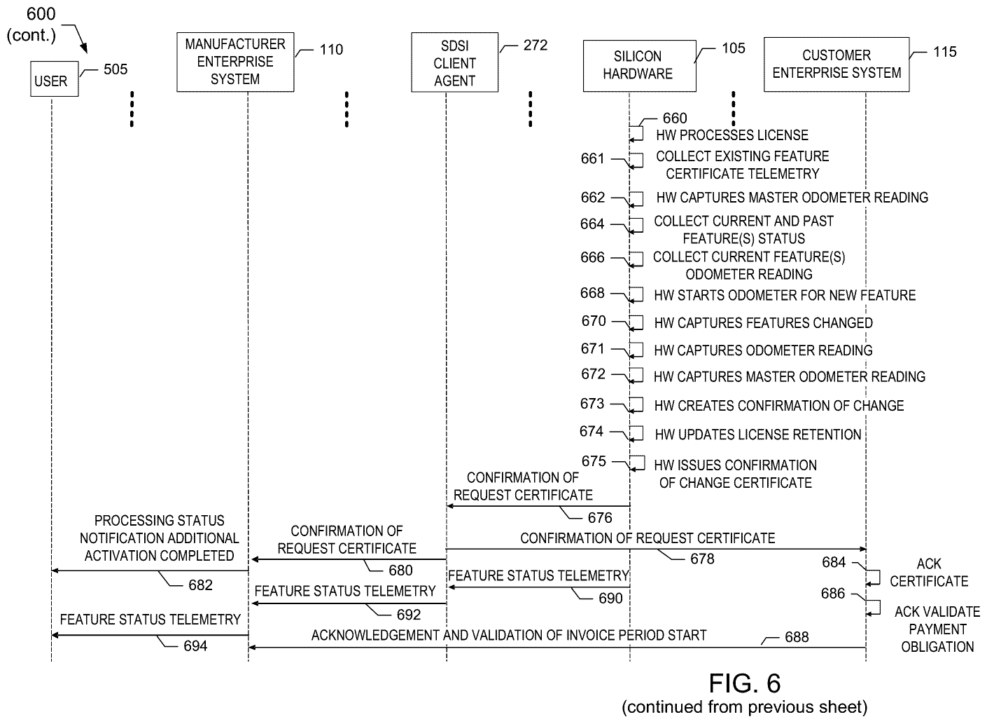

An example process flow 600 performed by the example systems 100 and/or 200 of FIGS. 1-2 to enable additional feature activation in the SDSi product 105 is illustrated in FIG. 6. The process flow 600 of the illustrated example begins with the manufacturer enterprise system 110 receiving a request from the user 505 to activate an additional SDSi feature of the SDSi product 105 and acknowledging the request (lines 620-626). As shown in the illustrated example, the additional feature activation request can be received from a source (e.g., computer device) separate from the customer enterprise system 115 or from the SDSi client agent 272 of the customer enterprise system 115. In the illustrated example, the manufacturer enterprise system 110 further confirms with the customer enterprise system 115 that the additional SDSi feature activation request is valid (lines 628-630).

Assuming the additional SDSi feature activation request is valid, the manufacturer enterprise system 110 queries the SDSi product 105 to determine whether the additional requested SDSi feature to be activated is supported by the SDSi product 105 (lines 632-642). In the illustrated example, the manufacturer enterprise system 110 sends the query to the SDSi client agent 272 of the customer enterprise system 115, which queries the SDSi product 105 for the status of the requested SDSi feature and returns a response to the manufacturer enterprise system 110. However, in other examples, the manufacturer enterprise system 110 queries the SDSi product 105 without involving the SDSi client agent 272 or, more generally, the customer enterprise system 115. For example, the SDSi agent management interface 264 of the manufacturer enterprise system 110 may send a query to the SDSi product 105 for the status of the requested SDSi feature and receive a response from the SDSi product 105. In the illustrated example, in addition to checking whether the requested feature is supported, the SDSi product 105 also validates the activation request against other policies (line 637). For example, such policies may confirm that the additional SDSi feature to be activated will not conflict with an earlier SDSi feature that was activated.

Assuming the requested additional SDSi feature is supported, the manufacturer enterprise system 110 generates a license to activate the additional SDSi feature in the SDSi product 105 (lines 644-646). The manufacturer enterprise system 110 also communicates with the customer enterprise system 115 to establish billing terms and other contractual obligations associated with activation of the additional SDSi feature (lines 648-654). The manufacturer enterprise system 110 then sends the generated license to the SDSi client agent 272 of the customer enterprise system 115 (line 656). Sometime later (e.g., when the customer is ready for the additional feature to be activated), the SDSi client agent 272 sends the license to the SDSi asset agent 140 of the SDSi product 105 (line 658). The SDSi asset agent 140 invokes the license processor 214 to process the received license to activate the requested SDSi feature (line 660). The license processor 214 also invokes the analytics engine 206 to collect telemetry data for the SDSi features of the SDSi product 105 (line 661) and capture one or more odometer readings (lines 662-672), and then creates a confirmation certificate to confirm activation of the requested feature (lines 673-675).

The SDSi asset agent 140 of the SDSi product 105 then reports the confirmation certificate to the manufacturer enterprise system 110 and the customer enterprise system 115 (e.g., via the SDSi client agent 272 in the illustrated example) (lines 676-680. The manufacturer enterprise system 110 and the customer enterprise system 115 process the received confirmation certificate, and the customer enterprise system 115 validates the start of a payment obligation responsive to activation of the requested SDSi feature (lines 682-688). In the illustrated example, the SDSi asset agent 140 of the SDSi product 105 also reports SDSi feature status telemetry (e.g., included in subsequent certificates) to the manufacturer enterprise system 110 (e.g., via the SDSi client agent 272 in the illustrated example) (lines 690-694).

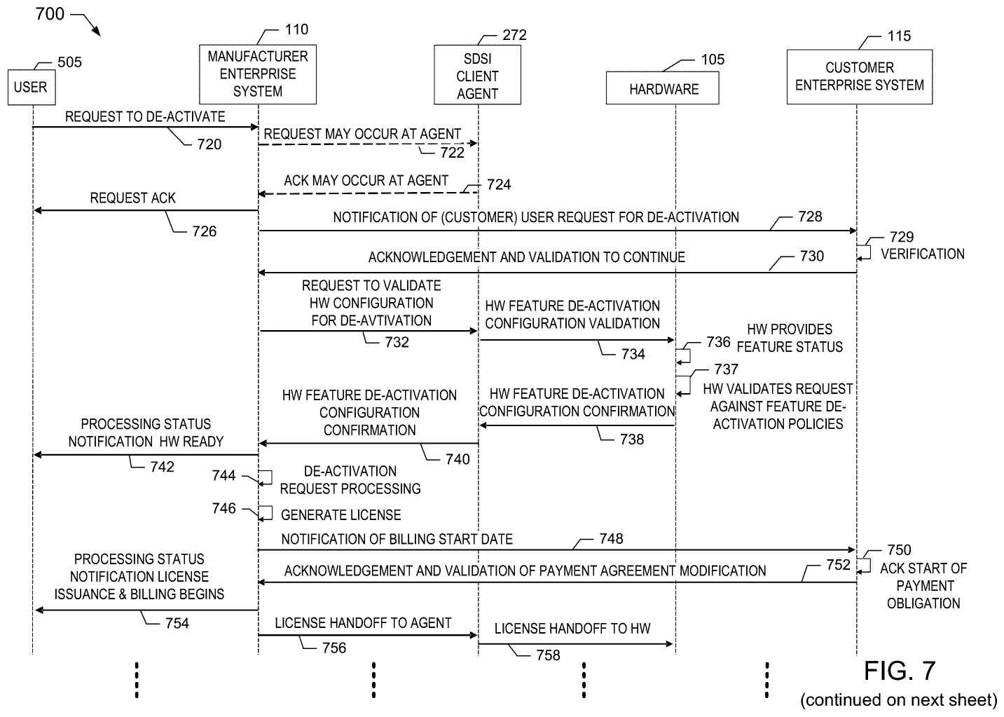

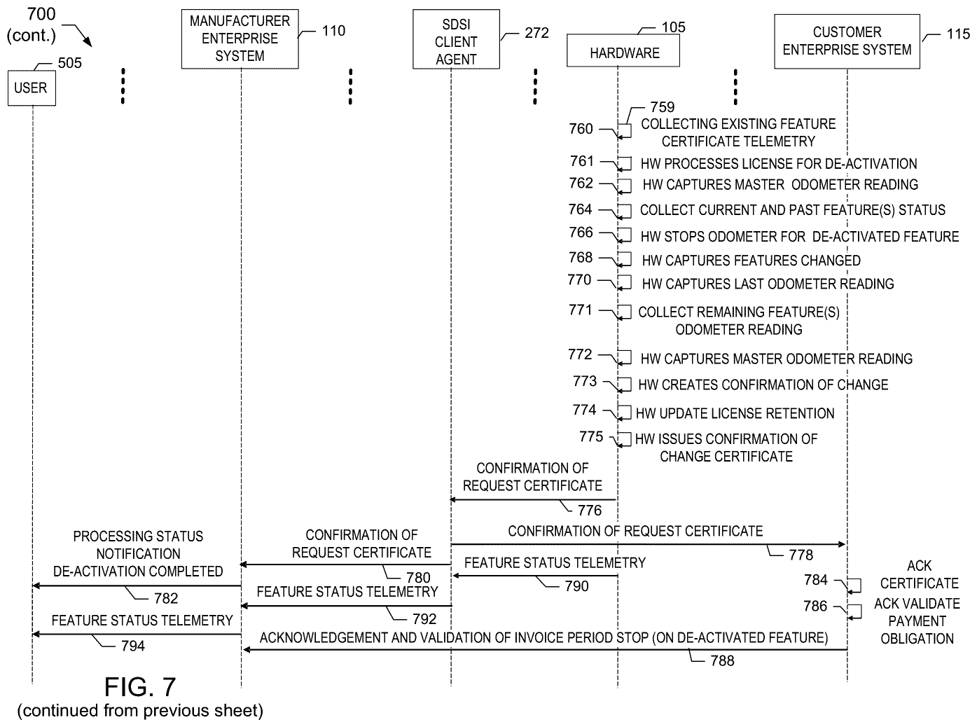

An example process flow 700 performed by the example systems 100 and/or 200 of FIGS. 1-2 to enable feature deactivation in the SDSi product 105 is illustrated in FIG. 7. The process flow 700 of the illustrated example begins with the manufacturer enterprise system 110 receiving a request from the user 505 to deactivate an SDSi feature of the SDSi product 105 and acknowledging the request (lines 720-726). As shown in the illustrated example, the feature deactivation request can be received from a source (e.g., computer device) separate from the customer enterprise system 115 or from the SDSi client agent 272 of the customer enterprise system 115. In the illustrated example, the manufacturer enterprise system 110 further confirms with the customer enterprise system 115 that the SDSi feature deactivation request is valid (lines 728-730).

Assuming the SDSi feature deactivation request is valid, the manufacturer enterprise system 110 queries the SDSi product 105 to determine whether the requested SDSi feature to be deactivated is supported by the SDSi product 105 (lines 732-742). In the illustrated example, the manufacturer enterprise system 110 sends the query to the SDSi client agent 272 of the customer enterprise system 115, which queries the SDSi product 105 for the status of the requested SDSi feature and returns a response to the manufacturer enterprise system 110. However, in other examples, the manufacturer enterprise system 110 queries the SDSi product 105 without involving the SDSi client agent 272 or, more generally, the customer enterprise system 115. For example, the SDSi agent management interface 264 of the manufacturer enterprise system 110 may send a query to the SDSi product 105 for the status of the requested SDSi feature and receive a response from the SDSi product 105. In the illustrated example, in addition to checking whether the requested feature is supported, the SDSi product 105 also validates the deactivation request against other policies (line 737). For example, such policies may confirm that the SDSi feature to be deactivated will not cause a conflict with remaining active SDSi features, will not violate a specified base SDSi feature state for SDSi product 105, etc.

Assuming the SDSi feature to be deactivated is supported, the manufacturer enterprise system 110 generates a license to deactivate the SDSi feature in the SDSi product 105 (lines 744-746). The manufacturer enterprise system 110 also communicates with the customer enterprise system 115 to establish billing terms and other contractual obligations associated with deactivation of the SDSi feature (lines 748-754). The manufacturer enterprise system 110 then sends the generated license to the SDSi client agent 272 of the customer enterprise system 115 (line 756). Sometime later (e.g., when the customer is ready for the feature to be deactivated), the SDSi client agent 272 sends the license to the SDSi asset agent 140 of the SDSi product 105 (line 758). The SDSi asset agent 140 invokes the analytics engine 206 to collect telemetry data for the SDSi product 105 before feature deactivation (line 759), and then invokes the license processor 214 to process the received license to deactivate the requested SDSi feature (line 760). The analytics engine 206 also captures one or more odometer readings and collects telemetry data for the remaining active SDSi features of the SDSi product 105 (lines 762-774), which are used by the license processor 214 to create a confirmation certificate to confirm deactivation of the requested feature (lines 775).

The SDSi asset agent 140 of the SDSi product 105 then reports the confirmation certificate to the manufacturer enterprise system 110 and the customer enterprise system 115 (e.g., via the SDSi client agent 272 in the illustrated example) (lines 776-780. The manufacturer enterprise system 110 and the customer enterprise system 115 process the received confirmation certificate, and the customer enterprise system 115 validates the start of a payment obligation responsive to deactivation of the requested SDSi feature (lines 782-788). In the illustrated example, the SDSi asset agent 140 of the SDSi product 105 also reports SDSi feature status telemetry (e.g., included in subsequent certificates) to the manufacturer enterprise system 110 (e.g., via the SDSi client agent 272 in the illustrated example) (lines 790-794).

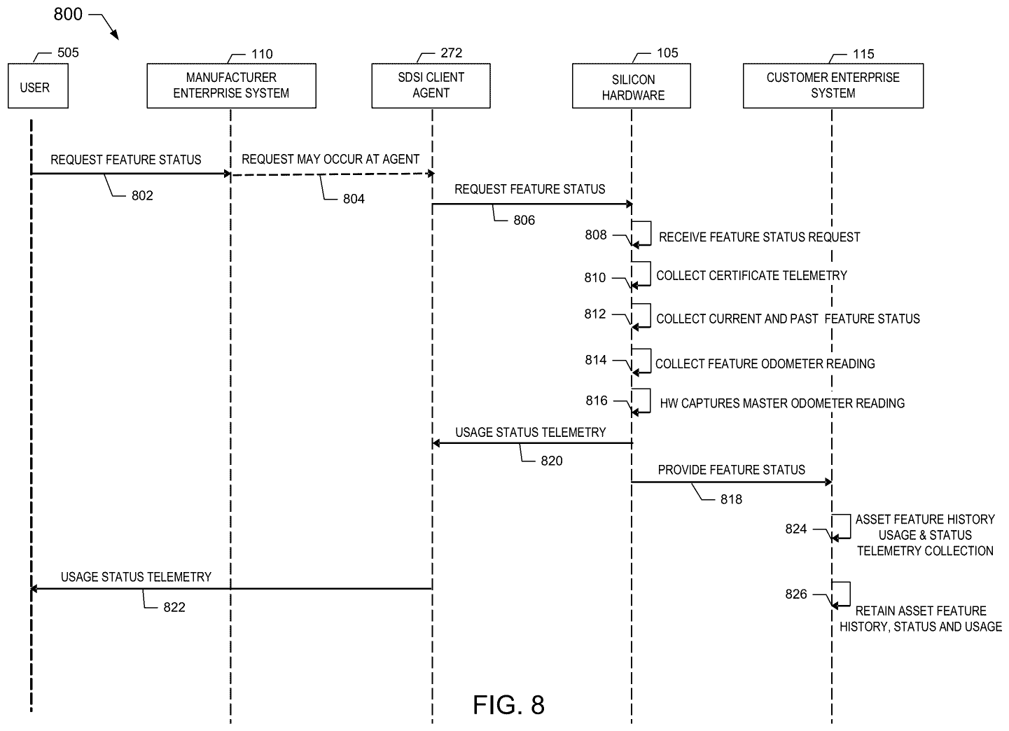

An example process flow 800 performed by the example systems 100 and/or 200 of FIGS. 1-2 to provide customer-initiated feature usage status and billing reconciliation is illustrated in FIG. 8. The process flow 800 of the illustrated example begins with the manufacturer enterprise system 110 receiving a request from the user 505 for SDSi feature status of the SDSi product 105 (lines 802-804). As shown in the illustrated example, the additional feature activation request can be received from a source (e.g., computer device) separate from the customer enterprise system 115, or can be received at the SDSi client agent 272 thereby bypassing the manufacturer enterprise system 110. In the illustrated example, the feature status request is received by the SDSi client agent 272, which sends the request to the SDSi asset agent 140 of the SDSi product 105 (line 806). In response to the feature status request, the SDSi asset agent 140 invokes the analytics engine 206 to collect telemetry data, current and past feature status, and odometer readings (lines 808-816). The SDSi asset agent 140 the reports the SDSi feature status of the SDSi product 105 to the customer enterprise system 115 (line 818), and more detailed telemetry status to the manufacturer enterprise system 110 (lines 820-822). In the illustrated example, the customer enterprise system 115 collects the SDSi feature status data from the SDSi product 105 and retains the status to perform feature usage status and billing reconciliation (lines 824-826).

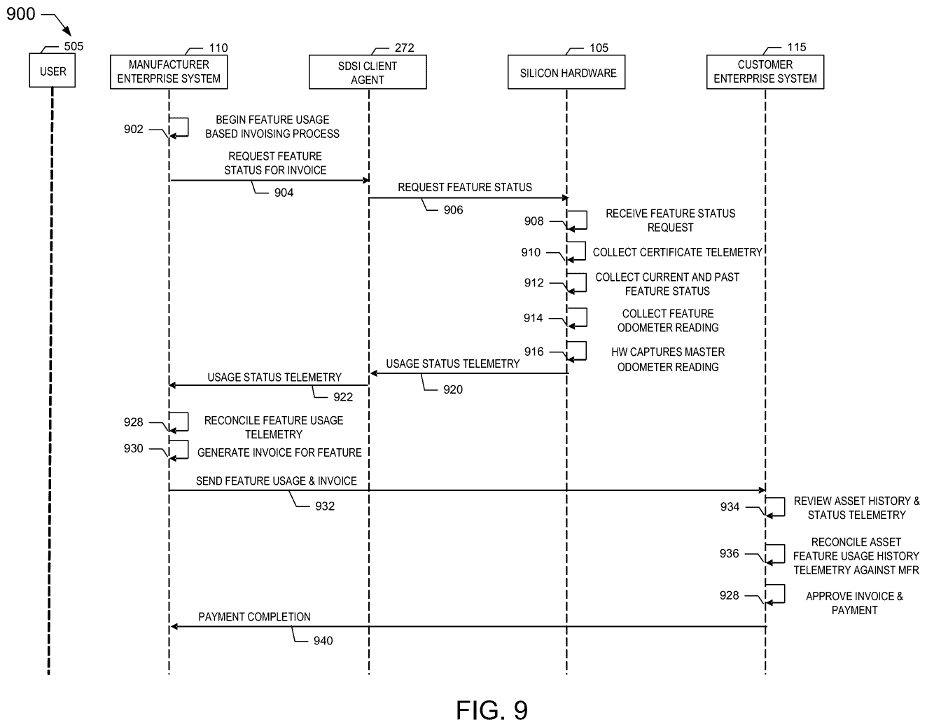

An example process flow 900 performed by the example systems 100 and/or 200 of FIGS. 1-2 to provide manufacturer-initiated feature usage status and billing reconciliation is illustrated in FIG. 9. The process flow 900 of the illustrated example begins with the manufacturer enterprise system 110 beginning an invoicing process based on SDSi feature usage associated with the SDSi product 105 (line 902). The manufacturer enterprise system 110 then send a request for SDSi feature status of the SDSi product 105 (line 904). In the illustrated example, the feature status request is received by the SDSi client agent 272, which sends the request to the SDSi asset agent 140 of the SDSi product 105 (line 906). In response to the feature status request, the SDSi asset agent 140 invokes the analytics engine 206 to collect telemetry data, current and past feature status, and odometer readings (lines 908-916). The SDSi asset agent 140 the reports the SDSi feature status and telemetry to the manufacturer enterprise system 110 (lines 920-922). In the illustrated example, the manufacturer enterprise system 110 uses the SDSi feature status data and telemetry from the SDSi product 105 to perform feature usage status and billing, and sends an invoice to the customer enterprise system 115 (lines 928-932). The customer enterprise system 115 then reconciles the invoice against stored SDSI feature status and telemetry for the SDSi product 105, approves payment, and sends payment (or a payment completion record) to the manufacturer enterprise system 110 (lines 934-940).

Although the examples of FIGS. 1-9 are illustrated as including a single SDSi silicon product 105 (SDSi semiconductor device 105), a single manufacturer enterprise system 110 in associated with a single cloud platform 120, and a single customer enterprise system 115, SDSi frameworks and architectures as disclosed herein are not limited thereto. For example, any number(s) and/or type(s) of SDSi silicon products 105 (SDSi semiconductor devices 105) can be configured and managed in the example systems 100 and 200 described above. Additionally or alternatively, any number of manufacturer enterprise systems 110 and/or cloud platforms 120 can be included in the systems 100 and 200 described above to manage respective SDSi silicon products 105 (SDSi semiconductor devices 105) manufactured by different silicon manufacturers. Additionally or alternatively, any number of client enterprise systems 115 can be included in the systems 100 and 200 described above to manage SDSi silicon products 105 (SDSi semiconductor devices 105) purchased by different customers (e.g., OEMs). Also, in some examples, the client enterprise systems 115 can include multiple SDSi client agents 272. For example, the client enterprise systems 115 can configure different SDSi client agents 272 to manage different groups of one or more SDSi products 105.

While example manners of implementing the systems 100 and 200 are illustrated in FIGS. 1-9, one or more of the elements, processes and/or devices illustrated in FIGS. 1-9 may be combined, divided, re-arranged, omitted, eliminated and/or implemented in any other way. Further, the example silicon product 105 (e.g., the example semiconductor device 105), the example manufacturer enterprise system 110, the example customer enterprise system 115, the example cloud platform 120, the example SDSi asset agent 140, the example agent interface 202, the example agent local services 204, the example analytics engine 206, the example communication services 208, the example agent CLI 210, the example agent daemon 212, the example license processor 214, the example agent library 218, the example feature libraries 220-230, the example product management service 252, the example customer management service 254, the example SDSi feature management service 256, the example SDSi portal 262, the example SDSi agent management interface 264, the example SDSi client agent 272, the example platform inventory management service 274, the example accounts management service 276, the example entitlement management service 278 and/or, more generally, the systems 100 and/or 200 of FIGS. 1-9 may be implemented by hardware, software, firmware and/or any combination of hardware, software and/or firmware. Thus, for example, any of the example silicon product 105 (e.g., the example semiconductor device 105), the example manufacturer enterprise system 110, the example customer enterprise system 115, the example cloud platform 120, the example SDSi asset agent 140, the example agent interface 202, the example agent local services 204, the example analytics engine 206, the example communication services 208, the example agent CLI 210, the example agent daemon 212, the example license processor 214, the example agent library 218, the example feature libraries 220-230, the example product management service 252, the example customer management service 254, the example SDSi feature management service 256, the example SDSi portal 262, the example SDSi agent management interface 264, the example SDSi client agent 272, the example platform inventory management service 274, the example accounts management service 276, the example entitlement management service 278 and/or, more generally, the systems 100 and/or 200 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)), field programmable gate arrays (FPGAs) and/or field programmable logic device(s) (FPLD(s)). When reading any of the apparatus or system claims of this patent to cover a purely software and/or firmware implementation, at least one of the example systems 100 and/or 200, the example silicon product 105 (e.g., the example semiconductor device 105), the example manufacturer enterprise system 110, the example customer enterprise system 115, the example cloud platform 120, the example SDSi asset agent 140, the example agent interface 202, the example agent local services 204, the example analytics engine 206, the example communication services 208, the example agent CLI 210, the example agent daemon 212, the example license processor 214, the example agent library 218, the example feature libraries 220-230, the example product management service 252, the example customer management service 254, the example SDSi feature management service 256, the example SDSi portal 262, the example SDSi agent management interface 264, the example SDSi client agent 272, the example platform inventory management service 274, the example accounts management service 276 and/or the example entitlement management service 278 is/are hereby expressly defined to include a non-transitory computer readable storage device or storage disk such as a memory, a digital versatile disk (DVD), a compact disk (CD), a Blu-ray disk, etc. including the software and/or firmware. Further still, the example systems 100 and/or 200 may include one or more elements, processes and/or devices in addition to, or instead of, those illustrated in FIGS. 1-9, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

Protection Against Misuse of Software Defined Silicon

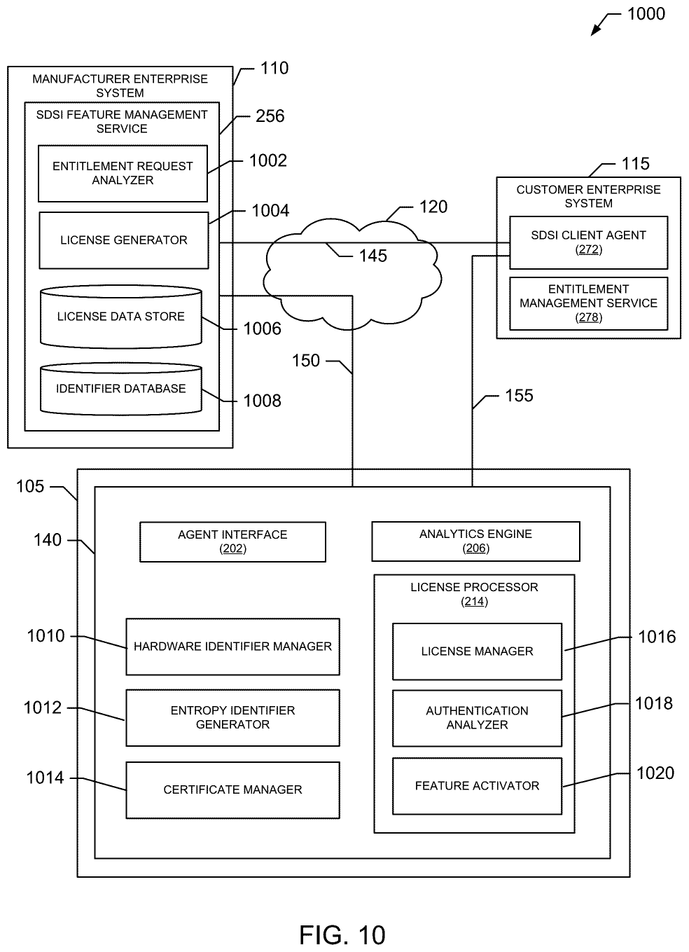

FIG. 10 is a block diagram 1000 of an example system to implement protection against misuse of software-defined silicon in accordance with teachings of this disclosure. The block diagram 1000 of FIG. 10 includes the example semiconductor device 105, the example manufacturer enterprise system 110, the example customer enterprise system 115, the example cloud platform 120, the example SDSi asset agent 140, and the example connections 145, 150, and 155 of FIGS. 1 and 2.

In the illustrated example of FIG. 10, the example SDSi feature management service 256 of the example manufacturer enterprise system 110 includes an example entitlement request analyzer 1002, an example license generator 1004, an example license data store 1006, and an example identifier database 1008. Further, in the illustrated example of FIG. 10, the example SDSi asset agent 140 includes an example hardware identifier manager 1010, an example entropy identifier generator 1012, and an example certificate manager 1014. In the illustrated example of FIG. 10, the example license processor 214 includes an example license manager 1016, an example authentication analyzer 1018, and an example feature activator 1020.

The example entitlement request analyzer 1002 of the illustrated example of FIG. 10 processes entitlement requests to determine whether one or more license(s) should be granted for feature adjustments. As used herein, entitlement requests refer to requests to activate, deactivate, etc., SDSi features of an asset, such as the semiconductor device 105. In some examples, an entitlement refers to an authorization to activate, deactivate, etc., one or more SDSi features of an asset, and a license refers to data and/or other things that cause activation, deactivation, etc., on the asset of the one or more SDSi features for which an entitlement has been granted. For example, the entitlement request analyzer 1002 can process an entitlement request received from the customer enterprise system 115 via the cloud platform 120. If the entitlement request analyzer 1002 determines that the entitlement request should be granted, the entitlement request analyzer 1002 can cause the license generator 1004 to generate a license to communicate to the customer enterprise system 115. If the entitlement request analyzer 1002 determines that the entitlement request should not be granted (e.g., based on the entitlement request not adhering to an entitlement rule, based on a state of the asset, etc.), the entitlement request analyzer 1002 can communicate a rejection of the entitlement request to the customer enterprise system 115. In some examples, the entitlement request analyzer 1002 may communicate (e.g., directly, via the network, etc.) a response to the SDSi asset agent 140.

In some examples, in response to receiving an entitlement request, the entitlement request analyzer 1002 determines a state of the asset for which a feature entitlement is being requested. As used herein, a state refers to a set of features and/or capabilities of an asset. In some examples, the entitlement request analyzer 1002 determines a base state for the asset. As used herein, a base state is an initial configuration for the asset when it is received by a customer (e.g., when ownership was last transferred). For example, the customer enterprise system 115 can request an entitlement for a feature to be activated or deactivated on the semiconductor device 105. The entitlement request analyzer 1002, in response to receiving the entitlement request, can determine the identity of the semiconductor device associated with the request (the semiconductor device 105 in the illustrated example of FIG. 10), and retrieve a base state for the semiconductor device.

In some examples, the entitlement request analyzer 1002 determines the base state of the semiconductor device 105 based on base state information stored in the license data store 1006. In some examples, the entitlement request analyzer 1002 determines a customer identity associated with the entitlement request. For example, the entitlement request analyzer 1002 can determine the customer identity based on an address (e.g., an Internet Protocol (IP) address) associated with the entitlement request and/or based on a credential associated with the entitlement request. In some examples, the entitlement request analyzer 1002 can determine whether the customer making the entitlement request is different from a customer that made a prior entitlement request. In some examples, the entitlement request analyzer 1002 determines the identity of a customer making an entitlement request based on an authentication key (e.g., a cryptographic key). For example, the entitlement request may be signed with a public identification key that belongs to a specific customer. The entitlement request analyzer 1002 can determine the base state of the semiconductor device 105 by looking the base state up using the public key (e.g., in the license data store 1006).

In some examples, the entitlement request analyzer 1002 sets (e.g., updates, stores, etc.) the base state for the semiconductor device 105. The entitlement request analyzer 1002 can store the base state along with an identifier corresponding to the semiconductor device 105 in the license data store 1006 and/or any other storage location accessible to the entitlement request analyzer 1002. For example, in response to receiving an entitlement request from a customer different than the customer associated with the prior entitlement request for the semiconductor device 105, the entitlement request analyzer 1002 can determine that a transfer of ownership has occurred, and set the base state based on the currently active features of the semiconductor device 105. In some examples, the entitlement request analyzer 1002 sets the base state for the semiconductor device 105 based on a completion certificate. In some such examples, the completion certificate is received at the manufacturing enterprise system 110 after execution of a license. In some examples, the completion certificate is received at the entitlement request analyzer 1002 along with a new entitlement request. A completion certificate (also referred to herein as a status certificate and/or certificate of completion) indicates the current state of the semiconductor device 105, such as which features are active, and which licenses have been executed (e.g., to enable/disable features).

The entitlement request analyzer 1002 analyzes the entitlement request in view of one or more rules. For example, if the manufacturer wishes to avoid deactivation of already activated features by subsequent owners of the semiconductor device 105, the entitlement request analyzer 1002 can reject entitlement requests that request deactivation of features that were enabled in the most recent base state. In some examples, the entitlement request analyzer 1002 can determine whether a customer has paid a specific fee (e.g., a recurring subscription fee, a one-time fee) associated with access to a feature and thereby determine whether to issue a license for the feature. In some examples, the entitlement request analyzer 1002 may be able to approve entitlement requests for features based on other features which are enabled (e.g., as represented in the base state) and/or based on a customer status (e.g., a subscriber status, a customer level, etc.). For example, some features may be sub-features of others, indicating that entitlements for these features can be granted if the master feature with which they are associated is already activated in the base state. In some examples, in addition to or alternatively to communicating with the license generator 1004 to generate a license when an entitlement is approved, the entitlement request analyzer 1002 may communicate with other components of the manufacturer enterprise system 110 to cause other changes to occur when an entitlement is approved. For example, a financial charge may be scheduled to enable the manufacturer to receive a payment for the feature that is being activated in response to the entitlement request.

The example license generator 1004 of the illustrated example of FIG. 10 generates license corresponding to activation or deactivation of features on the semiconductor device 105. In some examples, the license generator 1004 communicates licenses via the cloud network 120 to the semiconductor device 105. In some examples, the license generator 1004 communicates licenses to the customer enterprise system 115 to thereafter be provided to the semiconductor device 105. In some examples, the license is passed via proxy entities corresponding to the source of the entitlement request. For example, if a first enterprise system sent an entitlement request to a second enterprise system which then forwarded it to the manufacturer, the license may similarly be traversed through the proxy (e.g., sent to the second enterprise system and then to the first enterprise system). In some such examples, the license generator 1004 can use asymmetric cryptography to sign the license such that only the intended recipient can execute the license and enable the features. For example, the license generator 1004 may encrypt the license with a public key provided with the entitlement request. In some such examples, the semiconductor device 105 then utilizes the private key to decrypt the license and allow execution of the license.

In some examples, the example license generator 1004 of the illustrated example of FIG. 10 appends one or more identifiers along with the license communicated to the semiconductor device 105 to ensure that the license is executed on the intended asset. For example, the license generator 1004 can access one or more hardware identifiers from the identifier database 1008. The identifiers may be hardware based (e.g., based on fuses of the semiconductor device 105, based on physical characteristics of the hardware of the semiconductor device 105, etc.) and/or entropy-based (e.g., based on a physically-unclonable function, based on ambient noise, based on quantum noise, etc.).

The example license data store 1006 of the illustrated example of FIG. 10 stores information corresponding to licenses that can be, or have been, issued to semiconductor devices or other silicon assets, such as the semiconductor device 105. In some examples, the license data store 1006 includes one or more logs including historical data regarding licenses that have been executed on semiconductor devices. For example, the license data store 1006 can list licenses that have been executed, features that are activated, the most recent and/or any prior base states, or any other information that can be utilized by the entitlement request analyzer 1002 and/or the license generator 1004 to make entitlement decisions and/or to generate licenses. In some examples, the license data store 1006 and/or the identifier database 1008 may be implemented as a single database. For example, the hardware identifiers and/or entropy-based identifiers can be stored in association with base state information, feature activation/deactivation information, rule information, and/or other information useful for making entitlement decisions and generating licenses. In some examples, the entitlement request analyzer 1002 updates the base state of the semiconductor device 105 upon detecting a change in ownership by updating the base state associated with an identifier of the semiconductor device 105 in the license data store 1006.

The example identifier database 1008 of the illustrated example of FIG. 10 stores identification information corresponding to semiconductor devices (such as the semiconductor device 105). In some examples, the identification information may be a hardware identifier (e.g., associated with a fuse or other physical component on the semiconductor device 105). In some examples, the identification information stored in the identifier database 1008 may include a serial number, a SKU number, and/or any other unique identifier of the semiconductor device 105. In some examples, the identifier database 1008 includes entropy-based hardware identifiers that are generated while the semiconductor device 105 is still possessed by the manufacturer enterprise system 110. For example, at a time prior to sale of the semiconductor device 105 by the manufacturer, the entropy identifier generator 1012 can generate an identifier based on a physically unclonable function (PUF), based on ambient noise, analog noise, and/or any other repeatable source of entropy, and transmit the identifier to be stored in the license data store 1006 of the manufacturer enterprise system 110. In such examples, the entropy-based identifier can be utilized to reliably identify the semiconductor device 105 since the entropy-based identifier cannot be generated by any other device (it is a unique and unclonable identifier).

The example hardware identifier manager 1010 of the illustrated example of FIG. 10 stores and/or accesses a hardware identifier specific to the semiconductor device 105. For example, the hardware identifier manager 1010 may include one or more fuses which are unique to the semiconductor device 105. In some such examples, by reading values associated with the one or more fuses, a unique hardware identifier can be determined. In some examples, the hardware identifier manager 1010 determines the hardware identifier of the semiconductor device 105 based on one or more other physical aspects of the semiconductor device 105 (e.g., a characteristic of the circuitry, a physically unclonable function, internal CPU FLASH etc.). The hardware identifier manager 1010 can be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory, etc.). The hardware identifier manager 1010 can additionally or alternatively be implemented by one or more double data rate (DDR) memories, such as DDR, DD11, DD12, mobile DDR (mDDR), etc. The hardware identifier manager 1010 can additionally or alternatively be implemented by one or more mass storage devices such as hard disk drive(s), compact disk drive(s) digital versatile disk drive(s), etc. While, in the illustrated example, the hardware identifier manager 1010 is illustrated as a single database, the hardware identifier manager 1010 can be implemented by any number and/or type(s) of databases. Furthermore, the data stored in the hardware identifier manager 1010 can be in any data format such as, for example, binary data, comma delimited data, tab delimited data, structured query language (SQL) structures, etc.

The example entropy identifier generator 1012 of the illustrated example of FIG. 10 generates an entropy-based identifier for the semiconductor device 105. In some examples, the entropy-based identifier is generated using a PUF such that the output of the PUF uniquely corresponds to the semiconductor 105. For example, a PUF can provide a unique output based on unique manufacturing characteristics of the semiconductor device 105, such that another semiconductor device cannot replicate the same output as the semiconductor device 105. In some examples, the entropy-based identifier may be based on an ambient noise level on the semiconductor device 105. In some examples, the unique output of the PUF is passed through a hash function or a key derivation function (KDF) to obtain an additional unique value as an additional level of protection. The entropy-based identifier output by the entropy identifier generator 1012 can be shared without concern for privacy, as the unique generation characteristics of this identifier make it immune to replication by bad actors. Thus, entitlement requests can be transmitted with the entropy-based value without the need for additional protection to prevent other semiconductor devices from replicating the semiconductor device 105 of the illustrated example and attempting to utilize a license intended for the semiconductor device 105 of the illustrated example. In some examples, the entropy-based identifier generated by the entropy identifier generator 3912 is stored in association with (e.g., in combination with) the hardware identifier generated by the hardware identifier manager 1010. In some examples, the entropy identifier generator 1012 communicates the entropy-based identifier to the manufacturer enterprise system 110 (e.g., to be stored in the identifier database 1008).

The example certificate manager 1016 of the illustrated example of FIG. 10 stores and/or accesses completion certificates associated with execution of licenses by the license processor 214 of the semiconductor device 105, as described above. For example, the certificate manager may include data storage to store completion certificates generated by the license processor 214. In some examples, the certificate manager 1014 generates completion certificates in response to the license processor 214 executing a license. In some examples, the customer enterprise system 115 accesses certificates managed by the certificate manager 1014 to communicate the certificates to the manufacturer enterprise system 110. For example, the customer enterprise system 115 may communicate the latest completion certificate to the manufacturer enterprise system 110 to enable determination of the base state for the semiconductor device 105. Completion certificates may include features active on the semiconductor device 105, event logs pertaining to changes of features on the semiconductor device 105, and/or usage logs pertaining to usage of features on the semiconductor device 105. In some examples, the feature activator 1020 generates completion certificates and communicates them to the certificate manager.

The example license manager 1016 of the illustrated example of FIG. 10 accesses licenses to be executed on the semiconductor device 105. For example, the license manager 1016 can receive licenses provided by the license generator 1004 to the customer enterprise system 115. For example, the license manager 1016 can receives a license from the SDSi client agent 272 of the customer enterprise system 115, as described above. In some examples, the license manager 1016 includes storage to store a license for subsequent execution. In some examples, the license manager 1016 can determine whether a license is intended for execution on the semiconductor device 105 by comparing one or more identifiers associated with the license to one or more identifiers of the semiconductor device 105 (e.g., the hardware identifier managed by the hardware identifier manager 1010, the entropy-based identifier generated by the entropy identifier generator 1012, etc.).

In some examples, the license manager 1016 can determine whether a license can be executed on the semiconductor device 105 based on a version number associated with the license. In some such examples, the license manager 1016 further manages a version number associated with the semiconductor device 105 and increments the version number of the asset (e.g., semiconductor device 105) when licenses are executed. Thus, when licenses are generated (e.g., at the license generator 1004), they can include a version number that is higher than the last known version number of the semiconductor device 105. Thus, the license manager 1016 can utilize the version number of the license to ensure that it is a higher version number than that associated with the semiconductor device 105. For example, if a license is requested at a first time, and then stored by the license manager 1016 while other changes are made (e.g., other features are activated/deactivated at the semiconductor device 105), the version number of the semiconductor device 105 may be higher than or equal to the license number and prevent the license from being executed. In some examples, the license manager 1016 stores a list of licenses which have been executed on the semiconductor device 105. In some such examples, the license manager 1016 compares a license identifier of a license to be executed with identifiers on the list of licenses previously executed. If the license has already been executed (the license identifier is found on the list of licenses previously executed), the licenses can be invalidated (e.g., deleted, corrupted, etc.). In some examples, the license manager 1016 communicates invalid license events (e.g., attempts to execute a license that has previously been executed, attempts to execute a license with an outdated version number, etc.) to the manufacturer enterprise system 110.

The authentication analyzer 1018 of the illustrated example of FIG. 10 analyzes authentication information associated with licenses and/or authentication information communicated by the customer enterprise system 115. In some examples, licenses may be signed using an authentication key. For example, asymmetric cryptography can be utilized to sign a license with the private portion of an authentication key specific to a customer, and the public portion of the authentication key can be utilized to verify the signature and execute the license. In some such examples, the authentication analyzer 1018 determines whether a current owner's public key (e.g., a public key provided by the customer enterprise system 115) can be utilized to verify and execute a license. In response to the public key not being able to verify and/or execute the license, the authentication analyzer 1018 can determine it is not intended for execution by the current owner (the owner associated with the customer enterprise system 115). In some examples, the authentication analyzer 1018 stores authentication information (e.g., public authentication keys) corresponding to specific customers. While some examples herein discuss asymmetric cryptography as a means of authentication, any authentication technique may be utilized by the authentication analyzer 1018.

In some examples, the authentication analyzer 1018 may be utilized to sign completion certificates and/or base state information using an authentication key. For example, the authentication analyzer 1018 can sign a completion certificate with an authentication key corresponding to a specific customer, such that when the completion certificate is received by the manufacturer enterprise system 110, base state information can be determined and stored in association with the identity of the customer enterprise system 115 and the identity of the semiconductor device 105. Further, signing of the completion certificate and/or base state information prevents alteration by another entity and clearly enables the customer enterprise system 115 to set the base state prior to transferring ownership to another entity.

The example feature activator 1020 of the illustrated example of FIG. 10 executes one or more license(s) and causes features to be activated and/or deactivated in accordance with the license(s). In some examples, the feature activator 1020 communicates features which have been activated and/or deactivated to the certificate manager 1014 enable generation of a completion certificate. In some examples, the feature activator 1020 generates a completion certificate and communicates the completion certificate to the certificate manager 1014. In some examples, the feature activator 1020 can deactivate features by changing them to an unusable mode or configuration.

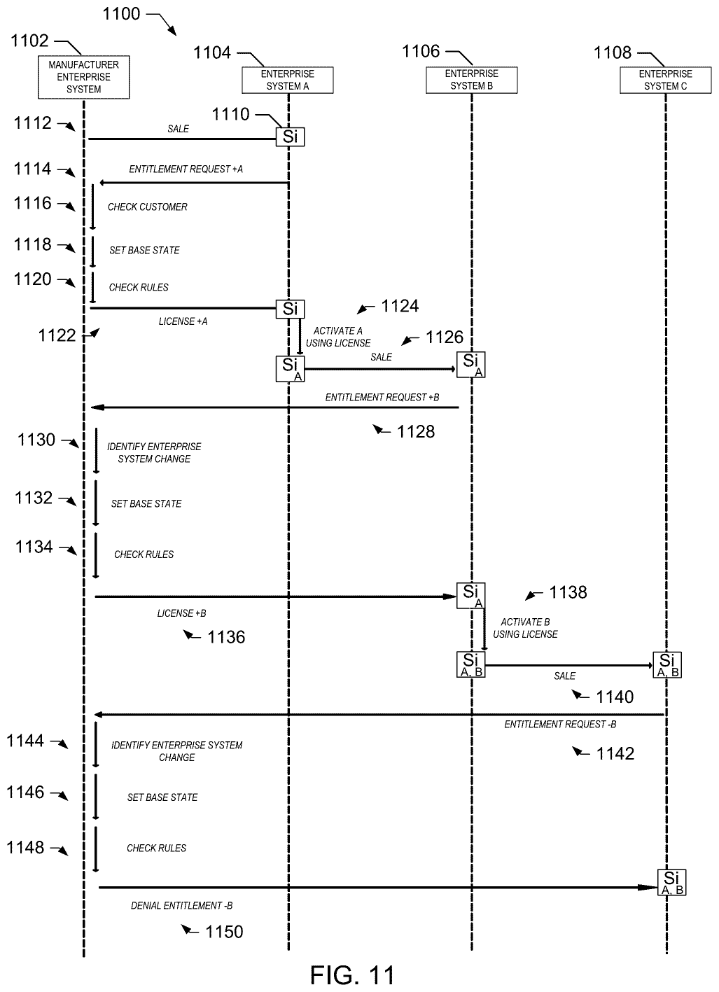

FIG. 11 illustrates a first example process flow 1100 performed by the example system 1000 of FIG. 10 to process entitlement requests. The example process flow 1100 illustrates interactions by and between an example manufacturer enterprise system 1102, an example enterprise system A 1104, an example enterprise system B 1106, and an example enterprise system C 1108. The processor flow 1100 further includes an example asset 1110. For example, the manufacturer enterprise system 1102 may be the manufacturer enterprise system 110 of FIG. 10, and the asset 1110 may be the semiconductor device 105. The example enterprise system A 1104, the example enterprise system B 1106 and the example enterprise system C 1108 may correspond to different example instances of the customer enterprise system 115 of FIG. 10.

At operation 1112, the example manufacturer enterprise system 1102 sells the asset 1110 to the enterprise system A 1104. In some examples, ownership may be transferred in another way (e.g., without a sale, via a lease, etc.).

At operation 1114, the example enterprise system A 1104 communicates an entitlement request to activate feature “A” of the asset 1110 to the manufacturer enterprise system 1102. As used throughout the process flow diagrams 1100, 1200, 1300, 1400 of FIGS. 11-14, features are referred to using letters as symbols to represent features for brevity. In some examples, the entitlement management server 278 of FIG. 10 communicates the entitlement request to the manufacturer enterprise system 110 via the SDSi client agent 272 and the cloud platform 120.

At operation 1116, the example manufacturer enterprise system 1102 checks the customer who requested the entitlement request. For example, the manufacturer enterprise system 1102 can determine the identity of the customer associated with the enterprise system A 1104 based on an identifier communicated with the entitlement request, via an authentication key, and/or via other information made accessible to the manufacturer enterprise system 1102. In some examples, the entitlement request analyzer 1002 determines the identity of the customer associated with the enterprise system A 1104.

At operation 1118, the example manufacturer enterprise system 1102 sets the base state for the asset 1110. In some examples, the entitlement request analyzer 1002 sets the base state for the asset 1110.

At operation 1120, the example manufacturer enterprise system 1102 checks rules associated with entitlement requests to determine whether the entitlement request for activation of feature “A” should be granted. In some examples, the entitlement request analyzer 1002 checks rules associated with entitlement requests to determine whether the entitlement request for activation of feature “A” should be granted.

At operation 1122, the example manufacturing enterprise system 1102 generates a license to activate feature “A” and communicates the license to the enterprise system A 1104, which provides the license (e.g., via its SDSi client agent 272) to the asset 1110.

At operation 1124, the example asset 1110 activates feature “A” by executing the license.

At operation 1126, the example enterprise system A 1104 sells and/or transfers ownership of the asset 1110 to the enterprise system B 1106. The enterprise system B 1106 receives the asset with feature “A” activated.

At operation 1128, the example enterprise system B 1106 communicates an entitlement request to activate feature “B” to the manufacturer enterprise system 1102.

At operation 1130, the example manufacturer enterprise system 1102 identifies that the enterprise system which requested the entitlement (enterprise system B 1106) is different from the prior enterprise system which requested an entitlement (enterprise system A 1104). For example, the entitlement request analyzer 1002 may identify the change in enterprise system.

At operation 1132, the example manufacturer enterprise system 1102 sets the base state of the asset in response to identifying the transfer in ownership (in operation 1130). For example, the base state may be stored in the license data store 1006.

At operation 1134, the example manufacturer enterprise system 1102 checks the entitlement request against one or more rules. For example, the entitlement request analyzer 1002 may determine whether the entitlement request attempts to deactivate any features that were previously active in the base state.

At operation 1136, the example manufacturer enterprise system 1102 issues a license to activate feature “B” and communicates the license to the enterprise system B 1106, which provides the license (e.g., via its SDSi client agent 272) to the asset 1110. For example, the license generator 1004 may generate the license.

At operation 1138, the example asset 1110 activates feature “B” using the license. In some examples, the license processor 214 executes the license to activate feature “B.”

At operation 1140, ownership of the example asset 1110 is transferred from the enterprise system B 1106 to the enterprise system C 1108.

At operation 1142, the example enterprise system C 1108 issues an entitlement request to deactivate feature “B” and communicates the entitlement request to the manufacturer enterprise system 1102.

At operation 1144, the example manufacturer enterprise system 1102 identifies a change in the enterprise system making the request (enterprise system C 1108) relative to the prior entitlement request handled at the manufacturer enterprise system 1102.

At operation 1146, the example manufacturer enterprise system 1102 sets the base state for the asset 1110. In some examples, the manufacturer enterprise system 1102 sets the base state in response to identifying the change in the enterprise system making the request.

At operation 1148, the example manufacturer enterprise system 1102 checks the entitlement request against one or more rules. For example, the entitlement request analyzer 1002 may determine whether the entitlement request attempts to deactivate any features that were previously active in the base state.

At operation 1150, the example manufacturer enterprise system 1102 denies the entitlement request to deactivate feature “B.” For example, the entitlement request analyzer 1002 can determine that the entitlement request would deactivate a feature previously active in the base state and deny the request. The manufacturer enterprise system 1102 communicates the denial of the entitlement request to the enterprise system C 1108.

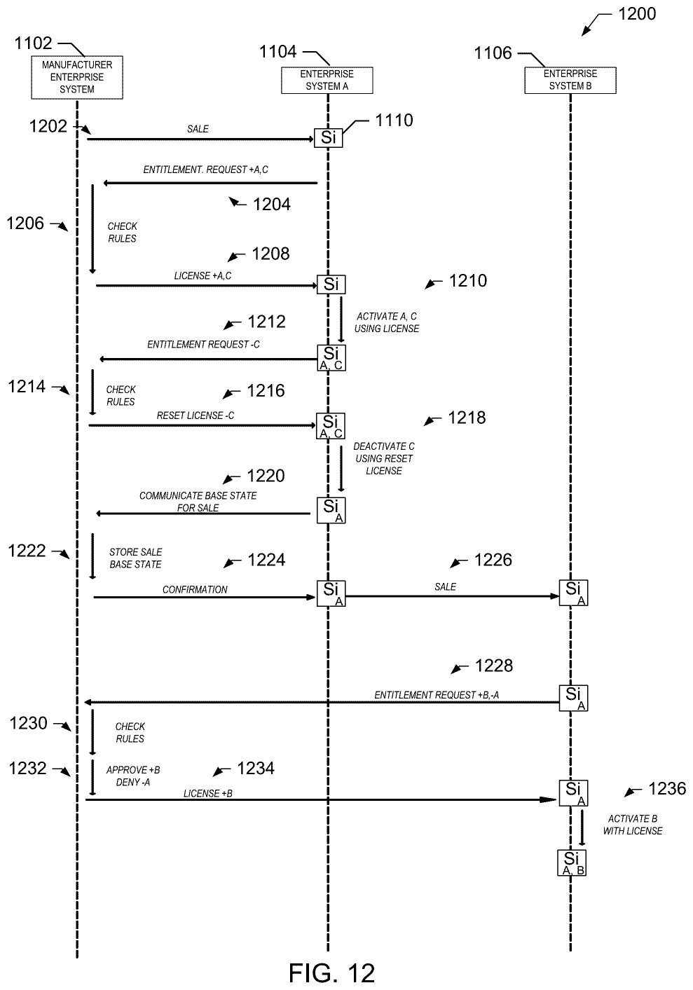

FIG. 12 illustrates an example second example process flow 1200 performed by the example system 1000 of FIG. 10 to process entitlement requests while setting a base state before a time of sale. The second process flow 1200 includes the manufacturer enterprise system 1102, the enterprise system A 1104, the enterprise system B 1106, and the asset 1110.

At operation 1202, the example manufacturer enterprise system 1102 transfers ownership of the asset 1110 to the enterprise system A 1104.

At operation 1204, the example enterprise system A 1104 submits an entitlement request for features “A” and “C” to the manufacturer enterprise system 1102.

At operation 1206, the example manufacturer enterprise system 1102 checks the entitlement request against one or more rules. In some examples, the entitlement request analyzer 1002 checks the entitlement request against one or more rules.

At operation 1208, the example manufacturer enterprise system 1102 issues a license for features “A” and “C” and communicates the license to the enterprise system A 1104, which provides the license (e.g., via its SDSi client agent 272) to the asset 1110. In some examples, the license generator 1004 generates and/or communicates the license.

At operation 1210, the example asset 1110 activates features “A” and “C” using the license. For example, the license processor 214 may execute the license and activate features “A” and “C”.

At operation 312, the example enterprise system A 1104 submits an entitlement request to deactivate feature “C” to the manufacturer enterprise system 1102.

At operation 314, the example manufacturer enterprise system 1102 checks the entitlement request against one or more rules.

At operation 316, the example manufacturer enterprise system 1102 issues a reset license to the enterprise system A 1104 to deactivate feature “C.” In some examples, the license generator 1004 issues the reset license in response to the entitlement request analyzer 1002 confirming the entitlement request does not violate any entitlement request rules.

At operation 318, the example asset deactivates feature “C” using the reset license (e.g., provided to the asset by the SDSi client agent 272 of the enterprise system A 1104). For example, the feature activator 1020 may deactivate feature “C” by disabling the feature.

At operation 320, the example enterprise system A 1104 communicates the base state of the asset 1110 for sale of the asset 1110. For example, the manufacturer enterprise system 1102 may require that prior to transfer of ownership of the asset 1110, the enterprise system A 1104 must communicate the base state which describes to features that will be active on the asset 1110 when ownership is transferred.

At operation 1222, the example manufacturer enterprise system 1102 stores the base state for the asset 1110. For example, the license data store 1006 can store the base state in association with one or more pieces of identifying information for the asset 1110 in order to enable subsequent comparison of the base state with one or more rules when a subsequent entitlement request is received.

At operation 1224, the example manufacturer enterprise system 1102 issues a confirmation that the base state has been stored to the enterprise system A 1104.

At operation 1226, ownership of the example asset 1136 is transferred from the enterprise system A 1104 to the enterprise system B 1106.

At operation 1228, the example enterprise system B 1106 issues an entitlement request for activation of feature “B” and deactivation of feature “A” and communicates the entitlement request to the manufacturer enterprise system 1102.

At operation 1130, the example manufacturer enterprise system 1102 checks the entitlement request against one or more rules.

At operation 1132, the example manufacturer enterprise system 1102 approves the activation of feature “B’ but denies the deactivation of feature “A”. For example, the entitlement request analyzer 1002 may deny the deactivation of feature “A” due to the feature “A” being active in the last base state of the asset 1110.

At operation 1134, the example manufacturer enterprise system 1102 issues a license to activate feature “B” and communicates the license to the enterprise system B 1106, which provides the license (e.g., via its SDSi client agent 272) to the asset 1110.

At operation 1136, the example asset 1110 activates feature “B’ by executing the license.

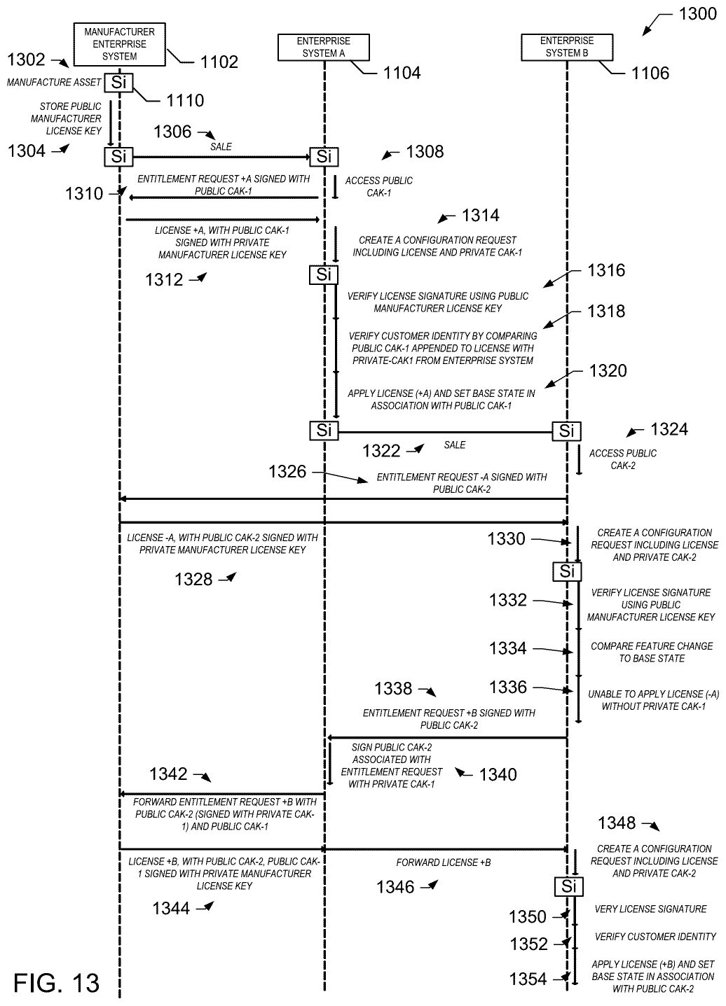

FIG. 13 illustrates a third example process flow 1300 performed by the example system 1000 of FIG. 10 to process entitlement requests using authentication keys.

At operation 1302, the example manufacturer enterprise system 1102 manufacturers the asset 1110. In some examples, the manufacturer enterprise system 1102 does not itself directly manufacturer the asset 1110 but receives the asset from a manufacturer.

At operation 1304, the manufacturer stores the public portion of a manufacturer license key in the asset 1110. By storing this public portion of the manufacturer license key on the asset 1110, the asset 1110 can receive licenses and verify that they were issued by the manufacturer enterprise system 1102, since the manufacturer enterprise system 1102 can issue the license signed with the private portion of the manufacturer license key.

At operation 1306, the example manufacturer enterprise system 1102 transfers ownership of the asset 1110 to the enterprise system A 1104.

At operation 1308, the example enterprise system A 1104 accesses a public customer authentication key, “CAK-1,” belonging to the enterprise system A 1104.

At operation 1310, the example enterprise system A 1104 submits an entitlement request for activation of feature “A” (identified in FIG. 13 as “+A”) signed with the public customer authentication key, “CAK-1.” The enterprise system A 1104 communicates this entitlement request to the manufacturer enterprise system 1102.

At operation 1312, the example enterprise system A 1104 issues a license for activation of feature “A” along with the public “CAK-1” key, signed with the private portion of the manufacturer's license key. The example manufacturer enterprise system 1102 communicates this license to the enterprise system A 1104.

At operation 1314, the example enterprise system A 1104 creates a configuration request including the license and the private portion of the authentication key, “CAK-1.” The enterprise system A 1104 communicates the configuration request to the asset 1110.

At operation 1316, the example asset 1110 verifies the license signature using the public manufacturer license key (e.g., the public portion of the manufacturer license key that was stored at the time of manufacture, in operation 1304).

At operation 1318, the example asset 1110 verifies the customer identity by comparing the public authentication key “CAK-1” appended to the license with the private authentication key “CAK-1” included in the configuration request from the enterprise system A 1104.

At operation 1320, the example asset 1110 applies the license to activate feature “A” and sets the base state of the asset in association with the public authentication key “CAK-1.” The base state indicates that feature “A” is activated, and by associating this base state with the public authentication key “CAK-1,” the base state and its features are bound to the enterprise system A 1104.

At operation 1322, ownership of the example asset 1110 is transferred to the enterprise system B 1106.

At operation 1324, the example enterprise system B 1106 accesses its public authentication key, “CAK-2.”

At operation 1326, the example enterprise system B 1106 submits an entitlement request for deactivation of feature “A” signed with the public authentication key “CAK-2.” The enterprise system B 1106 communicates the entitlement request for deactivation of feature “A” to the manufacturer enterprise system 1102.

At operation 1328, the example manufacturer enterprise system 1102 issues a license for deactivation of feature “A” with public authentication key “CAK-2” and signed with the private manufacturer license key. In the illustrated process flow 1300 of FIG. 13, the manufacturer enterprise system 1102 does not check the base state of the asset 1110 and doesn of check one or more rules against the base state prior to issuing the license. In some examples, the manufacturer enterprise system 1102 compares the base state of the asset, features being requested (e.g., for activation or deactivation), the identity of the customer making the request (e.g., based on a customer authentication key), and/or other factors to determine whether to issue the license in response to the entitlement request.

At operation 1330, the example enterprise system B 1106 creates a configuration request including the license and the private authentication key “CAK-2” belonging to the enterprise system B 1106. The example enterprise system B 1106 communicates the configuration request to the asset 1110.

At operation 1332, the example asset 1110 verifies the license signature using the public portion of the manufacturer license key.

At operation 1334, the example asset 1110 compares the feature change (deactivation of feature “A”) with the base state of the asset 1110.

At operation 1336, the example asset 1110 determines it is unable to apply the license to deactivate feature “A” without the private portion of “CAK-1,” since the base state in which feature “A” was enabled was set by the customer corresponding to the authentication key “CAK-1.”

At operation 1338, the example enterprise system B 1106 submits an entitlement request for activation of feature “B” with the public portion of the authentication key “CAK-2.” The enterprise system B 1106 submits the entitlement request to the enterprise system A 1104, rather than directly to the manufacturer enterprise system 1102.

At operation 1340, the example enterprise system A 1104 signs the public portion of the authentication key “CAK-2” with the private portion of the authentication key “CAK-1,” belonging to the enterprise system A 1104.

At operation 1342, the example enterprise system A 1104 forwards the entitlement request for activation of feature “B” with the public authentication key “CAK-2” (signed with private authentication key “CAK-1”) and the public authentication key “CAK-1” to the manufacturer enterprise system 1102.

At operation 1344, the example manufacturer enterprise system 1102 issues a license for activation of feature “B” signed with the private manufacturer license key, along with the public authentication key “CAK-2,” and the public authentication key “CAK-1.” The manufacturer enterprise system 1102 communicates this license to the enterprise system A 1104.

At operation 1346, the example enterprise system A 1104 forwards the license for activation of feature “B” to the enterprise system B 1106. In some examples, the enterprise system A 1104 is able to identify that the license should be forwarded, and to which entity it should be forwarded, based on (1) the authentication keys that have been provided in association with the license and/or (2) the previous sharing of public authentication keys between the entities.

At operation 1348, the example enterprise system B 1106 creates a configuration request including the license and the private authentication key “CAK-2.” The enterprise system B 1106 communicates the license and the authentication key to the asset 1110.

At block 1350, the example asset 1110 verifies the license signature using the public manufacturer license key (e.g., the public portion of the manufacturer license key that was stored at the time of manufacture, in operation 1304).

At block 1352, the example asset 1110 verifies the customer identity by comparing the public authentication key “CAK-2” appended to the license with the private authentication key “CAK-2” included in the configuration request from the enterprise system A 1104.

At operation 1354, the example asset 1110 applies the license to activate feature “B” and sets the base state of the asset in association with the public authentication key “CAK-2.” The base state indicates that feature “B” is activated, and by associating this base state with the public authentication key “CAK-2,” the base state and its features are associated with the enterprise system B 1106.

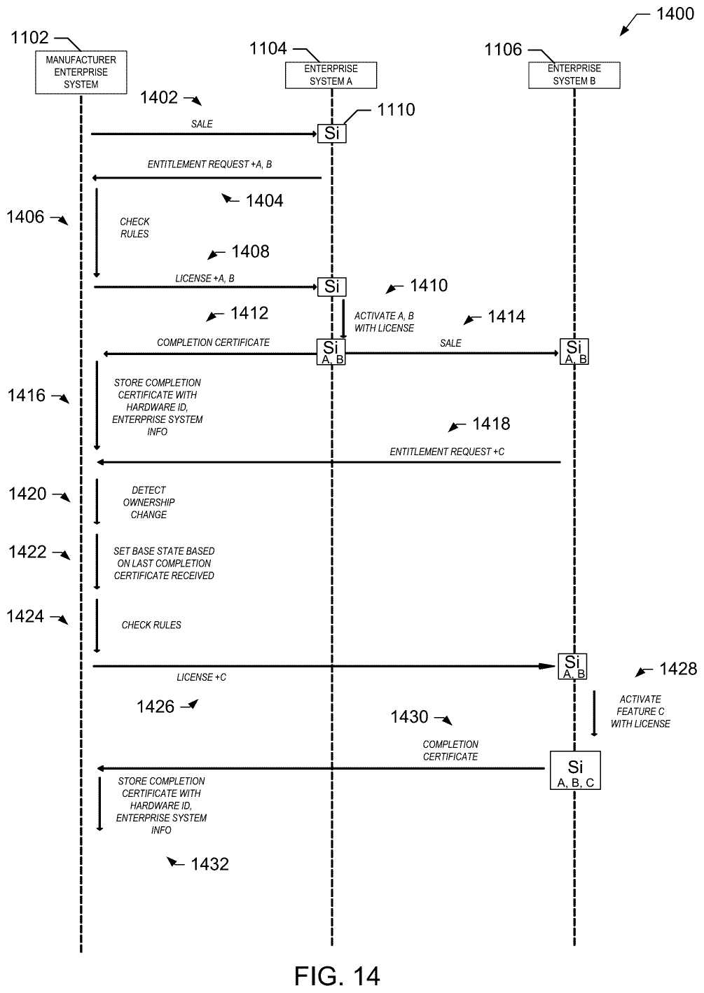

FIG. 14 illustrates a fourth example process flow 1400 performed by the example system 1000 of FIG. 10 to process entitlement requests using completion certificates.

At operation 1402, the example manufacturer enterprise system 1102 transfers ownership of the asset 1110 to the enterprise system A 1104.

At operation 1404, the example enterprise system A 1104 submits an entitlement request to activate features “A,” and “B.” The example enterprise system A 1104 communicates the entitlement request to the manufacturer enterprise system 1102.

At operation 1406, the example manufacturer enterprise system 1102 checks rules associated with entitlement requests to determine whether the entitlement request for activation of features “A” and “B” should be granted.

At operation 1408, the example manufacturer enterprise system 1102 issues a license to activate features “A” and “B.” The manufacturer enterprise system 1102 communicates the license to the enterprise system A 1104, which provides the license (e.g., via its SDSi client agent 272) to the asset 1110.

At operation 1410, the example asset 1110 activates features “A” and “B” by executing the license.

At operation 1412, the example asset 1110 generates a completion certificate including information describing the activation of features “A” and “B’ on the asset 1110. In some examples, the asset 1110 communicates the completion certificate to the enterprise system A 1104. In some examples, the asset 1110 communicates the completion certificate to the manufacturer enterprise system 1102.

At operation 1414, the example enterprise system A 1104 transfers ownership of the asset 1110 to the enterprise system B 1106.

At operation 1416, the example manufacturer enterprise system 1102 stores the completion certificate along with a hardware identifier (corresponding to the asset 1110) and/or enterprise system information (corresponding to the enterprise system A 1104).

At operation 1418, the example enterprise system B 1106 submits an entitlement request to the manufacturer enterprise system 1102 for activation of feature “C.”

At operation 1420, the example manufacturer enterprise system 1102 detects an ownership change based on identification information provided with the entitlement request for activation of feature “C.”

At operation 1422, the example manufacturer enterprise system 1102 sets the base state based on the last completion certificate received. For example, the license data store 1006 can utilize the completion certificate previously received (e.g., at operation 1412) to determine which features are active on the asset and store a base state for the asset in response to detecting a change in ownership (e.g., at operation 1420).

At operation 1424, the example manufacturer enterprise system 1102 checks the entitlement request against one or more rules.

At operation 1426, the example manufacturer enterprise system 1102 generates a license to activate feature “C.” The example manufacturer enterprise system 1102 communicates the license to the enterprise system B 1106, which provides the license (e.g., via its SDSi client agent 272) to the asset 1110.

At operation 1428, the asset 1110 activates feature “C” by executing the license.

At operation 1430, the example enterprise system B 1106 generates a completion certificate corresponding to activation of feature “C,” and communicates the completion certificate to the manufacturer enterprise system 1102.

At operation 1432, the example manufacturer enterprise system 1102 stores the completion certificate along with a hardware identifier (corresponding to the asset 1110) and/or enterprise system information (corresponding to the enterprise system A 1104).

While example manners of implementing the example manufacturing enterprise system 110 and the example SDSi asset agent 140 are illustrated in FIGS. 10-14 one or more of the elements, processes and/or devices illustrated in FIGS. 10-14 may be combined, divided, re-arranged, omitted, eliminated and/or implemented in any other way. Further, the example entitlement request analyzer 1002, the example license generator 1004, the example license data store 1006, the example identifier database 1008, the example hardware identifier manager 1010, the example entropy identifier generator 1012, the example certificate manager 1014, the example license manager 1016, the example authentication analyzer 1018, the example feature activator 1020 and/or, more generally, the example manufacturing enterprise system 110 and the example SDSi asset agent 140 of FIG. 10 may be implemented by hardware, software, firmware and/or any combination of hardware, software and/or firmware. Thus, for example, any of the example entitlement request analyzer 1002, the example license generator 1004, the example license data store 1006, the example identifier database 1008, the example hardware identifier manager 1010, the example entropy identifier generator 1012, the example certificate manager 1014, the example license manager 1016, the example authentication analyzer 1018, the example feature activator 1020 and/or, more generally, the example manufacturing enterprise system 110 and the example SDSi asset agent 140 of FIG. 10 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)), field programmable gate arrays (FPGAs) and/or field programmable logic device(s) (FPLD(s)). When reading any of the apparatus or system claims of this patent to cover a purely software and/or firmware implementation, at least one of the example entitlement request analyzer 1002, the example license generator 1004, the example license data store 1006, the example identifier database 1008, the example hardware identifier manager 1010, the example entropy identifier generator 1012, the example certificate manager 1014, the example license manager 1016, the example authentication analyzer 1018, and/or the example feature activator 1020 is/are hereby expressly defined to include a non-transitory computer readable storage device or storage disk such as a memory, a digital versatile disk (DVD), a compact disk (CD), a Blu-ray disk, etc. including the software and/or firmware. Further still, the example manufacturing enterprise system 110 and the example SDSi asset agent 140 may include one or more elements, processes and/or devices in addition to, or instead of, those illustrated in FIG. 10, and/or may include more than one of any or all of the illustrated elements, processes and devices.

Delegated SDSi Feature Licensing System

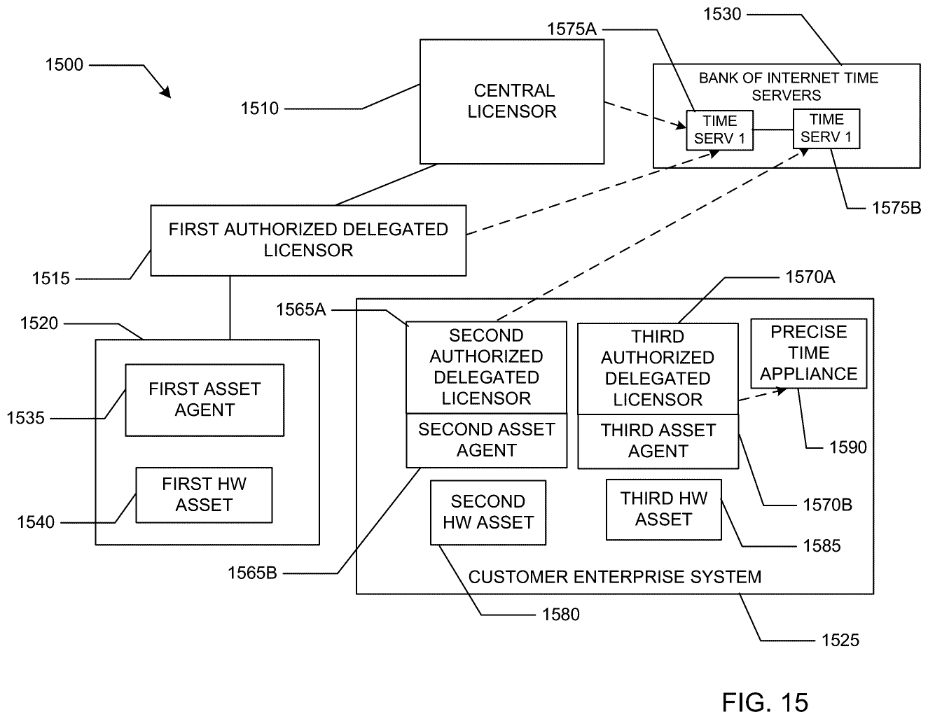

A block diagram of an example SDSi delegated licensing system 1500 is illustrated in FIG. 15 and includes an example central licensor 1510, a first example authorized delegated licensor 1515, an example SDSi product 1520, an example customer enterprise system 1525, and an example bank of internet time servers 1530 having example first and second time servers (Time Serv 1 1575A, and Time Serv 1 1575B). In some examples, the SDSi product 1520 includes an example first asset agent 1535, and an example first hardware asset 1540. In some examples, the customer processing site 1525 can include example second, and third authorized delegated licensors 1565A, 1570A associated with example second and third asset agents 1565B, 1570B, and further associated with example second and third hardware assets 1580, 1585. The customer enterprise system 1525 further includes a precise time appliance 1590.

In some examples, the example central licensor system 1500 operates to delegate, to third parties, an ability to issue SDSi licenses for SDSi products. In the example central licensor system 1500, such third parties are associated with the example first authorized delegated licensor 1515, the example second authorized delegated licensor 1565A, and/or the example third authorized delegated licensor 1570A. In some examples, the central licensor 1510 undertakes one or more tasks to determine which third parties are to be granted status as an authorized delegated licensor as disclosed further below. And, in some examples, any licenses generated by any of the first authorized delegated licensor 1515, the second authorized delegated licensor 1565, the third authorized delegated licensor 1570, etc. include a sequence number based on a timestamp collected from the bank of internet time servers 1530 or the example precise time appliance 1590. As further described below, the sequence numbers are used to ensure that a most recently issued license concerning a feature of an asset is applied instead of an outdated/expired license concerning the same feature (e.g., enabling the feature, or replacing the feature or disabling the feature) of the same asset. By using a timestamp to generate a sequence number and using the sequence numbers to identify a license, an asset manager can license a feature to a hardware asset even while the asset agent is not coupled to the internet. This is made possible because, after internet (or other network communication) is restored, the license having the sequence number can be sent to the manufacturer enterprise system 110 (along with other granted licenses) and used by the manufacturer to determine whether the license is the most recently granted and therefore valid or whether the license is, instead, invalid.

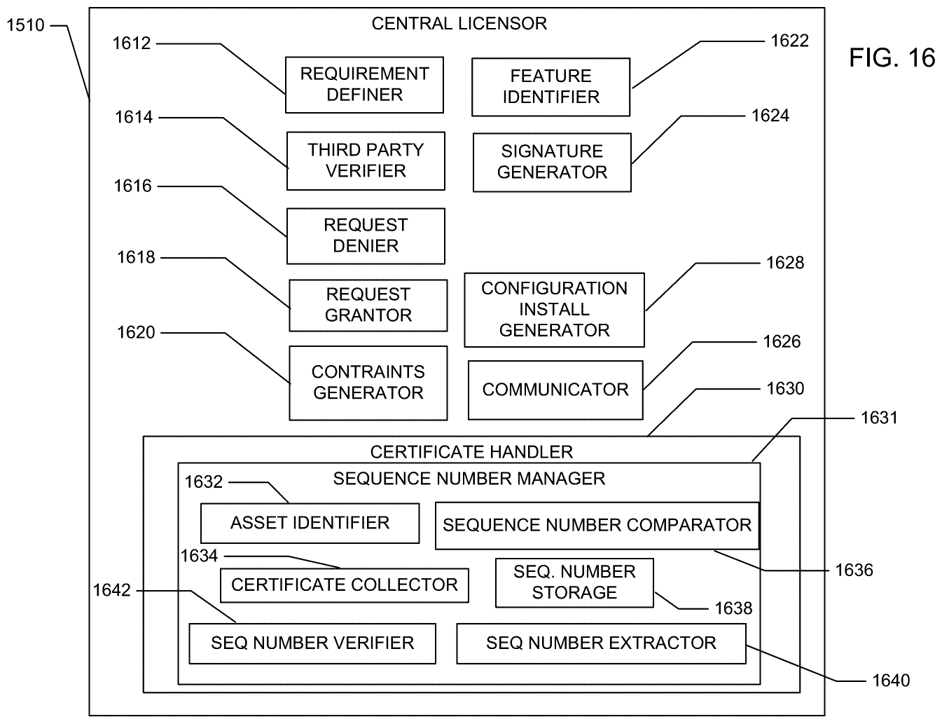

A block diagram of the example central licensor 1510 of FIG. 15 implemented to delegate licensing of SDSi product features in accordance with the teachings of this disclosure is illustrated in FIG. 16. In some examples, the central licensor 1510 includes an example requirement definer 1612, an example third party verifier 1614, an example request denier 1616, an example request grantor 1618, an example constraints generator 1620, an example feature identifier 1622, an example signature generator 1624, an example communicator 1626, an example configuration installation generator 1628, and an example certificate processor 1630. In some examples, the certificate processor 1630 includes an example sequence number manager 1631, an example asset identifier 1632, an example certificate collector 1634, an example sequence number comparator 1636, an example storage 1638, an example sequence number extractor 1640, and an example sequence number verifier 1642. In some examples, the central licensor 1510 can be implemented in the SDSi feature management system 256 (FIG. 1) of the example manufacturer enterprise system 110 (FIG. 1). Also, or instead, the central licensor system 1510 (or components thereof) can be implemented in a separate processor platform or product in communication with the example customer enterprise system 115 (FIG. 1) and/or in communication with the example first example asset agent 1535, the second example asset agent 1565B, and/or the third example asset agent 1570B of FIG. 15.

In some examples, the example requirement definer 1612 of the example central licensor 1510 defines requirements to be satisfied by any third party seeking to obtain authorized delegated licensor status. When a request from a third party to obtain such status is received, the example third party verifier 1614 determines whether the third party has credentials that satisfy the requirements defined by the requirement definer 1612. In some examples, the third party supplies such credentials in or with the request for licensor status and/or via a separate communication. In some examples, the third party credentials are already known to the example central licensor 1510 as being associated with purchasers of one or more SDSi products, for example. When the third party verifier 1614 determines that the defined requirements are satisfied, the example request grantor 1618 notifies the third party that the request has been granted. When the third party verifier 1614 determines that the requirements are not satisfied, the example request denier 1616 notifies the third party that the request has been denied.

In some examples, when authorized delegated licensor status is granted to a third party, the example constraints generator 1620 generates one or more constraints that can be used to restrict (or otherwise define/limit) the types of licenses that can granted, the SDSi products for which a license may be granted, the duration of any granted licenses, a geographic area within which an asset is to reside before a license is granted, etc. In some examples, the example feature identifier 1622 identifies one or more specific features that can be granted by the authorized delegated licensors (ADL(s)) (e.g., of the first, second and/or third ADLs 1515, 1565A, 1570A) or by specific ones of the first, second and/or third ADLs 1515, 1565A, 1570A.

In some examples, the example signature generator 1624 generates a script or code to be used by any of the example first, second and/or third ADLs 1515, 1565A, 1570A when granting a license. In some examples, a unique signature code/script is generated for each third party granted authorized licensor status. The generated example signature code/script is supplied to the first, second and/or third ADLs 1515, 1565A, 1570A associated with the request for authorized license status that is currently being processed. As described further below, the generated signature script/code is used to sign any licenses granted by the unique ones of the first, second and/or third ADLs 1515, 1565A, 1570A (of a third party(ies)).

In some examples, the example configuration installation generator 1628 of the example central licensor 1510 generates script/code that, when executed by a hardware asset, (e.g., any of the first, second, and/or third hardware assets 1540, 1580, 1585) will, in some examples, enable or disable (or perform any other function with respect to) a feature of the hardware asset executing the script/code. To ensure that the configuration installation script/code remains secure from access by the ADL (e.g., any of the first, second, and/or third hardware assets 1540, 1580, 1585), the configuration installation script/code can be encrypted by the configuration installation generator 1628 (FIG. 2) in a manner such that the hardware asset can decrypt the configuration installation script/code but the ADL lacks decryption information needed to access the script/code.

In some examples, information to be used by the third party granted status as an ADL is provided to the third party by the example communicator 1626. In some examples, such information can include information identifying features for which the third party granted status as an ADL can issue licenses, the unique signature script/code to be used by the ADL when issuing a license, the configuration installation information by which a feature can be enable, disabled, etc., and information identifying the constraints/limits governing the licensing activities of the newly granted ADL (e.g., any of the example first, second and/or third ADLs 1515, 1565A, 1570A).

In some examples, the example certificate handler 1630 of the example central licensor 1510 receives a certificate from a consumer of a license (e.g., the customer enterprise system 115 of FIG. 1). In some such examples, the certificate handler 1630 can include any components needed to examine information included in the certificate and can use such information to determine whether any action should be taken in response to the information included in the certificate (e.g., whether the license associated with the certificate is valid, whether the license should be revoked, whether a cost for the license is to be billed to the consumer, etc.) In some examples, the incoming certificate includes an example sequence number. In some such examples, the example sequence number manager 1631 performs one or more tasks to ensure the sequence number is associated with a valid license, a valid licensor, etc. In some example, the example certificate collector 1634 collects the incoming certificate and the example sequence number extractor 1640 extracts the sequence number of the license associated with the incoming certificate. The example asset identifier 1632 uses information in the certificate to determine one or more of the hardware assets that consumed the license associated with the incoming certificate, the identity of the consumer (e.g., the third party) of the license, whether the license of the certificate was issued by an ADL, etc. In some such examples, some or all of the information may be encoded or otherwise included in the sequence number of the certificate. In some examples, the information may be stored as a separate field of the certificate and not included in the sequence number. Using the identity of the hardware asset (or any of the other information included in the certificate) that consumed the license, the asset identifier 1632 accesses the sequence number storage 1638 to determine a preceding, most recently granted license consumed by the hardware asset and a feature effected by the license to determine a sequence number associated with the preceding, most recently granted license consumed by the same hardware asset for the same feature. The example sequence number comparator 1636 compares the example sequence number associated with the certificate currently being handled by the certificate handler 1630 to the sequence number associated with the preceding, most recently granted license consumed by the same hardware asset for the same feature. When the sequence number comparator 1636 determines the example sequence number verifier was issued more recently than the license most recently issued, the sequence number verifier 1642 notifies other components of the certificate handler that the license associated with the certificate was validly issued so that the certificate can be handled by other components of the certificate handler in the manner described above. When the sequence number comparator 1636 determines the example sequence number verifier 1642 was not issued more recently than the previously issued license, the license is deemed invalid and the certificate handler and the sequence number verifier notifies other components of the certificate handler 1630 that the license associated with the certificate was outdated/expired/invalid so that the license associated with the certificate can be revoked or other appropriate action can be taken.

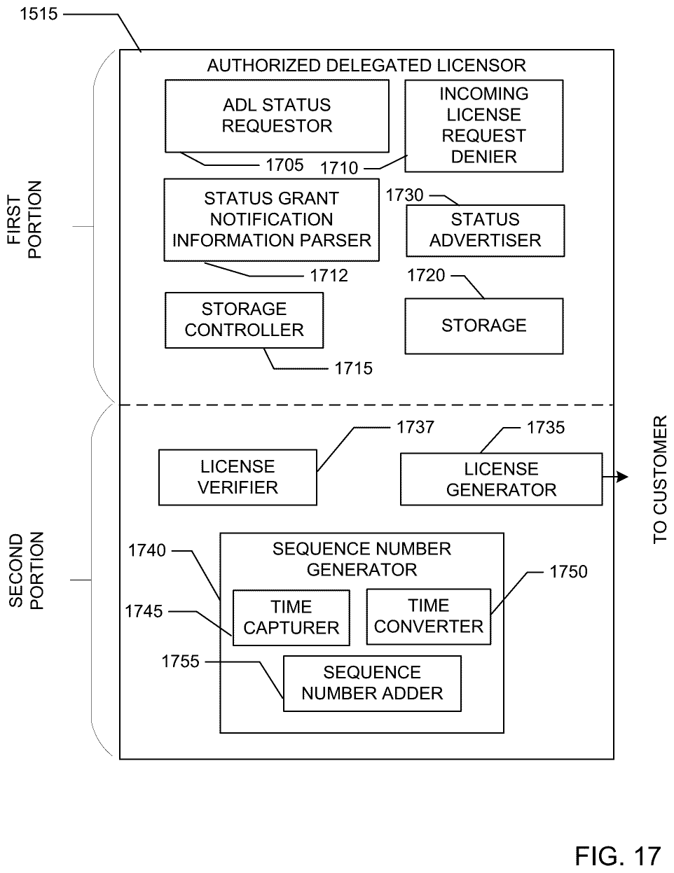

FIG. 17 is a block diagram of the example first ADL 1515 of FIG. 15 implemented to delegate licensing of SDSi product features in accordance with the teachings of this disclosure. In some examples, the ADL 1515 includes an example first portion that performs requests to achieve status as an ADL, and an example second portion that manages incoming license requests (assuming ADL status has been achieved/granted). In some examples, the first portion of the ADL 1515 includes an example ADL status requestor 1705, an example incoming license request denier 1710, an example status grant notification information parser 1712, an example storage controller 1715, an example storage 1720, an example decryptor 1725, and an example status advertiser 1730. In some examples, the second portion includes an example license generator 1735, an example license verifier 1737, and an example sequence number generator 1740 having an example time capturer 1745, an example time converter 1750, and an example sequence number adder 1755. In some examples, the ADL 1515 can be implemented in the SDSi client asset agent 140 of the example manufacturer enterprise system 110 (FIG. 1). Also, or instead, the ADL 1515 (or components thereof) can be implemented in a separate processor platform or product of a third party and in communication with the example customer enterprise system 115 (FIG. 1) and/or the example asset agent 140 of FIG. 1.

In some examples, the example ADL status requestor 1705 of the first portion generates a request to become an ADL (e.g., to have status as an ADL). The request can include information about the third party associated with the ADL 1515 including the information described with respect to FIG. 2. The request is communicated to the example central licensor 1510 (FIG. 15 and FIG. 16). The central licensor 1510 processes the request in the example manner described above with respect to FIG. 16. Assuming the request is denied, the example ADL status requestor 1705 receives a denial, and the ADL status requestor 1705 notifies the example incoming license request denier 1710. As a result, any incoming requests for a license received from any customer (e.g., the customer enterprise system 115 (FIG. 1) are denied (on the basis that the ADL 1515 is not, in fact, authorized to grant such licenses).

Assuming the request is granted, the example ADL status requestor 1705 relays a grant notification to the example status grant notification information parser 1712 of the example second portion. The example grant notification is received, for example, from the central licensor 1510 and indicates that status as an ADL has been granted/achieved. The grant notification received by the status grant notification information parser 1712 can include (or is followed by a communication that includes) information to be used by the second portion of the ADL 1515 to grant (or deny) licenses. In some examples, the information received in connection with the grant notification is parsed by the status grant notification information parser 1712. The information can be parsed to identify information included in the notification such as a set of example constraints, a set of example feature identifiers, first example script/code that can be used to generate a license signature that is unique to the ADL 1515, second example script/code that is encrypted and that can be used to enable/disable a feature(s) of a hardware agent associated with a license request received from a customer in the future, etc. In some examples, the grant notification is cryptographically signed (certified) by the central licensor 1510 so that the hardware asset can verify that the notification come from a legitimate source (e.g., the central licensor 1510) (instead of a spoof by a rogue ADL).

The example storage controller 1715 causes the parsed information to be stored in the example storage 1720 for use by the example license generator 1735 when generating (or denying) a license in response to a customer request for a license. An example advertiser 1730 notifies specific ones of the identified customers (or any customers), for example, to which the ADL 1515 has the ability and authority to grant feature licenses (e.g., has been granted authorized licensor status).

In some examples, when a request for a license is received at the ADL 1515 from a customer (e.g., the customer enterprise system 115 of FIG. 1), the example license verifier 1737 compares the information included in the license request (e.g., the feature for which a license is requested, information about the customer requesting the license, information about where the hardware asset of the customer is geographically located, etc.), to information stored in the example storage 1720 (e.g., constraints stored in the storage 1720, feature identities stored in the storage 1720, a geographical region stored in the storage, etc.). Based, as least in part, on the comparison, the license verifier 1737 determines whether the license request violates any constraints, whether the feature for which the license is requested is among the features that the ADL 1515 is permitted to license, whether a grant of the license will violate any technology export laws based on geography, etc. In some examples, the criteria/conditions in the storage 1720 are not satisfied and the license verifier 1737 communicates to the customer making the license request that the request is denied. The license verifier 1737 can also communicate information identifying violated constraints or any other reasons the license request is denied. In some examples, the license verifier 1737 verifies the credentials of the customer (using, for example signatures) and, if applicable, a sequence number associated with the requested license.

When the criteria/conditions in the example storage 1720 are satisfied (e.g., none of the constraints are violated, the customer requesting the license is within an acceptable geographical region, the feature for which the license is being requested is among the features identified as being licensable, the customer is among a list of customers to whom the example ADL 1515 can grant a license, etc.), the example license verifier 1737 grants the license and notifies the example license generator 1735. The license generator can then proceed to generate the license and communicate the license to the example customer (e.g., the customer enterprise system 115 of FIG. 1). In some examples, when generating the license, the license generator 1735 can activate the example sequence number generator 1740. In response to the activation, the example time capturer 1745 of the sequence number generator 1740 captures a time at which the license is generated. The example time converter 1750 converts the captured time to a sequence number and the example sequence number adder 1755 causes the license generator 1735 to add the sequence number to the license to be generated. As described in further detail above, in some examples, a certificate generated when the license is activated/consumed includes the unique sequence number. In some such examples, the example central licensor 1510 (FIG. 15) can use the sequence number (and information included in the certificate concerning the license) to verify that the license associated with the certificate is the most recently recorded license for that feature and for the hardware asset that consumed the license as described above.

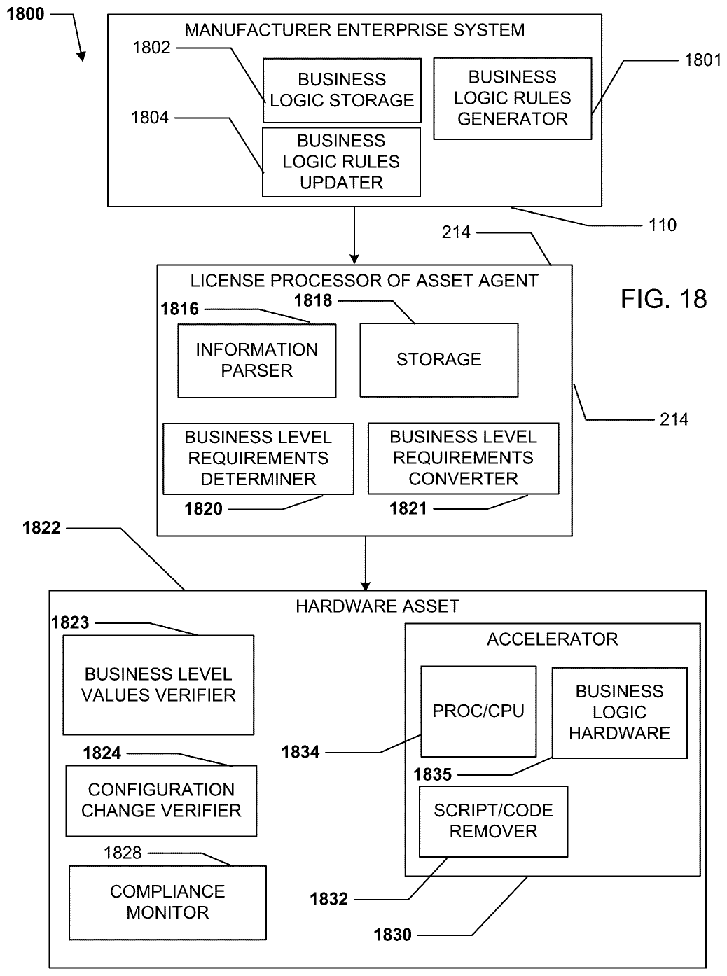

FIG. 18 is a block diagram of an example system 1800 to implement an example portion of the example manufacturer enterprise system 110 (FIG. 1), an example portion of the example license processor 214 (FIG. 2) of the example asset agent 140 (FIG. 1 and FIG. 2), and an example portion 1822 of the hardware asset (e.g., the second hardware asset 1580) in accordance with the teachings of this disclosure. In some examples, the system 1800 enables the changing of business logic rules that are to be applied to a license granted to a hardware asset. In some examples, the example system 1800 permits the altering of business logic in a hardware asset that, in the past, would be hardcoded and, thus, static and unmodifiable. The system 1800 of FIG. 18 permits such rules to be changed in accordance with the teachings of this disclosure.

Referring still to FIG. 18, in some examples, the example manufacturer enterprise system 110 includes an example business logic rules generator 1801, an example business logic rules storage 1802, and an example business logic rules updater 1804. In some examples, the example manufacturer enterprise system 110 can be implemented as an ADL. In some examples, the example license processor 214 of the example asset agent 140 includes an example information parser 1816, an example storage 1818, an example business level requirements determiner 1820, and an example business level requirements converter 1821. In some examples, an example hardware asset 1822 (which can be used to implement any of the example first, second and/or third hardware assets 1540, 1565B, 1570B (FIG. 15)) associated with any of the example first, second and/or the third asset agents 1535, 1565B, 1570B of FIG. 15 includes an example business level values verifier 1823, an example configuration change verifier 1824, an example compliance monitor 1828, and an example accelerator 1830 having an example script/code remover 1832, and an example CPU 1834, and example business logic hardware 1835. In some examples, the hardware asset may contain the CPU 1834 as illustrated. In some examples, the hardware asset may itself be a CPU (e.g., can be a physical device apart from any main CPU cores that execute user's programs and that include multiple additional modules/subsystems capable of executing non-user code/firmware). Such modules can be used to manage the CPU (for example, power mgmt, capabilities, etc.). In some examples, one of such modules may be used to execute the script/code.

In some examples, the example business logic storage 1802 of the example manufacturer enterprise system 110 stores business logic that includes example business logic rules. Such rules can include any of various types of rules including, in some examples, permitted durations of licenses permitted for various features, permitted export rules identifying geographical regions for which license are not permitted, a number of times a license can be granted to particular (or any customers) for one or more hardware assets, penalties for non-compliance, a maximum frequency at which features can be changed, feature(s) that, when activated, can only be activated in connection with other features, parties to which licenses are to be granted, etc. In some examples, the example rules of the business logic are entered by an administrator of the manufacturer enterprise system 110 and stored in the example business logic storage 1802. In some examples, the business logic (also referred to herein as business logic rules) can be generated or augmented using machine learning and stored in the example business logic storage 1802. As the business logic changes, the example business logic updater 1804 modifies the business logic stored in the business logic storage 1802 as needed to reflect the updated business logic.

In some examples, the business logic is received or from the example manufacturer enterprise system 110 (FIG. 1) or from elsewhere (e.g., the example customer enterprise), at the example license processor 214 of the asset agent 140 associated with the example hardware asset 1822 that is to incorporate the business logic. In some examples, the business logic received at the license processor 214 can be included with terms of a license to be consumed by the hardware asset or with any other information transmitted via any other communications. The example information parser 1816 of the example license processor 214 parses the business logic from any other information that may be included in the communication and stores the business logic in the example storage 1818. In some examples, the example business level requirements determiner 1820 accesses the business logic stored in the storage 1818 and determines, based on the business logic, business level requirements to be satisfied by the hardware asset when consuming a license. Provided the business level requirements are satisfied, in some examples, the example business level requirements determiner 1820 supplies the business level requirements to the example business level requirements converter 1821. The business level requirements converter 1821 converts the business level requirements to values that are interpretable by a CPU (e.g., a CPU associated with the hardware asset). In some examples, converting the values can include translating, concatenating, re-interpreting, etc., the requirements into actionable functions that are understandable and executable by a processor/CPU. The business level values are supplied to the hardware asset 1822.

In some examples, the example business level values verifier 1823 of the example hardware asset 1822 verifies that the business level values are from an authorized source. In some such examples, the business level values verifier 1823 may verify a signature included with the business level values. In some examples, the business level values verifier 1823 can perform any other tasks needed to verify the authenticity of the received business level values. Once verified, the business level values are supplied to the example configuration change verifier 1824. The configuration change verifier 1824 determines/verifies that the business level values are to affect the business level logic aspect of the hardware asset 1822 instead of (or in addition to) a feature change. In some examples, the configuration change verifier 1824, after determining/verifying that the changes are to affect the business logic of the hardware asset 1822, supplies the business level values to the example processor 1834 of the example accelerator 1830. In some examples, the processor/CPU 1834 executes the values in a manner that causes the business rules associated with the business logic to be hardcoded into the business logic hardware 1835 of the hardware asset 1822. In addition, after the process/CPU 1834 has processed the business level values, the example script/code remover 1832, causes the code executed to incorporate the business logic into the hardware asset to be removed. By removing the code, the limited space available in the hardware asset 1822 is preserved to accommodate business level logic changes that may be made in the future. In some examples, the example compliance monitor 1828 monitors the operation of the example hardware asset based on the business logic rules and can generate notifications to the asset agent for transmission to the manufacturer when noncompliance with the business logic rules is detected.

While example manners of implementing the systems 1500 are illustrated in FIGS. 15-18, one or more of the elements, processes and/or devices illustrated in FIGS. 15-18 may be combined, divided, re-arranged, omitted, eliminated and/or implemented in any other way. Further, the example central licensor 1500, the example first ADL 1515, the example SDSi Product 1520, the example customer enterprise system 1525, the example bank of internet time servers 1530, the example first asset agent 1535, the example first hardware asset 1540, the example second ADL 1565A, the example second asset agent 1565B, the example third ADL 1570A, the example third asset agent 1570B, the example first time server 1575A, the example second time server 1575B, the example second hardware asset 1580, the example third asset 1585, the example precise time appliance 1590, the example requirement definer 1612, the example third party verifier 1614, the example request denier 1616, the example request grantor 1618, the example constraints generator 1620, the example feature identifier 1622, the example signature generator 1624, the example configuration install generator 1628, the example communicator 1626, the example certificate handler 1630, the example sequence number manager 1631, the example asset identifier 1632, the example certificate collector 1634, the example sequence number comparator 1636, the example sequence number storage 1638 the example sequence number extractor 1640, the example ADL status requestor 1705, the example incoming license denier 1710, the example status grant notification information parser 1712, the example storage controller 1715, the example storage 1720, the example status advertiser 1730, the example license generator 1735, the example license verifier 1737, the example sequence number generator 1740, the example time capturer 1745, the example time converter 1750, the example sequence number adder 1755, the example business logic storage, the example business logic updater 1804, the example information parser 1816, the example storage 1818, the example business level requirements determiner 1820, the example business level requirement converter 1821, the example hardware asset 422, the example business level values verifier 1823, the example configuration change verifier 1824, the example compliance monitor 1828, the example accelerator 1830, the example processor/CPU 1834, the example script/code remover 1832, the example business logic hardware 1835, and/or, more generally, the systems 1500, 1600, 1700 and/or 1800 of FIGS. 15-18 may be implemented by hardware, software, firmware and/or any combination of hardware, software and/or firmware. Thus, for example, any of the example central licensor 1500, the example first ADL 1515, the example SDSi Product 1520, the example customer enterprise system 1525, the example bank of internet time servers 1530, the example first asset agent 1535, the example first hardware asset 1540, the example second ADL 1565A, the example second asset agent 1565B, the example third ADL 1570A, the example third asset agent 1570B, the example first time server 1575A, the example second time server 1575B, the example second hardware asset 1580, the example third asset 1585, the example precise time appliance 1590, the example requirement definer 1612, the example third party verifier 1614, the example request denier 1616, the example request grantor 1618, the example constraints generator 1620, the example feature identifier 1622, the example signature generator 1624, the example configuration install generator 1628, the example communicator 1626, the example certificate handler 1630, the example sequence number manager 1631, the example asset identifier 1632, the example certificate collector 1634, the example sequence number comparator 1636, the example sequence number storage 1638 the example sequence number extractor 1640, the example ADL status requestor 1705, the example incoming license denier 1710, the example status grant notification information parser 1712, the example storage controller 1715, the example storage 1720, the example status advertiser 1730, the example license generator 1735, the example license verifier 1737, the example sequence number generator 1740, the example time capturer 1745, the example time converter 1750, the example sequence number adder 1755, the example business logic storage, the example business logic updater 1804, the example information parser 1816, the example storage 1818, the example business level requirements determiner 1820, the example business level requirement converter 1821, the example hardware asset 1822, the example business level values verifier 1823, the example configuration change verifier 1824, the example compliance monitor 1828, the example accelerator 1830, the example processor/CPU 1834, the example script/code remover 1832, the example business logic hardware 1835, and/or, more generally, the systems 1500, 1600, 1700 and/or 1800 of FIGS. 15-18 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)), field programmable gate arrays (FPGAs) and/or field programmable logic device(s) (FPLD(s)). When reading any of the apparatus or system claims of this patent to cover a purely software and/or firmware implementation, at least one of the example systems 1500, 1600, 1700 and/or 1800, the example central licensor 1500, the example first ADL 1515, the example SDSi Product 1520, the example customer enterprise system 1525, the example bank of internet time servers 1530, the example first asset agent 1535, the example first hardware asset 1540, the example second ADL 1565A, the example second asset agent 1565B, the example third ADL 1570A, the example third asset agent 1570B, the example first time server 1575A, the example second time server 1575B, the example second hardware asset 1580, the example third asset 1585, the example precise time appliance 1590, the example requirement definer 1612, the example third party verifier 1614, the example request denier 1616, the example request grantor 1618, the example constraints generator 1620, the example feature identifier 1622, the example signature generator 1624, the example configuration install generator 1628, the example communicator 1626, the example certificate handler 1630, the example sequence number manager 1631, the example asset identifier 1632, the example certificate collector 1634, the example sequence number comparator 1636, the example sequence number storage 1638 the example sequence number extractor 1640, the example ADL status requestor 1705, the example incoming license denier 1710, the example status grant notification information parser 1712, the example storage controller 1715, the example storage 1720, the example status advertiser 1730, the example license generator 1735, the example license verifier 1737, the example sequence number generator 1740, the example time capturer 1745, the example time converter 1750, the example sequence number adder 1755, the example business logic storage, the example business logic updater 1804, the example information parser 1816, the example storage 1818, the example business level requirements determiner 1820, the example business level requirement converter 1821, the example hardware asset 422, the example business level values verifier 1823, the example configuration change verifier 1824, the example compliance monitor 1828, the example accelerator 1830, the example processor/CPU 1834, the example business logic hardware 1835, and/or the example script/code remover 1832 is/are hereby expressly defined to include a non-transitory computer readable storage device or storage disk such as a memory, a digital versatile disk (DVD), a compact disk (CD), a Blu-ray disk, etc. including the software and/or firmware. Further still, the example systems 1500, 1600, 1700 and/or 1800 may include one or more elements, processes and/or devices in addition to, or instead of, those illustrated in FIGS. 15-18, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

Software Defined Silicon Security

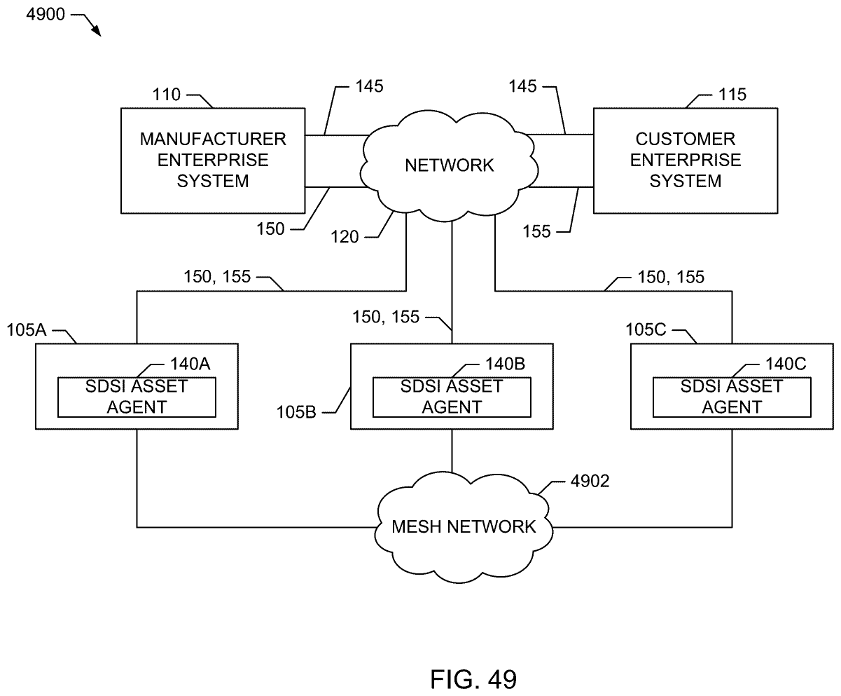

A block diagram of an example system 4900 to implement and manage SDSi products in accordance with teachings of this disclosure is illustrated in FIG. 49. The example SDSi system 4900 of FIG. 49 includes a plurality of the example silicon products 105 of FIG. 1 (e.g., a plurality of the SDSi semiconductor devices 105 of FIG. 1, a plurality of the semiconductor assets 105 of FIG. 1, etc.), such as a first example silicon product 105A (referred to herein as the “first semiconductor device 105A”), a second example silicon product 105B (referred to herein as the “second semiconductor device 105B”), and a third example silicon product 105C (referred to herein as the “third semiconductor device 105A”). The silicon products 105A-C include respective instantiations of the SDSi asset agent 140 of FIG. 1, such as a first example SDSi asset agent 140A, a second example SDSi asset agent 140B, and a third example SDSi asset agent 140C. The SDSi asset agents 140A-C of the example of FIG. 49, and/or, more generally, the semiconductor products 105A-C of FIG. 49, implement SDSi features as disclosed herein. The system 4900 also includes the example manufacturer enterprise system 110 of FIG. 1 and the example customer enterprise system 115 of FIG. 1W to manage the SDSi asset agents 140A-C of FIG. 49, and/or, more generally, the semiconductor products 105A-C of FIG. 49. In the illustrated example of FIG. 49, at least some aspects of the manufacturer enterprise system 110 and/or the customer enterprise system 115 are implemented as cloud services in the example cloud platform 120 of FIG. 1.

In the illustrated example of FIG. 49, the manufacturer enterprise system 110 is in communication with the customer enterprise system 115 via a cloud service implemented by the cloud platform 120 (represented by the line labeled 145 of FIG. 1). In the illustrated example of FIG. 49, the SDSi semiconductor devices 105A-C are in communication with the manufacturer enterprise system 110 via a cloud service implemented by the cloud platform 120 (represented by the line labeled 150 of FIG. 1). In the illustrated example of FIG. 49, the SDSi semiconductor devices 105A-C are in communication with the customer enterprise system 115 via a cloud service implemented by the cloud platform 120 (represented by the line labeled 155 of FIG. 1).

In the illustrated example of FIG. 49, the SDSi semiconductor devices 105A-C are in communication with each other via an example mesh network (e.g., a meshnet) 4902. For example, one or more of the SDSi semiconductor devices 105A-C are in communication with one or more of the SDSi semiconductor devices 105A-C using a mesh networking topology (e.g., a Hybrid Wireless Mesh Protocol (HWMP), Dynamic Source Routing, Associativity-Based Routing, Zone Routing Protocol, etc.) to deliver data in a wireless network (e.g., a wireless local area network (WLAN)). In such examples, one or more of the SDSi semiconductor devices 105A-C are in communication with one(s) of the SDSi semiconductor devices 105A-C in a direct, dynamic, and/or non-hierarchically architecture to route data between some or all of the semiconductor devices 105A-C.

In the illustrated example of FIG. 49, the mesh network 4902 may implement one or more peer-to-peer (P2P) security protocols where either side (e.g., an initiating one of the semiconductor devices 105A-C, a receiving one of the semiconductor devices 105A-C, etc.) can initiate authentication to the other side, or both sides can initiate authentication simultaneously. In some examples, when peers (e.g., peer SDSi asset agents 140A-C, peer semiconductor devices 105A-C, etc.) discover each other, they take part in an authentication process, such as a secure password-based authentication and/or key establishment protocol. In some examples, the authentication process may be implemented by a Simultaneous Authentication of Equals (SAE). In such examples, if SAE completes successfully, each peer knows the other peer possesses the authentication (e.g., the mesh password) and, as a by-product of the SAE exchange, the two peers establish a cryptographically strong key. In such examples, the cryptographic key is used to establish a secure peering session and derive a session key to protect mesh traffic, including routing traffic, during the secure peering session.

In some examples, peers can authenticate each other and/or otherwise be authenticated based on asymmetric encryption algorithms and/or symmetric encryption algorithms. For example, the SDSi asset agents 140A-C may decrypt/encrypt data in a data packet using the Advanced Encryption Standard (AES) that includes using a block cipher (e.g., the AES-128 block cipher, the AES-192 block cipher, the AES-256 block cipher, etc.) to decrypt/encrypt the data included in the data packet. In some examples, the SDSi asset agents 140A-C can decrypt/encrypt data using an AES cipher block chaining (AES-CBC) algorithm, a ciphertext feedback (AES-CFB) algorithm, an AES output feedback (AES-OFB) algorithm, a 2-byte CBC message authentication code (CBC-MAC) algorithm, a Galois MAC (GMAC) algorithm, or a keyed-Hashing MAC (HMAC) algorithm. Additionally or alternatively, the SDSi asset agents 140A-C may decrypt/encrypt data using any other symmetric algorithm. In some examples, the SDSi asset agents 140A-C can decrypt/encrypt data using an asymmetric encryption technique by using two independent keys, a first key to encrypt the data packet and a second key to decrypt the data packet. For example, the SDSi asset agents 140A-C may decrypt/encrypt a data packet of interest using a Diffie-Hellman key exchange, or a Rivest, Shamir and Adleman (RSA) algorithm. Additionally or alternatively, the SDSi asset agents 140A-C may decrypt/encrypt the data packet of interest using any other asymmetric encryption technique.

In some examples, the SDSi asset agents 140A-C authenticate and/or otherwise validate connections between the SDSi asset agents 140A-C. For example, the first SDSi asset agent 140A determines whether the second SDSi asset agent 140B has authorization to exchange data with the first SDSi asset agent 140A. In such examples, the first SDSi asset agent 140A can receive a first data packet from the second SDSi asset agent 140B corresponding to a request by the second semiconductor device 105B to communicate with the first semiconductor device 105A. In response to receiving the request, the first SDSi asset agent 140A can send a second data packet including a signature request to the second SDSi asset agent 140B. For example, the signature request corresponds to a signature associated with an Elliptic Curve Digital Signature Algorithm (ECDSA). In response to receiving the signature request, the second SDSi asset agent 140B can generate and transmit a third data packet including the signature to the first SDSi asset agent 140A via the mesh network 4902. The first SDSi asset agent 140A can authenticate the signature provided by the second SDSi asset agent 140B and validate subsequent data packet transfers between the first SDSi asset agent 140A and the second SDSi asset agent 140B. In some examples, the first SDSi asset agent 140A may authenticate the second SDSi asset agent 140B through any other Digital Signature Algorithm (DSA).

In some examples, the SDSi asset agents 140A-C communicate with each other via the mesh network 4902 to determine and/or otherwise obtain reputation information or score(s) (e.g., agent reputation score(s)). In some examples, a reputation score is indicative or representative of a level of trustworthiness associated with an agent (e.g., the SDSi asset agents 140A-C) of a semiconductor device (e.g., the semiconductor devices 105A-C). In some examples, an agent with the highest reputation score is chosen to facilitate a system function, such as issuing a license or reporting telemetry data (e.g., reporting telemetry data to the manufacturer enterprise system 110 and/or the customer enterprise system 115). Advantageously, to avoid locking into one of the SDSi asset agents 140A-C, which at some point may become compromised and turn rogue or otherwise malicious, the SDSi asset agents 140A-C may determine that a subsequent license be issued by a different one of the SDSi asset agents 140A-C.

In some examples, one or more of the activated features of one(s) of the semiconductor devices 105A-C may deactivate (e.g., periodically deactivate, asynchronously deactivate, etc.) to invoke a re-certification process of the deactivated one(s) of the semiconductor devices 105A-C. Advantageously, one(s) of the SDSi asset agents 140A-C can be located both in an intranet and on the Internet to effectuate high availability and performance maintaining a relatively high level of security.

In some examples, the SDSi asset agents 140A-C improve security of the system 4900 by deploying a TEE in which to execute secure application code and/or protect data of interest (e.g., silicon product manufacturer owned cryptographical data). For example, a TEE is a compute or computing execution context wherein resources, such as process data, memory, storage, input(s)/output(s) (I/O(s)), etc., are isolated and protected from untrusted and/or unauthorized access. In such examples, the TEE takes the form of an entire operating system or portion(s) thereof, such as application code running or executing in an isolated environment, such as that provided by Intel® Software Guard Extensions (SGX).

In some examples, the SDSi asset agents 140A-C deploy a TEE based on known TEEs deployable by one(s) of the semiconductor devices 105A-C. For example, the first SDSi asset agent 140A invokes the first semiconductor device 105A to deploy a first TEE included in the first semiconductor device 105A in response to determining that the first TEE is supported and/or otherwise deployable by the first semiconductor device 105A. In other examples, the first SDSi asset agent 140A invokes the second semiconductor device 105B to deploy the first TEE included in the second semiconductor device 105B in response to determining that the first TEE is not supported and/or otherwise deployable by the first semiconductor device 105A but is supported and/or otherwise deployable by the second semiconductor device 105B. In some such examples, the first TEE is a hardware or hardware-based TEE, a software or software-based TEE, or a combination thereof.

In some examples, the SDSi asset agents 140A-C assemble, compose, and/or otherwise generate a TEE based on one or more TEE components. For example, the TEE components correspond to compute capabilities that exist within the compute environment that represent a part, portion, or component of a TEE, such as trusted execution, trusted memory, trusted storage, etc. In such examples, the TEE components are either located on a platform local to an agent making a TEE deployment request (e.g., the first semiconductor device 105A when the first SDSi asset agent 140A makes the TEE deployment request) or available through a network connection (e.g., the mesh network 4902, the cloud platform 120, etc.). In some examples, the SDSi asset agents 140A-C generate a TEE based on one or more identified TEE components in response to determining that a known TEE or a previously generated or deployed TEE is not identified.

In some examples, the SDSi asset agents 140A-C deploy a TEE in response to translating an intent or intended outcome expected by a request. For example, the request is a change in a configuration, a requirement, etc., associated with availability (e.g., redundancy, a number failures-to-tolerate (FTT), etc.), machine learning, performance, reliability, security, etc., parameters of the system 4900. In such examples, a user (e.g., a customer, a computing device associated with the customer, a server, etc.) generates a request to adjust a configuration of the system 4900 based on one or more requirements. In some such examples, the SDSi asset agents 140A-C execute one or more artificial intelligence (AI)/machine learning (ML) models to translate and/or otherwise convert an intent or intended outcome from the one or more requirements of the request into one or more features of one(s) of the semiconductor devices 105A-C. For example, the SDSi asset agents 140A-C execute the one or more AI/ML models to translate a request to an intent to improve security of the system 4900, map the intent to one or more features (e.g., configurable features, security features, etc.) of one(s) of the semiconductor devices 105A-C, and deploy the one or more features based on the mapping. In such examples, the SDSi asset agents 140A-C maps the intent to one or more security features, such as a TEE supported by the first semiconductor device 105A, and invokes the first semiconductor device 105A to deploy the first TEE. Advantageously, the user may generate the request to adjust operation of the system 4900 without requiring the user to have in-depth knowledge of hardware and/or software configurations of the system 4900.

As used herein, availability refers to the level of redundancy required to provide continuous operation expected for workload(s) (e.g., computing workload(s), computational task(s), etc.) executed by the system 4900. As used herein, performance refers to the computer processing unit (CPU) operating speeds (e.g., CPU gigahertz (GHz)), memory (e.g., gigabytes (GB) of random access memory (RAM)), mass storage (e.g., GB hard drive disk (HDD), GB solid state drive (SSD)), and/or power capabilities to execute the workload(s). As used herein, security refers to hardware (e.g., a processor executing security decryption, encryption, monitoring services, etc., a firewall device, a hardware-based TEE, etc.), software (e.g., a software-based TEE, a virtual sandbox, etc.) and/or firmware (e.g., a firmware-based TEE) that can be deployed to protect the system 4900 or portion(s) thereof.

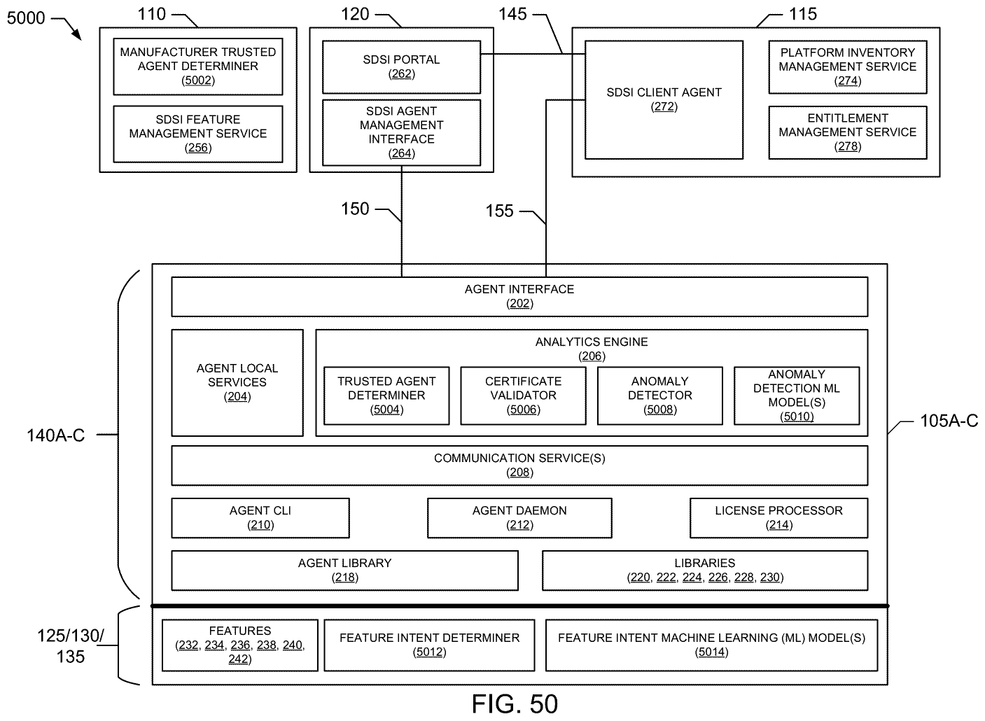

FIG. 50 depicts a block diagram of an example system 5000 that illustrates example implementations of the SDSi asset agent 140 and/or one(s) of the SDSi asset agents 140A-C, the manufacturer enterprise system 110, and the customer enterprise system 115 included in the example system 100 of FIG. 1 and/or the example system 4900 of FIG. 49. In the illustrated example of FIG. 50, the manufacturer enterprise system 110 includes the example SDSi feature management service 256 of FIG. 2 and an example manufacturer trusted agent determiner 1102. In the illustrated example of FIG. 50, the manufacturer enterprise system 110 includes the SDSi feature management service 256 to determine whether to renew license(s) associated with one(s) of the SDSi asset agents 140A-C to improve and/or otherwise effectuate security of the system 4900 of the example of FIG. 49.

In the illustrated example of FIG. 50, the manufacturer enterprise system 110 includes the manufacturer trusted agent determiner 1102 to determine a reputation score (e.g., an agent reputation score) for one(s) of the SDSi asset agents 140A-C of FIG. 50. For example, the SDSi feature management service 256 determines whether to renew license(s) associated with one(s) of the SDSi asset agents 140A-C. In such examples, the manufacturer trusted agent determiner 1102 determines a reputation score for respective one(s) of the SDSi asset agents 140A-C based on whether the license(s) are renewed. In some such examples, the manufacturer trusted agent determiner 1102 determines a first reputation score for the first SDSi asset agent 140A based on the determination to renew the license(s) associated with the first SDSi asset agent 140A. In some such examples, the manufacturer trusted agent determiner 1102 determines a second reputation score for the first SDSi asset agent 140A based on the determination not to renew the license(s) associated with the first SDSi asset agent 140A. In some examples, the second reputation score is less than the first reputation score because a determination not to renew the license(s) is indicative of the first SDSi asset agent 140A being compromised and/or otherwise acting not in accordance with accepted or typical behavior of an SDSi agent. Additionally or alternatively, the manufacturer enterprise system 110 of the example of FIG. 50 may include the example product management service 252 and/or the example customer management service 254 of the example of FIG. 2.

In the illustrated example of FIG. 50, the system 5000 includes the example SDSi portal 262 and the example SDSi agent management interface 264 of FIG. 2. In the example of FIG. 50, the example SDSi portal 262 and the example SDSi agent management interface 264 are implemented as cloud services in the cloud platform 120. In the illustrated example of FIG. 50, the example customer enterprise system 115 of FIG. 2 and/or FIG. 49 includes the example SDSi client agent 272, the example platform inventory management service 274, and the example entitlement management service 278 of FIG. 2. Additionally or alternatively, the example customer enterprise system 115 of FIG. 50 may include the example accounts management service 276 of the example of FIG. 2.

In the illustrated example of FIG. 50, the system 5000 includes an example implementation of the SDSi asset agent 140 of FIG. 1, and/or more generally, the semiconductor device 105 of FIG. 1, and/or an example implementation of the SDSi asset agents 140A-C of FIG. 49, and/or, more generally, the semiconductor devices 105A-C of FIG. 49. In the illustrated example of FIG. 50, the SDSi asset agents 140A-C include the example agent interface 202, the example agent local services 204, the example analytics engine 206, the example communication service(s) 208, the example agent CLI 210, the example agent daemon 212, the example license processor 214, the example agent library 218, and the example feature libraries 220-230 of FIG. 2 corresponding to the respective example feature sets 232-242 of FIG. 2 implemented by the example hardware circuitry 125, the example firmware 130, and/or the example BIOS 135 of FIG. 2.

In the illustrated example of FIG. 50, the analytics engine 206 includes an example trusted agent determiner 5004, an example certificate validator 5006, an example anomaly detector 5008, and example anomaly detection machine learning (ML) model(s) 5010.

In the illustrated example of FIG. 50, the analytics engine 206 includes the trusted agent determiner 5004 to determine and/or obtain reputation information (e.g., agent reputation information) associated with one(s) of the SDSi asset agents 140A-C. In some examples, the trusted agent determiner 5004 attests and/or otherwise executes attestation process(es) to determine a level of trustworthiness of the one(s) of the SDSi asset agents 140A-C. In such examples, the trusted agent determiner 5004 identifies one(s) of the SDSi asset agents 140A-C as trusted agent(s) (e.g., trusted SDSi agent(s)) based on the attestation. For example, in response to the first SDSi asset agent 140A being identified as a trusted agent, the first SDSi asset agent 140A can be an issuer (e.g., a trusted issuer) and/or a sender (e.g., a trusted sender) or transmitter (e.g., trusted transmitter). For example, an issuer is an agent that can obtain a license from the manufacturer enterprise system 110. In such examples, the issuer issues the license to a requesting one of the SDSi asset agents 140A-C. In some such examples, the issuer generates a certificate to confirm the successful activation or deactivation of the requested feature. In some examples, a sender is an agent that obtains a request to activate or deactivate a feature from one of the SDSi asset agents 140A-C and transmits the request to the manufacturer enterprise system 110.

In some examples, the trusted agent determiner 5004 determines whether a request has been received to activate and/or deactivate feature(s) of one(s) of the semiconductor devices 105A-C. In such examples, the trusted agent determiner 5004 identifies one(s) of the SDSi asset agents 140A-C as trusted agent(s). In some such examples, the trusted agent determiner 5004 selects a trusted agent from the identified trusted agent(s) to be a sender and/or an issuer to facilitate an issuance of corresponding license(s) based on the request.

In some examples, in response to a receipt of the request, the trusted agent determiner 5004 determines agent reputation score(s) of one(s) of the SDSi asset agents 140A-C to identify trusted agent(s). In some examples, the trusted agent determiner 5004 identifies one(s) of the SDSi asset agents 140A-C as trusted agent(s) based on the agent reputation scores. In some examples, the trusted agent determiner 5004 identifies the first SDSi asset agent 140A as a first trusted agent based on a first agent reputation score of the first SDSi asset agent 140A satisfying a threshold (e.g., a reputation score threshold, an agent reputation score threshold, a trusted reputation score threshold, a trusted agent reputation score threshold, etc.). For example, the trusted agent determiner 5004 determines that the first SDSi asset agent 140A has a first agent reputation score of 95 (e.g., a 95 out of a possible maximum agent reputation score of 100) and identifies the first SDSi asset agent 140A as the first trusted agent based on the first agent reputation score of 95 being greater than the threshold of 80 and, thus, satisfying the threshold. However, the first agent reputation score may be any other number, the first agent reputation score may be with respect to any other possible maximum agent reputation score, and/or the threshold may be any other number or representation of a threshold.

In some examples, the trusted agent determiner 5004 selects the first SDSi asset agent 140A as a trusted sender and/or a trusted issuer to execute the request for license(s) based on the first SDSi asset agent 140A having the highest agent reputation score of the SDSi asset agents 140A-C. In some examples, the trusted agent determiner 5004 selects the first SDSi asset agent 140 as a trusted sender and/or a trusted issuer based on a list of previously used trusted agents to ensure requests are distributed more evenly across all available and/or otherwise identified trusted agents. For example, the trusted agent determiner 5004 maintains a list (e.g., a trusted agent list) of N previously used trusted agents. In such examples, the trusted agent list includes the SDSi asset agents 140A-C. In some such examples, the trusted agent determiner 5004 queries and/or otherwise searches the list and determines based on the query that the first SDSi asset agent 140A has not been previously used to transmit an entitlement request. As used herein, entitlement requests refer to requests to activate, deactivate, etc., SDSi features of an asset, such as the semiconductor device 105. In some examples, an entitlement refers to an authorization to activate, deactivate, etc., one or more SDSi features of an asset, and a license refers to data and/or other things that cause activation, deactivation, etc., on the asset of the one or more SDSi features for which an entitlement has been granted. In some examples, the trusted agent determiner 5004 identifies the first SDSi asset agent 140A as the trusted agent in response to identifying the first SDSi asset agent 140 as not previously transmitting an entitlement request or, in some examples, in response to identifying the first SDSi asset agent 140A as not being used more recently than the second SDSi asset agent 140B and the third SDSi asset agent 140C.

In some examples, the trusted agent determiner 5004 determines agent reputation score(s) based on agent reputation score data. In such examples, the trusted agent determiner 5004 selects one of the SDSi asset agents 140A-C of interest to process. For example, the trusted agent determiner 5004 selects the first SDSi asset agent 140A to process. In such examples, the trusted agent determiner 5004 obtains certificate(s), renewed certificate(s), and/or agent information from the first SDSi asset agent 140A. In some such examples, the agent information includes an identifier of the first semiconductor device 105A, telemetry data reported by the first SDSi asset agent 140A, etc. In some such examples, the telemetry data includes an indication of whether a feature activation (or deactivation) was a success, a status of the SDSi feature affected by the activation (or deactivation) (e.g., such as the presently configured number of cores that are active, the presently active clock rate, etc.), a first odometer reading (e.g., first timestamp) indicating when the feature activation (or deactivation) occurred, a second odometer reading (e.g., a second timestamp) indicating whether the certificate was generated, etc.

In some examples, an initial agent reputation score is assigned by the manufacturer trusted agent determiner 1102 of the manufacturer enterprise system 110 to one(s) of the SDSi asset agents 140A-C based on an attestation protocol and/or an agent registration process. For example, the manufacturer trusted agent determiner 1102 issues an initial agent reputation score of 100 to the SDSi asset agents 140A-C because the level of trustworthiness is at a maximum after being commissioned from the silicon manufacturer. In some examples, the manufacturer trusted agent determiner 1102 invokes the SDSi agent management interface 264 to distribute the initial agent reputation scores to the SDSi asset agents 140A-C so that respective ones of the SDSi asset agents 140A-C maintain their own lists of agent reputation scores. In some examples, the trusted agent determiner 5004 of the SDSi asset agents 140A-C monitor and/or otherwise observe different ones of the SDSi asset agents 140A-C to identify anomalies, outliers, etc., associated with a number of licenses issued, a frequency of status broadcasts by the SDSi asset agents 140A-C, substantial changes in value(s) of feature(s) in license(s) issued by the SDSi asset agents 140A-C, etc. For example, the trusted agent determiner 5004 of the second SDSi asset agent 140B and the third SDSi asset agent 140C of the mesh network 4902 of FIG. 49 detect that the first SDSi asset agent 140A of the mesh network 4902 is abnormally behaving based on at least the criteria described above. In such examples, the trusted agent determiner 1102 of the second SDSi asset agent 140B lowers an agent reputation score of the first SDSi asset agent 140A by a first amount in a first list maintained by the second SDSi asset agent 140B and the trusted agent determiner 5004 of the third SDSi asset agent 140C lowers the agent reputation score of the first SDSi asset agent 140A by a second amount in a second list maintained by the third SDSi asset agent 140C. In some examples, the first amount is the same as the second amount while in other examples the first amount is different from the second amount.

In some examples, the trusted agent determiner 5004 of the second SDSi asset agent 140B and the third SDSi asset agent 140C of the mesh network 4902 of FIG. 49 detect that the first SDSi asset agent 140A of the mesh network 4902 is behaving as expected based on at least the criteria described above. For example, in response to the first SDSi asset agent 140A issuing a license to the first semiconductor device 105A that is consistent with typical behavior of an SDSi agent and/or is consistent with typical behavior of the first SDSi asset agent 140A, the trusted agent determiner 5004 of the second SDSi asset agent 140B and the third SDSi asset agent 140C determine an agent reputation score of the first SDSi asset agent 140A, an adjustment to the agent reputation score, etc., and/or a combination thereof. In some examples, the trusted agent determiner 5004 of the second SDSi asset agent 140B increases an agent reputation score of the first SDSi asset agent 140A by a first amount in a first list maintained by the second SDSi asset agent 140B and the trusted agent determiner 5004 of the third SDSi asset agent 140C increases the agent reputation score of the first SDSi asset agent 140A by a second amount in a second list maintained by the third SDSi asset agent 140C. For example, the trusted agent determiner of the second SDSi asset agent 140B and the third SDSi asset agent 140C determine the first amount and the second amount based on an issued certificate broadcasted from the first SDSi asset agent 140A to the mesh network 4902. In some examples, the first amount is the same as the second amount while in other examples the first amount is different from the second amount.

In some examples, the trusted agent determiner 5004 determine an agent reputation score based on whether one of the SDSi asset agents 140A-C reported a certificate to the manufacturer enterprise system 110. For example, the first SDSi asset agent 140A broadcasts a certificate to the mesh network 4902. In such examples, the second SDSi asset agent 140B and/or the third SDSi asset agent 140C report the broadcasted certificate to the manufacturer enterprise system 110. In some such examples, the manufacturer trusted agent 1102 invokes the SDSi agent management interface 264 to generate an alert, inform, notify, etc., the second SDSi asset agent 140B and/or the third SDSi asset agent 140C that the first SDSi asset agent 140A reported the certificate to the manufacturer enterprise system 110. In some such examples, the trusted agent determiner 5004 of the second SDSi asset agent 140B and/or the third SDSi asset agent 140C increase an agent reputation score of the first SDSi asset agent 140A in the list(s) of the second SDSi asset agent 140B and/or the third SDSi asset agent 140C. In other examples, the manufacturer trusted agent 1102 invokes the SDSi agent management interface 264 to generate an alert, inform, notify, etc., the second SDSi asset agent 140B and/or the third SDSi asset agent 140C that the first SDSi asset agent 140A did not report the certificate to the manufacturer enterprise system 110. In some such examples, the trusted agent determiner 5004 of the second SDSi asset agent 140B and/or the third SDSi asset agent 140C decrease an agent reputation score of the first SDSi asset agent 140A in the list(s) of the second SDSi asset agent 140B and/or the third SDSi asset agent 140C because the first SDSi asset agent 140A is abnormally behaving and/or otherwise not operating in a trustworthy manner.

In some examples, the trusted agent determiner 5004 blocks one(s) of the SDSi asset agents 140A-C based on an agent reputation score (e.g., by adding them to a blocked list). For example, the first SDSi asset agent 140A and the second SDSi asset agent 140B blocks the third SDSi asset agent 140C in response to an agent reputation score of the third SDSi asset agent 140C satisfying a blocked threshold. In such examples, the trusted agent determiner 5004 of the first SDSi asset agent 140A determines that the agent reputation score satisfies the blocked threshold based on the agent reputation score being lower than the blocked threshold. In some such examples, in response to the blocked threshold being satisfied, the first SDSi asset agent 140A adds the third SDSi asset agent 140C to a blocked list maintained by the first SDSi asset agent 140A. In some such examples, the trusted agent determiner 5004 of the first SDSi asset agent 140A determines that the agent reputation score of 60 satisfies the blocked threshold of 80 based on the agent reputation score of 60 being lower than the blocked threshold of 80.

In some examples, the trusted agent determiner 5004 allows access to one(s) of the SDSi asset agents 140A-C based on an agent reputation score (e.g., by adding them to an allowed list). For example, the first SDSi asset agent 140A and the second SDSi asset agent 140B allow access to the third SDSi asset agent 140C in response to an agent reputation score of the third SDSi asset agent 140C satisfying an allowed threshold. In such examples, the trusted agent determiner 5004 of the first SDSi asset agent 140A determines that the agent reputation score of the third SDSi asset agent 140C satisfies the allowed threshold based on the agent reputation score being higher than the whitest threshold (or a blocked threshold). In some such examples, in response to the allowed threshold being satisfied, the first SDSi asset agent 140A adds the third SDSi asset agent 140C to an allowed list maintained by the first SDSi asset agent 140A. In some such examples, the trusted agent determiner 5004 of the first SDSi asset agent 140A determines that the agent reputation score of 90 satisfies the allowed threshold of 80 based on the agent reputation score of 90 being higher than the allowed threshold of 80.

In some examples, the trusted agent determiner 5004 evaluates whether an agent reputation score associated with an SDSi asset agent satisfies the allowed threshold in response to obtaining a license from the SDSi asset agent. For example, the first SDSi asset agent 140A may receive a license from the second SDSi asset agent 140B. In such examples, the first SDSi asset agent 140A may compare the agent reputation score of the second SDSi asset agent 140B to the allowed threshold prior to invoking the license to ensure that the license has not been compromised by a malicious actor. In some such examples, the first SDSi asset agent 140A invokes the license in response to determining that the agent reputation score satisfies the allowed threshold. In some such examples, the first SDSi asset agent 140A discards the license in response to determining that the agent reputation score does not satisfy the allowed threshold.

Advantageously, in some examples, the trusted agent determiner 5004 communicates with different one(s) of the SDSi asset agents 140A-C for improved security. For example, to prevent the first semiconductor device 105A from communicating with only the second SDSi agent 140B, which may be compromised and/or otherwise controlled by a malicious actor or attacker, the first SDSi agent 140A may cycle through one(s) of the SDSi agents 140A-C. For example, the first SDSi agent 140A may cycle through one(s) of the SDSi agents 140A-C in a random pattern, a round robin pattern, etc., or any other type of pattern. In some examples, the first SDSi agent 140A may communicate with the second SDSi agent 140B during a first interaction, the third SDSi agent 140C during a second interaction, etc. In some such examples, after communicating with the second SDSi agent 140B during the first interaction, the first SDSi agent 140A may initiate a counter, a timer, etc., to determine a time period during which the second SDSi agent 140B is not to be communicated with. In response to the counter, the timer, etc., triggering the end of the time period, the first SDSi agent 140A may communicate again with the second SDSi agent 140B.

In some examples, the trusted agent determiner 5004 determines an agent reputation score based on a fingerprint (e.g., an agent fingerprint) determined by a runtime measurement. For example, the SDSi asset agents 140A-C request (e.g., periodically request, asynchronously request, etc.) runtime measurements from different ones of the SDSi asset agents 140A-C. Example runtime measurements include a hashed and/or otherwise cryptographically generated measurement of an application (e.g., application code, machine readable instructions, etc.) in memory, a counter value (e.g., a hardware counter value, a CPU counter value, etc.), etc. In some examples, the runtime measurements are indicative of, representative of, and/or otherwise correspond to a fingerprint of an agent, and/or, more generally, a semiconductor device.

In some examples, the trusted agent determiner 5004 determines an agent reputation score based on a comparison of a fingerprint obtained from a first agent to a stored fingerprint in a second agent. For example, the trusted agent determiner 5004 of the first SDSi asset agent 140A queries the second SDSi asset agent 140B for a runtime measurement. In such examples, the trusted agent determiner 5004 of the second SDSi asset agent 140B obtains a runtime measurement associated with hardware of the second semiconductor device 105B, such as a CPU counter value, and cryptographically signs the runtime measurement to generate a digital signature (e.g., an electronic signature). For example, the trusted agent determiner 5004 of the second SDSi asset agent 140B generates the digital signature by executing an algorithm (e.g., a cryptographic algorithm, an encryption algorithm, etc.) to transform first data (e.g., a runtime measurement) into second data (e.g., cryptographical data, cipher text, unreadable cipher text, etc.) that is unreadable to an unauthorized device or user. In some examples, the second SDSi asset agent 140B transmits the digital signature, the signed runtime measurement (e.g., the cryptographically signed runtime measurement), etc., to the first SDSi asset agent 140A. In such examples, the trusted agent determiner 5004 of the first SDSi asset agent 140A decrypts the digital signature by executing an algorithm (e.g., a cryptographic algorithm, a decryption algorithm, etc.) to make the underlying runtime measurement readable to the trusted agent determiner 5004. In some such examples, the trusted agent determiner 5004 uses a key (e.g., an asymmetric key, a symmetric key, etc.) to make the cryptographically protected runtime measurement readable.

In some examples, the trusted agent determiner 5004 of the first SDSi asset agent 140A compares the decrypted runtime measurement to a stored runtime measurement that is associated with the second SDSi asset agent 140B. For example, the stored runtime measurement is included in and/or otherwise stored in a file (e.g., a signed known good measurement file) that is stored in the mesh of the SDSi asset agents 140A-C, and/or, more generally, the mesh network 4902. In such examples, the file is returned to the one of the SDSi asset agents 140A-C that is acting and/or otherwise operating as a certification or validation authority on call of the one of the SDSi asset agents 140A-C being attested. In some such examples, different versions of the file are stored in different ones of the SDSi asset agents 140A-C due to untimely synchronization. The respective files have a security version number (SVN). In some examples, the file having the highest SVN, which is indicative of the most recent or most up-to-date file, is returned to the certification authority for the purposes of runtime measurement attestation.

In some examples, in response to determining that the measurements match based on the comparison, the trusted agent determiner 5004 of the first SDSi asset agent 140B increases an agent reputation score of the second SDSi asset agent 140B. In other examples, in response to determining that the measurements do not match based on the comparison, the trusted agent determiner 5004 of the first SDSi asset agent 140A decreases the agent reputation score of the second SDSi asset agent 140B. In some such examples, the mismatch of the runtime measurements is indicative that the second SDSi asset agent 140B has been compromised, manipulated (e.g., maliciously manipulated), etc., and/or is otherwise a rogue or malicious agent or actor.

In some examples, the trusted agent determiner 5004 implements means for determining a trusted agent. For example, the means for determining determines respective reputation scores associated with a plurality of agents in a mesh network, the plurality of agents associated with a plurality of semiconductor devices, respective ones of the semiconductor devices including circuitry configurable to provide one or more features. In such examples, the means for determining selects, based on the respective reputation scores, a first agent from the plurality of the agents to transmit a request to activate or deactivate at least one of the one or more features. In some examples, the request is a first request transmitted at a first time, and the means for determining determines whether the first agent transmitted a second request at a second time prior to the first time, and in response to determining that the first agent did not transmit the second request, selects the first agent to transmit the first request. In some examples, the means for determining queries the first agent for a cryptographically signed runtime measurement associated with a resource of the semiconductor device, compares the cryptographically signed runtime measurement to a validated cryptographically signed runtime measurement, broadcasts a validation result based on the comparison to the mesh network to cause the plurality of the agents to store the validation result, and in response to the validation result indicating a match, adds the first agent to an allowed list. In some examples, the means for determining blocks the first agent in response to the validation result not indicating a match, and drops future broadcasts from the first agent. In this example, the means for determining is implemented by any processor structured to perform the corresponding operation by executing software or firmware, or hardware circuit (e.g., discrete and/or integrated analog and/or digital circuitry, an FPGA, a PLD, a FPLD, an ASIC, a comparator, an operational-amplifier (op-amp), a logic circuit, etc.) structured to perform the corresponding operation without executing software or firmware, but other structures are likewise appropriate.

In some examples, the agent interface 202 implements means for interfacing with an agent. For example, the means for interfacing broadcasts an activation or deactivation of one or more features to a mesh network to cause the means for determining to update the reputation score of the first agent in response to the request. In this example, the means for interfacing is implemented by any processor structured to perform the corresponding operation by executing software or firmware, or hardware circuit (e.g., discrete and/or integrated analog and/or digital circuitry, an FPGA, a PLD, a FPLD, an ASIC, a comparator, an operational-amplifier (op-amp), a logic circuit, etc.) structured to perform the corresponding operation without executing software or firmware, but other structures are likewise appropriate.

In the illustrated example of FIG. 50, the analytics engine 206 includes the certificate validator 5006 to renew certificate(s) associated with trusted agent(s) of the mesh network 4902. In some examples, to effectuate security of the system 5000 of FIG. 50, trusted agent(s) are requested (e.g., periodically requested, asynchronously requested, etc.) to renew certificates by invalidating feature activation. For example, the certificate validator 5006 of the first SDSi asset agent 140A identifies the second semiconductor device 105B to validate by renewing certificate(s) associated with the second semiconductor device 105B. In such examples, the certificate validator 5006 determines certification information, such as a current asset status, activated feature(s), and/or license issuer(s) associated with certificate(s) of the second semiconductor device 105B.

In some examples, the certificate validator 5006 implements means for validating a certificate. For example, the means for determining determines a first reputation score of a first agent based on a renewal of a license issued to a first semiconductor device of a plurality of semiconductor devices associated with the first agent, and the means for validating determines an asset status of the first semiconductor device, determines a feature activated on the first semiconductor device, determine an issuer of the license that invoked an activation of the feature, cryptographically signs renew request data including data associated with at least one of the asset status, the feature, or the issuer, and transmits the cryptographically signed renew request data to cause a server to determine whether to facilitate the renewal of the license. In some examples, the means for validating, in response to obtaining a renewed license from the server, provisions the renewed license to the first semiconductor device and generates a renewal certificate. In such examples, the means for interfacing broadcasts the renewal certificate to the mesh network, and the means for determining updates the reputation score of the first agent based on the renewal certificate. In this example, the means for validating is implemented by any processor structured to perform the corresponding operation by executing software or firmware, or hardware circuit (e.g., discrete and/or integrated analog and/or digital circuitry, an FPGA, a PLD, a FPLD, an ASIC, a comparator, an operational-amplifier (op-amp), a logic circuit, etc.) structured to perform the corresponding operation without executing software or firmware, but other structures are likewise appropriate.

In some examples, the certificate validator 5006 de-activates the activated feature(s) based on the certificate information. In such examples, the certificate validator 5006 of the second SDSi asset agent 140B transmits a renew request (e.g., a renew certificate request) to the manufacturer enterprise system 110. In some such examples, the certificate validator 5006 of the second SDSi asset agent 140B cryptographically signs the renew request which, in some examples, includes the certificate information or portion(s) thereof. In response to obtaining the renew request, the SDSi feature management service 256 determines whether to renew the certificate(s) previously issued to the second semiconductor device 105B. For example, the SDSi feature management service 256 determines to renew the request based on an agent reputation score of the second SDSi asset agent 140B satisfying a threshold, determining that the certificate(s) were previously reported to the mesh network 4902 and/or the manufacturer enterprise system 110, etc., and/or a combination thereof. In some examples, the SDSi feature management service 256 determines not to renew the request based on the agent reputation score of the second SDSi asset agent 140B not satisfying the threshold, determining that the certificate(s) were not previously reported to the mesh network 4902 and/or the manufacturer enterprise system 110, etc., and/or a combination thereof, which is/are indicative of the second SDSi asset agent 140B being a rogue and/or otherwise compromised agent.

In some examples, in response to the SDSi feature management service 256 determining not to renew the request, the SDSi management service 256 invokes the SDSi agent management interface 264 to generate an alert, inform, notify, etc., one(s) of the SDSi asset agents 140A-C that the second SDSi asset agent 140B is not having the certificate(s) renewed. In such examples, the first SDSi asset agent 140A, the third SDSi agent 140C, etc., decrease an agent reputation score of the second SDSi asset agent 140B based on the alert, the informing, the notification, etc.

In some examples, in response to determining to renew the request, the SDSi feature management service 256 invokes the SDSi agent management interface 264 to generate an alert, inform, notify, etc., one(s) of the SDSi asset agents 140A-C that the second SDSi asset agent 140B is having the certificate(s) renewed. In such examples, the first SDSi asset agent 140A, the third SDSi agent 140C, etc., increase an agent reputation score of the second SDSi asset agent 140B based on the alert, the informing, the notification, etc.

In some examples, in response to the SDSi feature management service 256 determining to renew the request, the license processor 214 of the second SDSi asset agent 140B facilitates provisioning of the license to the second SDSi asset agent 140B by re-activating the de-activated feature(s). In such examples, in response to a successful reactivation, the agent analytics engine 206 generates a certificate. In some such examples, the agent analytics engine 206 invokes the agent interface 202 to broadcast the renewed certificate(s) to the mesh network 4902. In some examples, in response to receiving the broadcast, the trusted agent determiner 5004 of the first SDSi asset agent 140A and the third SDSi asset agent 140C increase the agent reputation score of the second SDSi asset agent 140B based on the renewed certificate(s), which is indicative of the second SDSi asset agent 140B being trustworthy and/or otherwise unlikely to be a rogue or compromised agent.

In the illustrated example of FIG. 50, the analytics engine 206 includes the anomaly detector 5008 to use artificial intelligence to analyze broadcasts from ones of the SDSi asset agents 140A-C to detect and/or otherwise identify one or more anomalies. In some examples, the anomaly detector 5008 analyzes the broadcasts from not blocked one(s) of the SDSi asset agents 140A-C and/or otherwise from one(s) of the SDSi asset agents 140A-C having relatively high agent reputation scores. In such examples, the anomaly detector 5008 may not analyze anomalies in broadcasts from blocked one(s) of the SDSi asset agents 140A-C because the trusted agent determiner 5004, and/or, more generally, a corresponding one of the SDSi asset agents 140A-C ignores the broadcasts from the blocked one(s) of the SDSi asset agents 140A-C.

In some examples, the anomaly detector 5008 executes one or more AI models, such as the anomaly detection machine learning (ML) model(s) 5010 of the example of FIG. 50. In such examples, the anomaly detector 5008 executes the anomaly detection ML model(s) 5010 to analyze trend(s) in a number of issued licenses, a number of activated (or deactivated) features, a value of respective one(s) of the activated (or deactivated) features, etc., and/or a combination thereof. In some such examples, the anomaly detection ML model(s) 5010 output and/or otherwise determine whether differences (e.g., significant differences, substantial differences, etc.) or deviations (e.g., significant deviations, substantial deviations, etc.) are detected based on the AI analysis. In some such examples, the anomaly detector 5008 invokes the trusted agent determiner 5004 to reduce and/or otherwise lower a score for the one of the SDSi asset agents 140A-C associated with the detected anomalies.

In some examples, the analytics engine 206 includes the anomaly detector 5008 to use AI, including ML, deep learning (DL), and/or other artificial machine-driven logic, to enable the analytics engine 206, and/or, more generally, the SDSi asset agent 140A-C to use a model, such as the anomaly detection ML model(s) 5010, to process input data (e.g., certificate data, license data, information included in a broadcast to the mesh network 4902, etc.) to generate an output (e.g., a detection or identification of one or more anomalies or deviations) based on patterns, trends, and/or associations previously learned by the model via a training process. For instance, the anomaly detector 5008 trains the anomaly detection ML model(s) 5010 with data to recognize patterns, trends, and/or associations and follow such patterns, trends, and/or associations when processing input data such that other input(s) result in output(s) consistent with the recognized patterns, trends, and/or associations.

In some examples, the anomaly detector 5008 implements means for detecting an anomaly. For example, the means for detecting executes a machine learning model to detect an anomaly associated with a license, and, in response to a detection of the anomaly, updates a reputation score associated with a second agent of the plurality of the agents based on the anomaly. In this example, the means for detecting is implemented by any processor structured to perform the corresponding operation by executing software or firmware, or hardware circuit (e.g., discrete and/or integrated analog and/or digital circuitry, an FPGA, a PLD, a FPLD, an ASIC, a comparator, an operational-amplifier (op-amp), a logic circuit, etc.) structured to perform the corresponding operation without executing software or firmware, but other structures are likewise appropriate.

Many different types of machine learning models and/or machine learning architectures exist. In some examples, a neural network model is used to implement the anomaly detection ML model(s) 5010. Using a neural network model enables the example anomaly detector 5008 to analyze patterns in certificates, licenses, etc., broadcasted to the mesh network 4902 and identify any anomalies or deviations based on the patterns. In general, ML models/architectures that are suitable to use in the example approaches disclosed herein include recurrent neural networks. However, other types of machine learning models could additionally or alternatively be used such as supervised learning artificial neural network models. Example supervised learning artificial neural network models include two-layer (2-layer) radial basis neural networks (RBN), learning vector quantization (LVQ) classification neural networks, etc.

The example anomaly detector 5008 and/or the example anomaly detection ML model(s) 5010 implement(s) an AI/ML system using two phases, a learning/training phase and an inference phase. In the learning/training phase, the anomaly detector 5008 executes a training algorithm to train the anomaly detection ML model(s) 5010 to operate in accordance with patterns, trends, and/or associations based on, for example, training data. In general, the anomaly detection ML model(s) 5010 includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be model hyperparameters that are determined prior to initiating the training process.

The example anomaly detector 5008 may deploy different types of training based on the type of AI/ML model of the anomaly detection ML model(s) 5010 and/or the expected output. In some examples, the anomaly detector 5008 deploys supervised training to use inputs and corresponding expected (e.g., labeled) outputs to select parameters (e.g., by iterating over combinations of select parameters) for the anomaly detection ML model(s) 5010 to reduce model error. As used herein, labelling refers to an expected output of the anomaly detection ML model(s) 5010 (e.g., a classification, an expected output value, etc.). In some examples, the anomaly detector 5008 deploys unsupervised training (e.g., used in deep learning, a subset of machine learning, etc.) to use inferring patterns from inputs to select parameters for the anomaly detection ML model(s) 5010 (e.g., without the benefit of expected (e.g., labeled) outputs).

In some examples, the anomaly detector 5008 trains the anomaly detection ML model(s) 5010 using unsupervised learning. In some examples, the anomaly detector 5008 trains the anomaly detection ML model(s) 5010 using stochastic gradient descent. However, any other training algorithm may additionally or alternatively be used. In some examples, the anomaly detector 5008 can perform training of the anomaly detection ML model(s) 5010 until the level of error is no longer reducing. In some examples, the anomaly detector 5008 executes the training by performing the training locally on the semiconductor device 105A-C. In some examples, the training is performed remotely at an external computing system (e.g., the manufacturer enterprise system 110, the customer enterprise system 115, etc.) communicatively coupled to the semiconductor device 105A-C.

In some examples, the anomaly detector 5008 performs the training of the anomaly detection ML model(s) 5010 using hyperparameters that control how the learning is performed (e.g., a learning rate, a number of layers to be used in the anomaly detection ML model(s) 5010, etc.). In some examples, hyperparameters that control model performance and training speed are the learning rate and regularization parameter(s). Such hyperparameters are selected by, for example, trial and error, a customer associated with the customer enterprise system 115 based on one or more requirements or specifications, etc., to reach an optimal model performance. In some examples, the anomaly detector 5008 utilizes Bayesian hyperparameter optimization to determine an optimal and/or otherwise improved or more efficient network architecture to avoid model overfitting and improve model's overall applicability. In some examples, the anomaly detector 5008 determines that re-training of the anomaly detection ML model(s) 5010 is to be performed. In such examples, the anomaly detector 5008 determines to execute such re-training in response to a predetermined time period elapsing, a quantity of certificate data, license data, etc., obtained from the mesh network 4902, a receipt of a re-training request by a user or external computing system, etc., and/or a combination thereof.

Training is performed using training data. In some examples, the training data originates from locally generated data, such as telemetry data from the SDSi asset agents 140A-C. In some examples where supervised training is used, the training data is labeled. Labeling is applied to the training data by a user manually or by an automated data pre-processing system. In some examples, the training data is pre-processed using, for example, an interface (e.g., the agent interface 202), or other portion of the SDSi asset agent 140A-C, such as the trusted agent determiner 5004, the certificate validator 5006, the anomaly detector 5008, etc., to determine training data. In some examples, the anomaly detector 5008 sub-divides the training data into two or more portions, such as a first portion of data for training the model and a second portion of data for validating the model.

Once training is complete, the example anomaly detector 5008 deploys the anomaly detection ML model(s) 5010 for use as an executable construct that processes an input and provides an output based on the network of nodes and connections defined in the anomaly detection ML model(s) 5010. The anomaly detection ML model(s) 5010 is stored in memory of the SDSi asset agent 140A-C, the semiconductor device 105A-C, etc., or in a database of a remote computing system, such as one or more servers associated with at least one of the manufacturer enterprise system 110 or the customer enterprise system 115. The example anomaly detector 5008 may then execute the example anomaly detection ML model(s) 5010 to detect anomalies associated with broadcast(s) from one(s) of the example SDSi asset agents 140A-C.

Once trained, the example deployed anomaly detection ML model(s) 5010 may be operated in an inference phase to process data. In the inference phase, data to be analyzed (e.g., live data) is input to the example anomaly detection ML model(s) 5010, and the anomaly detection ML model(s) 5010 execute(s) to create an output. By way of example, this inference phase can be thought of as the AI “thinking” to generate the output based on what it learned from the training (e.g., by executing the model to apply the learned patterns and/or associations to the live data). In some examples, input data undergoes pre-processing before being used as an input to the anomaly detection ML model(s) 5010. Moreover, in some examples, the output data may undergo post-processing after it is generated by the anomaly detection ML model(s) 5010 to transform the output into a useful result (e.g., a display of data, an instruction to be executed by a machine, etc.).

In some examples, output(s) of the deployed anomaly detection ML model(s) 5010 may be captured and provided as feedback. By analyzing the feedback, an accuracy of the deployed model can be determined. If the feedback indicates that the accuracy of the deployed model is less than a threshold or other criterion, the example anomaly detector 5008 triggers training of an updated model using the feedback and an updated training data set, hyperparameters, etc., to generate an updated, deployed one(s) of the example anomaly detection ML model(s) 5010.

In the illustrated example of FIG. 50, the hardware circuitry 125, the firmware 130, and/or the BIOS 135 implement an example feature intent determiner 5012 and example feature intent machine learning (ML) model(s) 5012. In some examples, the feature intent determiner 5012 determine an intent or expected outcome of a request to change a hardware asset, such as the semiconductor devices 105A-C, post manufacture. Typically, tools provided by silicon product manufacturers require an operator, a user, etc., to know details about features that need to activated or deactivated. Such a request to change the hardware asset may be in response to a customer order for manufacturing a server platform, an increased workload caused by a peak in computing and/or network traffic experienced by a customer associated with the customer enterprise system 115, etc. Such examples of bases for the request may require deep knowledge of the workload and understanding of the available hardware, software, and/or firmware features of the semiconductor devices 105A-C. In some such examples, the capability of changing a configuration of an asset by a customer may not be fully leveraged, which may lead to suboptimal asset utilization and/or increased costs. In some examples, a specific combination of features may result in better performance while another combination of other features may significantly decrease performance of execution. In such examples, the complexity of such dependencies increases with subsequent generations of semiconductor devices because of new features being introduced or existing features being modified.

Advantageously, the example feature intent determiner 5012 reduces the complexity of understanding features of the semiconductor device 105A-C when requesting a configuration change to improve performance of execution of computing workloads. For example, a configuration change of the semiconductor device 105A-C may include an activation of one or more first features, an activation of one or more second features, a deactivation of one or more third features, and/or a deactivation of one or more fourth features. In some examples, the feature intent determiner 5012 obtains a request for a configuration change of one(s) of the semiconductor devices 105A-C. In such examples, the request is based on and/or otherwise formatted according to a high-level meta-language to enable a requester (e.g., a user, a computing device, etc.) to define an expected outcome of the configuration change.

In some examples, the feature intent determiner 5012 deploys a language parser (e.g., a language parsing engine) to translate the request for the configuration change into one or more requirements associated with availability, machine learning, performance, reliability, security, etc., and translate the one or more requirements into one or more features of the semiconductor device 105A-C that, when activated, deliver the configuration change in accordance with the expected outcome. In such examples, the feature intent determiner 5012 invokes execution of the feature intent ML model(s) 5014 to determine whether to adjust and/or otherwise modify the one or more features identified by the feature intent determiner 5012. In some examples, in response to an identification of the one or more features, the modified one(s) of the one or more features, etc., the feature intent determiner 5012 invokes the license processor 214 to obtain (e.g., automatically obtain) the corresponding license(s) for the identified feature(s).

In some examples, the feature intent ML model(s) 5014 obtain(s) data (e.g., training data) from the mesh network 4902, the manufacturer enterprise network 110, and/or the customer enterprise network 115. Such example data includes system diagnostics and/or information associated with workloads previously executed, currently being executed, and/or in a queue to be processed by one(s) of the semiconductor devices 105A-C. Advantageously, the example feature intent determiner 5012 and/or the example feature intent ML model(s) 5014 implement a self-learning AI/ML system to adaptively handle and/or otherwise execute dynamically changing workloads with optimum and/or otherwise improved performance.

In some examples, the hardware circuitry 125, the firmware 130, and/or the BIOS 135 include the feature intent determiner 5012 to use AI, including ML, DL, and/or other artificial machine-driven logic, to use a model, such as the feature intent ML model(s) 5014, to process input data (e.g., system diagnostics, workload data, requested features, requirements, etc.) to generate an output (e.g., one or more features to be activated (or deactivated) based on patterns, trends, and/or associations previously learned by the feature intent ML model(s) 5014 via a training process. For instance, the feature intent determiner 5012 trains the feature intent ML model(s) 5014 with data to recognize patterns, trends, and/or associations and follow such patterns, trends, and/or associations when processing input data such that other input(s) result in output(s) consistent with the recognized patterns, trends, and/or associations.

In some examples, a neural network model is used to implement the feature intent ML model(s) 5014. Using a neural network model enables the example feature intent determiner 5012 to analyze patterns in system diagnostics, workloads, requested features, etc., broadcasted to the mesh network 4902 and/or stored by at least one of the manufacturer enterprise system 110 or the customer enterprise system 115. In some examples, other types of machine learning models could additionally or alternatively be used to implement the feature intent ML model(s) 5014, such as supervised learning artificial neural network models.

The example feature intent determiner 5012 and/or the example feature intent ML model(s) 5014 implement(s) an AI/ML system using two phases, a learning/training phase and an inference phase. In the learning/training phase, the example feature intent determiner 5012 executes a training algorithm to train the example feature intent ML model(s) 5014 to operate in accordance with patterns, trends, and/or associations based on, for example, training data. In general, the feature intent ML model(s) 5014 include(s) internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be model hyperparameters that are determined prior to initiating the training process.

The example feature intent determiner 5012 may deploy different types of training based on the type of AI/ML model of the feature intent ML model(s) 5014 and/or the expected output. In some examples, the feature intent determiner 5012 deploys supervised training to use inputs and corresponding expected (e.g., labeled) outputs to select parameters (e.g., by iterating over combinations of select parameters) for the feature intent ML model(s) 5014 to reduce model error. As used herein, labelling refers to an expected output of the feature intent ML model(s) 5014 (e.g., a classification, an expected output value, etc.). In some examples, the feature intent determiner 5012 deploys unsupervised training (e.g., used in deep learning, a subset of machine learning, etc.) to use inferring patterns from inputs to select parameters for the feature intent ML model(s) 5014 (e.g., without the benefit of expected (e.g., labeled) outputs).

In some examples, the feature intent determiner 5012 trains the feature intent ML model(s) 5014 using unsupervised learning. In some examples, the feature intent determiner 5012 trains the feature intent ML model(s) 5014 using stochastic gradient descent. However, any other training algorithm may additionally or alternatively be used. In some examples, the feature intent determiner 5012 can perform training of the feature intent ML model(s) 5014 until the level of error is no longer reducing. In some examples, the feature intent determiner 5012 executes the training by performing the training locally on the semiconductor device 105A-C. In some examples, the training is performed remotely at an external computing system (e.g., the manufacturer enterprise system 110, the customer enterprise system 115, etc.) communicatively coupled to the semiconductor device 105A-C.

In some examples, the feature intent determiner 5012 performs the training of the feature intent ML model(s) 5014 using hyperparameters that control how the learning is performed (e.g., a learning rate, a number of layers to be used in the feature intent ML model(s) 5014, etc.). In some examples, hyperparameters that control model performance and training speed are the learning rate and regularization parameter(s). Such hyperparameters are selected by, for example, trial and error, a customer associated with the customer enterprise system 115 based on one or more requirements or specifications, etc., to reach an optimal model performance. In some examples, the feature intent determiner 5012 utilizes Bayesian hyperparameter optimization to determine an optimal and/or otherwise improved or more efficient network architecture to avoid model overfitting and improve model's overall applicability. In some examples, the feature intent determiner 5012 determines that re-training of the feature intent ML model(s) 5014 is to be performed. In such examples, the feature intent determiner 5012 determines to execute such re-training in response to a predetermined time period elapsing, a quantity of system diagnostics, workload data, etc., obtained from the mesh network 4902, a receipt of a re-training request by a user or external computing system, etc., and/or a combination thereof.

Training is performed using training data. In some examples, the training data originates from locally generated data, such as telemetry data from the SDSi asset agents 140A-C, the system diagnostics, the workload data, etc. In some examples where supervised training is used, the training data is labeled. Labeling is applied to the training data by a user manually or by an automated data pre-processing system. In some examples, the training data is pre-processed using, for example, an interface (e.g., the agent interface 202) or other portion of the SDSi asset agent 140A-C to determine training data. In some examples, the feature intent determiner 5012 sub-divides the training data into two or more portions, such as a first portion of data for training the model and a second portion of data for validating the model.

Once training is complete, the example feature intent determiner 5012 deploys the feature intent ML model(s) 5014 for use as an executable construct that processes an input and provides an output based on the network of nodes and connections defined in the feature intent ML model(s) 5014. The example feature intent ML model(s) 5014 is stored in memory of the semiconductor device 105A-C, etc., or in a database of a remote computing system, such as one or more servers associated with at least one of the example manufacturer enterprise system 110 or the example customer enterprise system 115. The example feature intent determiner 5012 may then execute the example feature intent ML model(s) 5014 to determine one or more features to activate based on an intent or expected outcome from a request to change a configuration of one(s) of the example semiconductor devices 105A-C.

Once trained, the deployed feature intent ML model(s) 5014 may be operated in an inference phase to process data. In the inference phase, data to be analyzed (e.g., live data) is input to the example feature intent ML model(s) 5014, and the feature intent model(s) 5014 execute(s) to create an output. In some examples, input data undergoes pre-processing before being used as an input to the feature intent ML model(s) 5014. Moreover, in some examples, the output data may undergo post-processing after it is generated by the feature intent ML model(s) 5014 to transform the output into a useful result (e.g., a display of data, an instruction to be executed by a machine, etc.).

In some examples, output(s) of the deployed feature intent ML model(s) 5014 may be captured and provided as feedback. By analyzing the feedback, an accuracy of the deployed model can be determined. If the feedback indicates that the accuracy of the deployed model is less than a threshold or other criterion, the example feature intent determiner 5012 triggers training of an updated model using the feedback and an updated training data set, hyperparameters, etc., to generate an updated, deployed one(s) of the example feature intent ML model(s) 5014.

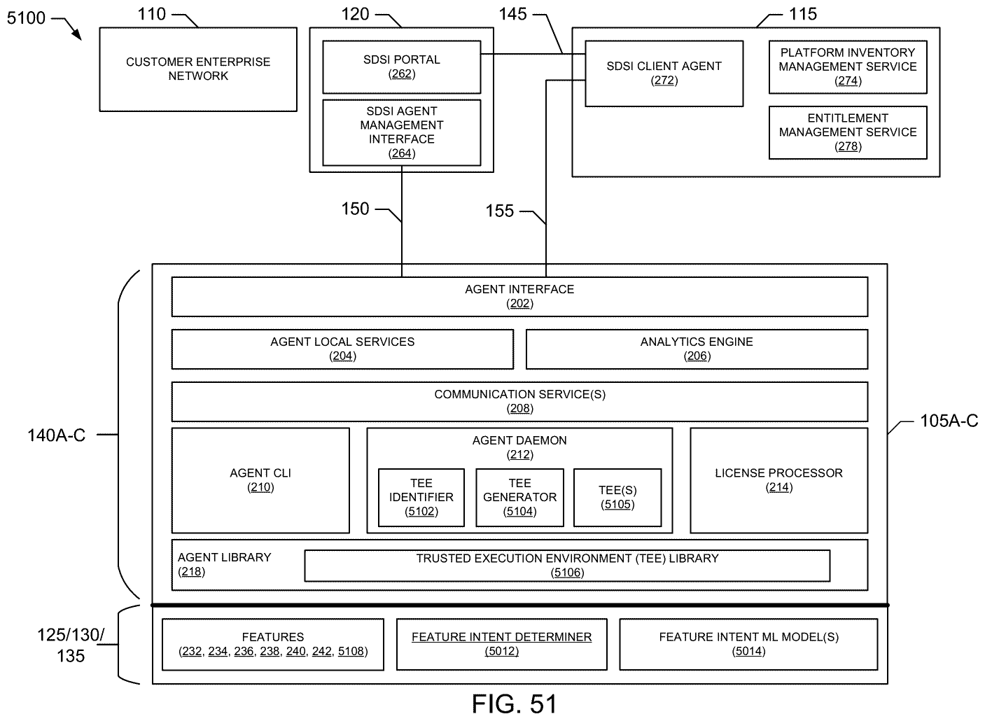

FIG. 51 depicts a block diagram of an example system 5100 that illustrates example implementations of the SDSi asset agent 140 and/or one(s) of the SDSi asset agents 140A-C, the manufacturer enterprise system 110, and the customer enterprise system 115 included in the example system 100 of FIG. 1, the example system 4900 of FIG. 49, and/or the example system 5000 of FIG. 50. In the illustrated example of FIG. 51, the system 5100 includes the example SDSi portal 262 and the example SDSi agent management interface 264 of FIG. 2. In the example of FIG. 51, the example SDSi portal 262 and the example SDSi agent management interface 264 are implemented as cloud services in the cloud platform 120. In the illustrated example of FIG. 51, the example customer enterprise system 115 of FIG. 2, FIG. 49, and/or FIG. 50 includes the example SDSi client agent 272, the example platform inventory management service 274, and the example entitlement management service 278 of FIG. 2. Additionally or alternatively, the example customer enterprise system 115 of FIG. 51 may include the example accounts management service 276 of the example of FIG. 2.

In the illustrated example of FIG. 51, the system 5100 includes an example implementation of the SDSi asset agent 140 of FIG. 1, and/or more generally, the semiconductor device 105 of FIG. 1, and/or an example implementation of the SDSi asset agents 140A-C of FIG. 49, and/or, more generally, the semiconductor devices 105A-C of FIG. 49. In the illustrated example of FIG. 51, the SDSi asset agents 140A-C include the example agent interface 202, the example agent local services 204, the example analytics engine 206, the example communication service(s) 208, the example agent CLI 210, the example agent daemon 212, the example license processor 214, the example agent library 218, and the example feature libraries 220-230 of FIG. 2 corresponding to the respective example feature sets 232-242 of FIG. 2 implemented by the example hardware circuitry 125, the example firmware 130, and/or the example BIOS 135 of FIG. 2.

In the illustrated example of FIG. 51, the agent daemon 212 includes an example trusted execution environment (TEE) identifier 5102, an example TEE generator 5104, and example TEE(s) 5105. In the illustrated example of FIG. 51, the agent library 218 includes an example TEE library 5106. In the illustrated example of FIG. 51, the hardware circuitry 125, the firmware 130, and/or the BIOS 135 include example TEE component(s) 1208, the feature intent determiner 5012 of FIG. 50, and the feature intent ML model(s) 5014 of FIG. 50.

The example agent daemon 212 securely executes the elements of the SDSi asset agent 140A-C. For example, the agent daemon 212 executes one or more of the agent interface 202, the agent local services 204, the analytics engine 206, the communication services 208, the agent CLI 210, and/or the license processor 214 in a protected environment, such as one(s) of the trusted execution environment(s) (TEE(s)) 5105, implemented by the semiconductor device 105A-C. The SDSi asset agent 140A-C of the illustrated example includes the agent library 218 to provide, among other things, hardware-agnostic application programming interfaces (APIs), such as TEE APIs included in the TEE library 5106.

In some examples, the agent daemon 212 invokes the TEE generator 5104 to generate an execution environment, such as one(s) of the TEE(s) 5105, that allows an application to run in a resource envelope that has the necessary TEE component(s) 1208, such as trusted execution, trusted memory, trusted storage, etc., to protect application specific secrets or other data in compliance with the highest certifications. Prior security technologies must be purpose built to leverage a TEE and must therefore be deployed into an end user environment as a combination of hardware and software that greatly increases the cost and complexity of the overall security solution. Advantageously, the example agent daemon 212 enables an application (e.g., software) to operate at two or more levels of intelligence and allow an application architecture that is not coupled (e.g., tightly coupled, integrated, etc.) to a particular TEE technology from a hardware perspective. In some examples, the agent daemon 212, at a first level of intelligence, can allow an instance of the application to leverage and/or otherwise take advantage of an available TEE identified by the TEE identifier 5102 to which the application has access, either local or remote to the semiconductor device 105A-C. In some examples, the agent daemon 214, at a second level of intelligence, can invoke the TEE generator 5104 to compose, assemble, compile, and/or otherwise generate the TEE(s) 5105 from one or more of the TEE component(s) 1208 to meet desired security requirements. In such examples, the agent daemon 214 invokes the TEE generator 5104 to generate the TEE(s) 5105 in response to a determination that a standard or known TEE is not available or leverage a software-based TEE definable by the TEE library 5106.

In the illustrated example of FIG. 51, the agent daemon 212 includes the TEE identifier 5102 to explore an environment (e.g., an execution environment) of a semiconductor device, such as the semiconductor devices 105A-C, for known TEE(s) based on security requirements. For example, the TEE(s) 5105 include one or more known or conventional TEEs. In some examples, the TEE identifier 5102 obtains a request to deploy a TEE, such as one(s) of the TEE(s) 5105, on the first semiconductor device 105A based on security requirements including a request for trusted execution, trusted memory, trusted storage, trusted key derivation and management, etc. In such examples, the TEE identifier 5102 identifies whether the first semiconductor device 105A supports one or more known TEEs that comply with the security requirements. In some such examples, the TEE identifier 5102 maps the security requirements to the TEE(s) 5105, the TEE library 5106, one or more hardware-based TEEs deployable by one(s) of the features 232, 234, 236, 238, 240, 242, 1208, etc. For example, the TEE identifier 5102 identifies that the first semiconductor device 105A has one or more known TEEs based on mapping the security requirements to the one or more known TEEs that comply with the security requirements.

Advantageously, the example TEE identifier 5102 senses an environment of the SDSi asset agent 140A-C, and/or, more generally, the semiconductor device 105A-C, for a presence of one or more TEEs, such as one(s) of the TEE(s) 5105, and selects from amongst the detected one or more TEEs that is/are best suited to protect the application, data associated with the application, and/or portion(s) thereof. Advantageously, in some examples, the TEE identifier 5102 selects one or more APIs from the TEE library 5106 that correspond to the selected TEE and configures the one or more selected APIs to generate an abstraction layer for the selected TEE. In such examples, the one or more configured APIs enable the application to interface with the selected TEE without concerning itself with the API specifics of the selected TEE.

In some examples, the TEE identifier 5102 implements means for identifying whether a semiconductor device supports a first TEE based on security requirements. In such examples, the semiconductor device includes circuitry configurable to provide one or more features. In this example, the means for identifying is implemented by any processor structured to perform the corresponding operation by executing software or firmware, or hardware circuit (e.g., discrete and/or integrated analog and/or digital circuitry, an FPGA, a PLD, a FPLD, an ASIC, a comparator, an operational-amplifier (op-amp), a logic circuit, etc.) structured to perform the corresponding operation without executing software or firmware, but other structures are likewise appropriate.

In some examples, in response to identifying the one or more known TEEs, the TEE generator 5104 selects one of the one or more known TEEs to deploy. For example, in response to identifying one of the TEE(s) 5105 as a known TEE, the TEE generator 5104 deploys the known TEE to protect application data, cryptographic data, etc., of interest. In such examples, the TEE generator 5104 invokes an application to execute in the deployed TEE to protect the secrets or other data associated with the application. In some examples, in response to not identifying a known TEE that complies with requested security requirements, the TEE generator 5104 generates a TEE based on a software-based TEE definable by the TEE library 5106 and/or the TEE component(s) 1208 either local or remote to the semiconductor device 105A-C.

In the illustrated example of FIG. 51, the agent daemon 212 includes the TEE generator 5104 to explore an environment of the SDSi asset agent 140A-C, and/or, more generally, the semiconductor device 105A-C, for a presence of one or more of the TEE components 1208. In some examples, the TEE generator 5104 determines whether a TEE (e.g., a hardware-based TEE) is composable based on identified one(s) of the TEE component(s) 1208 and/or security requirements included in a TEE deployment request. In some such examples, based on the determination that the TEE is composable, the TEE generator 5104 deploys the TEE, such as one(s) of the TEE(s) 5105 which, in some examples, is/are hardware-based TEE(s), based on at least one of the trusted execution, the trusted memory, or the trusted storage included in the TEE component(s) 1208. In some such examples, based on the determination that the TEE is not composable, the TEE generator 5104 deploys a different type of TEE, such as a software-based TEE included in the TEE library 5106, based on the security requirements.

In some examples, the TEE generator 5104 generates a handler (e.g., a TEE handler). For example, the TEE generator 5104 generates a handler to implement routine(s) (e.g., firmware and/or software routine(s)), function(s) (e.g., software and/or firmware function(s)), method(s) (e.g., firmware and/or software method(s)), etc., and/or a combination thereof, to expose a set of capabilities to the SDSi asset agent 140A-C to effectuate TEE protection for the data, the processes, etc., of an application that the SDSi asset agent 140A-C is tasked to protect. In such examples, in response to deploying a TEE, the TEE generator 5104 returns the handler or an abstracted instance of the deployed TEE that is configured to receive calls from the SDSi asset agent 140A-C to protect the data, the processes, etc., of an application of interest.

In some examples, the TEE generator 5104 implements means for generating a second TEE based on one or more features in response to a determination to generate the second TEE based on an identification whether a semiconductor device supports a first TEE based on security requirements. In some examples, the means for generating generates the second TEE in response to the determination indicating that the first TEE is not supported by the semiconductor device. In some examples, the means for generating determines whether the second TEE is deployable as a hardware TEE based on the one or more features, and deploys the second TEE as the hardware TEE based on the determination. In some examples, the means for generating deploys the second TEE as a software TEE in response to the determination indicating that the second TEE is not deployable as the hardware TEE. In this example, the means for generating is implemented by any processor structured to perform the corresponding operation by executing software or firmware, or hardware circuit (e.g., discrete and/or integrated analog and/or digital circuitry, an FPGA, a PLD, a FPLD, an ASIC, a comparator, an operational-amplifier (op-amp), a logic circuit, etc.) structured to perform the corresponding operation without executing software or firmware, but other structures are likewise appropriate.

In some examples, one or more of the TEE identifier 5102, the TEE generator 5104, the TEE(s), 5105, and/or the TEE library 5106 are deployed to the SDSi asset agent 140A-C. For example, in response to one or more licenses being issued to the first SDSi asset agent 140A, at least one of the TEE identifier 5102, the TEE generator 5104, the TEE(s) 5105, or the TEE library 5106 is/are deployed to the SDSi asset agent 140A-C.

In the illustrated example of FIG. 51, the agent daemon 212 includes the TEE(s) 5105 to securely execute the elements of the SDSi asset agent 140A-C. In some examples, the TEE(s) 5105 include one or more TEEs. For example, the TEE(s) 5105 include one or more known or conventional TEEs obtained from an external computing system, such as the manufacturer enterprise system 110 and/or the customer enterprise system 115. In some examples, the TEE(s) 5105 include one or more different types of TEEs. For example, the TEE(s) 5105 include one or more firmware-based TEEs, one or more software-based TEEs, and/or one or more hardware-based TEEs. For example, the TEE(s) 5105 include one or more firmware and/or software-based TEEs that can be exposed to an element of the SDSi asset agent 140A-C, the manufacturer enterprise system 110, and/or the customer enterprise system 115 via hardware-agnostic application programming interfaces (APIs), such as TEE APIs included in the TEE library 5106. In other examples, the TEE(s) 5105 include one or more hardware-based TEEs generated from one(s) of the features 232, 234, 236, 238, 240, 242, 1208. In such examples, the one or more hardware-based TEEs can be exposed to an element of the SDSi asset agent 140A-C, the manufacturer enterprise system 110, and/or the customer enterprise system 115 via hardware-agnostic application programming interfaces (APIs), such as TEE APIs included in the TEE library 5106. Although the TEE(s) 5105 are depicted as being included in the agent daemon 212, additionally or alternatively, the TEE(s) 5105 may be included in one or more different elements of the SDSi asset agent 140A-C, the hardware circuitry 125, the firmware 130, and/or the BIOS 135 of the semiconductor device 105A-C. For example, one or more of the TEEs 5105 are included in at least one of the agent daemon 212, the hardware circuitry 125, the firmware 130, or the BIOS 135 of the semiconductor device 105A-C.

In the illustrated example of FIG. 51, the agent library 218 includes the TEE library 5106 to store a suite of data and/or machine readable instructions (e.g., API(s), programming code, software handler(s), etc.). In some examples, the data and/or the machine readable instructions are configured to expose an API used to scan an environment (e.g., a compute environment) for the presence of TEEs, the initialization of the TEEs, and/or the use or execution of the TEEs. In some examples, the TEE library 5106 includes one or more known TEEs (e.g., one or more known software or software-based TEEs, one or more known hardware or hardware-based TEEs that can be composed from the TEE component(s) 1208, etc., and/or a combination thereof), one or more TEE APIs (e.g., one or more known TEE APIs that correspond to the one or more known TEEs), etc., and/or a combination thereof.

In the illustrated example of FIG. 51, the features include the TEE component(s) 1208 to be used to assemble, compose, and/or otherwise generate a TEE, such as one(s) of the TEE(s) 5105 (e.g., one or more hardware-based TEEs, one or more firmware-based TEEs, one or more software-based TEEs, etc., and/or a combination thereof). In some examples, the TEE components 308 include one or more hardware TEE components, such as secure or trusted compute resources (e.g., one or more cores of a multi-core CPU), memory, storage, bus(es), peripheral(s), etc. In some examples, the TEE components 308 include one or more firmware and/or BIOS TEE components, such as a secure or trusted bootloader, kernel, filesystem, trusted application, interrupt, etc. For example, the TEE generator 5104 assembles one(s) of the TEE component(s) 1208 and deploys the assembly, compilation, etc., as the TEE(s) 5105 in the agent daemon 212, as the TEE(s) 5105 in the hardware circuitry 125, as the TEE(s) 5105 in the firmware 130, and/or as the TEE(s) 5105 in the BIOS 135 of the semiconductor device 105A-C.

The SDSi asset agent 140A-C of the illustrated example includes the feature intent determiner 5012 and the feature intent ML model(s) 5014 to translate an intent or expected outcome from a request to deploy the TEE(s) 5105. In some examples, in response to a request to improve security of the system 5100, the feature intent determiner 5012 translates the request using a high-level meta-language (e.g., C, C++, Java, C#, Perl, Python, HyperText Markup Language (HTML), Structured Query Language (SQL), Swift, etc.) into one or more security requirements, one or more TEE requirements, etc. In such examples, the feature intent determiner 5012 invokes the TEE identifier 5102 to identify one or more known TEEs supported by the semiconductor device 105A-C, one or more TEE component(s) 1208 of the semiconductor device 105A-C, etc. In some such examples, the feature intent determiner 5012 invokes the one or more feature intent ML models 5014 to output a TEE configuration to meet and/or otherwise satisfy the intent of the request. For example, the one or more feature intent ML models 5014 determine whether one or more known TEEs supported by the semiconductor device 105A-C meet and/or otherwise satisfy the intended outcome of the request to improve security of the system 5100. In other examples, the one or more feature intent ML models 5014 determine whether one or more TEEs are composable based on the TEE library 5106, the TEE component(s) 1208, etc., to meet and/or otherwise satisfy the intended outcome of the request to improve security of the system 5100. Advantageously, the example TEE generator 5104 composes a TEE, such as the TEE(s) 5105, based on the output(s) from the feature intent ML model(s) 5014 to optimize and/or otherwise improve security of the system 5100.

In some examples, the feature intent determiner 5012 implements means for determining a feature intent. For example, the means for determining obtains a request to deploy a TEE, translates an intent of the request to the security requirements, executes a machine learning model to determine the one or more features, and generates the second TEE based on the one or more features. In such examples, the one or more features are a first set of features, and the means for determining determines to adjust the first set of features into a second set of one or more features, and re-trains the machine learning model based on the second set of the one or more features. In this example, the means for determining is implemented by any processor structured to perform the corresponding operation by executing software or firmware, or hardware circuit (e.g., discrete and/or integrated analog and/or digital circuitry, an FPGA, a PLD, a FPLD, an ASIC, a comparator, an operational-amplifier (op-amp), a logic circuit, etc.) structured to perform the corresponding operation without executing software or firmware, but other structures are likewise appropriate.

In some examples, the agent interface 202 implements means for interfacing with an agent. For example, the means for interfacing determines whether the one or more features of the semiconductor device includes a first feature representative of translating the intent, and in response to determining that the one or more features do not include the first feature, activates the first feature. In this example, the means for interfacing is implemented by any processor structured to perform the corresponding operation by executing software or firmware, or hardware circuit (e.g., discrete and/or integrated analog and/or digital circuitry, an FPGA, a PLD, a FPLD, an ASIC, a comparator, an operational-amplifier (op-amp), a logic circuit, etc.) structured to perform the corresponding operation without executing software or firmware, but other structures are likewise appropriate.

While example manners of implementing the systems 4900, 5000, and/or 5100 are illustrated in FIGS. 49-51, one or more of the elements, processes and/or devices illustrated in FIGS. 49-51 may be combined, divided, re-arranged, omitted, eliminated and/or implemented in any other way. Further, the example silicon product 105 (e.g., the example semiconductor device 105), the example manufacturer enterprise system 110, the example customer enterprise system 115, the example cloud platform 120, the example SDSi asset agent 140, the example agent interface 202, the example agent local services 204, the example analytics engine 206, the example communication services 208, the example agent CLI 210, the example agent daemon 212, the example license processor 214, the example agent library 218, the example feature libraries 220-230, the example product management service 252, the example customer management service 254, the example SDSi feature management service 256, the example SDSi portal 262, the example SDSi agent management interface 264, the example manufacturer trusted agent determiner 1102, the example SDSi client agent 272, the example platform inventory management service 274, the example accounts management service 276, the example entitlement management service 278, the example trusted agent determiner 5004, the example certificate validator 5006, the example anomaly detector 5008, the example anomaly detection ML model(s) 5010, the example feature intent determiner 5012, the example feature intent ML model(s) 5014, the example TEE identifier 5102, the example TEE generator 5104, the example TEE(s) 5105, the example TEE library 5106, the example TEE component(s) 1208, and/or, more generally, the systems 4900, 5000, and/or 5100 of FIGS. 49-51 may be implemented by hardware, software, firmware and/or any combination of hardware, software and/or firmware. Thus, for example, any of the example silicon product 105 (e.g., the example semiconductor device 105), the example manufacturer enterprise system 110, the example customer enterprise system 115, the example cloud platform 120, the example SDSi asset agent 140, the example agent interface 202, the example agent local services 204, the example analytics engine 206, the example communication services 208, the example agent CLI 210, the example agent daemon 212, the example license processor 214, the example agent library 218, the example feature libraries 220-230, the example product management service 252, the example customer management service 254, the example SDSi feature management service 256, the example SDSi portal 262, the example SDSi agent management interface 264, the example manufacturer trusted agent determiner 1102, the example SDSi client agent 272, the example platform inventory management service 274, the example accounts management service 276, the example entitlement management service 278, the example trusted agent determiner 5004, the example certificate validator 5006, the example anomaly detector 5008, the example anomaly detection ML model(s) 5010, the example feature intent determiner 5012, the example feature intent ML model(s) 5014, the example TEE identifier 5102, the example TEE generator 5104, the example TEE(s) 5105, the example TEE library 5106, the example TEE component(s) 1208, and/or, more generally, the systems 4900, 5000, and/or 5100 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)), field programmable gate arrays (FPGAs) and/or field programmable logic device(s) (FPLD(s)). When reading any of the apparatus or system claims of this patent to cover a purely software and/or firmware implementation, at least one of the example systems 4900, 5000, 5100, the example silicon product 105 (e.g., the example semiconductor device 105), the example manufacturer enterprise system 110, the example customer enterprise system 115, the example cloud platform 120, the example SDSi asset agent 140, the example agent interface 202, the example agent local services 204, the example analytics engine 206, the example communication services 208, the example agent CLI 210, the example agent daemon 212, the example license processor 214, the example agent library 218, the example feature libraries 220-230, the example product management service 252, the example customer management service 254, the example SDSi feature management service 256, the example SDSi portal 262, the example SDSi agent management interface 264, the example manufacturer trusted agent determiner 1102, the example SDSi client agent 272, the example platform inventory management service 274, the example accounts management service 276, the example entitlement management service 278, the example trusted agent determiner 5004, the example certificate validator 5006, the example anomaly detector 5008, the example anomaly detection ML model(s) 5010, the example feature intent determiner 5012, the example feature intent ML model(s) 5014, the example TEE identifier 5102, the example TEE generator 5104, the example TEE(s) 5105, the example TEE library 5106, and/or the example TEE component(s) 1208 is/are hereby expressly defined to include a non-transitory computer readable storage device or storage disk such as a memory, a digital versatile disk (DVD), a compact disk (CD), a Blu-ray disk, etc. including the software and/or firmware. Further still, the example systems 4900, 5000, and/or 5100 may include one or more elements, processes and/or devices in addition to, or instead of, those illustrated in FIGS. 49-51, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

Device Enhancements

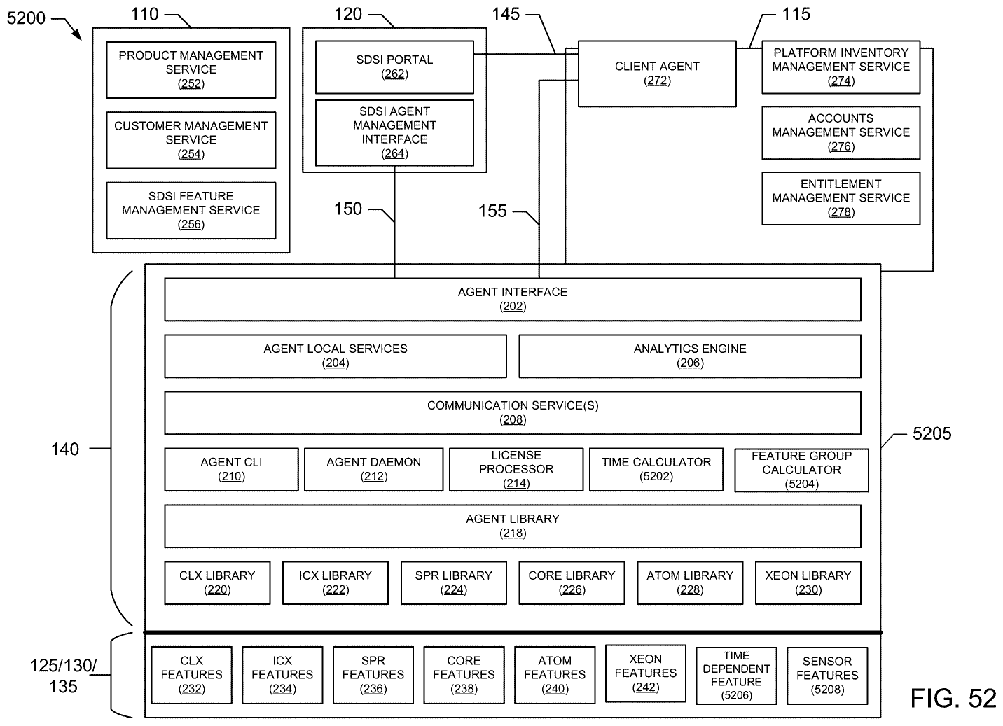

A block diagram of another example system 5200 to implement and manage SDSi products in accordance with the teachings of this disclosure is illustrated in FIG. 52. FIG. 52 is a block diagram of another example system 5200 to implement and manage an example software defined silicon product 5205 in accordance with the teachings of this disclosure. The example SDSi system 5200 and the example silicon product 5205 of FIG. 52 includes some of the features and/or elements of the example silicon product 105 of FIG. 1. Particularly, the example SDSi system 5200 includes the example SDSi agent 140, the example agent interface 202, the example agent local services 204, the example analytics engine 206, the example communication services 208, the example agent command line interface (CLI) 210, the example agent daemon 212, the example license processor 214, and the example agent library 218, the example feature libraries 220-230, and the respective example feature sets 232-242. Unless stated otherwise, the features of FIG. 2 included in FIG. 52 have the same function, form and relationships as described in connection with these features above.

The example SDSi system 5200 of FIG. 52 additionally includes an example time calculator 5202 and an example feature group calculator 5204. In the illustrated example of FIG. 52, the example SDSI system 5200 further includes example time-dependent features 5206 and sensor features 5208, which may be implemented by the hardware circuitry 125, firmware 130, and/or BIOS 135 of the silicon product 5205.

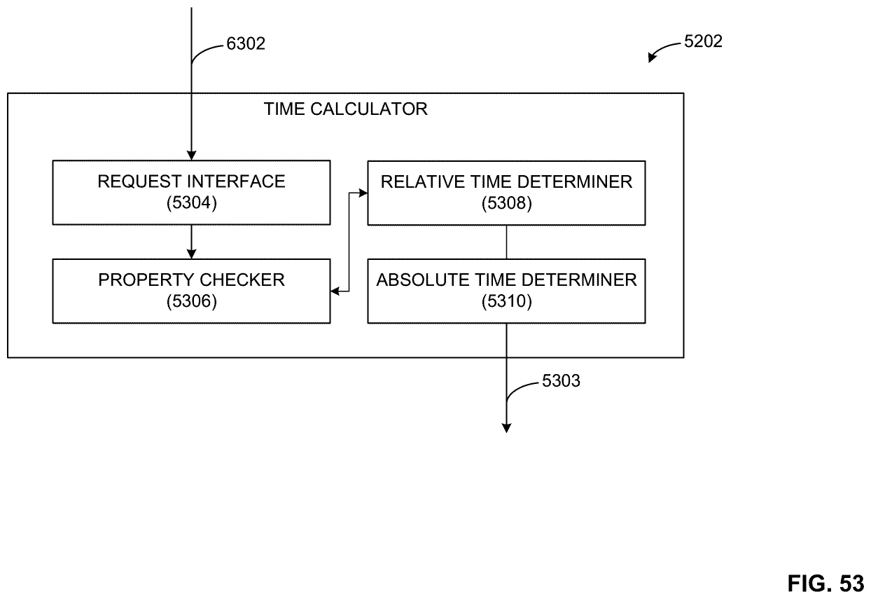

The example time calculator 5202 determines the absolute time and/or relative time when queried. In the illustrated example of FIG. 52, the time calculator 5202 determines the absolute time and/or relative based on the electrical properties of the time-dependent feature 5206. For example, the time calculator 5202 can determine the relative time based on a difference in the electrical properties of the time-dependent feature 5206 at a time of manufacture of the silicon product 5205 and the current electrical properties. The example time calculator 5202 can determine the absolute time based on the determined relative time and the recorded time of manufacture, which can also be stored and/or determined when the silicon product 5205 is manufactured. In such examples, the time calculator 5202 can determine and/or store the electric properties of the time-dependent feature 5206 when the silicon product is manufactured. An example implementation of the time calculator 5202 is described in greater detail below in conjunction with FIG. 53.

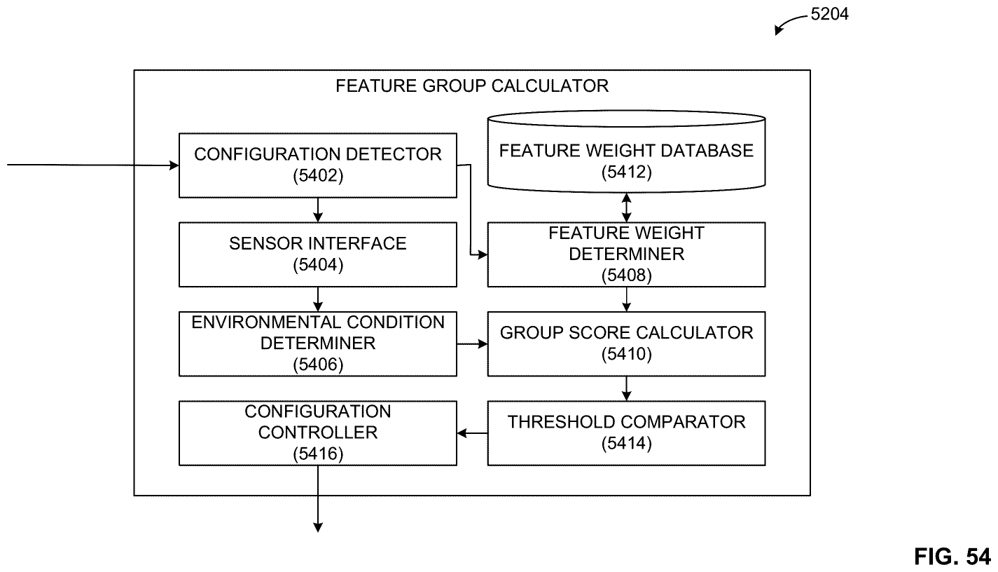

The example feature group calculator 5204 determines if configurations associated with the silicon product are permissible (e.g., do not exceed the operational capacity of the silicon product, etc.). For example, the feature group calculator 5204, in response to receiving a new feature combination, can perform a calculation to determine if the configuration associated with this feature combination of the CPU is permissible. In some examples, the feature group calculator 5204 determines the features associated with a license, determines values (e.g., scores, weights, etc.) associated with each of those features and then calculates a group score based on the values. In some examples, the feature group calculator 5204 compares the determined group score to one of more thresholds. For example, the feature group calculator 5204 can compare the calculated group score to a warranty threshold and/or a disable threshold. In some examples, if the feature group calculator 5204 determines the calculate group score exceeds the warranty threshold, the feature group calculator 5204 can void the warranty of the silicon product. In some examples, if the feature group calculator 5204 determines the calculated group score exceeds the disable threshold, the feature group calculator 5204 can prevent the license associated with the new feature combination from being activated. In some examples, the feature group calculator 5204 can include environmental factors (e.g., as detected/determined by the sensor features 5208, etc.) in the group score calculation(s). An example implementation of the feature group calculator 5204 is described below in conjunction with FIG. 54.

The example time-dependent feature 5206 is a mechanical (e.g., physical, etc.) feature embedded, installed and/or otherwise coupled to the silicon product 5205. In the illustrated example of FIG. 52, the time-dependent feature 5206 has one or more electrical propertie(s) (e.g., resistance, capacitance, inductance, etc.) that change over time in a predictable manner. Particularly, the time-dependent feature 5206 has one or more electrical parameters and/or properties that are primarily a function of time. As such, if the electrical property of the time-dependent feature 5206 is checked at a first time (e.g., a time of manufacture, etc.), the time calculator 5202 can determine a relative time difference between the first time and a second time, based on the difference in the measured electric property at the first time and the second time. As such, the time-dependent feature 5206 enables an interested party (e.g., the manufacturer enterprise system 110, the customer enterprise system 105, etc.) to determine absolute and relative time references without relying on the silicon product 5205 being powered. In some examples, the time-dependent feature 5206 can be implemented by a radioisotope with a relative long half-life (e.g., 57 Cobalt, etc.). In other examples, the time-dependent feature 5206 can be implemented by a physical unclonable function (PUF) with properties that vary over time. In other examples, the time-dependent feature 5206 can be implemented by any other suitable material and/or device.

The example sensor features 5208 are features of the silicon product that detect and/or otherwise determine the environmental conditions of the SDSi system 5200. For example, the sensor features 5208 can include a temperature sensor (e.g., a thermometer, etc.), a radiation sensor, a humidity sensor, moisture sensor, and/or any other suitable sensors that can detect and/or otherwise determine the environmental conditions of the SDSi system 5200. Additionally or alternatively, the sensor features 5208 can include features that enable the silicon product 5205 to interface and/or communicate with the machine that silicon product 5205 is installed. In such examples, the sensor features 5208 enable the time calculator 5202 to receive environmental condition information from sensors associated with the machine.

FIG. 53 is a block diagram of the example time calculator 5202 of FIG. 52. In the illustrated example of FIG. 52, the time calculator 5202 receives an example request 5302 and outputs an example time output 5303. In the illustrated example of FIG. 53, the example time calculator 5202 includes an example request interface 5304, an example property checker 5306, an example relative time determiner 5308, and an example absolute time determiner 5310. While the example time calculator 5202 is depicted as being part of the example silicon product 5205, some or all of the example time calculator 5202 can be implemented at another location (e.g., at the manufacturer enterprise system 110, at the customer enterprise system 115, etc.).

The example request interface 5304 receives the example request 5302 and determines if it is a request for an absolute time and/or a relative time. In some examples, the request interface 5304 can receive the request 5302. The example request 5302 is a request for the absolute time and/or the relative time. For example, the example request 5302 can include a request for a timestamp corresponding to the current absolute time (e.g., the time/date, etc.) and/or a timestamp corresponding to the relative time (e.g., the time between the request and an event in the past, etc.). The example request 5302 can be generated by the analytics engine 206 when logging SDSi feature activation and/or deactivation. In such examples, the analytic engine 206 can query the time calculator 5202 to generate an odometer reading (e.g., a timestamp, a time reference, etc.). In some examples, the license processor 214 can query the time calculator 5202 to determine if a license has expired and, thusly, the feature associated with the license should be deactivated and/or disabled.

The example property checker 5306 interfaces with the example time-dependent feature 5206 to determine the current electrical properties of the time-dependent feature 5206. For example, the property checker 5306 can determine the electrical property of the time-dependent feature 5206 by causing a current to run through time-dependent feature 5206 so the property checker 5306 can check the electrical property of the time-dependent feature 5206. In other examples, the property checker 5306 can retrieve a log of the electrical properties from a database associated with the silicon product 5205. In such examples, the property checker 5306 can determine the electrical properties based on recent operations of the silicon product 5205.

The example relative time determiner 5308 correlates the determined property with a relative time. For example, the relative time determiner 5308 can determine the relative time between a current request and a previous event based on (i) the time-dependent function of the time-dependent feature 5206, and (ii) a previously determined property of the time-dependent feature 5206 corresponding to when the previous event occurred. In some examples, the relative time determiner 5308 can determine the relative time between the request 1401 and a time of manufacturer of the silicon product 5205. In some examples, the relative time determiner 5308 can determine the relative time between the current event and any previous event in which the electrical property of the time-dependent feature 5206 was determined (e.g., the activation of a feature of the silicon product 5205, etc.).

The example absolute time determiner 5310 determines the absolute time. For example, the absolute time determiner 5310 determines the absolute time based on the relative time determined by the relative time determiner 5308. For example, after determining the relative time between the request and the time of manufacture, the absolute time determiner 5310 can add the relative time to the absolute time at the time of manufacture. In such examples, the absolute time determiner 5310 can retrieve the absolute time at the time of manufacture from storage.

While an example manner of implementing the time calculator 5202 of FIG. 52 is illustrated in FIG. 54, one or more of the elements, processes and/or devices illustrated in FIG. 4 may be combined, divided, re-arranged, omitted, eliminated and/or implemented in any other way. Further, the example request interface 204, the example property checker 5306, the example relative time determiner 5308, the example absolute time determiner 5310 and/or, more generally, the example time calculator 5202 of FIG. 53 may be implemented by hardware, software, firmware and/or any combination of hardware, software and/or firmware. Thus, for example, any of the example request interface 204, the example property checker 5306, the example relative time determiner 5308, the example absolute time determiner 5310 and/or, more generally, the example time calculator 5202 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, request interface 204, the example property checker 5306, the example relative time determiner 5308, the example absolute time determiner 5310 is/are hereby expressly defined to include a non-transitory computer readable storage device or storage disk such as a memory, a digital versatile disk (DVD), a compact disk (CD), a Blu-ray disk, etc. including the software and/or firmware. Further still, the example time calculator 5202 of FIG. 52 may include one or more elements, processes and/or devices in addition to, or instead of, those illustrated in FIG. 53, and/or may include more than one of any or all of the illustrated elements, processes and devices.

FIG. 54 is a block diagram of the example feature group calculator 5204 of FIG. 52. The example feature group calculator 5204 includes an example configuration detector 5402, an example sensor interface 5404, an example environmental condition determiner 5406, an example feature weight determiner 5408, an example group score calculator 5410, an feature weight database 5412, an example threshold comparator 5414, and configuration controller 5416.

The example configuration detector 5402 detects when the silicon product 5205 is configured and/or about to be configured into a new configuration. For example, the configuration detector 5402 can monitor the features of the processor to determine if a feature has been activated, deactivated, and/or modified. For example, the configuration detector 5402 can detect if a core of the processor has been activated and/or deactivated and/or the frequency of a core has been changed. In some examples, the configuration detector 5402 can detect if a new license has been received by the silicon product 5205. In such examples, the configuration detector 5402 can detect the received license and determine the feature(s) associated therewith. In some examples, the configuration detector 5402 can receive a request from the license processor 214 to determine if the features associated with a license can be enabled.

The sensor interface 5404, included in or otherwise implemented by the feature group calculator 5204, receives and distributes data detected and/or collected by the sensor features 5208. In some examples, the sensor interface 5404 can distribute collected sensor data to the environmental condition determiner 5406, the group score calculator 5410, and/or the feature weight database 5412. In some examples, the sensor interface 5404 can transform the collected sensor data into a format readable by the other components of the feature group calculator 5204. In some examples, the sensor interface 5404 can receive data associated with the ambient temperature, the humidity, ambient radiation, ambient moisture etc.

The environmental condition determiner 5406 determines the environmental conditions and associated environmental weight factors based on the sensor data received by the sensor interface 5404. For example, the environmental condition determiner 5406 can determine the weight factor associated with each environmental condition. In some examples, the environmental condition determiner 5406 can assign a weight factor to the ambient temperature if the ambient temperature exceeds a boundary condition (e.g., the environmental condition determiner 5406 can determine a weight of 10 if the ambient temperature exceeds 20 degrees Celsius (C), the environmental condition determiner can determine a weight of 30 if the ambient humidity exceeds 80%, etc.). In some examples, the environmental condition determiner 5406 can scale (e.g., linearly, exponentially, etc.) the determined weight as the environmental conditions become worse for processor performance (e.g., the environmental condition determiner 5406 can scale the temperature weight by 5 for each degree above 20 degrees Celsius (C), etc.). In some examples, the environmental condition determiner 5408 can determine a negative weight value if the environmental conditions are favorable (e.g., determining a temperature weight of −5 if the temperature is below 10 degrees Celsius (C), etc.). In some examples, the environmental condition determiner 5406 determines the environmental weight(s) based on previously determined empirical measurements. Additionally or alternatively, the environmental condition determiner 5406 can determine the weight values based on a machine learning model. In some examples, the environmental condition determiner 5406 can determine a total environmental score based on the sum of the determined environmental weights. In some examples, the environmental condition determiner 5406 can determine multiple environmental scores corresponding to each feature group affected by the configuration. In such examples, the determined weights can vary based on the associated feature group.

The feature weight determiner 5408 determines the weight of each feature associated with the detected/received configuration. For example, the feature weight determiner 5408 can interface with the feature weight database 5412 to determine the weight value of each feature associated with the detected/received configuration. For example, the feature weight determiner 5408 can determine a score for each feature associated with the configuration. For example, if the configuration includes 8 cores operating at 4.0 gigahertz (GHz), the feature weight determiner 5408 can determine that each operating core has a weight of 10 and that the operating frequency has a weight of 50. In such examples, the feature weight determiner 5408 can determine the feature score of 130. In such examples, the feature score is associated with the operating conditions (e.g., TDP, etc.) of the processor, without regard for the environmental conditions of the processor.

The group score calculator 5410 determines the group score based on the environmental score, as determined by the environmental condition determiner 5406, and the feature score, as determined by the feature weight determiner 5408. For example, the group score calculator 5410 can determine the group score based on the sum of environmental score and the feature score. In other examples, the group score calculator 5410 can determine the group score based on any other suitable manner (e.g., weighting the feature scores or the environmental score before summing them, multiplying the feature score and the environmental score, etc.). In some examples, the algorithm used by the group score calculator 5410 can be implemented by a machine learning algorithm. In such examples, the machine learning algorithm can be trained by the model trainer 1518. In some examples, if the configuration affects features from multiple groups, the group score calculator 5410 can determine multiple group scores for each group.

The threshold comparator 5414 compares the group score to one or more threshold(s). For example, the threshold comparator 5414 can determine if the group score exceeds a warranty threshold, an enablement threshold, etc. In some examples, the threshold comparator 5414 can have a dynamic threshold (e.g., determined via machine learning, etc.). In some examples, the threshold comparator 5414 can compare the calculated group score depending on the feature group being examined. For example, a first feature-group (e.g., core activation and speed, etc.) and a second feature-group (e.g., memory architecture, speed select, etc.) can have different thresholds associated therewith.

The configuration controller 5416 determines an appropriate action to take based on the output of the threshold comparator 5416. For example, if the group-score exceeds the enablement threshold, the configuration controller 5416 could prevent the configuration from being implemented. In other examples, if the group-score exceeds the warranty threshold but not the enablement threshold, the configuration controller could void the warranty of the processor. In other examples, the configuration controller 5416 can trigger any other suitable action based on the determined group score and/or output of the threshold comparator.

While an example manner of implementing the time calculator 5202 of FIG. 52 is illustrated in FIG. 54, one or more of the elements, processes and/or devices illustrated in FIG. 54 may be combined, divided, re-arranged, omitted, eliminated and/or implemented in any other way. Further, the example configuration detector 5402, sensor interface 5404, environmental condition determiner, feature weight determiner 5408, group score calculator 5410, threshold comparator 5414, configuration controller 5416, and/or, more generally, the example feature group calculator 5204 of FIG. 54 may be implemented by hardware, software, firmware and/or any combination of hardware, software and/or firmware. Thus, for example, any of the configuration detector 5402, sensor interface 5404, environmental condition determiner, feature weight determiner 5408, group score calculator 5410, threshold comparator 5414, configuration controller 5416 and/or, more generally, the example feature group calculator 5204 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example configuration detector 5402, sensor interface 5404, environmental condition determiner, feature weight determiner 5408, group score calculator 5410, threshold comparator 5414, configuration controller 5416 is/are hereby expressly defined to include a non-transitory computer readable storage device or storage disk such as a memory, a digital versatile disk (DVD), a compact disk (CD), a Blu-ray disk, etc. including the software and/or firmware. Further still, the example feature group calculator 5204 of FIG. 52 may include one or more elements, processes and/or devices in addition to, or instead of, those illustrated in FIG. 54, and/or may include more than one of any or all of the illustrated elements, processes and devices.

Flowchart Introduction

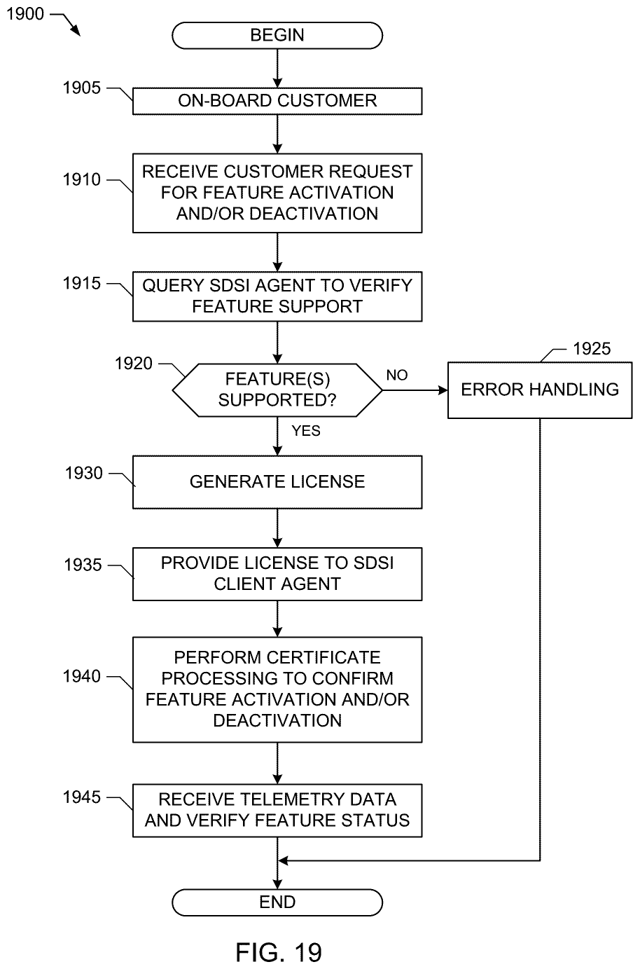

Flowcharts representative of example hardware logic, machine readable instructions, hardware implemented state machines, and/or any combination thereof for implementing the example systems 100 and/or 200, the example silicon product 105 (e.g., the example semiconductor device 105), the example manufacturer enterprise system 110, the example customer enterprise system 115, the example cloud platform 120, the example SDSi asset agent 140, the example agent interface 202, the example agent local services 204, the example analytics engine 206, the example communication services 208, the example agent CLI 210, the example agent daemon 212, the example license processor 214, the example agent library 218, the example feature libraries 220-230, the example product management service 252, the example customer management service 254, the example SDSi feature management service 256, the example SDSi portal 262, the example SDSi agent management interface 264, the example SDSi client agent 272, the example platform inventory management service 274, the example accounts management service 276 and/or the example entitlement management service 278 are shown in FIGS. 19-21. In these examples, the machine readable instructions may be one or more executable programs or portion(s) of an executable program for execution by a computer processor, such as the processors 3512, 3612 and/or 3712 shown in the example processor platforms 3500, 3600 and/or 3700 discussed below in connection with FIGS. 35-37. The one or more programs, or portion(s) thereof, may be embodied in software stored on a non-transitory computer readable storage medium such as a CD-ROM, a floppy disk, a hard drive, a DVD, a Blu-ray Disk™, or a memory associated with the processors 3512, 3612 and/or 3712, but the entire program or programs and/or parts thereof could alternatively be executed by a device other than the processor 3512, 3612 and/or 3712 and/or embodied in firmware or dedicated hardware. Further, although the example program(s) is(are) described with reference to the flowcharts illustrated in FIGS. 19-21, many other methods of implementing the example systems 100 and/or 200, the example silicon product 105 (e.g., the example semiconductor device 105), the example manufacturer enterprise system 110, the example customer enterprise system 115, the example cloud platform 120, the example SDSi asset agent 140, the example agent interface 202, the example agent local services 204, the example analytics engine 206, the example communication services 208, the example agent CLI 210, the example agent daemon 212, the example license processor 214, the example agent library 218, the example feature libraries 220-230, the example product management service 252, the example customer management service 254, the example SDSi feature management service 256, the example SDSi portal 262, the example SDSi agent management interface 264, the example SDSi client agent 272, the example platform inventory management service 274, the example accounts management service 276 and/or the example entitlement management service 278 may alternatively be used. For example, with reference to the flowcharts illustrated in FIGS. 19-21, the order of execution of the blocks may be changed, and/or some of the blocks described may be changed, eliminated, combined and/or subdivided into multiple blocks. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

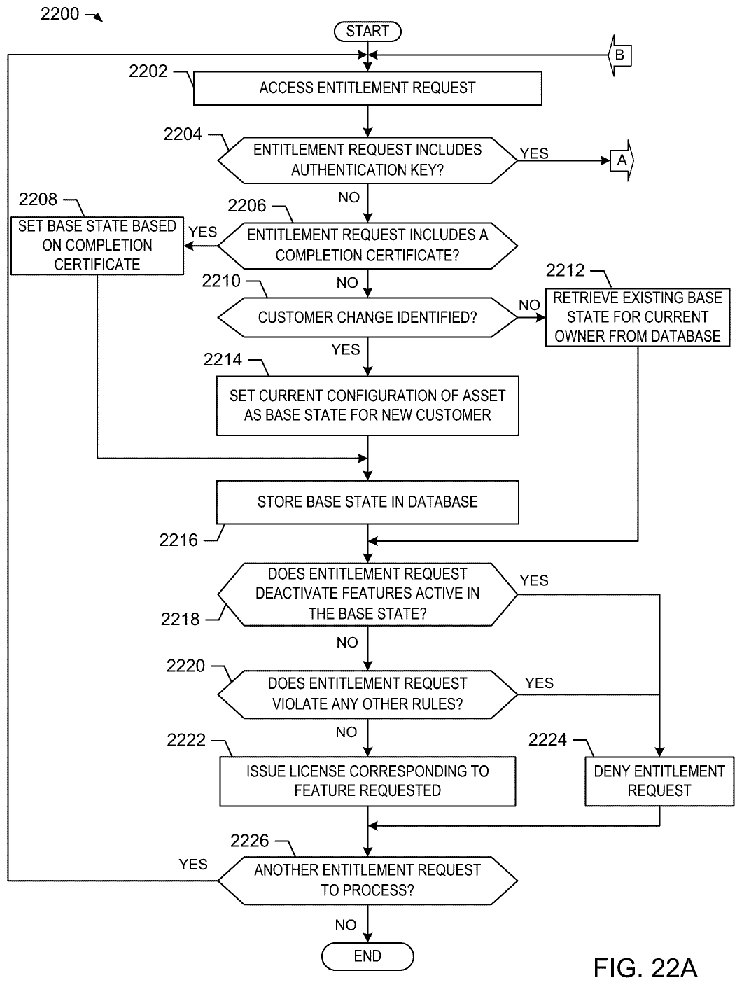

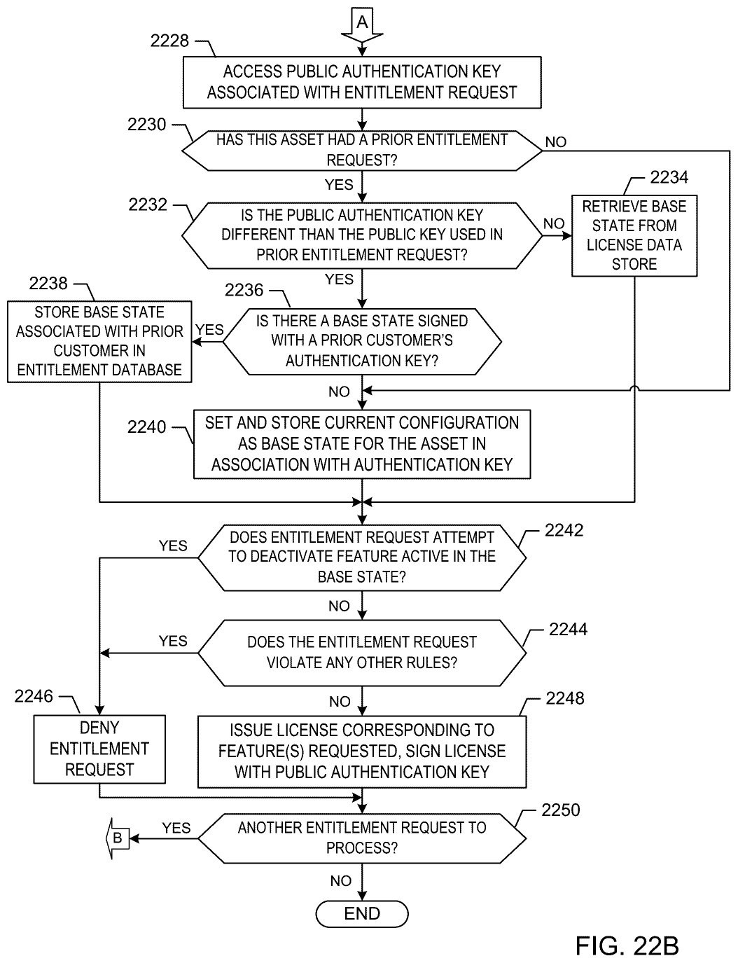

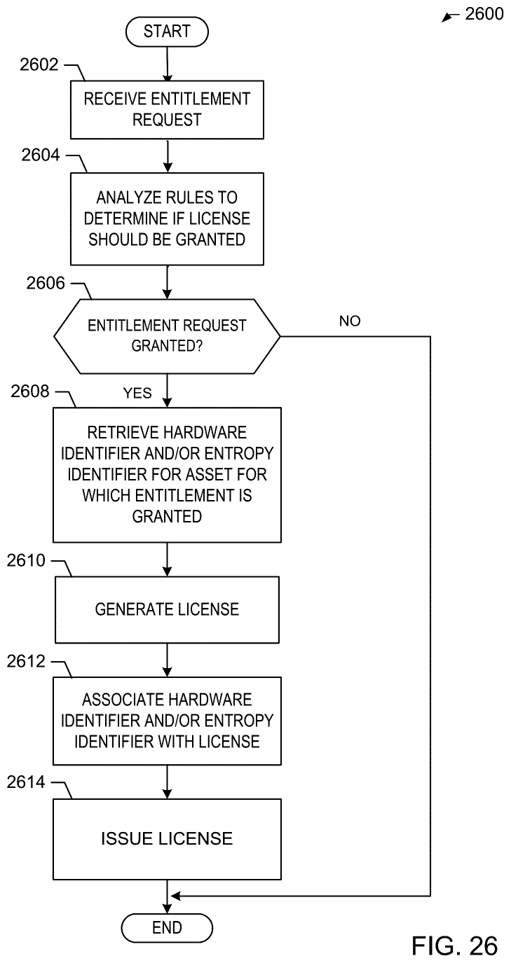

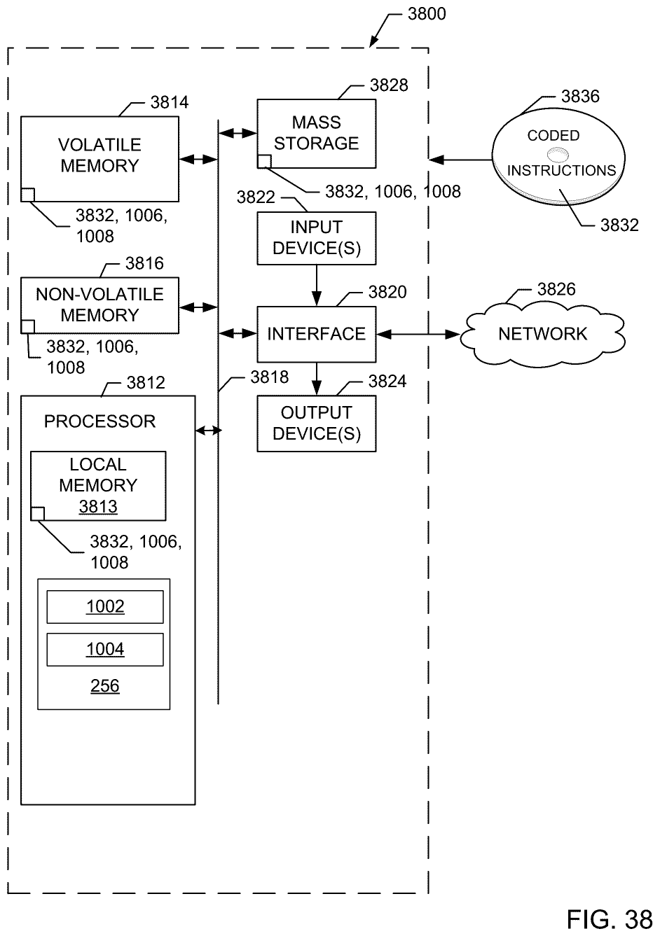

Flowcharts representative of example hardware logic, machine readable instructions, hardware implemented state machines, and/or any combination thereof for implementing the manufacturer enterprise system 110 of FIG. 10 are shown in FIGS. 22A-22B and 26. The machine readable instructions may be one or more executable programs or portion(s) of an executable program for execution by a computer processor such as the processor 3812 shown in the example processor platform 3800 discussed below in connection with FIG. 38. The program may be embodied in software stored on a non-transitory computer readable storage medium such as a CD-ROM, a floppy disk, a hard drive, a DVD, a Blu-ray disk, or a memory associated with the processor 3812, but the entire program and/or parts thereof could alternatively be executed by a device other than the processor 3812 and/or embodied in firmware or dedicated hardware. Further, although the example program is described with reference to the flowcharts illustrated in FIGS. 22A-22B and 26, many other methods of implementing the example manufacturer enterprise system 110 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

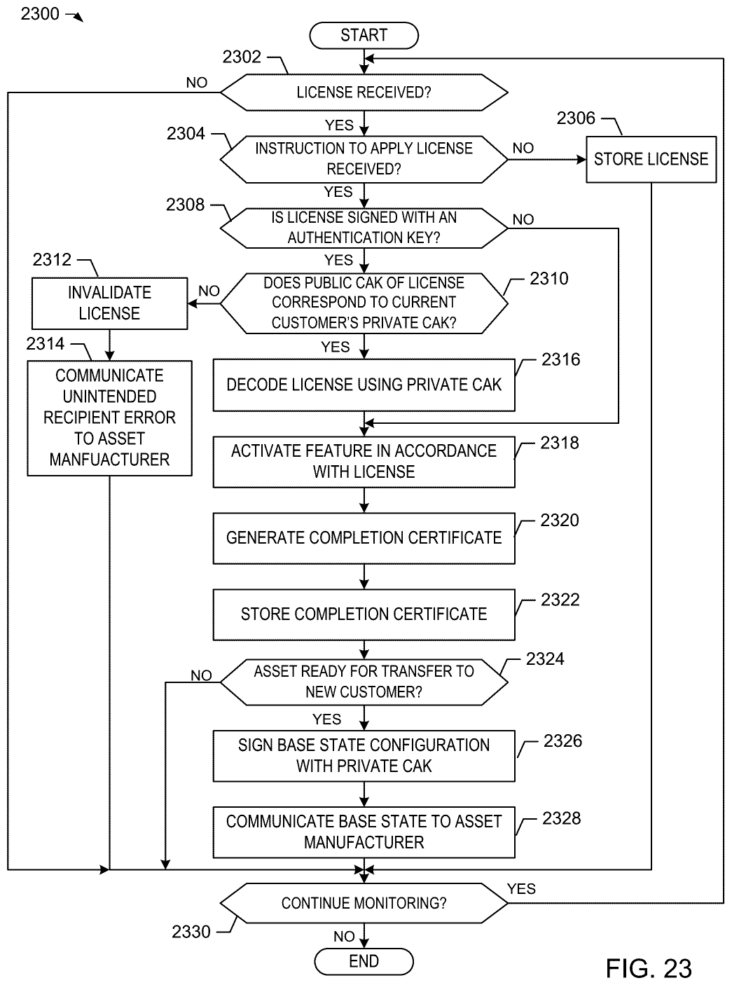

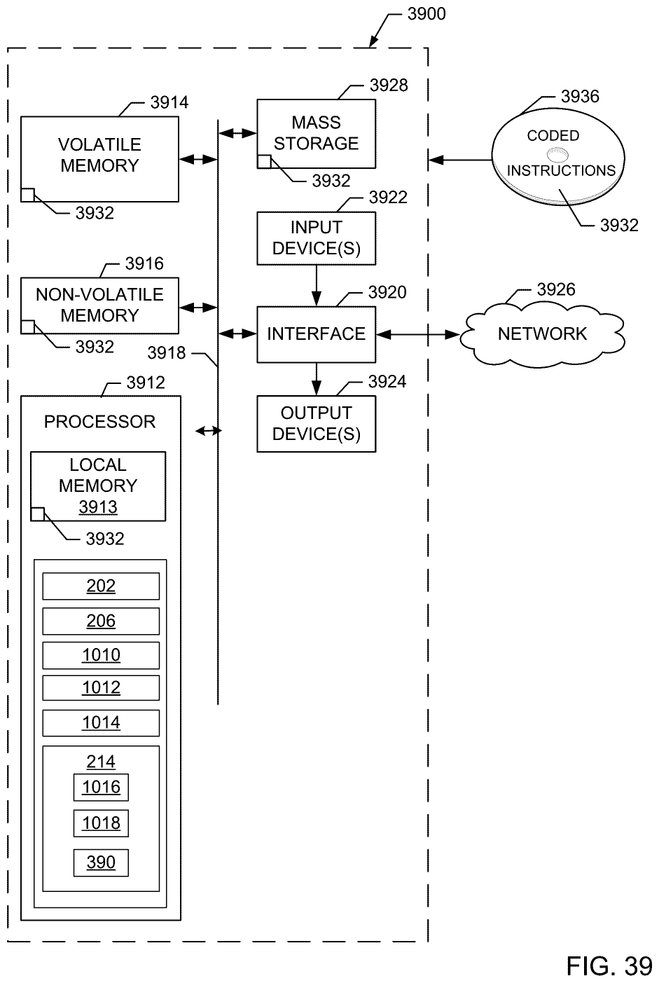

Flowcharts representative of example hardware logic, machine readable instructions, hardware implemented state machines, and/or any combination thereof for implementing the SDSi asset agent 140 of FIG. 10 are shown in FIGS. 23-25. The machine readable instructions may be one or more executable programs or portion(s) of an executable program for execution by a computer processor such as the processor 3912 shown in the example processor platform 3900 discussed below in connection with FIG. 39. The program may be embodied in software stored on a non-transitory computer readable storage medium such as a CD-ROM, a floppy disk, a hard drive, a DVD, a Blu-ray disk, or a memory associated with the processor 3912, but the entire program and/or parts thereof could alternatively be executed by a device other than the processor 3912 and/or embodied in firmware or dedicated hardware. Further, although the example program is described with reference to the flowcharts illustrated in FIGS. 23-25, many other methods of implementing the example SDSi asset agent 140 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

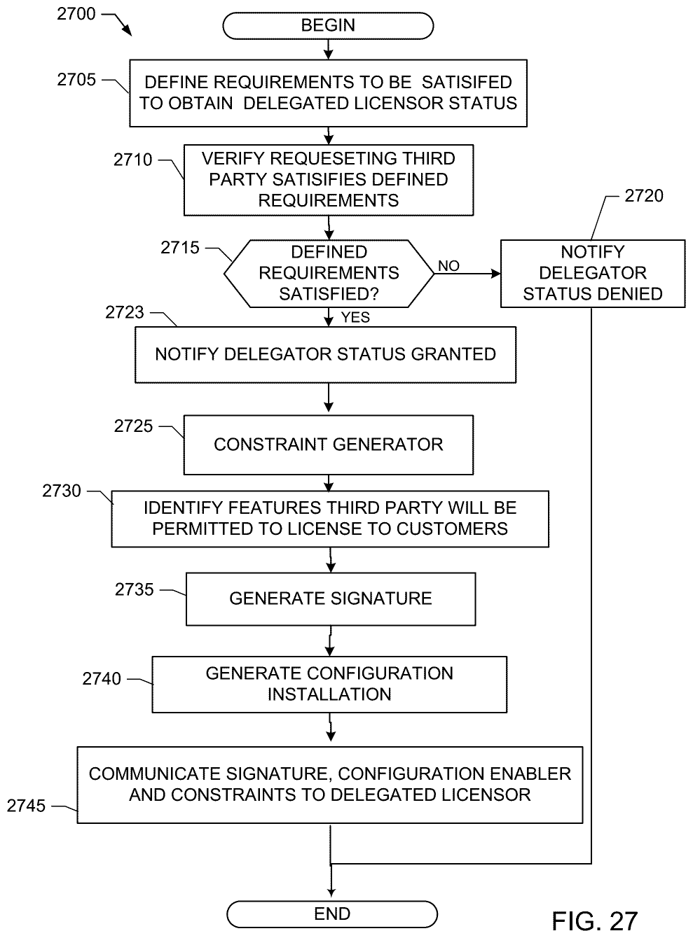

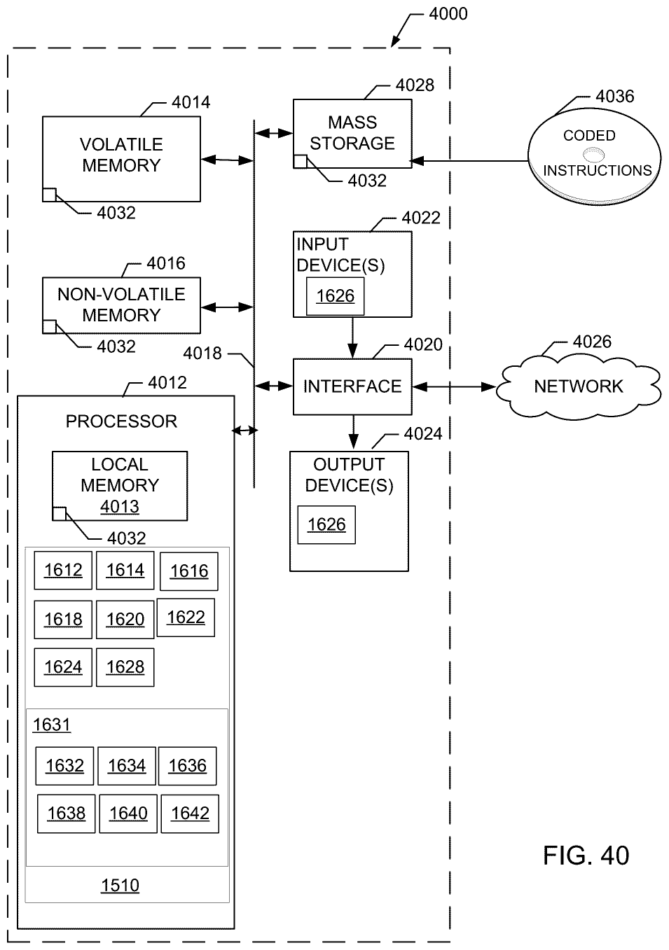

Flowcharts representative of example hardware logic, machine readable instructions, hardware implemented state machines, and/or any combination thereof for implementing the example systems 1500, 1600, 1700 and/or 1800, the example central licensor 1500, the example first ADL 1515, the example SDSi Product 1520, the example customer enterprise system 1525, the example bank of internet time servers 1530, the example first asset agent 1535, the example first hardware asset 1540, the example second ADL 1565A, the example second asset agent 1565B, the example third ADL 1570A, the example third asset agent 1570B, the example first time server 1575A, the example second time server 1575B, the example second hardware asset 1580, the example third asset 1585, the example precise time appliance 1590, the example requirement definer 1612, the example third party verifier 1614, the example request denier 1616, the example request grantor 1618, the example constraints generator 1620, the example feature identifier 1622, the example signature generator 1624, the example configuration install generator 1628, the example communicator 1626, the example certificate handler 1630, the example sequence number manager 1631, the example asset identifier 1632, the example certificate collector 1634, the example sequence number comparator 1636, the example sequence number storage 1638 the example sequence number extractor 1640, the example ADL status requestor 1705, the example incoming license denier 1710, the example status grant notification information parser 1712, the example storage controller 1715, the example storage 1720, the example status advertiser 1730, the example license generator 1735, the example license verifier 1737, the example sequence number generator 1740, the example time capturer 1745, the example time converter 1750, the example sequence number adder 1755, the example business logic storage, the example business logic updater 1804, the example information parser 1816, the example storage 1818, the example business level requirements determiner 1820, the example business level requirement converter 1821, the example hardware asset 422, the example business level values verifier 1823, the example configuration change verifier 1824, the example compliance monitor 1828, the example accelerator 1830, the example processor/CPU 1834, the example business logic hardware 1835, and/or the example script/code remover 1832 are shown in FIGS. 27-34. In these examples, the machine readable instructions may be one or more executable programs or portion(s) of an executable program for execution by a computer processor, such as the processors 4012, 4112, 4212, 4312, 4412 shown in the example processor platforms 4000, 4100, 4200, 4300 and/or 4400 discussed below in connection with FIGS. 40-44. The one or more programs, or portion(s) thereof, may be embodied in software stored on a non-transitory computer readable storage medium such as a CD-ROM, a floppy disk, a hard drive, a DVD, a Blu-ray Disk™, or a memory associated with the processors 4012, 4112, 4212, 4312, and/or 4412, but the entire program or programs and/or parts thereof could alternatively be executed by a device other than the processor 4012, 4112, 4212, 4312, and/or 4412 and/or embodied in firmware or dedicated hardware. Further, although the example program(s) is(are) described with reference to the flowcharts illustrated in FIGS. 27-34, many other methods of implementing the example systems 1500, 1600, 1700 and/or 1800, the example central licensor 1510, the example first ADL 1515, the example SDSi Product 1520, the example customer enterprise system 1525, the example bank of internet time servers 1530, the example first asset agent 1535, the example first hardware asset 1540, the example second ADL 1565A, the example second asset agent 1565B, the example third ADL 1570A, the example third asset agent 1570B, the example first time server 1575A, the example second time server 1575B, the example second hardware asset 1580, the example third asset 1585, the example precise time appliance 1590, the example requirement definer 1612, the example third party verifier 1614, the example request denier 1616, the example request grantor 1618, the example constraints generator 1620, the example feature identifier 1622, the example signature generator 1624, the example configuration install generator 1628, the example communicator 1626, the example certificate handler 1630, the example sequence number manager 1631, the example asset identifier 1632, the example certificate collector 1634, the example sequence number comparator 1636, the example sequence number storage 1638 the example sequence number extractor 1640, the example ADL status requestor 1705, the example incoming license denier 1710, the example status grant notification information parser 1712, the example storage controller 1715, the example storage 1720, the example status advertiser 1730, the example license generator 1735, the example license verifier 1737, the example sequence number generator 1740, the example time capturer 1745, the example time converter 1750, the example sequence number adder 1755, the example business logic storage, the example business logic updater 1804, the example information parser 1816, the example storage 1818, the example business level requirements determiner 1820, the example business level requirement converter 1821, the example hardware asset 422, the example business level values verifier 1823, the example configuration change verifier 1824, the example compliance monitor 1828, the example accelerator 1830, the example processor/CPU 1834, the example business logic hardware 1835, and/or the example script/code remover 1832 may alternatively be used. For example, with reference to the flowcharts illustrated in FIGS. 27-34, the order of execution of the blocks may be changed, and/or some of the blocks described may be changed, eliminated, combined and/or subdivided into multiple blocks. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

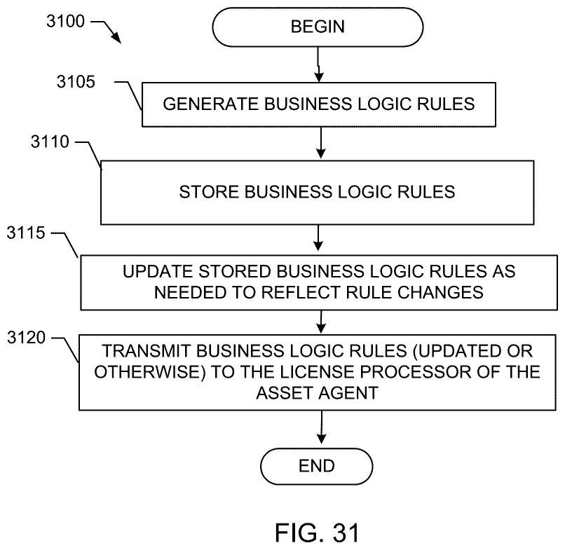

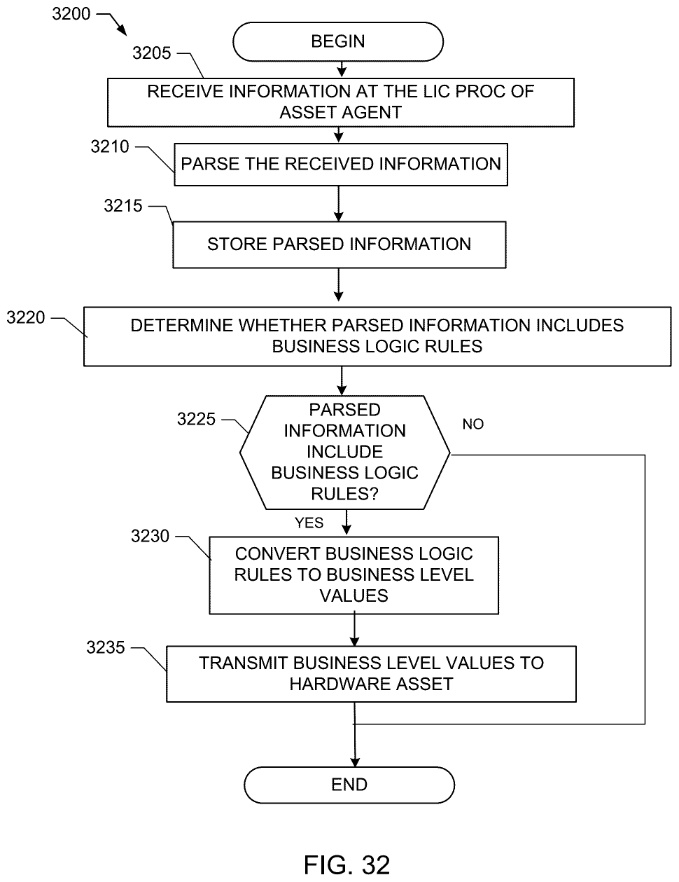

Flowcharts representative of example hardware logic, machine readable instructions, hardware implemented state machines, and/or any combination thereof for implementing the example systems 4900, 5000, 5100, the example silicon product 105 (e.g., the example semiconductor device 105), the example manufacturer enterprise system 110, the example customer enterprise system 115, the example cloud platform 120, the example SDSi asset agent 140, the example agent interface 202, the example agent local services 204, the example analytics engine 206, the example communication services 208, the example agent CLI 210, the example agent daemon 212, the example license processor 214, the example agent library 218, the example feature libraries 220-230, the example product management service 252, the example customer management service 254, the example SDSi feature management service 256, the example SDSi portal 262, the example SDSi agent management interface 264, the example manufacturer trusted agent determiner 1102, the example SDSi client agent 272, the example platform inventory management service 274, the example accounts management service 276, the example entitlement management service 278, the example trusted agent determiner 5004, the example certificate validator 5006, the example anomaly detector 5008, the example anomaly detection ML model(s) 5010, the example feature intent determiner 5012, the example feature intent ML model(s) 5014, the example TEE identifier 5102, the example TEE generator 5104, the example TEE(s) 5105, the example TEE library 5106, and/or the example TEE component(s) 1208 are shown in FIGS. 19-25. In these examples, the machine readable instructions may be one or more executable programs or portion(s) of an executable program for execution by a computer processor, such as the processors 6412, and/or 6512 shown in the example processor platforms 6400, 6500 discussed below in connection with FIGS. 31-32. The one or more programs, or portion(s) thereof, may be embodied in software stored on a non-transitory computer readable storage medium such as a CD-ROM, a floppy disk, a hard drive, a DVD, a Blu-ray Disk™, or a memory associated with the processors 6412, and/or 6512, but the entire program or programs and/or parts thereof could alternatively be executed by a device other than the processor 6412, and/or 6512 and/or embodied in firmware or dedicated hardware. Further, although the example program(s) is(are) described with reference to the flowcharts illustrated in FIGS. 19-25, many other methods of implementing the example systems 4900, 5000, and/or 5100, the example silicon product 105 (e.g., the example semiconductor device 105), the example manufacturer enterprise system 110, the example customer enterprise system 115, the example cloud platform 120, the example SDSi asset agent 140, the example agent interface 202, the example agent local services 204, the example analytics engine 206, the example communication services 208, the example agent CLI 210, the example agent daemon 212, the example license processor 214, the example agent library 218, the example feature libraries 220-230, the example product management service 252, the example customer management service 254, the example SDSi feature management service 256, the example SDSi portal 262, the example SDSi agent management interface 264, the example manufacturer trusted agent determiner 1102, the example SDSi client agent 272, the example platform inventory management service 274, the example accounts management service 276, the example entitlement management service 278, the example trusted agent determiner 5004, the example certificate validator 5006, the example anomaly detector 5008, the example anomaly detection ML model(s) 5010, the example feature intent determiner 5012, the example feature intent ML model(s) 5014, the example TEE identifier 5102, the example TEE generator 5104, the example TEE(s) 5105, the example TEE library 5106, and/or the example TEE component(s) 1208 may alternatively be used. For example, with reference to the flowcharts illustrated in FIGS. 19-25, the order of execution of the blocks may be changed, and/or some of the blocks described may be changed, eliminated, combined and/or subdivided into multiple blocks. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

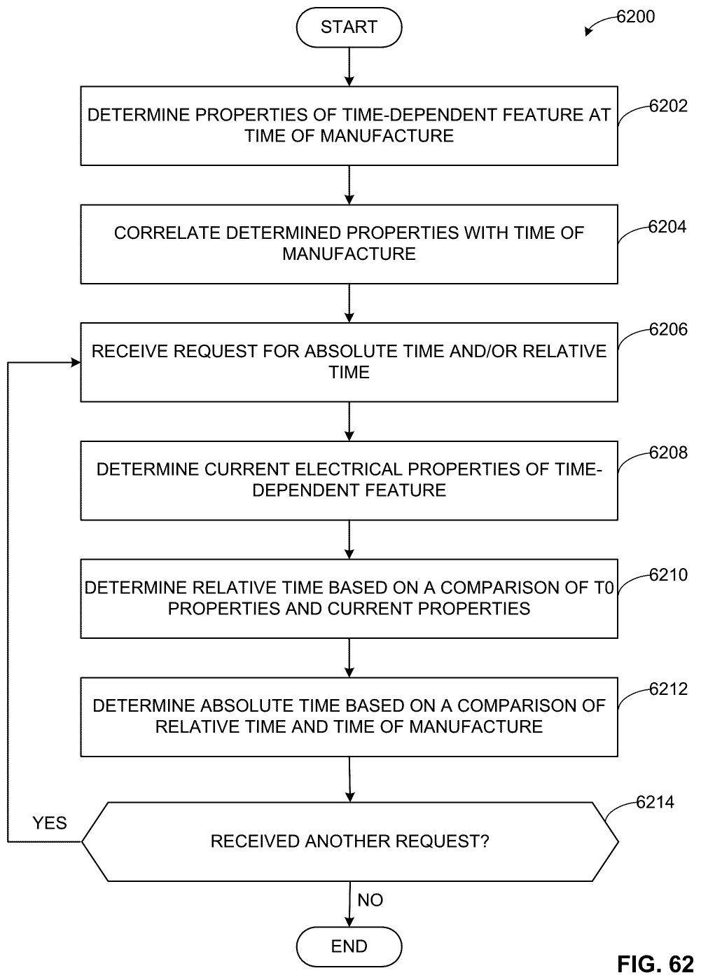

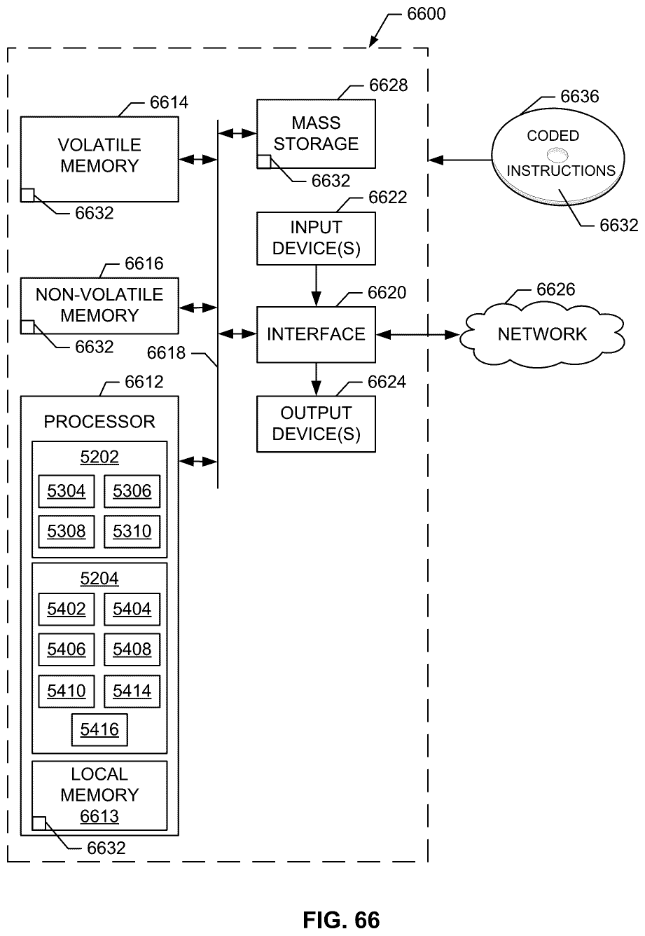

A flowchart representative of example hardware logic, machine readable instructions, hardware implemented state machines, and/or any combination thereof for implementing the time calculator 5202 of FIGS. 52 and 53 is shown in FIG. 62. The machine readable instructions may be one or more executable programs or portion(s) of an executable program for execution by a computer processor and/or processor circuitry, such as the processor 6612 shown in the example processor platform 6600 discussed below in connection with FIG. 66. The program may be embodied in software stored on a non-transitory computer readable storage medium such as a CD-ROM, a floppy disk, a hard drive, a DVD, a Blu-ray disk, or a memory associated with the processor 6612, but the entire program and/or parts thereof could alternatively be executed by a device other than the processor 6612 and/or embodied in firmware or dedicated hardware. Further, although the example program is described with reference to the flowchart illustrated in FIG. 62, many other methods of implementing the example time calculator 5202 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

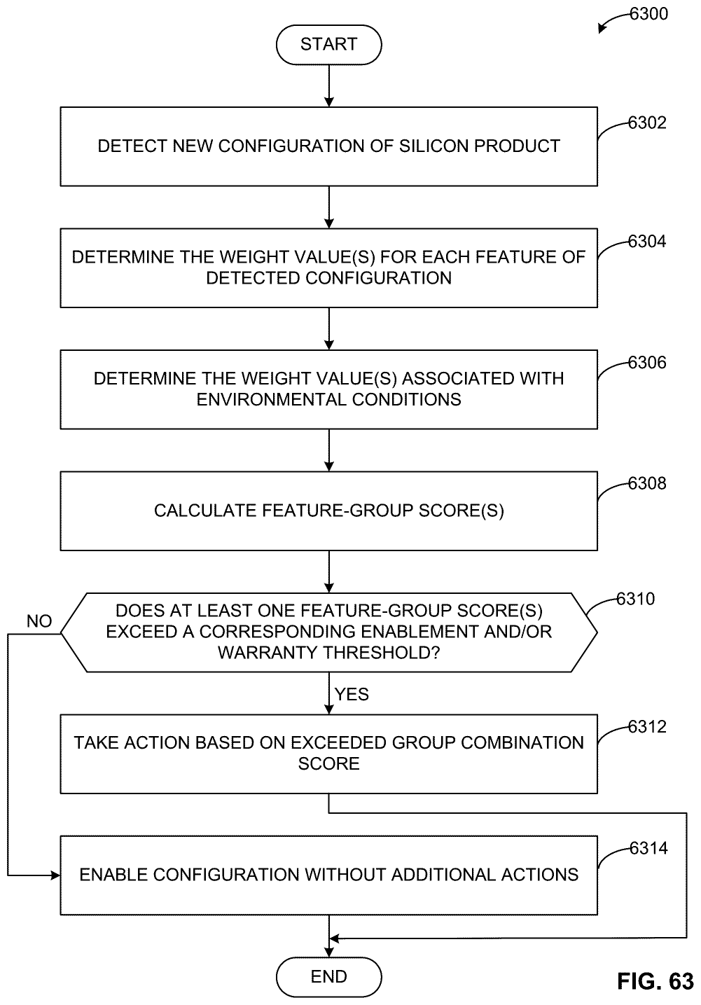

A flowchart representative of example hardware logic, machine readable instructions, hardware implemented state machines, and/or any combination thereof for implementing the feature group calculator 5204 of FIGS. 52 and 54 is shown in FIG. 63. The machine readable instructions may be one or more executable programs or portion(s) of an executable program for execution by a computer processor and/or processor circuitry, such as the processor 6612 shown in the example processor platform 6600 discussed below in connection with FIG. 66. The program may be embodied in software stored on a non-transitory computer readable storage medium such as a CD-ROM, a floppy disk, a hard drive, a DVD, a Blu-ray disk, or a memory associated with the processor 6612, but the entire program and/or parts thereof could alternatively be executed by a device other than the processor 6612 and/or embodied in firmware or dedicated hardware. Further, although the example program is described with reference to the flowchart illustrated in FIG. 63, many other methods of implementing the example feature group calculator 5204 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 19-21, FIGS. 22A-22B, 23-25 and 26, FIGS. 27-34, FIGS. 55-61, and FIGS. 62-63 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. Also, as used herein, the terms “computer readable” and “machine readable” are considered equivalent unless indicated otherwise.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

Software Defined Silicon Architecture

An example program 1900 that may be executed to implement the example manufacturer enterprise system 110 of the example systems 100 and/or 200 of FIGS. 1-2 is illustrated in FIG. 19. The example program 1900 may be executed at predetermined intervals, based on an occurrence of a predetermined event, etc., or any combination thereof. With reference to the preceding figures and associated written descriptions, the example program 1900 of FIG. 19 begins execution at block 1905 at which the customer management service 254 of the manufacturer enterprise system 110 on-boards a customer for access to SDSi capabilities offered by the manufacturer of the SDSi product 105, as described above. For example, the customer management service 254 can exchange information with the customer enterprise system 115 of the customer to on-board the customer prior to or after the customer's purchase of the SDSi product 105.

At block 1910, the SDSi portal 262 of the manufacturer enterprise system 110 receives a request to activate (or deactivate) an SDSi feature of the SDSi product 105, as described above. In the illustrated example, the request is forwarded to the SDSi feature management service 256, which identifies the SDSi product 105 associated with the request and determines whether the request is valid. Assuming the request is valid, at block 1915, the SDSi feature management service 256 initiates a query to determine whether the SDSi feature to be activated (or deactivated) is supported by the SDSi product 105. In some examples, the SDSi feature management service 256 invokes the SDSi agent management interface 264 of the manufacturer enterprise system 110 to send the query directly to the SDSi product 105, as described above, thereby directly querying the SDSi product 105. In some examples, the SDSi feature management service 256 sends the query to the SDSi client agent 272 of the client enterprise system 115, which then sends the query to the SDSi product 105, as described above, thereby indirectly querying the SDSi product 105. In some examples, the SDSi agent management interface 264 queries one or more database and/or other data structure(s) maintained by the manufacturer enterprise system 110 to determine whether the SDSi product 105 supports the SDSi feature to be activated (or deactivated), as described above.

If the requested SDSi feature is not supported by the SDSi product 105 (block 1920), at block 1925 the manufacturer enterprise system 110 performs error handling and denies the request, such as by sending an appropriate communication via the SDSi portal 262 to the customer enterprise system 115. However, if the requested SDSi feature is supported by the SDSi product 105 (block 1920), at block 1930 the SDSi feature management service 256 of the manufacturer enterprise system 110 generates a license to activate (or deactivate) the SDSi feature in response to the customer's request, as described above. At block 1935, the SDSi feature management service 256 causes the license to be sent via the SDSi portal 262 to the SDSi client agent 272 of the customer enterprise system 115, as described above.

Sometime later, at block 1940, the manufacturer enterprise system 110 receives, as described above, a certificate reported by the SDSi product 105 to confirm activation (or deactivation) of the requested SDSi feature, which is processed by the SDSi feature management service 256. In some examples, the certificate is received directly from the SDSi product 105 by the SDSi agent management interface 264 of the manufacturer enterprise system 110. In some examples, the certificate is received indirectly, such as from the SDSi client agent 272 of the client enterprise system 115, which received the certificate form the SDSi product 105. At block 1940, the SDSi feature management service 256 of the manufacturer enterprise system 110 processes the received certificate, as described above, to confirm successful activation (or deactivation) of the requested SDSi feature, and invokes the customer management service 254 to reconcile billing, generate an invoice, etc., which contacts the customer enterprise system 115 accordingly. Thereafter, at block 1945, the SDSi feature management service 256 of the manufacturer enterprise system 110 receives telemetry data reported by the SDSi product 105 (e.g., in one or more certificates), as described above, which is processed at the manufacturer enterprise system 110 to confirm proper operation of the SDSi product 105, reconcile billing, generate further invoice(s), etc.

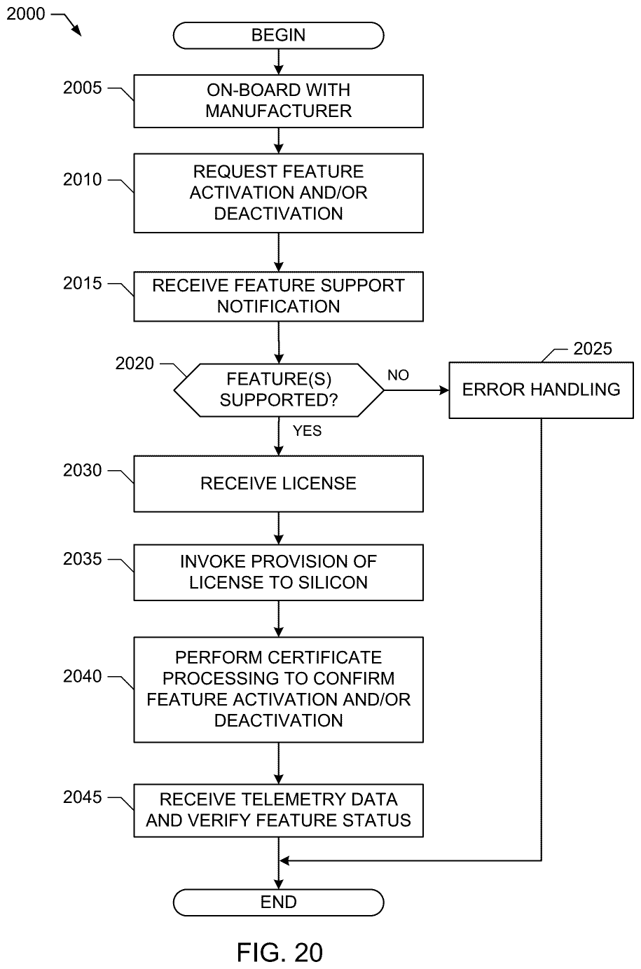

An example program 2000 that may be executed to implement the example customer enterprise system 115 of the example systems 100 and/or 200 of FIGS. 1-2 is illustrated in FIG. 20. The example program 2000 may be executed at predetermined intervals, based on an occurrence of a predetermined event, etc., or any combination thereof. With reference to the preceding figures and associated written descriptions, the example program 2000 of FIG. 20 begins execution at block 2005 at which the accounts management service 276 of the customer enterprise system 115 on-boards its customer for access to SDSi capabilities offered by a manufacturer of the SDSi product 105, as described above. For example, the accounts management service 276 can exchange information with the manufacturer enterprise system 110 to on-board with the manufacturer prior to or after the customer's purchase of the SDSi product 105.

At block 2010, the SDSi client agent 272 of the client enterprise system 115 sends a request to activate (or deactivate) an SDSi feature of the SDSi product 105, as described above. In the illustrated example, the request is generated by the platform inventory management service 274 or the SDSi client agent 272 of the client enterprise system 115, and is sent by the SDSi client agent 272 to the SDSi portal 262 of the manufacturer enterprise system 110. At block 2015, the SDSi client agent 272 receives a notification from the SDSi portal 262 that indicates whether the requested SDSi feature to be activated (or deactivated) is supported by the SDSi product 105. If the requested SDSi feature is not supported by the SDSi product 105 (block 2020), at block 2025 the customer enterprise system 115 performs error handling and, for example, updates the platform inventory management service 274 to note that the requested SDSi feature is not supported by the SDSi product 105. However, if the requested SDSi feature is supported by the SDSi product 105 (block 2020), at block 2030 the SDSi client agent 272 receives, from the SDSi portal 262, a license to activate (or deactivate) the SDSi feature in response to the customer's request, as described above. In the illustrated example, the license is maintained by the entitlement management service 278 of the customer enterprise system 115 until the customer is ready to invoke the license, as described above.

Sometime later, at block 2035, the entitlement management service 278 determines (e.g., based on customer input) that the license received at block 2030 to activate (or deactivate) the SDSi feature is to be invoked. Thus, the entitlement management service 278 provides the license to the SDSi client agent 272, which sends (e.g., downloads) the license to the SDSi product 105, as described above. Sometime later, at block 2040, the customer enterprise system 115 receives, as described above, a certificate reported by the SDSi product 105 to confirm activation (or deactivation) of the requested SDSi feature. In the illustrated example, the certificate is received directly from the SDSi product 105 by the SDSi client agent 272 of the customer enterprise system 115. At block 2040, the entitlement management service 278 of the customer enterprise system 115 processes the received certificate, as described above, to confirm successful activation (or deactivation) of the requested SDSi feature, and invokes the accounts management service 276 to reconcile billing, authorize payment, etc., which contacts the manufacturer enterprise system 110 accordingly. Thereafter, at block 2045, the SDSi client agent 272 of the customer enterprise system 115 receives feature status data reported by the SDSi product 105 (e.g., in one or more certificates), as described above, which is processed at the entitlement management service 278 and accounts management service 276 to confirm proper operation of the SDSi product 105, reconcile billing, authorize further payment(s), etc.

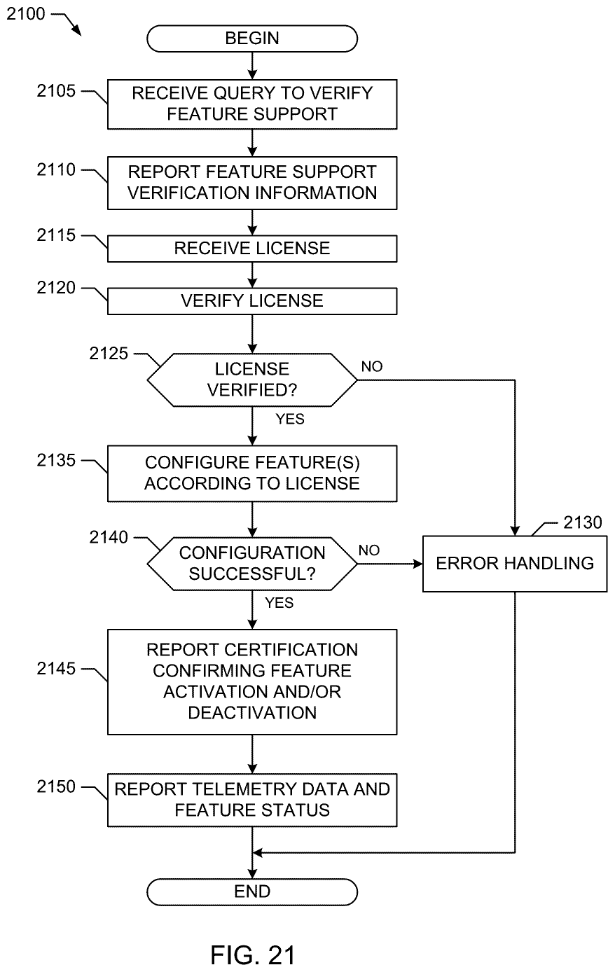

An example program 2100 that may be executed to implement the example SDSi asset agent 140 of the example systems 100 and/or 200 of FIGS. 1-2 is illustrated in FIG. 21. The example program 2100 may be executed at predetermined intervals, based on an occurrence of a predetermined event, etc., or any combination thereof. With reference to the preceding figures and associated written descriptions, the example program 2100 of FIG. 21 begins execution at block 2105 at which the SDSi asset agent 140 receives a query to confirm whether a particular SDSi feature is supported by the SDSi product 105. For example, the query may be from the SDSi agent management interface 264 of the manufacturer enterprise system 110, the SDSi client agent 272 of the customer enterprise system 115, etc. At block 2110, the SDSi asset agent 140 invokes its license processor 214 to generate a response to the query, as describes above. For example, the license processor 214 analyzes the configuration of the hardware circuitry 125, the firmware 130 and/or the BIOS 135 of the SDSi product 105, and generates feature support verification information indicating whether the queried feature is supported by the SDSi product 105, which is reported by the SDSi asset agent 140 back to the source of the query.

At block 2115, the SDSi asset agent 140 receives a license from the SDSi client agent 272 of the customer enterprise system 115 to activate (or deactivate) an SDSi feature of the SDSi product 105, as described above. At block 2120, the license processor 214 of the SDSi asset agent 140 verifies the license. For example, the license processor 214 may determine the license is verified when the license correctly identifies the SDSi product 105 and/or the feature to be activated (or deactivated), when the license is authentic (e.g., based on a manufacturer signature included with the license, a license sequence number included in the license, etc.), when activation (or deactivation) of the requested SDSi feature will not result in an unsupported or otherwise invalid configuration of the SDSi product 105, etc., or any combination thereof. In some examples, the license processor 214 determines the license is verified if some or all such verification criteria are satisfied, and determines the license is unverified if one or more of such verification criteria are not satisfied.

If the license is determined to be unverified (block 2125), at block 2130 the SDSi asset agent 140 performs error handling to, for example, discard the license and report a certificate to the SDSi client agent 272 that indicates the license could not be invoked. However, if the license is determined to be valid (block 2125), at block 2135 the license processor 214 configures the SDSi product 105 to activate (or deactivate) the SDSi feature in accordance with the license, as described above. If configuration is not successful (block 2140), at block 2130 the SDSi asset agent 140 performs error handling to, for example, discard the license and report a certificate to the SDSi client agent 272 that indicates the configuration of the SDSi product 105 to activate (or deactivate) the requested SDSi feature was unsuccessful.

However, if configuration is successful (block 2140), at block 2145 the license processor 214, in combination with the analytics engine 205, generates a certificate to confirm the successful activation (or deactivation) of the requested SDSi feature, which is reported by the SDSi asset agent 140 to the SDSi client agent 272, as described above. Sometime later (e.g., in response to a request, based on an event, etc.), at block 2150, the SDSi asset agent 140 reports telemetry data and feature status data (e.g., in one or more certificates) to the SDSi client agent 272 of the customer enterprise system 115 and/or to the SDSi agent management interface 264 of the manufacturer enterprise system 110, as described above.

Protection Against Misuse of Software Defined Silicon

Example machine readable instructions 2200 for implementing the manufacturer enterprise system 110 of FIG. 10 and that may be executed to process entitlement requests are illustrated in FIGS. 6A-B. With reference to the preceding figures and associated descriptions, the example machine readable instructions 2200 begin at block 2202 of FIG. 6A. At block 2202, the example SDSi feature management service 256 accesses an entitlement request. In some examples, the entitlement request analyzer 1002 accesses the entitlement request via the cloud platform 120.

At block 2204, the example SDSi feature management service 256 determines whether the entitlement request includes an authentication key. In some examples, the example entitlement request analyzer 1002 determines whether the entitlement request includes an authentication key. In response to the entitlement request including an authentication key, processing transfers to block 2228 of FIG. 22B. Conversely, in response to the entitlement request not including an authentication key, processing transfers to block 2206.

At block 2206, the example SDSi feature management service 256 determines whether the entitlement request includes a completion certificate. In some examples, the entitlement request analyzer 1002 determines whether the entitlement request includes a completion certificate. In response to the entitlement request including a completion certificate, processing transfers to block 2208. Conversely, in response to the entitlement request not including a completion certificate, processing transfers to block 2210.

At block 2208, the example SDSi feature management service 256 sets the base state based on the completion certificate. In some examples, the license data store 1006 stores the base state based on the completion certificate. For example, the license data store 1006 can determine which features were active on the asset based on the completion certificate and store this information as the base state for the asset.

At block 2210, the example SDSi feature management service 256 determines whether a customer change has been identified. In some examples, the entitlement request analyzer 1002 determines whether a customer change has been identified. For example, if a customer identifier associated with the entitlement request is different from a customer identifier on the previous entitlement request, the entitlement request analyzer can determine that the owner of the asset has changed. In response to a customer change being identified, processing transfers to block 2214. Conversely, in response to a customer change not having been identified, processing transfers to block 2212.

At block 2214, the example SDSi feature management service 256 sets the current configuration of the asset as the base state for the new customer. In some examples, the license data store 1006 sets the current configuration of the asset as the base state for the new customer.

At block 2216, the example SDSi feature management service 256 stores the base state in the database. In some examples, the base state is stored in the license data store 1006.

At block 2218, the example SDSi feature management service 256 determines whether the entitlement request deactivates features active in the base state. In some examples, the entitlement request analyzer 1002 determines whether the entitlement request deactivates features active in the base state. In response to the entitlement request deactivating features active in the base state, processing transfers to block 2224. Conversely, in response to the entitlement request not deactivating features active in the base state, processing transfers to block 2220.

At block 2220, the example SDSi feature management service 256 determines whether the entitlement request violates any other rules. In some examples, the entitlement request analyzer 1002 determines whether the entitlement request violates any other rules. In response to the entitlement request violating any other rules, processing transfers to block 2224. Conversely, in response to the entitlement request not violating any other rules, processing transfers to block 2222.

At block 2222, the example SDSi feature management service 256 issues a license corresponding to the feature requested. In some examples, the license generator 1004 generates a license corresponding to the features that have been requested.

At block 2224, the example SDSi feature management service 256 denies the entitlement request. In some examples, the entitlement request analyzer 1002 denies the entitlement request.

At block 2226, the example SDSi feature management service 256 determines whether there is another entitlement request to process. In response to there being another entitlement request to process, processing returns to block 602. Conversely, in response to there not being another entitlement request to process, processing terminates.

At block 2228 of FIG. 22B, the example SDSi feature management service 256 accesses a public authentication key associated with the entitlement request. In some examples, the entitlement request analyzer 1002 accesses the public authentication key associated with the entitlement request. In some examples, a different form of authentication may be accessed in connection with the entitlement request.

At block 2230, the example SDSi feature management service 256 determines if the asset has had a prior entitlement request. In some examples, the license data store 1006 determines whether the asset has had a prior entitlement request. In response to the asset having had a prior entitlement request, processing transfers to block 2232. Conversely, in response to the asset not having had a prior entitlement request, processing transfers to block 2240.

At block 2232, the example SDSi feature management service 256 determines if the public authentication key of the current entitlement is different than the public key used in the prior entitlement request. In some examples, the license data store 1006 determines if the public authentication key of the current entitlement is different than the public key used in the prior entitlement request. In response to the public authentication key being different from the public key used in the prior entitlement request, processing transfers to block 2238. Conversely, in response to the public authentication key being the same as the public key used in the prior entitlement request, processing transfers to block 2234.

At block 2234, the example SDSi feature management service 256 retrieves the base state from the license data store. In some examples, the entitlement request analyzer 1002 retrieves the base state from the license data store 1006.

At block 2236, the example SDSi feature management service 256 determines if the base state is signed with a prior customer's authentication key. In some examples, the license data store 1006 determines if the base state is signed with a prior customer's authentication key. In response to the base state being signed with a prior customer's authentication key, processing transfers to block 2238. Conversely, in response to the base state not being signed with a prior customer's authentication key, processing transfers to block 2240.

At block 2238, the example SDSi feature management service 256 stores the base state associated with the prior customer in the entitlement database. In some examples, the license data store 1006 stores the base state associated with the prior customer in the entitlement database.

At block 2240, the example SDSi feature management service 256 sets and stores the current configuration as the base state for the asset in association with the authentication key. In some examples, the license data store sets and stores the current configuration as the base state for the asset in association with the authentication key.

At block 2242, the example SDSi feature management service 256 determines if the entitlement request attempts to deactivate features active in the base state. In some examples, the entitlement request analyzer 1002 determines if the entitlement request attempts to deactivate features active in the base state. In response to the entitlement request attempting to deactivate features active in the base state, processing transfers to block 2246. Conversely, in response to the entitlement request not attempting to deactivate features active in the base state, processing transfers to block 2244.

At block 2244, the example SDSi feature management service 256 determines whether the entitlement request violates any other rules. In some examples, the entitlement request analyzer 1002 determines whether the entitlement request violates any other rules. In response to the entitlement request violating any other rules, processing transfers to block 2246. Conversely, in response to the entitlement request not violating any other rules, processing transfers to block 2248.

At block 2246, the example SDSi feature management service 256 denies the entitlement request. In some examples, the entitlement request analyzer 1002 denies the entitlement request.

At block 2248, the example SDSi feature management service 256 issues a license corresponding to the feature(s) requested, signing the license with the public authentication key. In some examples, the license generator 1004 issues a license corresponding to the feature(s) requested, signing the license with the public authentication key associated with the customer.

At block 2250, the example SDSi feature management service 256 determines whether there is another entitlement request to process. In response to there being another entitlement request to process, processing transfers to block 602 of FIG. 6A. Conversely, in response to there not being another entitlement request to process, processing terminates.

Example machine readable instructions 2300 for implementing the SDSi asset agent 140 of FIG. 10 are illustrated in FIG. 7. With reference to the preceding figures and associated descriptions, the example machine readable instructions 2300 begin at block 2302. At block 2302, the example SDSi asset agent 140 determines whether a license has been received. In some examples, the license processor 214 determines whether a license has been received. In response to a license having been received, processing transfers to block 2304. Conversely, in response to a license having not been received, processing transfers to block 2330.

At block 2304, the example SDSi asset agent 140 determines whether an instruction to apply a license has been received. In some examples, the license manager 1016 determines whether an instruction to apply a license has been received. In response to an instruction to apply the license having been received, processing transfers to block 2308. Conversely, in response to an instruction to apply the license not having been received, processing transfers to block 2306.

At block 2308, the example SDSi asset agent 140 determines if the license is signed with an authentication key. In some examples, the authentication analyzer 1018 determines if the license is signed with an authentication key. In response to the license being signed with an authentication key, processing transfers to block 2310. Conversely, in response to the license not being signed with an authentication key, processing transfers to block 2318.

At block 2310, the example SDSi asset agent 140 determines whether the public customer authentication key (CAK) of the license corresponds to the current customer's private CAK. In some examples, the authentication analyzer 1018 determines if the public CAK of the license corresponds to the current customer's private CAK. In response to the public CAK of the license corresponding to the current customer's private CAK, processing transfers to block 2316. Conversely, in response to the public CAK of the license not corresponding to the current customer's private CAK, processing transfers to block 2312.

At block 2312, the example SDSi asset agent 140 invalidates the license. In some examples, the license manager 1016 invalidates the license.

At block 2314, the example SDSi asset agent 140 communicates an unintended recipient error to the asset manufacturer. In some examples, the agent interface 202 and/or the authentication analyzer 1018 communicates the unintended recipient error to the asset manufacturer, to inform the manufacturer that an attempt was made to execute a license on an unintended asset.

At block 2316, the example SDSi asset agent 140 decodes the license using a private CAK. In some examples, the authentication analyzer 1016 decodes the license using the private CAK.

At block 2318, the example SDSi asset agent 140 activates feature(s) in accordance with the license. In some examples, the feature activator 1020 activates features in accordance with the license.

At block 2320, the example SDSi asset agent 140 generates a completion certificate. In some examples, the certificate manager 1014 generates a completion certificate.

At block 2322, the example SDSi asset agent 140 stores the completion certificate. In some examples, the certificate manager 1014 stores the completion certificate.

At block 2324, the example SDSi asset agent 140 determines whether the asset is ready for transfer to a new customer. In some examples, the agent interface 202 determines whether the asset is ready for transfer to a new customer. In response to the asset being ready for transfer to a new customer, processing transfers to block 2326. Conversely, in response to the asset not being ready for transfer to a new customer, processing transfers to block 2330.

At block 2326, the example SDSi asset agent 140 signs the base state configuration with a private authentication key. In some examples, the authentication analyzer 1018 signs the base state configuration with the private authentication key.

At block 2328, the example SDSi asset agent 140 communicates the base state to the asset manufacturer. In some examples, the agent interface 202 communicates the base state to the asset manufacturer.

At block 2330, the example SDSi asset agent 140 determines whether to continue monitoring. In response to continuing monitoring, processing transfers to block 702. Conversely, in response to not continuing monitoring, processing terminates.

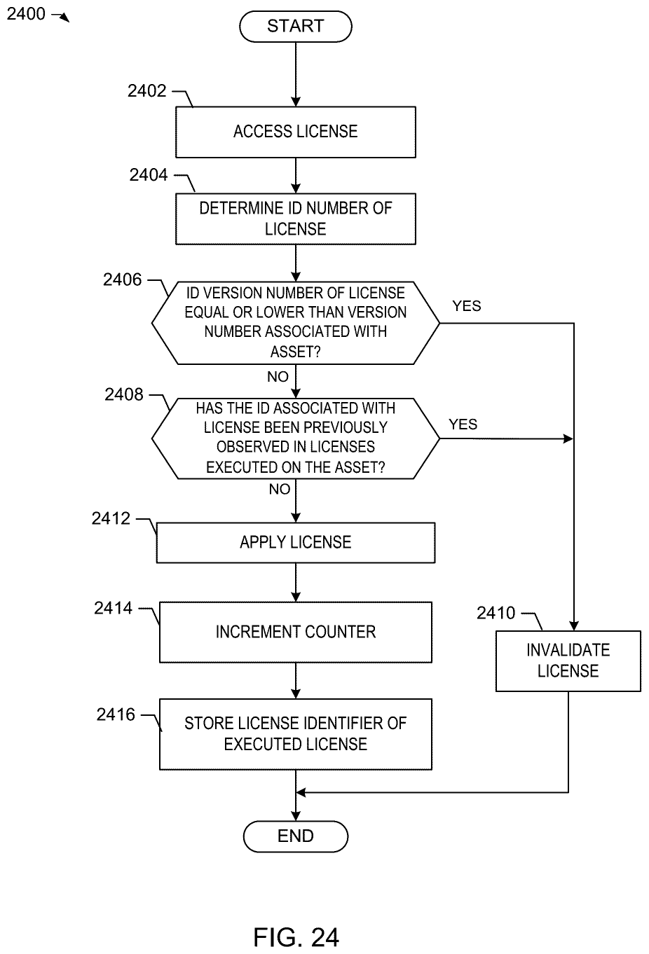

Example machine readable instructions 2400 for implementing the SDSi asset agent 140 of FIG. 10 to protect against license reuse are illustrated in FIG. 24. With reference to the preceding figures and associated descriptions, the example machine readable instructions 2400 begin at block 2402. At block 2402, the example SDSi asset agent 140 accesses a license. In some examples, the license manager 1016 accesses a license.

At block 2404, the example SDSi asset agent 140 determines an ID number of the license. In some examples, the license manager 1016 determines an ID number of the license.

At block 2406, the example SDSi asset agent 140 determines whether the ID version number is equal or lower than the version number associated with the asset. In some examples, the license manager 1016 compares the ID number of the license with a version number of the asset (e.g., the semiconductor device 105). In some examples, the version number of the asset is provided via the certificate manager 1014. For example, the version number may be incremented by the certificate manager 1014 in response to completion certificates received when licenses are executed. In response to the ID version number of the license being equal to or lower than the version number associated with the asset, processing transfers to block 2410. Conversely, in response to the ID version number of the license not being equal to or lower than the version number associated with the asset, processing transfers to block 2408.

At block 2408, the example SDSi asset agent 140 determines whether the ID associated with the license has been previously observed in licenses executed on the asset. In some examples, the license processor 214 determines whether the ID associated with the license has been previously observed in licenses executed on the asset. In response to the ID associated with the license having been previously observed, processing transfers to block 2410. Conversely, in response to the ID associated with the license not having been previously observed in licenses executed on the asset, processing transfers to block 2412.

At block 2410, the example SDSi asset agent 140 invalidates the license. In some examples, the license processor 214 invalidates the license.

At block 2412, the example SDSi asset agent 140 applies the license. In some examples, the feature activator 1020 executes the license and activates and/or deactivates features on the semiconductor device 105 based on instructions provided in the license.

At block 2414, the example SDSi asset agent 140 increments a counter. In some examples, the license manager 1016 increments a counter associated with the version number of the asset. For example, the counter may be incremented based on a number of licenses executed (e.g., in the case of executing one license, the version number associated with the asset increases by 0.1).

At block 2416, the example SDSi asset agent 140 stores the license identifier of the executed license. In some examples, the license processor 214 and/or the certificate manager 1014 store the license identifier of the executed license.

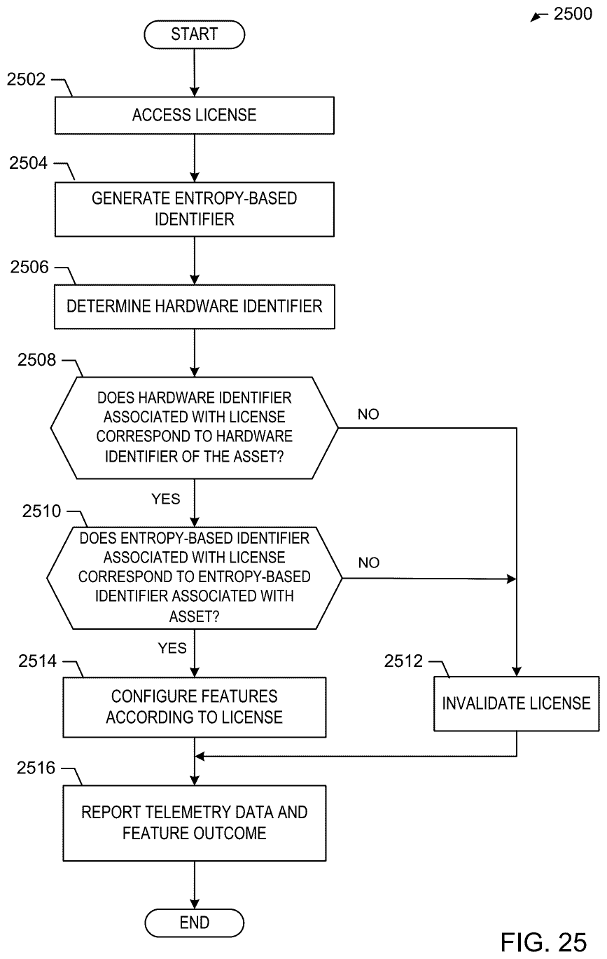

Example machine readable instructions 2500 for implementing the SDSi asset agent 140 of FIG. 10 to provide license identification protection features are illustrated in FIG. 25. With reference to the preceding figures and associated descriptions, the example machine readable instructions 2500 begin at block 2502. At block 2502, the example SDSi asset agent 140 accesses a license. In some examples, the license manager 1016 accesses a license.

At block 2504, the example SDSi asset agent 140 generates an entropy-based identifier. In some examples, the entropy identifier generator 1012 generates an entropy-based identifier to serve as a unique, non-cloneable identifier for the semiconductor device 105. In some examples, the entropy-based identifier has already been generated and is retrieved from the entropy identifier generator 1012 and/or retrieved from an accessible storage location.

At block 2506, the example SDSi asset agent 140 determines a hardware identifier. In some examples, the hardware identifier manager 1010 determines a hardware identifier. In some examples, the hardware identifier has been previously generated and/or determined and is retrieved from the hardware identifier manager 1010 and/or retrieved from another accessible storage location.

At block 2508, the example SDSi asset agent 140 determines whether the hardware identifier associated with the license corresponds to the hardware identifier of the asset. In some examples, the license manager 1016 determines whether the hardware identifier associated with the license corresponds to the hardware identifier of the asset. In response to the hardware identifier of the license corresponding to the hardware identifier of the asset, processing transfers to block 2510. Conversely, in response to the hardware identifier of the license not corresponding to the hardware identifier of the asset, processing transfers to block 2512.

At block 2510, the example SDSi asset agent 140 determines whether the entropy-based identifier associated with the license corresponds to the entropy-based identifier associated with the asset. In some examples, the license manager 1016 determines whether the entropy-based identifier associated with the license corresponds to the entropy-based identifier associated with the asset. In response to the entropy-based identifier associated with the license corresponding to the entropy-based identifier associated with the asset, processing transfers to block 2514. Conversely, in response to the entropy-based identifier associated with the license not corresponding to the entropy-based identifier associated with the asset, processing transfers to block 2512.

At block 2512, the example SDSi asset agent 140 invalidates the license. In some examples, the license manager 1016 invalidates the license.

At block 2514, the example SDSi asset agent 140 configures features according to the license. In some examples, the feature activator 1020 configures features (e.g., activates features, deactivates features, adjusts parameters of features, etc.) according to the license.

At block 2516, the example SDSi asset agent 140 reports telemetry data and the feature outcome. In some examples, the certificate manager 1014 communicates a completion certificate indicating which features are active on the semiconductor device 105 to the manufacturer enterprise system 110. In some examples, the completion certificate is stored on the manufacturing device 105.

Example machine readable instructions 2600 for implementing the manufacturer enterprise system 110 of FIG. 10 to employ license identification protection features are illustrated in FIG. 25. With reference to the preceding figures and associated descriptions, the example machine readable instructions 1000 begin at block 2602. At block 2602, the example manufacturer enterprise system 110 receives an entitlement request. In some examples, the entitlement request analyzer 1002 receives an entitlement request.

At block 2604, the example manufacturer enterprise system 110 analyzes rules to determine if a license should be granted. In some examples, the entitlement request analyzer 2604 analyzes rules to determine if the license should be granted.

At block 2606, the example manufacturer enterprise system 110 determines whether to grant the entitlement request. In some examples, the entitlement request analyzer 1002 determines whether to grant the entitlement request. In response to granting the entitlement request, processing transfers to block 2608. Conversely, in response to the entitlement request not being granted, processing transfers terminates.

At block 2608, the example manufacturer enterprise system 110 retrieves a hardware identifier and/or an entropy identifier for the asset for which the entitlement is granted. In some examples, the license generator 1004 retrieves the hardware identifier and/or the entropy-based identifier from the identifier database 1008. In some examples, the identifier is provided along with the entitlement request, and the license generator 1004 accesses the one or more identifiers from the entitlement request analyzer 1002.

At block 2610, the example manufacturer enterprise system 110 generates a license. In some examples, the license generator 1004 generates the license.

At block 2612, the example manufacturer enterprise system 110 associates the hardware identifier and/or the entropy identifier with the license. In some examples, the license generator 1004 associates the hardware identifier and/or the entropy-based identifier with the license.

At block 2614, the example manufacturer enterprise system 110 issues the license for the asset. In some examples, the license generator 1004 communicates the license to the customer enterprise system 115 for downloading to the semiconductor device 105.

Delegated SDSi Feature Licensing System

FIG. 27 is a program 2700 that can be executed to implement the example central processor 1510 of FIGS. 15 and 16. The program begins at block 2705 at which the example requirement definer 1612 defines requirements to be satisfied by any third party seeking to obtain ADL status in the manner described above with respect to FIG. 16. When a request from a third party to obtain such status is received, the example third party verifier 1614 attempts to verify that the requesting third party satisfies the defined requirements (block 2710). In some examples, the third party supplies such credentials in or with the request for licensor status and/or via a separate communication. In some examples, the third party credentials are already known to the example central licensor 1510 as being associated with purchasers of one or more SDSi products, for example. When the third party verifier 1614 determines that the defined requirements are satisfied (block 2715), the example request grantor 1618 notifies the third party that the request has been granted (block 2723). When the third party verifier 1614 determines that the requirements are not satisfied (also block 2715), the example request denier 1616 notifies the third party that the request has been denied (block 2720).

In some examples, when ADL status is granted to a third party, the example constraints generator 1620 generates one or more constraints that can be used to restrict (or otherwise define/limit) the types of licenses that can granted, the SDSi products for which a license may be granted, the duration of any granted licenses, a geographic area within which an asset is to reside before a license is granted, etc. (block 2725). In some examples, the example feature identifier 1622 identifies one or more specific features that can be granted by the ADLs (e.g., of the first, second and/or third ADLs 1515, 1565A, 1570A) or by specific ones of the first, second and/or third ADLs 1515, 1565A, 1570A (block 2730).

In some examples, the example signature generator 1624 generates a script or code to be used by any of the example first, second and/or third ADLs 1515, 1565A, 1570A when granting a license (block 2735) in the manner described above with respect to FIG. 2. The generated signature script/code is used to sign any licenses granted by the unique one of the first, second and/or third ADLs 1515, 1565A, 1570A (of a third party(ies)).

In some examples, the example configuration installation generator 1628 of the example central licensor 1510 generates script/code that, when executed by a hardware asset, (e.g., any of the first, second, and/or third hardware assets 1540, 1580, 1585) will, in some examples, enable or disable (or perform any other function with respect to) a feature of the hardware asset executing the script/code (block 2740). To ensure that the configuration installation script/code remains secure from access by the ADL (e.g., any of the first, second, and/or third hardware assets 1540, 1580, 1585), the configuration installation script/code can be encrypted by the configuration installation generator 1628 in a manner such that the hardware asset can decrypt the configuration installation script/code but the ADL lacks decryption information needed to access the script/code.

In some examples, information to be used by the third party granted status as an ADL is provided to the third party by the example communicator 1626. In some examples, such information can include information identifying features for which the third party granted status as an ADL can issue licenses, the unique signature script/code to be used by the ADL when issuing a license, the configuration installation information by which a feature can be enable, disabled, etc., and information identifying the constraints/limits governing the licensing activities of the newly ADL (e.g., any of the example first, second and/or third ADLs 1515, 1565A 1570A) (block 545). Thereafter the program 2700 ends. In some examples, the program 2700 (or portions thereof) can be repeated as needed process additional incoming requested to obtain ADL status.

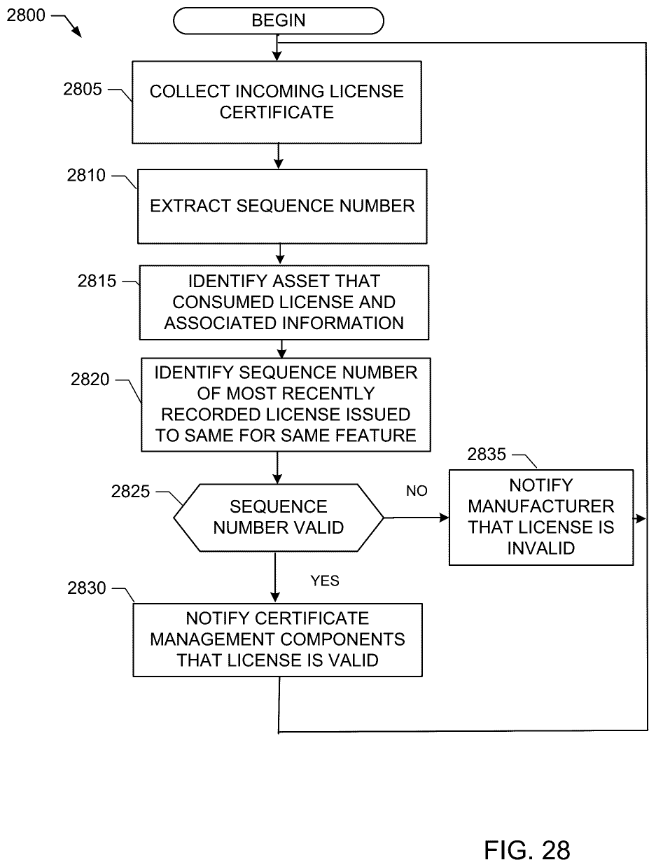

Turning now to FIG. 28, FIG. 28 is a program 2800 that can be executed to implement the example certificate handler 1630 (FIG. 2) of the example central processor 1510 (FIG. 15 and FIG. 16). The program 2800 begins at block 2805 at which the example certificate collector 1634 (FIG. 2) collects the incoming certificate. The example sequence number extractor 1640 (FIG. 2) extracts the sequence number of the license associated with the incoming certificate (block 2810). The example asset identifier 1632 (FIG. 2) uses information in the certificate to determine one or more of the hardware asset that consumed the license associated with the incoming certificate, the identity of the consumer (e.g., the third party) of the license, whether the license of the certificate was issued by an ADL, etc. (block 2815). In some such examples, some or all of the information may be encoded or otherwise included in the sequence number of the certificate. Using the identity of the hardware asset (or any of the other information included in the certificate) that consumed the license, the asset identifier 1632 accesses the sequence number storage 1638 to determine a preceding, most recently recorded license consumed by the hardware asset and a feature affected by the license to identify a sequence number associated with the preceding, most recently recorded license consumed by the same hardware asset for the same feature (block 2820). The example sequence number comparator 1636 compares the example sequence number associated with the certificate currently being handled by the certificate handler 1630 to the sequence number associated with the preceding, most recently recorded granted license consumed by the same hardware asset for the same feature (block 2825). When the sequence number comparator 1636 determines the example sequence number verifier 1642 was issued more recently than the license most recently recorded for the same feature and hardware asset, the sequence number verifier 1642 notifies other components of the certificate handler that the license associated with the certificate was validly issued so that the certificate can be handled by other components of the certificate handler in an appropriate manner (block 2830). When the sequence number comparator 1636 determines the example sequence number verifier 1642 was not issued more recently than the previously recorded license, the license is deemed invalid and the certificate handler and the sequence number verifier notifies other components of the certificate handler 1630 that the license associated with the certificate was outdated/expired/invalid (block 2835) so that the license associated with the certificate can be revoked or other appropriate action can be taken. After the certificate handler has been notified of the validity or invalidity of the license associated with the certificate (blocks 2835, 2830), the program 2800 returns to block 2805 and blocks subsequent thereto.

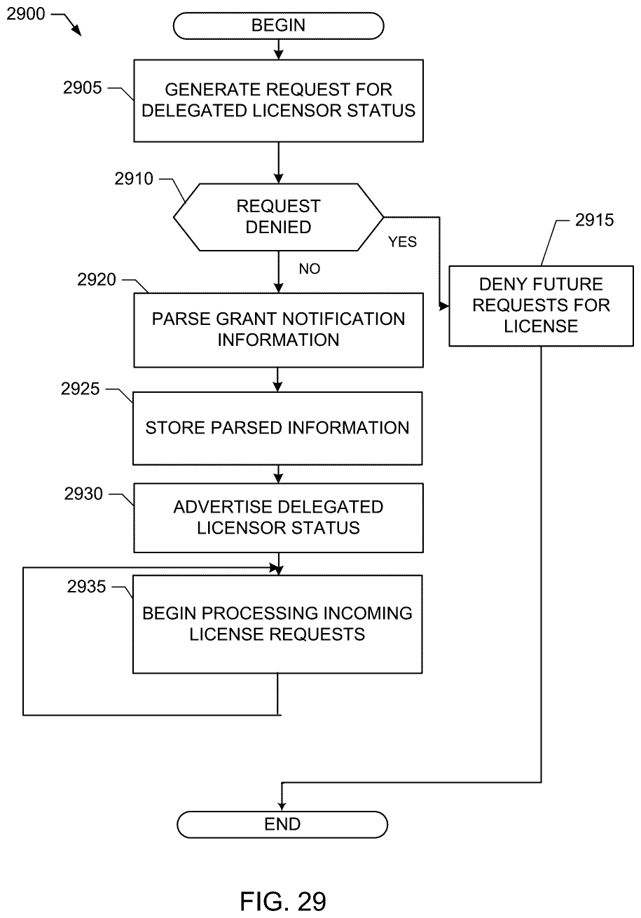

The flowchart of FIG. 29 represents a program 700 that can be executed to implement any of the example ADLs 1515, 1565A, 1570A (FIG. 3) of the example central processor 1510 (FIG. 15 and FIG. 16). The program 2900 begins at block 2905 at which the example authorized delegated license status requestor 1705 generates a request to become an ADL. The request can include information about the third party associated with the ADL 1515 including the information described with respect to FIG. 2. The request is communicated to the example central licensor 1510 (FIG. 1 and FIG. 2). The central licensor 1510 processes the request in the example manner disclosed above with respect to FIG. 2. Assuming the request is denied (block 2910), the example delegated license status requestor 1705 receives a denial, and the delegated license status requestor 1705 notifies the requestor that the example incoming license request has been denied (see block 2915). In response, any incoming requests for a license received from any customer (e.g., the customer enterprise system 115 (FIG. 1) are denied (on the basis that the ADL 1515 is not in fact authorized to grant such licenses) (block 2915). Thereafter, in some examples, the program 2900 ends.

Assuming the request is granted, a notification that status as an ADL has been granted is processed by the example status grant notification information parser 1712 (block 2920). The information can be parsed to identify information included in the notification such as a set of example constraints, a set of example feature identifiers, first example script/code that can be used to generate a license signature that is unique to the ADL 1515, second example script/code that is encrypted and that can be used to enable/disable a feature(s) of a hardware agent associated with the request. The example storage controller 1715 causes the parsed information to be stored in the storage (block 2925) for use by the example license generator 1735 when granting a license in response to a customer request for a license. An example advertiser 1730 notifies specific ones of the identified customers, for example, that the ADL 1515 has the ability and authority to grant feature licenses (block 2930). Thereafter, at block 2935, the example ADL can begin (and can continue to) process incoming license requests as permitted by the stored constraints and other information.

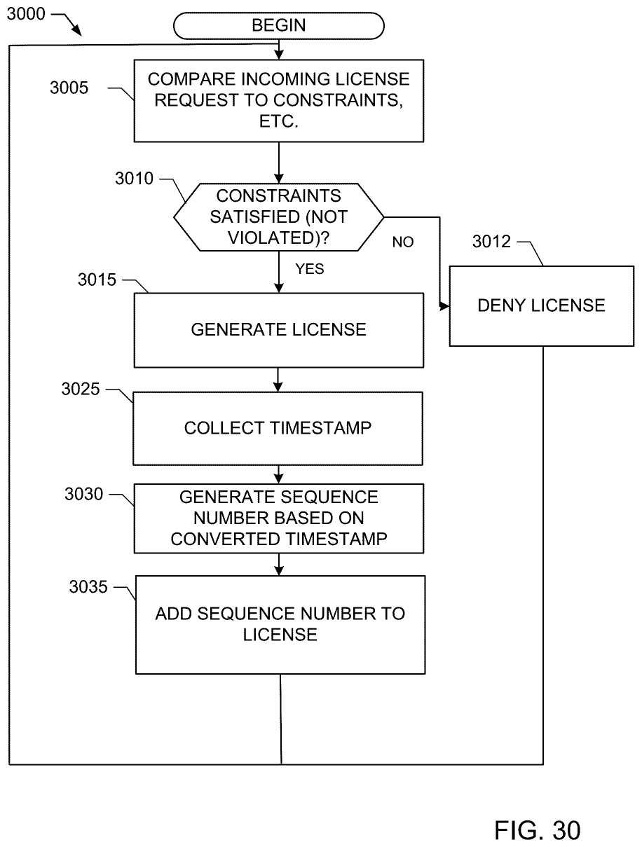

The flowchart of FIG. 30 represents a program 800 that can be executed to implement any of the example ADLs 1515, 1565A, 1570A (FIG. 3). The program 800 begins at block 3005 at which the example license verifier 1737 (FIG. 3) compares an incoming license request including, for example, the feature for which a license is requested, information about the customer requesting the license, etc., (block 3005) and determines whether the license request violates any constraints, whether the feature for which the license is requested is among the features that the ADL is permitted to license, etc. (block 3010) When the constraints are violated or the feature is not among the features for which a license may be granted, the license verifier 1737) can communicate to the customer that the request is denied (block 3012) and may further communicate information identifying the violated constraints (or not), or any other reasons the license request is denied (block 3012).

When the constraints are not violated and the feature is among the features for which the ADL 1515 is permitted to grant licenses, the license verifier 1737 can notify the example license generator 1735 which can proceed to generate the license and communicate the license to the example customer (e.g., the customer enterprise system 115 of FIG. 1) (block 3015). In some examples, when generating the license, the license generator 1735 can activate the example sequence number generator 1740. In response, the example time capturer 1745 of the sequence number generator 1740 captures a time at which the license is generated (block 3025). The example time converter 1750 converts the captured time to a sequence number (block 3030) and the example sequence number adder 1755 causes the license generator 1735 to the add the sequence number to the license to be generated (block 3035). As described in further detail above, in some examples, a certificate generated when the license is activated includes the unique sequence number. In some such examples, the example central licensor 1510 can use the sequence number and information included in the certificate concerning the license to verify that the license associated with the certificate is the most recently recorded license for that feature and for the hardware asset that consumed the license as described above. After the sequence number is added to the license the program 3000 can return to the block 3005 and blocks subsequent thereto to continue generating sequence numbers to be added to licenses that have been generated.

The flowchart of FIG. 31 represents a program 3100 that can be executed to implement an example portion of the example manufacturer enterprise system 110 (FIG. 1) illustrated in FIG. 18. The program 3100 begins at a block 3105 at which the example business logic rules generator 1801 generates the business logic rules in a business logic script/code format or in any other format. In some examples, the business logic rules are generated using machine learning. In some examples, the business logic rules (or parts thereof) can be entered by an administrator/user. In addition, the business logic rules are stored in the example business logic storage 1802 (block 3110). The example business logic rules updater 1804 can update the business logic rules as needed to reflect changes to the logic rules made by, for example, an administrator or by machine learning techniques as described above with respect to (block 3115). Thereafter, the license containing the business logic rules are transmitted to the example license processor of the example asset agent 214 of FIG. 2 (block 3120). It should be noted that, in some examples, a signature that can be used to verify the authenticity of the source of the business logic rules can be added to the business logic rules the business logic rules, prior to being transmitted to the license processor of the asset agent 214. The program of FIG. 31 (3100) then comes to an end. In some examples, the program 3100 is repeated when new business logic rules are to be generated and/or updated.

The flowchart of FIG. 32 represents a program 3200 that can be executed to implement at least a portion of the license processor of the asset agent 214. In some examples, the example business logic rules are received at the license processor of the asset agent 1812 and are formatted as business logic script/code. In some examples, the business logic rules include a corresponding signature (and can further include a license to enable or disable a feature) (block 3205). Assuming the signature included with the business logic rules is properly verified, the information parser 1816 parses the information received at the license processor of the asset agent (214) to separate the business logic rules from the signature, the license, and/or any other information included with the received communication (block 3210). In some examples, the information parser 1816 can cause the parsed information including the business logic rules script/code (if any are included in the received information) to be placed into the storage 1818 (block 3215) for access, as needed.

In some examples, the business level requirements determiner 1820 determines whether the parsed information includes business level logic rules or instead only includes a feature to be activated or deactivated (block 3220). In some examples, the parsed information does not include business logic rules (block 3225) and the program 3200 ends. In some examples, the business level requirements determiner 1820 determines that the parsed information includes business logic rules (block 3225). In some such examples, the example business level requirements converter 1821 converts the business logic rules script/code into a set of business level values that are interpretable by a Processor/CPU (e.g., a Processor/CPU 1834 of the hardware asset 1822) (block 3230). In some examples, converting the values can include translating, concatenating, re-interpreting, etc., the business level requirements into actionable functions are understandable and executable by the example processor/CPU 1834. Thereafter, the business level values and any other accompanying information is supplied to the hardware asset (block 3235) and the program 3200 ends.

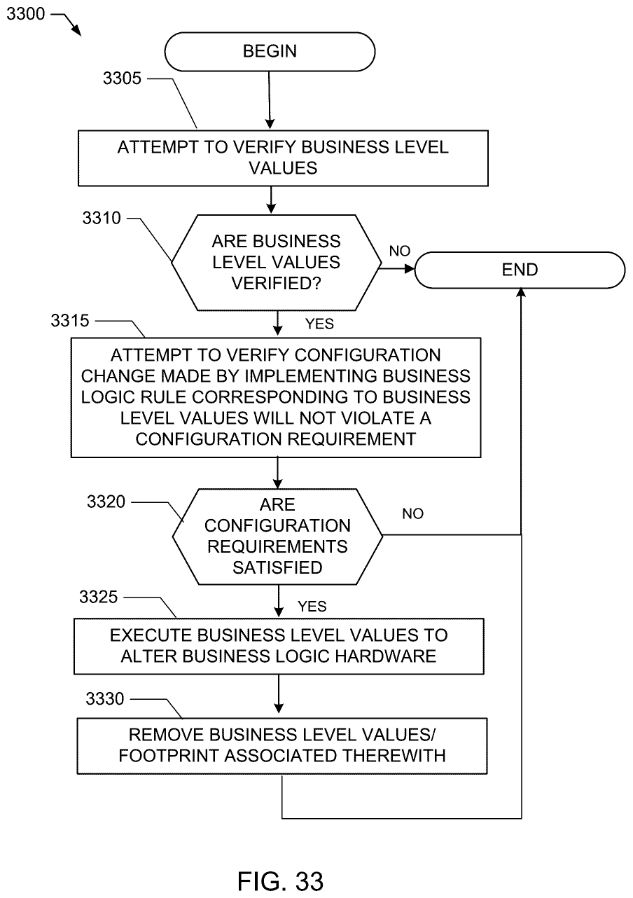

The flowchart of FIG. 33 represents a program 3300 that can be executed to implement at least a portion of the hardware asset 1822 of FIG. 18. In some examples, the business level values verifier 1823 attempts to verify that the business level values were supplied by a valid source (which may include authenticating any signatures supplied with the business level values) (block 3305). When the business level values cannot be verified (block 3310), the business logic rules are not hardcoded into the hardware asset (e.g., are not implemented) and the program 3300 ends. When the business level values are verified (block 3310), the configuration change verifier 1824 attempts to verify that the configuration change to be implemented by changing the business logic hardware when the business level values are executed by the processor/CPU 1834 will comply with any configuration requirement(s) that may be particular to the configuration of the hardware asset 1822 (block 3315). In some examples, the configuration change verifier 1824 also attempts to verify that the business level values correspond to a business logic rule change instead of, for example, a feature activation or deactivation (block 3315). When the configuration change verifier 1824 determines that the change that will occur as a result of implementing the business level values associated with the business logic rules will cause the configuration of the hardware asset to violate a configuration requirement (block 3320), the business logic rules represented by the business level values are not implemented, and the program 3300 ends. Likewise, when the configuration change verifier 1824 determines that the change to be affected by the business level values correspond to a feature activation/deactivation and not business logic rules (block 3320), the program 3300 ends.

When the configuration change verifier 1824 successfully verifies that the change that will occur as a result of implementing the business level values (associated with the business logic rules) will not cause the configuration of the hardware asset 1822 to violate a configuration requirement and that the business logic rules do not correspond to feature activation/deactivation (3320), the business level values are operated on by the example processor/CPU 1834 (FIG. 4) to alter/hardcode the business logic hardware 1835 (block 3325). In some such examples, the example business level values are supplied to the processor/CPU 1834 which interprets the business level values in a manner that causes the business logic hardware 1835 to be changed to operate with the new business logic rules in place (block 3325). After the business logic rules have been hardcoded into the business logic hardware, the example script/code remover 1832 removes the script/code/business level values (and/or a footprint thereof) used by the processor/CPU 1743 to thereby make space for future changes to the hardware encoded business logic rules (block 3330). By removing the code, the limited space available in the hardware asset 1822 is not limited by the number of business level logic changes that may be made in the future as space is available to accommodate future such changes. Thereafter, the program 3300 ends. In some examples, the program 3300 can be repeated each time new business logic rules are generated and/or updated.

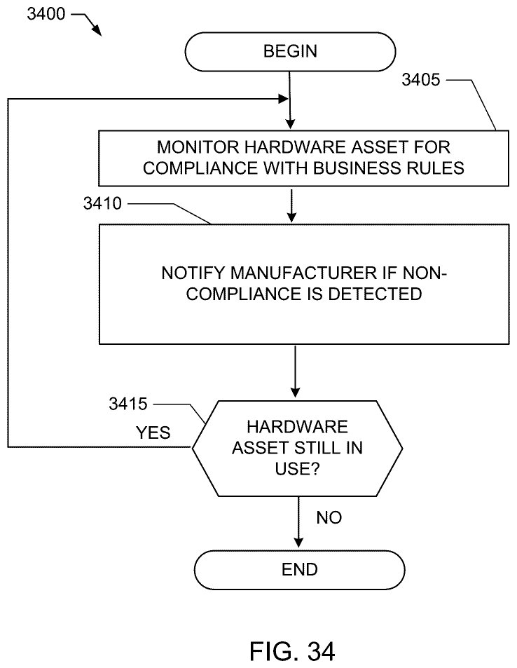

The flowchart of FIG. 34 represents a program 3400 that can be executed to implement at least a portion of the hardware asset 1822 of FIG. 18. In some examples, after the business logic rules have been implemented by the hardware asset in the manner described with respect to the program 3300 of FIG. 33, the example compliance monitor 1828 monitors the operation of the example hardware asset 1822 in light of the business logic rules (block 3405). In some examples, the compliance monitor 1828 of FIG. 18 generates notifications to the asset agent 214 (see FIG. 2) for transmission to the manufacturer 110 when noncompliance is detected (block 3410). The program 3400 continues to monitor compliance and report non-compliant operation until the hardware asset is taken out of commission or otherwise retired/replaced (as determined at block 3415) at which time the program 3400 ends.

Software Defined Silicon Security

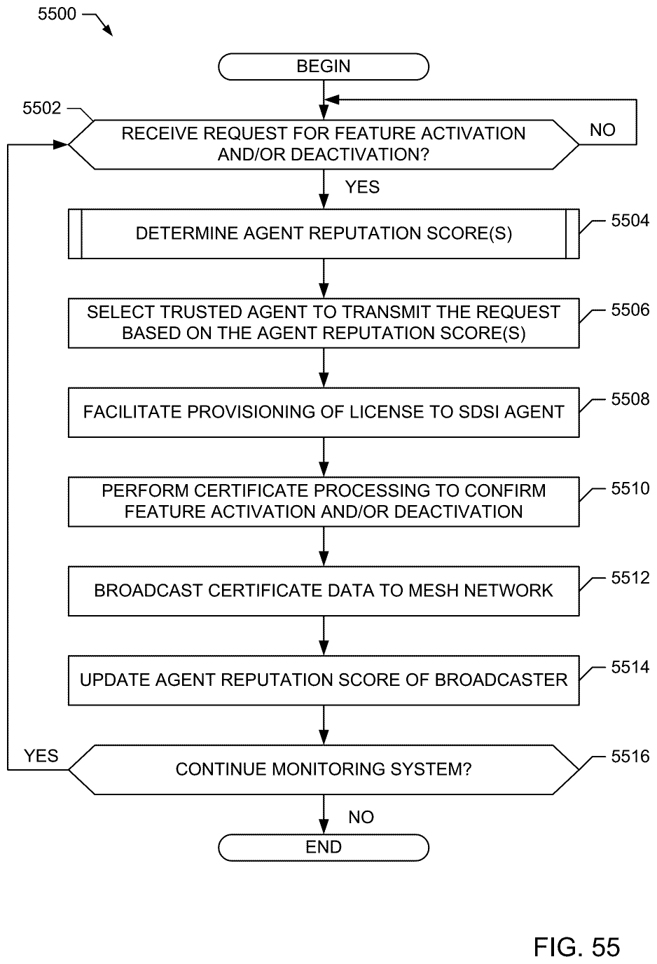

An example program 5500 that may be executed to implement the example SDSi asset agent 140 of the example systems 100 and/or 200 of FIGS. 1-2 and/or the example SDSi asset agents 140A-C of the example systems 4900, 5000, and/or 5100 of FIGS. 10-12 is illustrated in FIG. 55. The example program 5500 may be executed at predetermined intervals, based on an occurrence of a predetermined event, etc., or any combination thereof. With reference to the preceding figures and associated written descriptions, the example program 5500 of FIG. 55 begins execution at block 5502 at which the SDSi asset agent 140 and/or SDSi asset agent 140A-C determine whether a request for a feature activation and/or deactivation has been received. For example, the license processor 214 (FIG. 2) determines that a request to activate one of the features 232, 234, 236, 238, 240, 242 has been received.

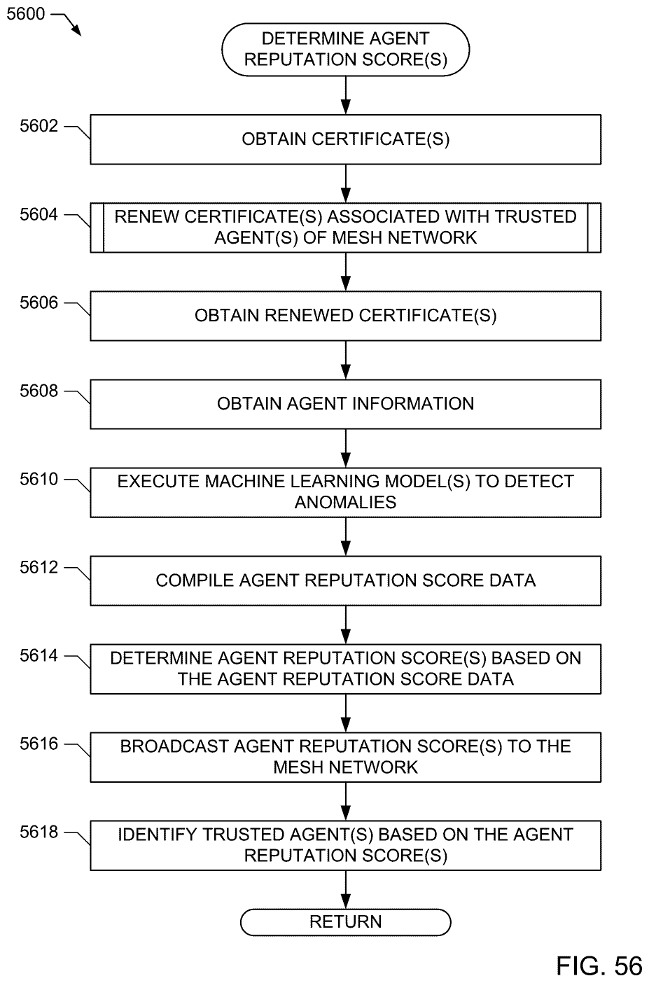

At block 5504, the SDSi asset agent 140 and/or SDSi asset agent 140A-C determine agent reputation score(s). For example, the trusted agent determiner 5004 (FIG. 50) executes an attestation process of one(s) of the SDSi agents 140A-C of the mesh network 4902 of FIG. 49. An example process that may be executed to implement block 5504 is described below in connection with FIG. 56.

At block 5506, the SDSi asset agent 140 and/or SDSi asset agent 140A-C select a trusted agent to transmit the request based on the agent reputation score(s). For example, the trusted agent determiner 5004 selects the first SDSi asset agent 140A as a sender (e.g., a trusted sender) and/or an issuer (e.g., a trusted issuer) to transmit the request to the manufacturer enterprise system 110 based on the first SDSi asset agent 140A having the highest agent reputation score of the SDSi asset agents 140A-C.

At block 5508, the SDSi asset agent 140 and/or SDSi asset agent 140A-C facilitate provisioning of a license to an SDSi agent. For example, the license processor 214 to process a license issued by the manufacturer enterprise system 110 to configure (e.g., activate) an SDSi feature included in the feature sets 232-242 implemented by the hardware circuitry 125, firmware 130, and/or BIOS 135 of the SDSi semiconductor device 105.

At block 5510, the SDSi asset agent 140 and/or SDSi asset agent 140A-C perform certificate processing to confirm feature activation and/or deactivation. For example, the certificate validator 5006 (FIG. 50) generates a certificate to confirm the successful activation of the SDSi feature.

At block 5512, the SDSi asset agent 140 and/or SDSi asset agent 140A-C broadcast certificate data to the mesh network 4902. For example, the certificate validator 5006 of the first SDSi asset agent 140A broadcasts certificate data including the issued certificate, a current asset status, a value of the activated feature, etc., to the second SDSi asset agent 140B and the third SDSi asset agent 140C of the mesh network 4902.

At block 5514, the SDSi asset agent 140 and/or SDSi asset agent 140A-C update an agent reputation score of the broadcaster. For example, the trusted agent determiner 5004 of the second SDSi asset agent 140B and the trusted agent determiner 5006 of the third SDSi asset agent 140C update an agent reputation score of the first SDSi asset agent 140A included in a list of respective ones of the second SDSi asset agent 140B and the third SDSi asset agent 140C. In such examples, the trusted agent determiner 5004 of the second SDSi asset agent 140B and the trusted agent determiner 5006 of the third SDSi asset agent 140C update the agent reputation score of the first SDSi asset agent 140A by increasing the agent reputation score because the successful activation of the license from the manufacturer enterprise system 110 indicates an increased level of trustworthiness of the first SDSi asset agent 140A.

At block 5516, the SDSi asset agent 140 and/or SDSi asset agent 140A-C determine whether to continue monitoring the system. For example, the license processor 214 determines to continue monitoring the system 4900 and/or 5000 for another request to activate and/or deactivate a feature of one of the semiconductor devices 105A-C has been received.

If, at block 5516, the SDSi asset agent 140 and/or SDSi asset agent 140A-C determine to continue monitoring the system, control returns to block 5502 to determine whether another request for feature activation and/or deactivation has been received. If, at block 5516, the SDSi asset agent 140 and/or SDSi asset agent 140A-C determine not to continue monitoring the system, the example program 5500 of the example of FIG. 55 concludes.

An example program 5600 that may be executed to implement the example SDSi asset agent 140 of the example systems 100 and/or 200 of FIGS. 1-2 and/or the example SDSi asset agents 140A-C of the example systems 4900, 5000, and/or 5100 of FIGS. 10-12 is illustrated in FIG. 56. The example program 5600 may be executed at predetermined intervals, based on an occurrence of a predetermined event, etc., or any combination thereof. The example program 5600 of FIG. 56 may be executed to implement block 5504 of the example of FIG. 55 to determine agent reputation score(s). With reference to the preceding figures and associated written descriptions, the example program 5600 of FIG. 56 begins execution at block 5602 at which the SDSi asset agent 140 and/or SDSi asset agent 140A-C obtains certificate(s). For example, the trusted agent determiner 5004 (FIG. 50) of the first SDSi asset agent 140A obtain one or more certificates from an SDSi agent, such as the second SDSi asset agent 140B of FIG. 49.

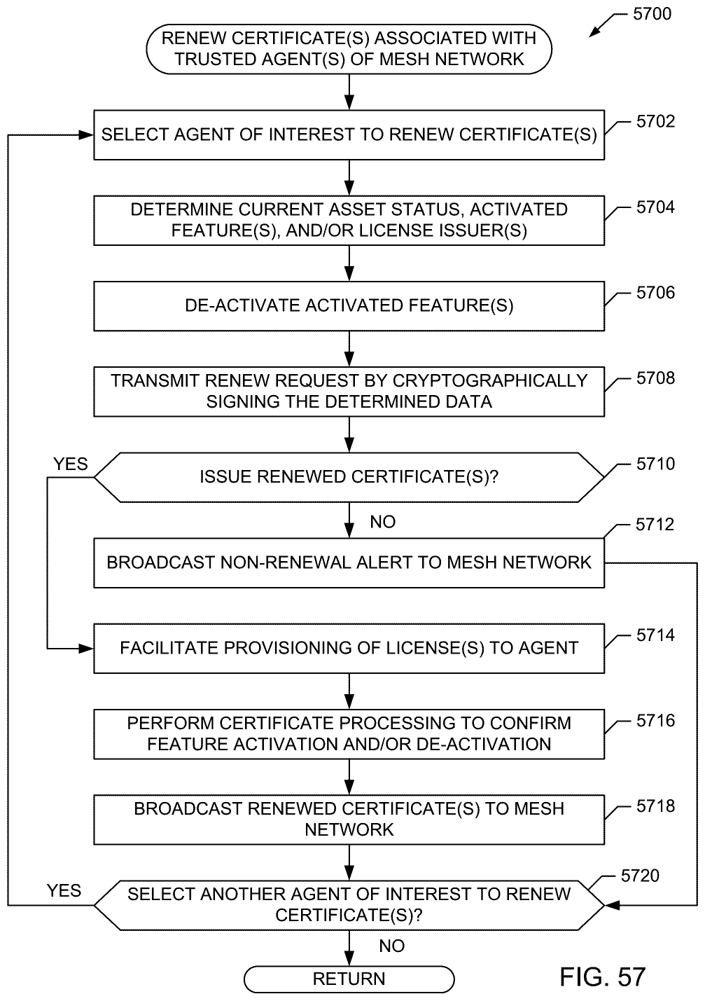

At block 5604, the SDSi asset agent 140 and/or SDSi asset agent 140A-C renew certificate(s) associated with trusted agent(s) of a mesh network. For example, the certificate validator 5006 (FIG. 50) of the first SDSi asset agent 140A deactivates one or more activated features of the second SDSi asset agent 140B to cause the second SDSi asset agent 140B to renew certificate(s) associated with the one or more deactivated features. An example process that may be executed to implement block 5604 is described below in connection with FIG. 57.

At block 5606, the SDSi asset agent 140 and/or SDSi asset agent 140A-C obtain renewed certificate(s). For example, the trusted agent determiner 5004 of the first SDSi asset agent 140A obtains zero, one, or more renewed certificates from the second SDSi asset agent 140B.

At block 5608, the SDSi asset agent 140 and/or SDSi asset agent 140A-C obtain agent information. For example, the trusted agent determiner 5004 of the first SDSi asset agent 140A obtains agent information, such as an identifier of the second semiconductor device 105B, telemetry data reported by the second SDSi asset agent 140B, etc., from the second SDSi asset agent 140B.

At block 5610, the SDSi asset agent 140 and/or SDSi asset agent 140A-C execute machine learning model(s) to detect anomalies. For example, the anomaly detector 5008 (FIG. 50) executes the anomaly detection model(s) 5010 to determine whether an anomaly is detected in connection with the certificate(s), the renewed certificate(s), the agent information, etc., associated with the second SDSi asset agent 140B.

At block 5612, the SDSi asset agent 140 and/or SDSi asset agent 140A-C compiles agent reputation score data. For example, the trusted agent determiner 5004 of the first SDSi asset agent 140A compiles agent reputation score data including the certificate(s), the renewed certificate(s), the agent information, etc., associated with the second SDSi asset agent 140B.

At block 5614, the SDSi asset agent 140 and/or SDSi asset agent 140A-C determine agent reputation score(s) based on the agent reputation score data. For example, the trusted agent determiner 5004 of the first SDSi asset agent 140A determines an agent reputation score of the second SDSi asset agent 140B based on the agent reputation score data. In other examples, the trusted agent determiner 5004 of the first SDSi asset agent 140A is identified as a trusted sender to transmit the agent reputation score data to the manufacturer trusted agent determiner 1102 (FIG. 50). In such examples, the manufacturer trusted agent determiner 1102 determines the agent reputation score of the second SDSi asset agent 140B based on the agent reputation score data.

At block 5616, the SDSi asset agent 140 and/or SDSi asset agent 140A-C broadcast agent reputation score(s) to the mesh network 4902. For example, the first SDSi asset agent 140A broadcasts the agent reputation score of the second SDSi asset agent 140B to the mesh network 4902. In some examples, the manufacturer trusted agent determiner 1102 140A broadcasts the agent reputation score of the second SDSi asset agent 140B to the mesh network 4902.

At block 5618, the SDSi asset agent 140 and/or SDSi asset agent 140A-C identify trusted agent(s) based on the agent reputation score(s). For example, the trusted agent determiner 5004 of the first SDSi asset agent 140A and/or the third SDSi asset agent 140C identifies the second SDSi asset agent 140B as a trusted agent in response to the agent reputation score of the second SDSi asset agent 140B satisfying and/or otherwise meeting a threshold. In response to identifying the trusted agent(s) based on the agent reputation score(s) at block 5618, the example program 5600 of the example of FIG. 56 concludes. For example, the program 5600 returns to block 5506 of the example of FIG. 55 to select a trusted agent to transmit the request based on the agent reputation score(s).

An example program 5700 that may be executed to implement the example SDSi asset agent 140 of the example systems 100 and/or 200 of FIGS. 1-2 and/or the example SDSi asset agents 140A-C of the example systems 4900, 5000, and/or 5100 of FIGS. 10-12 is illustrated in FIG. 57. The example program 5700 may be executed at predetermined intervals, based on an occurrence of a predetermined event, etc., or any combination thereof. With reference to the preceding figures and associated written descriptions, the example program 5700 of FIG. 57 begins execution at block 5702 at which the SDSi asset agent 140 and/or SDSi asset agent 140A-C select an agent of interest to renew certificate(s). For example, the certificate validator 5006 (FIG. 50) of the first SDSi asset agent 140A select the second SDSi asset agent 140B to renew certificate(s).

At block 5704, the SDSi asset agent 140 and/or SDSi asset agent 140A-C determine a current asset status, activated feature(s), and/or license issuer(s). For example, the certificate validator 5006 of the second SDSi asset agent 140B obtains a current asset status, activated feature(s), and/or license issuer(s) associated with the second semiconductor device 105B. In such examples, the second SDSi asset agent 140B transmits the current asset status, the activated feature(s), and/or the license issuer(s) information to the certificate validator 5006 of the first SDSi asset agent 140A.

At block 5706, the SDSi asset agent 140 and/or SDSi asset agent 140A-C de-activate activated feature(s). For example, the certificate validator 5006 of the first SDSi asset agent 140A transmits a de-activation command, instruction, signal, etc., to the certificate validator 5006 of the second SDSi asset agent 140B to de-activate one or more features of the second semiconductor device 105B.

At block 5708, the SDSi asset agent 140 and/or SDSi asset agent 140A-C transmit a renew request by cryptographically signing the determined data. For example, the certificate validator 5006 of the second SDSi asset agent 140B cryptographically and/or otherwise electronically signs data including at least one of a current asset status, activated feature(s), and/or license issuer(s) associated with the second semiconductor device 105B.

At block 5710, the SDSi asset agent 140, the SDSi asset agent 140A-C, and/or the manufacturer enterprise system 110 (FIG. 1) determine whether to issue renewed certificate(s). For example, the SDSi feature management service 256 (FIG. 2) determines whether to issue renewed certificate(s) to re-activate the de-activated feature(s) of the second semiconductor device 105B based on the cryptographically signed data. In such examples, the SDSi feature management service 256 determines whether to issue the renewed certificate(s) based on an agent reputation score of the second SDSi asset agent 140B, a level of trustworthiness of the second SDSi asset agent 140B, etc.

If, at block 5710, the SDSi asset agent 140, the SDSi asset agent 140A-C, and/or the manufacturer enterprise system 110 determine not to issue renewed certificate(s), then, at block 5712, the SDSi asset agent 140, the SDSi asset agent 140A-C, and/or the manufacturer enterprise system 110 broadcast a non-renewal alert to the mesh network 4902. For example, the SDSi feature management service 256 invokes the SDSi agent management interface 264 (FIG. 2) to broadcast to an alert, an indication, etc., to the mesh network 4902 that the certificate(s) for the second semiconductor device 105B have not been renewed. In response to broadcasting the non-renewal alert to the mesh network at block 5712, control proceeds to block 5720 to determine whether to select another agent of interest to renew certificate(s).

If, at block 5710, the SDSi asset agent 140, the SDSi asset agent 140A-C, and/or the manufacturer enterprise system 110 determine to issue renewed certificate(s) control proceeds to block 5714 to facilitate provisioning of license(s) to the agent. For example, the SDSi feature management service 256 invokes the SDSi agent management interface 264 to distribute one or more license(s) that correspond to the certificate(s) in the renew request to the second SDSi asset agent 140B to cause the second SDSi asset agent 140B to re-activate the de-activated feature(s).

At block 5716, the SDSi asset agent 140 and/or SDSi asset agent 140A-C perform certificate processing to confirm feature activation and/or de-activation. For example, the license processor 214 of the second SDSi asset agent 140B re-activates the previously de-activated feature(s). In such examples, the certificate validator 5006 of the second SDSi asset agent 140B generates a certificate (e.g., a renewal certificate) to confirm the activation (e.g., successful activation, successful re-activation, etc.).

At block 5718, the SDSi asset agent 140 and/or SDSi asset agent 140A-C broadcast renewed certificate(s) to the mesh network 4902. For example, the certificate validator 5006 of the second SDSi asset agent 140B invokes the agent interface 202 of the second SDSi asset agent 140B to broadcast the renewed certificate(s) to the mesh network 4902. In such examples, the broadcast of the renewed certificate(s) cause the trusted agent determiner 5004 of the first SDSi asset agent 140A and the third SDSi asset agent 140C to update an agent reputation score of the second SDSi asset agent 140B based on the renewed certificate(s).

At block 5720, the SDSi asset agent 140 and/or SDSi asset agent 140A-C determine whether to select another agent of interest to renew certificate(s). For example, the certificate validator 5006 determines to select the third SDSi asset agent 140C to renew certificate(s). If, at block 5720, the SDSi asset agent 140 and/or SDSi asset agent 140A-C determine to select another agent of interest to renew certificate(s), control returns to block 5702 to select another agent of interest to renew certificate(s). If, at block 5720, the SDSi asset agent 140 and/or SDSi asset agent 140A-C determine not to select another agent of interest to renew certificate(s), the example program 5700 concludes. For example, the program 5700 returns to block 5606 of the example of FIG. 56 to obtain renewed certificate(s).

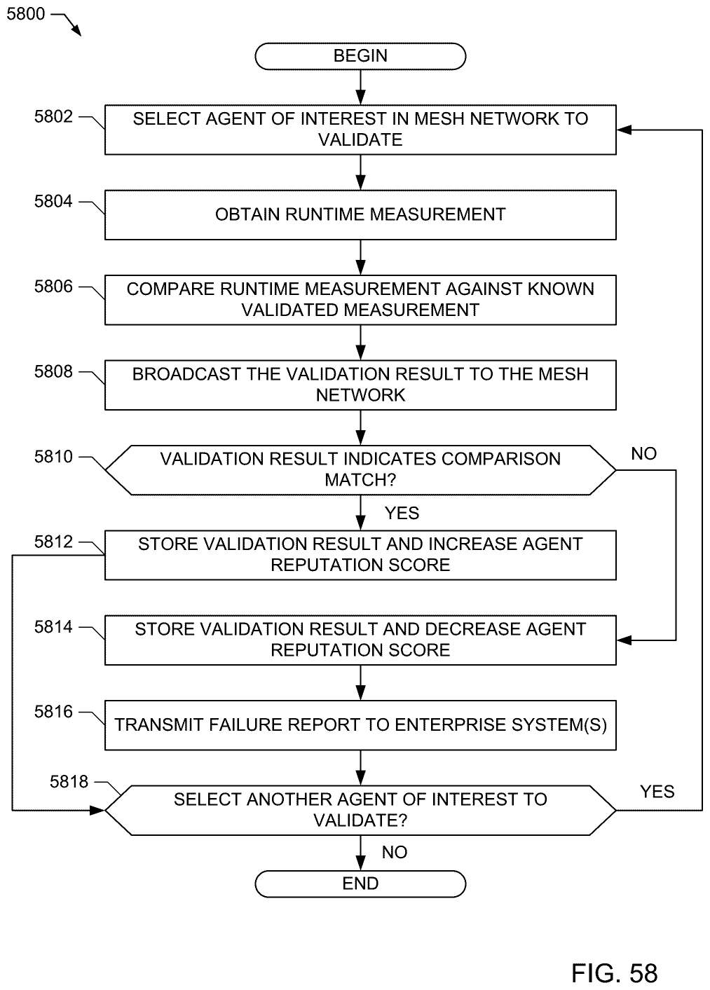

An example program 5800 that may be executed to implement the example SDSi asset agent 140 of the example systems 100 and/or 200 of FIGS. 1-2 and/or the example SDSi asset agents 140A-C of the example systems 4900, 5000, and/or 5100 of FIGS. 10-12 is illustrated in FIG. 58. The example program 5800 may be executed at predetermined intervals, based on an occurrence of a predetermined event, etc., or any combination thereof. With reference to the preceding figures and associated written descriptions, the example program 5800 of FIG. 58 begins execution at block 5802 at which the SDSi asset agent 140 and/or SDSi asset agent 140A-C select an agent of interest in a mesh network to validate. For example, the trusted agent determiner 5004 (FIG. 50) of the first SDSi asset agent 140A selects the second SDSi asset agent 140B of the mesh network 4902 to validate.

At block 5804, the SDSi asset agent 140 and/or SDSi asset agent 140A-C obtain a runtime measurement. For example, the trusted agent determiner 5004 of the second SDSi asset agent 140B generates a runtime measurement (e.g., a hash of application code, a value of a CPU counter, etc.). In such examples, the trusted agent determiner 5004 of the second SDSi asset agent 140B signs the runtime measurement and transmits the signed runtime measurement to the trusted agent determiner 5004 of the first SDSi asset agent 140A.

At block 5806, the SDSi asset agent 140 and/or SDSi asset agent 140A-C compare the runtime measurement against a known validated measurement. For example, the trusted agent determiner 5004 of the first SDSi asset agent 140A compares the signed runtime measurement to a known validated measurement stored in the first SDSi asset agent 140A, the manufacturer enterprise system 110, and/or the customer enterprise system 115.

At block 5808, the SDSi asset agent 140 and/or SDSi asset agent 140A-C broadcast the validation result to the mesh network. For example, the trusted agent determiner 5004 of the first SDSi asset agent 140A transmits the result of the comparison (e.g., the comparison yielded a match, a mismatch, etc.) to the second SDSi asset agent 140B, the third SDSi asset agent 140C, etc., of the mesh network 4902.

At block 5810, the SDSi asset agent 140 and/or SDSi asset agent 140A-C determine whether the validation result indicates a comparison match. For example, the third SDSi asset agent 140C obtains the validation result and determines that the comparison of the runtime measurement to the known validated measurement is a match, a mismatch, etc. If, at block 5810, the SDSi asset agent 140 and/or SDSi asset agent 140A-C determine the validation result indicates a comparison match, then, at block 5812, the SDSi asset agent 140 and/or SDSi asset agent 140A-C store the validation result and increase an agent reputation score. For example, the trusted agent determiner 5004 of the third SDSi asset agent 140C increases an agent reputation score of the second SDSi asset agent 140B because the comparison match indicates an increased level of trustworthiness of the second SDSi asset agent 140B. In such examples, the trusted agent determiner 5004 of the third SDSi asset agent 140C stores the validation result to use in a subsequent or future attestation process in connection with runtime measurements. In response to storing the validation result and increasing the agent reputation score at block 5814, control proceeds to block 5818 to determine whether to select another agent of interest to validate.

If, at block 5810, the SDSi asset agent 140 and/or SDSi asset agent 140A-C determine the validation result does not indicate a comparison match, control proceeds to block 5814 to store the validation result and decrease an agent reputation score. For example, the trusted agent determiner 5004 of the third SDSi asset agent 140C decreases an agent reputation score of the second SDSi asset agent 140B because the comparison mismatch indicates a decreased level of trustworthiness of the second SDSi asset agent 140B.

At block 5816, the SDSi asset agent 140 and/or SDSi asset agent 140A-C transmit a failure report to enterprise system(s). For example, the trusted agent determiner 5004 of the first SDSi asset agent 140A and/or the third SDSi asset agent 140C transmit(s) a failure report including an instance receipt detailing the runtime measurement, the known validated measurement, the result of the comparison, a timestamp, an identifier of the SDSi agent executing the comparison, an identifier of the SDSi agent generating the report, etc., to the manufacturer enterprise system 110 and/or the customer enterprise system 115.

At block 5818, the SDSi asset agent 140 and/or SDSi asset agent 140A-C determine whether to select another agent of interest to validate. For example, the first SDSi asset agent 140A determines to select the third SDSi asset agent 140C to validate. If, at block 5818, the SDSi asset agent 140 and/or SDSi asset agent 140A-C determine to select another agent of interest to validate, control returns to block 5802 to select another agent of interest in the mesh network 4902 to validate. If, at block 5818, the SDSi asset agent 140 and/or SDSi asset agent 140A-C determine not to select another agent of interest to validate, the example program 5800 concludes.

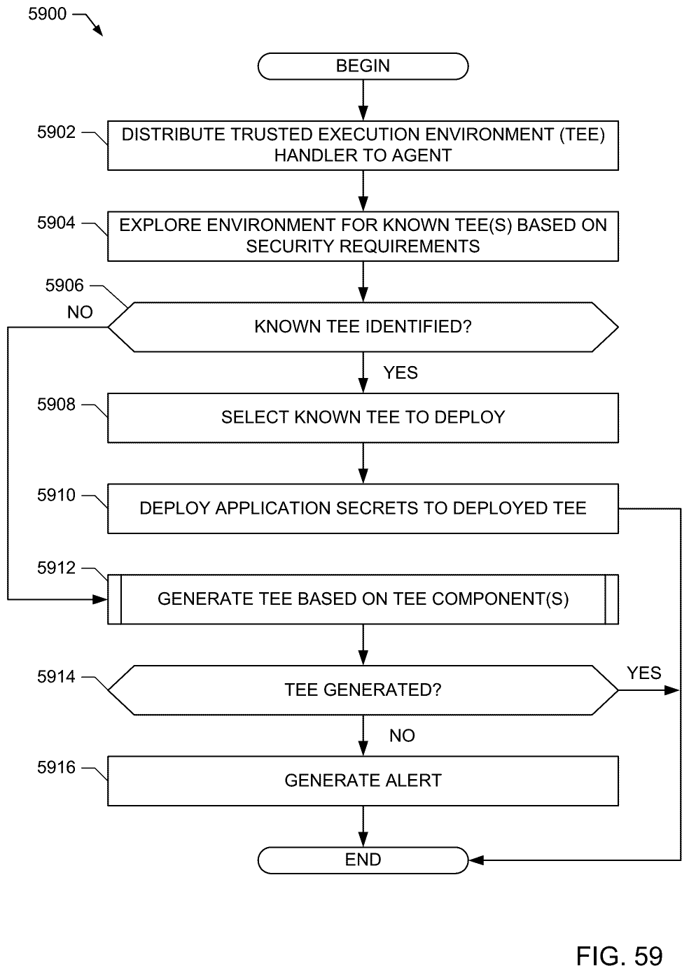

An example program 5900 that may be executed to implement the example SDSi asset agent 140 of the example systems 100 and/or 200 of FIGS. 1-2 and/or the example SDSi asset agents 140A-C of the example systems 4900, 5000, and/or 5100 of FIGS. 10-12 is illustrated in FIG. 59. The example program 5900 may be executed at predetermined intervals, based on an occurrence of a predetermined event, etc., or any combination thereof. With reference to the preceding figures and associated written descriptions, the example program 5900 of FIG. 59 begins execution at block 5902 at which the SDSi asset agent 140 and/or SDSi asset agent 140A-C distributes a trusted execution environment (TEE) handler to an agent. For example, the manufacturer enterprise network 110 and/or the customer enterprise network 115 distribute the TEE generator 5104 to one(s) of the SDSi asset agents 140A-C, such as the first SDSi asset agent 140A. In such examples, the TEE generator 5104 implements a TEE handler that generates a TEE, deploys the TEE, and/or returns an abstracted instance of the TEE to which an element of the first SDSi asset agent 140A or external computing system can interact and/or otherwise control via one or more hardware-agnostic TEE APIs.

At block 5904, the SDSi asset agent 140 and/or SDSi asset agent 140A-C explore an environment for known TEE(s) based on security requirements. For example, the TEE identifier 5102 explores, searches, queries, etc., at least one of the TEE(s) 5105, the TEE library 5106, or the TEE component(s) 1208 for a known, pre-packaged, and/or pre-configured TEE that meets and/or otherwise satisfies the security requirements.

At block 5906, the SDSi asset agent 140 and/or SDSi asset agent 140A-C determine whether a known TEE has been identified. For example, the TEE identifier 5102 identifies a known TEE of the TEE(s) 5105 that satisfies the security requirements. In other examples, the TEE identifier 5102 does not identify a known TEE of the TEE(s) 5105 that satisfies the security requirements.

If, at block 5906, the SDSi asset agent 140 and/or SDSi asset agent 140A-C determine that a known TEE has not been identified, control proceeds to block 5912 to generate a TEE based on TEE component(s). If, at block 5906, the SDSi asset agent 140 and/or SDSi asset agent 140A-C determine that a known TEE has been identified, then, at block 5908, the TEE identifier 5102 identifies the known TEE to deploy. For example, the TEE identifier 5102 invokes the TEE generator 5104 to return one or more TEE APIs from the TEE library 5106 to interface with the identified known TEE.

At block 5910, the SDSi asset agent 140 and/or SDSi asset agent 140A-C deploy application secrets to a deployed TEE. For example, the TEE(s) 5105 obtains application code to execute in the TEE(s) 5105, cryptographically protected data to store in trusted memory and/or storage of the TEE(s) 5105, etc. In response to deploying the application secrets to the deployed TEE, the example program 5900 concludes.

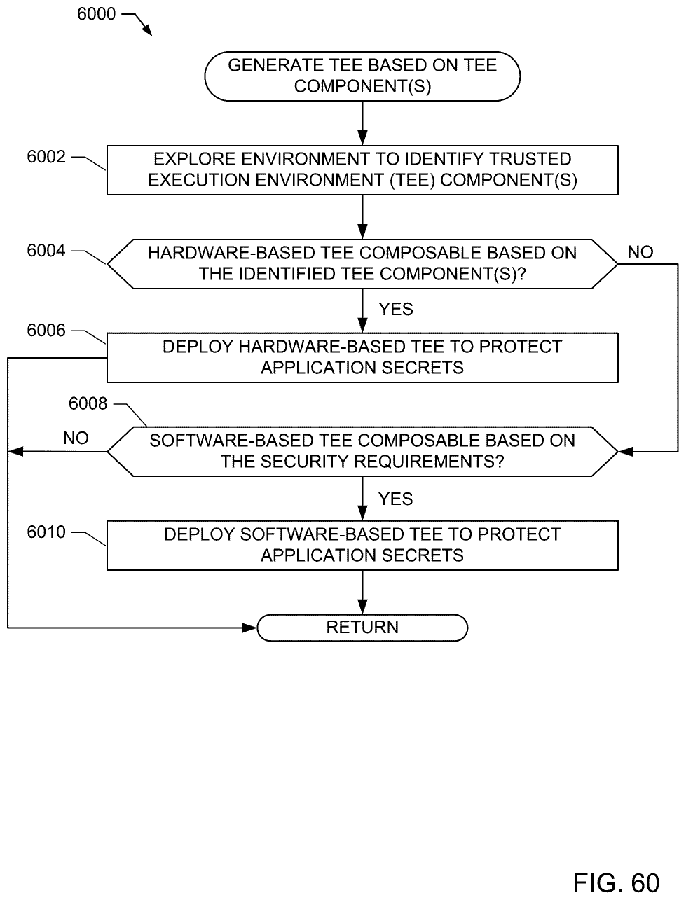

At block 5912, the SDSi asset agent 140 and/or SDSi asset agent 140A-C generates a TEE based on TEE component(s). For example, the TEE generator 5104 compiles a TEE from one(s) of the TEE component(s) 1208, or from TEE component(s) on a remote computing system (e.g., the customer enterprise system 115, a different one of the SDSi asset agents 140A-C, etc.). In such examples, the TEE generator 5104 deploys the compiled TEE as one of the TEE(s) 5105, or as a TEE on the remote computing system. An example process that may be executed to implement block 5912 is described below in connection with FIG. 60.

At block 5914, the SDSi asset agent 140 and/or SDSi asset agent 140A-C determine whether a TEE has been generated. For example, the TEE generator 5104 determines that a TEE has not been generated because the TEE component(s) 1208 cannot compose a TEE that satisfies the security requirements. In other examples, the TEE generator 5104 determines that a TEE has been generated based on the TEE being deployed to protect data of interest.

If, at block 5914, the SDSi asset agent 140 and/or SDSi asset agent 140A-C determine that a TEE has been generated, the example program 5900 concludes. If, at block 5914, the SDSi asset agent 140 and/or SDSi asset agent 140A-C determine that a TEE has not been generated, then, at block 5916, the SDSi asset agent 140 and/or SDSi asset agent 140A-C generate an alert. For example, the TEE generator 5104 generates an alert indicative of a TEE not being generated because necessary one(s) of the TEE component(s) 1208 are not activated, present, etc., the security requirements are too stringent, etc. In response to generating the alert at block 5916, the example program 5900 concludes.

An example program 6000 that may be executed to implement the example SDSi asset agent 140 of the example systems 100 and/or 200 of FIGS. 1-2 and/or the example SDSi asset agents 140A-C of the example systems 4900, 5000, and/or 5100 of FIGS. 10-12 is illustrated in FIG. 60. The example program 6000 may be executed to implement block 5912 of the example of FIG. 59 to generate a TEE based on TEE component(s). The example program 6000 may be executed at predetermined intervals, based on an occurrence of a predetermined event, etc., or any combination thereof. With reference to the preceding figures and associated written descriptions, the example program 6000 of FIG. 60 begins execution at block 6002 at which the SDSi asset agent 140 and/or SDSi asset agent 140A-C explore an environment to identify TEE component(s). For example, the TEE identifier 5102 (FIG. 51) explores, searches, queries, etc., at least one of the TEE(s) 5105, the TEE library 5106, or the TEE component(s) 1208 for a for hardware, software, and/or firmware TEE related component(s) that meet and/or otherwise satisfy requested security requirements. In such examples, the TEE identifier 302 identifies trusted execution, trusted memory, and trusted storage included in the TEE component(s) 1208 that satisfy the requested security requirements.

At block 6004, the SDSi asset agent 140 and/or SDSi asset agent 140A-C determine whether a hardware-based TEE is composable based on the identified TEE component(s). For example, the TEE identifier 5102 determines that the security requirements include trusted execution, trusted memory, and trusted storage. In such examples, the TEE identifier 5102 determines that the TEE component(s) 1208 include the trusted execution, trusted memory, and trusted storage. In some such examples, the TEE identifier 5102 determines that a hardware-based TEE can be composed, generated, etc., based on the trusted execution, trusted memory, and trusted storage.

If, at block 6004, the SDSi asset agent 140 and/or SDSi asset agent 140A-C determine that a hardware-based TEE is composable based on the identified TEE component(s), then, at block 6006, the SDSi asset agent 140 and/or SDSi asset agent 140A-C deploy a hardware-based TEE to protect application secrets. For example, the TEE generator 5104 deploys a hardware-based TEE as one of the TEE(s) 2405 based on the TEE component(s) 1208. In response to deploying the hardware-based TEE to protect the application secrets at block 6006, the example program 6000 concludes. For example, the program 6000 returns to block 5914 of the example of FIG. 59 to determine whether a TEE has been generated.

If, at block 6004, the SDSi asset agent 140 and/or SDSi asset agent 140A-C determine that a hardware-based TEE is not composable based on the identified TEE component(s), control proceeds to block 6008 to determine whether a software-based TEE is composable based on the security requirements. For example, the TEE identifier 5102 determines that a software-based TEE is composable based on the security requirements.

If, at block 6008, the SDSi asset agent 140 and/or SDSi asset agent 140A-C determine that a software-based TEE is not composable based on the security requirements, the example program 6000 concludes. For example, the program 6000 returns to block 5914 of the example of FIG. 59 to determine whether a TEE has been generated.

If, at block 6008, the SDSi asset agent 140 and/or SDSi asset agent 140A-C determine that a software-based TEE is composable based on the security requirements, then, at block 6010, the SDSi asset agent 140 and/or SDSi asset agent 140A-C deploy a software-based TEE to protect application secrets. For example, the TEE generator 5104 deploys a software-based TEE as one of the TEE(s) 2405 based on the TEE library 5106, the TEE component(s) 1208, etc., and/or a combination thereof. In response to deploying the software-based TEE to protect the application secrets at block 6010, the example program 6000 concludes. For example, the program 6000 returns to block 5914 of the example of FIG. 59 to determine whether a TEE has been generated.

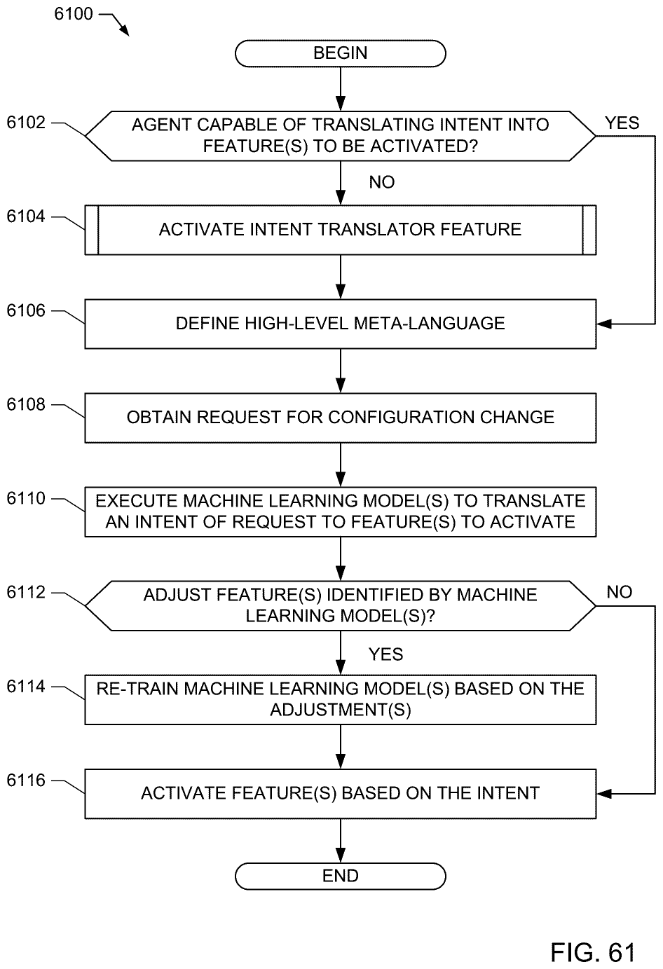

An example program 6100 that may be executed to implement the example SDSi asset agent 140 of the example systems 100 and/or 200 of FIGS. 1-2 and/or the example SDSi asset agents 140A-C of the example systems 4900, 5000, and/or 5100 of FIGS. 10-12 is illustrated in FIG. 61. The example program 6100 may be executed at predetermined intervals, based on an occurrence of a predetermined event, etc., or any combination thereof. With reference to the preceding figures and associated written descriptions, the example program 6100 of FIG. 61 begins execution at block 6102 at which the SDSi asset agent 140 and/or SDSi asset agent 140A-C determine whether an agent is capable of translating intent into feature(s) to be activated. For example, the first SDSi asset agent 140A determines that the SDSi asset agent 140A is capable of translating an intent or intended outcome from a request for a configuration change of the SDSi asset agent 140A, and/or, more generally, the system 4900, 5000, and/or 5100 of FIGS. 10-12 based on whether the SDSi asset agent 140A includes and/or otherwise has activated the feature intent determiner 5012 and/or the feature intent ML model(s) 5014.

If, at block 6102, the SDSi asset agent 140 and/or SDSi asset agent 140A-C determine that the agent is capable of translating intent into feature(s) to be activated, control proceeds to block 6106 to define a high-level meta-language. If, at block 6102, the SDSi asset agent 140 and/or SDSi asset agent 140A-C determine that the agent is not capable of translating intent into feature(s) to be activated, then, at block 6104, the SDSi asset agent 140 and/or SDSi asset agent 140A-C activates an intent translator feature. An example process that may be executed to implement block 6104 is described in connection with FIGS. 16, 17, and/or 18. For example, the first SDSi asset agent 140A requests the manufacturer enterprise system 110 for an license to activate the feature intent determiner 5012 and/or the feature intent ML model(s) 5014.

At block 6106, the SDSi asset agent 140 and/or SDSi asset agent 140A-C defines a high-level meta-language. For example, the feature intent determiner 5012 defines a high-level meta-language to process configuration change requests.

At block 6108, the SDSi asset agent 140 and/or SDSi asset agent 140A-C obtains a request for a configuration change. For example, the first SDSi asset agent 140A obtains a request to change the first SDSi asset agent 140A and/or, more generally, the first semiconductor device 105A, by adjusting requirement(s) associated with at least one of availability, machine learning, performance, reliability, or security.

At block 6110, the SDSi asset agent 140 and/or SDSi asset agent 140A-C executes machine learning model(s) to translate an intent of the request to feature(s) to activate. For example, the feature intent determiner 5012 invokes the feature intent ML model(s) 5014 to translate a change in performance requirements to an intent or intended outcome of improving performance of the first SDSi asset agent 140A and/or, more generally, the first semiconductor device 105A. In such examples, the feature intent ML model(s) 5014 translate the intent or intended outcome to one or more features of the first semiconductor device 105A to improve performance, such as activating one or more cores of a CPU.

At block 6112, the SDSi asset agent 140 and/or SDSi asset agent 140A-C determine whether to adjust feature(s) identified by the machine learning model(s). For example, a user, an external computing system, etc., determines to adjust and/or otherwise override the feature(s) identified by the feature intent ML model(s) 5014.

If, at block 6112, the SDSi asset agent 140 and/or SDSi asset agent 140A-C determine not to adjust feature(s) identified by the machine learning model(s), control proceeds to block 6116 to activate the feature(s) based on the intent. If, at block 6112, the SDSi asset agent 140 and/or SDSi asset agent 140A-C determine to adjust feature(s) identified by the machine learning model(s), then, at block 6114, the SDSi asset agent 140 and/or SDSi asset agent 140A-C re-trains the machine learning model(s) based on the adjustment(s). For example, the feature intent determiner 5012 provides feedback, new data (e.g., new training data), etc., representative of the adjustment(s) to the feature intent ML model(s) 5014 to retrain and deploy retrained one(s) of the feature intent ML model(s) 5014.

At block 6116, the SDSi asset agent 140 and/or SDSi asset agent 140A-C activates feature(s) based on the intent. For example, the feature intent determiner 5012 invokes the license processor 214 to facilitate activation of the identified feature(s). In response to activating the feature(s) based on the intent at block 6116, the example program 6100 of the example of FIG. 61 concludes.

Device Enhancements

FIG. 62 is a flowchart representative of example computer readable instructions that may be executed to implement the example time calculator of FIG. 53. The process 6200 of FIG. 62 begins and block 6202. At block 6202, the property checker 5306 determines properties of the time-dependent feature 5206 at the time of manufacture. For example, the property checker 5306 can cause a current to run through the time-dependent feature 5206 and record the electrical properties of the time-dependent feature 5206 at the time of manufacture of the silicon product 5205.

At block 6204, the absolute time determiner 5310 correlates the determined property with the time of manufacture. For example, the absolute time determiner 5310 can store the determined property with the time of manufacture in a storage associated with the silicon product 5205. The absolute time determiner 5310 can then determine the time of manufacture by communicating with a clock associated with silicon product 5205 and/or by a manual/automatic input by the manufacturer. In such examples, the absolute time determiner 5310 can record the absolute time of the time of manufacture with the determined electrical properties of the time-dependent feature 5206.

At block 6206, the request interface 5304 receives the request 5302 for absolute time and/or relative time. For example, the request interface 5304 can receive the request 5302 from the analytics engine 206, license processor 214, etc. In some examples, the request interface 5304 can determine what time is requested by the request 5302 (e.g., the absolute time, the relative time, or both).

At block 6208, the property checker 5306 determines the electrical properties of time-dependent feature 5206 at the time of the request 5302. For example, the property checker 5306 can cause a current to run through the time-dependent feature 5206 such that the electrical properties of the device can be determined. In some examples, the property checker 5306 can determine the current electrical properties by any other suitable means (e.g., reading a log of operations of the silicon product 5205, etc.).

At block 6210, the relative time determiner 5308 determines the relative time based on a comparison of the properties of the time-dependent feature 5206 at the time of manufacturer properties and the properties of the time-dependent feature 5206 at the current time (e.g., the time of the request 5302). For example, based on the known time-variance of the electrical properties of the time-dependent feature 5206, the relative time determiner 5308 can determine the relative time between the time of manufacture and the current time. In some examples, the relative time determiner 5308 can determine the relative time based on any other suitable means.

At block 6212, the absolute time determiner 5310 determines the absolute time based on a comparison of relative time and time of manufacture. For example, the absolute time determiner 5310 can add the relative time to the stored time of manufacture as recorded during the execution of block 6204. In some examples, the absolute time determiner 5310 can determine the absolute time by any other suitable means. After determining the absolute time, the absolute time determiner 5310 transmits the determined absolute and/or relative time to the requesting party/entity.

At block 6214, the request interface 5304 determines if another request 5302 has been received. If another request has been received, the process 6200 returns to block 6206. If another request has not been received, the process 6200 ends.

FIG. 63 is a flowchart representative of example computer-readable instructions that may be executed to implement the example feature group calculator 5204 of FIG. 54. The process 6300 of FIG. 63 begins at block 6302. At block 6302, the configuration detector 5402 detects a new configuration of silicon product 5205. For example, the configuration detector 5402 could detect features of the silicon product 5205 have been and/or are to be activated, deactivated, modified, etc. In some examples, the configuration detector 5402 can receive a notification (e.g., sent from the license processor 214, etc.) indicating a new configuration is/will be activated for the silicon product 5205. In some examples, the configuration detector 5402 can determine which feature-groups are affected by the configuration.

At block 6304, the feature weight determiner 5408 determines the weight value(s) for each feature of the detected configuration. For example, the feature weight determiner 5408 can determine the weight of each feature associated with the detected configuration. For example, the feature weight determiner 5408 can determine a score for each feature associated with the configuration. For example, if the configuration includes 8 cores operating at 4.0 gigahertz (GHz), the feature weight determiner 5408 can determine that each operating core has a weight of 10 and that the operating frequency has a weight of 50. In such examples, the feature weight determiner 5408 can determine the feature score of 130.

At block 6306, the environmental condition determiner 5406 determines the weight value(s) associated with environmental conditions. For example, the environmental condition determiner 5406, via the sensor interface 5404, can determine the environmental conditions under which the silicon product 5205 is operating. For example, the environmental condition determiner 5406 can determine the weight factor associated with each environmental condition. In some examples, the environmental condition determiner 5406 can assign a weight factor to the ambient temperature if the ambient temperature exceeds a boundary condition (e.g., the environmental condition determiner 5406 can determine a weight of 10 if the ambient temperature exceeds 20 degrees Celsius (C), the environmental condition determiner can determine a weight of 30 if the ambient humidity exceeds 80%, etc.). In some examples, the environmental condition determiner 5406 can scale (e.g., linearly, exponentially, etc.) the determined weight as the environmental conditions become worse for processor performance (e.g., the environmental condition determiner 5406 can scale the temperature weight by 5 for each degree above 20 degrees Celsius (C), etc.).

At block 6308, the group score calculator 5410 calculate feature-group score(s). For example, the group score calculator 5410 can determine the group score for each feature group detected by the new configuration detector during the execution of block 6302. In some examples, the group score calculator 5410 can determine the group score by summing the feature weight score and the environmental weight score. In some examples, the group score calculator 5410 can determine the group score(s) by any other suitable means.

At block 6310, the threshold comparator 5414 determines if at least one feature-group score(s) exceeds a corresponding enablement and/or warranty threshold. For example, the threshold comparator 5414 can compare the calculated group score(s) to at least one threshold and determine if the group score exceeds the at least one threshold. If at least one group score exceeds a threshold, the process 6300 advances to block 6312. If no group score exceeds a threshold, the process 6300 advances to block 6314.

At block 6312, the configuration controller 5416 takes action based on an exceeded group combination score. For example, if the configuration controller 5416 can void the warranty of the silicon product 5205 if a group score exceeds the warranty threshold. In some examples, the configuration controller 5416 can prevent the configuration from being enabled. At block 6314, the configuration controller 5416 enables configuration without additional actions. The process 6300 ends.

Processor and Distribution Platforms

FIG. 35 is a block diagram of an example processor platform 3500 structured to execute the instructions of FIGS. 19 and/or 55-61 to implement the manufacture enterprise system 110 of FIGS. 1-9 and/or 49-51. The processor platform 3500 can be, for example, a server, a personal computer, a workstation, a self-learning machine (e.g., a neural network), a mobile device (e.g., a cell phone, a smart phone, a tablet such as an iPad™), or any other type of computing device.

The processor platform 3500 of the illustrated example includes a processor 3512. The processor 3512 of the illustrated example is hardware. For example, the processor 3512 can be implemented by one or more integrated circuits, logic circuits, microprocessors, GPUs, DSPs, or controllers from any desired family or manufacturer. The hardware processor 3512 may be a semiconductor based (e.g., silicon based) device. In this example, the processor 3512 implements one or more of the example product management service 252, the example customer management service 254, the example SDSi feature management service 256, the example SDSi portal 262 and/or the example SDSi agent management interface 264.

The processor 3512 of the illustrated example includes a local memory 3513 (e.g., a cache). The processor 3512 of the illustrated example is in communication with a main memory including a volatile memory 3514 and a non-volatile memory 3516 via a link 3518. The link 3518 may be implemented by a bus, one or more point-to-point connections, etc., or a combination thereof. The volatile memory 3514 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 3516 may be implemented by flash memory and/or any other desired type of memory device. Access to the main memory 3514, 3516 is controlled by a memory controller.

The processor platform 3500 of the illustrated example also includes an interface circuit 3520. The interface circuit 3520 may be implemented by any type of interface standard, such as an Ethernet interface, a universal serial bus (USB), a Bluetooth® interface, a near field communication (NFC) interface, and/or a PCI express interface.

In the illustrated example, one or more input devices 3522 are connected to the interface circuit 3520. The input device(s) 3522 permit(s) a user to enter data and/or commands into the processor 3512. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 3500, can allow the user to control the computer system and provide data to the computer using physical gestures, such as, but not limited to, hand or body movements, facial expressions, and face recognition.

One or more output devices 3524 are also connected to the interface circuit 3520 of the illustrated example. The output devices 3524 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speakers(s). The interface circuit 3520 of the illustrated example, thus, typically includes a graphics driver card, a graphics driver chip and/or a graphics driver processor.

The interface circuit 3520 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 3526. The communication can be via, for example, an Ethernet connection, a digital subscriber line (DSL) connection, a telephone line connection, a coaxial cable system, a satellite system, a line-of-site wireless system, a cellular telephone system, etc.

The processor platform 3500 of the illustrated example also includes one or more mass storage devices 3528 for storing software and/or data. Examples of such mass storage devices 3528 include floppy disk drives, hard drive disks, compact disk drives, Blu-ray disk drives, redundant array of independent disks (RAID) systems, and digital versatile disk (DVD) drives.

The machine executable instructions 3532 corresponding to the instructions of FIGS. 19 and/or 55-61 may be stored in the mass storage device 3528, in the volatile memory 3514, in the non-volatile memory 3516, in the local memory 3513 and/or on a removable non-transitory computer readable storage medium, such as a CD or DVD 3536.

FIG. 36 is a block diagram of an example processor platform 3600 structured to execute the instructions of FIG. 20 to implement the customer enterprise system 115 of FIGS. 1-9. The processor platform 3600 can be, for example, a server, a personal computer, a workstation, a self-learning machine (e.g., a neural network), a mobile device (e.g., a cell phone, a smart phone, a tablet such as an iPad™) or any other type of computing device.

The processor platform 3600 of the illustrated example includes a processor 3612. The processor 3612 of the illustrated example is hardware. For example, the processor 3612 can be implemented by one or more integrated circuits, logic circuits, microprocessors, GPUs, DSPs, or controllers from any desired family or manufacturer. The hardware processor 3612 may be a semiconductor based (e.g., silicon based) device. In this example, the processor 3612 implements one or more of the example SDSi client agent 272, the example platform inventory management service 274, the example accounts management service 276 and/or the example entitlement management service 278.

The processor 3612 of the illustrated example includes a local memory 3613 (e.g., a cache). The processor 3612 of the illustrated example is in communication with a main memory including a volatile memory 3614 and a non-volatile memory 3616 via a link 3618. The link 3618 may be implemented by a bus, one or more point-to-point connections, etc., or a combination thereof. The volatile memory 3614 may be implemented by SDRAM, DRAM, RDRAM® and/or any other type of random access memory device. The non-volatile memory 3616 may be implemented by flash memory and/or any other desired type of memory device. Access to the main memory 3614, 3616 is controlled by a memory controller.

The processor platform 3600 of the illustrated example also includes an interface circuit 3620. The interface circuit 3620 may be implemented by any type of interface standard, such as an Ethernet interface, a USB, a Bluetooth® interface, an NFC interface, and/or a PCI express interface.

In the illustrated example, one or more input devices 3622 are connected to the interface circuit 3620. The input device(s) 3622 permit(s) a user to enter data and/or commands into the processor 3612. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 3600, can allow the user to control the computer system and provide data to the computer using physical gestures, such as, but not limited to, hand or body movements, facial expressions, and face recognition.

One or more output devices 3624 are also connected to the interface circuit 3620 of the illustrated example. The output devices 3624 can be implemented, for example, by display devices (e.g., an LED, an OLED, an LCD, a CRT display, an IPS display, a touchscreen, etc.), a tactile output device, a printer and/or speakers(s). The interface circuit 3620 of the illustrated example, thus, typically includes a graphics driver card, a graphics driver chip and/or a graphics driver processor.

The interface circuit 3620 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 3626. The communication can be via, for example, an Ethernet connection, a DSL connection, a telephone line connection, a coaxial cable system, a satellite system, a line-of-site wireless system, a cellular telephone system, etc.

The processor platform 3600 of the illustrated example also includes one or more mass storage devices 3628 for storing software and/or data. Examples of such mass storage devices 3628 include floppy disk drives, hard drive disks, compact disk drives, Blu-ray disk drives, RAID systems, and DVD drives.

The machine executable instructions 3632 corresponding to the instructions of FIG. 20 may be stored in the mass storage device 3628, in the volatile memory 3614, in the non-volatile memory 3616, in the local memory 3613 and/or on a removable non-transitory computer readable storage medium, such as a CD or DVD 3636.

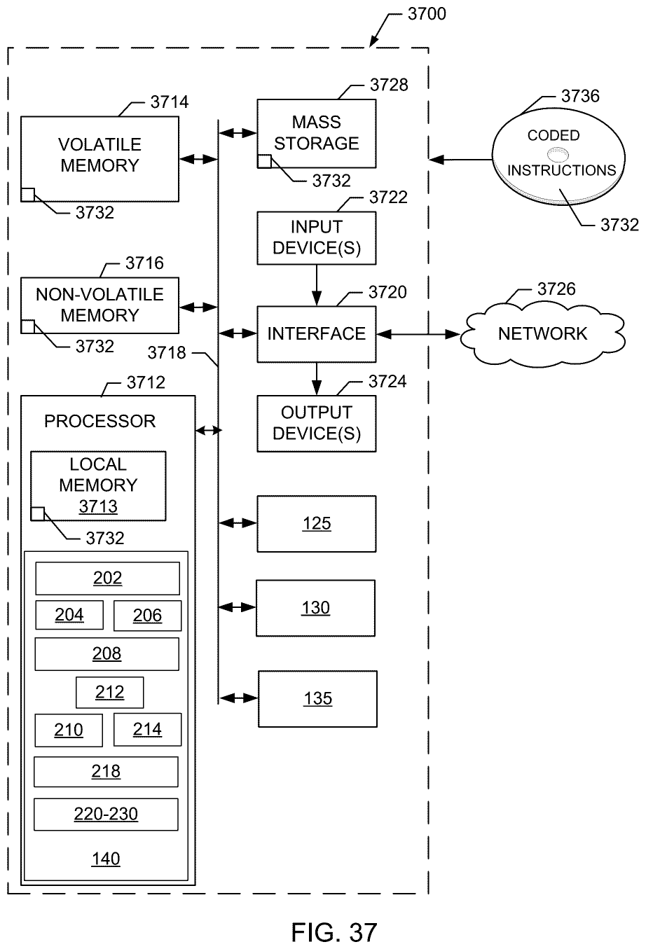

FIG. 37 is a block diagram of an example processor platform 3700 structured to execute the instructions of FIG. 35 to implement the SDSi asset agent 140 of FIGS. 1-9. The processor platform 3700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box a digital camera, a headset or other wearable device, or any other type of computing device.

The processor platform 3700 of the illustrated example includes a processor 3712. The processor 3712 of the illustrated example is hardware. For example, the processor 3712 can be implemented by one or more integrated circuits, logic circuits, microprocessors, GPUs, DSPs, or controllers from any desired family or manufacturer. The hardware processor 3712 may be a semiconductor based (e.g., silicon based) device. In this example, the processor 3712 implements one or more of the example agent interface 202, the example agent local services 204, the example analytics engine 206, the example communication services 208, the example agent CLI 210, the example agent daemon 212, the example license processor 214, the example agent library 218 and/or the example feature libraries 220-230.

The processor 3712 of the illustrated example includes a local memory 3713 (e.g., a cache). The processor 3712 of the illustrated example is in communication with a main memory including a volatile memory 3714 and a non-volatile memory 3716 via a link 3718. The link 3718 may be implemented by a bus, one or more point-to-point connections, etc., or a combination thereof. The volatile memory 3714 may be implemented by SDRAM, DRAM, RDRAM® and/or any other type of random access memory device. The non-volatile memory 3716 may be implemented by flash memory and/or any other desired type of memory device. Access to the main memory 3714, 3716 is controlled by a memory controller.

The processor platform 3700 of the illustrated example also includes an interface circuit 3720. The interface circuit 3720 may be implemented by any type of interface standard, such as an Ethernet interface, a USB, a Bluetooth® interface, an NFC interface, and/or a PCI express interface.

In the illustrated example, one or more input devices 3722 are connected to the interface circuit 3720. The input device(s) 3722 permit(s) a user to enter data and/or commands into the processor 3712. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 3700, can allow the user to control the computer system and provide data to the computer using physical gestures, such as, but not limited to, hand or body movements, facial expressions, and face recognition.

One or more output devices 3724 are also connected to the interface circuit 3720 of the illustrated example. The output devices 3724 can be implemented, for example, by display devices (e.g., an LED, an OLED, an LCD, a CRT display, an IPS display, a touchscreen, etc.), a tactile output device, a printer and/or speakers(s). The interface circuit 3720 of the illustrated example, thus, typically includes a graphics driver card, a graphics driver chip and/or a graphics driver processor.

The interface circuit 3720 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 3726. The communication can be via, for example, an Ethernet connection, a DSL connection, a telephone line connection, a coaxial cable system, a satellite system, a line-of-site wireless system, a cellular telephone system, etc.

The processor platform 3700 of the illustrated example also includes one or more mass storage devices 3728 for storing software and/or data. Examples of such mass storage devices 3728 include floppy disk drives, hard drive disks, compact disk drives, Blu-ray disk drives, RAID systems, and DVD drives.

The machine executable instructions 3732 corresponding to the instructions of FIG. 21 may be stored in the mass storage device 3728, in the volatile memory 3714, in the non-volatile memory 3716, in the local memory 3713 and/or on a removable non-transitory computer readable storage medium, such as a CD or DVD 3736.

FIG. 38 is a block diagram of an example processor platform 3800 structured to execute the instructions of FIGS. 22A-22B and 26 to implement the manufacturer enterprise system 110 of FIG. 10. The processor platform 3800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 3800 of the illustrated example includes a processor 3812. The processor 3812 of the illustrated example is hardware. For example, the processor 3812 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example entitlement request analyzer 1002, the example license generator 1004, the example license data store 1006, and the example identifier database 1008.

The processor 3812 of the illustrated example includes a local memory 3813 (e.g., a cache). The processor 3812 of the illustrated example is in communication with a main memory including a volatile memory 3814 and a non-volatile memory 3816 via a bus 3818. The volatile memory 3814 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 3816 may be implemented by flash memory and/or any other desired type of memory device. Access to the main memory 3814, 3816 is controlled by a memory controller.

The processor platform 3800 of the illustrated example also includes an interface circuit 3820. The interface circuit 3820 may be implemented by any type of interface standard, such as an Ethernet interface, a universal serial bus (USB), a Bluetooth® interface, a near field communication (NFC) interface, and/or a PCI express interface.

In the illustrated example, one or more input devices 3822 are connected to the interface circuit 3820. The input device(s) 3822 permit(s) a user to enter data and/or commands into the processor 3812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 3824 are also connected to the interface circuit 1120 of the illustrated example. The output devices 3824 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 3820 of the illustrated example, thus, typically includes a graphics driver card, a graphics driver chip and/or a graphics driver processor.

The interface circuit 3820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 3826. The communication can be via, for example, an Ethernet connection, a digital subscriber line (DSL) connection, a telephone line connection, a coaxial cable system, a satellite system, a line-of-site wireless system, a cellular telephone system, etc.

The processor platform 3800 of the illustrated example also includes one or more mass storage devices 3828 for storing software and/or data. Examples of such mass storage devices 3828 include floppy disk drives, hard drive disks, compact disk drives, Blu-ray disk drives, redundant array of independent disks (RAID) systems, and digital versatile disk (DVD) drives.

The machine executable instructions 3832 of FIGS. 22A-22B and 26 may be stored in the mass storage device 3828, in the volatile memory 3814, in the non-volatile memory 3816, and/or on a removable non-transitory computer readable storage medium such as a CD or DVD 3836.

FIG. 39 is a block 3900 structured to execute the instructions of FIGS. 23-25 to implement the SDSi asset agent 140 of FIG. 10. The processor platform 3900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 3900 of the illustrated example includes a processor 3912. The processor 3912 of the illustrated example is hardware. For example, the processor 3912 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example agent interface 202, the example analytics engine 206, the example license processor 214, the example hardware identifier manager 1010, the example entropy identifier generator 1012, the example certificate manager 1014, the example license manager 1016, the example authentication analyzer 1018, and the example feature activator 1020.

The processor 3912 of the illustrated example includes a local memory 3913 (e.g., a cache). The processor 3912 of the illustrated example is in communication with a main memory including a volatile memory 3914 and a non-volatile memory 3916 via a bus 3918. The volatile memory 3914 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 3916 may be implemented by flash memory and/or any other desired type of memory device. Access to the main memory 3914, 3916 is controlled by a memory controller.

The processor platform 3900 of the illustrated example also includes an interface circuit 3920. The interface circuit 3920 may be implemented by any type of interface standard, such as an Ethernet interface, a universal serial bus (USB), a Bluetooth® interface, a near field communication (NFC) interface, and/or a PCI express interface.

In the illustrated example, one or more input devices 3922 are connected to the interface circuit 3920. The input device(s) 3922 permit(s) a user to enter data and/or commands into the processor 1212. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 3924 are also connected to the interface circuit 3920 of the illustrated example. The output devices 3924 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 3920 of the illustrated example, thus, typically includes a graphics driver card, a graphics driver chip and/or a graphics driver processor.

The interface circuit 3920 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 3926. The communication can be via, for example, an Ethernet connection, a digital subscriber line (DSL) connection, a telephone line connection, a coaxial cable system, a satellite system, a line-of-site wireless system, a cellular telephone system, etc.

The processor platform 3900 of the illustrated example also includes one or more mass storage devices 3928 for storing software and/or data. Examples of such mass storage devices 3928 include floppy disk drives, hard drive disks, compact disk drives, Blu-ray disk drives, redundant array of independent disks (RAID) systems, and digital versatile disk (DVD) drives.

The machine executable instructions 3932 of FIGS. 23-25 may be stored in the mass storage device 3928, in the volatile memory 3914, in the non-volatile memory 3916, and/or on a removable non-transitory computer readable storage medium such as a CD or DVD 3936.

FIG. 40 is a block diagram of an example processor platform 4000 structured to execute the instructions of FIGS. 27 and 28 to implement the central licensor of FIG. 15 and FIG. 16. The processor platform 4000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 4000 of the illustrated example includes a processor 4012. The processor 4012 of the illustrated example is hardware. For example, the processor 4012 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example requirement definer 1612, the example third party verifier 1614, the example request denier 1616, the example request grantor 1618, the example constraints generator 1620, the example feature identifier 1622, the example signature generator 1624, the example configuration installation generator 1628, the example certificate processor 1630 certificate handler 1630, the example sequence number manager 1631, the example asset identifier 1632, the example certificate collector 1634, the example sequence number comparator 1636, the example sequence number extractor 1640, and the example sequence number verifier 1642.

The processor 4012 of the illustrated example includes a local memory 4013 (e.g., a cache). The processor 4012 of the illustrated example is in communication with a main memory including a volatile memory 4014 and a non-volatile memory 4016 via a bus 4018. The volatile memory 4014 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 4016 may be implemented by flash memory and/or any other desired type of memory device. Access to the main memory 4014, 4016 is controlled by a memory controller.

The processor platform 4000 of the illustrated example also includes an interface circuit 4020. The interface circuit 4020 may be implemented by any type of interface standard, such as an Ethernet interface, a universal serial bus (USB), a Bluetooth® interface, a near field communication (NFC) interface, and/or a PCI express interface.

In the illustrated example, one or more input devices 4022 are connected to the interface circuit 4020. The input device(s) 4022 permit(s) a user to enter data and/or commands into the processor 4012. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 4024 are also connected to the interface circuit 4020 of the illustrated example. The output devices 4024 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 4020 of the illustrated example, thus, typically includes a graphics driver card, a graphics driver chip and/or a graphics driver processor.

The interface circuit 4020 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 4026. The communication can be via, for example, an Ethernet connection, a digital subscriber line (DSL) connection, a telephone line connection, a coaxial cable system, a satellite system, a line-of-site wireless system, a cellular telephone system, etc.

The processor platform 4000 of the illustrated example also includes one or more mass storage devices 4028 for storing software and/or data. Examples of such mass storage devices 4028 include floppy disk drives, hard drive disks, compact disk drives, Blu-ray disk drives, redundant array of independent disks (RAID) systems, and digital versatile disk (DVD) drives.

The machine executable instructions 4032 of FIGS. 27 and 28 may be stored in the mass storage device 4028, in the volatile memory 4014, in the non-volatile memory 4016, and/or on a removable non-transitory computer readable storage medium such as a CD or DVD.

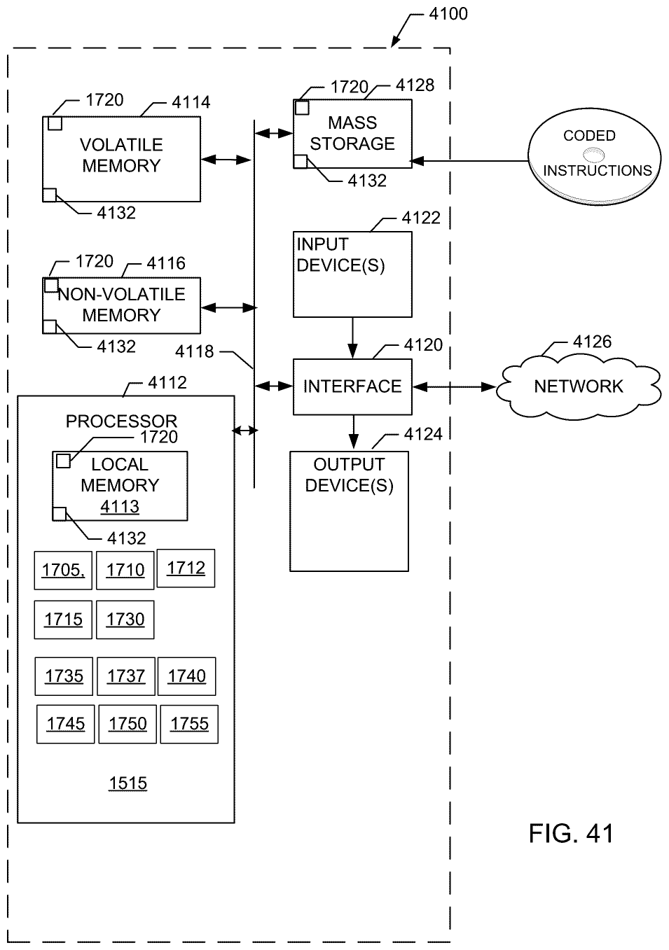

FIG. 41 is a block diagram of an example processor platform 4100 structured to execute the instructions of FIGS. 29 and 30 to implement the central licensor of FIG. 15 and FIG. 16. The processor platform 4100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 4100 of the illustrated example includes a processor 4112. The processor 4112 of the illustrated example is hardware. For example, the processor 4112 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example ADL 1515, the example ADL status requestor 1705, the example incoming license request denier 1710, the example status grant notification information parser 1712, the example storage controller 1715, the example decryptor 1725, and the example status advertiser 1730. In some examples, the second portion includes an example license generator 1735, an example license verifier 1737, and an example sequence number generator 1740 having an example time capturer 1745, an example time converter 1750, and an example sequence number adder 1755.

The processor 4112 of the illustrated example includes a local memory 4113 (e.g., a cache). The processor 4112 of the illustrated example is in communication with a main memory including a volatile memory 4114 and a non-volatile memory 4116 via a bus 4118. The volatile memory 4114 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 4116 may be implemented by flash memory and/or any other desired type of memory device. Access to the main memory 4114, 4116 is controlled by a memory controller.

The processor platform 4100 of the illustrated example also includes an interface circuit 4120. The interface circuit 4120 may be implemented by any type of interface standard, such as an Ethernet interface, a universal serial bus (USB), a Bluetooth® interface, a near field communication (NFC) interface, and/or a PCI express interface.

In the illustrated example, one or more input devices 4122 are connected to the interface circuit 4120. The input device(s) 4122 permit(s) a user to enter data and/or commands into the processor 4112. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 4124 are also connected to the interface circuit 4120 of the illustrated example. The output devices 4124 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 4120 of the illustrated example, thus, typically includes a graphics driver card, a graphics driver chip and/or a graphics driver processor.

The interface circuit 4120 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 4126. The communication can be via, for example, an Ethernet connection, a digital subscriber line (DSL) connection, a telephone line connection, a coaxial cable system, a satellite system, a line-of-site wireless system, a cellular telephone system, etc.

The processor platform 4100 of the illustrated example also includes one or more mass storage devices 4128 for storing software and/or data. Examples of such mass storage devices 4128 include floppy disk drives, hard drive disks, compact disk drives, Blu-ray disk drives, redundant array of independent disks (RAID) systems, and digital versatile disk (DVD) drives.

The machine executable instructions 4132 of FIGS. 29 and 30 may be stored in the mass storage device 4128, in the volatile memory 4114, in the non-volatile memory 4116, and/or on a removable non-transitory computer readable storage medium such as a CD or DVD.

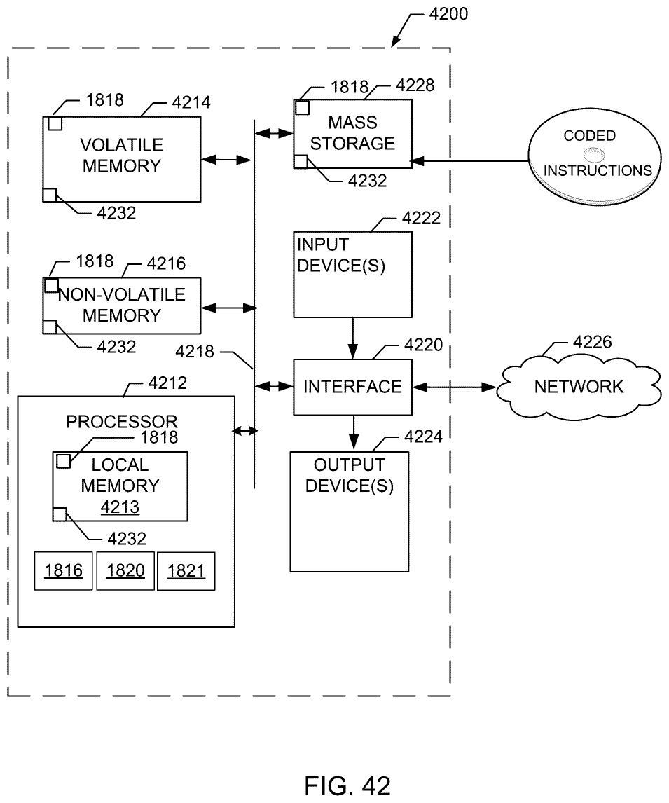

FIG. 42 is a block diagram of an example processor platform 4200 structured to execute the instructions of FIGS. 29 and 30 to implement the central licensor of FIG. 15 and FIG. 16. The processor platform 4200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 4200 of the illustrated example includes a processor 4212. The processor 4212 of the illustrated example is hardware. For example, the processor 4212 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example information parser 1816, the example business level requirements determiner 1820, and the example business level requirements converter 1821.

The processor 4212 of the illustrated example includes a local memory 4213 (e.g., a cache). The processor 4212 of the illustrated example is in communication with a main memory including a volatile memory 4214 and a non-volatile memory 4216 via a bus 4218. The volatile memory 4214 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 4216 may be implemented by flash memory and/or any other desired type of memory device. Access to the main memory 4214, 4216 is controlled by a memory controller.

The processor platform 4200 of the illustrated example also includes an interface circuit 4220. The interface circuit 4220 may be implemented by any type of interface standard, such as an Ethernet interface, a universal serial bus (USB), a Bluetooth® interface, a near field communication (NFC) interface, and/or a PCI express interface.

In the illustrated example, one or more input devices 4222 are connected to the interface circuit 4220. The input device(s) 4222 permit(s) a user to enter data and/or commands into the processor 4212. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 4224 are also connected to the interface circuit 4220 of the illustrated example. The output devices 4224 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 4220 of the illustrated example, thus, typically includes a graphics driver card, a graphics driver chip and/or a graphics driver processor.

The interface circuit 4220 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 4226. The communication can be via, for example, an Ethernet connection, a digital subscriber line (DSL) connection, a telephone line connection, a coaxial cable system, a satellite system, a line-of-site wireless system, a cellular telephone system, etc.

The processor platform 4200 of the illustrated example also includes one or more mass storage devices 4228 for storing software and/or data. Examples of such mass storage devices 4228 include floppy disk drives, hard drive disks, compact disk drives, Blu-ray disk drives, redundant array of independent disks (RAID) systems, and digital versatile disk (DVD) drives.

The machine executable instructions 4232 of FIG. 32 may be stored in the mass storage device 4228, in the volatile memory 4214, in the non-volatile memory 4216, and/or on a removable non-transitory computer readable storage medium such as a CD or DVD.

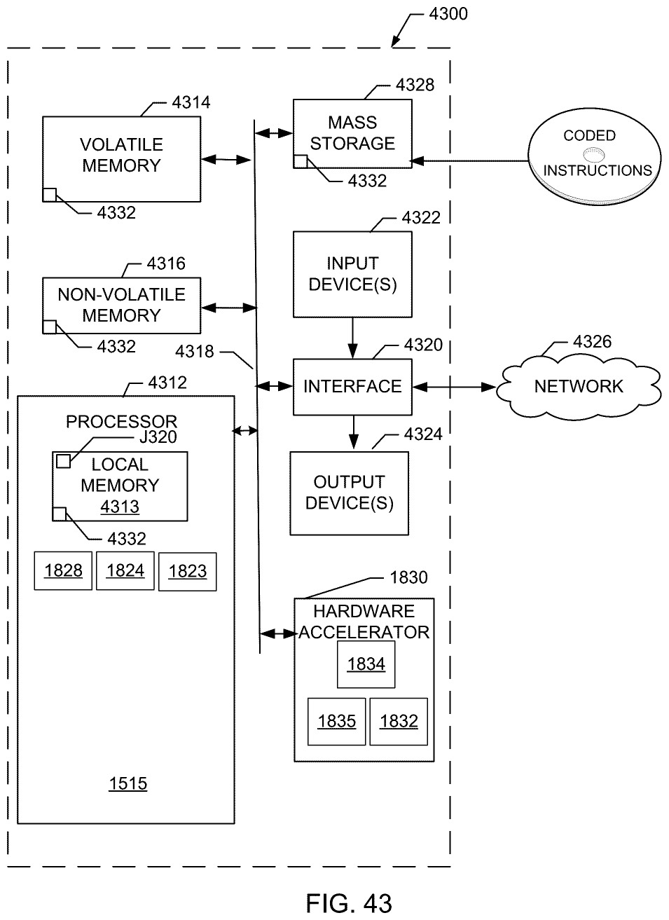

FIG. 43 is a block diagram of an example processor platform 4300 structured to execute the instructions of FIGS. 33 and 34 to implement the central licensor of FIG. 15 and FIG. 16. The processor platform 4300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 4300 of the illustrated example includes a processor 4312. The processor 4312 of the illustrated example is hardware. For example, the processor 4312 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example business level values verifier 1823, an example configuration change verifier 1824, an example compliance monitor 1828. In this example, the processor platform 4300 also includes the example accelerator 1830 having the example script/code remover 1832, and the example CPU 1834, and example business logic hardware 1835.

The processor 4312 of the illustrated example includes a local memory 4313 (e.g., a cache). The processor 4312 of the illustrated example is in communication with a main memory including a volatile memory 4314 and a non-volatile memory 4316 via a bus 4318. The volatile memory 4314 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 4316 may be implemented by flash memory and/or any other desired type of memory device. Access to the main memory 4314, 4316 is controlled by a memory controller.

The processor platform 4300 of the illustrated example also includes an interface circuit 4320. The interface circuit 4320 may be implemented by any type of interface standard, such as an Ethernet interface, a universal serial bus (USB), a Bluetooth® interface, a near field communication (NFC) interface, and/or a PCI express interface.

In the illustrated example, one or more input devices 4322 are connected to the interface circuit 4320. The input device(s) 4322 permit(s) a user to enter data and/or commands into the processor 4312. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 4324 are also connected to the interface circuit 4320 of the illustrated example. The output devices 4324 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 4320 of the illustrated example, thus, typically includes a graphics driver card, a graphics driver chip and/or a graphics driver processor.

The interface circuit 4320 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 4326. The communication can be via, for example, an Ethernet connection, a digital subscriber line (DSL) connection, a telephone line connection, a coaxial cable system, a satellite system, a line-of-site wireless system, a cellular telephone system, etc.

The processor platform 4300 of the illustrated example also includes one or more mass storage devices 4328 for storing software and/or data. Examples of such mass storage devices 4328 include floppy disk drives, hard drive disks, compact disk drives, Blu-ray disk drives, redundant array of independent disks (RAID) systems, and digital versatile disk (DVD) drives.

The machine executable instructions 4332 of FIGS. 33 and 34 may be stored in the mass storage device 4328, in the volatile memory 4314, in the non-volatile memory 4316, and/or on a removable non-transitory computer readable storage medium such as a CD or DVD.

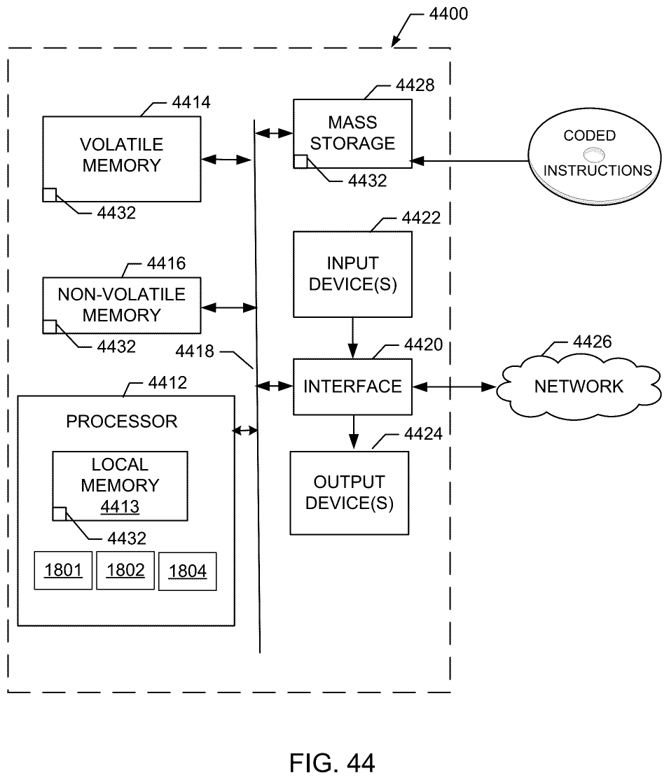

FIG. 44 is a block diagram of an example processor platform 4400 structured to execute the instructions of FIG. 31 to implement a portion of the central licensor of FIG. 15, FIG. 16, and FIG. 18. The processor platform 4400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 4400 of the illustrated example includes a processor 4412. The processor 4412 of the illustrated example is hardware. For example, the processor 4412 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example business logic rules generator 1801, the example business logic rules storage 1802, and the example business logic rules updater 1804.

The processor 4412 of the illustrated example includes a local memory 4413 (e.g., a cache). The processor 4412 of the illustrated example is in communication with a main memory including a volatile memory 4414 and a non-volatile memory 4416 via a bus 4418. The volatile memory 4414 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 4416 may be implemented by flash memory and/or any other desired type of memory device. Access to the main memory 4414, 4416 is controlled by a memory controller.

The processor platform 4400 of the illustrated example also includes an interface circuit 4420. The interface circuit 4420 may be implemented by any type of interface standard, such as an Ethernet interface, a universal serial bus (USB), a Bluetooth® interface, a near field communication (NFC) interface, and/or a PCI express interface.

In the illustrated example, one or more input devices 4422 are connected to the interface circuit 4420. The input device(s) 4422 permit(s) a user to enter data and/or commands into the processor 4412. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 4424 are also connected to the interface circuit 4420 of the illustrated example. The output devices 4424 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 4420 of the illustrated example, thus, typically includes a graphics driver card, a graphics driver chip and/or a graphics driver processor.

The interface circuit 4420 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 4426. The communication can be via, for example, an Ethernet connection, a digital subscriber line (DSL) connection, a telephone line connection, a coaxial cable system, a satellite system, a line-of-site wireless system, a cellular telephone system, etc.

The processor platform 4400 of the illustrated example also includes one or more mass storage devices 4428 for storing software and/or data. Examples of such mass storage devices 4428 include floppy disk drives, hard drive disks, compact disk drives, Blu-ray disk drives, redundant array of independent disks (RAID) systems, and digital versatile disk (DVD) drives.

The machine executable instructions 4432 of FIG. 44 may be stored in the mass storage device 4428, in the volatile memory 4414, in the non-volatile memory 4416, and/or on a removable non-transitory computer readable storage medium such as a CD or DVD.

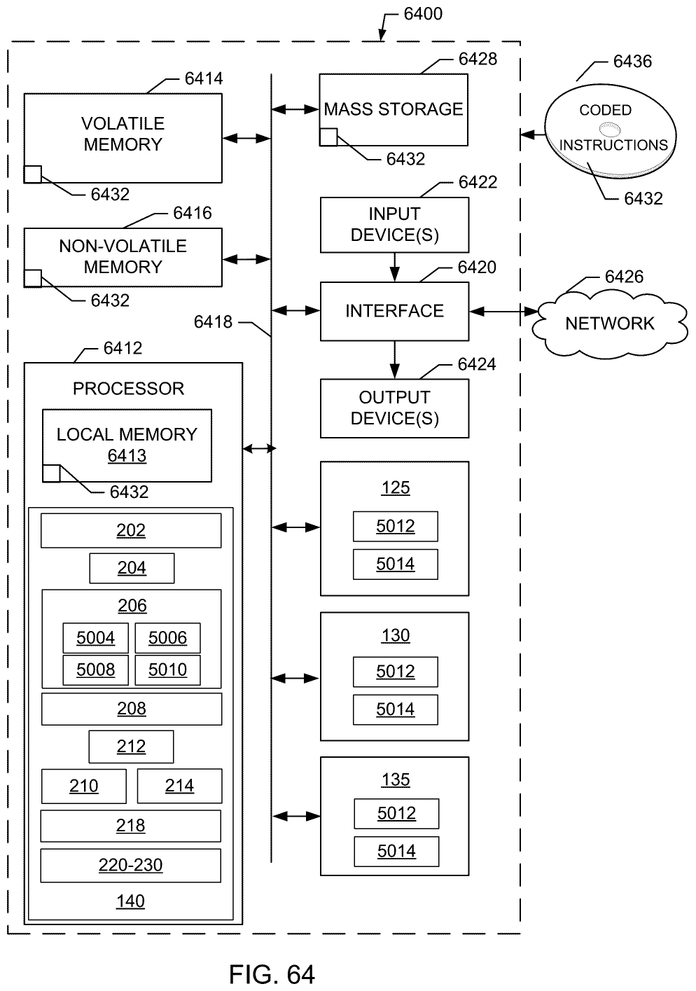

FIG. 64 is a block diagram of an example processor platform 6400 structured to execute the instructions of FIGS. 55-58 and/or 61 to implement the SDSi asset agent 140 of FIGS. 1-9 and/or the SDSi asset agent 140A-C of FIGS. 49-51. The processor platform 6400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box a digital camera, a headset or other wearable device, or any other type of computing device.

The processor platform 6400 of the illustrated example includes a processor 6412. The processor 6412 of the illustrated example is hardware. For example, the processor 6412 can be implemented by one or more integrated circuits, logic circuits, microprocessors, GPUs, DSPs, or controllers from any desired family or manufacturer. The hardware processor 6412 may be a semiconductor based (e.g., silicon based) device. In this example, the processor 6412 implements one or more of the example agent interface 202, the example agent local services 204, the example analytics engine 206, the example communication services 208, the example agent CLI 210, the example agent daemon 212, the example license processor 214, the example agent library 218, the example feature libraries 220-230, the example trusted agent determiner 5004, the example certificate validator 5006, the example anomaly detector 5008, the example anomaly detection ML model(s) 5010, the example feature intent determiner 5012, and/or the example feature intent ML model(s) 5014.

The processor 6412 of the illustrated example includes a local memory 6413 (e.g., a cache). The processor 6412 of the illustrated example is in communication with a main memory including a volatile memory 6414 and a non-volatile memory 6416 via a link 6418. The link 6418 may be implemented by a bus, one or more point-to-point connections, etc., or a combination thereof. The volatile memory 6414 may be implemented by SDRAM, DRAM, RDRAM® and/or any other type of random access memory device. The non-volatile memory 6416 may be implemented by flash memory and/or any other desired type of memory device. Access to the main memory 6414, 6416 is controlled by a memory controller.

The processor platform 6400 of the illustrated example also includes an interface circuit 6420. The interface circuit 6420 may be implemented by any type of interface standard, such as an Ethernet interface, a USB, a Bluetooth® interface, an NFC interface, and/or a PCI express interface.

In the illustrated example, one or more input devices 6422 are connected to the interface circuit 6420. The input device(s) 6422 permit(s) a user to enter data and/or commands into the processor 6412. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 6400, can allow the user to control the computer system and provide data to the computer using physical gestures, such as, but not limited to, hand or body movements, facial expressions, and face recognition.

One or more output devices 6424 are also connected to the interface circuit 6420 of the illustrated example. The output devices 6424 can be implemented, for example, by display devices (e.g., an LED, an OLED, an LCD, a CRT display, an IPS display, a touchscreen, etc.), a tactile output device, a printer and/or speakers(s). The interface circuit 6420 of the illustrated example, thus, typically includes a graphics driver card, a graphics driver chip and/or a graphics driver processor.

The interface circuit 6420 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 6426. The communication can be via, for example, an Ethernet connection, a DSL connection, a telephone line connection, a coaxial cable system, a satellite system, a line-of-site wireless system, a cellular telephone system, etc.

The processor platform 6400 of the illustrated example also includes one or more mass storage devices 6428 for storing software and/or data. Examples of such mass storage devices 6428 include floppy disk drives, hard drive disks, compact disk drives, Blu-ray disk drives, RAID systems, and DVD drives.

The machine executable instructions 6432 corresponding to the instructions of FIG. 55-58 and/or 61 may be stored in the mass storage device 6428, in the volatile memory 6414, in the non-volatile memory 6416, in the local memory 6413 and/or on a removable non-transitory computer readable storage medium, such as a CD or DVD 6436.

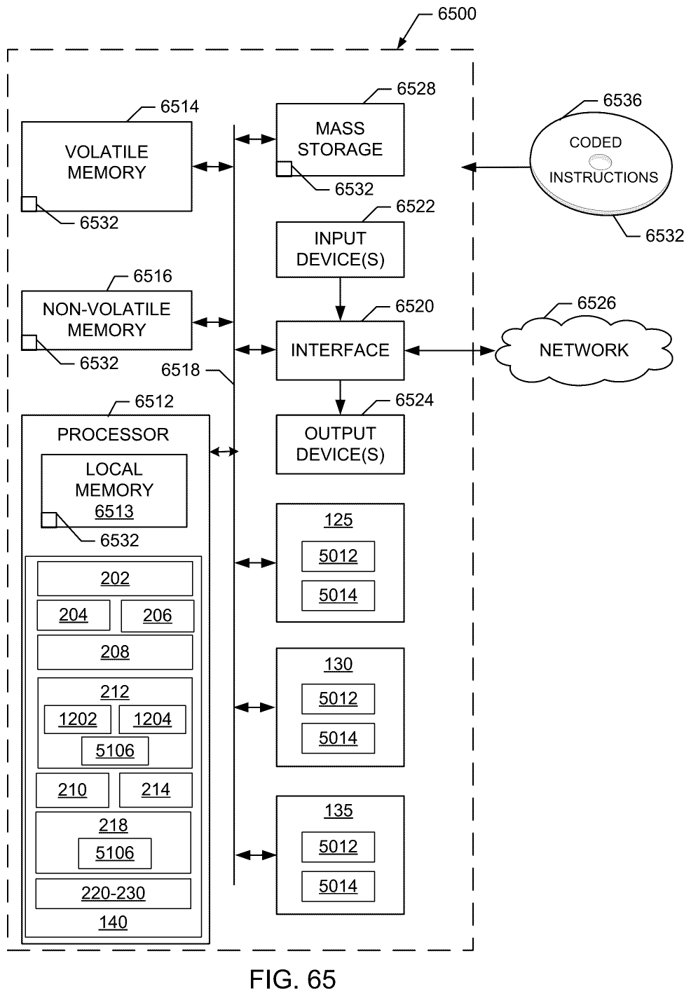

FIG. 65 is a block diagram of an example processor platform 6500 structured to execute the instructions of FIGS. 59, 60, and/or 61 to implement the SDSi asset agent 140 of FIGS. 1-9 and/or the SDSi asset agent 140A-C of FIGS. 49-51. The processor platform 6500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box a digital camera, a headset or other wearable device, or any other type of computing device.

The processor platform 6500 of the illustrated example includes a processor 6512. The processor 6512 of the illustrated example is hardware. For example, the processor 6512 can be implemented by one or more integrated circuits, logic circuits, microprocessors, GPUs, DSPs, or controllers from any desired family or manufacturer. The hardware processor 6512 may be a semiconductor based (e.g., silicon based) device. In this example, the processor 6512 implements one or more of the example agent interface 202, the example agent local services 204, the example analytics engine 206, the example communication services 208, the example agent CLI 210, the example agent daemon 212, the example license processor 214, the example agent library 218, the example feature libraries 220-230, the example TEE identifier 5102, the example TEE generator 5104, the example TEE(s) 5105, the example TEE library 5106, the example feature intent determiner 5012, and/or the example feature intent ML model(s) 5014.

The processor 6512 of the illustrated example includes a local memory 6513 (e.g., a cache). The processor 6512 of the illustrated example is in communication with a main memory including a volatile memory 6514 and a non-volatile memory 6516 via a link 6518. The link 6518 may be implemented by a bus, one or more point-to-point connections, etc., or a combination thereof. The volatile memory 6514 may be implemented by SDRAM, DRAM, RDRAM® and/or any other type of random access memory device. The non-volatile memory 6516 may be implemented by flash memory and/or any other desired type of memory device. Access to the main memory 6514, 6516 is controlled by a memory controller. In this example, respective ones of the hardware circuitry 125, the firmware 130, and the BIOS 135 include the example TEE component(s) of FIG. 51.

The processor platform 6500 of the illustrated example also includes an interface circuit 6520. The interface circuit 6520 may be implemented by any type of interface standard, such as an Ethernet interface, a USB, a Bluetooth® interface, an NFC interface, and/or a PCI express interface.

In the illustrated example, one or more input devices 6522 are connected to the interface circuit 6520. The input device(s) 6522 permit(s) a user to enter data and/or commands into the processor 6512. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 6500, can allow the user to control the computer system and provide data to the computer using physical gestures, such as, but not limited to, hand or body movements, facial expressions, and face recognition.

One or more output devices 6524 are also connected to the interface circuit 6520 of the illustrated example. The output devices 6524 can be implemented, for example, by display devices (e.g., an LED, an OLED, an LCD, a CRT display, an IPS display, a touchscreen, etc.), a tactile output device, a printer and/or speakers(s). The interface circuit 6520 of the illustrated example, thus, typically includes a graphics driver card, a graphics driver chip and/or a graphics driver processor.

The interface circuit 6520 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 6526. The communication can be via, for example, an Ethernet connection, a DSL connection, a telephone line connection, a coaxial cable system, a satellite system, a line-of-site wireless system, a cellular telephone system, etc.

The processor platform 6500 of the illustrated example also includes one or more mass storage devices 6528 for storing software and/or data. Examples of such mass storage devices 6528 include floppy disk drives, hard drive disks, compact disk drives, Blu-ray disk drives, RAID systems, and DVD drives.

The machine executable instructions 6532 corresponding to the instructions of FIGS. 59, 60, and/or 61 may be stored in the mass storage device 6528, in the volatile memory 6514, in the non-volatile memory 6516, in the local memory 6513 and/or on a removable non-transitory computer readable storage medium, such as a CD or DVD 6536.

FIG. 66 is a block diagram of an example processor platform 6600 structured to execute the instructions of FIGS. 62-63 to implement the time calculator 5202 and feature group calculator 5204 of FIGS. 52-54. The processor platform 6600 can be, for example, a server, a personal computer, a workstation, a self-learning machine (e.g., a neural network), a mobile device (e.g., a cell phone, a smart phone, a tablet such as an iPad′), a personal digital assistant (PDA), an Internet appliance, a DVD player, a CD player, a Blu-ray player, a gaming console, a personal video recorder, a headset or other wearable device, or any other type of computing device.

The processor platform 6600 of the illustrated example includes a processor 6612. The processor 6612 of the illustrated example is hardware. For example, the processor 6612 can be implemented by one or more integrated circuits, logic circuits, microprocessors, GPUs, DSPs, or controllers from any desired family or manufacturer. The hardware processor may be a semiconductor based (e.g., silicon based) device. In this example, the processor 6612 implements the example time calculator 5202, the example feature group calculator 5204, the example request interface 5304, the example property checker 5306, the relative time determiner 5308, the absolute determiner 5310, the example configuration detector 5402, the example sensor interface 5404, the example environmental condition determiner 5406, the example feature weight determiner 5408, the example group score calculator 5410, the example threshold comparator 5414, and/or the example configuration controller 5416.

The processor 6612 of the illustrated example includes a local memory 6613 (e.g., a cache). The processor 6612 of the illustrated example is in communication with a main memory including a volatile memory 6614 and a non-volatile memory 6616 via a bus 6618. The volatile memory 6614 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 6616 may be implemented by flash memory and/or any other desired type of memory device. Access to the main memory 6614, 6616 is controlled by a memory controller.

The processor platform 6600 of the illustrated example also includes an interface circuit 6620. The interface circuit 6620 may be implemented by any type of interface standard, such as an Ethernet interface, a universal serial bus (USB), a Bluetooth® interface, a near field communication (NFC) interface, and/or a PCI express interface.

In the illustrated example, one or more input devices 6622 are connected to the interface circuit 6620. The input device(s) 6622 permit(s) a user to enter data and/or commands into the processor 6612. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 6624 are also connected to the interface circuit 6620 of the illustrated example. The output devices 6624 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 6620 of the illustrated example, thus, typically includes a graphics driver card, a graphics driver chip and/or a graphics driver processor.

The interface circuit 6620 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 6626. The communication can be via, for example, an Ethernet connection, a digital subscriber line (DSL) connection, a telephone line connection, a coaxial cable system, a satellite system, a line-of-site wireless system, a cellular telephone system, etc.

The processor platform 6600 of the illustrated example also includes one or more mass storage devices 6628 for storing software and/or data. Examples of such mass storage devices 6628 include floppy disk drives, hard drive disks, compact disk drives, Blu-ray disk drives, redundant array of independent disks (RAID) systems, and digital versatile disk (DVD) drives.

The machine executable instructions 6632 of FIGS. 62 and 63 may be stored in the mass storage device 6628, in the volatile memory 6614, in the non-volatile memory 6616, and/or on a removable non-transitory computer readable storage medium such as a CD or DVD 6636.

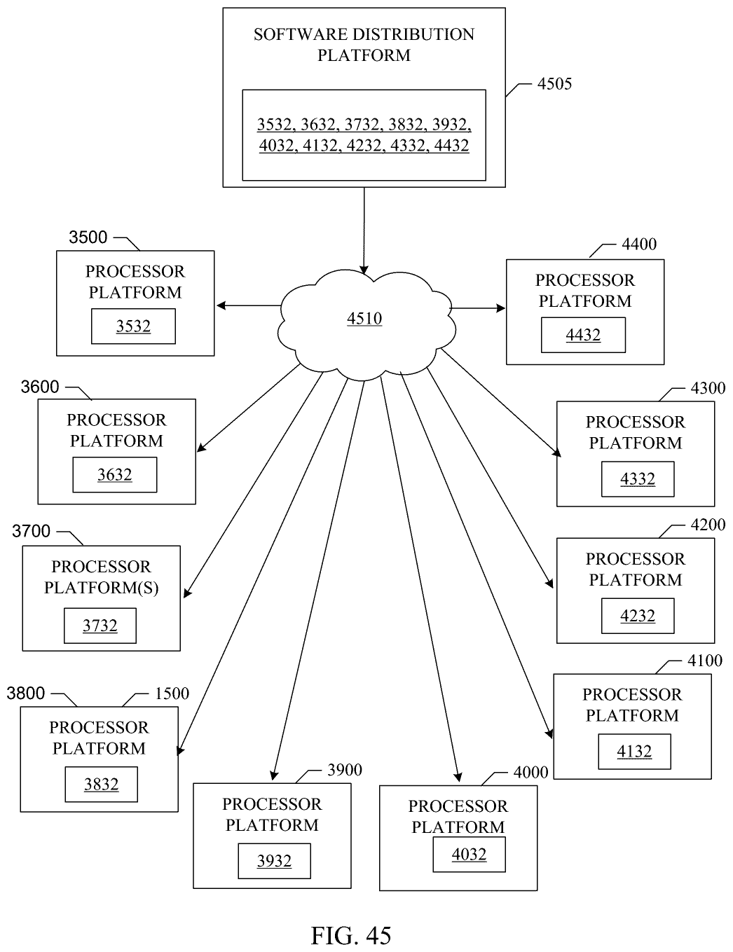

A block diagram illustrating an example software distribution platform 4505 to distribute software such as the example computer readable instructions 3532, 3632 and/or 3732 of FIGS. 35-37 and/or the example computer readable instructions 3832 and/or 3932 of FIGS. 38-39 and/or the example computer readable instructions 4032, 4132, 4232, 4332 and/or 4432 of FIGS. 40-44 to third parties is illustrated in FIG. 45. The example software distribution platform 4505 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 3532, 3632 and/or 3732 of FIGS. 35-37 and/or the example computer readable instructions 3832 and/or 3932 of FIGS. 38-39 and/or the example computer readable instructions 4032, 4132, 4232, 4332 and/or 4432 of FIGS. 40-44. The third parties may be consumers, users, retailers, OEMs, etc., who purchase and/or license the software for use and/or re-sale and/or sub-licensing. In the illustrated example, the software distribution platform 4505 includes one or more servers and one or more storage devices. The storage devices store the computer readable instructions 3532, 3632 and/or 3732, which may correspond to the example computer readable instructions 1900, 2000 and/or 2100 of FIGS. 19-21, and/or the computer readable instructions 3832 and/or 3932, which may correspond to the example computer readable instructions 2200, 2300, 2400, 2500 and/or 2600 of FIGS. 22A-22B and 23-26, and/or the example computer readable instructions 4032, 4132, 4232, 4332 and/or 4432, which may correspond to the example computer readable instructions 2700-3400 as described above. The one or more servers of the example software distribution platform 4505 are in communication with a network 4510, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 3832, 3932, 3532, 3632 and/or 3732 from the software distribution platform 4505. For example, the software, which may correspond to the example computer readable instructions 1900, 2000 and/or 2100 of FIGS. 19-21, may be downloaded to the example processor platforms 3500, 3600 and/or 3700, which execute the computer readable instructions 3532, 3632 and/or 3732 to implement the manufacture enterprise system 110, the customer enterprise system 115 and/or the SDSi asset agent 140. As another example, the software, which may correspond to the example computer readable instructions 2200, 2300, 2400, 2500 and/or 2600 of FIGS. 22A-22B and 23-26, may be downloaded to the example processor platforms 3800 and/or 3900, which execute the computer readable instructions 3832 and/or 3932 to implement the manufacture enterprise system 110 and/or the SDSi asset agent 140. In some example, one or more servers of the software distribution platform 4505 periodically offer, transmit, and/or force updates to the software (e.g., the example computer readable instructions 3532, 3632 and/or 3732 of FIGS. 35-37, and/or the example computer readable instructions 3832 and/or 3932 of FIGS. 38-39, and/or the example computer readable instructions 4032, 4132, 4232, 4332 and/or 4432 of FIGS. 40-44) to ensure improvements, patches, updates, etc. are distributed and applied to the software at the end user devices.

Edge Computing

FIG. 46 is a block diagram 4600 showing an overview of a configuration for edge computing, which includes a layer of processing referred to in many of the following examples as an “edge cloud”. As shown, the edge cloud 4610 is co-located at an edge location, such as an access point or base station 4640, a local processing hub 4650, or a central office 4620, and thus may include multiple entities, devices, and equipment instances. The edge cloud 4610 is located much closer to the endpoint (consumer and producer) data sources 4660 (e.g., autonomous vehicles 4661, user equipment 4662, business and industrial equipment 4663, video capture devices 4664, drones 4665, smart cities and building devices 4666, sensors and IoT devices 4667, etc.) than the cloud data center 4630. Compute, memory, and storage resources which are offered at the edges in the edge cloud 4610 are critical to providing ultra-low latency response times for services and functions used by the endpoint data sources 4660 as well as reduce network backhaul traffic from the edge cloud 4610 toward cloud data center 4630 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

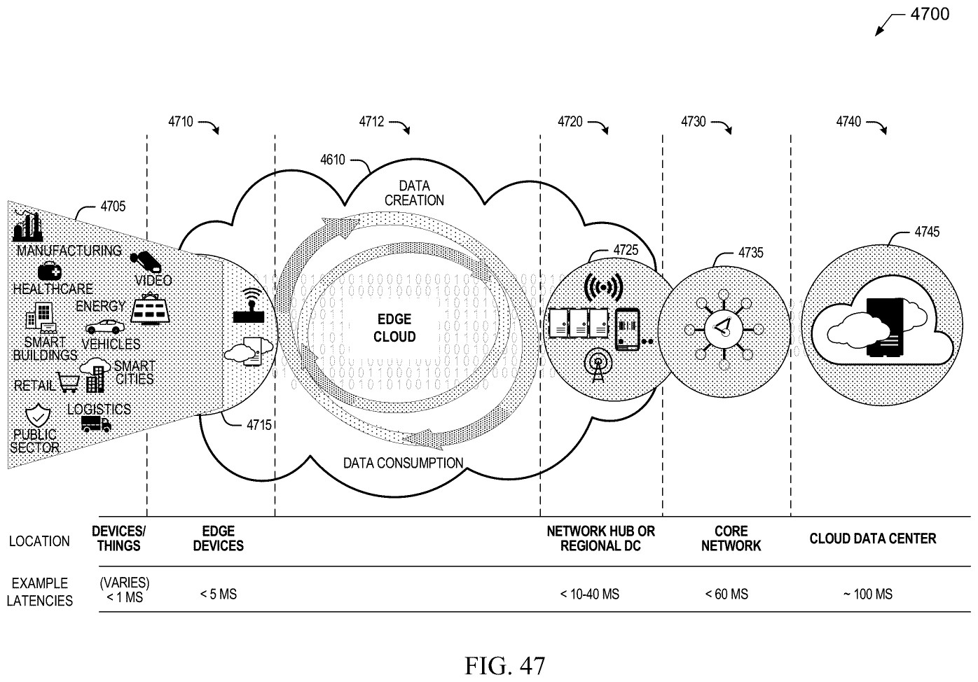

FIG. 47 illustrates operational layers among endpoints, an edge cloud, and cloud computing environments. Specifically, FIG. 47 depicts examples of computational use cases 4705, utilizing the edge cloud 4610 among multiple illustrative layers of network computing. The layers begin at an endpoint (devices and things) layer 4700, which accesses the edge cloud 4610 to conduct data creation, analysis, and data consumption activities. The edge cloud 4610 may span multiple network layers, such as an edge devices layer 4710 having gateways, on-premise servers, or network equipment (nodes 4715) located in physically proximate edge systems; a network access layer 4720, encompassing base stations, radio processing units, network hubs, regional data centers (DC), or local network equipment (equipment 4725); and any equipment, devices, or nodes located therebetween (in layer 4712, not illustrated in detail). The network communications within the edge cloud 4610 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 4700, under 5 ms at the edge devices layer 4710, to even between 10 to 40 ms when communicating with nodes at the network access layer 4720. Beyond the edge cloud 4610 are core network 4730 and cloud data center 4740 layers, each with increasing latency (e.g., between 50-60 ms at the core network layer 4730, to 100 or more ms at the cloud data center layer). As a result, operations at a core network data center 4735 or a cloud data center 4745, with latencies of at least 50 to 100 ms or more, will not be able to accomplish many time-critical functions of the use cases 4705. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 4735 or a cloud data center 4745, a central office or content data network may be considered as being located within a “near edge” layer (“near” to the cloud, having high latency values when communicating with the devices and endpoints of the use cases 4705), whereas an access point, base station, on-premise server, or network gateway may be considered as located within a “far edge” layer (“far” from the cloud, having low latency values when communicating with the devices and endpoints of the use cases 4705). It will be understood that other categorizations of a particular network layer as constituting a “close”, “local”, “near”, “middle”, or “far” edge may be based on latency, distance, number of network hops, or other measurable characteristics, as measured from a source in any of the network layers 4700-4740.

The various use cases 4705 may access resources under usage pressure from incoming streams, due to multiple services utilizing the edge cloud. To achieve results with low latency, the services executed within the edge cloud 4610 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 4610 may provide the ability to serve and respond to multiple applications of the use cases 4705 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 4610 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 4610 (network layers 4700-4740), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 4610.

As such, the edge cloud 4610 is formed from network components and functional features operated by and within edge gateway nodes, edge aggregation nodes, or other edge compute nodes among network layers 4710-4730. The edge cloud 4610 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 4610 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

The network components of the edge cloud 4610 may be servers, multi-tenant servers, appliance computing devices, and/or any other type of computing devices. For example, the edge cloud 4610 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. The example processor systems of FIGS. 35-44, 64-66, 71, 78, 86, 94, 97, 98, 107, 108, 118, 119, 125, 126, 132, 133, 138-141, 145, 146 and/or 149 illustrate example hardware for implementing an appliance computing device. The edge cloud 4610 may also include one or more servers and/or one or more multi-tenant servers. Such a server may include an operating system and a virtual computing environment. A virtual computing environment may include a hypervisor managing (spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

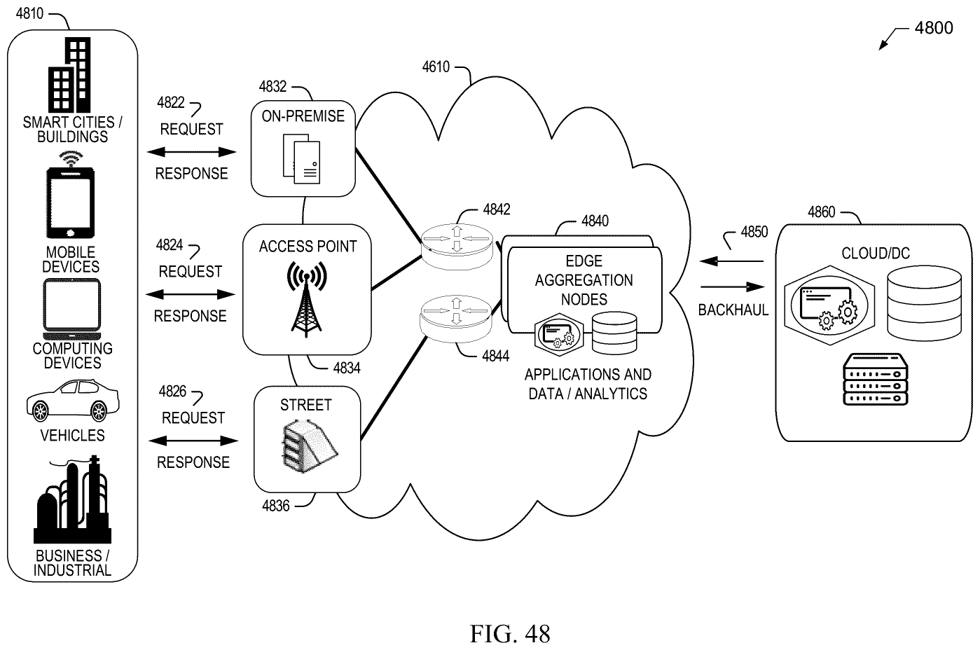

In FIG. 48, various client endpoints 4810 (in the form of mobile devices, computers, autonomous vehicles, business computing equipment, industrial processing equipment) exchange requests and responses that are specific to the type of endpoint network aggregation. For instance, client endpoints 4810 may obtain network access via a wired broadband network, by exchanging requests and responses 4822 through an on-premise network system 4832. Some client endpoints 4810, such as mobile computing devices, may obtain network access via a wireless broadband network, by exchanging requests and responses 4824 through an access point (e.g., cellular network tower) 4834. Some client endpoints 4810, such as autonomous vehicles may obtain network access for requests and responses 4826 via a wireless vehicular network through a street-located network system 4836. However, regardless of the type of network access, the TSP may deploy aggregation points 4842, 4844 within the edge cloud 4610 to aggregate traffic and requests. Thus, within the edge cloud 4610, the TSP may deploy various compute and storage resources, such as at edge aggregation nodes 4840, to provide requested content. The edge aggregation nodes 4840 and other systems of the edge cloud 4610 are connected to a cloud or data center 4860, which uses a backhaul network 4850 to fulfill higher-latency requests from a cloud/data center for websites, applications, database servers, etc. Additional or consolidated instances of the edge aggregation nodes 4840 and the aggregation points 4842, 4844, including those deployed on a single server framework, may also be present within the edge cloud 4610 or other areas of the TSP infrastructure.

In view of the descriptions provided hereinabove and further hereinbelow, the example processor systems of FIGS. 35-44, 64-66, 71, 78, 86, 94, 97, 98, 107, 108, 118, 119, 125, 126, 132, 133, 138-141, 145, 146 and/or 149 can be used to implement one or more example edge server processor circuitry, example edge cloud processor circuitry, example edge node processor circuitry, example edge gateway processor circuitry, example edge switch processor circuitry, example XPU(s), example Infrastructure Processing Unit(s), example network interface circuitry, example acceleration circuitry, example graphics processor unit(s), example vision processor unit(s), example Artificial Intelligence processor(s), example machine learning processor(s), example neural network processor(s), example digital signal processor(s), and/or example general purpose processor(s), and/or apparatus including any of the preceding examples, as illustrated in the examples of FIGS. 46-48 and/or other examples disclosed herein.

Conclusion

From the foregoing, it will be appreciated that example methods, apparatus and articles of manufacture have been disclosed that enables activation, deactivation and management of silicon product features after the silicon product has left the manufacturer's facility and control. The disclosed methods, apparatus and articles of manufacture improve the efficiency of using a computing device by providing mechanisms to activate dormant features of the silicon product, deactivate active features of the silicon product, perform failure recovery, etc. The disclosed methods, apparatus and articles of manufacture are accordingly directed to one or more improvement(s) in the functioning of a computer.

From the foregoing, it will also be appreciated that example methods, apparatus and articles of manufacture have been disclosed that protect semiconductor devices from feature adjustments that violate the intended configuration of the semiconductor devices. For example, techniques disclosed herein prevent the deactivation of features on a semiconductor device that were active when ownership of the semiconductor device was transferred, thereby preventing changes in hardware configurations that may invalidate warranties, violate financial agreements, and/or compromise safe and predictable operation of the semiconductor device. Example apparatus, methods, and articles of manufacture disclosed herein intelligently track ownership of a semiconductor device using hardware identifiers, entropy-based identifiers, and/or authentication keys to prevent cloning of devices for prohibited hardware and/or software changes. Example apparatus, methods, and articles of manufacture disclosed herein leverage technical characteristics of the semiconductor device to utilize identifiers that are unclonable prevent re-use of licenses that adjust features on semiconductor devices. Example techniques disclosed herein further enable license execution tracking to prevent licenses from being executed at unintended times (e.g., after making other changes on the semiconductor device). The disclosed methods, apparatus and articles of manufacture are accordingly directed to one or more improvement(s) in the functioning of a computer.

From the foregoing, it will also be appreciated that example methods, apparatus, and articles of manufacture have been disclosed that effectuate security of silicon product features after the silicon product has left the manufacturer's facility and control. The disclosed methods, apparatus, and articles of manufacture improve the efficiency of using a computing device by providing mechanisms to activate dormant features of the silicon product, deactivate active features of the silicon product, perform failure recovery, etc., corresponding to mesh attestation processes, deployment of TEE(s), and translation of intent(s) or intended outcome(s) associated with configuration change requests into dormant features of which to activate. The disclosed methods, apparatus and articles of manufacture are accordingly directed to one or more improvement(s) in the functioning of a computer.

From the foregoing, it will also be appreciated that example methods, apparatus, and articles of manufacture disclosed herein improve the efficiency of using a computing device by providing mechanisms to activate dormant features of the silicon product, deactivate active features of the silicon product, perform failure recovery, etc., corresponding to an unfalsifiable and reliable method of determining time references and determining feature load on a processor. The disclosed methods, apparatus and articles of manufacture are accordingly directed to one or more improvement(s) in the functioning of a computer.

Systems, Apparatus, Articles of Manufacture, and Methods for Virtual Resource Migration Using Software-Defined Silicon

Virtualizing computer systems provides benefits such as the ability to execute multiple computer systems on a single hardware computer, replicating computer systems, moving computer systems among multiple hardware computers, and so forth. “Infrastructure-as-a-Service” (also commonly referred to as “IaaS”) generally describes a suite of technologies provided by a service provider as an integrated solution to allow for elastic creation of a virtualized, networked, and pooled computing platform (sometimes referred to as a “cloud computing platform”). Enterprises may use IaaS as a business-internal organizational cloud computing platform (sometimes referred to as a “private cloud”) that gives an application developer access to infrastructure resources, such as virtualized servers, storage, and networking resources. By providing ready access to the hardware resources required to run an application, the cloud computing platform enables developers to build, deploy, and manage the lifecycle of a web application (or any other type of networked application) at a greater scale and at a faster pace than ever before.

Executing workloads in distributed and/or virtualized computing environments provides benefits such as allocating resources (e.g., physical hardware resources, virtualizations of the physical hardware resources, etc.) to effectuate lifecycle management of an application with reduced downtime. Lifecycle management may include upgrading a server, or portion(s) thereof, such as upgrading hardware, software, and/or firmware from first version(s) to second version(s). In some instances, reconfiguration of a server may be needed to ensure compliance with a service level agreement (SLA) or resource orchestration policy. In some instances, reconfiguration of a server may be needed when a burst, or temporary change in the workload type is detected, and migration to a different server with different capabilities and/or resources may result in an optimal and/or otherwise improved resource utilization. In some instances, a reconfiguration of a server (e.g., a hardware, software, and/or firmware reconfiguration, change, or upgrade) may take time and/or require a reboot of the server. During the upgrade time and/or the reboot time, a workload executed by the server is to be paused can be resumed after the configuration change(s) of the server is/are complete. Such downtime of the workload may introduce significant delays in the processing of the workload.

Examples disclosed herein include systems, apparatus, articles of manufacture, and methods for virtual resource migration using software-defined silicon (SDSi). In some disclosed examples, a server (e.g., a server of a customer enterprise system) can effectuate a migration of a virtual resource, such as a virtual machine (VM), a container, etc., from a first host server to a second host server with reduced downtime. In some disclosed examples, the first host server can execute a workload (e.g., an application, a compute workload, etc.). In some disclosed examples, the server can capture a snapshot of a first state of the first host server and store the snapshot in secure cache or other type of secure storage. In some disclosed examples, the snapshot of the first state includes one or more first features (e.g., software features, hardware features, firmware features, etc.) of a first semiconductor device of the first host server, one or more licenses associated with the one or more first features, and/or a state of the virtual resource. In some disclosed examples, the server can reconfigure the second host server by changing one or more second features of a second semiconductor device of the second host server to the one or more first features of the first semiconductor device. In some disclosed examples, the server can migrate the virtual resource from the first host server to the second host server. In some disclosed examples, the server can apply the snapshot of the first host server to the second host server to deploy at least one of the one or more licenses or the state of the virtual resource on the second host server. Advantageously, the second host server can resume execution of the workload by performing the workload on the VM of the second host server with reduced downtime compared to prior approaches.

In some disclosed examples, the server can effectuate a temporary migration of the virtual resource. For example, after the migration of the virtual resource from the first host server to the second host server, the server can reconfigure at least one of the one or more first features of the first semiconductor device based on a recommendation or determination to improve execution of the workload. In some disclosed examples, in response to the server reconfiguring the first semiconductor device based on the recommendation/determination, the server can apply the snapshot of the first host server to the first host server to deploy at least one of the one or more licenses or the state of the virtual resource on the first host server. In some disclosed examples, the server can migrate the virtual resource from the second host server to the first host server. Advantageously, the first host server can resume execution of the workload by performing the workload on the VM of the first host server based on the reconfiguration of the first semiconductor device with improved efficiency with respect to the previous configuration of the first semiconductor device.

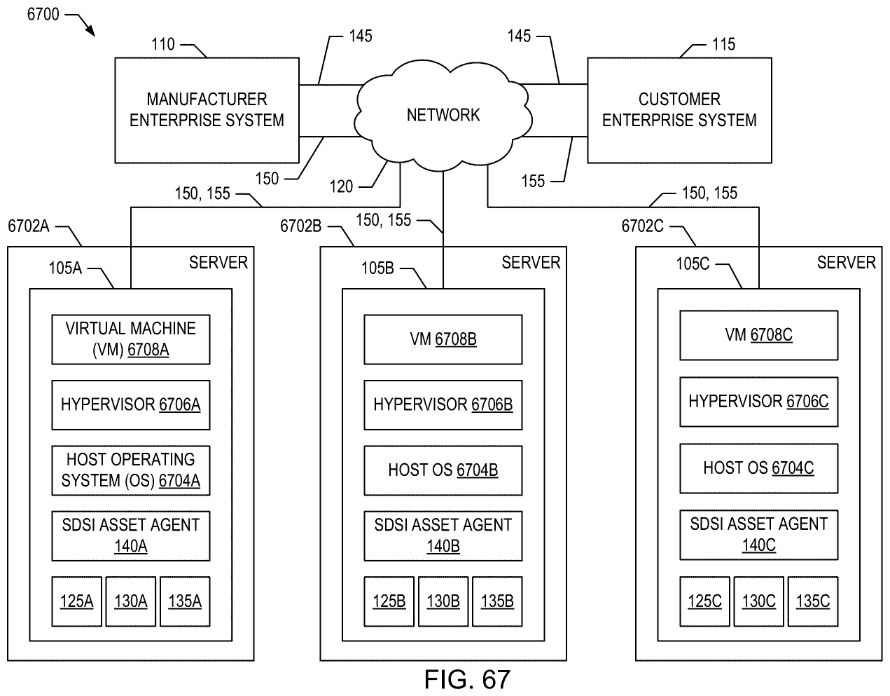

FIG. 67 is a block diagram of an example system (e.g., an SDSi system) 6700 to implement and manage SDSi products in accordance with teachings of this disclosure. The SDSi system 6700 of the illustrated example of FIG. 67 includes a plurality of the example silicon products 105 of FIG. 1 (e.g., a plurality of the SDSi semiconductor devices 105 of FIG. 1, a plurality of the semiconductor assets 105 of FIG. 1, etc.), such as the silicon products 105A-C of FIG. 49. The silicon products 105A-C include respective instantiations of the SDSi asset agent 140 of FIG. 1, such as the SDSi asset agents 140A-C of FIG. 49. The silicon products 105A-C include respective instantiations of the hardware circuitry 125 of FIG. 1, such as first example hardware circuitry 125A, second example hardware circuitry 125B, and third example hardware circuitry 125C. The silicon products 105A-C include respective instantiations of the firmware 130 of FIG. 1, such as first example firmware 130A, second example firmware 130B, and third example firmware 130C. The silicon products 105A-C include respective instantiations of the BIOS 135 of FIG. 1, such as a first example BIOS 135A, a second example BIOS 135B, and a third example BIOS 135C.

The SDSi asset agents 140A-C of the example of FIG. 67, and/or, more generally, the semiconductor products 105A-C of the example of FIG. 49, implement SDSi features as disclosed herein. The SDSi system 6700 also includes the example manufacturer enterprise system 110 of FIGS. 1 and/or 49 and the example customer enterprise system 115 of FIGS. 1 and/or 49 to manage the SDSi asset agents 140A-C of FIG. 49, and/or, more generally, the semiconductor products 105A-C of FIG. 49. In the illustrated example of FIG. 67, at least some aspects of the manufacturer enterprise system 110 and/or the customer enterprise system 115 are implemented as cloud services in the example cloud platform 120 of FIGS. 1 and/or 49.

In the illustrated example of FIG. 67, the manufacturer enterprise system 110 is in communication with the customer enterprise system 115 via a cloud service implemented by the cloud platform 120 (represented by the line labeled 145 of FIGS. 1 and/or 49). In the illustrated example of FIG. 67, the SDSi semiconductor devices 105A-C are in communication with the manufacturer enterprise system 110 via a cloud service implemented by the cloud platform 120 (represented by the line labeled 150 of FIGS. 1 and/or 49). In the illustrated example of FIG. 67, the SDSi semiconductor devices 105A-C are in communication with the customer enterprise system 115 via a cloud service implemented by the cloud platform 120 (represented by the line labeled 155 of FIGS. 1 and/or 49).

In the illustrated example of FIG. 67, the SDSi system 6700 includes example servers 6702A-C, such as a first example server 6702A, a second example server 6702B, and a third example server 6702C. For example, the servers 6702A-C can be computer servers, electronic servers, etc., that include one or more of the SDSi semiconductor devices 105A-C and/or other hardware, such as accelerator(s), network interface(s), memory (e.g., volatile memory, non-volatile memory, etc.), memory controller(s), mass storage device(s), bus(es), input device(s), output device(s), etc., and/or any combination(s) thereof. In the illustrated example of FIG. 67, the servers 6702A-C include a respective one of the SDSi semiconductor devices 105A-C. Alternatively, one or more of the servers 6702A-C may include more than one of the SDSi semiconductor devices 105A-C. In some examples, one(s) of the servers 6702A-C is/are referred to herein as customer servers (e.g., customer enterprise servers). In some examples, one(s) of the servers 6702A-C is/are referred to herein as host servers. In some examples, one(s) of the servers 6702A-C is/are virtualized servers instantiated by respective one(s) of the hardware circuitry 125A-C, the firmware 130A-C, and/or the BIOS 135A-C.

In the illustrated example of FIG. 67, the SDSi semiconductor devices 105A-C include respective instantiations of an example host operating system (OS) 6704A-C, such as a first example host OS 6704A, a second example host OS 6704B, and a third example host OS 6704C. In the illustrated example of FIG. 67, the SDSi semiconductor devices 105A-C include respective instantiations of an example hypervisor 6706A-C, such as a first example hypervisor 6706A, a second example hypervisor 6706B, and a third example hypervisor 6706C. In the illustrated example of FIG. 67, the SDSi semiconductor devices 105A-C include respective instantiations of an example virtual machine (VM) 6708A-C, such as a first example VM 6708A, a second example VM 6708B, and a third example VM 6708C.

In some examples, the hypervisors 6706A-C can implement a virtualization platform, service, etc., for a type of virtualization environment. Three example types of virtualization environment are: full virtualization, paravirtualization, and OS virtualization. The SDSi system 6700 can be implemented by a full virtualization environment, a paravirtualization environment, and/or an OS virtualization environment as described herein.

Full virtualization, as used herein, is a virtualization environment in which hardware resources, such as the SDSi semiconductor devices 105A-C, are managed by a respective one of the hypervisors 6706A-C to provide virtual hardware resources to a respective one of the VMs 6708A-C. In a full virtualization environment, the VMs 6708A-C do not have access to the underlying hardware resources. In a typical full virtualization, the host OS 6704A-C with an embedded hypervisor (e.g., one of the hypervisors 6706A-C) is installed on the server hardware (e.g., hardware of the servers 6702A-C). The VMs 6708A-C, which include virtual hardware resources, are then deployed on a respective one of the hypervisors 6706A-C. In some examples, a guest OS can be installed in the VMs 6708A-C. The hypervisors 6706A-C manage the association between the hardware resources of the server hardware (e.g., hardware of the servers 6702A-C) and the virtual resources allocated to the VMs 6708A-C (e.g., associating physical random-access memory (RAM) with virtual RAM). Typically, in full virtualization, the VMs 6708A-C and the corresponding guest OS have no visibility and/or access to the hardware resources of the underlying server. In some examples, in full virtualization, a full guest OS can be installed in the VMs 6708A-C while the host OS 6704A-C is installed on the server hardware (e.g., hardware of the servers 6702A-C).

Paravirtualization, as used herein, is a virtualization environment in which hardware resources of the SDSi semiconductor devices 105A-C, and/or, more generally, the servers 6702A-C, are managed by the hypervisors 6706A-C to provide virtual hardware resources to the VMs 6708A-C, and guest OSs can also be allowed to access some or all the underlying hardware resources of the servers 6702A-C (e.g., without accessing an intermediate virtual hardware resource). In a typical paravirtualization system, the host OS 6704A-C (e.g., a Linux-based OS) can be installed on the server hardware (e.g., hardware of the servers 6702A-C). The hypervisors 6706A-C execute on the host OS 6704A-C. The VMs 6708A-C, which include virtual hardware resources, are then deployed on the hypervisors 6706A-C. The hypervisors 6706A-C manage the association between the hardware resources of the server hardware (e.g., hardware of the servers 6702A-C) and the virtual resources allocated to the VMs 6708A-C (e.g., associating RAM with virtual RAM). In some examples, in paravirtualization, the guest OS installed in the VMs 6708A-C is configured also to have direct access to some or all of the hardware resources of the servers 6702A-C. For example, the guest OS may be precompiled with special drivers that allow the guest OS to access the hardware resources without passing through a virtual hardware layer. For example, a guest OS may be precompiled with drivers that allow the guest OS to access a sound card installed in the server hardware. Directly accessing the hardware (e.g., without accessing the virtual hardware resources of the VMs 6708A-C) may be more efficient, may allow for performance of operations that are not supported by the VMs 6708A-C and/or the hypervisors 6706A-C, etc.

OS virtualization is also referred to herein as container virtualization. As used herein, OS virtualization refers to a system in which processes are isolated in an OS (e.g., the host OS 6704A-c, a guest OS, etc.). In a typical OS virtualization system, the host OS 6704A-C is installed on the server hardware (e.g., hardware of the servers 6702A-C). Additionally and/or alternatively, the host OS 6704A-C may be installed in the VMs 6708A-C of a full virtualization environment or a paravirtualization environment. The host OS 6704A-C of an OS virtualization system is configured (e.g., utilizing a customized kernel) to provide isolation and resource management for processes that execute within the host OS 6704A-C (e.g., applications that execute on the host OS 6704A-C). The isolation of the processes is known as a container. Thus, a process executes within a container that isolates the process from other processes executing on the host OS 6704A-C. Thus, OS virtualization provides isolation and resource management capabilities without the resource overhead utilized by a full virtualization environment or a paravirtualization environment.

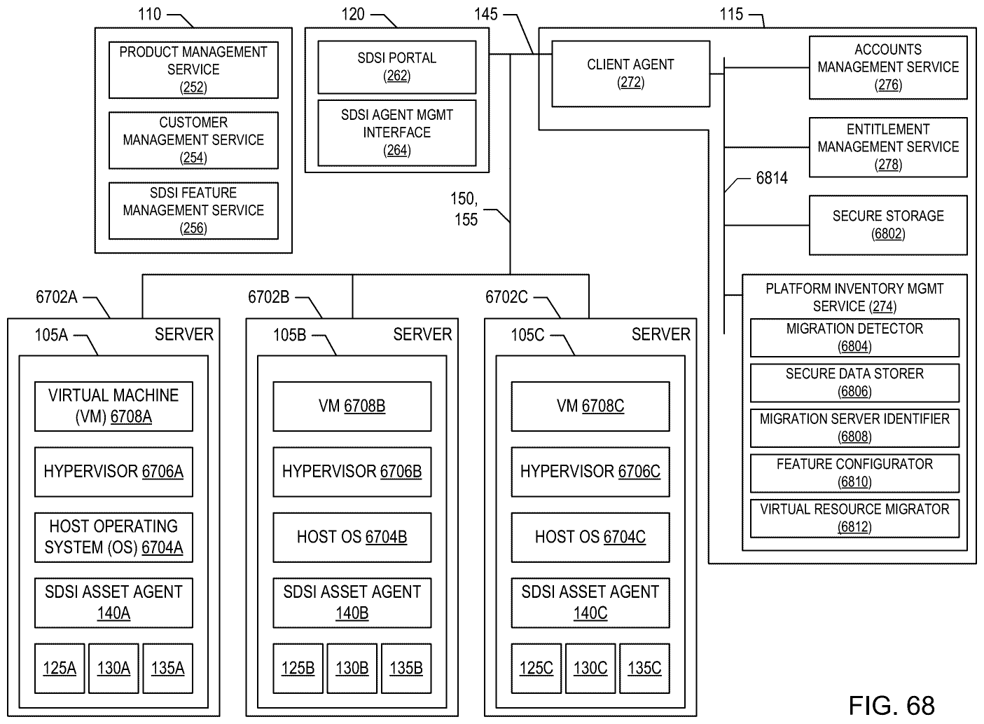

FIG. 68 is a block diagram of an example implementation of the SDSi system 6700 of FIG. 67, which includes example implementations of the SDSi silicon products 105A-C, the manufacturer enterprise system 110, the customer enterprise system 115, and the cloud platform 120.

The illustrated example of FIG. 68 includes the servers 6702A-C of FIG. 67. The manufacturer enterprise system 110 of the illustrated example of FIG. 68 includes the product management service 252, the customer management service 254, and the SDSi feature management service 256 of FIG. 2. The cloud platform 120 of the illustrated example of FIG. 68 includes the SDSi portal 262 and the SDSi agent management interface 264 (identified by SDSI AGENT MGMT INTERFACE) of FIG. 2.

The customer enterprise system 115 of the illustrated example of FIG. 68 includes the client agent 272, the accounts management service 276, and the entitlement management service 278 of FIG. 2. The customer enterprise system 115 of the illustrated example of FIG. 68 includes example secure storage 6802 and an example implementation of the platform inventory management service 274 (identified by PLATFORM INVENTORY MGMT SERVICE) of FIG. 2. In the illustrated example of FIG. 68, the client agent 272, the platform inventory management service 274, the accounts management service 276, the entitlement management service 278, and the secure storage 6802 are in communication with one(s) of each other via an example bus 6814. For example, the bus 6814 can be implemented by at least one of an Inter-Integrated Circuit (I2C) bus, a Serial Peripheral Interface (SPI) bus, a Peripheral Component Interconnect (PCI) bus, or a Peripheral Component Interconnect Express (PCIe or PCIE) bus. Additionally or alternatively, the bus 6814 can be implemented by any other type of computing or electrical bus. In some examples, the bus 6814 can be implemented by software communication link(s), such as application programming interface(s) (API(s)), network(s), or any other type of software interface(s).

The secure storage 6802 of the illustrated example is hardware, software, and/or firmware that can store data and restrict access to the data by unauthorized and/or unverified hardware, software, and/or firmware. For example, the secure storage 6802 can be cryptographically protected to restrict and/or otherwise prevent access by unauthorized and/or unverified entities. In some examples, the secure storage 6802 is a trusted execution environment (TEE) in which secure application code can be executed and/or data of interest (e.g., silicon product manufacturer owned cryptographical data) can be protected. A TEE is a compute or computing execution context wherein resources, such as process data, memory, storage, input(s)/output(s) (I/O(s)), etc., are isolated and protected from untrusted and/or unauthorized access. In some examples, the TEE can take the form of an entire operating system or portion(s) thereof, such as application code running or executing in an isolated environment, such as that provided by Intel® Software Guard Extensions (SGX). In some examples, the TEE is a hardware or hardware-based TEE, a software or software-based TEE, or any combination(s) thereof.

In some examples, the secure storage 6802 can be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The secure storage 6802 may additionally or alternatively be implemented by one or more double data rate (DDR) memories, such as DDR, DDR2, DDR3, DDR4, DDR5, mobile DDR (mDDR), DDR SDRAM, etc. The secure storage 6802 may additionally or alternatively be implemented by one or more mass storage devices such as hard disk drive(s) (HDD(s)), compact disk (CD) drive(s), digital versatile disk (DVD) drive(s), solid-state disk (SSD) drive(s), Secure Digital (SD) card(s), CompactFlash (CF) card(s), etc. While in the illustrated example the secure storage 6802 is illustrated as a single instance of the secure storage 6802, the secure storage 6802 may be implemented by any number and/or type(s) of secure storage. Furthermore, the data stored in the secure storage 6802 may be in any data format such as, for example, binary data, comma delimited data, tab delimited data, structured query language (SQL) structures, etc.

The customer enterprise system 115 includes the platform inventory management service 274 to manage the platforms offered by the customer (OEM), such as platforms that include the SDSi semiconductor devices 105A-C. For example, the platform inventory management service 274 can deploy, commission, configure, manage, and/or instantiate one(s) of the servers 6702A-C, or portion(s) thereof, such as one(s) of the VMs 6708A-C. In some examples, the platform inventory management service 274 can decommission, disable, lock, and/or deactivate one(s) of the servers 6702A-C, or portion(s) thereof, such as one(s) of the VMs 6708A-C. The platform inventory management service 274 of the illustrated example of FIG. 68 includes an example migration detector 6804, an example secure data storer 6806, an example migration server identifier 6808, an example feature configurator 6810, and an example virtual resource migrator 6812.

The platform inventory management service 274 includes the migration detector 6804 to determine whether to migrate a virtual resource, such as a VM or a container, executing a workload on a first server with first features. For example, the migration detector 6804 can receive a request (e.g., a request from the accounts management service 276, the entitlement management service 278, the manufacturer enterprise system 110 via the client agent 272, etc.) to migrate the first VM 6708A from the first server 6702A to the second server 6702B. In some examples, the migration detector 6804 can determine to migrate the first VM 6708A in response to a determination to upgrade the first VM 6708A (e.g., from a first software version to a second version), the first host OS 6704A (e.g., from a first OS version to a second OS version), the first hardware circuitry 125A (e.g., from a first hardware version to a second hardware version), the first firmware 130A (e.g., from a first firmware version to a second firmware version), the first BIOS 135A (e.g., from a first BIOS version to a second BIOS version), etc., and/or any combination(s) thereof.

In some examples, the migration detector 6804 can determine to migrate the first VM 6708A based on a determination to improve execution of a workload. For example, the migration detector 6804 can determine to migrate the first VM 6708A from the first server 6702A to the second server 6702B because the second server 6702B can execute the workload in less time and/or with reduced resources (e.g., hardware, software, and/or firmware, compute resources, memory resources, storage resources, etc.) with respect to the first server 6702A. In some examples, the migration detector 6804 can identify the first VM 6708A as a candidate for migration based on an output from an AI/ML model as described herein. For example, the migration detector 6804 can execute an AI/ML model with first features of the first hardware circuitry 125A, the first firmware 130A, the first BIOS 135A, etc., as first model input(s), second features of the second hardware circuitry 125B, the second firmware 130B, the second BIOS 135B, etc., as second model input(s), etc., to generate model output(s), which can include the determination to move and/or otherwise migrate the first VM 6708A from the first server 6702A to the second server 6702B. For example, the model output(s) can include a first time of execution for the first server 6702A to complete a workload and a second time of execution for the second server 6702B to complete the workload. In some examples, the migration detector 6804 can determine to migrate the first VM 6708A in response to a determination that the second time of execution is less than the first time of execution and/or a migrate time (e.g., a time duration to migrate the first VM 6708A).

In some examples, the migration detector 6804 can determine that there may be SDSi configuration(s) that can improve workload execution performance, but none of the servers 6702A-C are configured with the SDSi configuration(s). In some examples, the migration detector 6804 can effectuate the SDSi configuration(s) by way of (i) temporarily migrating a VM (e.g., the first VM 6708) from a first server (e.g., the first server 6702A) to a second server (e.g., the second server 6702B); (ii) reconfiguring the first server to the SDSi configuration(s); and (iii) migrating the VM back to the now reconfigured first server. In some examples, the migration detector 6804 can effectuate the SDSi configuration(s) by way of (i) reconfiguring a second server (e.g., the second server 6702B) to the SDSi configuration(s); and (ii) migrating a VM (e.g., the first VM 108A) from a first server (e.g., the first server 6702A) to the second server.

The platform inventory management service 274 includes the secure data storer 6806 to store data associated with the first server 6702A in the secure storage 6802, the data including at least one of the first features, a license, or a VM state associated with the first server 6702A. For example, the secure data storer 6806 can capture a snapshot of state(s) associated with the first server 6702A. In some examples, the state(s) can include an identification of SDSi feature(s) enabled by the first hardware circuitry 125A, the first firmware 130A, and/or the first BIOS 135A. For example, the state(s) can include a configuration of one(s) of the first hardware circuitry 125A, the first firmware 130A, and/or the first BIOS 135A. In some examples, the secure data storer 6806 can store license(s) associated with the SDSi feature(s) enabled by the first hardware circuitry 125A, the first firmware 130A, and/or the first BIOS 135A.

In some examples, the secure data storer 6806 can store a state of the first hardware circuitry 125A, which can include value(s) of digital circuitry (e.g., flip-flop(s), register(s), latch(es), etc.) value(s) of hardware counter(s), etc., and/or any combination(s) thereof. In some examples, the secure data storer 6806 can store a state of the first host OS 6704A, which can include a version of the OS implemented by the first host OS 6704A, value(s) of software register(s), type(s) of kernel(s) utilized, value(s) of software counter(s), etc., and/or any combination(s) thereof. In some examples, the secure data storer 6806 can capture a state of the first hypervisor 6706A, which can include a version of the first hypervisor 6706A, value(s) of software register(s), type(s) of kernel(s) utilized, value(s) of software counter(s), etc., and/or any combination(s) thereof. In some examples, the secure data storer 6806 can store a state of the first VM 6708A, which can include a version of an application being executed by the first VM 6708A, value(s) of software register(s), type(s) of kernel(s) utilized, value(s) of software counter(s), a progress of a workload being executed (e.g., a percentage of a workload being completed, an identification of which portion(s) of a workload are complete versus not complete, etc.), etc., and/or any combination(s) thereof.

The platform inventory management service 274 includes the migration server identifier 6808 to identify a server with second features configurable to ones of the first features associated with the first server 6702A. By way of example, the migration server identifier 6808 can determine that the first hardware circuitry 125A has one or more first features enabled (e.g., a type of hardware accelerator enabled, a number of cores of multi-core processor circuitry enabled, etc.). The migration server identifier 6808 can determine that the second server 6702B and/or the third server 6702C can implement the one or more first features. For example, the migration server identifier 6808 can determine that the second hardware circuitry 125B is configured to implement the one or more first features and/or is configurable to implement the one or more first features. For example, the migration server identifier 6808 can determine that the second hardware circuitry 125B has a first configuration that cannot implement the one or more first features and can be changed via SDSi techniques described herein to a second configuration that can implement the one or more first features.

In some examples, the migration server identifier 6808 identifies a server with second features that are different from ones of the first features associated with the first server 6702A, but can yield better performance for a workload in process by the first server 6702A. By way of example, the migration server identifier 6808 can determine that the first hardware circuitry 125A has one or more first features enabled (e.g., a type of hardware accelerator enabled, a number of cores of multi-core processor circuitry enabled, etc.). The migration server identifier 6808 can determine that the second server 6702B is configurable for one or more second features, which can be different from the one or more first features. In some examples, the one or more second features can execute a workload in process by the first hardware circuitry 125A with improved efficiency, performance, etc., when compared to the one or more first features utilized by the first hardware circuitry 125A.

The platform inventory management service 274 includes the feature configurator 6810 to configure and/or reconfigure a server based on the first features. For example, the feature configurator 6810 can configure/reconfigure one(s) of the hardware circuitry 125A-C, the firmware 130A-C, the BIOS 135A-C, the SDSi asset agents 140A-C, the host OS 6704A-C, the hypervisors 6706A-C, the VMs 6708A-C, and/or, more generally, the servers 6702A-C, via SDSi technique(s) as described herein. For example, the feature configurator 6810 can unlock/lock (e.g., enable/disable) a feature of the first hardware circuitry 125A, the first firmware 6730A, the first BIOS 135A, etc., using SDSi technique(s) as described herein.

In some examples, the feature configurator 6810 can upgrade (or downgrade) one(s) of the hardware circuitry 125A-C, the firmware 130A-C, the BIOS 135A-C, the SDSi asset agents 140A-C, the host OS 6704A-C, the hypervisors 6706A-C, the VMs 6708A-C, and/or, more generally, the servers 6702A-C. For example, the feature configurator 6810 can upgrade (or downgrade) and/or otherwise change a version of the first firmware 130A from a first firmware version to a second firmware version. In some examples, the feature configurator 6810 can upgrade (or downgrade) and/or otherwise change a version of the first host OS 6704A from a first OS version to a second OS version. In some examples, the feature configurator 6810 can upgrade (or downgrade) and/or otherwise change a version of the first hypervisor 6706A from a first hypervisor version to a second hypervisor version. In some examples, the feature configurator 6810 can upgrade (or downgrade) and/or otherwise change a version of the first VM 6708A (or application(s) executing thereon) from a first version (e.g., a first VM version, a first application version, etc.) to a second version (e.g., a second VM version, a second application version, etc.).

The platform inventory management service 274 includes the virtual resource migrator 6812 to migrate a virtual resource, such as a VM, a container, etc., from a first server to a second server. In some examples, the virtual resource migrator 6812 can implement a cross virtual resource migration, where the changes in resources affect a workload, and where the workload parameters, OS parameters, system and/or ingredient features, parameters, and/or license agreements are extracted and recreated (e.g., recreated exactly, precisely, substantially identical, etc.) on a different virtual resource instance. By way of example, the virtual resource migrator 6812 can shut down, decommission, and/or otherwise cease operation of the first VM 6708A on the first server 6702A. In some examples, in response to shutting down the first VM 6708A, the virtual resource migrator 6812 can instantiate, commission, and/or otherwise spin up the first VM 6708A on the second server 6702B. For example, the virtual resource migrator 6812 can run the first VM 6708A on the second hypervisor 6706B. In some examples, the first VM 6708A on the second hypervisor 6706B can be implemented by the second VM 6708B of the illustrated example of FIG. 68.

In some examples, the virtual resource migrator 6812 can configure the first VM 6708A based on feature(s) associated with the first VM 6708A (e.g., a type of application to execute, a version of the application, a type/version of a software driver, a type/version of a kernel, etc.) stored in the secure storage 6802. In some examples, the virtual resource migrator 6812 can deploy and/or otherwise install one or more licenses associated with the first VM 6708A, and/or, more generally, the first server 6702A, on the second server 6702B to enable the feature(s) associated with the first VM 6708A.

In some examples, the virtual resource migrator 6812 can execute the workload on the first VM 6708A on the second server 6702B based on at least one of the feature(s), the license(s), or the state of the first VM 6708A. For example, in response to a migration of the first VM 6708A, or portion(s) thereof, from the first server 6702A to the second server 6702B, the virtual resource migrator 6812 can cause execution of the workload by resuming execution of the workload at the point the workload was previously halted on the first server 6702A. In some examples, the virtual resource migrator 6812 can migrate the first VM 6708A from the second server 6702B back to the first server 6702A (or a different server such as the third server 6702C). For example, in response to a change, an upgrade, etc., to the first server 6702A (or portion(s) thereof), the virtual resource migrator 6812 can migrate the first VM 6708A back to the first server 6702A (or a different server such as the third server 6702C).

In some examples, the virtual resource migrator 6812 can implement an in-place migration of a virtual resource. For example, the virtual resource migrator 6812 can increase (or decrease) system resources to meet and/or otherwise satisfy workload requirements whereby the system resources are changed, the kernel can accept the changes and make the new system resources available to the workload without a system reset, kernel space interruption, etc. By way of example, the virtual resource migrator 6812 can increase (or decrease) resources of a server, such as the first server 6702A, to meet requirements of a workload. In some examples, the virtual resource migrator 6812 can pause and/or otherwise cease execution of a workload by the first VM 6708A. In some examples, the virtual resource migrator 6812 can shut down the first VM 6708A instantiated by a first core of multi-core processor circuitry of the first hardware circuitry 125A. In some examples, the secure data storer 6806 can store aspect(s), configuration(s), snapshot(s), etc., of the first VM 6708A in the secure storage 6802. In some examples, the virtual resource migrator 6812 can instantiate and/or otherwise start up the first VM 6708A on a second core of the multi-core processor circuitry. In some examples, the virtual resource migrator 6812 can configure the first VM 6708A based on the stored aspect(s), configuration(s), snapshot(s), etc., of the first VM 6708A stored in the secure storage 6802. In some examples, the virtual resource migrator 6812 can resume execution of the workload on the first VM 6708A after the migration of the first VM 6708A from the first core to the second core of the multi-core processor circuitry of the first hardware circuitry 125A. For example, the virtual resource migrator 6812 can resume hardware counter(s), software counter(s), etc., associated with execution of the workload on the first VM 6708A.

In some examples, the virtual resource migrator 6812 can implement a cross platform migration (e.g., a cross platform virtual resource migration). A cross platform migration can occur where the changes in system resources may affect multiple workloads that are in relationship (e.g., strict relationship, direct connection, a hierarchical relationship, etc.) with one(s) of each other. For example, the virtual resource migrator 6812 can implement a cross platform migration by evaluating movement of multiple virtual resources and/or workloads and generate a migration plan, sequence, etc., for the new placement with either one or more in-place migrations and/or one or more cross virtual resource migrations as described above.

By way of example, the virtual resource migrator 6812 can identify a migration of the first VM 6708A to the third server 6702C. In some examples, the virtual resource migrator 6812 can identify a dependency, a relationship, etc., between a first workload of the first VM 6708A and a second workload of the second VM 6708B. For example, first output(s) of the first workload can be provided to the second workload as input(s) to generate second output(s). In some examples, the virtual resource migrator 6812 can pause and/or otherwise cease execution of the first workload by the first VM 6708A and/or the second workload by the second VM 6708B. In some examples, the virtual resource migrator 6812 can shut down the first VM 6708A instantiated by the first VM 6708A. In some examples, the secure data storer 6806 can store aspect(s), configuration(s), snapshot(s), etc., of the first VM 6708A in the secure storage 6802. For example, the aspect(s), configuration(s), snapshot(s), etc., can include the dependency, the relationship, etc., between the first workload and the second workload and correspondingly between the first VM 6708A and the second VM 6708B. In some examples, the virtual resource migrator 6812 can instantiate and/or otherwise start up the first VM 6708A on the third hypervisor 6706C. For example, the first VM 6708A on the third hypervisor 6706C can implement the third VM 6708C of the illustrated example of FIG. 68. In some examples, the virtual resource migrator 6812 can configure the first VM 6708A on the third hypervisor 6706C based on the stored aspect(s), configuration(s), snapshot(s), etc., of the first VM 6708A stored in the secure storage 6802. In some examples, the virtual resource migrator 6812 can resume execution of the first workload and/or the second workload after the migration of the first VM 6708A from the first server 6702A to the third server 6702C. For example, the virtual resource migrator 6812 can resume hardware counter(s), software counter(s), etc., associated with execution of the first workload and/or the second workload.

Advantageously, the virtual resource migrator 6812, and/or, more generally, the platform inventory management service 274, can ensure that during migration of virtual resource(s), the state(s) of the virtual resource(s) is/are preserved and the license term(s) and condition(s) are transferred and/or otherwise validated according to the overall contract agreement with a customer associated with the customer enterprise system 115. For example, the virtual resource migrator 6812, and/or, more generally, the platform inventory management service 274, can maintain and/or otherwise preserve the same state(s) of workload(s) during the entire operation and ensure that both the workload runtime(s) and the licensing provision(s) and measurement(s) are maintained without interruption and/or otherwise reduced downtime.

While an example manner of implementing the customer enterprise system 115 of FIGS. 1 and/or 67 is illustrated in FIG. 68, one or more of the elements, processes, and/or devices illustrated in FIG. 68 may be combined, divided, re-arranged, omitted, eliminated, and/or implemented in any other way. Further, the example client agent 272, the example platform inventory management service 274, the example accounts management service 276, the example entitlement management service 278, the example secure storage 6802, the example migration detector 6804, the example secure data storer 6806, the example migration server identifier 6808, the example feature configurator 6810, the example virtual resource migrator 6812, the example bus 6814, and/or, more generally, the example customer enterprise system 115 of FIGS. 1 and/or 67, may be implemented by hardware alone or by hardware in combination with software and/or firmware. Thus, for example, any of the example client agent 272, the example platform inventory management service 274, the example accounts management service 276, the example entitlement management service 278, the example secure storage 6802, the example migration detector 6804, the example secure data storer 6806, the example migration server identifier 6808, the example feature configurator 6810, the example virtual resource migrator 6812, the example bus 6814, and/or, more generally, the example customer enterprise system 115, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example customer enterprise system 115 of FIGS. 1 and/or 67 may include one or more elements, processes, and/or devices in addition to, or instead of, those illustrated in FIG. 68, and/or may include more than one of any or all of the illustrated elements, processes and devices.

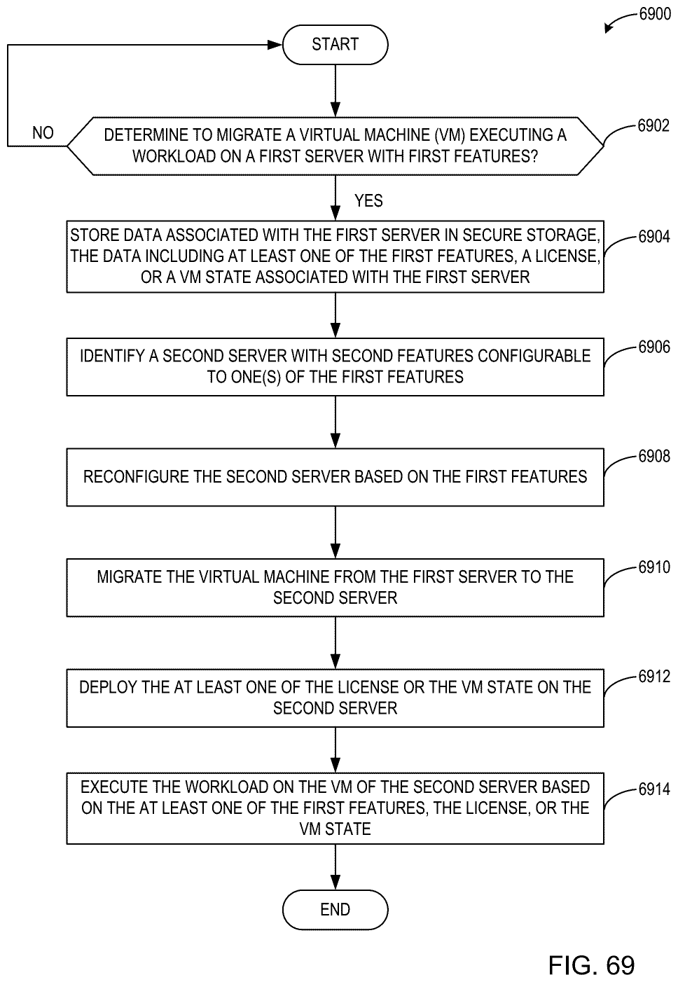

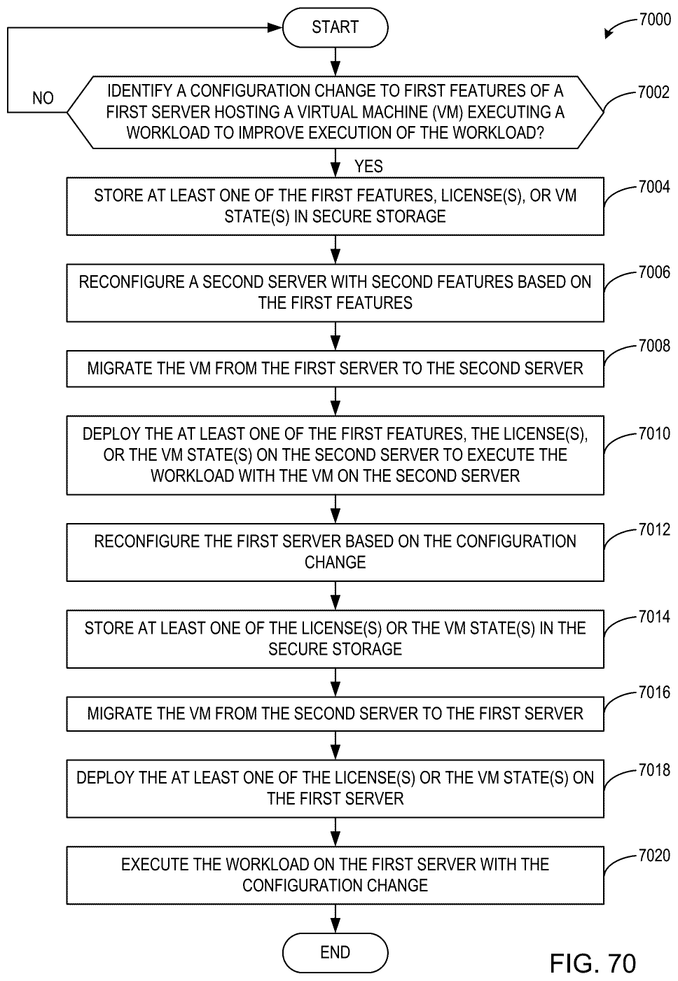

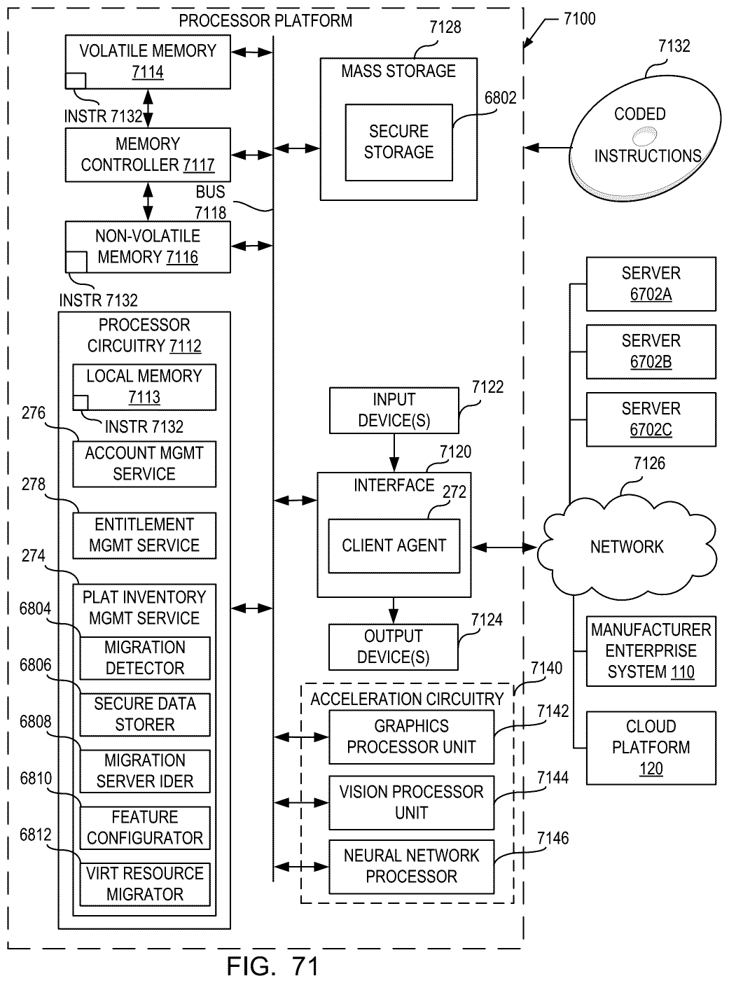

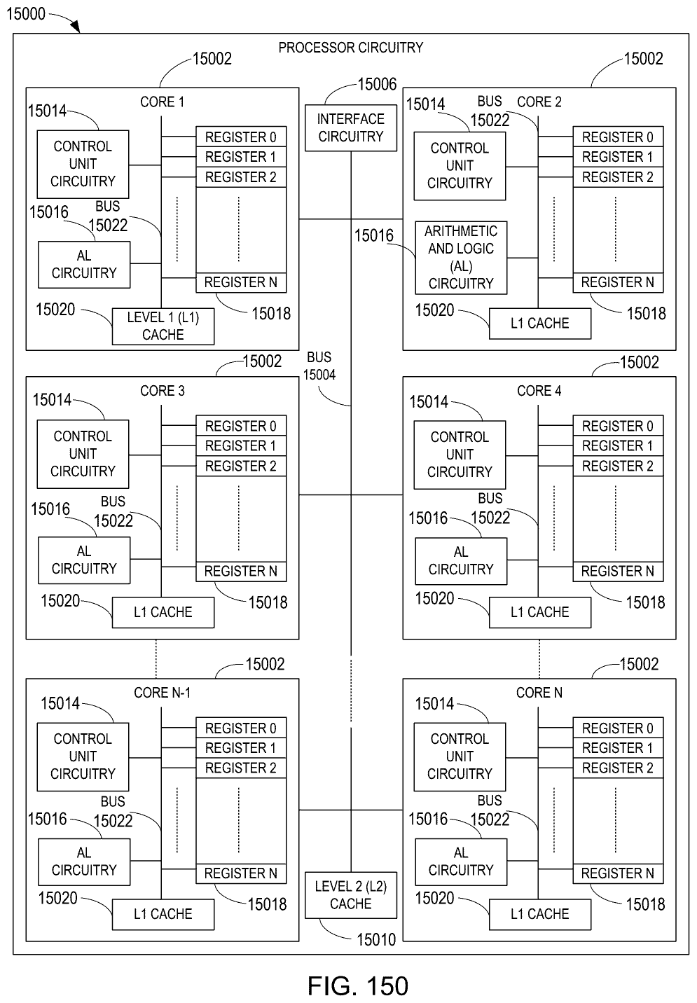

Flowcharts representative of example machine readable instructions which may be executed to configure processor circuitry to implement the example customer enterprise system 115 of FIGS. 1, 67, and/or 68, and/or, more generally, the SDSi system 6700 of FIG. 68, are shown in FIGS. 69-70. The machine readable instructions may be one or more executable programs or portion(s) of an executable program for execution by processor circuitry, such as the processor circuitry 7112 shown in the example processor platform 7100 discussed below in connection with FIG. 71 and/or the example processor circuitry discussed below in connection with FIGS. 150 and/or 151. The program may be embodied in software stored on one or more non-transitory computer readable storage media such as a CD, a floppy disk, an HDD, an SSD, a DVD, a Blu-ray disk, a volatile memory (e.g., RAM of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device) Similarly, the non-transitory computer readable storage media may include one or more mediums located in one or more hardware devices. Further, although the example program is described with reference to the flowcharts illustrated in FIGS. 69-70, many other methods of implementing the example customer enterprise system 115 of FIGS. 1, 67, and/or 68, and/or, more generally, the SDSi system 6700 of FIG. 68, may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 69-70 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 69 is a flowchart representative of example machine readable instructions and/or example operations 6900 that may be executed and/or instantiated by processor circuitry to migrate a virtual resource, such as a VM. Additionally and/or alternatively, the example machine readable instructions and/or the example operations 6900 may be executed and/or instantiated by processor circuitry to migrate a different type of virtual resource, such as a container. The example machine readable instructions and/or the example operations 6900 of FIG. 69 begin at block 6902, at which the customer enterprise system 115 of FIGS. 1, 67, and/or 68 determine whether to migrate a virtual machine (VM) executing a workload on a first server with first features. For example, the migration detector 6804 of FIG. 68 can determine whether to migrate the first VM 6708A from the first server 6702A to the second server 6702B.

If, at block 6902, the customer enterprise system 115 determines not to migrate a virtual machine executing a workload on a first server with first features, control waits at block 6902. If, at block 6902, the customer enterprise system 115 determines to migrate a virtual machine executing a workload on a first server with first features, then, at block 6904, the customer enterprise system 115 stores data associated with the first server in secure storage, the data including at least one of the first features, a license, or a VM state associated with the first server. For example, the secure data storer 6806 of FIG. 68 can capture and/or store one or more first features associated with the first hardware circuitry 125A, the first firmware 6730A, the first BIOS 135A, the first SDSi asset agent 140A, the first host OS 6704A, the first hypervisor 6706A, the first VM 6708A, and/or, more generally, the first SDSi semiconductor device 105A, and/or, more generally, the first server 6702A. In some examples, the secure data storer 6806 can store the one or more features in the secure storage 6802, which can be protected from unauthorized access.

At block 6906, the customer enterprise system 115 identifies a second server with second features configurable to one(s) of the first features. For example, the migration server identifier 6808 of FIG. 68 can identify the second server 6702B as having one or more second features that are in a configuration to implement the one or more first features and/or are configurable to the configuration to implement the one or more first features. In some examples, the migration server identifier 6808 can identify the second server 6702B as having one or more second features that are improvements with respect to the one or more first features when executing a workload. In some examples, the migration server identifier 6808 can identify the second server 6702B as being configured with one or more second features and being configurable for one or more third features, where the one or more third features are improvements over the one or more first features with respect to workload processing. For example, the migration server identifier 6808 can identify the second server 6702B as having a set of features that, although not utilized, may be configurable to the set of features to execute a workload with improved performance with respect to the first server 6702A using the one or more first features to execute the workload.

In some examples, the migration server identifier 6808 can determine that the second server 6702B complies and/or otherwise satisfies a service level agreement (SLA), a resource orchestration policy, etc., associated with the first server 6702A.

At block 6908, the customer enterprise system 115 reconfigures the second server based on the first features. For example, the feature configurator 6810 of FIG. 68 can configure the second hardware circuitry 125B, the second firmware 6730B, the second BIOS 135B, the second SDSi asset agent 140B, the second host OS 6704B, the second hypervisor 6706B, and/or the second VM 6708B based on the one or more first features and/or a recommendation to improve workload processing efficiency. In some examples, the feature configurator 6810 can configure the second hardware circuitry 125B to implement the one or more first features of the first hardware circuitry 125A, and/or, more generally, the first SDSi semiconductor device 105A, and/or, more generally, the first server 6702A.

At block 6910, the customer enterprise system 115 migrates the virtual machine from the first server to the second server. For example, the virtual resource migrator 6812 of FIG. 68 can pause an execution of a workload by the first VM 108A; shut down the first VM 6708A (e.g., release virtual and/or physical hardware resources back to the first server 6702A to be utilized differently); transfer data to the second hypervisor 6706B to instantiate the first VM 6708A on the second hypervisor 6706B; and configure the first VM 6708A based on the stored data in the secure storage 6802.

At block 6912, the customer enterprise system 115 deploys the at least one of the license or the VM state on the second server. For example, the virtual resource migrator 6812 can transfer one or more licenses to the second SDSi asset agent 6740B to enable the one or more first features. In some examples, the virtual resource migrator 6812 can configure the first VM 6708A on the second hypervisor 6706B based on the previously stored state of the first VM 6708A, which can include value(s) of software counter(s), indications of progress of the workload, etc., and/or any combination(s) thereof.

At block 6914, the customer enterprise system 115 executes the workload on the VM of the second server based on the at least one of the first features, the license, or the VM state. For example, the virtual resource migrator 6812 can resume execution of the workload on the first VM 6708a, which has been migrated from the first server 6702A to the second server 6702B. In some examples, the first VM 6708A can resume execution of the workload utilizing the one or more first features, the one or more licenses, and/or the VM state of the first VM 6708A at the time of the pausing of the workload. In response to executing the workload on the VM of the second server based on the at least one of the first features, the license, or the VM state at block 6914, the example machine readable instructions and/or the example operations 6900 of FIG. 69 conclude.

FIG. 70 is a flowchart representative of example machine readable instructions and/or example operations 7000 that may be executed and/or instantiated by processor circuitry to temporarily migrate a virtual resource, such as a VM. Additionally and/or alternatively, the example machine readable instructions and/or the example operations 7000 may be executed and/or instantiated by processor circuitry to temporarily migrate a different type of virtual resource, such as a container. For example, the example machine readable instructions and/or the example operations 7000 may be executed and/or instantiated by processor circuitry to temporarily migrate a VM from a first server to a second server to effectuate a change in the first server before migrating the VM back to the first server and the change to the first server can achieve improved execution of a workload.

The example machine readable instructions and/or the example operations 7000 of FIG. 70 begin at block 7002, at which the customer enterprise system 115 of FIGS. 1, 67, and/or 68 determines whether a configuration change to first features of a first server hosting a virtual machine (VM) executing a workload to improve execution of the workload is identified. For example, the migration detector 6804 of FIG. 68 can determine that the first VM 6708A is executing a workload with first execution parameters, which can include a first time of execution, a first quantity of resources to execute the workload (e.g., a number of gigahertz (GHz) of compute resources, a number of gigabytes (GB) of memory and/or storage, a number of compute cores of multi-core processor circuitry, a number and/or a type of hardware accelerators utilized, etc., and/or any combination(s) thereof), a first measure of power consumption, etc. In some examples, the migration detector 6804 can determine that a change in a configuration of at least one of the first hardware circuitry 125A, the first firmware 130A, the first BIOS 135A, the first host OS 6704A, the first hypervisor 6706A, the first VM 6708A, or the first SDSi asset agent 6740A can improve one or more of the first execution parameters. For example, the migration detector 6804 can determine that a change in feature(s) of the first hardware circuitry 125A can yield second execution parameters associated with the workload, such as a second time of execution less than the first time of execution, a second quantity of resources to execute the workload less than the first quantity of resources, a second measure of power consumption less than the first measure of power consumption, etc., and/or any combination(s) thereof. Advantageously, the migration detector 6804 can determine that a change to one or more portion(s) of the first server 6702A can improve execution of the workload, such as with reduced time of execution, a reduced number of resources to execute the workload, etc.

If, at block 7002, the customer enterprise system 115 does not identify a configuration change to first features of a first server hosting a virtual machine (VM) executing a workload to improve execution of the workload, control waits at block 7002 (e.g., wait for a time period to retrigger the identification process). If, at block 7002, the customer enterprise system 115 identifies a configuration change to first features of a first server hosting a virtual machine (VM) executing a workload to improve execution of the workload, then, at block 7004, the customer enterprise system 115 stores at least one of the first features, license(s), or VM state(s) in secure storage. For example, the secure data storer 6806 of FIG. 68 can capture a snapshot, a state, etc., of the first server 6702A, or portion(s) thereof, and store data representative of the snapshot, the state, etc., in the secure storage 6802 of FIG. 68. In some examples, the secure data storer 6806 can store a configuration (e.g., a list, an identification, etc., of activated and/or deactivated features) of the first hardware circuitry 125A in the secure storage 6802, a license to activate/deactivate the configuration in the secure storage 6802, etc., and/or any combination(s) thereof.

At block 7006, the customer enterprise system 115 reconfigures a second server with second features based on the first features. For example, the migration server identifier 6808 of FIG. 68 can identify the second server 6702B for migration of the first VM 6708A. In some examples, the migration server identifier 6808 can determine that the second server 6702B complies and/or otherwise satisfies an SLA, a resource orchestration policy, etc., associated with the first server 6702A. In some examples, the migration server identifier 6808 can validate that the second server 6702B is configured to and/or configurable to execute the workload associated with the first VM 6708A. In some examples, the feature configurator 6810 of FIG. 68 can reconfigure at least one of the second hardware circuitry 125B, the second firmware 130B, the second BIOS 135B, the second host OS 6704B, the second hypervisor 6706B, the second VM 6708B, or the second SDSi asset agent 6740B to accommodate and/or otherwise match or partially match the configuration of the first server 6702A. For example, the feature configurator 6810 can reconfigure the second hardware circuitry 125B via SDSi techniques as described herein to match or partially match the configuration of the first hardware circuitry 125A.

At block 7008, the customer enterprise system 115 migrates the VM from the first server to the second server. For example, the virtual resource migrator 6812 can migrate the first VM 6708A from the first server 6702A to the second server 6702B. In some examples, the virtual resource migrator 6812 can pause execution of the workload; shut down the first VM 6708A; transfer data associated with the first VM 6708A to the second server 6702B; and instantiate the first VM 6708A on the second hypervisor 6706B.

At block 7010, the customer enterprise system 115 deploys the at least one of the first features, the license(s), or the VM state(s) on the second server to execute the workload with the VM on the second server. For example, the virtual resource migrator 6812 can deploy the stored configuration of the first server 6702A, or portion(s) thereof, to the second server 6702B. For example, the virtual resource migrator 6812 can provide the license to activate/deactivate the configuration to the second SDSi asset agent 140B. In some examples, the virtual resource migrator 6812 can provide the license from the secure storage 6802 or request a new issuance of the license from the manufacturer enterprise system 110. In some examples, the virtual resource migrator 6812 can configure the first VM 6708A on the second hypervisor 6706B based on the stored VM state in the secure storage 6802. In some examples, the first VM 6708A on the second hypervisor 6706B can implement the second VM 6708B in the illustrated example of FIG. 68. For example, the virtual resource migrator 6812 can configure the second VM 6708B to have the same VM state of the first VM 6708A. In some examples, the virtual resource migrator 6812 can configure the second VM 6708B by setting value(s) of software counter(s), value(s) of register(s), configuring kernel(s), etc., and/or any combination(s) thereof based on the VM state stored in the secure storage 6802. In some examples, the virtual resource migrator 6812 can resume execution of the workload on the second VM 6708B.

At block 7012, the customer enterprise system 115 reconfigures the first server based on the configuration change. For example, the feature configurator 6810 can reconfigure at least one of the first hardware circuitry 125A, the first firmware 130A, the first BIOS 135A, the first host OS 6704A, the first hypervisor 6706A, the first VM 6708A, or the first SDSi asset agent 6740A based on the identified configuration change. For example, the feature configurator 6810 can implement and/or otherwise cause a change in feature(s) of the first hardware circuitry 125A to achieve the second execution parameters associated with the workload, such as a second time of execution less than the first time of execution, a second quantity of resources to execute the workload less than the first quantity of resources, etc., and/or any combination(s) thereof. In some examples, the feature configurator 6810 can invoke the first hardware circuitry 125A to change from one or more first features to one or more second features to achieve improved execution of the workload.

At block 7014, the customer enterprise system 115 stores at least one of the license(s) or the VM state(s) in the secure storage. For example, the secure data storer 6806 can store at least one of the license or the VM state associated with the second VM 6708B in the secure storage 6802. The secure data storer 6806 can capture a snapshot, a state, etc., of the second server 6702B, or portion(s) thereof, and store data representative of the snapshot, the state, etc., in the secure storage 6802. For example, the secure data storer 6806 can obtain a current state of execution of the workload so that the workload may be resumed in the same position on the first server 6702A. In some examples, the secure data storer 6806 can store current software counter value(s), register value(s), progress or current position of execution of the workload, etc., in the secure storage 6802.

At block 7016, the customer enterprise system 115 migrates the VM from the second server to the first server. For example, the virtual resource migrator 6812 can migrate the first VM 6708A (e.g., implemented as the second VM 6708B) from the second server 6702B to the first server 6702A. In some examples, the virtual resource migrator 6812 can pause execution of the workload; shut down the first VM 6708A; transfer data associated with the first VM 6708A to the first server 6702A; and instantiate the first VM 6708A on the first hypervisor 6706A.

At block 7018, the customer enterprise system 115 deploys the at least one of the license(s) or the VM state(s) on the first server. For example, the virtual resource migrator 6812 can deploy the stored configuration of the second server 6702B, or portion(s) thereof, to the first server 6702A. For example, the virtual resource migrator 6812 can provide the license to activate/deactivate the configuration to the first SDSi asset agent 140A. In some examples, the virtual resource migrator 6812 can provide the license from the secure storage 6802 or request a new issuance of the license from the manufacturer enterprise system 110. In some examples, the virtual resource migrator 6812 can configure the first VM 6708A on the first hypervisor 6706A based on the stored VM state in the secure storage 6802. For example, the virtual resource migrator 6812 can configure the first VM 6708A to have the same VM state of the first VM 6708A on the second hypervisor 6706B (e.g., the second VM 6708B). In some examples, the virtual resource migrator 6812 can configure the first VM 6708A by setting value(s) of software counter(s), value(s) of register(s), configuring kernel(s), etc., and/or any combination(s) thereof based on the stored VM state in the secure storage 6802.

At block 7020, the customer enterprise system 115 executes the workload on the first server with the configuration change. For example, the virtual resource migrator 6812 can resume execution of the workload on the first VM 6708A. Advantageously, the virtual resource migrator 6812 can cause the first VM 6708A to execute the workload with the second execution parameters as described above, such as with reduced time of execution, reduced quantity of resources to execute the workload, etc. In response to executing the workload on the first server with the configuration change at block 7020, the example machine readable instructions and/or the example operations 7000 of FIG. 70 conclude.

FIG. 71 is a block diagram of an example processor platform 7100 structured to execute and/or instantiate the example machine readable instructions and/or the example operations of FIGS. 69-70 to implement the example customer enterprise system 115 of FIGS. 67 and/or 68. The processor platform 7100 can be, for example, any other type of computing device.

The processor platform 7100 of the illustrated example includes processor circuitry 7112. The processor circuitry 7112 of the illustrated example is hardware. For example, the processor circuitry 7112 can be implemented by one or more integrated circuits, logic circuits, FPGAs, microprocessors, CPUs, GPUs, DSPs, and/or microcontrollers from any desired family or manufacturer. The processor circuitry 7112 may be implemented by one or more semiconductor based (e.g., silicon based) devices. In this example, the processor circuitry 7112 implements the example account management service 276 (identified by ACCOUNT MGMT SERVICE), the example entitlement management service 278 (identified by ENTITLEMENT MGMT SERVICE), the example platform inventory management service 274 (identified by PLAT INVENTORY MGMT SERVICE), the example migration detector 6804, the example secure data storer 6806, the example migration server identifier 6808 (identified by MIGRATION SERVER IDER), the example feature configurator 6810, and the example virtual resource migrator 6812 (identified by VIRT RESOURCE MIGRATOR) of FIGS. 67 and/or 68.

The processor circuitry 7112 of the illustrated example includes a local memory 7113 (e.g., a cache, registers, etc.). The processor circuitry 7112 of the illustrated example is in communication with a main memory including a volatile memory 7114 and a non-volatile memory 7116 by a bus 7118. In some examples, the bus 7118 implements the bus 6814 of FIG. 68. The volatile memory 7114 may be implemented by SDRAM, DRAM, RDRAM®, and/or any other type of RAM device. The non-volatile memory 7116 may be implemented by flash memory and/or any other desired type of memory device. Access to the main memory 7114, 7116 of the illustrated example is controlled by a memory controller 7117.

The processor platform 7100 of the illustrated example also includes interface circuitry 7120. The interface circuitry 7120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In this example, the interface circuitry 7120 implements the example client agent 272 of FIGS. 67 and/or 68.

In the illustrated example, one or more input devices 7122 are connected to the interface circuitry 7120. The input device(s) 7122 permit(s) a user to enter data and/or commands into the processor circuitry 7112. The input device(s) 7122 can be implemented by, for example, an audio sensor, a microphone, a camera (still or video), a keyboard, a button, a mouse, a touchscreen, a track-pad, a trackball, an isopoint device, and/or a voice recognition system.

One or more output devices 7124 are also connected to the interface circuitry 7120 of the illustrated example. The output device(s) 7124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 7120 of the illustrated example, thus, typically includes a graphics driver card, a graphics driver chip, and/or graphics processor circuitry such as a GPU.

The interface circuitry 7120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 7126. The communication can be by, for example, an Ethernet connection, a digital subscriber line (DSL) connection, a telephone line connection, a coaxial cable system, a satellite system, a line-of-site wireless system, a cellular telephone system, an optical connection, etc. In this example, the example servers 6702A-C, the example manufacturer enterprise system 110, and the example cloud platform of FIGS. 67 and/or 68 is/are communicatively coupled to the example processor platform 7100 via the example network 7126.

The processor platform 7100 of the illustrated example also includes one or more mass storage devices 7128 to store software and/or data. Examples of such mass storage devices 7128 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives. In this example, the one or more mass storage devices 7128 implement the example secure storage 6802 of FIG. 68.

The machine readable instructions 7132, which may be implemented by the machine readable instructions of FIGS. 69-70, may be stored in the mass storage device 7128, in the volatile memory 7114, in the non-volatile memory 7116, and/or on a removable non-transitory computer readable storage medium such as a CD or DVD.

The processor platform 7100 of the illustrated example of FIG. 71 includes example acceleration circuitry 7140, which includes an example graphics processing unit (GPU) 7142, an example vision processing unit (VPU) 7144, and an example neural network processor 7146. In this example, the GPU 7142, the VPU 7144, and the neural network processor 7146 are in communication with different hardware of the processor platform 7100, such as the volatile memory 7114, the non-volatile memory 7116, etc., via the bus 7118. In this example, the neural network processor 7146 may be implemented by one or more integrated circuits, logic circuits, microprocessors, GPUs, DSPs, or controllers from any desired family or manufacturer that can be used to execute an AI/ML model, such as a neural network, which may be implemented by AI/ML model(s) as described herein. In some examples, one or more of the account management service 276, the entitlement management service 278, the platform inventory management service 274, the migration detector 6804, the secure data storer 6806, the migration server identifier 6808, the feature configurator 6810, and/or the virtual resource migrator 6812 can be implemented by at least one of the GPU 7142, the VPU 7144, or the neural network processor 7146 instead of or in addition to the processor circuitry 7112.

Systems, Apparatus, Articles of Manufacture, and Methods for Resource Configuration Management Using Software-Defined Silicon

Executing workloads in distributed and/or virtualized computing environments provides benefits such as allocating resources (e.g., physical hardware resources, virtualizations of the physical hardware resources, etc.) and/or deallocating resources to achieve execution of workload(s) (e.g., application(s), compute workload(s), etc.) based on a service level agreement (SLA), an orchestration policy (e.g., a resource orchestration policy), requirement(s) of the workload(s), etc., and/or any combination(s) thereof. A system (e.g., a computing system, a workload execution system, etc.) may have an availability of ingredients, new features or capabilities, etc., to achieve the execution of the workload(s) to satisfy the SLA, the orchestration policy, etc., but a lack of information and insight on when to allocate/deallocate resources may lead to suboptimal and/or otherwise reduced efficiency when executing the workload(s). For example, a system (or Information Technology (IT) personnel associated with the system) may lack forecasting and/or prediction capabilities to identify possible or future requirements to execute the workload(s), upcoming system fault(s) due to hardware exceeding reliability metrics or parameters, etc., and/or any combination(s) thereof, can lead to manual changes to the system. In some instances, manually identifying hardware and change(s) thereof to improve workload execution can be time consuming and inefficient and may lead to suboptimal workload execution.

Examples disclosed herein include systems, apparatus, articles of manufacture, and methods for resource configuration management using software-defined silicon (SDSi). In some disclosed examples, SDSi techniques can be used to upgrade and/or unlock dormant resource capacity (e.g., unused core(s) of multi-core processor circuitry, unused hardware accelerators, unused virtualized memory, etc.) based on output(s) from machine learning (ML) models. For example, one or more ML models can be executed using telemetry data as ML model input(s). In some disclosed examples, the telemetry data can be associated with execution of workload(s) by semiconductor device(s), which can include configurable circuitry to activate/deactivate features of the semiconductor device(s). In some disclosed examples, the telemetry data can include workload telemetry data (e.g., characteristic(s) or fingerprint(s) of a workload, a workload sequence including a plurality of workloads, current progress of execution of a workload, etc.), semiconductor telemetry data (e.g., resource utilization(s), activated/deactivated feature(s), etc.), etc. In some disclosed examples, the telemetry data can include data associated with at least one of a semiconductor device, a server including the semiconductor device, or a platform (e.g., an enterprise platform, a cloud platform, a compute platform, etc.) including the server.

In some disclosed examples, the one or more ML models can output a characterization, a classification, or a profile of a workload to determine how to optimally (e.g., improve) execute the workload. For example, the one or more ML models can classify a workload as a compute-intensive workload that may require a quantity of compute resources executing in parallel to achieve optimal and/or otherwise improved workload execution. In some disclosed examples, the one or more ML models can output a proposal, a recommendation, a suggestion, etc., of change(s) to feature(s) of a semiconductor device to improve execution of the workload. For example, the recommendation can include unlocking/activating dormant resources to reduce latency, increase throughput, etc., when executing the workload. In some disclosed examples, the recommendation can include locking/deactivating resources that are idle and/or otherwise underutilized to reduce power consumption.

In some disclosed examples, the recommendation can include migrating execution of a workload from a first resource (e.g., a virtual resource such as a virtual machine (VM) or container) to a second resource. For example, the one or more ML models can determine that the workload can be executed with improved efficiency with a first semiconductor device having one or more features. In some disclosed examples, in response to a determination that the first semiconductor device is not configurable for the one or more features, the one or more ML models can identify a second semiconductor device that is configurable for the one or more features. In some disclosed examples, the second semiconductor device can be configured based on the one or more features. For example, the workload can be transferred and/or otherwise migrated from the first semiconductor device to the second semiconductor device. Advantageously, in some disclosed examples, the second semiconductor device can execute the workload utilizing the one or more features with increased efficiency, increased throughput, reduced latency, reduced time of execution, etc., and/or any combination(s) thereof, with respect to the first semiconductor device executing the workload without utilizing the one or more features.

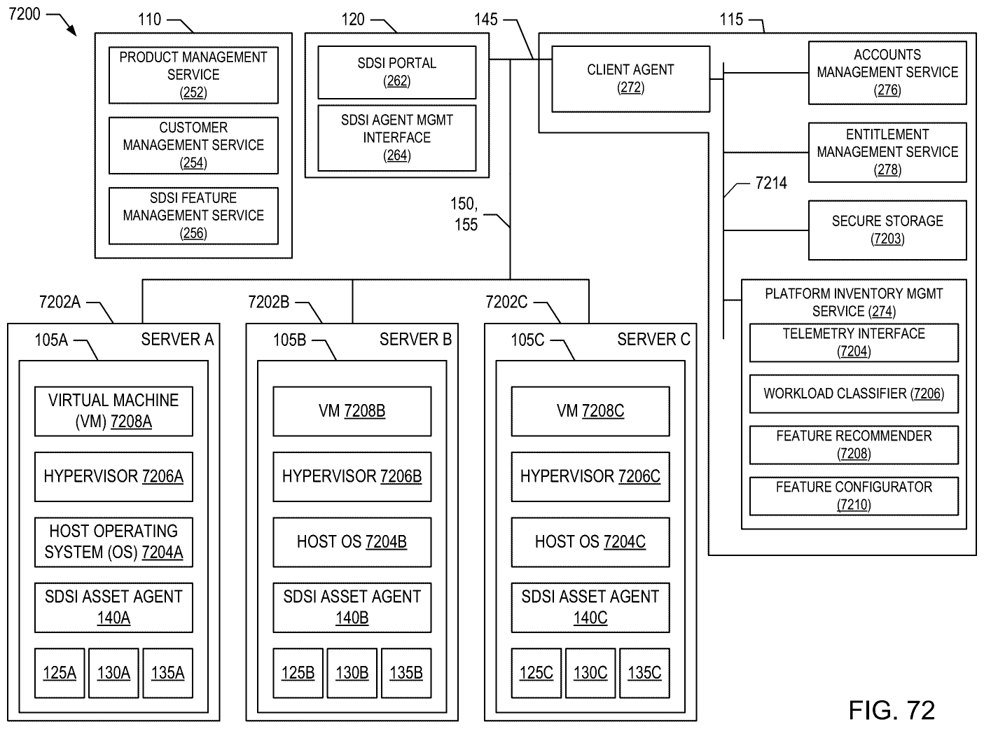

FIG. 72 is a block diagram of an example system (e.g., an SDSi system) 7200 to implement and manage SDSi products in accordance with teachings of this disclosure. The SDSi system 7200 of the illustrated example of FIG. 72 includes a plurality of the example silicon products 105 of FIG. 1 (e.g., a plurality of the SDSi semiconductor devices 105 of FIG. 1, a plurality of the semiconductor assets 105 of FIG. 1, etc.), such as the silicon products 105A-C of FIG. 49. The silicon products 105A-C include respective instantiations of the SDSi asset agent 140 of FIG. 1, such as the SDSi asset agents 140A-C of FIG. 49. The silicon products 105A-C include respective instantiations of the hardware circuitry 125 of FIG. 1, such as first example hardware circuitry 125A, second example hardware circuitry 125B, and third example hardware circuitry 125C. The silicon products 105A-C include respective instantiations of the firmware 130 of FIG. 1, such as first example firmware 130A, second example firmware 130B, and third example firmware 130C. The silicon products 105A-C include respective instantiations of the BIOS 135 of FIG. 1, such as a first example BIOS 135A, a second example BIOS 135B, and a third example BIOS 135C.

The SDSi asset agents 140A-C of the example of FIG. 72, and/or, more generally, the semiconductor products 105A-C of the example of FIG. 49, implement SDSi features as disclosed herein. The SDSi system 7200 also includes the example manufacturer enterprise system 110 of FIGS. 1 and/or 49 and the example customer enterprise system 115 of FIGS. 1 and/or 49 to manage the SDSi asset agents 140A-C of FIG. 49, and/or, more generally, the semiconductor products 105A-C of FIG. 49. In the illustrated example of FIG. 72, at least some aspects of the manufacturer enterprise system 110 and/or the customer enterprise system 115 are implemented as cloud services in the example cloud platform 120 of FIGS. 1 and/or 49.

In the illustrated example of FIG. 72, the manufacturer enterprise system 110 is in communication with the customer enterprise system 115 via a cloud service implemented by the cloud platform 120 (represented by the line labeled 145 of FIGS. 1 and/or 49). In the illustrated example of FIG. 72, the SDSi semiconductor devices 105A-C are in communication with the manufacturer enterprise system 110 via a cloud service implemented by the cloud platform 120 (represented by the line labeled 150 of FIGS. 1 and/or 49). In the illustrated example of FIG. 72, the SDSi semiconductor devices 105A-C are in communication with the customer enterprise system 115 via a cloud service implemented by the cloud platform 120 (represented by the line labeled 155 of FIGS. 1 and/or 49).

In the illustrated example of FIG. 72, the SDSi system 7200 includes example servers 7202A-C, such as a first example server 7202A, a second example server 7202B, and a third example server 7202C. For example, the servers 7202A-C can be computer servers, electronic servers, etc., that include one or more of the SDSi semiconductor devices 105A-C and/or other hardware, such as accelerator(s), network interface(s), memory (e.g., volatile memory, non-volatile memory, etc.), memory controller(s), mass storage device(s), bus(es), input device(s), output device(s), etc., and/or any combination(s) thereof. In the illustrated example of FIG. 72, the servers 7202A-C include a respective one of the SDSi semiconductor devices 105A-C. Alternatively, one or more of the servers 7202A-C may include more than one of the SDSi semiconductor devices 105A-C. In some examples, one(s) of the servers 7202A-C is/are referred to herein as customer servers (e.g., customer enterprise servers). In some examples, one(s) of the servers 7202A-C is/are referred to herein as host servers. In some examples, one(s) of the servers 7202A-C is/are virtualized servers instantiated by respective one(s) of the hardware circuitry 125A-C, the firmware 130A-C, and/or the BIOS 135A-C.

In the illustrated example of FIG. 72, the SDSi semiconductor devices 105A-C include respective instantiations of an example host operating system (OS) 7204A-C, such as a first example host OS 7204A, a second example host OS 7204B, and a third example host OS 7204C. In the illustrated example of FIG. 72, the SDSi semiconductor devices 105A-C include respective instantiations of an example hypervisor 7206A-C, such as a first example hypervisor 7206A, a second example hypervisor 7206B, and a third example hypervisor 7206C. In the illustrated example of FIG. 72, the SDSi semiconductor devices 105A-C include respective instantiations of an example virtual machine (VM) 7208A-C, such as a first example VM 7208A, a second example VM 7208B, and a third example VM 7208C.

In some examples, the hypervisors 7206A-C can implement a virtualization platform, service, etc., for a type of virtualization environment. In some examples, the SDSi system 7200 can be implemented by a full virtualization environment, a paravirtualization environment, and/or an OS virtualization environment as described herein.

The manufacturer enterprise system 110 of the illustrated example of FIG. 72 includes the product management service 252, the customer management service 254, and the SDSi feature management server 256 of FIG. 2. The cloud platform 120 of the illustrated example of FIG. 72 includes the SDSi portal 262 and the SDSi agent management interface 264 (identified by SDSI AGENT MGMT INTERFACE) of FIG. 2.

The customer enterprise system 115 of the illustrated example of FIG. 72 includes the client agent 272, the accounts management service 276, and the entitlement management service 278 of FIG. 2. The customer enterprise system 115 of the illustrated example of FIG. 72 includes example secure storage 7203 and an example implementation of the platform inventory management service 274 (identified by PLATFORM INVENTORY MGMT SERVICE) of FIG. 2. In the illustrated example of FIG. 72, the client agent 272, the platform inventory management service 274, the accounts management service 276, the entitlement management service 278, and the secure storage 7203 are in communication with one(s) of each other via an example bus 7214. For example, the bus 7214 can be implemented by at least one of an Inter-Integrated Circuit (I2C) bus, a Serial Peripheral Interface (SPI) bus, a Peripheral Component Interconnect (PCI) bus, or a Peripheral Component Interconnect Express (PCIe or PCIE) bus. Additionally or alternatively, the bus 7214 can be implemented by any other type of computing or electrical bus. In some examples, the bus 7214 can be implemented by software communication link(s), such as application programming interface(s) (API(s)), network(s), or any other type of software interface(s).

The secure storage 7203 of the illustrated example is hardware, software, and/or firmware that can store data and restrict access to the data by unauthorized and/or unverified hardware, software, and/or firmware. For example, the secure storage 7203 can be cryptographically protected to restrict and/or otherwise prevent access by unauthorized and/or unverified entities. In some examples, the secure storage 7203 is a trusted execution environment (TEE) in which secure application code can be executed and/or data of interest (e.g., silicon product manufacturer owned cryptographical data) can be protected. A TEE is a compute or computing execution context wherein resources, such as process data, memory, storage, input(s)/output(s) (I/O(s)), etc., are isolated and protected from untrusted and/or unauthorized access. In some examples, the TEE can take the form of an entire operating system or portion(s) thereof, such as application code running or executing in an isolated environment, such as that provided by Intel® SGX. In some examples, the TEE is a hardware or hardware-based TEE, a software or software-based TEE, or any combination(s) thereof.

In some examples, the secure storage 7203 can store AI/ML data, such as training data, inference data, etc. In some examples, the secure storage 7203 can store AI/ML model(s), such as a model executable file or configuration image, a binary file or other executable construct, etc. In some examples, the secure storage 7203 can store historical data, such as data associated with previously executed workload(s), prior telemetry data, prior configuration(s) of semiconductor device(s) (e.g., identification(s) of hardware, firmware, and/or BIOS feature(s), etc.), etc. In some examples, the secure storage 7203 can store telemetry data from one(s) of the semiconductor devices 105A-C, and/or, more generally, one(s) of the servers 7202A-C.

In some examples, the secure storage 7203 can be implemented by a volatile memory (e.g., SDRAM, DRAM, RDRAM, etc.) and/or a non-volatile memory (e.g., flash memory). The secure storage 7203 may additionally or alternatively be implemented by one or more DDR memories, such as DDR, DDR2, DDR3, DDR4, DDR5, mDDR, DDR SDRAM, etc. The secure storage 7203 may additionally or alternatively be implemented by one or more mass storage devices such as HDD(s), CD drive(s), DVD drive(s), SSD drive(s), SD card(s), CF card(s), etc. While in the illustrated example the secure storage 7203 is illustrated as a single instance of the secure storage 7203, the secure storage 7203 may be implemented by any number and/or type(s) of secure storage. Furthermore, the data stored in the secure storage 7203 may be in any data format such as, for example, binary data, comma delimited data, tab delimited data, SQL structures, etc.

The customer enterprise system 115 includes the platform inventory management service 274 to manage the platforms offered by the customer (OEM), such as platforms that include the SDSi semiconductor devices 105A-C. For example, the platform inventory management service 274 can deploy, commission, configure, manage, and/or instantiate one(s) of the servers 7202A-C, or portion(s) thereof, such as one(s) of the VMs 7208A-C. In some examples, the platform inventory management service 274 can decommission, disable, lock, and/or deactivate one(s) of the servers 7202A-C, or portion(s) thereof, such as one(s) of the VMs 7208A-C. The platform inventory management service 274 of the illustrated example of FIG. 72 includes an example telemetry interface 7204, an example workload classifier 7206, an example feature recommender 7208, and an example feature configurator 7210.

The platform inventory management service 274 includes the telemetry interface 7204 to obtain telemetry data associated with one(s) of the semiconductor devices 7205A-C, and/or, more generally, one(s) of the servers 7202A-C, and/or, more generally, a platform (e.g., a compute or computing platform, a cloud or cloud computing platform, an enterprise platform, a customer platform, a customer enterprise platform, etc.), such as the SDSi system 7200 of FIG. 72. For example, the telemetry interface 7204 can obtain telemetry data from the first hardware circuitry 125A, the first firmware 130A, the first BIOS 135A, the first SDSi asset agent 140A, the first host OS 7204A, the first hypervisor 7206A, the first VM 7208A, and/or, more generally, the first semiconductor device 105A, and/or, more generally, the first server 7202A. In some examples, the telemetry interface 7204 can obtain the telemetry data via network connection(s) identified by reference numerals 150, 155.

In some examples, the telemetry interface 7204 can obtain telemetry data associated with resource(s) of the semiconductor devices 105A-C, and/or, more generally, the servers 7202A-C. For example, the telemetry data can correspond to, be representative of, and/or otherwise include or indicate data (e.g., data values, metadata, information, measurements, etc.) associated with a resource, such as quality-related information (e.g., hardware, firmware, and/or software parameters, statistics, etc., hardware reliability data such as mean-time between failure (MTBF) data, etc.), configuration information (e.g., hardware, firmware, and/or software attributes, settings, features, etc.), or any other analytics-based data (e.g., hardware counter(s), software counter(s), etc.). As used herein, such quality-related information, configuration information, and/or analytics-based data is generally referred to as telemetry (e.g., telemetry data, telemetry information, etc.).

In some examples, the telemetry data includes resource utilization information associated with the utilization of resource(s) (e.g., hardware resources, software resources, virtual hardware and/or software resources, etc.) and/or the efficiency with which those resources are able to meet the demands placed on them. For example, the telemetry data can include a utilization (e.g., a percentage of a resource that is utilized or not utilized), a delay (e.g., an average delay) in receiving a computation task for execution (e.g., latency), a rate (e.g., an average rate) at which a resource is available (e.g., bandwidth, throughput, etc.), power expenditure, a residency (e.g., a time duration at which the resource is at or within a range of a utilization), etc., associated with one(s) of the resource(s) of the semiconductor devices 105A-C, and/or, more generally, the servers 7202A-C.

In some examples, the telemetry data can include a utilization value (or non-utilization value) of the first hardware circuitry 125A (e.g., a utilization value of processor circuitry, a hardware accelerator, etc., or portion(s) thereof (e.g., a utilization value of a compute core of multi-core processor circuitry, a hardware thread of a hardware accelerator, etc.). In some examples, the telemetry data can include a utilization value (or non-utilization value) of the first firmware 130A, or portion(s) thereof. In some examples, the telemetry data can include a utilization value (or non-utilization value) of the first BIOS 135A, or portion(s) thereof. In some examples, the telemetry data can include a utilization value (or non-utilization value) of the first SDSi asset agent 140A, or portion(s) thereof.

In some examples, the telemetry data can include a utilization value (or non-utilization value) of the first host OS 7204A, or portion(s) thereof. In some examples, the telemetry data can include a utilization value (or non-utilization value) of the first hypervisor 7206A, or portion(s) thereof. In some examples, the telemetry data can include a utilization value (or non-utilization value) of the first VM 108A (or other virtualized resource such as a container, a virtualized load balancer, a virtualized network switch or gateway, etc.), or portion(s) thereof. In some examples in which the first server 7202A has multiple semiconductor devices, the telemetry data can include a utilization value (or non-utilization value) of a different semiconductor device than the first semiconductor device 105A.

In some examples, the telemetry data can include compute utilization data corresponding to a percentage of processor circuitry (e.g., a CPU, a GPU, etc.) being utilized. In some examples, the compute utilization data can include time data (e.g., time durations, time stamps, etc.) identifying a quantity of time at which the processor circuitry is utilized at a specific utilization percentage or within a range of a utilization percentage. In some examples, the compute utilization data can include workload data such as a type of instruction (e.g., machine readable instruction) being executed by the processor circuitry.

In some examples, the telemetry data can include storage utilization data corresponding to a percentage or other quantifier of storage, such as a mass storage disc or device, being utilized by the semiconductor devices 105A-C. In some examples, the telemetry data can include cache utilization data associated with cache memory of the semiconductor devices 105A-C 106 being utilized, memory utilization data (e.g., volatile memory utilization data, non-volatile memory utilization data, etc.), etc., associated with memory of the semiconductor devices 105A-C being utilized, etc. Additionally or alternatively, the telemetry data may include any other data associated with utilization(s) of resource(s) of the semiconductor devices 105A-C, and/or, more generally, the servers 7202A-C.

In some examples, the telemetry interface 7204 can obtain telemetry data including utilization threshold(s). For example, the telemetry interface 7204 can obtain a compute utilization threshold from the first semiconductor device 105A. In some examples, the compute utilization threshold can be representative of a utilization or a utilization above which is not to be exceeded in an effort to reduce wear/tear and/or otherwise elongate the lifetime of the first semiconductor device 105A. Additionally and/or alternatively, the telemetry interface 7204 can obtain any other type of utilization threshold (e.g., a storage utilization threshold, a memory utilization threshold, a network or network interface utilization threshold, etc.) with any type of specificity or granularity (e.g., a compute utilization for one core or a plurality of cores of multi-core processor circuitry).

In some examples, the telemetry interface 7204 can obtain telemetry data including hardware reliability data associated with the first semiconductor device 105A. For example, the telemetry interface 7204 can receive, request, and/or obtain hardware reliability data associated with the first hardware circuitry 125A. In some examples, the hardware reliability data can include a number of read/write cycles (e.g., a number of read/write cycles by memory/storage or portion(s)/partition(s) thereof), a number of completed compute or processor cycles by processor circuitry, etc., which can be used to estimate remaining useful life of the first hardware circuitry 125A. In some examples, the hardware reliability data can include MTBF data, which can be specified by a datasheet associated with the first hardware circuitry 125A, an SLA, an orchestration policy, etc. In some examples, the telemetry interface 7204 can obtain the hardware reliability data from the semiconductor devices 105A-C, a different component of the customer enterprise system 115 (e.g., the accounts management service 276, the entitlement management service 278, etc.), and/or the manufacturer enterprise system 110.

In some examples, the telemetry data includes instruction data such as data associated with an execution of a machine readable instruction by a resource. For example, the instruction data can include an indication whether a resource (e.g., a hardware resource, a software resource, etc.) is executing or retiring an instruction, executing a logical cycle, executing a reference cycle, executing a call, executing a direct call, executing a service (e.g., a firmware and/or software service) or process (e.g., a firmware and/or software process, a particular or specified service or process of interest, etc.), etc. In some examples, the telemetry data includes performance counter data such as value(s) of a hardware counter (e.g., a hardware performance counter), a software counter (e.g., a software performance counter), etc., that is used to monitor a function of the resource. For example, the telemetry data can include value(s) of one or more counters implemented by a performance monitoring unit (PMU) of the semiconductor devices 105A-C. In some examples, the instruction data includes a quantity of read/write cycles executed by storage, memory, etc., or portion(s) or partition(s) thereof, a latency of the storage, memory, etc., a percentage or portion of the storage, memory, etc., that is available to execute a storage/memory task, etc.

In some examples, the telemetry interface 7204 determines whether to continue monitoring for telemetry data. For example, the telemetry interface 7204 can determine whether to continue collecting and/or otherwise obtaining telemetry data from one(s) of the semiconductor devices 105A-C, and/or, more generally, the servers 7202A-C, based on a service level agreement (SLA), an orchestration policy, etc. In some examples, the telemetry interface 7204 can collect telemetry data and/or request telemetry data based on a data collection period indicated by the SLA, the orchestration policy, etc. For example, the telemetry interface 7204 can collect and/or request telemetry data periodically (e.g., synchronously) (e.g., every second, minute, hour, day, week, month, year, etc.) or a periodically (e.g., asynchronously) based on a trigger or invocation by the telemetry interface 7204, and/or, more generally, the customer enterprise system 115.

In some examples, the telemetry interface 7204 obtains telemetry data including characteristic(s) of workload(s) executed or to be executed by the semiconductor devices 105A-C. For example, the characteristic(s) can include a type of the workload(s), a type of instruction to be executed to complete the workload(s), a number of instructions to be executed, a number of the workload(s) to be executed, a number and/or type(s) of resource(s) to be utilized to execute the workload(s).

In some examples, the telemetry interface 7204 obtains telemetry data including workflow requirements, which can include sequence(s) of workload(s). For example, the telemetry interface 7204 can obtain data indicative of a first workload and whether the first workload has workload dependencies with other workloads. For example, the telemetry interface 7204 can obtain data that indicates that the first workload is to be executed in response to completion of one or more second workloads. In some examples, the telemetry interface 7204 can obtain data that indicates that the first workload is to be executed prior to one or more second workloads. For example, the telemetry data can be indicative of what resource(s) is/are needed to complete a first workload and what resource(s) is/are anticipated to be needed for workload(s) to follow completion (or partial completion) of the first workload.

In some examples, the telemetry interface 7204 obtains telemetry data including feature(s) that is/are activated or deactivated on the semiconductor devices 105A-C. For example, the telemetry interface 7204 can request the first semiconductor device 105A to provide telemetry data that indicates which feature(s) of the first hardware circuitry 125A, the first firmware 130A, the first BIOS 135A, etc., is/are activated or deactivated.

In some examples, the telemetry interface 7204 can obtain historical data, such as historical telemetry data, that corresponds to the semiconductor devices 105A-C and/or workload(s) executed or to be executed by the semiconductor devices 105A-C. For example, the telemetry interface 7204 can obtain telemetry data associated with the first semiconductor device 105A, which can include workload characteristic(s) and/or feature(s) activated/deactivated by the first semiconductor device 105A. In some examples, the telemetry interface 7204 can obtain historical telemetry data generated by the semiconductor devices 105A-C when they executed prior workload(s) having the workload characteristic(s) while utilizing the feature(s).

The platform inventory management service 274 includes the workload classifier 7206 to classify, profile, and/or otherwise categorize a workload (e.g., an unlabeled workload, a labeled workload), etc., based on the telemetry data associated with the workload(s) executed or to be executed by the semiconductor devices 105A-C. For example, the workload classifier 7206 can classify the workload(s) based on an identification of a fingerprint of the workload(s). In some examples, the workload classifier 7206 can determine phase residency data from the telemetry data. For example, the phase residency data can be indicative of the time periods of various resource utilization phases exhibited by each workload and the patterns in which the workloads exhibit the resource utilization phases. In some examples, the phase residency data for a given workload can represent a fingerprint (e.g., a resource utilization pattern) unique to the workload. For example, the workload classifier 7206 can generate a workload classification for a workload, which may be implemented as any data indicative of the general resource utilization tendencies of the semiconductor devices 105A-C when executing the workload. In some examples, the workload classifier 7206 can generate and assign a workload classification for a workload to be compute or processor circuitry intensive, memory intensive, interface or network bandwidth intensive, cache memory intensive, storage intensive, accelerator intensive, security intensive, etc., and/or any combination(s) thereof.

In some examples, the workload classifier 7206 can classify, profile, and/or otherwise categorize a workload based on an output from a machine learning (ML) model. For example, the workload classifier 7206 can provide telemetry data as input(s) (e.g., model input(s)) to an ML model, such as a neural network or any other type of AI/ML model, to generate output(s) (e.g., model output(s)). In some examples, the workload classifier 7206 can train or retrain the ML model based on training data, which can include the telemetry data, the historical data, etc., and/or any combination(s) thereof.

In some examples, the workload classifier 7206 can execute the ML model using the input(s) to generate the output(s), which can include a classification, a profile, a categorization, etc., of the workload. In some examples, the output(s) from the ML model can include a determination of whether the execution of the workload by one(s) of the semiconductor devices 105A-C is meeting and/or otherwise satisfying an SLA, such as meeting a bandwidth, latency, or throughput requirement indicated by the SLA. In some examples, the output(s) from the ML model can include an estimated, expected, or predicted progress of the workload. For example, the workload classifier 7206 can determine a current progress of workload execution (e.g., how much of the workload has been completed, how much of the workload is not completed, etc.) based on the telemetry data from the semiconductor devices 105A-C, which can include which feature(s) of the semiconductor devices 105A-C is/are activated/deactivated. In some examples, the workload classifier 7206 can determine an estimated or predicted progress of the workload based on historical data (e.g., historical workload data, historical activated/deactivated features, etc.). For example, the workload classifier 7206 can execute the ML model to determine a predicted level of progress for the workload based on previous executions of the workload (or substantially similar workloads) by the semiconductor devices 105A-C (or different semiconductor devices) having the same or substantially similar activated/deactivated features.

In some examples, the workload classifier 7206 can determine a difference between the current progress of the workload and the predicted progress of the workload. For example, the workload classifier 7206 can determine whether the semiconductor devices 105A-C are underperforming (e.g., the current progress is less than the predicted progress), performing as expected (e.g., the current progress is within a tolerance range of the predicted progress), or overperforming (e.g., the current progress is greater than the predicted progress). In some examples, the workload classifier 7206 can determine that dormant feature(s) is/are to be activated to reduce the difference based on a determination that the semiconductor devices 105A-C are underperforming. In some examples, the workload classifier 7206 can determine that dormant feature(s) is/are to be deactivated based on a determination that the semiconductor devices 105A-C are overperforming. In some examples, the workload classifier 7206 can determine that activated feature(s) is/are to be deactivated and dormant feature(s) is/are to be activated based on a determination that the semiconductor devices 105A-C, or portion(s) thereof, are approaching, meeting, and/or extending beyond hardware reliability limit(s), threshold(s), etc.

The platform inventory management service 274 includes the feature recommender 7208 to generate a recommendation for configurable circuitry of the semiconductor devices 105A-C with one or more first features to change to one or more second features (e.g., activate/deactivate the one or more first features and/or activate/deactivate the one or more second features). For example, the feature recommender 7208 can generate the recommendation by executing an ML model. In some examples, the feature recommender 7208 can provide output(s) from the workload classifier 7206 as input(s) (e.g., model input(s)) to generate output(s) (e.g., model output(s)), which can be representative of and/or otherwise implement the recommendation. For example, the feature recommender 7208 can obtain an indication from the workload classifier 7206 that one(s) of the semiconductor devices 105A-C is/are underperforming when executing workload(s). In some examples, the feature recommender 7208 can provide the indication to the ML model as input(s) to generate output(s), which can include a proposal, a recommendation, a suggestion, etc., of feature(s) for the one(s) of the semiconductor devices 105A-C to activate/deactivate to cause the one(s) of the semiconductor devices 105A-C to perform as expected. For example, the feature recommender 7208 can generate the recommendation to reduce the difference between the current progress of the workload(s) and the expected progress of the workload(s) and thereby increase and/or otherwise improve the execution of the workload(s) by the one(s) of the semiconductor devices 105A-C.

The platform inventory management service 274 includes the feature configurator 7210 to cause execution of workload(s) by the semiconductor devices 105A-C based on a change of feature(s) of the semiconductor devices 105A-C invoked by the recommendation. For example, the feature configurator 7210 can direct, instruct, and/or otherwise cause the first semiconductor device 105A to change from first feature(s) to second feature(s) (e.g., change a first feature of the first hardware circuitry 125A, the first firmware 130A, the first BIOS 135A, etc., to a second feature) via SDSi techniques as described herein.

In some examples, the feature configurator 7210 determines whether the semiconductor devices 105A-C are capable of the change(s) indicated by the recommendation. For example, the feature configurator 7210 can determine that the recommendation includes a change of a first feature of the first semiconductor device 105A to a second feature. In some examples, the feature configurator 7210 can determine that the first semiconductor device 105A is configurable to activate the second feature. For example, the feature configurator 7210 can instruct the first semiconductor device 105A to deactivate the first feature and/or activate the second feature. In some examples, the feature configurator 7210 can cause the first semiconductor device 105A to execute a workload with the second feature.

In some examples, the feature configurator 7210 can determine that the first semiconductor device 105A is not configurable to activate the second feature. For example, the feature configurator 7210 identify different one(s) of the semiconductor devices 105A-C, such as the second semiconductor device 105B, that is/are configurable for the second feature. In some examples, the feature configurator 7210 can instruct the second semiconductor device 105B to deactivate the first feature and/or activate the second feature. In some examples, the feature configurator 7210 can cause the second semiconductor device 105B to execute a workload with the second feature. For example, the feature configurator 7210 can pause and/or otherwise cease execution of a workload by the first semiconductor device 105A. In some examples, the feature configurator 7210 can transfer and/or otherwise migrate the workload (e.g., machine readable instructions to process the workload, input data to be processed, etc.) from the first semiconductor device 105A to the second semiconductor device 105B. For example, the feature configurator 7210 can resume execution of the workload on the second semiconductor device 105B based on a determination that the second semiconductor device 105B has activated the second feature. In some examples, the feature configurator 7210 can deactivate the first feature on the first semiconductor device 105A based on a successful transfer/migration, and/or, more generally, can deactivate the first semiconductor device 105A to reduce power consumption and/or reallocate the first semiconductor device 105A to execute a different workload to increase resource utilization of the SDSi system 7200.

In some examples, the feature configurator 7210 can configure and/or reconfigure the semiconductor devices 105A-C, and/or, more generally, the servers 7202A-C, based on recommended feature(s). For example, the feature configurator 7210 can configure/reconfigure one(s) of the hardware circuitry 125A-C, the firmware 130A-C, the BIOS 135A-C, the SDSi asset agents 140A-C, the host OS 7204A-C, the hypervisors 7206A-C, the VMS 7208A-C, and/or, more generally, the servers 7202A-C. For example, the feature configurator 7210 can unlock/lock (e.g., enable/disable) a feature of the first hardware circuitry 125A, the first firmware 130A, the first BIOS 135A, etc.

In some examples, the feature configurator 7210 can upgrade (or downgrade) one(s) of the hardware circuitry 125A-C, the firmware 130A-C, the BIOS 135A-C, the SDSi asset agents 140A-C, the host OS 7204A-C, the hypervisors 7206A-C, the VMS 7208A-C, and/or, more generally, the servers 7202A-C. For example, the feature configurator 7210 can upgrade (or downgrade) and/or otherwise change a version of the first firmware 130A from a first firmware version to a second firmware version. In some examples, the feature configurator 7210 can upgrade (or downgrade) and/or otherwise change a version of the first host OS 7204A from a first OS version to a second OS version. In some examples, the feature configurator 7210 can upgrade (or downgrade) and/or otherwise change a version of the first hypervisor 7206A from a first hypervisor version to a second hypervisor version. In some examples, the feature configurator 7210 can upgrade (or downgrade) and/or otherwise change a version of the first VM 7208A (or application(s) executing thereon) from a first version (e.g., a first VM version, a first application version, etc.) to a second version (e.g., a second VM version, a second application version, etc.).

In some examples, the feature configurator 7210 can migrate a virtual resource, such as a VM, a container, etc., from a first server to a second server. In some examples, the feature configurator 7210 can implement a cross virtual resource migration as described above. For example, the feature configurator 7210 can shut down, decommission, and/or otherwise cease operation of the first VM 7208A on the first server 7202A. In some examples, in response to shutting down the first VM 7208A, the feature configurator 7210 can instantiate, commission, and/or otherwise spin up the first VM 7208A on the second server 7202B. For example, the feature configurator 7210 can run the first VM 7208A on the second hypervisor 7206B. In some examples, the first VM 7208A on the second hypervisor 7206B can be implemented by the second VM 7208B of the illustrated example of FIG. 72.

In some examples, the feature configurator 7210 can configure the first VM 7208A based on feature(s) associated with the first VM 7208A (e.g., a type of application to execute, a version of the application, a type/version of a software driver, a type/version of a kernel, etc.) stored in the secure storage 7203. In some examples, the feature configurator 7210 can deploy and/or otherwise install one or more licenses associated with the first VM 7208A, and/or, more generally, the first server 7202A, on the second server 7202B to enable the feature(s) associated with the first VM 7208A. In some examples, the feature configurator 7210 can execute the workload on the first VM 7208A on the second server 7202B based on at least one of the feature(s), the license(s), or the state of the first VM 7208A. For example, in response to a migration of the first VM 7208A, or portion(s) thereof, from the first server 7202A to the second server 7202B, the feature configurator 7210 can cause execution of the workload by resuming execution of the workload at the point the workload was previously halted on the first server 7202A. In some examples, the feature configurator 7210 can migrate the first VM 7208A from the second server 7202B back to the first server 7202A (or a different server such as the third server 7202C). For example, in response to a change, an upgrade, etc., to the first server 7202A (or portion(s) thereof), the feature configurator 7210 can migrate the first VM 7208A back to the first server 7202A (or a different server such as the third server 7202C).

In some examples, the feature configurator 7210 can implement an in-place migration of a virtual resource as described above. For example, the feature configurator 7210 can increase (or decrease) system resources to meet and/or otherwise satisfy workload requirements whereby the system resources are changed, the kernel can accept the changes and make the new system resources available to the workload without a system reset, kernel space interruption, etc.

In some examples, the virtual resource migrator 7212 can implement a cross platform migration (e.g., a cross platform virtual resource migration) as described above. For example, the feature configurator 7210 can implement a cross platform migration by evaluating movement of multiple virtual resources and/or workloads and generate a migration plan, sequence, etc., for the new placement with either one or more in-place migrations and/or one or more cross virtual resource migrations as described above.

Advantageously, the platform inventory management service 274 can utilize platform counters and/or other platform performance telemetry to be monitored by an in band or out of band agent, such as the SDSi asset agents 140A-C. For example, the platform inventory management service 274 can execute AI/ML model(s) based on the telemetry data to output insight(s) into how workloads may be optimized and/or otherwise improved on the servers 7202A-C based on the workload runtime characteristics and/or available features of the semiconductor devices 105A-C. Advantageously, the platform inventory management service 274 can obtain additional telemetry data for workloads that are members of strictly or loosely coupled workflows, where specific insights can utilized for load balancing operations, high availability resource management, and/or scheduling time sensitive, deterministic workloads.

Advantageously, the platform inventory management service 274 can utilize AI/ML model(s) to forecast the likelihood of completion and/or provide insight on the estimated or planned completion of a workload with respect to real time completion progress of the workload. Advantageously, the platform inventory management service 274 can generate recommendations to be used by the customer enterprise system 115 for reconfiguring the SDSi system 7200 for existing workloads. Advantageously, the customer enterprise system 115 can provide feature enablement, enhancements, and/or additional capacity to meet the planned SLA with cost increases (e.g., computational cost, memory cost, storage cost, etc., based on a quantity of utilized resources to effectuate a workload) and/or predictions included. Advantageously, the platform inventory management service 274 can generate predictive recommendations for trends associated with workloads executed by the servers 7202A-C that can indicate when feature(s) is/are to be activated/turned on to satisfy an SLA of interest.

While an example manner of implementing the customer enterprise system 115 of FIG. 1 is illustrated in FIG. 72, one or more of the elements, processes, and/or devices illustrated in FIG. 72 may be combined, divided, re-arranged, omitted, eliminated, and/or implemented in any other way. Further, the example client agent 272, the example platform inventory management service 274, the example accounts management service 276, the example entitlement management service 278, the example secure storage 7203, the example telemetry interface 7204, the example workload classifier 7206, the example feature recommender 7208, the example feature configurator 7210, the example bus 7214, and/or, more generally, the example customer enterprise system 115 of FIG. 1, may be implemented by hardware alone or by hardware in combination with software and/or firmware. Thus, for example, any of the example client agent 272, the example platform inventory management service 274, the example accounts management service 276, the example entitlement management service 278, the example secure storage 7203, the example telemetry interface 7204, the example workload classifier 7206, the example feature recommender 7208, the example feature configurator 7210, the example bus 7214, and/or, more generally, the example customer enterprise system 115, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example customer enterprise system 115 of FIG. 1 may include one or more elements, processes, and/or devices in addition to, or instead of, those illustrated in FIG. 72, and/or may include more than one of any or all of the illustrated elements, processes and devices.

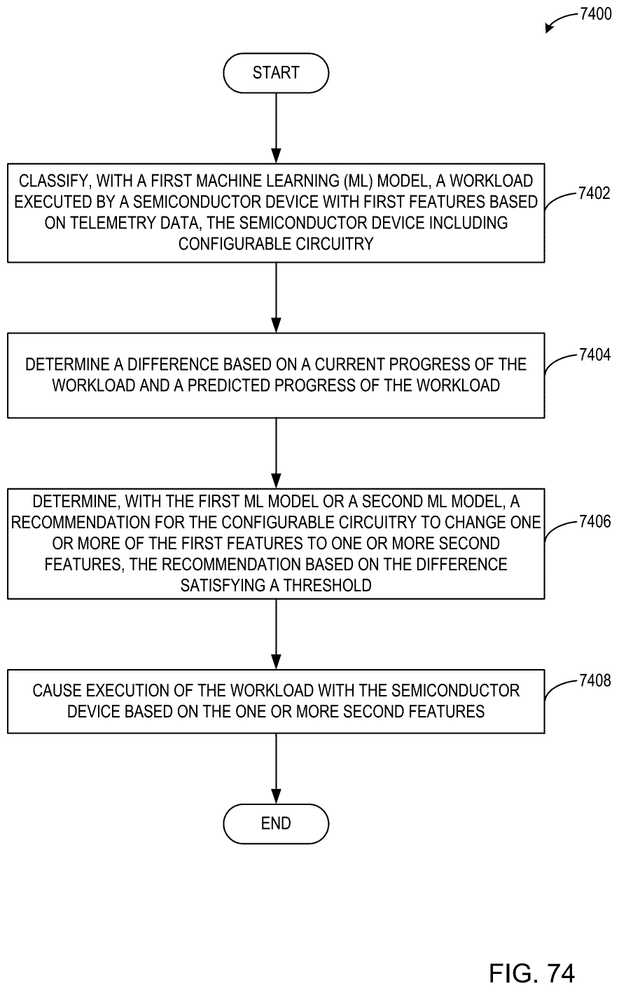

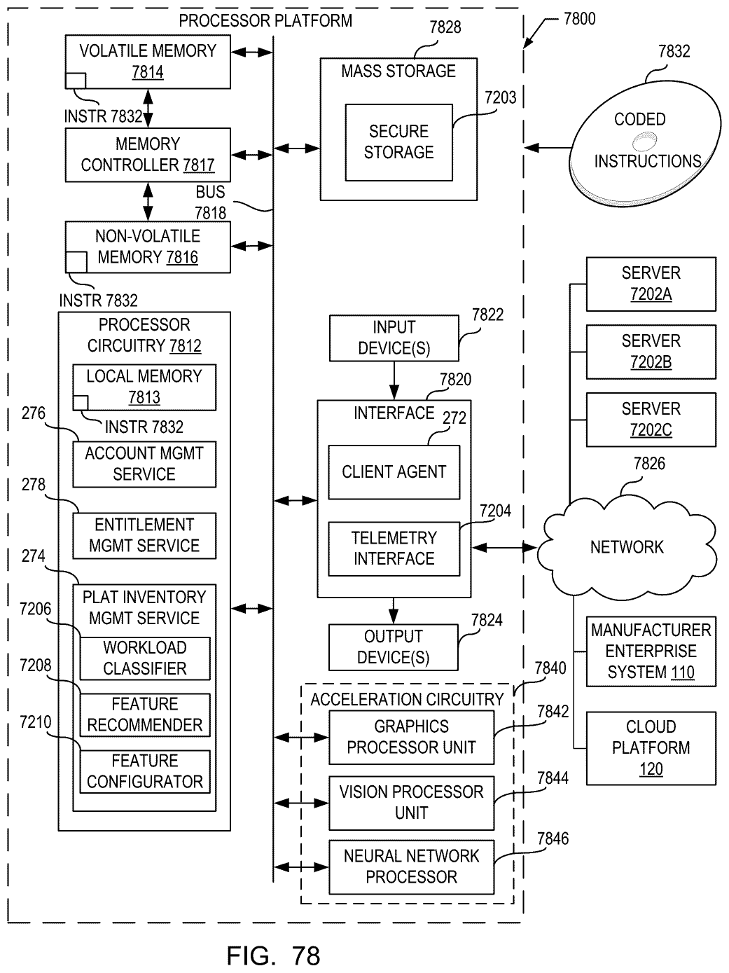

Flowcharts representative of example machine readable instructions which may be executed to configure processor circuitry to implement the example customer enterprise system 115 of FIGS. 1 and/or 72, and/or, more generally, the SDSi system 7200 of FIG. 72, are shown in FIGS. 74-77. The machine readable instructions may be one or more executable programs or portion(s) of an executable program for execution by processor circuitry, such as the processor circuitry 7812 shown in the example processor platform 7800 discussed below in connection with FIG. 78 and/or the example processor circuitry discussed below in connection with FIGS. 150 and/or 151. The program may be embodied in software stored on one or more non-transitory computer readable storage media such as a CD, a floppy disk, an HDD, an SSD, a DVD, a Blu-ray disk, a volatile memory (e.g., RAM of any type, etc.), or a non-volatile memory (e.g., electrically EEPROM, FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a RAN) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 74-77, many other methods of implementing the example customer enterprise system 115 of FIGS. 1 and/or 72, and/or, more generally, the SDSi system 7200 of FIG. 72, may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an op-amp, a logic circuit, etc.) structured to perform the corresponding operation without executing software or firmware. The processor circuitry may be distributed in different network locations and/or local to one or more hardware devices (e.g., a single-core processor (e.g., a single core CPU), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a DLL), an SDK, an API, etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HTML, SQL, Swift, etc.

As mentioned above, the example operations of FIGS. 74-77 may be implemented using executable instructions (e.g., computer and/or machine readable instructions) stored on one or more non-transitory computer and/or machine readable media such as optical storage devices, magnetic storage devices, an HDD, a flash memory, a ROM, a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or RAID systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

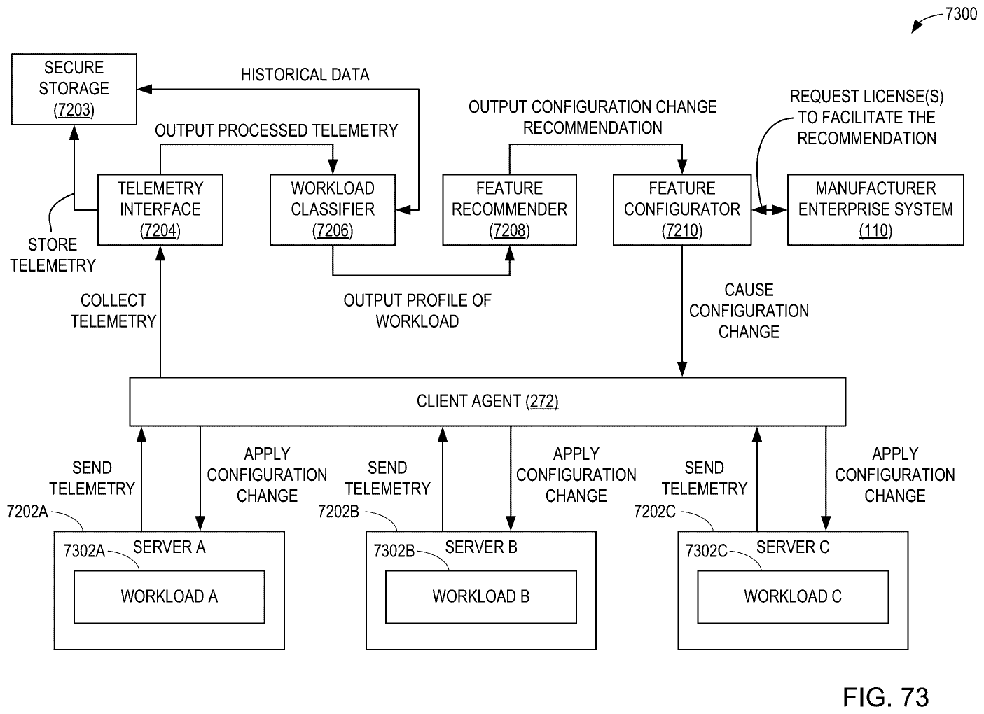

FIG. 73 is a block diagram of an example workflow 7300 to manage resource configurations based on a recommendation from a machine learning model. The workflow 7300 includes example operations associated with the servers 7202A-C, the client agent 272, the secure storage 7203, the telemetry interface 7204, the workload classifier 7206, the feature recommender 7208, the feature configurator 7210, and the manufacturer enterprise system 110 of FIGS. 1 and/or 72.

During the workflow 7300, the servers 7202A-C are executing respective example workloads 7302A-C, such as a first example workload 7302A, a second example workload 7302B, and a third example workload 7302C. For example, the workloads 7302A-C can be compute workloads (e.g., AI/ML workloads, server workloads, data processing workloads, etc.), memory workloads (e.g., reading/writing data into memory, storage, compressing/decompressing data, etc.), network workloads (e.g., generating data packets, receiving/transmitting data packets, etc.), security workloads (e.g., encrypting/decrypting data), etc., and/or any combination(s) thereof. In example operation, the servers 7202A-C can send telemetry (e.g., telemetry data) to the telemetry interface 7204 of FIG. 72 via the client agent 272 of FIGS. 1 and/or 72. For example, the servers 7202A-C can generate, store, and/or collect telemetry data associated with respective executions of the workloads 7302A-C.

In example operation, the telemetry interface 7204 can collect telemetry from the servers 7202A-C via the client agent 272. In some examples, the telemetry interface 7204 can store the telemetry, or portion(s) thereof, in the secure storage 7203 of FIG. 72. In example operation, the telemetry interface 7204 can process the telemetry, such as by extracting data of interest (e.g., metadata, workload data, feature(s) of the servers 7202A-C, utilization data associated with the servers 7202A-C, etc.), formatting the data of interest for data consumption by an ML model, etc., and/or any combination(s) thereof.

In example operation, the telemetry interface 7204 can output telemetry, such as processed telemetry, to the workload classifier 7206. In example operation, the workload classifier 7206 can execute a first ML model based on historical data and/or telemetry as data input(s) to generate data output(s), which can include profile(s) of the workloads 7302A-C. For example, the workload classifier 7206 can determine whether the servers 7202A-C are executing the workloads 7302A-C in accordance with satisfying an SLA, an orchestration policy, etc.

In example operation, the feature recommender 7208 can execute a second ML model (or the first ML model) based on the profile(s) of the workloads 7302A-C as data input(s) to generate data output(s), which can include configuration change recommendation(s) associated with one(s) of the servers 7202A-C. For example, the feature recommender 7208 can execute a neural network model using a profile of the first workload 7302 to determine a recommendation of how to optimize and/or otherwise improve execution of the first workload 7302 by changing feature(s) of the first server 7202A, or portion(s) thereof.

In example operation, the feature configurator 7210 can request license(s) from the manufacturer enterprise system 110 to facilitate the recommendation. For example, the feature configurator 7210 can request license(s) that correspond to activating/deactivating feature(s) indicated by the recommendation from the feature configurator 7210.

In example operation, the feature configurator 7210 can cause configuration change(s) to one(s) of the servers 7202A-C via the client agent 272. For example, the feature configurator 7210 can provide the license(s) from the manufacturer enterprise system 110 to the one(s) of the servers 7202A-C to activate/deactivate recommended feature(s). In some examples, the feature configurator 7210 can command, direct, instruct, and/otherwise cause the one(s) of the servers 7202A-C to activate/deactivate feature(s) based on the license(s).

In example operation, the feature configurator 7210 can cause the one(s) of the servers 7202A-C to execute (or resume execution of) the workloads 7302A-C with the activated/deactivated features. Advantageously, the workflow 7300 can be performed to achieve optimal and/or otherwise improved execution of the workloads 7302A-C based on telemetry data associated with the workloads 7302A-C, and/or, more generally, the servers 7202A-C.

FIG. 74 is a flowchart representative of example machine readable instructions and/or example operations 7400 that may be executed and/or instantiated by processor circuitry to execute a workload based on a recommendation of feature(s) from machine learning model(s). The example machine readable instructions and/or the example operations 7400 of FIG. 74 begin at block 7402, at which the customer enterprise system 115 of FIGS. 1 and/or 72 classifies, with a first machine learning (ML) model, a workload executed by a semiconductor device with first features based on telemetry data, the semiconductor device including configurable circuitry. For example, the workload classifier 7206 of FIG. 72 can execute a first ML model with telemetry data as input(s) to generate output(s), which can include classification(s) of the first workload 7302A as compute intensive and/or having a particular progress of execution (e.g., 40% complete, 60% complete, etc.).

At block 7404, the customer enterprise system 115 determines a difference based on a current progress of the workload and a predicted progress of the workload. For example, the workload classifier 7206 can execute the first ML model to determine a predicted progress of the first workload 7302A based on historical data associated with and/or otherwise corresponding to the first workload 7302A. In some examples, the workload classifier 7206 can determine a difference between the current progress and the predicted progress to determine whether the first server 7202A is underperforming (e.g., not satisfying an SLA, not complying with requirements of the SLA, etc.), performing as expected (e.g., satisfying the SLA, complying with the requirements of the SLA within a tolerance range, etc.), or overperforming.

At block 7406, the customer enterprise system 115 determines, with the first ML model or a second ML model, a recommendation for the configurable circuitry to change one or more of the first features to one or more second features, the recommendation based on the difference satisfying a threshold. For example, the feature recommender 7208 of FIG. 72 can execute the first ML model and/or a second ML model to generate a proposal, a recommendation, etc., to change one or more first features of the first server 7202A to one or more second features to improve execution (e.g., increase bandwidth, increase throughput, reduce latency, etc.) of the first workload 7302A.

At block 7408, the customer enterprise system 115 causes execution of the workload with the semiconductor device based on the one or more second features. For example, the feature configurator 7210 of FIG. 72 can instruct the first semiconductor device 105A of FIG. 72 to change from one or more first features (e.g., one or more first features of the first hardware circuitry 125A) to one or more second features (e.g., one or more second features of the first hardware circuitry 125A). In some examples, the feature configurator 7210 can cause the first server 7202A to execute the first workload 7302A with the one or more second features. In response to causing execution of the workload with the semiconductor device based on the one or more second features at block 7402, the example machine readable instructions and/or the example operations 7400 of FIG. 74 conclude.

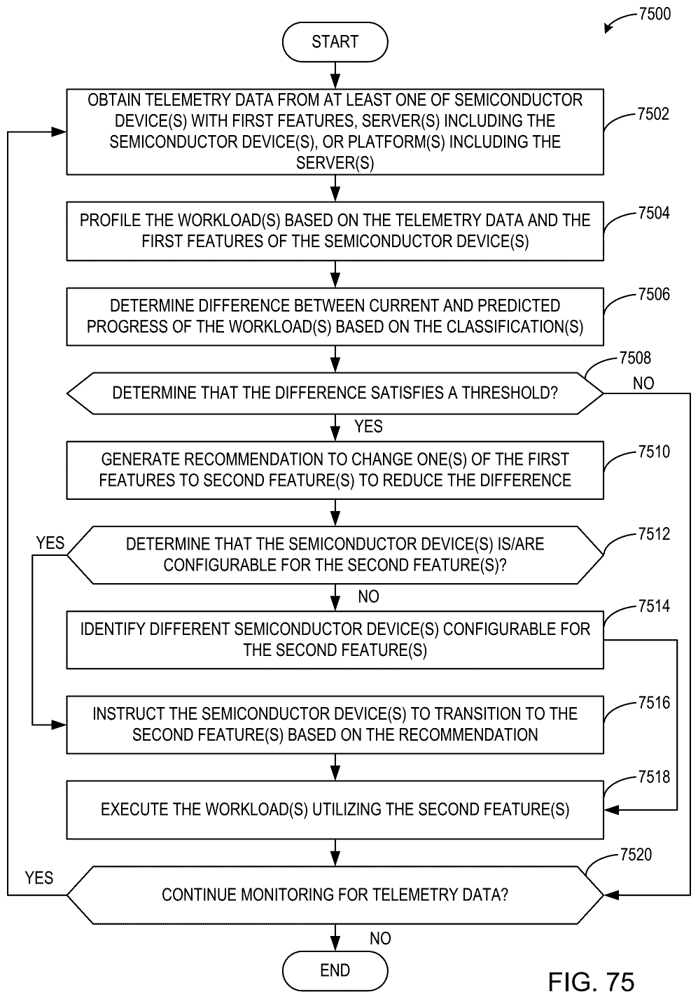

FIG. 75 is a flowchart representative of example machine readable instructions and/or example operations 7500 that may be executed and/or instantiated by processor circuitry to change feature(s) of semiconductor device(s) based on telemetry data associated with the semiconductor device(s). The example machine readable instructions and/or the example operations 7500 of FIG. 75 begin at block 7502, at which the customer enterprise system 115 of FIGS. 1 and/or 72 obtains telemetry data from at least one of semiconductor device(s) with first features, server(s) including the semiconductor device(s), or platform(s) including the server(s). For example, the telemetry interface 7204 of FIG. 72 can obtain telemetry data from at least one(s) of the semiconductor devices 105A-C, the servers 7202A-C, and/or, more generally, the SDSi system 7200 of FIG. 72.

At block 7504, the customer enterprise system 115 profiles the workload(s) based on the telemetry data and the first features of the semiconductor device(s). For example, the workload classifier 7206 of FIG. 72 can execute a first ML model based on telemetry data associated with the first workload 7302, and/or, more generally, the first server 7202A, and/or feature(s) thereof. In some examples, the workload classifier 7206 can execute the first ML model to generate output(s), which can include classification(s) of the first workload 7302A.

At block 7506, the customer enterprise system 115 determines a difference between a current and predicted progress of the workload(s) based on the classification(s). For example, the workload classifier 7206 can determine a difference between a current and predicted progress of the first workload 7302A based on the classification(s) of the first workload 7302A.

At block 7508, the customer enterprise system 115 determines whether the difference satisfies a threshold. For example, the workload classifier 7206 can determine whether the difference satisfies a threshold (e.g., a threshold of 1% difference, 5% difference, 10% difference, etc.). In some examples, the threshold can be included in an SLA, an orchestration policy, a workload requirement, etc.

If, at block 7508, the customer enterprise system 115 determines that the difference does not satisfy a threshold, control proceeds to block 7520, otherwise control proceeds to block 7510. At block 7510, the customer enterprise system 115 generates a recommendation to change one(s) of the first features to second feature(s) to reduce the difference. For example, the feature recommender 7208 can execute the first ML model and/or a second ML model to generate a recommendation output representative of changing first feature(s) of the first semiconductor device 105A to second feature(s).

At block 7512, the customer enterprise system 115 determines whether the semiconductor device(s) is/are configurable for the second feature(s). For example, the feature configurator 7210 of FIG. 72 can determine whether the first hardware circuitry 125A, the first firmware 130A, the first BIOS 135A, etc., of the first semiconductor device 105A is configurable to achieve and/or otherwise utilize the second feature(s). If, at block 7512, the customer enterprise system 115 determines that the semiconductor device(s) is/are not configurable for the second feature(s), control proceeds to block 7514.

At block 7514, the customer enterprise system 115 identifies different semiconductor device(s) configurable for the second feature(s). For example, the feature configurator 7210 can identify that the second hardware 125B, the second firmware 130B, the second BIOS 135B, etc., of the second semiconductor device 105B is configurable to achieve and/or otherwise utilize the second feature(s). In response to identifying different semiconductor device(s) configurable for the second feature(s) control proceeds to block 7518.

If, at block 7512, the customer enterprise system 115 determines that the semiconductor device(s) is/are configurable for the second feature(s), control proceeds to block 7516. At block 7516, the customer enterprise system 115 instructs the semiconductor device(s) to transition to the second feature(s) based on the recommendation. For example, the feature configurator 7210 can direct the first semiconductor device 105A to activate/deactivate the second feature(s) of the first hardware circuitry 125A, the first firmware 130A, the first BIOS 135A, etc. In response to instructing the semiconductor device(s) to transition to the second feature(s) based on the recommendation at block 7516, control proceeds to block 7518.

At block 7518, the customer enterprise system 115 executes the workload(s) utilizing the second feature(s). For example, the feature configurator 7210 can cause execution of the first workload 7302A by the first semiconductor device 105A utilizing the second feature(s). In some examples, the feature configurator 7210 can cause execution of the first workload 7302A by resuming execution of the first workload 7302A after the first semiconductor device 105A activates/deactivates the second feature(s).

At block 7520, the customer enterprise system 115 determines whether to continue monitoring for telemetry data. For example, the telemetry interface 7204 can determine whether to continue obtaining telemetry data from at least one(s) of the semiconductor devices 105A-C, the servers 7202A-C, and/or, more generally, the SDSi system 7200 of FIG. 72. If, at block 7520, the customer enterprise system 115 determines to continue monitoring for telemetry data at block 7520, control proceeds to block 7502, otherwise the example machine readable instructions and/or the example operations 7500 of FIG. 75 conclude.

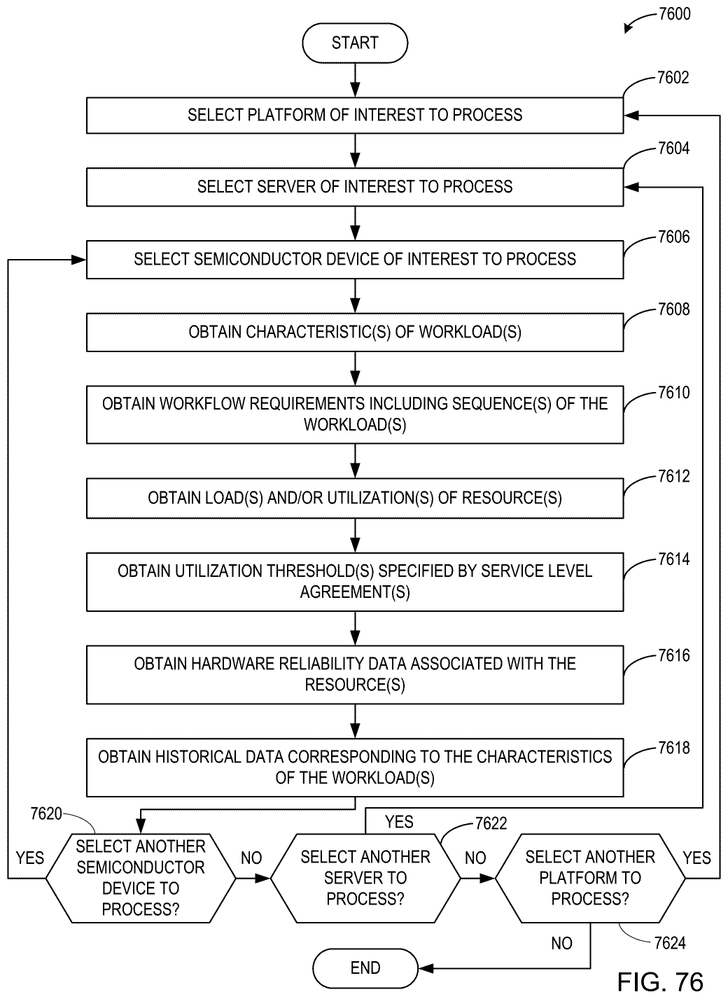

FIG. 76 is a flowchart representative of example machine readable instructions and/or example operations 7600 that may be executed and/or instantiated by processor circuitry to collect telemetry data associated with the example SDSi system 7200 of FIG. 72. The example machine readable instructions and/or the example operations 7600 of FIG. 76 begin at block 7602, at which the customer enterprise system 115 of FIGS. 1 and/or 72 selects a platform of interest to process. For example, the telemetry interface 7204 of FIG. 72 can select the SDSi system 7200 from which to obtain telemetry data. In some examples, the telemetry interface 7204 can obtain the telemetry data associated with the SDSi system 7200 from the secure storage 7203 or any other data source, such as the customer enterprise system 115.

At block 7604, the customer enterprise system 115 selects a server of interest to process. For example, the telemetry interface 7204 can select the first server 7202A from which to obtain telemetry data. In some examples, the telemetry interface 7204 can obtain the telemetry data associated with the first server 7202A from the secure storage 7203 or any other data source, such as the first server 7202A.

At block 7606, the customer enterprise system 115 selects a semiconductor device of interest to process. For example, the telemetry interface 7204 can select the first semiconductor device 105A from which to obtain telemetry data. In some examples, the telemetry interface 7204 can obtain the telemetry data from the secure storage 7203 or any other data source, such as the first semiconductor device 105A.

At block 7608, the customer enterprise system 115 obtains characteristic(s) of workload(s). For example, the telemetry interface 7204 can obtain telemetry data from the first semiconductor device 105A, such as characteristic(s) of the first workload 7302A. In some examples, the telemetry data can include type(s) and/or quantities of instructions to be executed for the first workload 7302A, utilization value(s) of resource(s) of the first semiconductor device 105A, etc.

At block 7610, the customer enterprise system 115 obtains workflow requirement(s) of the workload(s). For example, the telemetry interface 7204 can obtain telemetry data associated with the first workload 7302A, such as a sequence of the workload(s). In some examples, the sequence can include whether a second workload preceded the first workload 7302A or is to follow execution or completion of the first workload 7302A.

At block 7612, the customer enterprise system 115 obtains load(s) and/or utilization(s) of resource(s). For example, the telemetry interface 7204 can obtain telemetry data associated with the first semiconductor device 105A, such as a compute utilization or load of one or more cores of multi-core processor circuitry of the first semiconductor device 105A, a memory utilization of memory of the first semiconductor device 105A, etc., and/or any combination(s) thereof.

At block 7614, the customer enterprise system 115 obtains utilization threshold(s) specified by service level agreement(s). For example, the telemetry interface 7204 can obtain telemetry data, such as a compute utilization threshold, a memory utilization threshold, MTBF threshold(s), etc., specified by and/or otherwise included in an SLA associated with the first semiconductor device 105A.

At block 7616, the customer enterprise system 115 obtains hardware reliability data associated with the resource(s). For example, the telemetry interface 7204 can obtain telemetry data, such as MTBF value(s) associated with the first hardware circuitry 125A, or portion(s) thereof.

At block 7618, the customer enterprise system 115 obtains historical data corresponding to the characteristics of the workload(s). For example, the telemetry interface 7204 can obtain telemetry data, such as historical data corresponding to the first workload 7302A. In some examples, the historical data can include telemetry data as described above, or portion(s) thereof, obtained in connection with a prior execution of a workload with characteristic(s) that correspond to the characteristic(s) of the first workload 7302A.

At block 7620, the customer enterprise system 115 determines whether to select another semiconductor device to process. For example, the telemetry interface 7204 can determine whether to select the second semiconductor device 105B from which to obtain telemetry data. If, at block 7620, the customer enterprise system 115 determines to select another semiconductor device to process, control returns to block 7606, otherwise control proceeds to block 7622.

At block 7622, the customer enterprise system 115 determines whether to select another server to process. For example, the telemetry interface 7204 can determine whether to select the second server 102B from which to obtain telemetry data. If, at block 7622, the customer enterprise system 115 determines to select another server to process, control returns to block 7604, otherwise control proceeds to block 7624.

At block 7624, the customer enterprise system 115 determines whether to select another platform to process. For example, the telemetry interface 7204 can determine whether to select a different SDSi system than the SDSi system 7200 from which to obtain telemetry data. If, at block 7624, the customer enterprise system 115 determines to select another platform to process, control returns to block 7602, otherwise the example machine readable instructions and/or the example operations 7600 of FIG. 76 conclude.

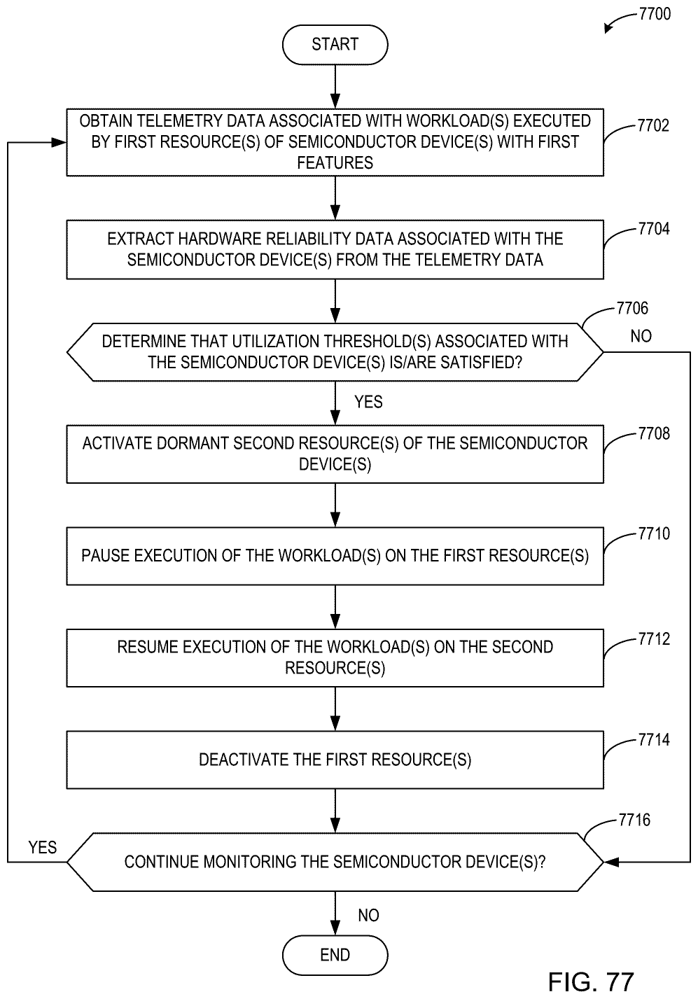

FIG. 77 is a flowchart representative of example machine readable instructions and/or example operations 7700 that may be executed and/or instantiated by processor circuitry to activate dormant features of semiconductor device(s) based on telemetry data. The example machine readable instructions and/or the example operations 7700 of FIG. 77 begin at block 7702, at which the customer enterprise system 115 of FIGS. 1 and/or 72 obtains telemetry data associated with workload(s) executed by first resource(s) of semiconductor device(s) with first features. For example, the telemetry interface 7204 of FIG. 72 can obtain telemetry data from the first semiconductor device 105A. In some examples, the first semiconductor device 105A can execute the first workload 7302A with first feature(s) of the first hardware circuitry 125A, the first firmware 130A, the first BIOS 135A.

At block 7704, the customer enterprise system 115 extracts hardware reliability data associated with the semiconductor device(s) from the telemetry data. For example, the telemetry interface 7204 can identify and/or extract hardware reliability data, such as MTBF data, from the telemetry data. In some examples, the MTBF data can include platform counter(s), hardware counter(s), software counter(s), etc., associated with the first semiconductor device 105A.

At block 7706, the customer enterprise system 115 determines whether the utilization threshold(s) associated with the semiconductor device(s) is/are satisfied. For example, workload classifier 7206 of FIG. 72 can execute an ML model with the telemetry data as data input(s) to the ML model to generate data output(s), which can include determination(s) of whether the compute utilization, the memory utilization, etc., satisfy one or more thresholds.

If, at block 7706, the customer enterprise system 115 determines that the utilization threshold(s) associated with the semiconductor device(s) is/are not satisfied, control proceeds to block 7716. If, at block 7706, the customer enterprise system 115 determines that the utilization threshold(s) associated with the semiconductor device(s) is/are satisfied, control proceeds to block 7708.

At block 7708, the customer enterprise system 115 activates dormant second resource(s) of the semiconductor device(s). For example, the feature configurator 7210 of FIG. 72 can activate and/or otherwise unlock second feature(s) of the first hardware circuitry 125A, the first firmware 130A, the first BIOS 135A.

At block 7710, the customer enterprise system 115 pauses execution of the workload(s) on the first resource(s). For example, the feature configurator 7210 can pause execution of the first workload 7302A by the first hardware circuitry 125A, the first firmware 130A, the first BIOS 135A, etc., utilizing the first feature(s).

At block 7712, the customer enterprise system 115 resumes execution of the workload(s) on the second resource(s). For example, the feature configurator 7210 can resume execution of the first workload 7302A by the first hardware circuitry 125A, the first firmware 130A, the first BIOS 135A, etc., utilizing the second feature(s).

At block 7714, the customer enterprise system 115 deactivates the first resource(s). For example, the feature configurator 7210 can deactivate and/or otherwise lock the first feature(s) of the first hardware circuitry 125A, the first firmware 130A, the first BIOS 135A.

At block 7716, the customer enterprise system 115 determines whether to continue monitoring the semiconductor device(s). For example, the telemetry interface 7204 can determine whether there is additional telemetry to obtain from the first semiconductor device 105A, whether to request additional telemetry from the first semiconductor device 105A based on a data collection period or interval specified by an SLA, etc. If, at block 7716, the customer enterprise system 115 determines to continue monitoring the semiconductor device(s), control returns to block 7702, otherwise the example machine readable instructions and/or the example operations 7700 of FIG. 77 conclude.

FIG. 78 is a block diagram of an example processor platform 7800 structured to execute and/or instantiate the example machine readable instructions and/or the example operations of FIGS. 74-77 to implement the example customer enterprise system 115 of FIGS. 1 and/or 72. The processor platform 7800 can be, for example, any other type of computing device.

The processor platform 7800 of the illustrated example includes processor circuitry 7812. The processor circuitry 7812 of the illustrated example is hardware. For example, the processor circuitry 7812 can be implemented by one or more integrated circuits, logic circuits, FPGAs, microprocessors, CPUs, GPUs, DSPs, and/or microcontrollers from any desired family or manufacturer. The processor circuitry 7812 may be implemented by one or more semiconductor based (e.g., silicon based) devices. In this example, the processor circuitry 7812 implements the example account management service 276 (identified by ACCOUNT MGMT SERVICE), the example entitlement management service 278 (identified by ENTITLEMENT MGMT SERVICE), the example platform inventory management service 274 (identified by PLAT INVENTORY MGMT SERVICE), the example workload classifier 7206, the example feature recommender 7208, the example feature configurator 7210 of FIGS. 1 and/or 72.

The processor circuitry 7812 of the illustrated example includes a local memory 7813 (e.g., a cache, registers, etc.). The processor circuitry 7812 of the illustrated example is in communication with a main memory including a volatile memory 7814 and a non-volatile memory 7816 by a bus 7818. In some examples, the bus 7818 implements the bus 7214 of FIG. 72. The volatile memory 7814 may be implemented by SDRAM, DRAM, RDRAM®, and/or any other type of RAM device. The non-volatile memory 7816 may be implemented by flash memory and/or any other desired type of memory device. Access to the main memory 7814, 7816 of the illustrated example is controlled by a memory controller 7817.

The processor platform 7800 of the illustrated example also includes interface circuitry 7820. The interface circuitry 7820 may be implemented by hardware in accordance with any type of interface standard, such as an Ethernet interface, a USB interface, a Bluetooth® interface, a NFC interface, a PCI interface, and/or a PCIe interface. In this example, the interface circuitry 7820 implements the example client agent 272 and the example telemetry interface 7204 of FIGS. 1 and/or 72.

In the illustrated example, one or more input devices 7822 are connected to the interface circuitry 7820. The input device(s) 7822 permit(s) a user to enter data and/or commands into the processor circuitry 7812. The input device(s) 7822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 7824 are also connected to the interface circuitry 7820 of the illustrated example. The output device(s) 7824 can be implemented, for example, by display devices (e.g., an LED, an OLED, an LCD, a CRT display, an IPS display, a touchscreen, etc.), a tactile output device, a printer, and/or speaker. The interface circuitry 7820 of the illustrated example, thus, typically includes a graphics driver card, a graphics driver chip, and/or graphics processor circuitry such as a GPU.

The interface circuitry 7820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 7826. The communication can be by, for example, an Ethernet connection, a DSL connection, a telephone line connection, a coaxial cable system, a satellite system, a line-of-site wireless system, a cellular telephone system, an optical connection, etc. In this example, the example servers 7202A-C, the example manufacturer enterprise system 110, and the example cloud platform of FIGS. 1 and/or 72 is/are communicatively coupled to the example processor platform 7800 via the example network 7826.

The processor platform 7800 of the illustrated example also includes one or more mass storage devices 7828 to store software and/or data. Examples of such mass storage devices 7828 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives. In this example, the one or more mass storage devices 7828 implement the example secure storage 7203 of FIG. 72.

The machine readable instructions 7832, which may be implemented by the machine readable instructions of FIGS. 74-77, may be stored in the mass storage device 7828, in the volatile memory 7814, in the non-volatile memory 7816, and/or on a removable non-transitory computer readable storage medium such as a CD or DVD.

The processor platform 7800 of the illustrated example of FIG. 78 includes example acceleration circuitry 7840, which includes an example graphics processing unit (GPU) 7842, an example vision processing unit (VPU) 7844, and an example neural network processor 7846. In this example, the GPU 7842, the VPU 7844, and the neural network processor 7846 are in communication with different hardware of the processor platform 7800, such as the volatile memory 7814, the non-volatile memory 7816, etc., via the bus 7818. In this example, the neural network processor 7846 may be implemented by one or more integrated circuits, logic circuits, microprocessors, GPUs, DSPs, or controllers from any desired family or manufacturer that can be used to execute an AI/ML model, such as a neural network, which may be implemented by AI/ML model(s) as described herein. In some examples, one or more of the account management service 276, the entitlement management service 278, the platform inventory management service 274, the workload classifier 7206, the feature recommender 7208, and/or the feature configurator 7210 can be implemented by at least one of the GPU 7842, the VPU 7844, or the neural network processor 7846 instead of or in addition to the processor circuitry 7812.

Systems, Apparatus, Articles of Manufacture, and Methods for Hardware Self-Configuration Using Software-Defined Silicon

Deploying resources, such as hardware (e.g., processor circuitry), to execute workloads in distributed and/or virtualized computing environments can be static. For instance, a target feature set of a compute platform can be tailored to the prospect type of workload to be executed by the compute platform. Given the vast array of features that a manufacturer/vendor offers, such tailoring of hardware has led to emergency of multiple stock keeping units (SKUs) with unique feature sets, which can be adjusted to a particular market segment or even individual customer needs. However, managing multitudes of similar-but-distinct unit types is difficult when managing inventory. Further, such tailoring of hardware is too static for adapting to rapidly changing workload profiles (e.g., compute, memory, etc., profiles), data traffic surges, etc.

Some soft-SKU (SSKU) techniques may allow changes in software to effectuate changes in a feature set of hardware. However, SSKU techniques may rely on a static paradigm in which a platform owner (e.g., a customer enterprise system) preemptively purchases a new capability or feature, which is then enabled during installation, commissioning, deployment, etc. Such SSKU techniques fall short in the presence of relatively highly volatile workload changes, which may require rapid capability set adjustments (e.g., sub-second capability set adjustments).

Examples disclosed herein include systems, apparatus, articles of manufacture, and methods for hardware self-configuration using software-defined silicon (SDSi). In some disclosed examples, a semiconductor device can self-SKU within pre-established boundaries and thereby dynamically effectuate SSKU techniques based on changes in a type of workload and/or performance (e.g., utilization, bandwidth, throughput, latency, etc.) of the semiconductor device when executing a workload. In some disclosed examples, the semiconductor device can self-SKU (e.g., change one or more first features of the semiconductor device to one or more second features using configurable circuitry of the semiconductor device) based on local decision-making, which can be integrated into the semiconductor device itself. For example, the semiconductor device can execute and/or instantiate an Artificial Intelligence/Machine Learning (AI/ML) model using telemetry data as input(s) (e.g., data input(s), model input(s), etc.) to generate output(s) (e.g., data output(s), model output(s), etc.), which can include a recommendation to change feature(s) of the semiconductor device for optimized and/or improved execution of a workload.

In some disclosed, SDSi techniques can be used to access, consume, and/or otherwise utilize upgrade credits or tokens (e.g., licenses, feature credits, feature tokens, non-fungible tokens (NFTs), gas tokens, reconfiguration tokens, etc.), which can be exchanged into hardware capabilities of a semiconductor device. Advantageously, examples disclosed herein can use on-platform analysis (e.g., execution of AI/ML techniques or models) to determine a time at which to upgrade a semiconductor device, feature(s) of the semiconductor device to upgrade, etc., and/or any combination(s) thereof. Advantageously, examples disclosed herein can SKU (e.g., autonomously SKU) a semiconductor device based on a workload executed by the semiconductor device.

In some disclosed examples, SDSi techniques can be used to upgrade and/or unlock dormant resource capacity (e.g., unused core(s) of multi-core processor circuitry, unused hardware accelerators, unused virtualized memory, etc.) based on output(s) from AI/ML models. For example, one or more ML models can be executed using telemetry data as ML model input(s). In some disclosed examples, the telemetry data can be associated with execution of workload(s) by semiconductor device(s), which can include configurable circuitry to activate/deactivate features of the semiconductor device(s). In some disclosed examples, the telemetry data can include workload telemetry data (e.g., characteristic(s) or fingerprint(s) of a workload, a workload sequence including a plurality of workloads, current progress of execution of a workload, etc.), semiconductor telemetry data (e.g., resource utilization(s), activated/deactivated feature(s), etc.), etc.

In some disclosed examples, the one or more ML models can output a characterization, a classification, or a profile of a workload to determine how to optimally (e.g., improve) execute the workload. For example, the one or more ML models can classify a workload as a compute-intensive workload that may require a quantity of compute resources executing in parallel to achieve optimal and/or otherwise improved workload execution. In some disclosed examples, the one or more ML models can output a proposal, a recommendation, a suggestion, etc., of change(s) to feature(s) of a semiconductor device to improve execution of the workload. For example, the recommendation can include unlocking/activating dormant resources to reduce latency, increase throughput, etc., when executing the workload. In some disclosed examples, the recommendation can include locking/deactivating resources that are idle and/or otherwise underutilized to reduce power consumption. Advantageously, in some disclosed examples, a semiconductor device can execute the workload utilizing the unlocked/activated features with increased efficiency, increased throughput, reduced latency, reduced time of execution, etc., and/or any combination(s) thereof, with respect to the semiconductor device executing the workload without utilizing the unlocked/activated features.

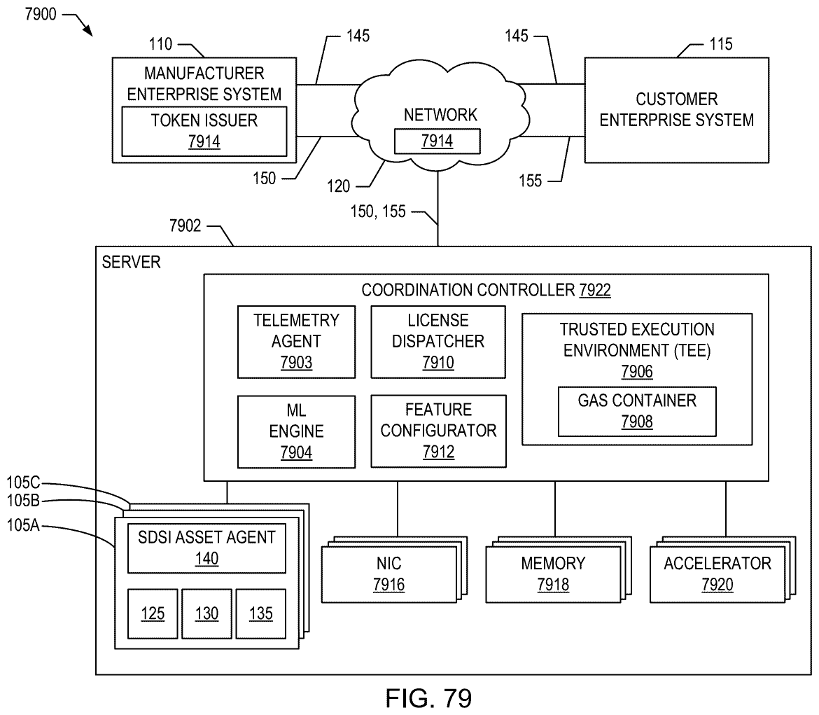

FIG. 79 is a block diagram of an example system (e.g., an SDSi system) 7900 to implement and manage hardware self-configuration based on a recommendation from a machine learning model in accordance with teachings of this disclosure. The SDSi system 7900 of the illustrated example of FIG. 79 includes an example server 7902, which includes a plurality of the example silicon products 105 of FIG. 1 (e.g., a plurality of the SDSi semiconductor devices 105 of FIG. 1, a plurality of the semiconductor assets 105 of FIG. 1, etc.), such as the silicon products 105A-C of FIG. 49. The silicon products 105A-C include respective instantiations of the SDSi asset agent 140 of FIG. 1. The silicon products 105A-C include respective instantiations of the hardware circuitry 125 of FIG. 1, the firmware 130 of FIG. 1, and the BIOS 135 of FIG. 1.

The SDSi asset agent 140 of the example of FIG. 79, and/or, more generally, the semiconductor products 105A-C of the example of FIG. 49, implement SDSi features as disclosed herein. The SDSi system 7900 also includes the example manufacturer enterprise system 110 of FIGS. 1 and/or 49 and the example customer enterprise system 115 of FIGS. 1 and/or 49 to manage the SDSi asset agents 140, and/or, more generally, the semiconductor products 105A-C. In the illustrated example of FIG. 79, at least some aspects of the manufacturer enterprise system 110 and/or the customer enterprise system 115 are implemented as cloud services in the example cloud platform 120 of FIGS. 1 and/or 49.

In the illustrated example of FIG. 79, the manufacturer enterprise system 110 is in communication with the customer enterprise system 115 via a cloud service implemented by the cloud platform 120 (represented by the line labeled 145 of FIGS. 1 and/or 49). In the illustrated example of FIG. 79, the SDSi semiconductor devices 105A-C are in communication with the manufacturer enterprise system 110 via a cloud service implemented by the cloud platform 120 (represented by the line labeled 150 of FIGS. 1 and/or 49). In the illustrated example of FIG. 79, the SDSi semiconductor devices 105A-C are in communication with the customer enterprise system 115 via a cloud service implemented by the cloud platform 120 (represented by the line labeled 155 of FIGS. 1 and/or 49). The manufacturer enterprise system 110 and the cloud platform 120 of the illustrated example of FIG. 79 include an example token issuer 7914. Alternatively, the manufacturer enterprise system 110 and/or the cloud platform 120 may not include the token issuer 7914.

In the illustrated example of FIG. 79, the server 7902 is a computer server, an electronic server, etc., that includes one or more of the SDSi semiconductor devices 105A-C and/or other hardware, such as example network interface cards (NICs) or NIC circuitry 7916, example memory 7918 (e.g., volatile memory, non-volatile memory, etc.), and example accelerators 7920 (e.g., hardware accelerators, artificial intelligence/machine learning (AI/ML) accelerators, etc.). For example, the NIC 7916 can include one or more NICs, the memory 7918 can include one or more memories, and/or the accelerator 7920 can include one or more accelerators. Additionally and/or alternatively, the server 7902 may include any other type of hardware, such as memory controller(s), mass storage device(s), bus(es), input device(s), output device(s), etc., and/or any combination(s) thereof. In some examples, the server 7902 is referred to herein as a customer server (e.g., a customer enterprise server). In some examples, the server 7902 is a virtualized server that is instantiated by the hardware circuitry 125, the firmware 130, and/or the BIOS 135. Alternatively, more than one of the server 7902 may be utilized.

In the illustrated example of FIG. 79, the server 7902 includes an example coordination controller 7922 to coordinate, manage, handle, and/or otherwise control aspect(s) of the semiconductor devices 105A-C. In some examples, the coordination controller 7922 can be implemented by a baseboard management controller (BMC). For example, the coordination controller 7922 can be a BMC that monitors physical state(s) of the semiconductor devices 105A-C, the NIC 7916, the memory 7918, the accelerator 7920, etc., using sensors and communicating with at least one of the manufacturer enterprise system 110 or the customer enterprise system 115 through independent connection(s). In some examples, the coordination controller 7922 can be a BMC that monitors the physical state(s) based on telemetry data associated with portion(s) of the server 7902. Alternatively, the coordination controller 7922 may be implemented by a rack controller, a datacenter orchestrator, or an enterprise resource planning (ERP) system.

In the illustrated example of FIG. 79, the coordination controller 7922 includes an example telemetry agent 7903, an example ML engine 7904, an example trusted execution environment (TEE) 7906, which includes an example gas container 7908. In the illustrated example of FIG. 79, the coordination controller 7922 includes an example license dispatcher 7910 and an example feature configurator 7912.

In the illustrated example of FIG. 79, the coordination controller 7922 includes the telemetry agent 7903 to obtain telemetry data associated with the semiconductor devices 105A-C. For example, the telemetry agent 7903 can obtain telemetry data from the hardware circuitry 125, the firmware 130, the BIOS 135, the SDSi asset agent 140, and/or, more generally, the semiconductor devices 105A-C.

In some examples, the telemetry agent 7903 can obtain telemetry data associated with resource(s) of the semiconductor devices 105A-C. For example, the telemetry data can correspond to, be representative of, and/or otherwise include or indicate data (e.g., data values, metadata, information, measurements, etc.) associated with a resource, such as quality-related information (e.g., hardware, firmware, and/or software parameters, statistics, etc., hardware reliability data such as mean-time between failure (MTBF) data, etc.), configuration information (e.g., hardware, firmware, and/or software attributes, settings, features, etc.), or any other analytics-based data (e.g., hardware counter(s), software counter(s), etc.). As used herein, such quality-related information, configuration information, and/or analytics-based data is generally referred to as telemetry (e.g., telemetry data, telemetry information, etc.).

In some examples, the telemetry data includes resource utilization information associated with the utilization of resource(s) (e.g., hardware resources, software resources, virtual hardware and/or software resources, etc.) and/or the efficiency with which those resources are able to meet the demands placed on them. For example, the telemetry data can include a utilization (e.g., a percentage of a resource that is utilized or not utilized), a delay (e.g., an average delay) in receiving a computation task for execution (e.g., latency), a rate (e.g., an average rate) at which a resource is available (e.g., bandwidth, throughput, etc.), power expenditure, a residency (e.g., a time duration at which the resource is at or within a range of a utilization), etc., associated with one(s) of the resource(s) of the semiconductor devices 105A-C.

In some examples, the telemetry data can include a utilization value (or non-utilization value) of the hardware circuitry 125 (e.g., a utilization value of processor circuitry, a hardware accelerator, etc., or portion(s) thereof (e.g., a utilization value of a compute core of multi-core processor circuitry, a hardware thread of a hardware accelerator, etc.). In some examples, the telemetry data can include a utilization value (or non-utilization value) of the firmware 130, or portion(s) thereof. In some examples, the telemetry data can include a utilization value (or non-utilization value) of the BIOS 135, or portion(s) thereof. In some examples, the telemetry data can include a utilization value (or non-utilization value) of the SDSi asset agent 140, or portion(s) thereof.

In some examples, the telemetry data can include compute utilization data corresponding to a percentage of processor circuitry (e.g., a CPU, a GPU, etc.) of the hardware circuitry 125 being utilized. In some examples, the compute utilization data can include time data (e.g., time durations, time stamps, etc.) identifying a quantity of time at which the processor circuitry of the hardware circuitry 125 is utilized at a specific utilization percentage or within a range of a utilization percentage. In some examples, the compute utilization data can include workload data such as a type of instruction (e.g., machine readable instruction) being executed by the processor circuitry of the hardware circuitry 125.

In some examples, the telemetry data can include storage utilization data corresponding to a percentage or other quantifier of storage, such as a mass storage disc or device, being utilized by the semiconductor devices 105A-C. In some examples, the telemetry data can include cache utilization data associated with cache memory of the semiconductor devices 105A-C 106 being utilized, memory utilization data (e.g., volatile memory utilization data, non-volatile memory utilization data, etc.), etc., associated with memory of the semiconductor devices 105A-C being utilized, etc. Additionally or alternatively, the telemetry data may include any other data associated with utilization(s) of resource(s) of the semiconductor devices 105A-C.

In some examples, the telemetry agent 7903 can obtain telemetry data including utilization threshold(s). For example, the telemetry agent 7903 can obtain a compute utilization threshold from the first semiconductor device 105A. In some examples, the compute utilization threshold can be representative of a utilization or a utilization above which is not to be exceeded in an effort to reduce wear/tear and/or otherwise elongate the lifetime of the first semiconductor device 105A. Additionally and/or alternatively, the telemetry agent 7903 can obtain any other type of utilization threshold (e.g., a storage utilization threshold, a memory utilization threshold, a network or network interface utilization threshold, etc.) with any type of specificity or granularity (e.g., a compute utilization for one core or a plurality of cores of multi-core processor circuitry).

In some examples, the telemetry agent 7903 can obtain telemetry data including hardware reliability data associated with the semiconductor devices 105A-C. For example, the telemetry agent 7903 can receive, request, and/or obtain hardware reliability data associated with the hardware circuitry 125. In some examples, the hardware reliability data can include a number of read/write cycles (e.g., a number of read/write cycles by memory/storage or portion(s)/partition(s) thereof), a number of completed compute or processor cycles by processor circuitry of the hardware circuitry 125, etc., which can be used to estimate remaining useful life of the hardware circuitry 125. In some examples, the hardware reliability data can include MTBF data, which can be specified by a datasheet associated with the hardware circuitry 125, an SLA, an orchestration policy, etc. In some examples, the telemetry agent 7903 can obtain the hardware reliability data from the semiconductor devices 105A-C.

In some examples, the telemetry data includes instruction data such as data associated with an execution of a machine readable instruction by a resource of the semiconductor devices 105A-C. For example, the instruction data can include an indication whether a resource (e.g., a hardware resource of the hardware circuitry 125, a firmware/software resource of the firmware 130 and/or the BIOS 135, etc.) is executing or retiring an instruction, executing a logical cycle, executing a reference cycle, executing a call, executing a direct call, executing a service (e.g., a firmware and/or software service) or process (e.g., a firmware and/or software process, a particular or specified service or process of interest, etc.), etc. In some examples, the telemetry data includes performance counter data such as value(s) of a hardware counter (e.g., a hardware performance counter), a software counter (e.g., a software performance counter), etc., that is used to monitor a function of the resource. For example, the telemetry data can include value(s) of one or more counters implemented by a performance monitoring unit (PMU) of the semiconductor devices 105A-C. In some examples, the instruction data includes a quantity of read/write cycles executed by storage, memory, etc., or portion(s) or partition(s) thereof, a latency of the storage, memory, etc., a percentage or portion of the storage, memory, etc., that is available to execute a storage/memory task, etc.

In some examples, the telemetry agent 7903 determines whether to continue monitoring for telemetry data. For example, the telemetry agent 7903 can determine whether to continue collecting and/or otherwise obtaining telemetry data from one(s) of the semiconductor devices 105A-C based on a service level agreement (SLA), an orchestration policy, etc. In some examples, the telemetry agent 7903 can collect telemetry data and/or request telemetry data based on a data collection period indicated by the SLA, the orchestration policy, etc. For example, the telemetry agent 7903 can collect and/or request telemetry data periodically (e.g., synchronously) (e.g., every second, minute, hour, day, week, month, year, etc.) or a periodically (e.g., asynchronously) based on a trigger or invocation by the telemetry agent 7903, and/or, more generally, the customer enterprise system 115.

In some examples, the telemetry agent 7903 obtains telemetry data including characteristic(s) of workload(s) executed or to be executed by the semiconductor devices 105A-C. For example, the characteristic(s) can include a type of the workload(s), a type of instruction to be executed to complete the workload(s), a number of instructions to be executed, a number of the workload(s) to be executed, a number and/or type(s) of resource(s) to be utilized to execute the workload(s).

In some examples, the telemetry agent 7903 obtains telemetry data including workflow requirements, which can include sequence(s) of workload(s). For example, the telemetry agent 7903 can obtain data indicative of a first workload and whether the first workload has workload dependencies with other workloads. For example, the telemetry agent 7903 can obtain data that indicates that the first workload is to be executed in response to completion of one or more second workloads. In some examples, the telemetry agent 7903 can obtain data that indicates that the first workload is to be executed prior to one or more second workloads. For example, the telemetry data can be indicative of what resource(s) is/are needed to complete a first workload and what resource(s) is/are anticipated to be needed for workload(s) to follow completion (or partial completion) of the first workload.

In some examples, the telemetry agent 7903 obtains telemetry data including feature(s) that is/are activated or deactivated on the semiconductor devices 105A-C. For example, the telemetry agent 7903 can request the first semiconductor device 105A to provide telemetry data that indicates which feature(s) of the hardware circuitry 125, the firmware 130, the BIOS 135, etc., is/are activated or deactivated.

In some examples, the telemetry agent 7903 can obtain historical data, such as historical telemetry data, which corresponds to the semiconductor devices 105A-C and/or workload(s) executed or to be executed by the semiconductor devices 105A-C. For example, the telemetry agent 7903 can obtain telemetry data associated with the first semiconductor device 105A, which can include workload characteristic(s) and/or feature(s) activated/deactivated by the first semiconductor device 105A. In some examples, the telemetry agent 7903 can obtain historical telemetry data generated by the semiconductor devices 105A-C when they executed prior workload(s) having the workload characteristic(s) while utilizing the feature(s). In some examples, the telemetry agent 102 can obtain historical telemetry data from local storage, memory, etc., of the semiconductor devices 105A-C and/or from storage, memory, etc., of the customer enterprise system 115.

In the illustrated example of FIG. 79, the coordination controller 7922 includes the ML engine 7904 to execute and/or instantiate an ML model to classify, profile, and/or otherwise categorize a workload (e.g., an unlabeled workload, a labeled workload), etc., based on the telemetry data associated with the workload(s) executed or to be executed by the semiconductor devices 105A-C. For example, the ML engine 7904 can classify the workload(s) based on an identification of a fingerprint of the workload(s). In some examples, the ML engine 7904 can determine phase residency data from the telemetry data. For example, the phase residency data can be indicative of the time periods of various resource utilization phases exhibited by each workload and the patterns in which the workloads exhibit the resource utilization phases. In some examples, the phase residency data for a given workload can represent a fingerprint (e.g., a resource utilization pattern) unique to the workload. For example, the ML engine 7904 can generate a workload classification for a workload, which may be implemented as any data indicative of the general resource utilization tendencies of the semiconductor devices 105A-C when executing the workload. In some examples, the ML engine 7904 can generate and assign a workload classification for a workload to be compute or processor circuitry intensive, memory intensive, interface or network bandwidth intensive, cache memory intensive, storage intensive, accelerator intensive, security intensive, etc., and/or any combination(s) thereof. Additionally and/or alternatively, the ML engine 7904 may classify a workload using non-AI/ML classification techniques (e.g., statistical analysis or techniques).

In some examples, the ML engine 7904 can classify, profile, and/or otherwise categorize a workload based on an output from the ML model. For example, the ML engine 7904 can provide telemetry data as input(s) (e.g., model input(s)) to an ML model, such as a neural network or any other type of AI/ML model, to generate output(s) (e.g., model output(s)). In some examples, the ML engine 7904 can train or retrain the ML model based on training data, which can include the telemetry data, the historical data, etc., and/or any combination(s) thereof.

In some examples, the ML engine 7904 can execute the ML model using the input(s) to generate the output(s), which can include a classification, a profile, a categorization, etc., of the workload. In some examples, the output(s) from the ML model can include a determination of whether the execution of the workload by one(s) of the semiconductor devices 105A-C is meeting and/or otherwise satisfying an SLA, such as meeting a bandwidth, latency, or throughput requirement indicated by the SLA. In some examples, the output(s) from the ML model can include an estimated, expected, or predicted progress of the workload. For example, the ML engine 7904 can determine a current progress of workload execution (e.g., how much of the workload has been completed, how much of the workload is not completed, etc.) based on the telemetry data from the semiconductor devices 105A-C, which can include which feature(s) of the semiconductor devices 105A-C is/are activated/deactivated. In some examples, the ML engine 7904 can determine an estimated or predicted progress of the workload based on historical data (e.g., historical workload data, historical activated/deactivated features, etc.). For example, the ML engine 7904 can execute the ML model to determine a predicted level of progress for the workload based on previous executions of the workload (or substantially similar workloads) by the semiconductor devices 105A-C (or different semiconductor devices) having the same or substantially similar activated/deactivated features.

In some examples, the ML engine 7904 can determine a difference between the current progress of the workload and the predicted progress of the workload. For example, the ML engine 7904 can determine whether the semiconductor devices 105A-C are underperforming (e.g., the current progress is less than the predicted progress), performing as expected (e.g., the current progress is within a tolerance range of the predicted progress), or overperforming (e.g., the current progress is greater than the predicted progress). In some examples, the ML engine 7904 can determine that dormant feature(s) is/are to be activated to reduce the difference based on a determination that the semiconductor devices 105A-C are underperforming. In some examples, the ML engine 7904 can determine that dormant feature(s) is/are to be deactivated based on a determination that the semiconductor devices 105A-C are overperforming. In some examples, the ML engine 7904 can determine that activated feature(s) is/are to be deactivated and dormant feature(s) is/are to be activated based on a determination that the semiconductor devices 105A-C, or portion(s) thereof, are approaching, meeting, and/or extending beyond hardware reliability limit(s), threshold(s), etc.

In some examples, the ML engine 7904 executes and/or instantiates an ML model to generate a recommendation for configurable circuitry of the semiconductor devices 105A-C with one or more first features to change to one or more second features (e.g., activate/deactivate the one or more first features and/or activate/deactivate the one or more second features). For example, the ML engine 7904 can generate the recommendation by executing an ML model. In some examples, the ML engine 7904 can provide a classification of a workload or characteristic(s) thereof to the ML model as input(s) (e.g., model input(s)) to generate output(s) (e.g., model output(s)), which can be representative of and/or otherwise implement the recommendation. For example, the ML engine 7904 can obtain a classification of a workload that indicates that one(s) of the semiconductor devices 105A-C is/are underperforming when executing workload(s). In some examples, the ML engine 7904 can execute the ML model with the classification as input(s) to generate output(s), which can include a proposal, a recommendation, a suggestion, etc., of feature(s) for the one(s) of the semiconductor devices 105A-C to activate/deactivate to cause the one(s) of the semiconductor devices 105A-C to perform as expected. For example, the ML engine 7904 can generate the recommendation to reduce the difference between the current progress of the workload(s) and the expected progress of the workload(s) and thereby increase and/or otherwise improve the execution of the workload(s) by the one(s) of the semiconductor devices 105A-C.

In the illustrated example of FIG. 79, the coordination controller 7922 includes the TEE 7906 to store (e.g., securely store) data, which can include licenses (e.g., cryptographic tokens, non-fungible tokens (NFTs), gas tokens, reconfiguration tokens, credits, etc.) that can be used to activate/deactivate features. The TEE 7906 of the illustrated example is hardware, software, and/or firmware that can store data and restrict access to the data by unauthorized and/or unverified hardware, software, and/or firmware. For example, the TEE 7906 can be cryptographically protected to restrict and/or otherwise prevent access by unauthorized and/or unverified entities. In some examples, the TEE 7906 is an execution environment in which secure application code can be executed and/or data of interest (e.g., silicon product manufacturer owned cryptographical data) can be protected. In some examples, the TEE 7906 is a compute or computing execution context wherein resources, such as process data, memory, storage, input(s)/output(s) (I/O(s)), etc., are isolated and protected from untrusted and/or unauthorized access. In some examples, the TEE 7906 can take the form of an entire operating system or portion(s) thereof, such as application code running or executing in an isolated environment, such as that provided by Intel® SGX. For example, the TEE 7906 can be a secure computation environment with access to storage that meets/satisfies requirements for data integrity and/or rollback protection. In some examples, the TEE 7906 is a hardware or hardware-based TEE, a software or software-based TEE, or any combination(s) thereof.

In some examples, the TEE 7906 can store AI/ML data, such as training data, inference data, etc. In some examples, the TEE 7906 can store AI/ML model(s), such as a model executable file or configuration image, a binary file or other executable construct, etc. In some examples, the TEE 7906 can store historical data, such as data associated with previously executed workload(s), prior telemetry data, prior configuration(s) of semiconductor device(s) (e.g., identification(s) of hardware, firmware, and/or BIOS feature(s), etc.), etc. In some examples, the TEE 7906 can store telemetry data from the semiconductor devices 105A-C.

In some examples, the TEE 7906 can be implemented by a volatile memory (e.g., SDRAM, DRAM, RDRAM, etc.) and/or a non-volatile memory (e.g., flash memory). For example, the TEE 7906 can be a secure execution environment that can access a volatile memory and/or a non-volatile memory for secure/trusted workload execution. The TEE 7906 may additionally or alternatively be implemented by one or more DDR memories, such as DDR, DDR2, DDR3, DDR4, DDR5, mDDR, DDR SDRAM, etc. The TEE 7906 may additionally or alternatively be implemented by one or more mass storage devices such as HDD(s), CD drive(s), DVD drive(s), SSD drive(s), SD card(s), CF card(s), etc. While in the illustrated example the TEE 7906 is illustrated as a single instance of the TEE 7906, the TEE 7906 may be implemented by any number and/or type(s) of secure storage. Furthermore, the data stored in the TEE 7906 may be in any data format such as, for example, binary data, comma delimited data, tab delimited data, SQL structures, etc.

In the illustrated example of FIG. 79, the TEE 7906 includes the gas container 7908 to store licenses acquired and/or purchased from a license issuer, such as the manufacturer enterprise system 110. In some examples, the licenses can be implemented by credits, tokens (e.g., cryptographic tokens, NFTs, gas tokens, reconfiguration tokens, electronic tokens, etc.), etc., which are stored in the gas container 7908. In some examples, the gas container 7908, and/or, more generally, the semiconductor devices 105A-C, are trusted by the manufacturer enterprise system 110 to handle and/or otherwise manage the licenses securely and/or according to a predetermined set of rules (e.g., a rule not to duplicate the licenses, a rule not to modify the licenses, etc.). For example, the predetermined set of rules can be included and/or otherwise specified by an SLA, an orchestration policy, etc., that is associated with one(s) of the semiconductor devices 105A-C.

In some examples, the licenses are data representative of gas, such as gas utilized by a blockchain, a cryptocurrency (e.g., Ethereum), a smart contract, etc. For example, the licenses can be representative of digital rights or digital rights records carrying gas, which can be representative of a pool of resources (or credits or currency) to allow the semiconductor devices 105A-C to perform (e.g., autonomously perform) SKU reconfigurations at the expense of activating or consuming an amount of the gas. For example, gas can refer to a fee, pricing value, or cost value (e.g., computational cost value) required to successfully conduct a transaction or execute a contract on a blockchain. In the illustrated example, gas stored by the gas container 7908 can be representative of an amount or quantity of computational cost required to utilize a feature of the hardware circuitry 125, the firmware 130, and/or the BIOS 135 for a specified amount of time, number of clock cycles, number of workloads, etc., and/or any combination(s) thereof. For example, the gas stored by the gas container 7908 can be data that, when read by hardware, a machine, processor circuitry, etc., is to be understood as which feature(s) of the semiconductor devices 105A-C can be utilized and/or for what time period(s) the feature(s) can be utilized.

By way of example, the gas stored by the gas container 7908 can be purchased, provisioned, and/or otherwise distributed from the manufacturer enterprise system 110 to the semiconductor devices 105A-C. The provisioned gas can be representative of a form of currency that the semiconductor devices 105A-C can trade (e.g., autonomously trade) for to enable SSKU-able feature set(s) of the semiconductor devices 105A-C choosing. The semiconductor devices 105A-C can consume the gas, or portion(s) thereof (e.g., one unit of gas, two units of gas, ten units of gas, etc.), while the feature set(s) are used. In some examples, the consumption of gas is a one-time consumption (e.g., consumed upon or prior to activation of the feature set(s)) by the semiconductor devices 105A-C. For example, the gas container 7908 of the first semiconductor device 105A can store 50 units of gas. The first semiconductor device 105A can execute an ML model to determine to activate a feature of the hardware circuitry 125. The activation of the feature can cost 10 units of gas. The first semiconductor device 105A can consume 10 units of gas from the gas container 7908 by decrementing, decreasing, etc., the 10 units of gas from the 50 units of gas stored in the gas container 7908. After consuming the 10 units of gas, the first semiconductor device 105A can activate the feature of the hardware circuitry 125 and execute a workload with the activated feature.

In some examples, the consumption of gas is time bound, usage metric/data bound, etc., and/or any combination(s) thereof. By utilizing the example above of the gas container 7908 storing 50 units of gas, the first semiconductor device 105A can execute a workload using the feature, which can cost 10 units of gas per number of computational cycles (e.g., 10 units of gas for every 1000 clock cycles, 50,000 clock cycles, etc.), time duration (e.g., 10 units of gas for every second of feature usage, 10 units of gas for every minute of feature usage, etc.), metric/data (e.g., 10 units of gas for every gigabyte (GB) of data processed using the feature, 10 units of gas for every megabyte (MB) of data received/transmitted using the feature, etc.), etc., and/or any combination(s) thereof.

In some examples, the gas container 7908 can be referred to herein as gas storage or gas wallet, currency or cryptocurrency storage, currency or cryptocurrency wallet, etc. In some examples, the gas container 7908 can store gas generated by the semiconductor devices 105A-C. For example, the first semiconductor device 105A can activate a first feature of the hardware circuitry 125 and deactivate a second feature of the hardware circuitry 125. In some examples, the first semiconductor device 105A can generate unit(s) of gas by maintaining the second feature in the inactive or deactivated state. For example, the first semiconductor device 105A can generate 10 units of gas, 50 units of gas, etc., per unit of time that the second feature is deactivated and/or otherwise not being utilized.

In some examples, the gas container 7908 implements storage for credits or tokens, such as cryptographic credits, cryptographic tokens, firmware/software credits, firmware/software tokens, NFTs, gas tokens, reconfiguration tokens, electronic tokens, compute tokens, etc. For example, the manufacturer enterprise system 110 can mint and/or otherwise generate an NFT associated with a feature of the semiconductor devices 105A-C, such as a feature of the hardware circuitry 125, the firmware 130, and/or the BIOS 135. In some examples, the manufacturer enterprise system 110 and/or the cloud platform 120 include the token issuer 7914 to generate and/or store the NFT in a repository (e.g., a token repository). In some examples, the token issuer 7914 can be implemented by a database, datastore, etc., that stores tokens, such as cryptographic tokens, NFTs, credits, etc. In some examples, the token issuer 7914 can implement a marketplace, an electronic commerce (e-commerce) platform, etc. For example, the token issuer 7914 can be implemented by software interface(s) that can be accessed by electronic device(s) to buy/purchase/procures, sell, exchange, trade, etc., a token such as an NFT associated with an activation/deactivation of semiconductor device feature(s).

In some examples, the manufacturer enterprise system 110 can record entries associated with the NFT in a blockchain. By way of example, the manufacturer enterprise system 110 can record a first entry in a blockchain to memorialize a minting/generation of the NFT. The manufacturer enterprise system 110 can record a second entry in the blockchain to record a purchase or procurement of the NFT by the first semiconductor device 105A. The manufacturer enterprise system 110 can record a third entry in the blockchain to record a transfer of the NFT from the first semiconductor device 105A to the second semiconductor device 105B or from the SDSi system 7900 to a different SDSi system. In some examples, the blockchain can be stored in at least one of the manufacturer enterprise system 110, the cloud platform 120, the customer enterprise system 115, or one(s) of the semiconductor devices 105A-C. In some examples, the token issuer 7914 can store the blockchain or portion(s) thereof. For example, the blockchain (e.g., a public blockchain, a private blockchain, etc.) can be implemented by the token issuer 7914.

In the illustrated example of FIG. 79, the coordination controller 7922 includes the license dispatcher 7910 to handle and/or otherwise manage distribution of licenses from the manufacturer enterprise system 110 (and/or a license marketplace associated with the manufacturer enterprise system 110 such as the token issuer 7914) to the semiconductor devices 105A-C. In some examples, the license dispatcher 7910 (may also be referred to herein as a license manager, a license handler, etc.) receives a license from the customer enterprise system 115. In some examples, the license dispatcher 7910 installs the license on the semiconductor device 105A-C. In some examples, the license dispatcher 7910 stores the license in the TEE 7906. For example, the licenses can be representative of individual credits, tokens, etc., (e.g., 1 license for 1 unit of value, 1 license for credit, 1 license for 1 token, etc.). In some examples, the license dispatcher 7910 erases, deletes, and/or otherwise removes the license from the semiconductor devices 105A-C after the license is consumed, utilized, invoked, activated, etc.

In some examples, the license is signed (e.g., cryptographically signed, electronically signed, etc.) by an issuer of the license (e.g., the manufacturer enterprise system 110). For example, the manufacturer enterprise system 110 can sign the license with a signature targeted for a specific electronic device or platform, such as the first semiconductor device 105A. In some examples, the license includes data that indicates a pool of resources (e.g., data that identifies feature(s) of the semiconductor devices 105A-C to unlock), which can invoke a countersignature by the license dispatcher 7910. For example, the manufacturer enterprise system 110 can generate a license, which includes data to permit up to 8 cores of multi-core processor circuitry to be used by the first semiconductor device 105A. In some examples, the license dispatcher 7910 can sign (e.g., countersign) the license as to the amount of the resources that is allowed to be consumed by the first semiconductor device 105A. For example, the license dispatcher 7910 can determine that the hardware circuitry 125 includes processor circuitry with 4 cores. In some examples, the license dispatcher 7910 can countersign the license with data to indicate that 4 of the 8 cores of the license are to be utilized by the first semiconductor device 105A.

In some examples, the license dispatcher 7910 can disburse units (e.g., units of gas) from the gas container 7908 for consumption by the semiconductor devices 105A-C. For example, the units can be implemented by a license activation code (LAC), such as a temporal LAC, which can be revisioned and/or targeted at a specific component of the semiconductor devices 105A-C being modified. By way of example, the license dispatcher 7910 can request the gas container 7908 for 50 units (e.g., 50 tokens, 50 gas units, etc.) with the intent of redeeming them to upgrade processor circuitry of the hardware circuitry 125 (e.g., a CPU in socket 1 having a unique ID, serial number, etc.). The gas container 7908 can issue a LAC for 50 units, which is valid only for the processor circuitry. The gas container 7908 can remove the 50 units from the pool of units of the gas container 7908. In some examples, the license dispatcher 7910 can sign (e.g., countersign) the resulting LAC with its own key (e.g., cryptographic key, electronic signature key, etc.). In some examples, the processor circuitry can accept the LAC and enable the configuration change. In some examples, if different processor circuitry than the processor circuitry identified by the LAC receives the LAC, then the different processor circuitry may ignore such a configuration change as it has not been authorized by the license dispatcher 7910. Advantageously, in some examples, although the manufacturer enterprise system 110 may issue a license including units to the first semiconductor device 105A, the first semiconductor device 105A may manage allocation of the units by way of the gas container 7908 and/or the license dispatcher 7910 to effectuate relatively rapid changes (e.g., sub second changes in response to changes in workload).

In the illustrated example of FIG. 79, the coordination controller 7922 includes the feature configurator 7912 to cause execution of workload(s) by the semiconductor devices 105A-C based on a change of feature(s) of the semiconductor devices 105A-C invoked by a recommendation output from an ML model. For example, the feature configurator 7912 can direct, instruct, and/or otherwise cause the first semiconductor device 105A to change from first feature(s) to second feature(s) (e.g., change a first feature of the first hardware circuitry 125A, the first firmware 130A, the first BIOS 135A, etc., to a second feature) via SDSi techniques as described herein.

In some examples, the feature configurator 7912 determines whether the semiconductor devices 105A-C are capable of the change(s) indicated by the recommendation. For example, the feature configurator 7912 can determine that the recommendation includes a change of a first feature of the first semiconductor device 105A to a second feature. In some examples, the feature configurator 7912 can determine that the first semiconductor device 105A is configurable to activate the second feature. For example, the feature configurator 7912 can instruct the first semiconductor device 105A to deactivate the first feature and/or activate the second feature. In some examples, the feature configurator 7912 can cause the first semiconductor device 105A to execute a workload with the second feature.

In some examples, the feature configurator 7912 determines a cost to change feature(s) of the semiconductor devices 105A-C. For example, the feature configurator 7912 can determine that a change in a first feature of the hardware circuitry 125 of the first semiconductor device 105A to a second feature has a cost (e.g., a license cost, a gas cost, a consumption cost, etc.) of 20 units (e.g., 20 units of gas, 20 credits or upgrade credits, etc.). In some examples, the feature configurator 7912 can verify whether the units in the gas container 7908 are valid, legitimate, etc., and/or whether the gas container 7908 is authorized to manage the gas in the gas container 7908. Alternatively, the feature configurator 7912 may determine that the units are valid based on a match (or partial match) of an identifier (ID) of the first semiconductor device 105A to an ID associated with the units (e.g., an ID included in and/or stored in connection with the license in the gas container 7908).

In some examples, the feature configurator 7912 can determine whether the cost of 20 units is less than a budget (e.g., a cost budget, a gas budget, etc.) afforded to the first semiconductor device 105A by a license stored in the gas container 7908. For example, the license can grant 50 units to the first semiconductor device 105A and the feature configurator 7912 can determine to proceed with the change to the second feature because the 20 units is less than the budget of 50 units. In some examples, the feature configurator 7912 can acquire, obtain, etc., 20 units from the gas container 7908 to effectuate the change from the first feature to the second feature. For example, the feature configurator 7912 can decrement 20 units from the 50 units to leave 30 units to be stored in the gas container 7908.

In some examples, after the decrementing, the feature configurator 7912 constructs and/or otherwise generates configuration changes to enable the change from the first feature to the second feature. For example, the feature configurator 7912 can identify a first configuration change associated with the hardware circuitry 125, a second configuration change associated with the firmware 130, and/or a third configuration change associated with the BIOS 135 to transition from the first feature to the second feature (or simply activate the second feature). By way of example, the feature configurator 7912 can engage with preemptive kernel features of an operating system executed and/or instantiated by the hardware circuitry 125. The feature configurator 7912 can engage with the preemptive kernel features to enable processor circuitry interruption (e.g., interrupt the processor circuitry executing a workload) to enable a driver for the newly available feature/component. Alternatively, the first semiconductor device 105A may have all available features/components loaded/installed but maintains one(s) of the available features/components in an unavailable state until a license is accepted and/or accessed. In some examples, the feature configurator 7912 can install the feature change. For example, the feature configurator 7912 can pause execution of a workload by the hardware circuitry 125. The feature configurator 7912 can make the first, second, and/or third configuration change. The feature configurator 7912 can resume execution of the workload by the hardware circuitry 125 using the second feature.

In some examples, the feature configurator 7912 can determine that the first semiconductor device 105A does not have sufficient units to activate the second feature. For example, the feature configurator 7912 can deactivate third feature(s) of the first semiconductor device 105A to generate sufficient gas to activate the second feature.

In some examples, the feature configurator 7912 can configure and/or reconfigure the semiconductor devices 105A-C based on recommended feature(s). For example, the feature configurator 7912 can instruct the SDSi asset agent 140 to configure/reconfigure respective one(s) of the hardware circuitry 125, the firmware 130, the BIOS 135, and/or, more generally, the semiconductor devices 105A-C. For example, the feature configurator 7912 can cause the SDSi asset agent 140 to unlock/lock (e.g., enable/disable) a feature of the hardware circuitry 125, the firmware 130, the BIOS 135, etc.

In some examples, the feature configurator 7912 can upgrade (or downgrade) respective one(s) of the hardware circuitry 125, the firmware 130, the BIOS 135, and/or, more generally, the semiconductor devices 105A-C. For example, the feature configurator 7912 can upgrade (or downgrade) and/or otherwise cause a change of a version of the firmware 130 of the first semiconductor device 105A from a first firmware version to a second firmware version.

In example operation, the ML engine 7904 can determine whether to reconfigure portion(s) of the semiconductor devices 105A-C, such as the hardware circuitry 125 of the first semiconductor device 105A, based on telemetry data associated with the hardware circuitry 125. By way of example, assume that the hardware circuitry 125 of the first semiconductor device 105A has two active cores to execute a first workload. In some examples, the two cores can execute a second workload after completion of the first workload. The second workload can be a new workload and/or otherwise different from the first workload, which can cause a performance difference of 25%, such as a workload execution time increasing by 25% (e.g., the second workload is taking 25% longer to complete than the first workload). For example, the ML engine 7904 can calculate, determine, and/or otherwise identify the performance difference of 25% based on telemetry data associated with the two cores, and/or, more generally, the hardware circuitry 125.

By way of example, assume that the ML engine 104 uses a first threshold (e.g., a reconfiguration threshold) of 20% and/or a second threshold (e.g., an experiment or experimental threshold of 5%) to generate recommendation(s) to change feature(s) of the hardware circuitry 125. Alternatively, any other value(s) of the first threshold and/or the second threshold may be used. In example operation, the ML engine 7904 can determine that the performance difference of 25% as described above satisfies the first threshold of 20% because the performance difference of 25% is greater than the first threshold of 20%. Based on the determination that the first threshold is satisfied, the ML engine 7904 can determine that the performance difference is significant enough to justify active adaptation, learning, tuning, etc., in determining change(s) to feature(s) of the hardware circuitry 125, such as an increase in a number of active cores to execute the second workload (and/or subsequent workloads).

In example operation, the ML engine 7904 can execute an ML model to generate output(s), which can include a recommendation to upgrade the hardware circuitry 125 from two cores to four cores to execute the second workload. In some examples, the ML engine 7904 can generate the recommendation as an initial guess or recommendation if the utilized ML model is not yet trained to generate recommendation(s) associated with workload(s) of type(s) corresponding to the second workload. After the recommendation, the feature configurator 7912 can cause the configuration change to occur, such as activating/unlocking two additional cores to be used to process the second workload.

In example operation, after the configuration change, the telemetry agent 7903 can obtain telemetry data from the four cores, and/or, more generally, the hardware circuitry 125, to determine whether workload execution performance changed in response to the activation/unlocking of the two additional cores. In some examples, the telemetry agent 7903 can determine that the execution time of the second workload has sped up by 10%. The ML engine 7904 can determine that the speed up in execution time of 10% is a meaningful and/or substantial enough change in performance because the speed up of 10% is greater than the second threshold of 5%. Advantageously, the ML engine 7904 can determine that the change from two cores to four cores is a valid change because of the observed speed up of 10% being greater than the second threshold of 5%. Advantageously, the ML engine 7904 can receive the feedback of 10% (and associated telemetry data) to generate another recommendation in an effort to achieve greater performance gain with respect to the speed up of 10%.

In example operation, the ML engine 7904 can generate another recommendation to upgrade the hardware circuitry 125 from four active cores to eight active cores. In some examples, the telemetry agent 7903 can determine that the resulting speed up in execution time is 1% (e.g., a 1% increase in execution time using eight cores with respect to using four cores). The ML engine 7904 can determine that the 1% of observable gain is not significant enough to continue generating additional recommendations because the 1% observable gain is less than the second threshold of 5%. In some examples, the ML engine 7904 can determine to cease generating recommendations in connection with the hardware circuitry 125 and/or alternatively may generate recommendations to adjust the firmware 130 and/or the BIOS 135, such as by increasing the clock speed of the eight active cores to determine whether an increase in performance gain may be achieved.

In example operation, based on the determination that the 1% observable gain is less than the second threshold of 5%, the feature configurator 7912 can undo the last change, such as by deactivating the previously activated four cores to cause the hardware circuitry 125 to utilize four cores (instead of the eight cores indicated by the previous recommendation of the ML engine 7904). In example operation, the hardware circuitry 125 can transition to normal or stable operation where the hardware circuitry 125 executes workloads until the workloads differ enough to warrant a new learning or experimental phase to identify change(s) in feature(s) of the hardware circuitry 125 to optimize and/or otherwise improve execution of the workloads. Advantageously, the ML engine 7904 can update the ML model with observed data (e.g., training data, learning data, etc.), such as the telemetry data that caused the acceptance of the recommendation of using four active cores, the telemetry data that caused the rejection of the recommendation of using eight active cores, etc. Advantageously, the ML engine 7904 can train, retrain, and/or otherwise update the ML model using the observed data to improve prediction capabilities of the ML engine 7904 to identify change(s) in feature set(s) without the need of experimentation as described above.

Advantageously, the semiconductor devices 105A-C can utilize platform counters and/or other platform performance telemetry to be monitored by an in band or out of band agent, such as the SDSi asset agent 140. For example, the SDSi asset agent 140 can execute ML model(s) based on the telemetry data to output insight(s) into how workloads may be optimized and/or otherwise improved on the hardware circuitry 125, the firmware 130, the BIOS 135, etc., based on the workload runtime characteristics and/or available features of the semiconductor devices 105A-C. Advantageously, the semiconductor devices 105A-C can obtain additional telemetry data for workloads that are members of strictly or loosely coupled workflows, where specific insights can utilized for load balancing operations, high availability resource management, and/or scheduling time sensitive, deterministic workloads.

Advantageously, the semiconductor devices 105A-C can generate (e.g., locally generate) recommendations to be used by the semiconductor devices 105A-C for reconfiguring the semiconductor devices 105A-C for existing workloads. Advantageously, the semiconductor devices 105A-C can generate (e.g., locally generate) predictive recommendations for trends associated with workloads executed by the semiconductor devices 105A-C that can indicate when feature(s) is/are to be activated/turned on to satisfy an SLA of interest.

Advantageously, in some examples, the license dispatcher 7910 can consume tokens, NFTs, etc., in a continuous and/or iterative manner instead of via a one-time consumption (e.g., consumed for a fixed amount of gas, tokens, etc.). For example, the license dispatcher 7910 can consume the tokens, NFTs, etc., for as long as the feature(s) remain(s) enabled and a number of the tokens, NFTS, etc., may be depleted (e.g., gradually depleted). In some examples, the feature configurator 7912 can cause the SDSi asset agent 140 to deactivate the feature(s) if the number of the tokens, NFTS, etc., are depleted without being replenished (e.g., gas is generated by deactivating other feature(s), a new license is procured from the manufacturer enterprise system 110, etc.).

As used herein, data is information in any form that may be ingested, processed, interpreted and/or otherwise manipulated by processor circuitry to produce a result. The produced result may itself be data.

As used herein “threshold” is expressed as data such as a numerical value represented in any form, that may be used by processor circuitry as a reference for a comparison operation.

As used herein, a model is a set of instructions and/or data that may be ingested, processed, interpreted and/or otherwise manipulated by processor circuitry to produce a result. Often, a model is operated using input data to produce output data in accordance with one or more relationships reflected in the model. The model may be based on training data.

While an example manner of implementing the server 7902 of FIG. 79 is illustrated in FIG. 79, one or more of the elements, processes, and/or devices illustrated in FIG. 79 may be combined, divided, re-arranged, omitted, eliminated, and/or implemented in any other way. Further, the example telemetry agent 7903, the example ML engine 7904, the example TEE 7906, the example gas container 7908, the example license dispatcher 7910, the example feature configurator 7912, and/or, more generally, the example coordination controller 7922, the example SDSi asset agent 140, the example hardware circuitry 125, the example firmware 130, the example BIOS 135, and/or, more generally, the example semiconductor devices 105A-C, the example NIC 7916, the example memory 7918, the example accelerator 7920, and/or, more generally, the example server 7902, of FIGS. 1, 49, and/or 79, may be implemented by hardware alone or by hardware in combination with software and/or firmware. Thus, for example, any of the example telemetry agent 7903, the example ML engine 7904, the example TEE 7906, the example gas container 7908, the example license dispatcher 7910, the example feature configurator 7912, and/or, more generally, the example coordination controller 7922, the example SDSi asset agent 140, the example hardware circuitry 125, the example firmware 130, the example BIOS 135, and/or, more generally, the example semiconductor devices 105A-C, the example NIC 7916, the example memory 7918, the example accelerator 7920, and/or, more generally, the example server 7902, could be implemented by processor circuitry, analog circuit(s), digital circuit(s), logic circuit(s), programmable processor(s), programmable microcontroller(s), GPU(s), DSP(s), ASIC(s), PLD(s)) and/or FPLD(s) such as FPGAs. Further still, the example server 7902 FIGS. 1, 49, and/or 79 may include one or more elements, processes, and/or devices in addition to, or instead of, those illustrated in FIG. 79, and/or may include more than one of any or all of the illustrated elements, processes and devices.

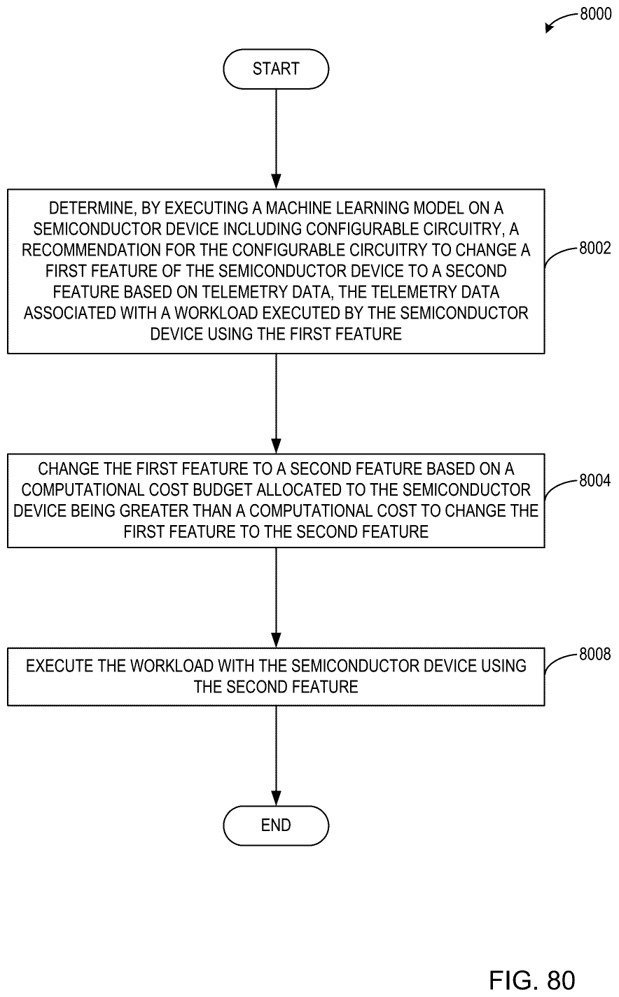

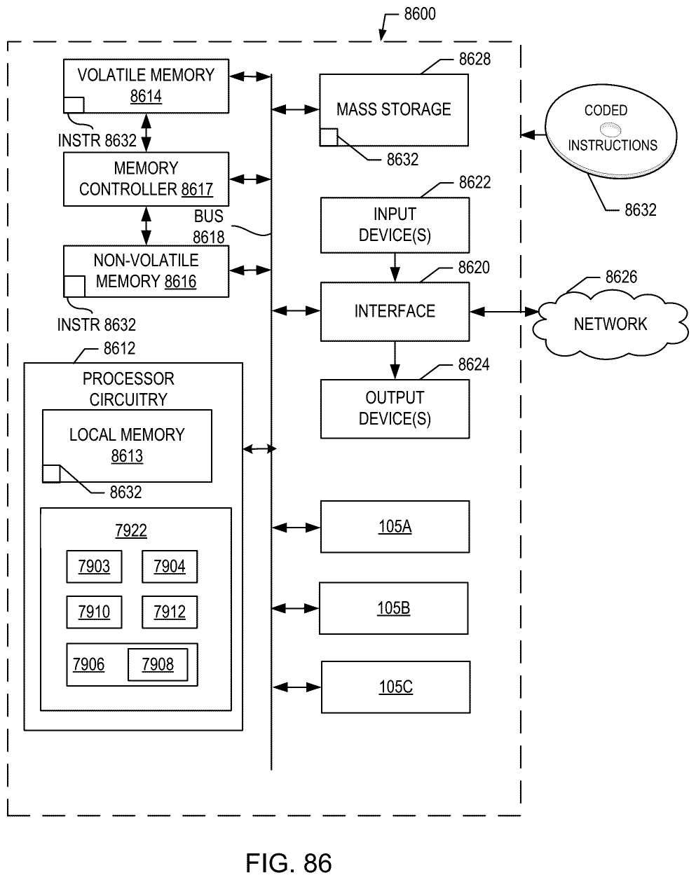

Flowcharts representative of example machine readable instructions which may be executed to configure processor circuitry to implement the example server 7902, the example manufacturer enterprise system 110, the example customer enterprise system 115, and/or, more generally, the example SDSi system 7900 of FIG. 79, are shown in FIGS. 80-85. The machine readable instructions may be one or more executable programs or portion(s) of an executable program for execution by processor circuitry, such as the processor circuitry 8612 shown in the example processor platform 8600 discussed below in connection with FIG. 86 and/or the example processor circuitry discussed below in connection with FIGS. 150 and/or 151. The program may be embodied in software stored on one or more non-transitory computer readable storage media such as a CD, a floppy disk, an HDD, an SSD, a DVD, a Blu-ray disk, a volatile memory (e.g., RAM of any type, etc.), or a non-volatile memory (e.g., electrically EEPROM, FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a RAN) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 80-85, many other methods of implementing the example server 7902, the example manufacturer enterprise system 110, the example customer enterprise system 115, and/or, more generally, the example SDSi system 7900 of FIG. 79, may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an op-amp, a logic circuit, etc.) structured to perform the corresponding operation without executing software or firmware. The processor circuitry may be distributed in different network locations and/or local to one or more hardware devices (e.g., a single-core processor (e.g., a single core CPU), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a DLL), an SDK, an API, etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HTML, SQL, Swift, etc.

As mentioned above, the example operations of FIGS. 80-85 may be implemented using executable instructions (e.g., computer and/or machine readable instructions) stored on one or more non-transitory computer and/or machine readable media such as optical storage devices, magnetic storage devices, an HDD, a flash memory, a ROM, a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or RAID systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

FIG. 80 is a flowchart representative of example machine readable instructions and/or example operations 8000 that may be executed and/or instantiated by processor circuitry to execute a workload based on a recommendation of feature change(s) from machine learning model(s). The example machine readable instructions and/or the example operations 8000 of FIG. 80 begin at block 8002, at which the coordination controller 7922 of FIG. 79 determines, by executing a machine learning model on a semiconductor device including configurable circuitry, a recommendation for the configurable circuitry to change a first feature of the semiconductor device to a second feature based on telemetry data, the telemetry data associated with a workload executed by the semiconductor device using the first feature. For example, the ML engine 7904 of FIG. 79 can execute an ML model with telemetry data as input(s) to generate output(s), which can include a recommendation for the feature configurator 7912 of FIG. 79 to change a first feature of the hardware circuitry 125 to a second feature.

At block 8004, the coordination controller 7922 changes the first feature to a second feature based on a computational cost budget allocated to the semiconductor device being greater than a computational cost to change the first feature to the second feature. For example, the feature configurator 7912 can change the first feature of the hardware circuitry 125 to the second feature based on a determination that a number of units (e.g., a number of units of gas) in the gas container 7908 is greater than a number of units needed to effectuate the change.

At block 8004, the coordination controller 7922 executes the workload with the semiconductor device using the second feature. For example, the feature configurator 7912 can cause the hardware circuitry 125 to execute the workload with the second feature. In response to executing the workload with the semiconductor device using the second feature at block 8008, the example machine readable instructions and/or the example operations 8000 of FIG. 80 conclude.

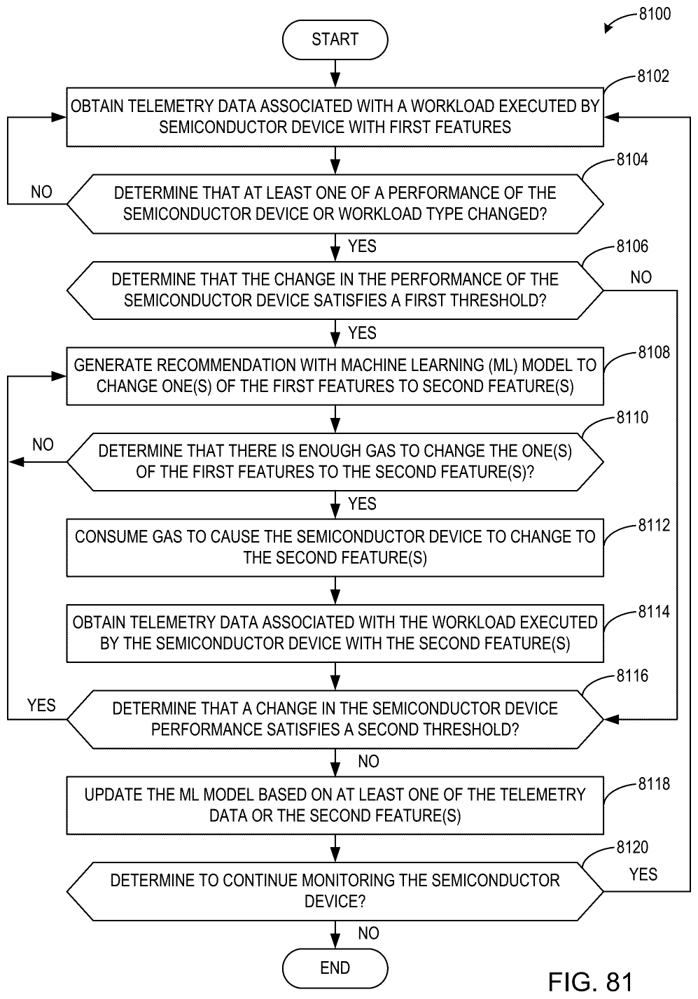

FIG. 81 is a flowchart representative of example machine readable instructions and/or example operations 8100 that may be executed and/or instantiated by processor circuitry to change feature(s) of semiconductor device(s) based on telemetry data associated with the semiconductor device(s). The example machine readable instructions and/or the example operations 8100 of FIG. 81 begin at block 8102, at which the coordination controller 7922 of FIG. 79 obtains telemetry data associated with a workload executed by semiconductor device with first features. For example, the telemetry agent 7903 of FIG. 79 can obtain telemetry data associated with a workload executed by at least one of the hardware circuitry 125, the firmware 130, or the BIOS 135 with first feature(s) (e.g., a number of active cores of processor circuitry, a type of active hardware accelerator(s), etc.).

At block 8104, the coordination controller 7922 determines whether at least one of a performance of the semiconductor device or workload type changed. For example, the ML engine 7904 of FIG. 79 can execute an ML model with telemetry data as input(s) to generate output(s), which can include a detection of a change in performance (e.g., a change in utilization, bandwidth, throughput, latency, etc.) of the hardware circuitry 125 during execution of a workload, a detection of a change in a type of the workload being executed by the hardware circuitry 125, etc., and/or any combination(s) thereof.

If, at block 8104, the coordination controller 7922 determines that at least one of a performance of the semiconductor device or workload type did not change, control returns to block 8102, otherwise control proceeds to block 8106. At block 8106, the coordination controller 7922 determine whether the change in the performance of the semiconductor device satisfies a first threshold. For example, the ML engine 7904 can determine that an increase of 25% in compute utilization of the hardware circuitry 125 of the first semiconductor device 105A satisfies a first threshold (e.g., a performance change threshold, a compute utilization change threshold, a reconfiguration or reconfiguration trigger threshold, etc.) of 20%. In some examples, the first threshold can be a reconfiguration threshold, which is representative of a threshold at which a reconfiguration of portion(s) of the semiconductor devices 105A-C is to occur for improved workload execution.

At block 8108, the coordination controller 7922 generates a recommendation with a machine learning (ML) model to change one(s) of the first features to second feature(s). For example, the ML engine 7904 can execute an ML model to generate output(s), which can include a recommendation for configurable circuitry of the semiconductor devices 105A-C to change from one(s) of the first features to second feature(s), such as changing from four active cores of processor circuitry to eight active cores of the processor circuitry of the hardware circuitry 125.

At block 8110, the coordination controller 7922 determines that there is enough gas to change the one(s) of the first features to the second feature(s). For example, the license dispatcher 7910 of FIG. 79 can determine whether the gas container 7908 has sufficient gas to facilitate the change from the one(s) of the first features to the second feature(s). If, at block 8108, the coordination controller 7922 determines that there is not enough gas to change the one(s) of the first features to the second feature(s), control returns to block 8108, otherwise control proceeds to block 8112.

At block 8112, the coordination controller 7922 consumes gas to cause the semiconductor device to change to the second feature(s). For example, the license dispatcher 7910 can decrease an amount of gas stored in the gas container 7908 by an amount corresponding to the change from the one(s) of the first features to the second feature(s).

At block 8114, the coordination controller 7922 obtains telemetry data associated with the workload executed by the semiconductor device with the second feature(s). For example, the telemetry agent 7903 can obtain telemetry data associated with a workload executed by at least one of the hardware circuitry 125, the firmware 130, or the BIOS 135 with the second feature(s). In some examples, the telemetry data is generated in response to the at least one of the hardware circuitry 125, the firmware 130, or the BIOS 135 executing the workload with the second feature(s).

At block 8116, the coordination controller 7922 determines that a change in the semiconductor device performance satisfies a second threshold. For example, the ML engine 7904 can determine whether a change in the semiconductor performance satisfies a second threshold. For example, the ML engine 7904 can determine that after the change from four active cores to eight active cores, a change in an execution time of the workload of the processor circuitry sped up by 10%, which can be greater than a second threshold (e.g., a performance change threshold, a compute utilization change threshold, etc.) of 5%. In some examples, the second threshold can be an experimental threshold below which is not a significant enough gain in performance to further tune change(s) to feature(s) of the semiconductor device(s) and/or above which is a significant enough gain in performance to further tune change(s) to achieve additional gain in performance. For example, the second threshold can be implemented by a delta of a parameter pre and post change in feature(s). In some examples, the second threshold can be implemented by a delta of time (e.g., a delta or change in execution time) that the first semiconductor device 105A takes to complete a workload (or portion(s) of the workload) before the change in feature(s) and after the change in feature(s). In some examples, the second threshold can be implemented by a delta of utilization (e.g., a delta or change in compute utilization, storage utilization, memory utilization, etc.) before the change in feature(s) and after the change in feature(s).

If, at block 8116, the coordination controller 7922 determines that a change in the semiconductor device performance satisfies a second threshold, control returns to block 8108. For example, the ML engine 7904 can determine that the change from four active cores to eight active cores yielded a performance gain that satisfied an experimental threshold and additional cores may be activated to achieve further performance gain.

If, at block 8116, the coordination controller 7922 determines that a change in the semiconductor device performance does not satisfy a second threshold, control proceeds to block 8118. At block 8118, the coordination controller 7922 updates the ML model based on at least one of the telemetry data or the second feature(s). For example, the ML engine 7904 can train/retrain and/or otherwise update the ML model using at least one of the telemetry data or the change in features of the hardware circuitry 125 from four cores to eight cores.

At block 8120, the coordination controller 7922 determines whether to continue monitoring the semiconductor device. For example, the telemetry agent 7903 can determine whether there is additional telemetry data to request and/or obtain in connection with the semiconductor devices 105A-C. If, at block 8120, the coordination controller 7922 determines to continue monitoring the semiconductor device, control returns to block 8102, otherwise the example machine readable instructions and/or the example operations 8100 conclude.

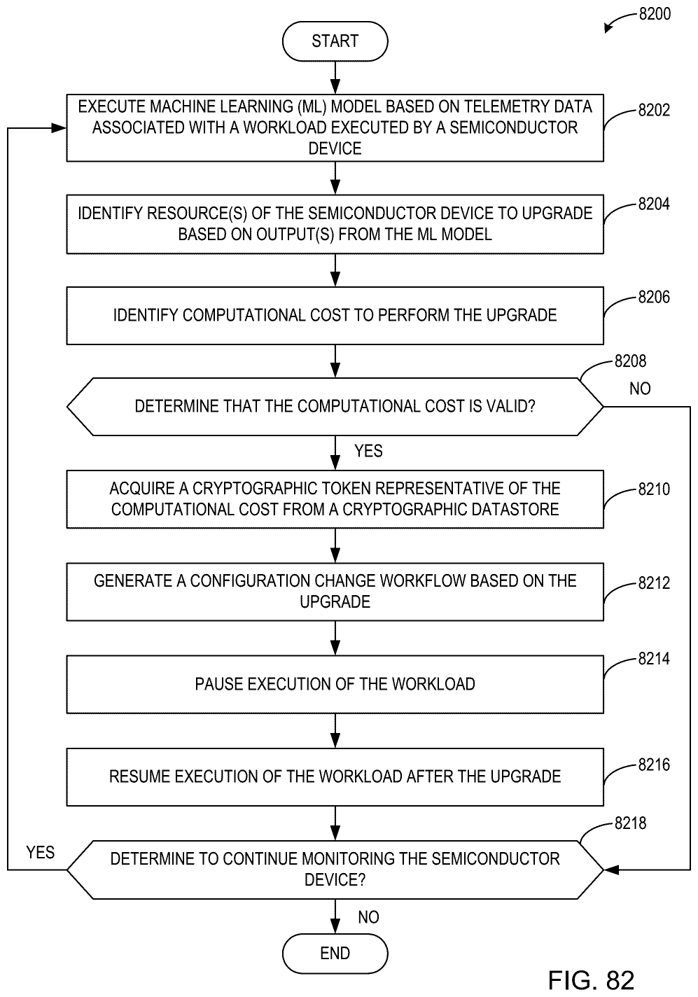

FIG. 82 is a flowchart representative of example machine readable instructions and/or example operations 8200 that may be executed and/or instantiated by processor circuitry to resume execution of a workload on a semiconductor device after an upgrade of the semiconductor device. The example machine readable instructions and/or the example operations 8200 of FIG. 82 begin at block 8202, at which the coordination controller 7922 of FIG. 79 executes a machine learning (ML) model based on telemetry data associated with a workload executed by a semiconductor device. For example, the ML engine 7904 of FIG. 79 can execute an ML model, such as a neural network, using telemetry data associated with workload(s) executed by the semiconductor devices 105A-C as input(s) to the ML model.

At block 8204, the coordination controller 7922 identifies resource(s) of the semiconductor device to upgrade based on output(s) from the ML model. For example, the license dispatcher 7910 of FIG. 79 can determine that the output(s) from the ML model identify a number of cores of processor circuitry of the hardware circuitry 125 to upgrade.

At block 8206, the coordination controller 7922 identifies a computational cost to perform the upgrade. For example, the license dispatcher 7910 can identify a computational cost of 50 units (e.g., 50 units of gas, 50 credits or upgrade credits, etc.) associated with increasing a number of cores of the processor circuitry.

At block 8208, the coordination controller 7922 determines whether the computational cost is valid. For example the license dispatcher 7910 can determine whether the units stored in the gas container 7908 of FIG. 79 are valid. In some examples, the license dispatcher 7910 can determine that the units are valid based on a comparison (e.g., a match or partial match) of an ID or other data of the processor circuitry to an ID or other data associated with the units stored in the gas container 7908.

If, at block 8208, the coordination controller 7922 determines that the computational cost is not valid, control proceeds to block 8218. For example, the license dispatcher 7910 can request the manufacturer enterprise system 110 for a license to grant the requisite units to the semiconductor devices 105A-C to complete the upgrade.

If, at block 8208, the coordination controller 7922 determines that the computational cost is valid, control proceeds to block 8210. At block 8210, the coordination controller 7922 acquires a cryptographic token representative of the computational cost from a cryptographic datastore. For example, the license dispatcher 7910 can acquire a cryptographic token, an NFT, etc., representative of the 50 units from the gas container 7908. In some examples, the license dispatcher 7910 can acquire the cryptographic token, the NFT, etc., by removing it from the gas container 7908.

At block 8212, the coordination controller 7922 generates a configuration change workflow based on the upgrade. For example, the feature configurator 7912 of FIG. 79 can identify one or more configuration changes in sequence, which can include a pause in execution of the workload, to be executed to upgrade the number of cores of the processor circuitry.

At block 8214, the coordination controller 7922 pauses execution of the workload. For example, the feature configurator 7912 can generate a hardware, firmware, and/or software interrupt to pause an execution of a workload by the hardware circuitry 125.

At block 8216, the coordination controller 7922 resumes execution of the workload after the upgrade. For example, the feature configurator 7912 can upgrade the hardware circuitry 125 from a first number of active cores to a second number of active cores, from a first clock frequency to a second clock frequency, etc., and/or any combination(s) thereof.

At block 8218, the coordination controller 7922 determines whether to continue monitoring the semiconductor device. For example, the telemetry agent 7903 can determine whether there is available telemetry data to request and/or obtain from the semiconductor devices 105A-C and/or whether an upgrade of the semiconductor devices 105A-C is/are needed. If, at block 8218, the coordination controller 7922 determines to continue monitoring the semiconductor device, control returns to block 8202, otherwise the example machine readable instructions and/or the example operations 8200 conclude.

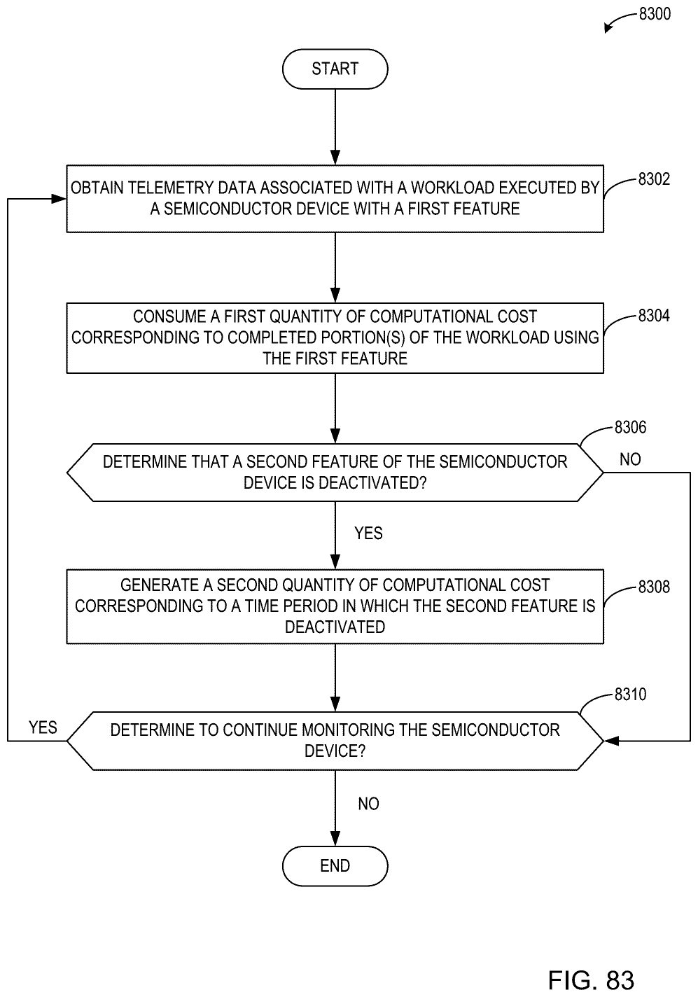

FIG. 83 is a flowchart representative of example machine readable instructions and/or example operations 8300 that may be executed and/or instantiated by processor circuitry to manage consumption and/or generation of computational cost(s) of a semiconductor device. The example machine readable instructions and/or the example operations 8300 of FIG. 83 begin at block 8302, at which the coordination controller 7922 of FIG. 79 obtains telemetry data associated with a workload executed by a semiconductor device with a first feature. For example, the telemetry agent 7903 of FIG. 79 can obtain telemetry data from the first semiconductor device 105A. In some examples, the first semiconductor device 105A can execute a workload with a first feature of the hardware circuitry 125, such as a first clock frequency of core(s) of processor circuitry.

At block 8304, the coordination controller 7922 consumes a first quantity of computational cost corresponding to completed portion(s) of the workload using the first feature. For example, the license dispatcher 7910 of FIG. 79 can acquire token(s), unit(s) of gas, etc., from the gas container 7908 to be exchanged for execution of portion(s) of the workload.

At block 8306, the coordination controller 7922 determines whether a second feature of the semiconductor device is deactivated. For example, the feature configurator 7912 of FIG. 79 can determine that a second feature of the hardware circuitry 125, such as enablement of an FPGA to accelerate the workload, is deactivated.

If, at block 8306, the coordination controller 7922 determines that a second feature of the semiconductor device is not deactivated, control proceeds to block 8310. If, at block 8306, the coordination controller 7922 determines that a second feature of the semiconductor device is deactivated, control proceeds to block 8308.

At block 8308, the coordination controller 7922 generates a second quantity of computational cost corresponding to a time period in which the second feature is deactivated. For example, the license dispatcher 7910 can generate token(s), unit(s) of gas, etc., and store the generated token(s), the unit(s) of gas, etc., in the gas container 7908. In some examples, the license dispatcher 7910 can generate the token(s), the unit(s) of gas, etc., by adding the token(s) in the gas container 7908, incrementing a number of unit(s) of gas in the gas container 7908 in the gas container 7908, etc. In some examples, the license dispatcher 7910 can be authorized to increment the number of unit(s) of gas in the gas container 7908 by signing (e.g., countersigning) a license in the gas container 7908 and become authorized based on the signing. In some examples, the generated token(s), the number of unit(s), etc., can be utilized by any semiconductor device in the SDSi system 7900, such as one(s) of the semiconductor devices 105A-C. In some examples, the generated token(s), the number of unit(s), etc., can be generated separately from any workload execution. For example, first processor circuitry of the hardware circuitry 125 can generate gas on each cycle the first processor circuitry is powered off at a first stage or point in time. In some examples, second processor circuitry of the hardware circuitry 125 can consume the generated gas by the first processor circuitry at a later stage or point in time.

At block 8310, the coordination controller 7922 determines whether to continue monitoring the semiconductor device. For example, the telemetry agent 7903 can determine whether there is additional telemetry to obtain from the first semiconductor device 105A, whether to request additional telemetry from the first semiconductor device 105A based on a data collection period or interval specified by an SLA, etc. If, at block 8310, the coordination controller 7922 determines to continue monitoring the semiconductor device, control returns to block 8302, otherwise the example machine readable instructions and/or the example operations 8300 of FIG. 83 conclude.

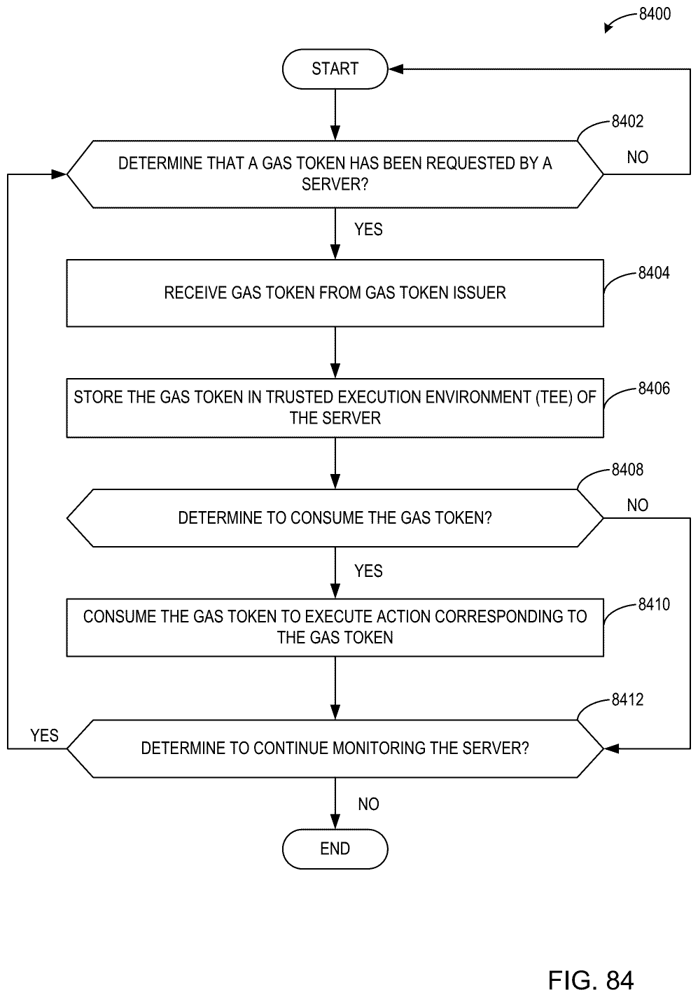

FIG. 84 is a flowchart representative of example machine readable instructions and/or example operations 8400 that may be executed and/or instantiated by processor circuitry to manage consumption and/or removal of token(s) of a semiconductor device. The example machine readable instructions and/or the example operations 8400 of FIG. 84 begin at block 8402, at which the coordination controller 7922 of FIG. 79 determines that a gas token has been requested by a server. For example, the license dispatcher 7910 of FIG. 79 can determine that a gas token (e.g., a cryptographic token, an NFT, etc.), which can be used to execute an action in connection with one(s) of the semiconductor devices 105A-C, has been requested from the manufacturer enterprise system 110. For example, the action can be activating a feature of the hardware circuitry 125, the firmware 130, and/or the BIOS 135.

If, at block 8402, the coordination controller 7922 determines that a gas token has not been requested by the server, control waits (e.g., wait until triggered or invoked to make another determination). If, at block 8402, the coordination controller 7922 determines that a gas token has been requested by a server, control proceeds to block 8404.

At block 8404, the coordination controller 7922 receives a gas token from a gas token issuer. For example, the license dispatcher 7910 can receive an NFT from the token issuer 7914, and/or, more generally, the manufacturer enterprise system 110 and/or the cloud platform 120.

At block 8406, the coordination controller 7922 stores the gas token in a trusted execution environment (TEE) of the server. For example, the license dispatcher 7910 can store the NFT in the gas container 7908, and/or, more generally, the TEE 7906, of the server 7902.

At block 8408, the coordination controller 7922 determines whether to consume the gas token. For example, the ML engine 7904 of FIG. 79 can execute and/or instantiate an ML model to generate an output, which can include a recommendation to upgrade the first semiconductor device 105A via consuming and/or accessing the NFT from the gas container 7908.

If, at block 8408, the coordination controller 7922 determines not to consume the gas token, control proceeds to block 8412, otherwise control proceeds to block 8410. At block 8410, the coordination controller 7922 consumes the gas token to execute an action corresponding to the gas token. For example, the license dispatcher 7910 can determine that the recommendation to upgrade the first semiconductor device 105A can be achieved by consuming the NFT stored in the gas container 7908. In some examples, the license dispatcher 7910 can consume the NFT by instructing and/or otherwise causing the feature configurator 7912 of FIG. 79 to activate the feature(s) included in, corresponding to, and/or otherwise referenced by the NFT. Additionally and/or alternatively, the license dispatcher 7910 may consume the NFT by informing the manufacturer enterprise system 110 that the first semiconductor device 105A activated the feature(s) referenced by the NFT, which can cause the manufacturer enterprise system 110 to record an entry in a blockchain to record the activation.

At block 8412, the coordination controller 7922 determines whether to continue monitoring the server. For example, the telemetry agent 7903 can determine whether there is additional telemetry to obtain from the first semiconductor device 105A, whether to request additional telemetry from the first semiconductor device 105A based on a data collection period or interval specified by an SLA, etc. If, at block 8412, the coordination controller 7922 determines to continue monitoring the server, control returns to block 8402, otherwise the example machine readable instructions and/or the example operations 8400 of FIG. 84 conclude.

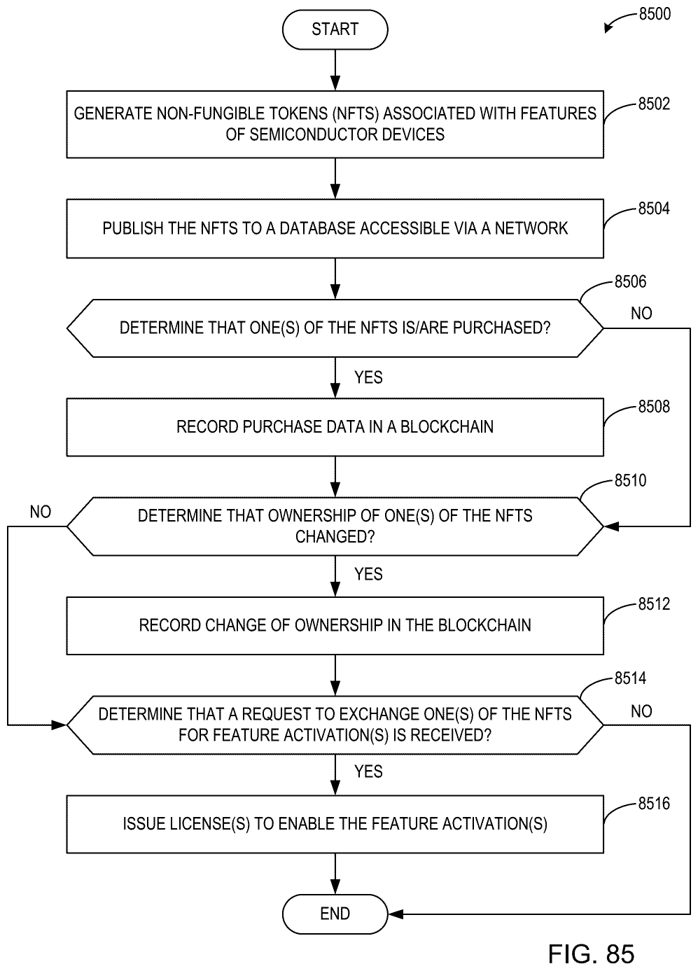

FIG. 85 is a flowchart representative of example machine readable instructions and/or example operations 8500 that may be executed and/or instantiated by processor circuitry to manage generation and/or disbursement of non-fungible tokens associated with feature(s) of semiconductor device(s). The example machine readable instructions and/or the example operations 8500 of FIG. 85 begin at block 8502, at which the manufacturer enterprise system 110 of FIGS. 1, 49, and/or 79 generates non-fungible tokens (NFTs) associated with features of semiconductor devices. For example, the token issuer 7914 of FIG. 79 can generate a plurality of NFTs associated with respective feature(s) that can be activated/deactivates on an electronic device, such as one(s) of the semiconductor devices 105A-C.

At block 8504, the manufacturer enterprise system 110 publishes the NFTs to a database accessible via a network. For example, the token issuer 7914 can store the NFTs (or any other types of tokens associated with feature activation(s)/deactivation(s)) in a datastore or database, which can be accessible via the cloud service implemented by the cloud platform 120 (represented by the line labeled 150 of FIGS. 1, 49, and/or 79).

At block 8506, the manufacturer enterprise system 110 determines whether one(s) of the NFTs is/are purchased. For example, the token issuer 7914 can determine that a first NFT is procured by the first semiconductor device 105A.

If, at block 8506, the manufacturer enterprise system 110 determines that one(s) of the NFTs is/are not purchased, control proceeds to block 8510, otherwise control proceeds to block 8508. At block 8508, the manufacturer enterprise system 110 records purchase data in a blockchain. For example, the token issuer 7914 can write an entry in a blockchain (e.g., a blockchain data structure). In some examples, the entry can include purchase data, such as an ID of the first semiconductor device 105A, an ID of the purchased NFT, a timestamp, an Internet Protocol (IP) address associated with the first semiconductor device 105A, a media access control (MAC) address associated with the first semiconductor device 105A, etc., and/or any combination(s) thereof.

At block 8510, the manufacturer enterprise system 110 determines whether ownership of one(s) of the NFTs changed. For example, the token issuer 7914 can determine whether ownership of the NFT changed from the first semiconductor device 105A to the second semiconductor device 105B based on telemetry data obtained from at least one of the first semiconductor device 105A or the second semiconductor device 105B.

At block 8512, the manufacturer enterprise system 110 records a change of ownership in the blockchain. For example, the token issuer 7914 can record the change in ownership of the NFT in the blockchain, which can be stored in and/or by the token issuer 7914 and/or other storage location(s) of the SDSi system 7900.

At block 8514, the manufacturer enterprise system 110 determines whether a request to exchange one(s) of the NFTs for feature activation(s) is received. For example, the token issuer 7914 can determine whether a request from the first semiconductor device 105A to exchange the NFT for activation(s) of feature(s) referenced by the NFT.

If, at block 8514, the manufacturer enterprise system 110 determines that a request to exchange one(s) of the NFTs for feature activation(s) is not received, the example machine readable instructions and/or the example operations 8500 of FIG. 85 conclude. If, at block 8514, the manufacturer enterprise system 110 determines that a request to exchange one(s) of the NFTs for feature activation(s) is received, control proceeds to block 8516.

At block 8516, the manufacturer enterprise system 110 issue(s) license(s) to enable the feature activation(s). For example, the token issuer 7914 can generate and/or otherwise issue a license in exchange for the NFT. In some examples, the token issuer 7914 can transmit the license to the license dispatcher 7910 by way of the cloud platform 120 and/or the agent interface 202. For example, the license dispatcher 7910 can process the license and/or cause the feature configurator 7912 to enable the features specified and/or otherwise granted by the license. In response to issuing license(s) to enable the feature activation(s) at block 8516, the example machine readable instructions and/or the example operations 8500 of FIG. 85 conclude.

FIG. 86 is a block diagram of an example processor platform 8600 structured to execute and/or instantiate the example machine readable instructions and/or the example operations of FIGS. 80-85 to implement the example coordination controller 7922 of FIG. 79, and/or, more generally, the example server 7902 of FIG. 79. The processor platform 8600 can be, for example, any type of computing or electronic device.

The processor platform 8600 of the illustrated example includes processor circuitry 8612. The processor circuitry 8612 of the illustrated example is hardware. For example, the processor circuitry 8612 can be implemented by one or more integrated circuits, logic circuits, FPGAs, microprocessors, CPUs, GPUs, DSPs, and/or microcontrollers from any desired family or manufacturer. The processor circuitry 8612 may be implemented by one or more semiconductor based (e.g., silicon based) devices. In this example, the processor circuitry 8612 implements the example telemetry agent 7903, the example license dispatcher 7910, the example ML engine 7904, the example TEE 7906, the example gas container 7908, and the example feature configurator 7912 of FIG. 79.

The processor circuitry 8612 of the illustrated example includes a local memory 8613 (e.g., a cache, registers, etc.). The processor circuitry 8612 of the illustrated example is in communication with a main memory including a volatile memory 8614 and a non-volatile memory 8616 by a bus 8618. The volatile memory 8614 may be implemented by SDRAM, DRAM, RDRAM®, and/or any other type of RAM device. The non-volatile memory 8616 may be implemented by flash memory and/or any other desired type of memory device. Access to the main memory 8614, 8616 of the illustrated example is controlled by a memory controller 8617.

The processor platform 8600 of the illustrated example also includes interface circuitry 8620. The interface circuitry 8620 may be implemented by hardware in accordance with any type of interface standard, such as an Ethernet interface, a USB interface, a Bluetooth® interface, an NFC interface, a PCI interface, and/or a PCIe interface.

In the illustrated example, one or more input devices 8622 are connected to the interface circuitry 8620. The input device(s) 8622 permit(s) a user to enter data and/or commands into the processor circuitry 8612. The input device(s) 8622 can be implemented by, for example, an audio sensor, a microphone, a camera (still or video), a keyboard, a button, a mouse, a touchscreen, a track-pad, a trackball, an isopoint device, and/or a voice recognition system.

One or more output devices 8624 are also connected to the interface circuitry 8620 of the illustrated example. The output device(s) 8624 can be implemented, for example, by display devices (e.g., an LED, an OLED, an LCD, a CRT display, an IPS display, a touchscreen, etc.), a tactile output device, a printer, and/or speaker. The interface circuitry 8620 of the illustrated example, thus, typically includes a graphics driver card, a graphics driver chip, and/or graphics processor circuitry such as a GPU.

The interface circuitry 8620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 8626. The communication can be by, for example, an Ethernet connection, a DSL connection, a telephone line connection, a coaxial cable system, a satellite system, a line-of-site wireless system, a cellular telephone system, an optical connection, etc.

The processor platform 8600 of the illustrated example also includes one or more mass storage devices 8628 to store software and/or data. Examples of such mass storage devices 8628 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 8632, which may be implemented by the machine readable instructions of FIGS. 80-85, may be stored in the mass storage device 8628, in the volatile memory 8614, in the non-volatile memory 8616, and/or on a removable non-transitory computer readable storage medium such as a CD or DVD. Further depicted in the illustrated example of FIG. 86 are the semiconductor devices 105A-C of FIG. 79. In the illustrated example, the semiconductor devices 105A-C are connected to other component(s) of the processor platform 8600 via the bus 8618.

Systems, Apparatus, Articles of Manufacture, and Methods for Reduced Footprint Agents Using Software-Defined Silicon

Typically, compute infrastructure owners are highly security sensitive and particularly attuned to compute aspects that may result in compromised infrastructure. To protect data centers and/or other compute systems or environments, compute infrastructure owners prefer to limit outside involvement. For example, compute infrastructure owners may prefer to limit external network connections, external traffic, and/or external agents (particularly in-band agents) as these aspects may introduce opportunities for compromise and/or other undesirable actions such as data exfiltration. While important for security, such a posture of limiting outside involvement may be at odds with trending shifts to outsourcing where software and services are delivered by third parties and the delivery of as-a-service (aaS) offerings are effectuated by tools like agents to provision product offerings.

Examples disclosed herein include systems, apparatus, articles of manufacture, and methods for reduced footprint agents using software-defined silicon (SDSi). In some disclosed examples, a customer enterprise system can instantiate, compile, and/or otherwise generate reduced footprint agents (RFAs) that can be provided as executables (e.g., binaries, executable binaries, executable files, etc.) to install, configure, and/or execute hardware, software, and/or service(s). For example, after an operation (e.g., installing, configuring, and/or executing hardware, software, and/or service(s)) is completed, the RFAs can leave a reduced footprint (e.g., a zero footprint, a near-zero footprint, an approximately zero footprint, etc.) by being uninstalled and/or otherwise removed from a platform (e.g., an electronic device, a semiconductor device, a compute platform, etc.). In some disclosed examples, the RFA can be utilized to provision a license to activate a dormant or unlocked feature of a platform. Advantageously, in some disclosed examples, the platform can execute workload(s) utilizing the unlocked/activated features with increased efficiency, increased throughput, reduced latency, reduced time of execution, etc., and/or any combination(s) thereof, with respect to the platform device executing the workload(s) without utilizing the unlocked/activated features effectuated by the RFA.

In some disclosed examples, an RFA upon activation can install an executable file to be executed to perform an action, an operation, a task, etc., such as a collection of telemetry data associated with a platform, a provisioning of a license to the platform, execution of a service or software routine, etc. Advantageously, in some examples, after the executable is installed, the RFA can uninstall and/or otherwise remove itself from the platform and thereby leave no footprint behind other than a successfully provisioned license, a data log indicating a success or failure to do so, etc., and/or any combination(s) thereof. In some examples, the data log can be omitted to further reduce a footprint of the RFA on the platform. Advantageously, by removing itself after completing specified or necessary action(s), the RFA can cause less residual code to remain on the platform and thereby increase security of the platform (as well as alleviate some concerns of the compute infrastructure owners). In some disclosed examples, the RFA can be delivered to a trusted execution environment (TEE) via a secure protocol and/or executed in the TEE for enhanced security. Other example applications of the RFA can include information technology (IT) and/or return material authorization (RMA) workflows in which a technician or other personnel of an original equipment manufacturer (OEM) can apply a modification or update to a platform with minimal instructions, process, procedures, tools, etc. For example, the RFA can be deployed to a platform to upgrade the platform and, after the upgrade, the RFA can remove itself to reduce residual code on the platform. For example, the residual code may subsequently be utilized by malicious actors or entities to compromise the platform and removal of such residual code can enhance security of the platform.

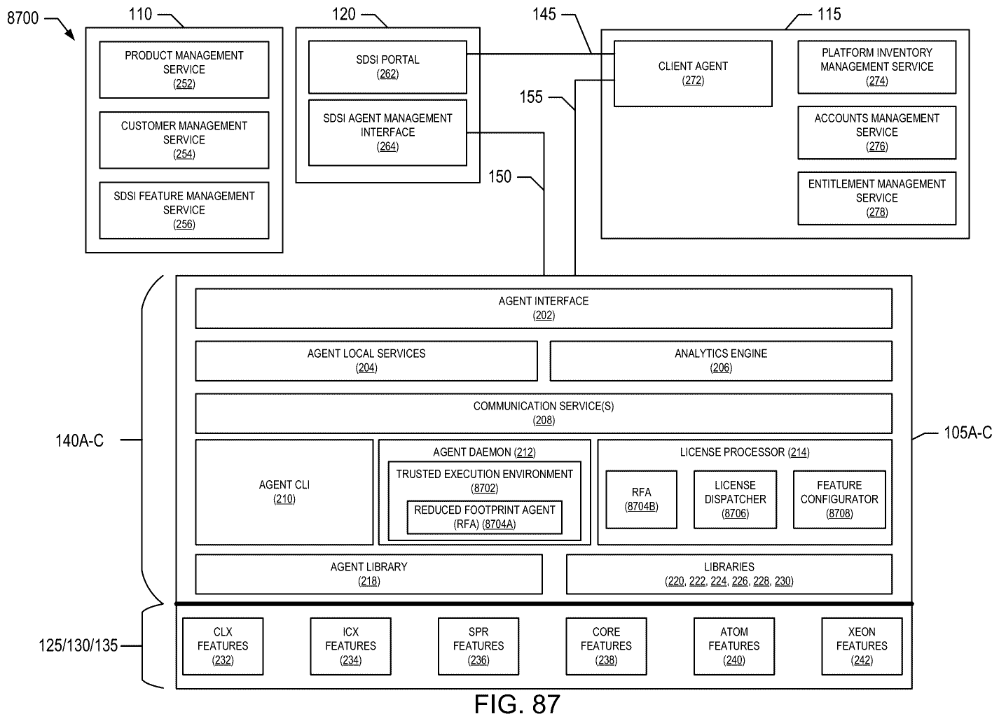

FIG. 87 is a block diagram of an example system (e.g., an SDSi system) 8700 to implement and manage reduced footprint agents (RFAs) in accordance with teachings of this disclosure. The SDSi system 8700 of the illustrated example of FIG. 87 includes a plurality of the example silicon products 105 of FIG. 1 (e.g., a plurality of the SDSi semiconductor devices 105 of FIG. 1, a plurality of the semiconductor assets 105 of FIG. 1, etc.), such as the silicon products 105A-C of FIG. 49. The silicon products 105A-C include respective instantiations of the SDSi asset agent 140 of FIG. 1, such as the SDSi asset agents 140A-C of FIG. 49. The silicon products 105A-C include respective instantiations of the hardware circuitry 125 of FIG. 1, the firmware 130 of FIG. 1, and the BIOS 135 of FIG. 1.

The SDSi asset agents 140A-C of the example of FIG. 87, and/or, more generally, the semiconductor products 105A-C of the example of FIG. 49, implement SDSi features as disclosed herein. The SDSi system 8700 also includes the example manufacturer enterprise system 110 of FIGS. 1 and/or 49 and the example customer enterprise system 115 of FIGS. 1 and/or 49 to manage the SDSi asset agents 140A-C of FIG. 49, and/or, more generally, the semiconductor products 105A-C of FIG. 49. In the illustrated example of FIG. 87, at least some aspects of the manufacturer enterprise system 110 and/or the customer enterprise system 115 are implemented as cloud services in the example cloud platform 120 of FIGS. 1 and/or 49.

In the illustrated example of FIG. 87, the manufacturer enterprise system 110 is in communication with the customer enterprise system 115 via a cloud service implemented by the cloud platform 120 (represented by the line labeled 145 of FIGS. 1 and/or 49). In the illustrated example of FIG. 87, the SDSi semiconductor devices 105A-C are in communication with the manufacturer enterprise system 110 via a cloud service implemented by the cloud platform 120 (represented by the line labeled 150 of FIGS. 1 and/or 49). In the illustrated example of FIG. 87, the SDSi semiconductor devices 105A-C are in communication with the customer enterprise system 115 via a cloud service implemented by the cloud platform 120 (represented by the line labeled 155 of FIGS. 1 and/or 49).

The manufacturer enterprise system 110 of the illustrated example of FIG. 87 includes the product management service 252, the customer management service 254, and the SDSi feature management service 256 of FIG. 2. The cloud platform 120 of the illustrated example of FIG. 87 includes the SDSi portal 262 and the SDSi agent management interface 264 of FIG. 2. The customer enterprise system 115 of the illustrated example of FIG. 87 includes the client agent 272, the platform inventory management service 274, the accounts management service 276, and the entitlement management service 278 of FIG. 2.

In the illustrated example of FIG. 87, the SDSi asset agents 140A-C include respective instantiations of the agent interface 202, the agent local services 204, the analytics engine 206, the communication service(s) 208, the agent CLI 210, the agent daemon 212, the license processor 214, the agent library 218, the libraries 220, 222, 224, 226, 228, 230, and the features 232, 234, 236, 238, 240, 242 of FIG. 2. In the illustrated example of FIG. 87, the agent daemon 212 includes an example trusted execution environment (TEE) 8702, which includes a first example RFA 8704A. In the illustrated example of FIG. 87, the license processor 214 includes a second example RFA 8704B, an example license dispatcher 8706, and an example feature configurator 8708. In some examples, the first RFA 8704A and the second RFA 8704B are the same (e.g., instances of each other). In some examples, the first RFA 8704A and the second RFA 8704B are different. In some examples, the SDSi asset agents 140A-C may include the first RFA 8704A and may not include the second RFA 8704B. In some examples, the SDSi asset agents 140A-C may not include the first RFA 8704A and may include the second RFA 8704B.

In the illustrated example of FIG. 87, the analytics engine 206 obtains telemetry data associated with the semiconductor devices 105A-C as described herein. For example, the analytics engine 206 can obtain telemetry data from the hardware circuitry 125, the firmware 130, the BIOS 135, the SDSi asset agents 140A-C, and/or, more generally, the semiconductor devices 105A-C.

In the illustrated example of FIG. 87, the agent daemon 212 includes the TEE 8702 to store (e.g., securely store) data, such as the first RFA 8704A. In some examples, the TEE 8702 can store licenses, which can be used to activate/deactivate features of the hardware circuitry 125, the firmware 130, and/or the BIOS 135. The TEE 8702 of the illustrated example is hardware, software, and/or firmware that can store data and restrict access to the data by unauthorized and/or unverified hardware, software, and/or firmware. For example, the TEE 8702 can be cryptographically protected to restrict and/or otherwise prevent access by unauthorized and/or unverified entities. In some examples, the TEE 8702 is an execution environment in which secure application code can be executed and/or data of interest (e.g., silicon product manufacturer owned cryptographical data) can be protected. In some examples, the TEE 8702 is a compute or computing execution context wherein resources, such as process data, memory, storage, input(s)/output(s) (I/O(s)), etc., are isolated and protected from untrusted and/or unauthorized access. In some examples, the TEE 8702 can take the form of an entire operating system or portion(s) thereof, such as application code running or executing in an isolated environment, such as that provided by Intel® SGX. In some examples, the TEE 8702 is a hardware or hardware-based TEE, a software or software-based TEE, or any combination(s) thereof.

In some examples, the TEE 8702 can be implemented by a volatile memory (e.g., SDRAM, DRAM, RDRAM, etc.) and/or a non-volatile memory (e.g., flash memory). The TEE 8702 may additionally or alternatively be implemented by one or more DDR memories, such as DDR, DDR2, DDR3, DDR4, DDR5, mDDR, DDR SDRAM, etc. The TEE 8702 may additionally or alternatively be implemented by one or more mass storage devices such as HDD(s), CD drive(s), DVD drive(s), SSD drive(s), SD card(s), CF card(s), etc. While in the illustrated example the TEE 8702 is illustrated as a single instance of the TEE 8702, the TEE 8702 may be implemented by any number and/or type(s) of secure storage. Furthermore, the data stored in the TEE 8702 may be in any data format such as, for example, binary data, comma delimited data, tab delimited data, SQL

In the illustrated example of FIG. 87, the TEE 8702 includes the first RFA 8704A to provision a license to activate/deactivate a feature and/or execute a service or other software routine. In the illustrated example of FIG. 87, the license processor 214 includes the second RFA 8704B to provision a license to activate/deactivate a feature and/or execute a service or other software routine.

In some examples, the RFAs 8704A-B can be implemented by an executable file (e.g., an executable binary file) that includes at least one of an installer or a license. For example, the RFAs 8704A-B can be implemented by an installer that, when executed, can install and/or configure a component (e.g., a firmware and/or software component), a service (e.g., a firmware and/or software service, a driver, a kernel, etc.), etc., to carry out and/or otherwise perform a compute task, operation, or workload. In some examples, the RFAs 8704A-B can be implemented by a license that, when provisioned by the installer, can activate/deactivate feature(s) of the semiconductor devices 105A-C.

In some examples, the RFAs 8704A-B uninstall, delete, and/or otherwise remove themselves after they are executed and complete their intended or programmed function(s). Advantageously, after removal of the RFAs 8704A-B, a resulting footprint of the RFAs 8704A-B may be only the provisioned license(s) and/or data log(s) recording success(es) and/or failure(s) of the programmed function(s). Additionally and/or alternatively, the RFAs 8704A-B may be utilized to carry out any other type of compute task (e.g., aside from license provisioning), such as telemetry data collection, installing update(s) to software, the firmware 130, and/or the BIOS 135 of the semiconductor devices 105A-C, compressing/decompressing data of interest, encrypting/decrypting data of interest, etc., and/or any combination(s) thereof. For example, the RFAs 8704A-B can be (i) executed and/or instantiated to periodically (e.g., in response to a timer, counter, or time duration elapsing or reaching a threshold value) or a periodically (e.g., in response to an asynchronous request from the semiconductor devices 105A-C, the manufacturer enterprise system 110, the customer enterprise system 115, etc.) collect and/or transmit telemetry data to a server (e.g., the manufacturer enterprise system 110, the customer enterprise system 115, etc.) and (ii) removed after the prescribed action(s) is/are complete.

In some examples, the RFAs 8704A-B can be executed and/or instantiated during platform/system boot (e.g., during boot of the firmware 130, the BIOS 135, etc.) or during runtime (e.g., to prepare for and/or to force a reboot of the platform/system) to enact management action(s), routine(s), etc., and/or enforce policies (e.g., service level agreements (SLAs), orchestration policies, etc.). For example, the RFAs 8704A-B can enact management action(s), routine(s), etc., and/or enforce policies on existing licenses associated with the semiconductor devices 105A-C that are in place for activations to manage compliancy between contracts and license activation/active license rights and privileges. In some examples, the RFAs 8704A-B can be invoked by an application or instrumentation to run scenarios and activation for on-demand activation. Advantageously, the RFAs 8704A-B can complete provisioning of licenses needed for providing products, services, etc., while keeping platforms, such as the semiconductor devices 105A-C, free of superfluous code that may subsequently become compromised or a source of malicious attacks or exploits.

In the illustrated example of FIG. 87, the license processor 214 includes the license dispatcher 8706 to handle and/or otherwise manage distribution of licenses from the manufacturer enterprise system 110 to the semiconductor devices 105A-C. In some examples, the license dispatcher 8706 (may also be referred to herein as a license manager, a license handler, etc.) receives a license from the manufacturer enterprise system 110. In some examples, the license dispatcher 8706 installs the license on the semiconductor device 105A-C. In some examples, the license dispatcher 8706 stores the license in the TEE 8702.

In some examples, the license is signed (e.g., cryptographically signed, electronically signed, etc.) by an issuer of the license (e.g., the manufacturer enterprise system 110). For example, the manufacturer enterprise system 110 can sign the license with a signature targeted for a specific electronic device or platform, such as the first semiconductor device 105A. In some examples, the license includes data that indicates a pool of resources (e.g., data that identifies feature(s) of the semiconductor devices 105A-C to unlock), which can invoke a countersignature by the license dispatcher 8706. For example, the manufacturer enterprise system 110 can generate a license, which includes data to permit up to 8 cores of multi-core processor circuitry to be used by the first semiconductor device 105A. In some examples, the license dispatcher 8706 can sign (e.g., countersign) the license as to the amount of the resources that is allowed to be consumed by the first semiconductor device 105A. For example, the license dispatcher 8706 can determine that the hardware circuitry 125 includes processor circuitry with 4 cores. In some examples, the license dispatcher 8706 can countersign the license with data to indicate that 4 of the 8 cores of the license are to be utilized by the first semiconductor device 105A.

In the illustrated example of FIG. 87, the license processor 214 includes the feature configurator 8708 to cause execution of workload(s) by the semiconductor devices 105A-C based on a change of feature(s) of the semiconductor devices 105A-C invoked by a recommendation output from an ML model. For example, the feature configurator 8708 can direct, instruct, and/or otherwise cause the first semiconductor device 105A to change from first feature(s) to second feature(s) (e.g., change a first feature of the first hardware circuitry 125A, the first firmware 130A, the first BIOS 135A, etc., to a second feature) via SDSi techniques as described herein.

In some examples, the feature configurator 8708 determines whether the semiconductor devices 105A-C are capable of the change(s) indicated by the recommendation. For example, the feature configurator 8708 can determine that the recommendation includes a change of a first feature of the first semiconductor device 105A to a second feature. In some examples, the feature configurator 8708 can determine that the first semiconductor device 105A is configurable to activate the second feature. For example, the feature configurator 8708 can instruct the first semiconductor device 105A to deactivate the first feature and/or activate the second feature. In some examples, the feature configurator 8708 can cause the first semiconductor device 105A to execute a workload with the second feature.

In some examples, the feature configurator 8708 can configure and/or reconfigure the semiconductor devices 105A-C based on recommended feature(s). For example, the RFAs 8704A-B can invoke and/or otherwise cause the feature configurator 8708 to configure/reconfigure respective one(s) of the hardware circuitry 125, the firmware 130, the BIOS 135, the SDSi asset agents 140A-C, and/or, more generally, the semiconductor devices 105A-C. For example, the feature configurator 8708 can unlock/lock (e.g., enable/disable) a feature of the hardware circuitry 125, the firmware 130, the BIOS 135, etc.

In some examples, the feature configurator 8708 can upgrade (or downgrade) respective one(s) of the hardware circuitry 125, the firmware 130, the BIOS 135, the SDSi asset agents 140A-C, and/or, more generally, the semiconductor devices 105A-C. For example, the RFAs 8704A-B can invoke and/or otherwise cause the feature configurator 8708 to upgrade (or downgrade) and/or otherwise change a version of the firmware 130 of the first semiconductor device 105A from a first firmware version to a second firmware version.

In example operation, the customer enterprise system 115 can initiate a request for a license or an agent (e.g., the RFAs 8704A-B) to complete an action by calling the SDSi portal 262 of the cloud platform 120. In example operation, the SDSi portal 262, and/or, more generally, the cloud platform 120, can determine whether the request is valid. For example, the SDSi portal 262 can determine that the request is valid based on determinations that the customer is known, is authorized to make a request for products/services or tasks/actions to be completed, etc., and/or any combination(s) thereof. In example operation, the SDSi portal 262 can either respond to the call with an error if something is wrong with the request (e.g., the request is not validated) or it will initiate the generation of a license and/or agent to fulfill the request (e.g., the request is validated). In example operation, the SDSi feature management service 256, and/or, more generally, the manufacturer enterprise system 110, can examine the request for validity associated with the product/services requested using additional criteria and either report an error (e.g., the request is not validated) or generate the requested license/agent in the form of a binary executable that can be deployed by the customer enterprise system 115 (e.g., the request is validated). In example operation, the SDSi feature management service 256 can provide and/or otherwise output the executable binary to the SDSi portal 262 and/or the SDSi agent management interface 264. For example, the SDSi agent management interface 264 can transmit the executable binary to the agent interface 202, which, in turn, can store the executable binary in the TEE 8702, the license processor 214, etc. In some examples, the SDSi portal 262 can transmit the executable binary to the client agent 272. In some examples, the client agent 272 can relay and/or otherwise transmit the executable binary to the agent interface 202, which, in turn, can store the executable binary in the TEE 8702, the license processor 214, etc. For example, the customer enterprise system 115 can deploy the executable binary to one(s) of the semiconductor devices 105A-C.

In some examples, the executable binary can be executed and/or instantiated in the TEE 8702 to install the first RFA 8704A. In some examples, the executable binary can be executed and/or instantiated by the license processor 214 to install the second RFA 8704B. After installation of the first RFA 8704A and/or the second RFA 8704B, the RFAs 8704A-B can provision a requested license and/or perform task(s) for which they are deployed. In some examples, the RFAs 8704A-B can log success(es) or failure(s) (e.g., error(s)). In some examples, the RFAs 8704A-B can uninstall themselves and release all system resources they may have engaged during the installation, provisioning, and/or task completion process and, thus, leave a reduced and/or otherwise minimum footprint.

By way of another example, an onboard or license clock (e.g., a non-fungible token (NFT) clock) of the semiconductor devices 105A-C can request or initialize activation of the RFAs 8704A-B to ensure that license compliance is satisfied according to contract terms and conditions (e.g., terms and conditions of an SLA). For example, the onboard activation contract timer mechanism, which can be implemented by the license processor 214, or portion(s) thereof (e.g., the license dispatcher 8706), can trigger the RFAs 8704A-B to evaluate the contract terms and terms to ensure that deactivation, reactivation, and/or an extension to the activation can be processed if needed. In some examples, the RFAs 8704A-B can evaluate the contract terms and conditions if there are new activations (e.g., new feature activations) that are to be processed. In some examples, the RFAs 8704A-B can manage failures of the hardware circuitry 125 where the failed activated feature(s) can be processed so the customer enterprise system 115 can receive credit on the deactivation of a license on failed portion(s) of the hardware circuitry 125. In some examples, the RFAs 8704A-B can manage the on-demand activation (e.g., scale up or scale down resources) as needed with reduced and/or otherwise minimal footprint. In some examples, the RFAs 8704A-B can manage and engage with pre-emptive operating system (OS) kernel features of the semiconductor devices 105A-C to ensure that scale-up/down operations proceed without kernel panic (e.g., a stop error, an OS stop error, etc.) and that the activations complete with full capability availability with reduced and/or otherwise minimal footprint. Advantageously, the RFAs 8704A-B can change, modify, and/or otherwise configure at least one of the hardware circuitry 125, the firmware 130, or the BIOS 135 and remove itself after the change(s), modification(s), and/or configuration(s).

While an example manner of implementing the SDSi asset agents 140A-C of FIG. 49 is illustrated in FIG. 87, one or more of the elements, processes, and/or devices illustrated in FIG. 87 may be combined, divided, re-arranged, omitted, eliminated, and/or implemented in any other way. Further, the example agent interface 202, the example agent local services 204, the example analytics engine 206, the example communication services 208, the example agent CLI 210, the example agent daemon 212, the example TEE 8702, the first example RFA 8704A, the example license processor 214, the second example RFA 8740B, the example license dispatcher 8706, the example feature configurator 8708, the example agent library 218, the example libraries 220, 222, 224, 226, 228, 230, the example features 232, 234, 236, 238, 240, 242, the example hardware circuitry 125, the example firmware 130, the example BIOS 135, and/or, more generally, the example SDSi asset agents 140A-C of FIGS. 1, 49, and/or 87, may be implemented by hardware alone or by hardware in combination with software and/or firmware. Thus, for example, any of the example agent interface 202, the example agent local services 204, the example analytics engine 206, the example communication services 208, the example agent CLI 210, the example agent daemon 212, the example TEE 8702, the first example RFA 8704A, the example license processor 214, the second example RFA 8740B, the example license dispatcher 8706, the example feature configurator 8708, the example agent library 218, the example libraries 220, 222, 224, 226, 228, 230, the example features 232, 234, 236, 238, 240, 242, the example hardware circuitry 125, the example firmware 130, the example BIOS 135, and/or, more generally, the example SDSi asset agents 140A-C of FIGS. 1, 49, and/or 87, could be implemented by processor circuitry, analog circuit(s), digital circuit(s), logic circuit(s), programmable processor(s), programmable microcontroller(s), GPU(s), DSP(s), ASIC(s), PLD(s)) and/or FPLD(s) such as FPGAs. Further still, the example SDSi asset agents 140A-C of FIGS. 1, 49, and/or 87 may include one or more elements, processes, and/or devices in addition to, or instead of, those illustrated in FIG. 87, and/or may include more than one of any or all of the illustrated elements, processes and devices.

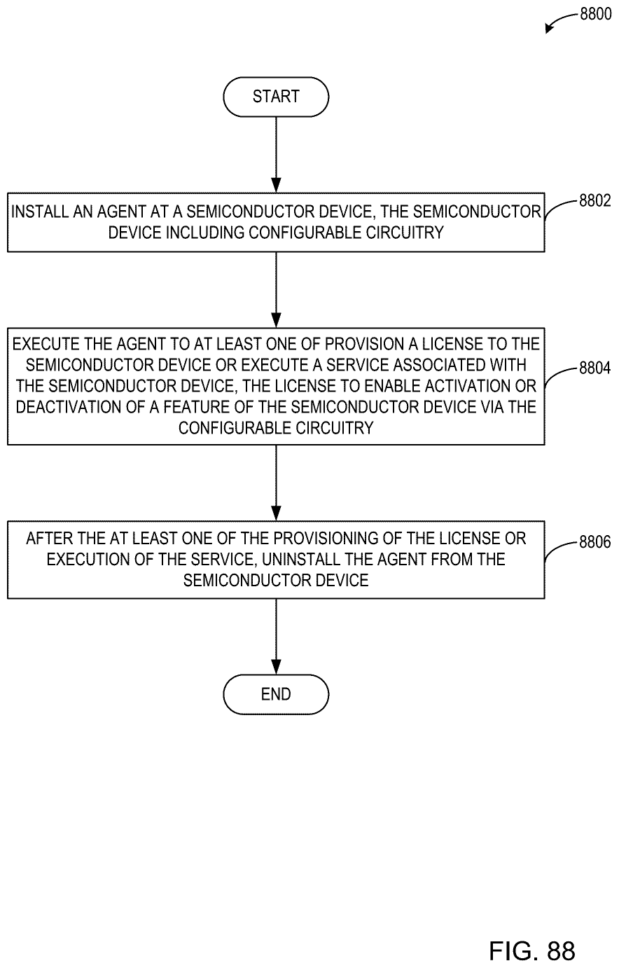

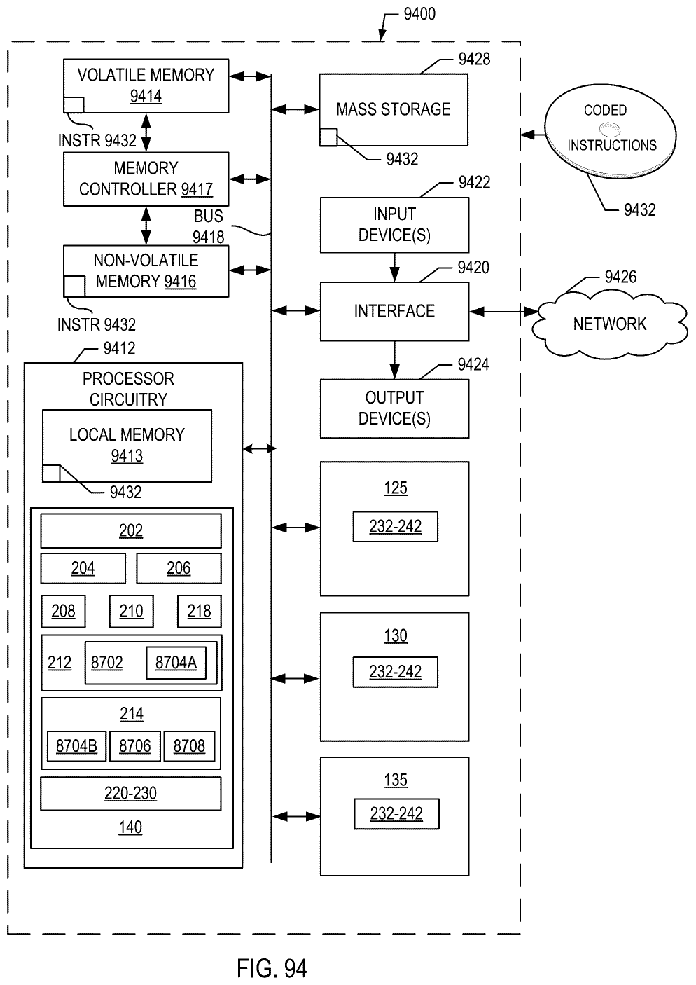

Flowcharts representative of example machine readable instructions which may be executed to configure processor circuitry to implement the example SDSi asset agents 140A-C, the example manufacturer enterprise system 110, the example customer enterprise system 115, and/or, more generally, the example SDSi system 8700 of FIG. 87, are shown in FIGS. 88-93. The machine readable instructions may be one or more executable programs or portion(s) of an executable program for execution by processor circuitry, such as the processor circuitry 9412 shown in the example processor platform 9400 discussed below in connection with FIG. 94 and/or the example processor circuitry discussed below in connection with FIGS. 150 and/or 151. The program may be embodied in software stored on one or more non-transitory computer readable storage media such as a CD, a floppy disk, an HDD, an SSD, a DVD, a Blu-ray disk, a volatile memory (e.g., RAM of any type, etc.), or a non-volatile memory (e.g., electrically EEPROM, FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a RAN) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 88-93, many other methods of implementing the example SDSi asset agents 140A-C, the example manufacturer enterprise system 110, the example customer enterprise system 115, and/or, more generally, the example SDSi system 8700 of FIG. 87, may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an op-amp, a logic circuit, etc.) structured to perform the corresponding operation without executing software or firmware. The processor circuitry may be distributed in different network locations and/or local to one or more hardware devices (e.g., a single-core processor (e.g., a single core CPU), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a DLL), an SDK, an API, etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HTML, SQL, Swift, etc.

As mentioned above, the example operations of FIGS. 88-93 may be implemented using executable instructions (e.g., computer and/or machine readable instructions) stored on one or more non-transitory computer and/or machine readable media such as optical storage devices, magnetic storage devices, an HDD, a flash memory, a ROM, a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or RAID systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

FIG. 88 is a flowchart representative of example machine readable instructions and/or example operations 8800 that may be executed and/or instantiated by processor circuitry to at least one of provision a license or execute a service with a reduced footprint agent. The example machine readable instructions and/or the example operations 8800 of FIG. 88 begin at block 8802, at which the SDSi asset agents 140A-C of FIGS. 1, 49, and/or 87 install an agent at a semiconductor device, the semiconductor device including configurable circuitry. For example, the agent daemon 212 can install the first RFA 8704-A in the TEE 8702. In some examples, the license dispatcher 8706, and/or, more generally, the license processor 214, can install the second RFA 8704-B in the license processor 214.

At block 8804, the SDSi asset agents 140A-C execute the agent to at least one of provision a license to the semiconductor device or execute a service associated with the semiconductor device, the license to enable activation or deactivation of a feature of the semiconductor device via the configurable circuitry. For example, the first RFA 8704A can be executed and/or instantiated in the TEE 8702 to provision a license to the first semiconductor device 105A to activate a feature of the hardware circuitry 125, such as increasing a number of compute cores of processor circuitry of the hardware circuitry 125. In some examples, the second RFA 8704B can be executed and/or instantiated to provision a license to the first semiconductor device 105A to activate the feature of the hardware circuitry 125. In some examples, the license dispatcher 8706 can execute and/or instantiate the second RFA 8704B. In some examples, the first RFA 8704A and/or the second RFA 8704B can be executed and/or instantiated to execute a service, which can include collecting telemetry data associated with the semiconductor devices 105A-C and/or transmitting the telemetry data off platform (e.g., transmitting the telemetry data to the manufacturer enterprise system 110, the customer enterprise system 115, etc.).

At block 8806, the SDSi asset agents 140A-C, after the at least one of the provisioning of the license or execution of the service, uninstall the agent from the semiconductor device. For example, the first RFA 8704A and/or the second RFA 8704B can uninstall themselves after their prescribed or programmed function(s), task(s), etc., is/are complete. In response to uninstalling the agent from the semiconductor device after the at least one of the provisioning of the license or execution of the service at block 8806, the example machine readable instructions and/or the example operations 8800 of FIG. 88 conclude.

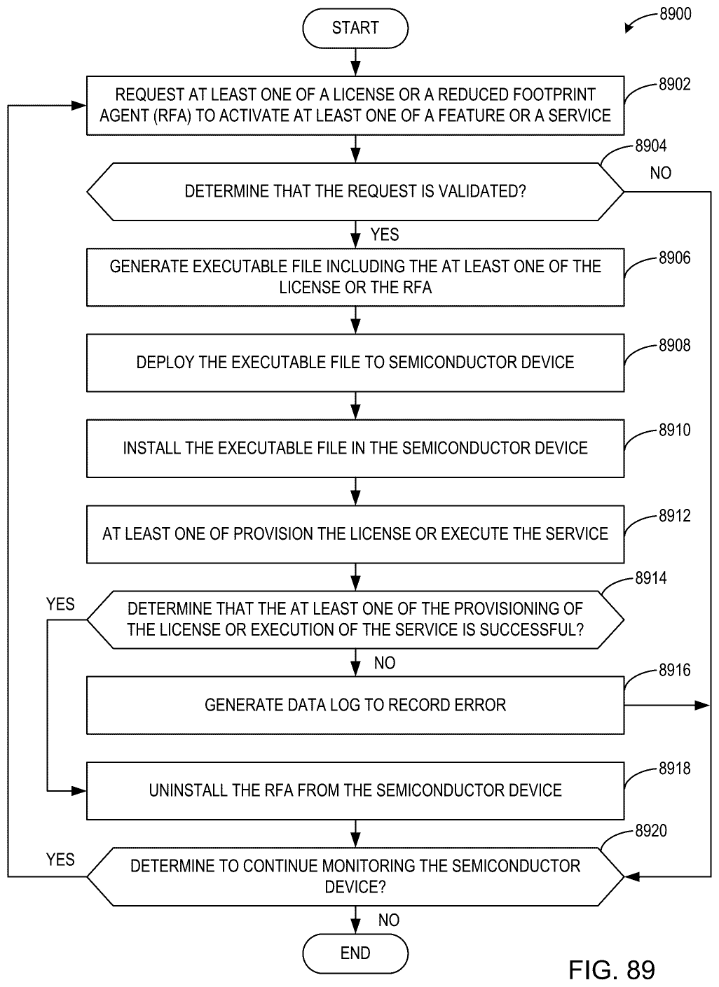

FIG. 89 is a flowchart representative of example machine readable instructions and/or example operations 8900 that may be executed and/or instantiated by processor circuitry to at least one of provision a license or execute a service with a reduced footprint agent. The example machine readable instructions and/or the example operations 8900 of FIG. 89 begin at block 8902, at which the SDSi asset agents 140A-C of FIGS. 1, 49, and/or 87 and/or the customer enterprise system 115 request at least one of a license or a reduced footprint agent (RFA) to activate at least one of a feature or a service. For example, the agent interface 202 can request the SDSi agent management interface 264 for at least one of a license or one(s) of the RFAs 8704A-B. In some examples, the client agent 272 can request the SDSi portal 262 for at least one of a license or one(s) of the RFAs 8704A-B.

At block 8904, the cloud platform 120 determines whether the request is validated. For example, the SDSi portal 262 and/or the SDSi agent management interface 264 can determine that the request is valid based on an ID of a requesting one of the semiconductor devices 105A-C, an ID of the customer enterprise system 115, etc.

If, at block 8904, the cloud platform 120 determines that the request is not validated, control proceeds to block 8920. For example, the SDSi portal 262 and/or the SDSi agent management interface 264 can ignore and/or otherwise drop the request based on a determination that the request originated from an unknown and/or unauthorized entity.

If, at block 8904, the cloud platform 120 determines that the request is validated, control proceeds to block 8906. At block 8906, the manufacturer enterprise system 110 generates an executable file including the at least one of the license or the RFA. For example, the SDSi feature management service 256 can generate an executable binary (e.g., an executable binary file) that includes at least one of (i) a license to activate a feature or (ii) one(s) of the RFAs 8704A-B to provision the license.

At block 8908, the manufacturer enterprise system 110 deploys the executable file to a semiconductor device. For example, the SDSi feature management service 256 can transmit the executable binary to one(s) of the semiconductor devices 105A-C via the SDSi agent management interface 264 and the agent interface 202. In some examples, the SDSi feature management service 256 can transmit the executable binary to one(s) of the semiconductor devices 105A-C by way of the SDSi portal 262, the client agent 272, and the agent interface 202.

At block 8910, the SDSi asset agents 140A-C install the executable file in the semiconductor device. For example, the agent daemon 212 can install at least one of the license or the first RFA 8704A in the TEE 8702. In some examples, the license processor 214 can install at least one of the license or the second RFA 8704B in the license processor 214.

At block 8912, the SDSi asset agents 140A-C at least one of provision the license or execute the service. For example, the first RFA 8704A and/or the second RFA 8704B can be executed and/or instantiated to at least one of provision the license or execute the service.

At block 8914, the SDSi asset agents 140A-C determine whether the at least one of the provisioning of the license or execution of the service is successful. For example, the first RFA 8704A and/or the second RFA 8704B can determine that the at least one of the provisioning of the license or execution of the service is successful.

If, at block 8914, the SDSi asset agents 140A-C determine that the at least one of the provisioning of the license or execution of the service is not successful, control proceeds to block 8916. At block 8916, the SDSi asset agents 140A-C generates a data log to record an error. For example, the first RFA 8704A and/or the second RFA 8704B can generate a data log including data to identify that the at least one of the provisioning of the license or execution of the service is not successful. In response to generating a data log to record an error at block 8916, control proceeds to block 8920.

If, at block 8914, the SDSi asset agents 140A-C determine that the at least one of the provisioning of the license or execution of the service is successful, control proceeds to block 8918. At block 8918, the SDSi asset agents 140A-C uninstall the RFA from the semiconductor device. For example, the first RFA 8704A can uninstall and/or otherwise remove itself from the TEE 8702, and/or, more generally, from the semiconductor devices 105A-C. In some examples, the second RFA 8704B can uninstall and/or otherwise remove itself from the license processor 214, and/or, more generally, from the semiconductor devices 105A-C. In response to uninstalling the RFA at the semiconductor device at block 8918, control proceeds to block 8920.

At block 8920, the cloud platform 120 determine whether to continue monitoring the semiconductor device. For example, the SDSi portal 262 and/or the SDSi agent management interface 264 can determine whether there is another request for at least one of a license or an RFA to activate at least one of a feature or a service in connection with one(s) of the semiconductor devices 105A-C. If, at block 8920, the cloud platform 120 determine to continue monitoring the semiconductor device, control returns to block 8902, otherwise the example machine readable instructions and/or the example operations 8900 of FIG. 89 conclude.

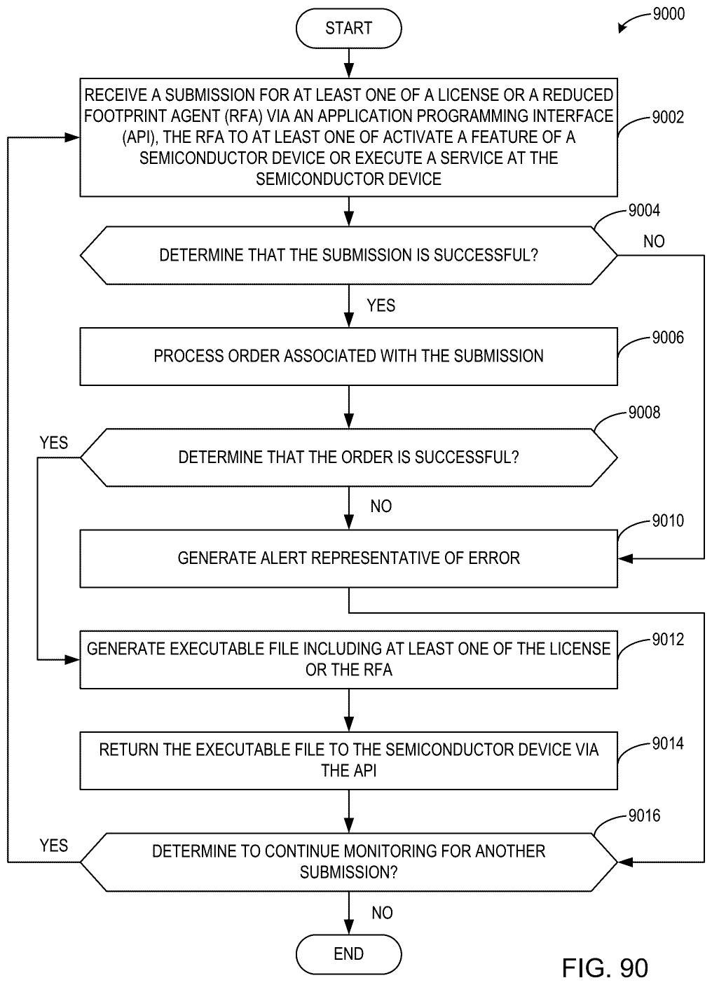

FIG. 90 is a flowchart representative of example machine readable instructions and/or example operations 9000 that may be executed and/or instantiated by processor circuitry to process a submission for at least one of a license or a reduced footprint agent. The example machine readable instructions and/or the example operations 9000 of FIG. 90 begin at block 9002, at which the cloud platform 120 of FIGS. 1, 49, and/or 87 receives a submission for at least one of a license or a reduced footprint agent (RFA) via an application programming interface (API), the RFA to at least one of activate a feature of a semiconductor device or execute a service at the semiconductor device. For example, the SDSi portal 262 and/or the SDSi agent management interface 264 can receive a request from the agent interface 202 and/or the client agent 272 for at least one of a license to activate feature(s) of one(s) of the semiconductor devices 105A-C or execute service(s) at the one(s) of the semiconductor devices 105A-C.

At block 9004, the cloud platform 120 determines whether the submission is successful. For example, the SDSi portal 262 and/or the SDSi agent management interface 264 can determine that the submission originated from a known customer and/or device based on information included in the submission. If, at block 9004, the cloud platform 120 determines that the submission is not successful, control proceeds to block 9010. If, at block 9004, the cloud platform 120 determines that the submission is successful, control proceeds to block 9006.

At block 9006, the manufacturer enterprise system 110 processes an order associated with the submission. For example, the product management service 252 and/or the customer management service 254 can process an order to issue license(s) based on the submission.

At block 9008, the manufacturer enterprise system 110 determines whether the order is successful. For example, the product management service 252 and/or the customer management service 254 can determine that the order did originate from a known customer and/or device based on information included in the submission and/or known to the manufacturer enterprise system 110. If, at block 9008, the manufacturer enterprise system 110 determines that the order is not successful, control proceeds to block 9010. At block 9010, the manufacturer enterprise system 110 generates an alert representative of an error. For example, the product management service 252 and/or the customer management service 254 can generate a data log indicating the unsuccessful order, an alert indicative of the unsuccessful order, etc. In response to generating an alert representative of an error at block 9010, control proceeds to block 9016.

If, at block 9008, the manufacturer enterprise system 110 determines that the order is successful, control proceeds to block 9012. At block 9012, the manufacturer enterprise system 110 generates an executable file including at least one of the license or the RFA. For example, the SDSi feature management service 256 can generate an executable binary file that includes at least one of the license or one(s) of the RFAs 8704A-B.

At block 9014, the manufacturer enterprise system 110 returns the executable file to the semiconductor device via the API. For example, the SDSi feature management service 256 can provide the executable binary file to one(s) of the semiconductor devices 105A-C by way of the cloud platform 120 and/or the customer enterprise system 115.

At block 9016, the cloud platform 120 determines whether to continue monitoring for another submission. For example, the cloud platform 120 can determine whether there is another submission for at least one of a license or an RFA via an API. If, at block 9016, the cloud platform 120 determines to continue monitoring for another submission, control returns to block 9002, otherwise the example machine readable instructions and/or the example operations 9000 of FIG. 90 conclude.

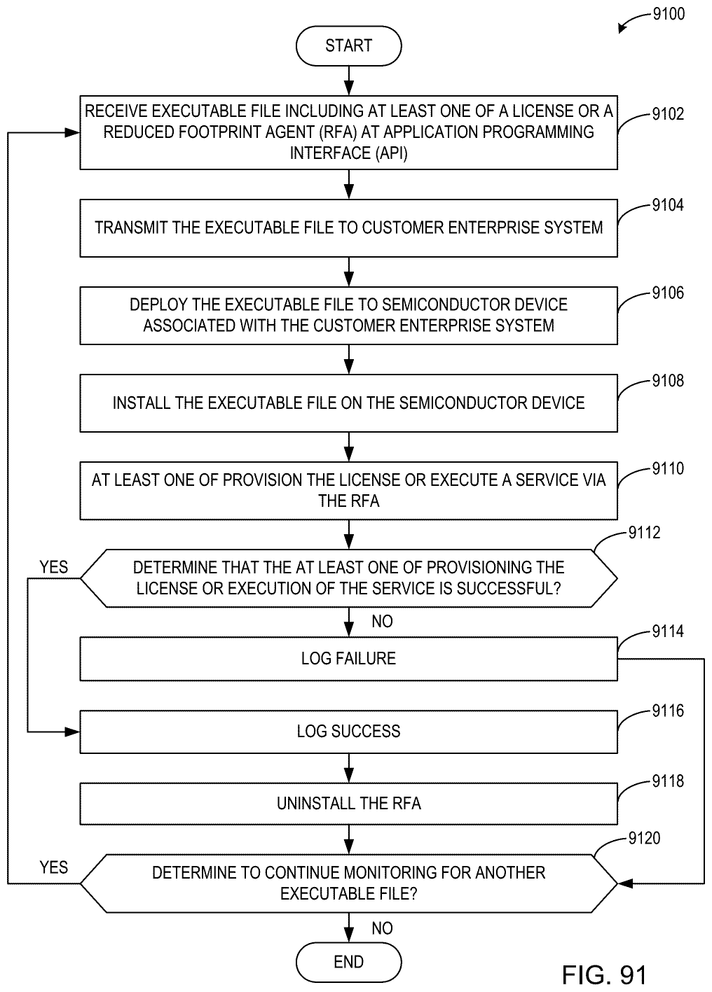

FIG. 91 is a flowchart representative of example machine readable instructions and/or example operations 9100 that may be executed and/or instantiated by processor circuitry to at least one of provision a license or execute a service with a reduced footprint agent. The example machine readable instructions and/or the example operations 9100 of FIG. 91 begin at block 9102, at which the cloud platform 120 of FIGS. 1, 49, and/or 87 receives an executable file including at least one of a license or a reduced footprint agent (RFA) at an application programming interface. For example, the SDSi portal 262 can obtain an executable file from the SDSi feature management service 256. In some examples, the executable file can include code, that, when executed and/or instantiated, can provision a license to activate a feature of one(s) of the semiconductor devices 105A-C and/or execute service(s) on the one(s) of the semiconductor devices 105A-C.

At block 9104, the cloud platform 120 transmits the executable file to a customer enterprise system. For example, the SDSi portal 262 can transmit the executable file to the client agent 272.

At block 9106, the customer enterprise system 115 deploys the executable file to a semiconductor device associated with the customer enterprise system. For example, the client agent 272 can transmit the executable file to one(s) of the semiconductor devices 105A-C. In some examples, the entitlement management service 278 can identify the one(s) of the semiconductor devices 105A-C based on the executable file or any other data known to the customer enterprise system 115, such as telemetry data associated with the one(s) of the semiconductor devices 105A-C.

At block 9108, the SDSi asset agents 140A-C installs the executable file on the semiconductor device. For example, the agent daemon 212 can install the first RFA 8704A in the TEE 8702.

At block 9110, the SDSi asset agents 140A-C at least one of provision the license or execute a service via the RFA. For example, the first RFA 8704A can be executed and/or instantiated to provision the license to activate feature(s) of one(s) of the semiconductor devices 105A-C and/or execute service(s) on the one(s) of the semiconductor devices 105A-C.

At block 9112, the SDSi asset agents 140A-C determine whether the at least one of provisioning the license or execution of the service is successful. For example, the first RFA 8704A can determine that the provisioning the license or execution of the service is successful.

If, at block 9112, the SDSi asset agents 140A-C determine that the at least one of provisioning the license or execution of the service is not successful, control proceeds to block 9114. At block 9114, the SDSi asset agents 140A-C log failure. For example, the first RFA 8704A can generate and/or store a data log identifying the failure(s) in the TEE 8702 or elsewhere in the SDSi asset agents 140A-C. In response to logging failure at block 9114, control proceeds to block 9120.

If, at block 9112, the SDSi asset agents 140A-C determine that the at least one of provisioning the license or execution of the service is successful, control proceeds to block 9116. At block 9116, the SDSi asset agents 140A-C log success. For example, the first RFA 8704A can generate and/or store a data log identifying the success(es) in the TEE 8702 or elsewhere in the SDSi asset agents 140A-C. In response to logging success at block 9116, control proceeds to block 9118.

At block 9118, the SDSi asset agents 140A-C uninstall the RFA. For example, the first RFA 8704A can uninstall and/or otherwise remove itself from the TEE 8702, and/or, more generally, the SDSi asset agents 140A-C.

At block 9120, the SDSi asset agents 140A-C determine whether to continue monitoring for another executable file. For example, the agent interface 202 and/or the agent daemon 212 can determine whether there another instance of the first RFA 8704A is received and/or if a different RFA is received, such as the second RFA 8704B. If, at block 9120, the SDSi asset agents 140A-C determine to continue monitoring for another executable file, control returns to block 9102, otherwise the example machine readable instructions and/or the example operations 9100 of FIG. 91 conclude.

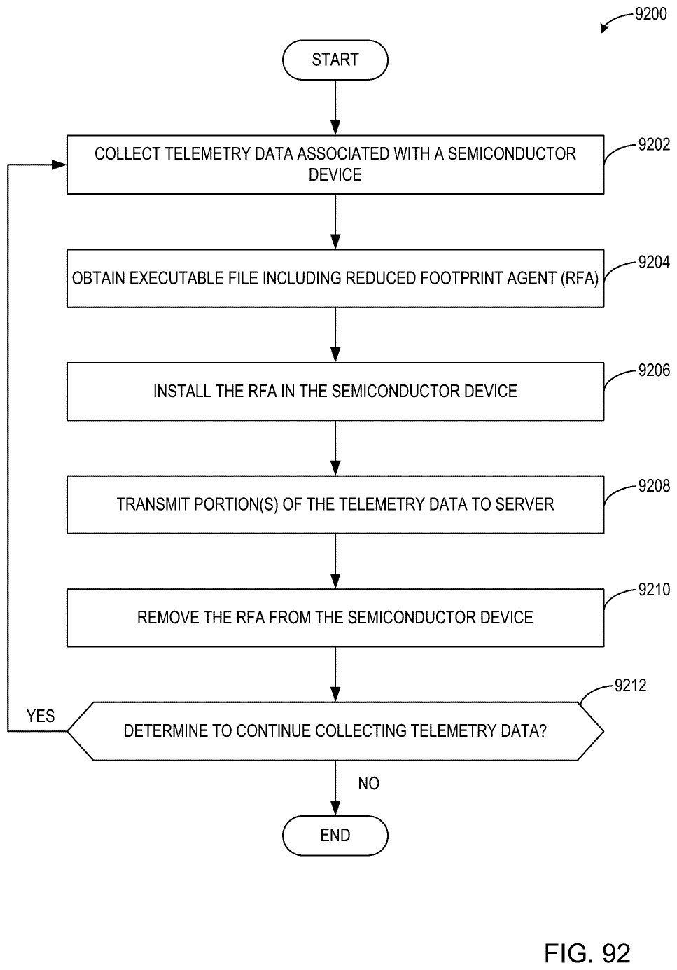

FIG. 92 is a flowchart representative of example machine readable instructions and/or example operations 9200 that may be executed and/or instantiated by processor circuitry to manage execution of a reduced footprint agent at a semiconductor device to execute a telemetry collection service. The example machine readable instructions and/or the example operations 9200 of FIG. 92 begin at block 9202, at which the SDSi asset agents 140A-C of FIGS. 1, 49, and/or 87 collect telemetry data associated with a semiconductor device. For example, the firmware 130, the BIOS 135, and/or, more generally, the SDSi asset agents 140A-C, can collect telemetry data associated with the hardware circuitry 125.

At block 9204, the SDSi asset agents 140A-C obtain an executable file including a reduced footprint agent (RFA). For example, the agent daemon 212 can obtain an executable file that, when executed and/or instantiated, can install the first RFA 8704A in the TEE 8702.

At block 9206, the SDSi asset agents 140A-C install the RFA in the semiconductor device. For example, the agent daemon 212 can execute and/or instantiate the executable file to install the first RFA 8704A in the TEE 8702.

At block 9208, the SDSi asset agents 140A-C transmit portion(s) of the telemetry data to a server. For example, the first RFA 8704A can be executed and/or instantiated to collect the telemetry data. In some examples, the first RFA 8704 can transmit portion(s) of the telemetry data, such as a compute utilization for respective core(s) of processor circuitry of the hardware circuitry 125, to at least one of the cloud platform 120 or the customer enterprise system 115.

At block 9210, the SDSi asset agents 140A-C remove the RFA from the semiconductor device. For example, after completion of the telemetry collection service, the first RFA 8704A can remove itself from the TEE 8702, and/or, more generally, a corresponding one of the semiconductor devices 105A-C.

At block 9212, the SDSi asset agents 140A-C determine whether to continue collecting telemetry data. For example, the firmware 130 and/or the BIOS 135 can determine whether to continue collecting telemetry data as specified per an SLA, an orchestration policy, etc. If, at block 9212, the SDSi asset agents 140A-C determine to continue collecting telemetry data, control returns to block 9202, otherwise the example machine readable instructions and/or the example operations 9200 of FIG. 92 conclude.

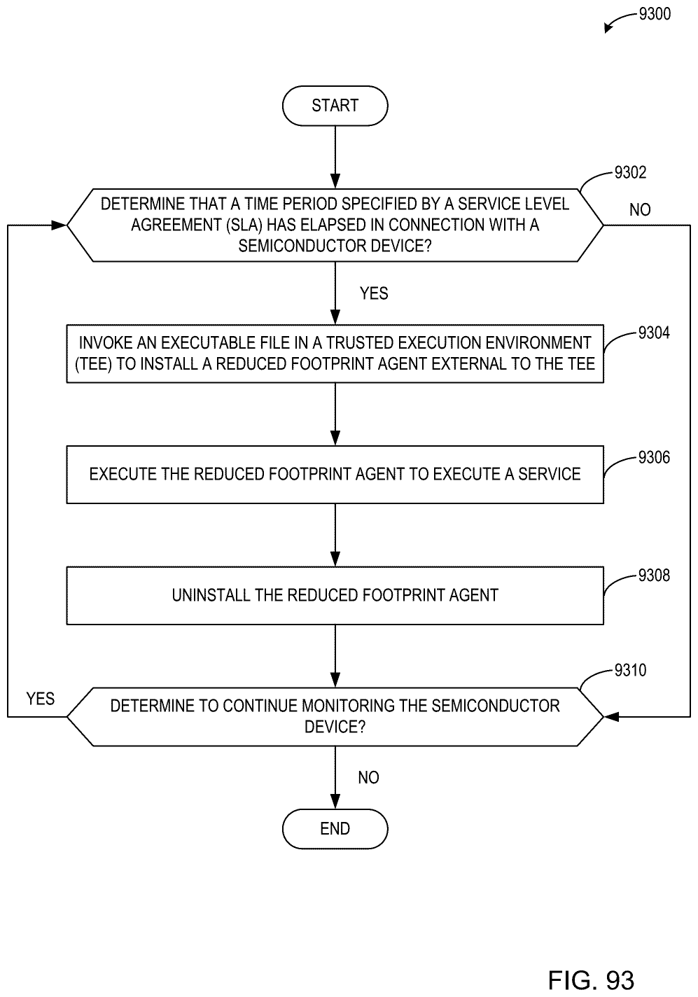

FIG. 93 is a flowchart representative of example machine readable instructions and/or example operations 9300 that may be executed and/or instantiated by processor circuitry to manage execution of a reduced footprint agent at a semiconductor device to execute a service. The example machine readable instructions and/or the example operations 9300 of FIG. 93 begin at block 9302, at which the SDSi asset agents 140A-C determine whether a time period specified by a service level agreement (SLA) has elapsed in connection with a semiconductor device. For example, the license dispatcher 8706, and/or, more generally, the license processor 214, can determine that an SLA associated with the first semiconductor device 105A specifies that a service is to be executed every 10 minutes. Alternatively, any other time period may be specified. In some examples, the license dispatcher 8706, and/or, more generally, the license processor 214, can determine that at least 10 minutes have elapsed since a previous execution of the service.

If, at block 9302, the SDSi asset agents 140A-C determine that a time period specified by an SLA has not elapsed in connection with a semiconductor device, control proceeds to block 9310, otherwise control proceeds to block 9304.

At block 9304, the SDSi asset agents 140A-C invoke an executable file in a trusted execution environment (TEE) to install a reduced footprint agent external to the TEE. For example, the license dispatcher 8706 can retrieve an executable file from the TEE 8702. In some examples, the license dispatcher 8706 can execute and/or instantiate the executable file to install the second RFA 8704B in the license processor 214.

At block 9306, the SDSi asset agents 140A-C execute the RFA to execute a service. For example, the second RFA 8704B can be executed and/or instantiated to perform and/or otherwise carry out a service, such as a telemetry collection service, a feature activation service, a feature deactivation service, an upgrade service in connection with portion(s) of the first semiconductor device 105A, etc., and/or any combination(s) thereof.

At block 9308, the SDSi asset agents 140A-C uninstall the RFA. For example, after completion of the service, the second RFA 8704B can remove itself to reduce and/or eliminate its own footprint. Alternatively, a different component of the SDSi asset agents 140A-C can remove the second RFA 8704B from the license processor 214, such as the license dispatcher 8706.

At block 9310, the SDSi asset agents 140A-C determine whether to continue monitoring the semiconductor device. For example, the license dispatcher 8706, and/or, more generally, the license processor 214, can determine whether a time period has elapsed since a previous execution of the service. If, at block 9310, the SDSi asset agents 140A-C determine to continue monitoring the semiconductor device, control returns to block 9302, otherwise the example machine readable instructions and/or the example operations 9300 of FIG. 93 conclude.

FIG. 94 is a block diagram of an example processor platform 9400 structured to execute and/or instantiate the example machine readable instructions and/or the example operations of FIGS. 88-93 to implement the example SDSi asset agents 140A-C, and/or, more generally, the semiconductor devices 105A-C, of FIGS. 1, 49, and/or 87. The processor platform 9400 can be, for example, any other type of computing or electronic device.

The processor platform 9400 of the illustrated example includes processor circuitry 9412. The processor circuitry 9412 of the illustrated example is hardware. For example, the processor circuitry 9412 can be implemented by one or more integrated circuits, logic circuits, FPGAs, microprocessors, CPUs, GPUs, DSPs, and/or microcontrollers from any desired family or manufacturer. The processor circuitry 9412 may be implemented by one or more semiconductor based (e.g., silicon based) devices. In this example, the processor circuitry 9412 implements the example agent interface 202, the example agent local services 204, the example analytics engine 206, the example communication services 208, the example agent CLI 210, the example agent daemon 212, the example TEE 8702, the first example RFA 8704A, the example license processor 214, the second example RFA 8704B, the example license dispatcher 8706, the example feature configurator 8708, the example agent library 218, the example libraries 220, 222, 224, 226, 228, 230, and/or, more generally, the example SDSi asset agents 140A-C of FIGS. 1, 49, and/or 87.

The processor circuitry 9412 of the illustrated example includes a local memory 9413 (e.g., a cache, registers, etc.). The processor circuitry 9412 of the illustrated example is in communication with a main memory including a volatile memory 9414 and a non-volatile memory 9416 by a bus 9418. The volatile memory 9414 may be implemented by SDRAM, DRAM, RDRAM®, and/or any other type of RAM device. The non-volatile memory 9416 may be implemented by flash memory and/or any other desired type of memory device. Access to the main memory 9414, 9416 of the illustrated example is controlled by a memory controller 9417.

The processor platform 9400 of the illustrated example also includes interface circuitry 9420. The interface circuitry 9420 may be implemented by hardware in accordance with any type of interface standard, such as an Ethernet interface, a USB interface, a Bluetooth® interface, an NFC interface, a PCI interface, and/or a PCIe interface.

In the illustrated example, one or more input devices 9422 are connected to the interface circuitry 9420. The input device(s) 9422 permit(s) a user to enter data and/or commands into the processor circuitry 9412. The input device(s) 9422 can be implemented by, for example, an audio sensor, a microphone, a camera (still or video), a keyboard, a button, a mouse, a touchscreen, a track-pad, a trackball, an isopoint device, and/or a voice recognition system.

One or more output devices 9424 are also connected to the interface circuitry 9420 of the illustrated example. The output device(s) 9424 can be implemented, for example, by display devices (e.g., an LED, an OLED, an LCD, a CRT display, an IPS display, a touchscreen, etc.), a tactile output device, a printer, and/or speaker. The interface circuitry 9420 of the illustrated example, thus, typically includes a graphics driver card, a graphics driver chip, and/or graphics processor circuitry such as a GPU.

The interface circuitry 9420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 9426. The communication can be by, for example, an Ethernet connection, a DSL connection, a telephone line connection, a coaxial cable system, a satellite system, a line-of-site wireless system, a cellular telephone system, an optical connection, etc.

The processor platform 9400 of the illustrated example also includes one or more mass storage devices 9428 to store software and/or data. Examples of such mass storage devices 9428 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 9432, which may be implemented by the machine readable instructions of FIGS. 88-93, may be stored in the mass storage device 9428, in the volatile memory 9414, in the non-volatile memory 9416, and/or on a removable non-transitory computer readable storage medium such as a CD or DVD. Further depicted in the illustrated example of FIG. 94 are the hardware circuitry 125, the firmware 130, and the BIOS 135 of FIGS. 1, 49, and/or 87. In the illustrated example of FIG. 94, each of the hardware circuitry 125, the firmware 130, and the BIOS 135 include the features 232-242 of FIGS. 2, 49, and/or 87. In the illustrated example, the hardware circuitry 125, the firmware 130, and the BIOS 135 are connected to other component(s) of the processor platform 9400 via the bus 9418.

Performing SDSi Usage Evaluation and Corresponding License Transfer Responsive to Detected and/or Predicted Failures

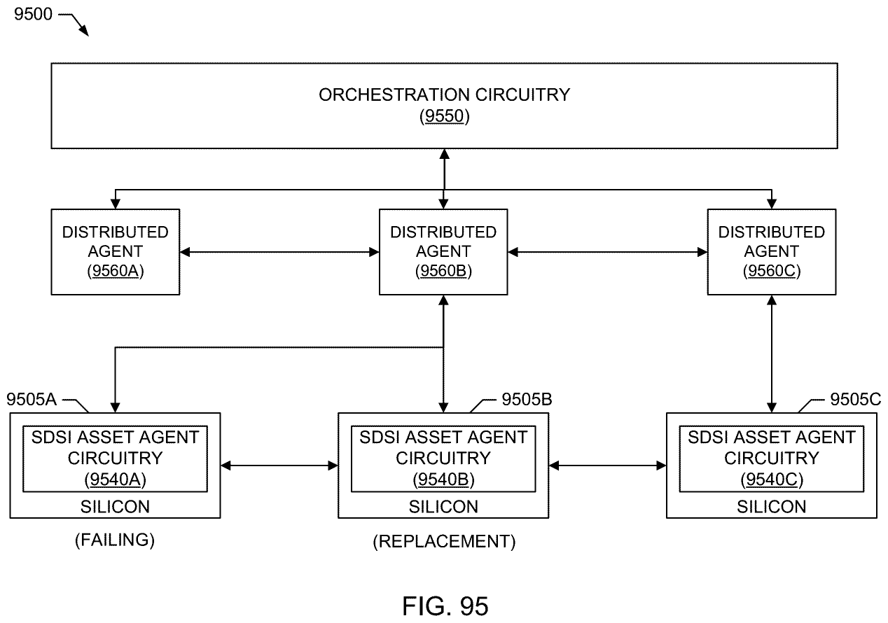

Turning to the figures, FIG. 95 illustrates a block diagram of an example system 9500 that performs SDSi usage evaluation and corresponding license transfer(s) responsive to detected and predicted failures of SDSi-enabled products, such as the SDSi semiconductor device 105 described above. The example system 9500 of FIG. 95 includes multiple example SDSi semiconductor devices 9505A-C that, as described above, may correspond to any type of silicon products, such as, but not limited to, computer processors, CPUs, IPUs, XPUs, semiconductor chips, silicon hardware devices, etc., as well as circuit boards and/or systems employing such silicon products, etc. In the illustrated example, the SDSi semiconductor devices 9505A-C implement respective SDSi features as described above in connection with the SDSi semiconductor device 105. As such, each one of the SDSi semiconductor devices 9505A-C includes respective example SDSi asset agent circuitry 9540A-C, which implement an SDSi asset agent such as the SDSi agent 140 described above. The SDSi asset agent circuitry 9540A-C also perform SDSi usage evaluation and corresponding license transfer(s) responsive to detected and predicted failures of ones of the SDSi semiconductor devices 9505A-C, as described in further detail below.

The example system 9500 of FIG. 95 also includes example orchestration circuitry 9550 and/or one or more example distributed agents 9560A-C to perform SDSi usage evaluation and corresponding license transfer(s) responsive to detected and predicted failures, as described in further detail below. In the illustrated example of FIG. 95, the SDSi semiconductor devices W105A-C, the orchestration circuitry W150 and the distributed agent(s) 9560A-C are in communication with each other via one or more example networks (not shown), such as the example network 120 described above.

In some examples, the system 9500 can correspond to a customer data center, customer manufacturing center, customer data processing site, etc. In some such examples, the SDSi semiconductor devices 9505A-C can be used to implement servers of the customer data center, and the orchestration circuitry 9550 can correspond to and/or be implemented by an orchestrator and/or other enterprise system associated with a customer utilizing the SDSi semiconductor devices 9505A-C. For example, the orchestration circuitry 9550 can be implemented by the example customer enterprise system 115, the example SDSi client agent 272 and/or the example entitlement management service 278 described above.

In some such examples, the distributed agent(s) 9560A-C can also correspond to and/or be implemented by software and/or hardware in the customer data center, customer manufacturing center, customer data processing site, etc. For example, the distributed agent(s) 9560A-C can be implemented by software executed by and/or hardware included in one or more servers, routers, edge devices, computers, orchestrators, enterprise systems, etc., associated with a customer utilizing the SDSi semiconductor devices 9505A-C. In some examples, one or more of the distributed agent(s) 9560A-C is(are) implemented by the orchestration circuitry 9550. In some examples, one or more of the distributed agent(s) 9560A-C is(are) operate separately from the orchestration circuitry 9550.

As such, the elements of the example system 9500 of FIG. 95 may be instantiated (e.g., creating an instance of, bring into being for any length of time, materialize, implement, etc.) by processor circuitry such as a central processing unit executing instructions. Additionally or alternatively, the elements of the example system 9500 of FIG. 95 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 95 may, thus, be instantiated at the same or different times. Some or all of the circuitry may be instantiated, for example, in one or more threads executing concurrently on hardware and/or in series on hardware. Moreover, in some examples, some or all of the circuitry of FIG. 95 may be implemented by microprocessor circuitry executing instructions to implement one or more virtual machines and/or containers. Also, although the example system 9500 of FIG. 95 is illustrated as including three SDSi semiconductor devices 9505A-C, one instance of orchestration circuitry 9550, and three distributed agent(s) 9560A-C, the system 9500 can include any number of SDSi semiconductor devices 9505A-C, any number of instances of orchestration circuitry 9550, and any number of distributed agent(s) 9560A-C.

As indicated above, the example system 9500 performs SDSi usage evaluation and corresponding license transfer(s) responsive to detected and predicted failures of ones of the SDSi semiconductor devices 9505A-C. For example, one of the SDSi semiconductor devices 9505A-C may start malfunctioning or fail completely. In some example scenarios, if that SDSi semiconductor device 9505A-C had been upgraded using SDSi technology as disclosed herein, the SDSi license(s) for the upgrade(s) may be lost if the SDSi semiconductor device 9505A-C stops functioning correctly. This is because in some prior examples, an SDSi license for a given feature is bound to the SDSi semiconductor device 9505A-C when the corresponding SDSi feature is activated and cannot be transferred or used on another one of the SDSi semiconductor device 9505A-C.

In contrast with such prior examples, in example system 9500, the orchestration circuitry 9550 and/or the distributed agent(s) 9560 in the data center monitor the SDSi semiconductor device 9505A-C to detect symptoms forecasting or otherwise indicating that the SDSi semiconductor device 9505A-C may fail in the near future or have already failed. In some examples, the local SDSi asset agent circuitry 9540A-C (e.g., such as its license processor 214) of the SDSi semiconductor device 9505A-C themselves may additionally or alternatively perform such failure monitoring. In some examples, the failure monitoring is based on one or more deterministic algorithms having one or more trigger thresholds, and/or based on one or more machine learning algorithms, etc. In some examples, the failure monitoring may be integrated in the orchestration circuitry 9550 of the data center. In some examples, the local SDSi asset agent circuitry 9540A-C (e.g., such as its license processor 214) of the respective SDSi semiconductor devices 9505A-C may monitor their internal systems and report failures or upcoming failure indicators to the local SDSi asset agent circuitry 9540A-C of other ones of the SDSi semiconductor devices 9505A-C, and/or to the distributed agent(s) 9560, and/or to the orchestration circuitry 9550. As such, the example system 9500 implements an SDSi solution that allows for automated failure management of the SDSi semiconductor devices 9505A-C and as such, lowers maintenance costs and reduces downtime when an SDSi semiconductor device 9505A-C with desired activate features is not available.

In some examples, the local SDSi asset agent circuitry 9540A-C (e.g., such as its license processor 214) of the respective SDSi semiconductor devices 9505A-C evaluate their respective device's ability to deliver SDSi feature(s) according to the current SDSi license activation and credentials for authorized use. In some such examples, this information is evaluated by the SDSi asset agent circuitry 9540A-C locally in the SDSi semiconductor devices 9505A-C to provide the ability to recover from failure of an activated SDSi feature if dormant (e.g., hidden, recessive, etc.) and/or duplicated features are still available on-board the respective SDSi semiconductor devices 9505A-C. The presence of such a dormant/duplicate SDSi feature, and its subsequent activation, allows the functionality of the failed SDSi feature to be recovered on the respective SDSi semiconductor devices 9505A-C without an overall platform or workload service outage. In some examples, the SDSi license for the failed SDSi feature would be transferred, without interruption, to the dormant/duplicate SDSi feature that will be activated to replace the failed feature. In some examples, an activation key for the SDSi license would be re-generated based on the information obtained from the respective SDSi semiconductor devices 9505A-C, and the activation rights for the SDSi feature to be activated would be bridged while the new activation credentials are implemented.

In some examples, the monitoring techniques used in the example system 9500 to detect failures or future failure indicators may include annual failure rate (AFR) estimation techniques that evaluate the rate of degradation of silicon ingredients, processors and controllers, and estimate the MTTF (mean time to failure) of respective ones of the SDSi semiconductor devices 9505A-C. In some examples, the monitoring techniques used in the example system 9500 to detect failures or future failure indicators may additionally or alternatively include reputation calculus techniques that utilize system runtime and threshold metrics, such as, but not limited to, power metrics, thermal metrics, resource utilization metrics, etc., as well as external or environmental data (e.g., such as pollution data, humidity data, thermal data, etc.) to estimate the likelihood of failure based on the operational norms for respective ones of the SDSi semiconductor devices 9505A-C. In some examples, one or more of the monitoring techniques used in the example system 9500 process telemetry and/or other data collected from the SDSi semiconductor devices 9505A-C (e.g., reported by their respective SDSi asset agent circuitry 9540A-C) to perform their failure evaluations.

In some examples, the distributed agent(s) 9560A-C is(are) and the SDSi asset agent circuitry 9540A-C of the respective SDSi semiconductor devices 9505A-C may communicate with each other (e.g., using evaluation, planning and implementation services) to coordinate actions related to failure detection, collection and retention of telemetry information, identification of a replacement SDSi semiconductor device 9505A-C (e.g., the SDSi semiconductor device 9505B in the illustrated example) to continue a licensed SDSi feature of another SDSi semiconductor device 9505A-C associated with a failure detection (e.g., the SDSi semiconductor device 9505A in the illustrated example), SDSi license transfer, etc. Additionally or alternatively, in some examples, the respective SDSi semiconductor devices 9505A-C may intercommunicate (e.g., via their respective SDSi asset agent circuitry 9540A-C) to detect potential failures or to find hardware supporting SDSi features currently implemented by hardware that is about to fail or already failed. In both such examples, the orchestration circuitry 9550 may or may not be involved in the foregoing actions, (e.g., depending on data center setup).

In the example system 9500 of FIG. 95, after an actual failure or a potential failure of a given one of the SDSi semiconductor devices 9505A-C is detected or forecasted, the orchestration circuitry 9550, the distributed agent(s) 9560A-C, and/or the SDSi asset agent circuitry 9540A-C of the respective SDSi semiconductor devices 9505A-C operate to identify a replacement SDSi semiconductor device 9505A-C with the same or similar SDSi features as the failed/failing SDSi semiconductor device 9505A-C. For example, if the SDSi semiconductor device 9505A is associated with a detected failure condition corresponding to an actual or forecasted failure, the SDSi semiconductor device 9505B may be identified as its replacement. In some examples, the replacement SDSi semiconductor device 9505B is identified based on capability characteristics of the different SDSi semiconductor devices 9505A-C, the workload and/or workflow requirement (which is directly or indirectly identified) that is to be transferred from the failed/failing SDSi semiconductor device 9505A to the replacement SDSi semiconductor device 9505B, etc. In some examples, the replacement SDSi semiconductor device 9505B is identified based on a goal to provide the same agreed-to service characteristics by (1) identifying a replacement SDSi semiconductor device 9505B that supports similar SDSi features that can achieve the same service and/or contract agreement as the failed/failing SDSi semiconductor device 9505A, or (2) identifying a replacement SDSi semiconductor device 9505B that supports identical SDSi features that can achieve the same service and/or contract agreement the failed/failing SDSi semiconductor device 9505A. In some examples, the replacement SDSi semiconductor device 9505B may support the same SDSi feature activation as the failed/failing SDSi semiconductor device 9505A, such that after the replacement SDSi semiconductor device 9505B is reconfigured with transferred SDSi license, the SDSi features provided by the replacement SDSi semiconductor device 9505B have characteristics that meet or exceed a service level agreement (SLA) associated with the failed/failing SDSi semiconductor device 9505A.

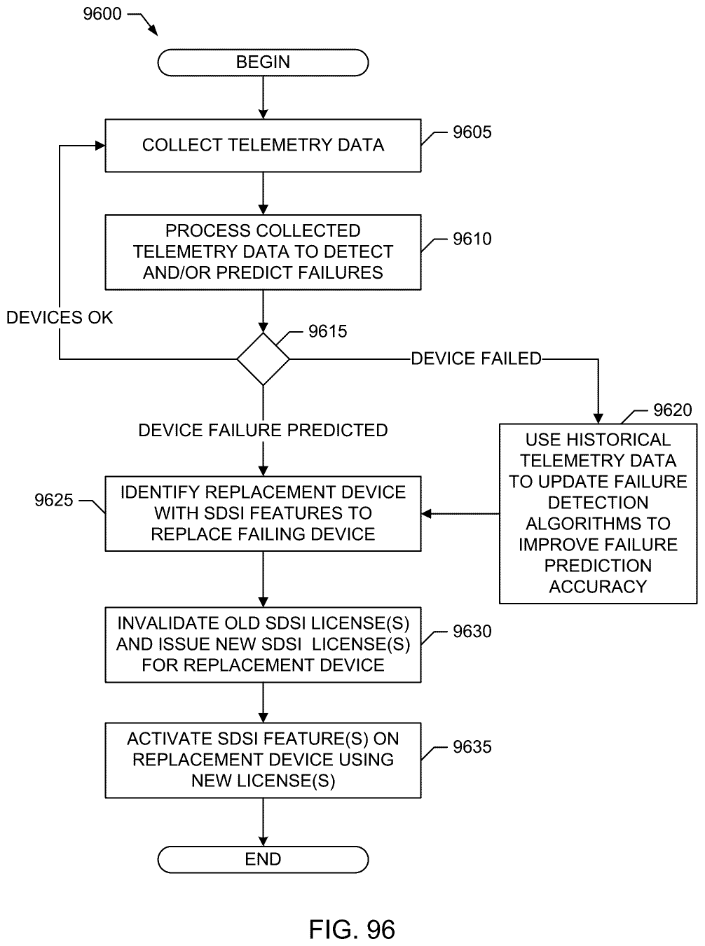

In some examples of the system 9500, after the replacement SDSi semiconductor device 9505B is identified, the old SDSi license(s) associated with the activated feature(s) of the failed/failing SDSi semiconductor device 9505A get invalidated while new SDSi license(s) bound to the replacement SDSi semiconductor device 9505B is(are) issued. After the new SDSi license(s) are issued, the orchestration circuitry 9550 and/or the distributed agent(s) 9560 cause the SDSi feature(s) corresponding to the new SDSi license(s) to be activated on the replacement SDSi semiconductor device 9505B using new license(s). In some examples, a customer management system (e.g., such as the customer enterprise system 115) is also updated to reflect the continued contract and license agreement by ensuring that costs, license terms and conditions do not change even if the license agreement date associated with the new SDSi licenses(s) is more recent than for the old SDSi licenses. Any of the SDSi license transfer techniques disclosed herein can be used to implement the transfer of SDSi license(s) from the failed/failing SDSi semiconductor device 9505B to the replacement SDSi semiconductor device 9505B in the system 9500 of the illustrated example. Further details concerning operation of the SDSi asset agent circuitry 9540A-C of the SDSi semiconductor devices 9505A-C, the distributed agent(s) 9560A-C and the orchestration circuitry W150 to perform SDSi usage evaluation and corresponding license transfer(s) responsive to detected and predicted failures in the example system 9500 are described below in connection with the flowchart of FIG. 96.

In some examples of the system 9500, one or more of the SDSi semiconductor devices 9505A-C support recovery of failed/failing SDSi features within the given SDSi semiconductor devices 9505A-C itself. For example, the SDSi asset agent circuitry 9540C (e.g., such as its license processor 214) of the SDSi semiconductor device 9505C may perform recovery operations within the SDSi semiconductor device 9505C itself provided that only some of the subcomponent(s) of the SDSi semiconductor device 9505C have failed and/or are forecasted to be failing. In such an example, transferring of the SDSi license(s) for the failed/failing SDSi features would not be needed as the license(s) already apply to the SDSi semiconductor device 9505C. For example, assume that one of the subcomponents (e.g., a CPU core) of the SDSi semiconductor device 9505C is broken or is about to fail and another dormant subcomponent of the same type is available. In such an example, the SDSi asset agent circuitry 9540C (e.g., such as its license processor 214) activates dormant subcomponent(s) (e.g., a dormant CPU core, for example) and deactivated failing/failed subcomponent(s) using SDSi technology, as disclosed herein. The existing workload may be moved almost seamlessly to the newly activated subcomponent.

While an example manner of implementing the system 9500 is illustrated in FIG. 95, one or more of the elements, processes, and/or devices illustrated in FIG. 95 may be combined, divided, re-arranged, omitted, eliminated, and/or implemented in any other way. Further, the example SDSi semiconductor devices 9505A-C, the example SDSi asset agent circuitry 9540A-C, the example orchestration circuitry 9550, the example distributed agents 9560A-C and/or, more generally, the example system 9500 of FIG. 95, may be implemented by hardware alone or by hardware in combination with software and/or firmware. Thus, for example, any of the example SDSi semiconductor devices 9505A-C, the example SDSi asset agent circuitry 9540A-C, the example orchestration circuitry 9550, the example distributed agents 9560A-C, and/or, more generally, the example system 9500, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example system 9500 may include one or more elements, processes, and/or devices in addition to, or instead of, those illustrated in FIG. 95, and/or may include more than one of any or all of the illustrated elements, processes and devices.

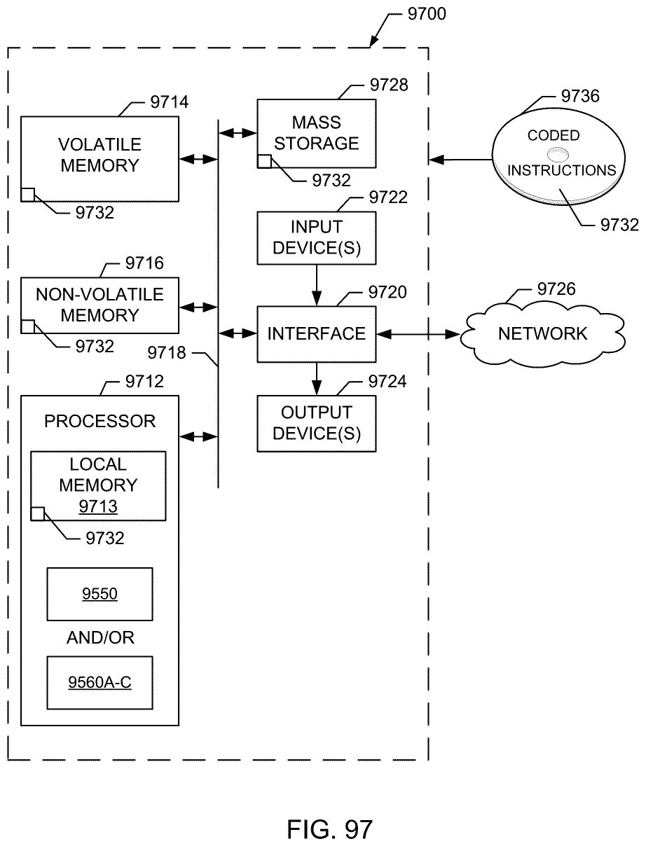

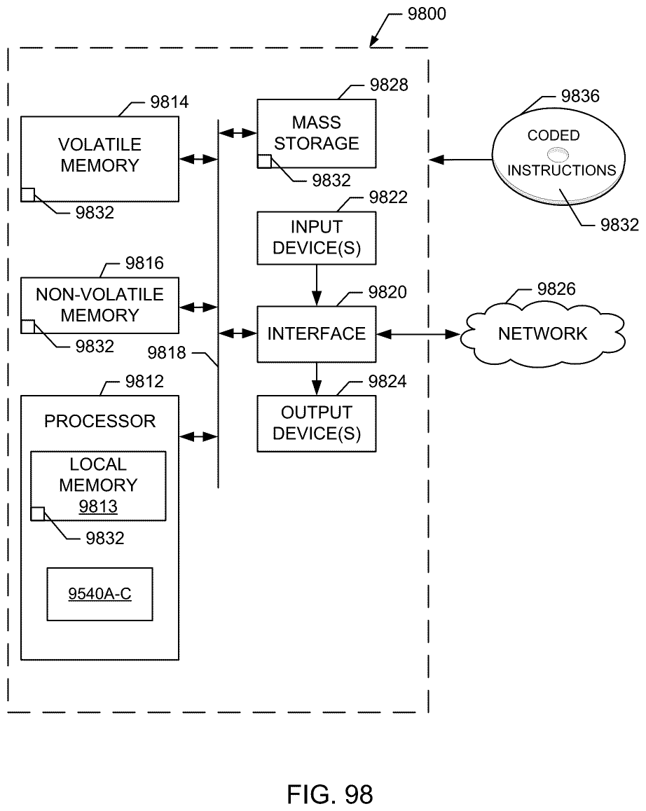

A flowchart representative of example machine readable instructions which may be executed to configure processor circuitry to implement the example system 9500 of FIG. 95 is shown in FIG. 96. The machine readable instructions may be one or more executable programs or portion(s) of an executable program for execution by processor circuitry, such as the processor circuitry 9712 and/or 9812 shown in the example processor platforms 9700 and/or 9812 discussed below in connection with FIG. 97 and FIG. 98 and/or the example processor circuitry discussed below in connection with FIGS. 150 and/or 151. The program(s) may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program(s) and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program(s) is(are) described with reference to the flowchart illustrated in FIG. 96, many other methods of implementing the example system 9500 may alternatively be used. For example, the order of execution of the blocks may be changed, and/or some of the blocks described may be changed, eliminated, combined and/or subdivided into multiple blocks. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 96 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc. Also, as used herein, the terms “computer readable” and “machine readable” are considered equivalent unless indicated otherwise.

FIG. 96 is a flowchart representative of example machine readable instructions and/or example operations 9600 that may be executed and/or instantiated by processor circuitry to performs SDSi usage evaluation and corresponding license transfer(s) responsive to detected and predicted failures in the system 9500. The machine readable instructions and/or operations 9600 of FIG. 96 can be implemented by the SDSi asset agent circuitry 9540A-C of the SDSi semiconductor devices 9505A-C, the distributed agent(s) 9560 and/or the orchestration circuitry 9550 of the example system 9500 of FIG. 95. With reference to the preceding figures and associated written descriptions, the machine readable instructions and/or the operations 9600 of FIG. 96 begin at block 9605 at which the SDSi asset agent circuitry 9540A-C of the SDSi semiconductor devices 9505A-C collect telemetry data for their respective SDSi semiconductor devices 9505A-C. For example, the telemetry data can include heartbeat and/or health data for monitored subcomponents of the SDSi semiconductor devices 9505A-C, such as, but not limited to, CPUs, memories, network components, accelerators, etc., included in the SDSi semiconductor devices 9505A-C. Additionally or alternatively, the telemetry data can include availability and/or usage data (e.g., resource usage, power usage, etc.) for the monitored subcomponents of the SDSi semiconductor devices 9505A-C, such as, but not limited to, CPU availability/usage, memory availability/usage, network component availability/usage, accelerator availability/usage, etc. Additionally or alternatively, the telemetry data can include temperature, humidity and/or other environmental measurement for the SDSi semiconductor devices 9505A-C and/or their respective monitored subcomponents.

In some examples, at block 9605, the orchestration circuitry 9550 and/or the distributed agent(s) 9560A-C collect the telemetry data for the SDSi semiconductor devices 9505A-C from their respective SDSi asset agent circuitry 9540A-C. In some examples, any appropriate communication protocol (e.g., Internet protocol (IP), transmission control protocol (TCP), hypertext transfer protocol (HTTP), etc.) can be used to communicate the telemetry data from the SDSi asset agent circuitry 9540A-C of the SDSi semiconductor devices 9505A-C to the orchestration circuitry 9550 and/or the distributed agent(s) 9560A-C. In some examples, the integrity of the communications between the SDSi asset agent circuitry 9540A-C of the SDSi semiconductor devices 9505A-C, the orchestration circuitry 9550 and/or the distributed agent(s) 9560A-C is protected using secure protocols such as, but not limited to, security protocol and data model (SPDM) or similar protocols if communication is between hardware components, mutual Transport Level Security (mTLS) or similar protocol if communication is between software components, etc.

At block 9610, the collected telemetry data is processed by the SDSi asset agent circuitry 9540A-C, the orchestration circuitry 9550 and/or the distributed agent(s) 9560A-C to determine whether one or more of the SDSi semiconductor devices 9505A-C (and/or one or more of their respective subcomponents) have failed and/or whether one or more of the SDSi semiconductor devices 9505A-C (and/or one or more of their respective subcomponents) are predicted/forecasted to fail. For example, the SDSi asset agent circuitry 9540A-C, the orchestration circuitry 9550 and/or the distributed agent(s) 9560A-C can implement one or more classical failure detection algorithms (e.g., with one or more failure detection threshold) and/or one or more machine learning algorithms detect failures and/or predict failures of respective ones of the SDSi semiconductor devices 9505A-C and/or their subcomponents. In some examples, if multiple data processors (e.g., multiple ones of the SDSi asset agent circuitry 9540A-C, the orchestration circuitry 9550 and/or the distributed agent(s) 9560A-C) operate on the collected telemetry data to detect/predict failures, then a consensus among the multiple data processors may be required to detect/predict failures, as well as to make decision concerning identifying the replacement target, transferring the SDSi licenses, etc. For example, such consensus may be determined based on techniques used in blockchain networks and/or via a majority vote among the multiple data processors.

At block 9615, the SDSi asset agent circuitry 9540A-C, the orchestration circuitry 9550 and/or the distributed agent(s) 9560A-C determine (e.g., individually, based on a consensus, etc.) whether one or more of the SDSi semiconductor devices 9505A-C and/or their subcomponents have failed or are predicted to fail. If none of the SDSi semiconductor devices 9505A-C have failed or are predicted to fail (corresponding to the “DEVICES OK” output from block 9615), then processing returns to block 9605 to cause telemetry data to continue to be collected and processed. However, if one of the SDSi semiconductor devices 9505A-C, such as the SDSi semiconductor device 9505A, has failed (corresponding to the “DEVICE FAILED” output from block 9615), then at block 9620 historical telemetry data for the failed SDSi semiconductor device 9505A is retrieved from storage (e.g., at the orchestration circuitry 9550 and/or the distributed agent(s) 9560A-C because the SDSi semiconductor device 9505A has failed) and is used to update the classical failure detection algorithms and/or one or more machine learning algorithms used at block 9610 to detect and/or predict failures. In this way, the classical failure detection algorithms and/or one or more machine learning algorithms used at block 9610 can be adjusted/improved to predict failures more accurately before they actually occur.

However, if one of the SDSi semiconductor devices 9505A-C, such as the SDSi semiconductor device 9505A, has not yet failed but is predicted to fail (corresponding to the “DEVICE FAILURE PREDICTED” output from block 9615), then at block 9625 the orchestration circuitry 9550, the distributed agent(s) 9560A-C, and/or the SDSi asset agent circuitry 9540A-C of the respective SDSi semiconductor devices 9505A-C operate to identify a replacement SDSi semiconductor device for the SDSi semiconductor device 9505A associated with the failure condition. For example, the orchestration circuitry 9550, one or more of the distributed agent(s) 9560A-C and/or one or more of the SDSi asset agent circuitry instances 9540A-C may communicate with each other to identify a replacement SDSi semiconductor device, such as the SDSi semiconductor device 9540B, with available SDSi features that are the same or similar to the failing SDSi semiconductor device 9505A such that the replacement SDSi semiconductor device 9505B can take over the workload being handled by the failing SDSi semiconductor device 9505A. As noted above, in some examples, any appropriate communication protocol (e.g., IP, TCP, HTTP, etc.) can be used to communicate between the SDSi asset agent circuitry 9540A-C of the SDSi semiconductor devices 9505A-C and the orchestration circuitry 9550 and/or the distributed agent(s) 9560A-C. Furthermore, the integrity of the communications between the SDSi asset agent circuitry 9540A-C of the SDSi semiconductor devices 9505A-C, the orchestration circuitry 9550 and/or the distributed agent(s) 9560A-C is protected using secure protocols such as, but not limited to, SPDM or similar protocols if communication is between hardware components, mTLS or similar protocol if communication is between software components, etc.

In some examples, one or more of the SDSi features on the replacement SDSi semiconductor device 9505B that will be used to replace the features of the failing SDSi semiconductor device 9505A may not be active. As such, at block 9630, the orchestration circuitry 9550, the distributed agent(s) 9560A-C, and/or the SDSi asset agent circuitry 9540A-C of the failing and/or replacement SDSi semiconductor devices 9505A-C perform any of the SDSi license transfer techniques disclosed herein to transfer the SDSi license(s) from the failing SDSi semiconductor device 9505A to the replacement SDSi semiconductor device 9505B. Then, at block 9635, the orchestration circuitry 9550, the distributed agent(s) 9560A-C, and/or the SDSi asset agent circuitry 9540A-C of the failing and/or replacement SDSi semiconductor devices 9505A-C perform any of the SDSi license transfer techniques disclosed herein to deactivate the SDSi features(s) corresponding to the old SDSi license(s) on the failing SDSi semiconductor device 9505A and activate the SDSi features(s) corresponding to the new SDSi license(s) on the replacement SDSi semiconductor device 9505B. The machine readable instructions and/or operations 9600 then end.

As noted above, in some examples, one or more of the SDSi semiconductor devices 9505A-C support recovery of failed/failing SDSi features withing the given SDSi semiconductor devices 9505A-C itself. For example, the SDSi asset agent circuitry 9540C (e.g., such as its license processor 214) of the SDSi semiconductor device 9505C may perform recovery operations within the SDSi semiconductor device 9505C itself provided that only some of the subcomponent(s) of the SDSi semiconductor device 9505C have failed and/or are forecasted to be failing. In some such examples, the SDSi asset agent circuitry 9540C (e.g., such as its license processor 214) of the SDSi semiconductor device 9505C performs the processing at blocks 9605-9625 of FIG. 96 to detect failed and/or failing subcomponent(s) of the SDSi semiconductor device 9505C (e.g., that are associated with activated SDSi feature(s)), and to identify replacement subcomponent(s) that can be used to activate corresponding replacement SDSi feature(s) in the SDSi semiconductor device 9505C. In some such examples, the processing at 9630 and 9635 of FIG. 96 can be omitted because the SDSi semiconductor device 9505C already possesses the requisite SDSi license(s) for the replacement SDSi feature(s) and, thus, no license transfer is needed.

FIG. 97 is a block diagram of an example processor platform 9700 structured to execute and/or instantiate the machine readable instructions and/or the operations of FIG. 96 to implement the example orchestrator 9550 and/or one or more of the example distributed agents 9560A-C in the example system 9500 of FIG. 95. The processor platform 9700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 9700 of the illustrated example includes processor circuitry 9712. The processor circuitry 9712 of the illustrated example is hardware. For example, the processor circuitry 9712 can be implemented by one or more integrated circuits, logic circuits, FPGAs, microprocessors, CPUs, GPUs, DSPs, and/or microcontrollers from any desired family or manufacturer. The processor circuitry 9712 may be implemented by one or more semiconductor based (e.g., silicon based) devices. In this example, the processor circuitry 9712 implements the example orchestration circuitry 9550 and/or one or more of the example distributed agents 9560A-C.

The processor circuitry 9712 of the illustrated example includes a local memory 9713 (e.g., a cache, registers, etc.). The processor circuitry 9712 of the illustrated example is in communication with a main memory including a volatile memory 9714 and a non-volatile memory 9716 by a bus 9718. The volatile memory 9714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 9716 may be implemented by flash memory and/or any other desired type of memory device. Access to the main memory 9714, 9716 of the illustrated example is controlled by a memory controller 9717.

The processor platform 9700 of the illustrated example also includes interface circuitry 9720. The interface circuitry 9720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 9722 are connected to the interface circuitry 9720. The input device(s) 9722 permit(s) a user to enter data and/or commands into the processor circuitry 9712. The input device(s) 9722 can be implemented by, for example, an audio sensor, a microphone, a camera (still or video), a keyboard, a button, a mouse, a touchscreen, a track-pad, a trackball, a trackbar, an isopoint device, a voice recognition system and/or any other human-machine interface. In some examples, the input device(s) 9722 are arranged or otherwise configured to allow the user to control the processor platform 9700 and provide data to the processor platform 9700 using physical gestures, such as, but not limited to, hand or body movements, facial expressions, face recognition, etc.

One or more output devices 9724 are also connected to the interface circuitry 9720 of the illustrated example. The output device(s) 9724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 9720 of the illustrated example, thus, typically includes a graphics driver card, a graphics driver chip, and/or graphics processor circuitry such as a GPU.

The interface circuitry 9720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 9726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 9700 of the illustrated example also includes one or more mass storage devices 9728 to store software and/or data. Examples of such mass storage devices 9728 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 9732, which may be implemented by the machine readable instructions of FIG. 96, may be stored in the mass storage device 9728, in the volatile memory 9714, in the non-volatile memory 9716, and/or on a removable non-transitory computer readable storage medium such as a CD or DVD.

FIG. 98 is a block diagram of an example processor platform 9800 structured to execute and/or instantiate the machine readable instructions and/or the operations of FIG. 96 to implement one or more of the example SDSi semiconductor devices 9505A-C in the example system 9500 of FIG. 95. The processor platform 9800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 9800 of the illustrated example includes processor circuitry 9812. The processor circuitry 9812 of the illustrated example is hardware. For example, the processor circuitry 9812 can be implemented by one or more integrated circuits, logic circuits, FPGAs, microprocessors, CPUs, GPUs, DSPs, and/or microcontrollers from any desired family or manufacturer. The processor circuitry 9812 may be implemented by one or more semiconductor based (e.g., silicon based) devices. In this example, the processor circuitry 412 implements one or more of the example SDSi asset agent circuitry 9540A-C for the respective one or more of the SDSi semiconductor devices 9505A-C implemented by the processor platform 9800.

The processor circuitry 9812 of the illustrated example includes a local memory 9813 (e.g., a cache, registers, etc.). The processor circuitry 9812 of the illustrated example is in communication with a main memory including a volatile memory 9814 and a non-volatile memory 9816 by a bus 9818. The volatile memory 9814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 9816 may be implemented by flash memory and/or any other desired type of memory device. Access to the main memory 9814, 9816 of the illustrated example is controlled by a memory controller 9817.

The processor platform 9800 of the illustrated example also includes interface circuitry 9820. The interface circuitry 9820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 9822 are connected to the interface circuitry 9820. The input device(s) 9822 permit(s) a user to enter data and/or commands into the processor circuitry 9812. The input device(s) 9822 can be implemented by, for example, an audio sensor, a microphone, a camera (still or video), a keyboard, a button, a mouse, a touchscreen, a track-pad, a trackball, a trackbar, an isopoint device, a voice recognition system and/or any other human-machine interface. In some examples, the input device(s) 9822 are arranged or otherwise configured to allow the user to control the processor platform 9800 and provide data to the processor platform 9800 using physical gestures, such as, but not limited to, hand or body movements, facial expressions, face recognition, etc.

One or more output devices 9824 are also connected to the interface circuitry 9820 of the illustrated example. The output device(s) 9824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 9820 of the illustrated example, thus, typically includes a graphics driver card, a graphics driver chip, and/or graphics processor circuitry such as a GPU.

The interface circuitry 9820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 9826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 9800 of the illustrated example also includes one or more mass storage devices 9828 to store software and/or data. Examples of such mass storage devices 9828 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 9832, which may be implemented by the machine readable instructions of FIG. 96, may be stored in the mass storage device 9828, in the volatile memory 9814, in the non-volatile memory 9816, and/or on a removable non-transitory computer readable storage medium such as a CD or DVD.

Transferring Node Locked SDSi Licenses

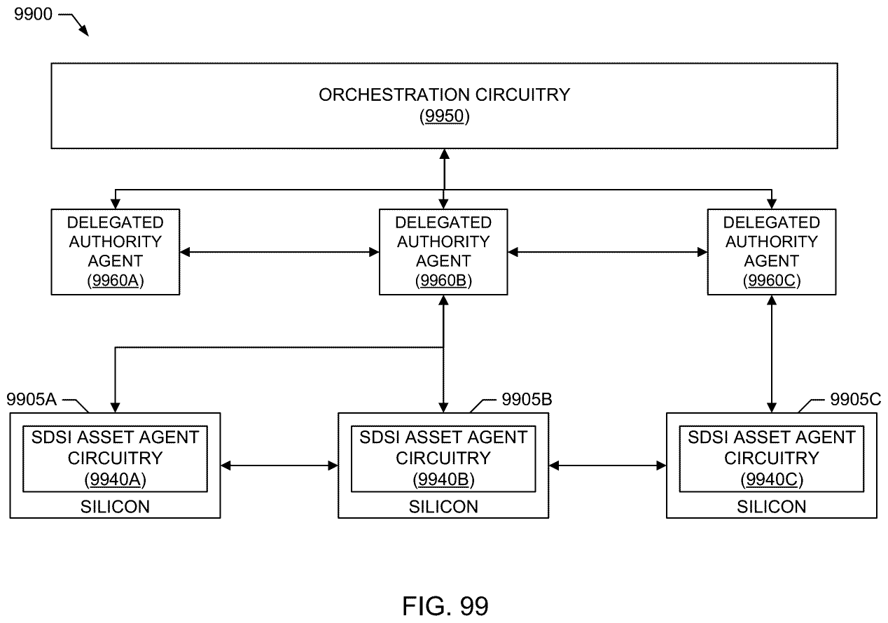

Turning to the figures, FIG. 99 illustrates a block diagram of an example system 9900 that implements one or more techniques to transfer node locked SDSi licenses between SDSi-enabled products, such as the SDSi semiconductor device 105 described above. The example system 9900 of FIG. 99 includes multiple example SDSi semiconductor devices 9905A-C that, as described above, may correspond to any type of silicon products, such as, but not limited to, computer processors, CPUs, IPUs, XPUs, semiconductor chips, silicon hardware devices, etc., as well as circuit boards and/or systems employing such silicon products, etc. In the illustrated example, the SDSi semiconductor devices 9905A-C implement respective SDSi features as described above in connection with the SDSi semiconductor device 105. As such, each one of the SDSi semiconductor devices 9905A-C includes respective example SDSi asset agent circuitry 9940A-C, which implement an SDSi asset agent such as the SDSi agent 140 described above. The SDSi asset agent circuitry 9940A-C also implements one or more techniques to transfer node locked SDSi licenses between ones of the SDSi semiconductor devices 9905A-C, as described in further detail below.

The example system 9900 of FIG. 99 also includes example orchestration circuitry 9950 and/or one or more example delegated authority agents 9960A-C to implement one or more techniques to transfer node locked SDSi licenses between ones of the SDSi semiconductor devices 9905A-C, as described in further detail below. In the illustrated example of FIG. 99, the SDSi semiconductor devices 9905A-C, the orchestration circuitry 9950 and the delegated authority agent(s) 9960A-C are in communication with each other via one or more example networks (not shown), such as the example network 120 described above.

In some examples, the system 9900 can correspond to a customer data center, customer manufacturing center, customer data processing site, etc. In some such examples, the SDSi semiconductor devices 9905A-C can be used to implement servers of the customer data center, and the orchestration circuitry 9950 can correspond to and/or be implemented by an orchestrator and/or other enterprise system associated with a customer utilizing the SDSi semiconductor devices 9905A-C. For example, the orchestration circuitry 9950 can be implemented by the example customer enterprise system 115, the example SDSi client agent 272 and/or the example entitlement management service 278 described above.

In some such examples, the delegated authority agent(s) 9960A-C can also correspond to and/or be implemented by software and/or hardware in the customer data center, customer manufacturing center, customer data processing site, etc. For example, the delegated authority agent(s) 9960A-C can be implemented by software executed by and/or hardware included in one or more servers, routers, edge devices, computers, orchestrators, enterprise systems, etc., associated with a customer utilizing the SDSi semiconductor devices 9905A-C. In some examples, one or more of the delegated authority agent(s) 9960A-C is(are) implemented by the orchestration circuitry 9950. In some examples, one or more of the delegated authority agent(s) 9960A-C is(are) operate separately from the orchestration circuitry 9950.

As such, the elements of the example system 9900 of FIG. 99 may be instantiated (e.g., creating an instance of, bring into being for any length of time, materialize, implement, etc.) by processor circuitry such as a central processing unit executing instructions. Additionally or alternatively, the elements of the example system 9900 of FIG. 99 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 99 may, thus, be instantiated at the same or different times. Some or all of the circuitry may be instantiated, for example, in one or more threads executing concurrently on hardware and/or in series on hardware. Moreover, in some examples, some or all of the circuitry of FIG. 99 may be implemented by microprocessor circuitry executing instructions to implement one or more virtual machines and/or containers. Also, although the example system 9900 of FIG. 99 is illustrated as including three SDSi semiconductor devices 9905A-C, one instance of orchestration circuitry 9950, and delegated authority agent(s) 9960A-C, the system 9900 can include any number of SDSi semiconductor devices 9905A-C, any number of instances of orchestration circuitry 9950, and any number of delegated authority agent(s) 9960A-C.

As indicated above, the example system 9900 implement one or more techniques to transfer node locked SDSi licenses between ones of the SDSi semiconductor devices 9905A-C. For example, one of the SDSi semiconductor devices 9905A-C may start malfunctioning or fail completely. In some example scenarios, if that SDSi semiconductor device 9905A-C had been upgraded using SDSi technology as disclosed herein, the SDSi license(s) for the upgrade(s) may be lost if the SDSi semiconductor device 9905A-C stops functioning correctly. This is because in some prior examples, an SDSi license for a given feature is bound to the SDSi semiconductor device 9905A-C when the corresponding SDSi feature is activated and cannot be transferred or used on another one of the SDSi semiconductor devices 9905A-C. In some prior licensing techniques, a manual process is executing by the silicon manufacturer to issue a new SDSi license for a replacement SDSi semiconductor device when a failed or failing SDSi semiconductor device is reported by the customer. However, such a manual mechanism could be taken advantage of if a failure is reported for an SDSi semiconductor device that is not actually failed or failing to obtain a new license from the silicon manufacturer for another SDSi semiconductor device without proper payment.

In contrast with such prior licensing techniques, in example system 9900, the SDSi semiconductor devices 9905A-C (e.g., via their respective SDSi asset agent circuitry 9940A-C) the orchestration circuitry 9950 and/or the delegated authority agent(s) 9960A-C implement one or more techniques that allow for automatic and secure transfer of an SDSi license from a failed or failing SDSi semiconductor device to a replacement SDSi semiconductor device when a risk of failure is detected. Failed and failing SDSi semiconductor device(s) in the system 9900 can be detected using any failure detection technique, including one or more of the failure detection techniques disclosed herein.

In some examples, the system 9900 implements one or more of the following example techniques to transfer node locked SDSi licenses between ones of the SDSi semiconductor devices 9905A-C. In a first example license transfer technique disclosed herein, which may be implemented by the system 9900, the SDSi semiconductor devices 9905A-C (e.g., via their respective SDSi asset agent circuitry 9940A-C) query (e.g., poll) one or more of the delegated authority agent(s) 9960A-C for their respective SDSi licenses and/or the statuses of those licenses. In some such examples, the delegated authority agent(s) 9960A-C is(are) responsible for license management (e.g., moving SDSi license(s) from one of the SDSi semiconductor devices 9905A-C to another) and mark appropriate SDSi licenses as active and inactive. In some such examples, the SDSi semiconductor devices 9905A-C (e.g., via their respective SDSi asset agent circuitry 9940A-C) obey the SDSi license statuses provided by the delegated authority agent(s) 9960A-C and act accordingly (e.g., by activating or deactivating the SDSi features corresponding to the respective SDSi license(s)). In some examples, one or more of the delegated authority agent(s) 9960A-C act as a community delegated authority agent that stores and maintains one or more backups of the current and/or previous SDSi license compositions of the system 9900 (e.g., as shadow copies, snapshots, etc.) For example, the community delegated authority agent can use its SDSi license backup(s) to replay prior SDSi feature requests and corresponding SDSi license grants for a new SDSi semiconductor device added to the system 9900 (e.g., to replace an existing, failing one of the SDSi semiconductor devices 9905A-C).

In a second example license transfer technique disclosed herein, which may be implemented by the system 9900, one or more of the delegated authority agent(s) 9960A-C push new SDSi licenses and/or the statuses of those licenses to the SDSi semiconductor devices 9905A-C (e.g., via their respective SDSi asset agent circuitry 9940A-C). Such push operations may be in addition to, are instead of, the SDSi semiconductor devices 9905A-C (e.g., via their respective SDSi asset agent circuitry 9940A-C) polling one or more of the delegated authority agent(s) 9960A-C for their respective SDSi licenses and/or the statuses of those licenses. In some such examples, based on the SDSi license information pushed by the delegated authority agent(s) 9960A-C to the SDSi semiconductor devices 9905A-C, the respective SDSi asset agent circuitry 9940A-C configure (e.g., activate and/or deactivate) the SDSi feature sets of the SDSi semiconductor devices 9905A-C to match the SDSi license configurations advertised (e.g., pushed) by the delegated authority agent(s) 9960A-C.

In a third example license transfer technique disclosed herein, which may be implemented by the system 9900, failing and replacement ones of the SDSi semiconductor devices 9905A-C (e.g., via their respective SDSi asset agent circuitry 9940A-C) are able to setup a secure channel between each other and move SDSi license(s) through this channel. For example, if the SDSi semiconductor device 9905A is determined to be failing (e.g., using one or more of the failure detection techniques disclosed herein), the SDSi asset agent circuitry 9940A of the SDSi semiconductor device 9905A may deactivate its SDSi license(s) and the SDSi feature(s) controlled by those license(s). Additionally, a replacement SDSi semiconductor device, such as the SDSi semiconductor device 9905B (e.g., which is identified using any of the replacement identification techniques disclosed herein), copies (e.g., via their respective SDSi asset agent circuitry 9940A) the SDSi license(s) from failing SDSi semiconductor device 9905A and activates the SDSi feature(s) corresponding to those license(s).

In some examples, the first and second SDSi license transfer solutions disclosed above rely on delegated authority agent(s) 9960A-C that are trusted to securely perform the SDSi license polling and pushing operations described above. In contrast, in some examples, the third SDSi license transfer solution disclosed does not require the presence of a delegated authority agent, much less a trusted delegated authority agent, to facilitate SDSi license transfers.

The foregoing example SDSi license transfer solutions allow for fully automated and trusted failure management of SDSi upgraded semiconductor devices, such as the SDSi semiconductor devices 9905A-C. As such, the foregoing example SDSi license transfer solutions can lower maintenance costs and reduce down time when SDSi upgraded semiconductor devices with desired SDSi features are not available. The foregoing example SDSi license transfer solutions can also reduce risk of financial loss associated with improper SDSi license transfer requests.

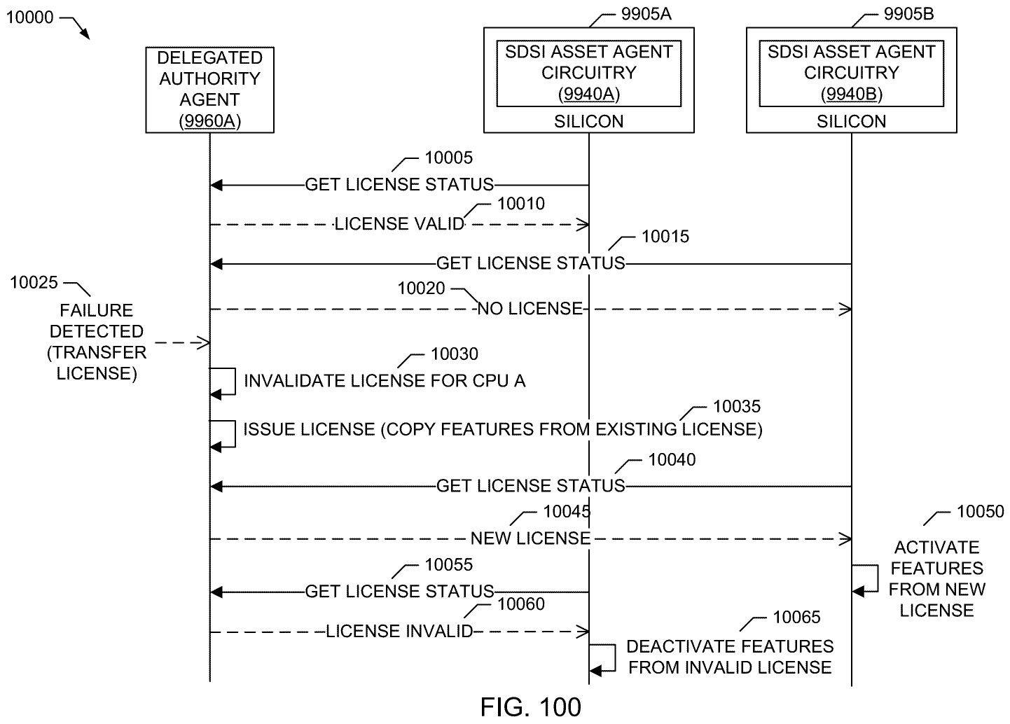

FIGS. 100-102 depict ladder diagrams illustrating example implementations of some of the example techniques disclosed herein to transfer node locked SDSi licenses between ones of the SDSi semiconductor devices 9905A-C. In the illustrated examples of FIGS. 100-102, it is assumed that the SDSi semiconductor device 9905A has been identified as the failing device in the system 9900 (e.g., using any failure detection technique disclosed herein), the SDSi semiconductor device 9905B has been identified as the replacement device in the system 9900 (e.g., using any failure detection technique disclosed herein), and the delegated authority agent 9960A is managing the SDSi license transfer. Also, in the illustrated examples of FIGS. 100-102, any appropriate communication protocol (e.g., Internet protocol (IP), transmission control protocol (TCP), hypertext transfer protocol (HTTP), etc.) can be used to exchange the messages and/or any other communications depicted in the ladder diagrams. In some examples, the integrity of such messages and/or any other communications between the SDSi asset agent circuitry 9940A-C of the SDSi semiconductor devices W105A-C, the orchestration circuitry 9950 and/or the delegated authority agent(s) 9960A-C is protected using secure protocols such as, but not limited to, security protocol and data model (SPDM) or similar protocols if communication is between hardware components, mutual Transport Level Security (mTLS) or similar protocol if communication is between software components, etc.

FIG. 100 depicts a ladder diagram illustrating an example polling-based license transfer operation 10000 implemented in accordance with teachings of this disclosure. The example polling-based license transfer operation 10000 is based on the SDSi asset agent circuitry 9940A-C of the SDSi semiconductor devices 9905A-C polling the trusted delegated authority agent(s) 9960A-C to obtain information about their respective SDSi license(s). This SDSi license information returned by the trusted delegated authority agent(s) 9960A-C may include new/updated SDSi license(s) with changed SDSi feature set(s) to be activated or deactivated, status information indicating that a previously issued SDSi license has been deactivated, etc. In the polling-based license transfer operation 10000, the SDSi asset agent circuitry 9940A-C of the SDSi semiconductor devices 9905A-C conform to the SDSi license information received from trusted delegated authority agent(s) 9960A-C and activate new SDSi feature(s) controlled by activated license(s) and/or deactivate SDSi feature(s) controlled by deactivated license(s) on their respective SDSi semiconductor devices 9905A-C accordingly.

Turning to FIG. 100, the example polling-based license transfer operation 10000 corresponds to a scenario in an SDSi license is moved from the failing SDSi semiconductor device 9905A to the replacement SDSi semiconductor device 9905A using a polling mechanism, as disclosed herein. In the illustrated example, the SDSi semiconductor devices 9905A-C in the system 9900 (e.g., in the data center), which include the failing SDSi semiconductor device 9905A and the replacement SDSi semiconductor device 9905B, periodically poll the delegated authority agent 9960A for the status of their SDSi license(s). For example, before a potential failure, the SDSi asset agent circuitry W140A (e.g., such as its license processor 214) of the SDSi semiconductor device 9905A sends an example get license status message 10005 to the delegated authority agent 9960A for the status of the SDSI license(s) of the SDSi semiconductor device 9905A. In response, the delegated authority agent 9960A sends an example license valid response message 10010 to the SDSi asset agent circuitry W140A (e.g., such as its license processor 214) of the SDSi semiconductor device 9905A that indicates the current SDSi license issued to the SDSi semiconductor device 9905A is valid. Similarly, the SDSi asset agent circuitry W140B (e.g., such as its license processor 214) of the SDSi semiconductor device 9905B sends an example get license status message 10015 to the delegated authority agent 9960A for the status of the SDSI license(s) of the SDSi semiconductor device 9905B. In response, the delegated authority agent 9960A sends an example no license response message 10020 to the SDSi asset agent circuitry W140B (e.g., such as its license processor 214) of the SDSi semiconductor device 9905B that indicates there are no active SDSi licenses for the SDSi semiconductor device 9905B.

Sometime later, the delegated authority agent 9960A receives an example failure detection message 10025 (e.g., based on any of the failure detection techniques disclosed herein), which indicates that a failure condition associated with the SDSi semiconductor device 9905A has been detected. Furthermore, in the illustrated example, the failure detection message 10025 includes instructions to move (e.g., transfer) the SDSi license(s) from the failing SDSi semiconductor device 9905A to the replacement SDSi semiconductor device 9905B. For example, the replacement SDSi semiconductor device 9905B can be identified using any of the associated replacement identification techniques disclosed herein.

In the illustrated example, in response to the failure detection message 10025, the delegated authority agent 9960A perform an example invalidate license operation 10030 to invalidate the active SDSi license(s) for the failing SDSi semiconductor device 9905A. The delegated authority agent 9960A also performs an example issue license operation 10035 to copy the configuration from the SDSi license(s) of the failing SDSi semiconductor device 9905A and to create a new SDSi license(s) based on the copied configuration for the replacement SDSi semiconductor device 9905B.

Sometime later (e.g., based on a polling frequency/period, a polling schedule, etc.), the SDSi asset agent circuitry W140B (e.g., such as its license processor 214) of the SDSi semiconductor device 9905B sends an example get license status message 10040 to the delegated authority agent 9960A to again poll for the status of the SDSI license(s) of the SDSi semiconductor device 9905B. In the illustrated example, in response, the delegated authority agent 9960A now sends an example new license response message 10045 to the SDSi asset agent circuitry W140B (e.g., such as its license processor 214) of the SDSi semiconductor device 9905B to provide the new SDSi license(s) for the SDSi semiconductor device 9905B. In response, the SDSi asset agent circuitry W140B (e.g., such as its license processor 214) of the SDSi semiconductor device 9905B performs an example activate feature operation 10050 to activate the SDSi feature(s) corresponding to the new SDSi license(s) on the SDSi semiconductor device 9905B.

Also sometime later (e.g., based on a polling frequency/period, a polling schedule, etc.), in the example of FIG. 100, the SDSi asset agent circuitry W140A (e.g., such as its license processor 214) of the SDSi semiconductor device 9905A sends an example get license status message 10055 to the delegated authority agent 9960A to again poll for the status of the SDSI license(s) of the SDSi semiconductor device 9905A. In the illustrated example, in response, the delegated authority agent 9960A now sends an example license invalid response message 10060 to the SDSi asset agent circuitry W140B (e.g., such as its license processor 214) of the SDSi semiconductor device 9905B that indicates there are no active SDSi licenses for the SDSi semiconductor device 9905A. In response to the license invalid message 10060, the SDSi asset agent circuitry W140A (e.g., such as its license processor 214) of the SDSi semiconductor device 9905A performs an example deactivate feature operation 10060 to deactivate the SDSi feature(s) corresponding to the invalidated SDSi license(s) on the SDSi semiconductor device 9905B. In some examples. if a rogue actor blocks the license invalid message 10060 to hide the fact that the license was invalidated, the SDSi asset agent circuitry W140A of the SDSi semiconductor device 9905A may include a timer or other mechanism, as disclosed herein, to disable the active SDSi license(s) of the SDSi semiconductor device 9905A if polling fails to confirm the license(s) to be active within specified time (e.g., a specified timeout period).

In the illustrated example of FIG. 100, the order of polling may be random, and it may happen that the SDSi semiconductor device 9905A will poll for its updated status before the SDSi semiconductor device 9905B does, or both devices may poll at the same time. Also, in some example implementations of the polling-based license transfer operation 10000, the messages sent between the delegated authority agent 9960A and the SDSi semiconductor devices 9905A-B are digitally signed and/or otherwise attested to be trustworthy.

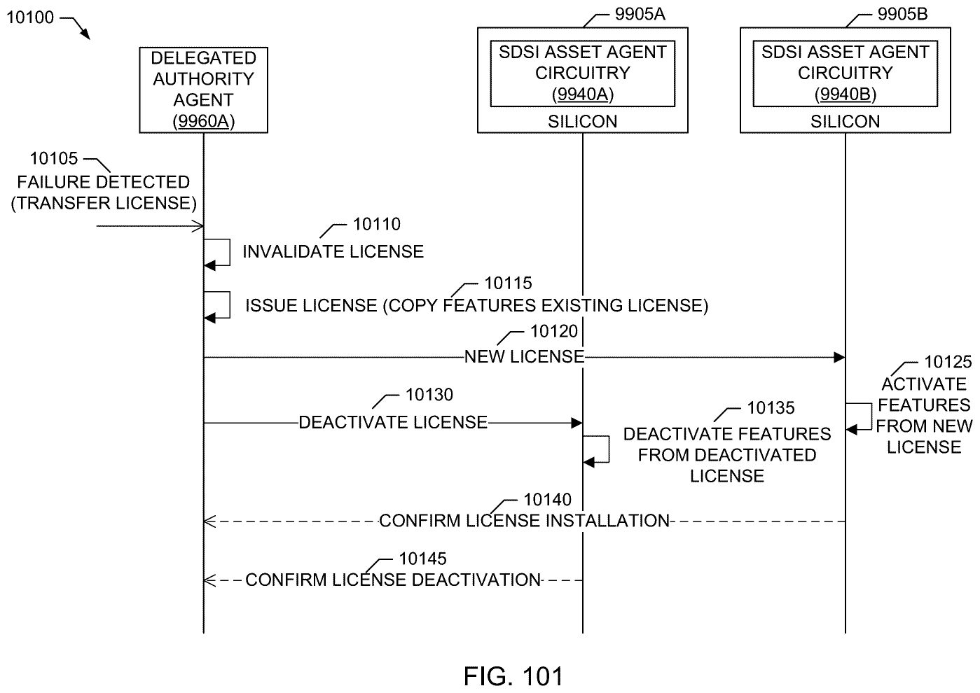

FIG. 101 depicts a ladder diagram illustrating an example push-based license transfer operation 10100 implemented in accordance with teachings of this disclosure. The example push-based license transfer operation 10100 is based on the trusted delegated authority agent(s) 9960A-C pushing SDSi license information (e.g., such as SDSi license status information and/or the SDSi licenses themselves) to the SDSi asset agent circuitry 9940A-C of the SDSi semiconductor devices 9905A-C in the system 9900. For example, the trusted delegated authority agent(s) 9960A-C may push SDSi license updates to affected ones of the SDSi semiconductor devices 9905A-C when there is a need to transfer SDSi license(s) based on a predicted failure of one of the SDSi semiconductor devices 9905A-C.

Turning to FIG. 101, the example polling-based license transfer operation 10100 corresponds to a scenario in an SDSi license is moved from the failing SDSi semiconductor device 9905A to the replacement SDSi semiconductor device 9905A using a push mechanism, as disclosed herein. In the illustrated example, the polling-based license transfer operation 10100 begins when the delegated authority agent 9960A receives an example failure detection message 10105 (e.g., based on any of the failure detection techniques disclosed herein), which indicates that a failure condition associated with the SDSi semiconductor device 9905A has been detected. Furthermore, in the illustrated example, the failure detection message 10105 includes instructions to move (e.g., transfer) the SDSi license(s) from the failing SDSi semiconductor device 9905A to the replacement SDSi semiconductor device 9905B. For example, such the replacement SDSi semiconductor device 9905B can be identified using any of the associated techniques disclosed herein.

In the illustrated example, in response to the failure detection message 10105, the delegated authority agent 9960A perform an example invalidate license operation 10110 to invalidate the active SDSi license(s) for the failing SDSi semiconductor device 9905A. The delegated authority agent 9960A also performs an example issue license operation 10115 to copy the configuration from the SDSi license(s) of the failing SDSi semiconductor device 9905A and to create a new SDSi license(s) based on the copied configuration for the replacement SDSi semiconductor device 9905B.

In the illustrated example, the delegated authority agent 9960A then sends an example new license message 10120 to the SDSi asset agent circuitry W140B (e.g., such as its license processor 214) of the SDSi semiconductor device 9905B to push the new SDSi license(s) to the SDSi semiconductor device 9905B. In response, the SDSi asset agent circuitry W140B (e.g., such as its license processor 214) of the SDSi semiconductor device 9905B performs an example activate feature operation 10125 to activate the SDSi feature(s) corresponding to the new SDSi license(s) on the SDSi semiconductor device 9905B.

In the illustrated example, the delegated authority agent 9960A also sends an example deactivate license message 10130 to the SDSi asset agent circuitry W140B (e.g., such as its license processor 214) of the SDSi semiconductor device 9905B to cause the SDSi semiconductor device 9905A to deactivate its SDSi license(s). In response to the deactivate license message 10130, the SDSi asset agent circuitry W140A (e.g., such as its license processor 214) of the SDSi semiconductor device 9905A performs an example deactivate feature operation 10135 to deactivate the SDSi feature(s) corresponding to the deactivated SDSi license(s) on the SDSi semiconductor device 9905B.

In some examples, after the activate feature operation 10125 completes activation of the newly licensed SDSi feature(s) on the SDSi semiconductor device 9905B, the SDSi asset agent circuitry W140B (e.g., such as its license processor 214) of the SDSi semiconductor device 9905B sends an example confirm license installation message 10140 to the delegated authority agent 9960A to confirm SDSi license installation and corresponding feature activation was successful. Additionally or alternatively, in some examples, after the deactivate feature operation 10135 completes deactivation of the appropriate SDSi feature(s) on the SDSi semiconductor device 9905A, the SDSi asset agent circuitry W140A (e.g., such as its license processor 214) of the SDSi semiconductor device 9905A sends an example confirm license deactivation message 10145 to the delegated authority agent 9960A to confirm SDSi license deactivation and corresponding feature deactivation was successful. In some example implementations of the push-based license transfer operation 10100, the messages sent between the delegated authority agent 9960A and the SDSi semiconductor devices 9905A-B are digitally signed and/or otherwise attested to be trustworthy.

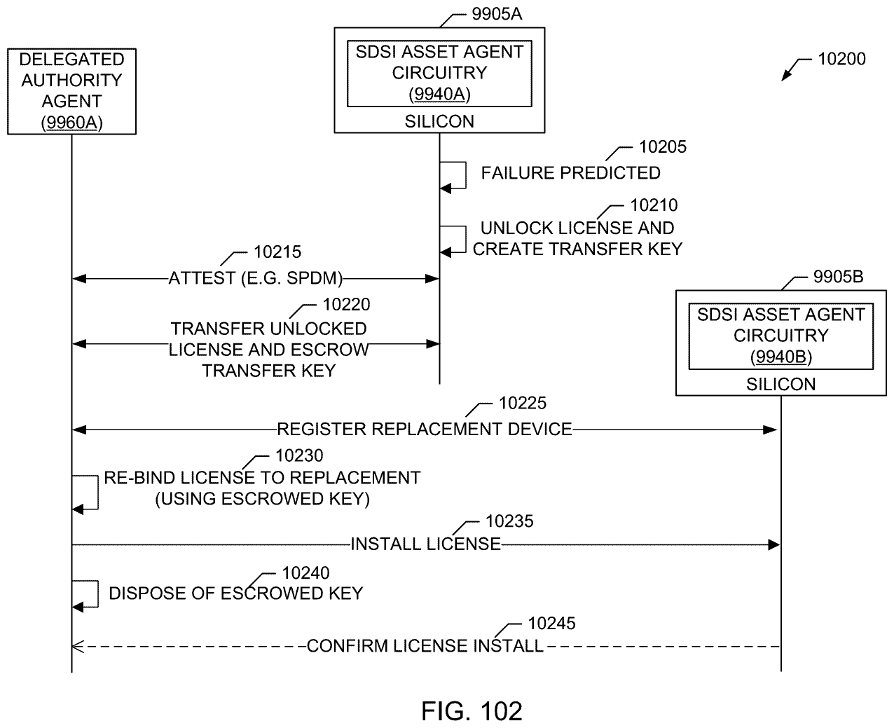

FIG. 102 depicts a ladder diagram illustrating another example license transfer operation 10200 implemented in accordance with teachings of this disclosure. The example license transfer operation 10200 assumes that the delegated authority agent(s) 9960A-C are given transient authority to transfer SDSi licenses by the SDSi asset agent circuitry 9940A-C of the SDSi semiconductor devices 9905A-C. For example, the example license transfer operation 10200 begins with the delegated authority agent 9960A as a low trust entity that is not capable of issuing new SDSi licenses. Also, the SDSi semiconductor device 9905A is assumed to have activates SDSi feature(s) corresponding to activated SDSi license(s).

Next, at some time during the operating lifecycle of the SDSi semiconductor device 9905A, the SDSi asset agent circuitry W140A (e.g., such as its license processor 214) of the SDSi semiconductor device 9905A decides, based on one or more trigger conditions, to grant the delegated authority agent 9960A temporary authority to re-assign the SDSi license(s) of the SDSi semiconductor device 9905A to another SDSi semiconductor device, such as SDSi semiconductor device 9905B, or to return them to the silicon manufacturer for credit. An example of such a trigger condition is illustrated in FIG. W4 in which the SDSi asset agent circuitry W140A (e.g., such as its license processor 214) of the SDSi semiconductor device 9905A performs an example failure prediction operation 10205 to predict a failure condition associated with the SDSi semiconductor device 9905A (e.g., using one or more of the failure detection techniques disclosed herein). In some examples, the failure prediction operation 10205 evaluates telemetry collected for the SDSi semiconductor device 9905A against one more reliability thresholds to detect an impending failure of the SDSi semiconductor device 9905A or one or more of its subcomponents. In some examples, the SDSi asset agent circuitry W140A of the SDSi semiconductor device 9905A performs the failure prediction operation 10205 autonomously and with little to no external intervention. However, in some examples, the failure prediction operation 10205 may also process external stimulus, such as data from the delegated authority agent 9960A and/or the orchestration circuitry 9950. In the illustrated example, when the failure prediction operation 10205 predicts a failure condition associated with the SDSi semiconductor device 9905A, the SDSi asset agent circuitry W140A (e.g., such as its license processor 214) of the SDSi semiconductor device 9905A decides to transfer its SDSi license(a) back to the appropriate granting authority and to grant the delegated authority agent 9960A temporary authority to re-assign those SDSi license(s)

To do this, the SDSi asset agent circuitry W140A (e.g., such as its license processor 214) of the SDSi semiconductor device 9905A performs an example unlock license operation 10210 to node unlock the SDSi license(s) assigned to the SDSi semiconductor device 9905A. For example, the SDSi asset agent circuitry W140A of the SDSi semiconductor device 9905A may node unlock its SDSi license(s) by signing the license(s) with a key, such as a private key, which can be used as proof of the intent of the SDSi semiconductor device 9905A to escrow its license(s) with the delegated authority agent 9960A for possible re-assignment (e.g., immediately or sometime later in the future) to another SDSi semiconductor device, such as the SDSi semiconductor device 9905B. Such a signature applied to the unlocked SDSi license(s) can also be used as proof of a return merchandise authorization claim, which can be used by the silicon manufacturer to trigger a credit to the customer.

In the illustrated example, as part of the unlock license operation 10210, the SDSi asset agent circuitry W140A (e.g., such as its license processor 214) of the SDSi semiconductor device 9905A also creates a new, temporary transfer key and associates it with the node-unlocked SDSi license(s). In some examples, the unlocked SDSi license(s) and the transfer key are signed by the SDSi asset agent circuitry W140A of the SDSi semiconductor device 9905A with a private key as proof of the intent of the SDSi semiconductor device 9905A to escrow its license(s) with the delegated authority agent 9960A for possible re-assignment (e.g., immediately or sometime later in the future) to another SDSi semiconductor device, such as the SDSi semiconductor device 9905B. In some such examples, possession by an agent, such as the delegated authority agent 9960A, of the signed transfer key is proof that the agent, such as the delegated authority agent 9960A, is authorized to re-assign the associated SDSi license(s).

In the illustrated example, the SDSi asset agent circuitry W140A (e.g., such as its license processor 214) of the SDSi semiconductor device 9905A also performs an example attestation operation 10215 to attest the delegated authority agent 9960A. In some examples, the SDSi asset agent circuitry W140A of the SDSi semiconductor device 9905A attests the delegated authority agent 9960A to permit the delegated authority agent 9960A to be trusted with temporary authority to re-assign its node-unlocked SDSi license(s) just once (or some other specified number of times) before authority is revoked (e.g., automatically) to prevent license cloning/duplication, etc. Then, the SDSi asset agent circuitry W140A (e.g., such as its license processor 214) of the SDSi semiconductor device 9905A performs an example unlocked license transfer operation 10220 to send (e.g., transfer) the signed node unlocked SDSi license(s) and the associated transfer key to the delegated authority agent 9960A to be stored (e.g., escrowed) for possible subsequent re-assignment. In this way, the example operations W410-10220 grant the delegated authority agent 9960A temporary authority over the unlocked SDSi license set, and the unlocked SDSi license(s) are transferred into its custody. In some examples, this event may be performed preemptively by the SDSi asset agent circuitry W140A of the SDSi semiconductor device 9905A and accompanied with handling instructions not to exercise the transfer rights as long as the SDSi semiconductor device 9905A is alive (e.g., operational). In some examples this event may be one of the final actions performed by the SDSi asset agent circuitry W140A of the SDSi semiconductor device 9905A before the impending failure of the device, and may be accompanied by the SDSi asset agent circuitry W140A performing an erasure of the SDSi semiconductor device's own copy of license(s).

In the illustrated example, sometime later (possibly shortly after the SDSi semiconductor device 9905A fails or long after the SDSi semiconductor device 9905A has failed), the replacement SDSi semiconductor device 9905B is advertised (e.g., identified) to the delegated authority agent 9960A via an example replacement device registration operation 10045. For example, any of the techniques for identifying replacement SDSi devices disclosed herein can be used to implement the replacement device registration operation 10045. Upon successfully attesting that the replacement SDSi semiconductor device 9905B is a replacement of the SDSi semiconductor device 9905A, the delegated authority agent 9960A performs an example license reassignment operation 10230 to exercise its temporary authority to transfer the unlocked SDSi license(s) escrowed from the SDSi semiconductor device 9905A. For example, in the license reassignment operation 10230, the delegated authority agent 9960A may embed an identifier (e.g., its protected processor inventory number or PPIN) of the replacement SDSi semiconductor device 9905B in the SDSi license(s) to be transferred, and sign the resulting SDSi license(s) (e.g., the resulting SDSi license data structure) with the escrowed transfer key associated with those license(s).

Next the delegated authority agent 9960A sends an example install license message 10235 including the re-assigned SDSi license(s) to the replacement SDSi semiconductor device 9905B. In response to the install license message 10235, the SDSi asset agent circuitry W140B (e.g., such as its license processor 214) of the SDSi semiconductor device 9905B installs the re-assigned SDSi license(s) and activates the associated SDSi features on the SDSi semiconductor device 9905B. In some examples, the SDSi asset agent circuitry W140B (e.g., such as its license processor 214) of the SDSi semiconductor device 9905B validates the re-assigned SDSi license(s) by verifying the signature applied to the SDSi license(s) with the transfer key (e.g., using a public version of the transfer key). Note that the SDSi asset agent circuitry W140B of the replacement SDSi semiconductor device 9905B allows installation of the new SDSi license not because of its own trust in the delegated authority agent 9960A, but rather due to the fact it trusts the decision by the SDSi semiconductor device 9905A that was the original owner of the license(s) to delegate part of the trust to the delegated authority agent 9960A.

In the illustrated example, after sending the re-assigned SDSi license(s) to the replacement SDSi semiconductor device 9905B, the delegated authority agent 9960A also performs an example key disposal operation 10240 to erase the escrowed transfer key to relinquish its control over the transfer of those SDSi licenses and, thus, is no longer a higher-trust entity associated with those licenses. In some examples, the SDSi asset agent circuitry W140B (e.g., such as its license processor 214) of the SDSi semiconductor device 9905B returns an example confirm license installation message 10245 to the delegated authority agent 9960A after successful installation of the re-assigned SDSi licenses.

In some examples, instead of using the transfer key described above, the SDSi asset agent circuitry W140A (e.g., such as its license processor 214) of the SDSi semiconductor device 9905A may grant the license transfer authority to the delegated authority agent 9960A by embedding a fingerprint (e.g., including attested measurements) of the SDSi semiconductor device 9905A in the unlocked SDSi license(s). In some such examples, the SDSi asset agent circuitry W140B (e.g., such as its license processor 214) of the replacement SDSi semiconductor device 9905B may attest the delegated authority agent 9960A and allow SDSi license transfer so long as the assigning entity (e.g., the delegated authority agent 9960A) is the same assigning entity (e.g., the delegated authority agent 9960A) that the SDSi semiconductor device 9905A originally trusted.

In some examples, instead of using a transfer key created the SDSi semiconductor device 9905A, as described above, the delegated authority agent 9960A may be provisioned by the silicon manufacturer with a universal transfer key or similar feature that delegates license transfer authority to the delegated authority agent 9960A.

In some examples, the role of the delegated authority agent 9960A in the example license transfer operation 10200 may be fulfilled by another SDSi semiconductor device in the system 9900, such as the SDSi asset agent circuitry W140C of the SDSi semiconductor device 9905C in the example system 9900.

While an example manner of implementing the system 9900 is illustrated in FIGS. 99-102, one or more of the elements, processes, and/or devices illustrated in FIGS. 99-102 may be combined, divided, re-arranged, omitted, eliminated, and/or implemented in any other way. Further, the example SDSi semiconductor devices 9905A-C, the example SDSi asset agent circuitry 9940A-C, the example orchestration circuitry 9950, the example delegated authority agent(s) 9960A-C, and/or, more generally, the example system 9900 of FIGS. 99-102, may be implemented by hardware alone or by hardware in combination with software and/or firmware. Thus, for example, any of the example SDSi semiconductor devices 9905A-C, the example SDSi asset agent circuitry 9940A-C, the example orchestration circuitry 9950, the example delegated authority agent(s) 9960A-C and/or, more generally, the example system 9900, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example system 9900 may include one or more elements, processes, and/or devices in addition to, or instead of, those illustrated in FIGS. 99-102, and/or may include more than one of any or all of the illustrated elements, processes and devices.

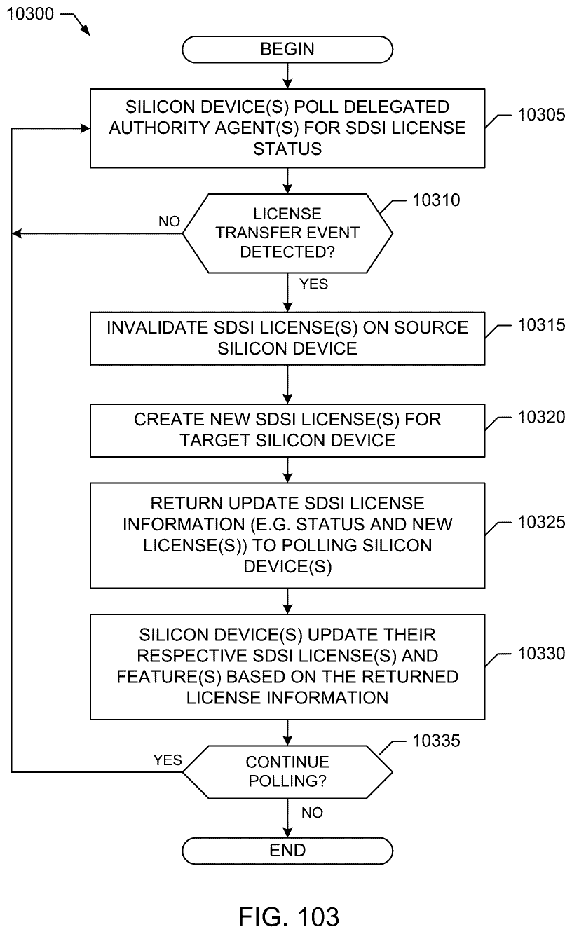

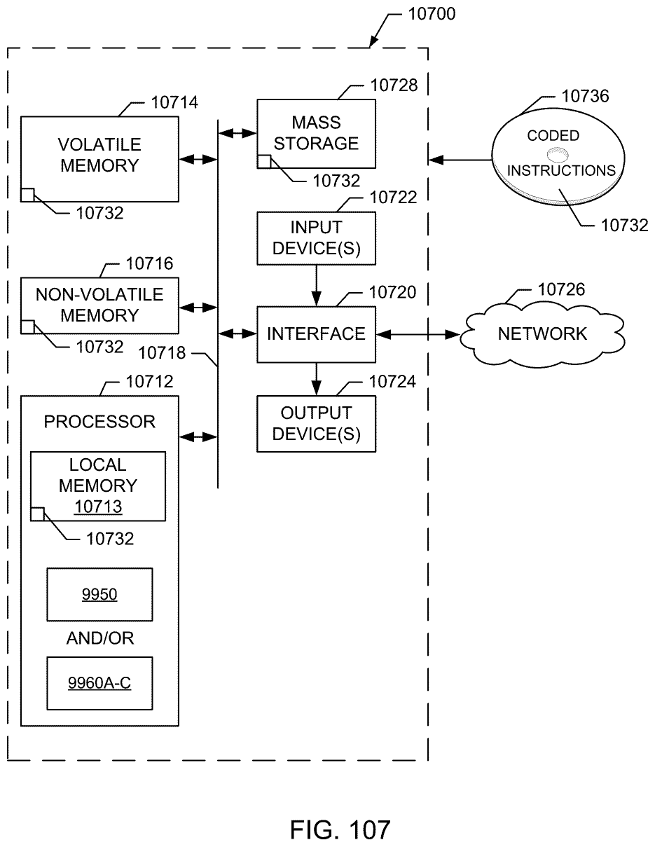

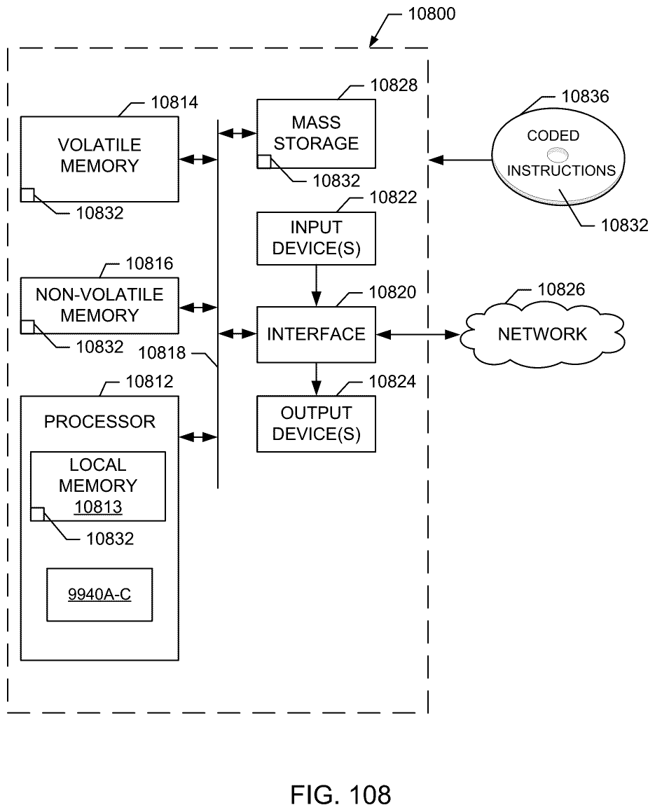

Flowcharts representative of example machine readable instructions which may be executed to configure processor circuitry to implement the example system 9900 are shown in FIGS. 103-106. The machine readable instructions may be one or more executable programs or portion(s) of an executable program for execution by processor circuitry, such as the processor circuitry 10712 and/or 10812 shown in the example processor platforms 10700 and/or 10800 discussed below in connection with FIG. 107 and FIG. 108 and/or the example processor circuitry discussed below in connection with FIGS. 150 and/or 151. The program(s) may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program(s) and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program(s) is(are) described with reference to the flowcharts illustrated in FIGS. 103-106, many other methods of implementing the example system 9900 may alternatively be used. For example, the order of execution of the blocks may be changed, and/or some of the blocks described may be changed, eliminated, combined and/or subdivided into multiple blocks. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 103-106 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc. Also, as used herein, the terms “computer readable” and “machine readable” are considered equivalent unless indicated otherwise.

FIGS. 103-106 are flowcharts representative of example implementations of different example techniques to transfer node locked SDSi licenses between SDSi-enabled products disclosed herein. In particular, FIG. 103 is a flowchart representative of example machine readable instructions and/or example operations 10300 that may be executed and/or instantiated by processor circuitry to implement the example polling-based license transfer operation 10000 disclosed above. For convenience, and without loss of generality, the machine readable instructions and/or operations 10300 of FIG. 103 are described in the context of the example system 9900 of FIG. 99 and, in particular, from the perspective of the SDSi semiconductor device 9905A being identified as a failing device in the system 9900 (e.g., using any failure detection technique disclosed herein), the SDSi semiconductor device 9905B being identified as a replacement device in the system 9900 (e.g., using any failure detection technique disclosed herein), and the delegated authority agent 9960A managing the SDSi license transfer. With reference to the preceding figures and associated written descriptions, the machine readable instructions and/or the operations 10300 of FIG. 103 begin at block 10305 at which the SDSi semiconductor devices 9905A-C (e.g., via their respective the SDSi asset agent circuitry 9940A-C, such as their respective license processors 214) poll the delegated authority agent 9960A for SDSi license information, such as SDSi license(s), SDSi license status, etc., as described above.

At block 10310, the delegated authority agent 9960A determines whether a license transfer event associated with one of the SDSi semiconductor devices 9905A-C. For example, the license transfer event may correspond to receipt of the example failure detection message 10025, which may be from the orchestration circuitry 9950 and/or another agent that detects a failure condition (e.g., an actual or predicted failure of the semiconductor device or one or more of its subcomponents) associated with one of the SDSi semiconductor devices 9905A-C (e.g., using one or more of the failure detection techniques disclosed herein). In some examples, the delegated authority agent 9960A may implement one or more of the failure detection techniques disclosed herein to detect a failure condition associated with one of the SDSi semiconductor devices 9905A-C.

If a failure condition is not detected (corresponding to the “NO” output from block 10310), processing returns to block 10305 at which the SDSi semiconductor devices 9905A-C continue polling the delegated authority agent 9960A for SDSi license information. However, if a failure detection is detected (corresponding to the “YES” output from block 10310), processing proceeds to block 10315. Assuming the detected failure condition is associated with the SDSi semiconductor device 9905A, at block 10315 the delegated authority agent 9960A invalidates the SDSi license(s) assigned to the failing SDSi semiconductor device 9905A, as described above. In the illustrated example, the failing SDSi semiconductor device 9905A is also referred to as the source SDSi semiconductor device 9905 because it is the source of the SDSi license(s) to be transferred. Furthermore, assume that the SDSi semiconductor device 9905B is identified as the replacement for the failing SDSi semiconductor device 9905A (e.g., as signaled in the example failure detection message 10025 or otherwise identified by one or more of the replacement device identification techniques disclosed herein.) At block 10320, the delegated authority agent 9960A creates new SDSi license(s) for the replacement SDSi semiconductor device 9905B that copy the SDSi feature configuration of the failing, or source, SDSi semiconductor device 9905A, as described above. In the illustrated example, the replacement SDSi semiconductor device 9905B is also referred to as the target SDSi semiconductor device 990B because it is the target of the SDSi license(s) to be transferred.

At block 10325, the delegated authority agent 9960A returns updated SDSi license information, as described above, to the source and target SDSi semiconductor devices 9905A-B in response subsequent polls by the source and target SDSi semiconductor devices 9905A-B after the processing at block 10315 and 10320 has completed. In the illustrated example, the updated SDSi license information returned by the delegated authority agent 9960A at block 10325 includes status information informing the source SDSi semiconductor device 9905A that its SDSi license(s) have been invalidated, as described above. In the illustrated example, the updated SDSi license information returned by the delegated authority agent 9960A at block 10325 also includes status information informing the target SDSi semiconductor device 9905B that new SDSi license(s) have been assigned to it, as well as the new SDSi license(s) themselves, as described above.

At block 10330, the source and target SDSi semiconductor devices 9905A-B (e.g., via their respective the SDSi asset agent circuitry 9940A-B, such as their respective license processors 214) update their respective SDSi license(s) and corresponding SDSi feature(s) based on the updated SDSi license information received at block 10325. For example, at block 10330, the source SDSi semiconductor device 9905A (e.g., via its SDSi asset agent circuitry 9940A, such as its license processor 214) invalidates its previously assigned SDSi license(s) and deactivates the SDSi feature(s) corresponding to the deactivated SDSi license(s), as described above. Also, in the illustrated example, at block 10330 the target SDSi semiconductor device 9905B (e.g., via its SDSi asset agent circuitry 9940B, such as its license processor 214) installs its new SDSi license(s) and activates the SDSi feature(s) corresponding to the newly installed SDSi license(s), as described above.

At block 10335, the SDSi semiconductor devices 9905A-C and/or the delegated authority agent 9960A determine whether SDSi information polling is to continue. If polling is to continue (corresponding to the “YES” output from block 10335), then processing returns to block 10305 at which the SDSi semiconductor devices 9905A-C continue polling the delegated authority agent 9960A for SDSi license information. However, if polling is to end (corresponding to the “NO” output from block 10335), then the machine readable instructions and/or operations 10300 end.

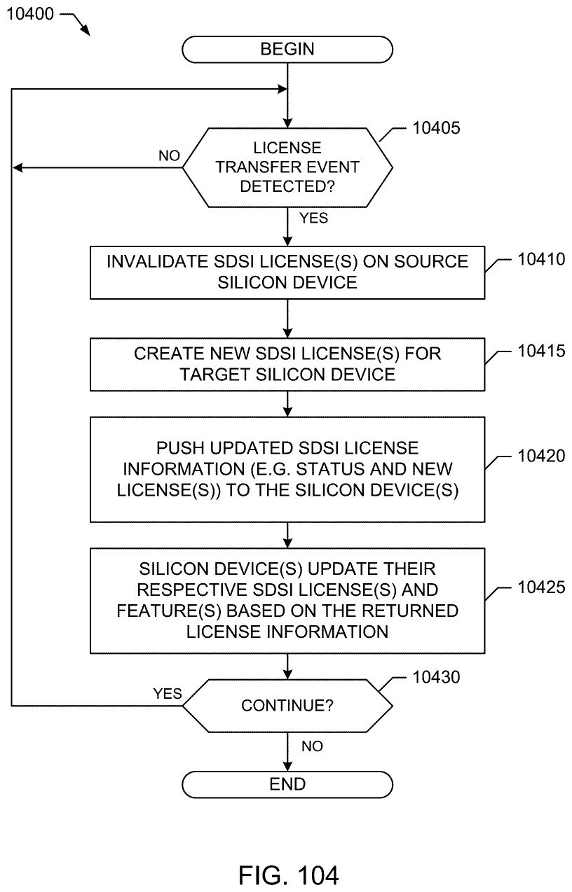

FIG. 104 is a flowchart representative of example machine readable instructions and/or example operations 10400 that may be executed and/or instantiated by processor circuitry to implement the example push-based license transfer operation 10100 disclosed above. For convenience, and without loss of generality, the machine readable instructions and/or operations 10400 of FIG. 104 are described in the context of the example system 9900 of FIG. 99 and, in particular, from the perspective of the SDSi semiconductor device 9905A being identified as a failing device in the system 9900 (e.g., using any failure detection technique disclosed herein), the SDSi semiconductor device 9905B being identified as a replacement device in the system 9900 (e.g., using any failure detection technique disclosed herein), and the delegated authority agent 9960A managing the SDSi license transfer. With reference to the preceding figures and associated written descriptions, the machine readable instructions and/or the operations 10400 of FIG. 104 begin at block 10405 at which the delegated authority agent 9960A determines whether a license transfer event associated with one of the SDSi semiconductor devices 9905A-C in the system 9900. For example, the license transfer event may correspond to receipt of the example failure detection message 10105, which may be from the orchestration circuitry 9950 and/or another agent that detects a failure condition (e.g., an actual or predicted failure of the semiconductor device or one or more of its subcomponents) associated with one of the SDSi semiconductor devices 9905A-C (e.g., using one or more of the failure detection techniques disclosed herein). In some examples, the delegated authority agent 9960A may implement one or more of the failure detection techniques disclosed herein to detect a failure condition associated with one of the SDSi semiconductor devices 9905A-C.

If a failure condition is not detected (corresponding to the “NO” output from block 10405), processing returns to block 10405 at which the delegated authority agent 9960A waits for a license transfer event. However, if a failure detection is detected (corresponding to the “YES” output from block 10405), processing proceeds to block 10410. Assuming the detected failure condition is associated with the SDSi semiconductor device 9905A, at block 10410 the delegated authority agent 9960A invalidates the SDSi license(s) assigned to the failing SDSi semiconductor device 9905A, as described above. In the illustrated example, the failing SDSi semiconductor device 9905A is also referred to as the source SDSi semiconductor device 9905 because it is the source of the SDSi license(s) to be transferred. Furthermore, assume that the SDSi semiconductor device 9905B is identified as the replacement for the failing SDSi semiconductor device 9905A (e.g., as signaled in the example failure detection message 10105 or otherwise identified by one or more of the replacement device identification techniques disclosed herein.) At block 10415, the delegated authority agent 9960A creates new SDSi license(s) for the replacement SDSi semiconductor device 9905B that copy the SDSi feature configuration of the failing, or source, SDSi semiconductor device 9905A, as described above. In the illustrated example, the replacement SDSi semiconductor device 9905B is also referred to as the target SDSi semiconductor device 990B because it is the target of the SDSi license(s) to be transferred.

At block 10420, the delegated authority agent 9960A pushes updated SDSi license information, as described above, to the source and target SDSi semiconductor devices 9905A-B after the processing at block 10410 and 10415 has completed. In the illustrated example, the updated SDSi license information pushed by the delegated authority agent 9960A at block 10420 includes status information informing the source SDSi semiconductor device 9905A that its SDSi license(s) have been invalidated, as described above. In the illustrated example, the updated SDSi license information pushed by the delegated authority agent 9960A at block 10420 also includes status information informing the target SDSi semiconductor device 9905B that new SDSi license(s) have been assigned to it, as well as the new SDSi license(s) themselves, as described above.

At block 10425, the source and target SDSi semiconductor devices 9905A-B (e.g., via their respective the SDSi asset agent circuitry 9940A-B, such as their respective license processors 214) update their respective SDSi license(s) and corresponding SDSi feature(s) based on the updated SDSi license information received at block 10420. For example, at block 10425, the source SDSi semiconductor device 9905A (e.g., via its SDSi asset agent circuitry 9940A, such as its license processor 214) invalidates its previously assigned SDSi license(s) and deactivates the SDSi feature(s) corresponding to the deactivated SDSi license(s), as described above. Also, in the illustrated example, at block 10425 the target SDSi semiconductor device 9905B (e.g., via its SDSi asset agent circuitry 9940B, such as its license processor 214) installs its new SDSi license(s) and activates the SDSi feature(s) corresponding to the newly installed SDSi license(s), as described above.

At block 10430, the SDSi semiconductor devices 9905A-C and/or the delegated authority agent 9960A determine whether SDSi information push-based license transfer processing is to continue. If processing is to continue (corresponding to the “YES” output from block 10430), then processing returns to block 10405 at which the delegated authority agent 9960A waits for a license transfer event. However, if processing is to end (corresponding to the “NO” output from block 10430), then the machine readable instructions and/or operations 10400 end.

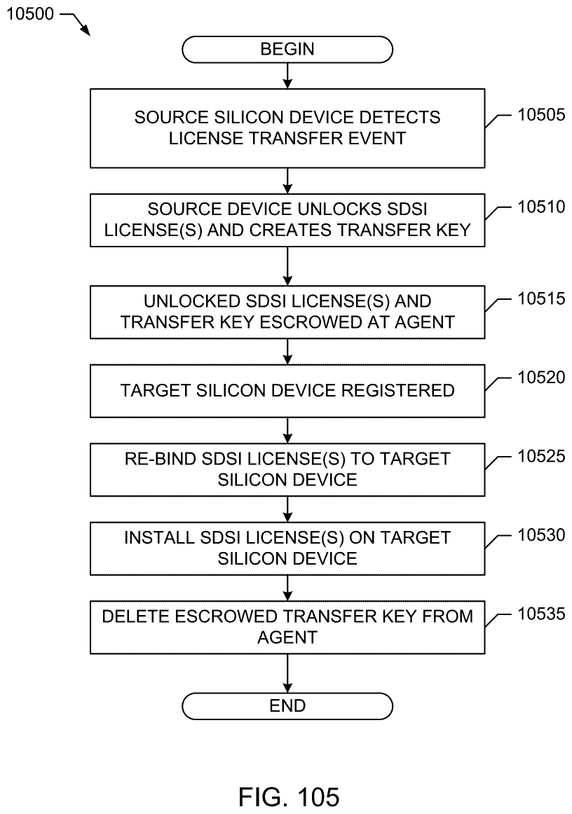

FIG. 105 is a flowchart representative of example machine readable instructions and/or example operations 10500 that may be executed and/or instantiated by processor circuitry to implement the example license transfer operation 10200 disclosed above. For convenience, and without loss of generality, the machine readable instructions and/or operations 10500 of FIG. 105 are described in the context of the example system 9900 of FIG. 99 and, in particular, from the perspective of the SDSi semiconductor device 9905A being a source device that is to transfer its node-locked SDSi licenses in the system 9900, the SDSi semiconductor device 9905B being a target device in the system 9900 that is to receive the SDSi license(s) to be transferred by the source SDSi semiconductor device 9905A, and the delegated authority agent 9960A being involved in the SDSi license transfer. With reference to the preceding figures and associated written descriptions, the machine readable instructions and/or the operations 10500 of FIG. 105 begin at block 10505 at which the SDSi semiconductor device 9905A (e.g., via its SDSi asset agent circuitry 9940A, such as its license processor 214) detects, based on one or more trigger conditions, a license transfer event and decides to grant the delegated authority agent 9960A temporary authority to re-assign the SDSi license(s) of the SDSi semiconductor device 9905A, as described above. At block 10510, the SDSi semiconductor device 9905A (e.g., via its SDSi asset agent circuitry 9940A, such as its license processor 214) unlocks its node locked SDSi license(s) by, for example, signing the SDSi license(s) with a private key associated with the SDSi semiconductor device 9905A, as described above. At block 10510, the SDSi semiconductor device 9905A (e.g., via its SDSi asset agent circuitry 9940A, such as its license processor 214) also creates a new, temporary transfer key and associates the transfer key with its node-unlocked SDSi license(s). At block 10515, the SDSi semiconductor device 9905A (e.g., via its SDSi asset agent circuitry 9940A, such as its license processor 214) causes the unlocked SDSi license(s) and associated transfer key to be escrowed at the delegated authority agent 9960A, as described above.

At block 10520, the delegated authority agent 9960 registers the SDSi semiconductor device 9905B as the target device to which the escrowed SDSi license(s) from the SDSi semiconductor device 9905A is(are) to be transferred, as described above. At block 10525, the delegated authority agent 9960A re-binds the escrowed SDSi license(s) to the target SDSi semiconductor device 9905B by, for example, embedding an identifier (e.g., its protected processor inventor number or PPIN) of the target SDSi semiconductor device 9905B in the escrowed SDSi license(s) to be transferred, and signing the resulting SDSi license(s) with the escrowed transfer key associated with those license(s), as described above. At block 10530, the delegated authority agent 9960A provides the re-assigned SDSi license(s) prepared at block 10525 to the target SDSi semiconductor device 9905B, and the target SDSi semiconductor device 9905B (e.g., via its SDSi asset agent circuitry 9940A, such as its license processor 214) installs the re-assigned SDSi license(s) and activates the associated SDSi features on the SDSi semiconductor device 9905B, as described above. At block 1015, the delegated authority agent 9960A deletes the escrowed transfer key to relinquish its control over transfer of those previously escrowed SDSi licenses, as described above. The machine readable instructions and/or operations 10500 then end.

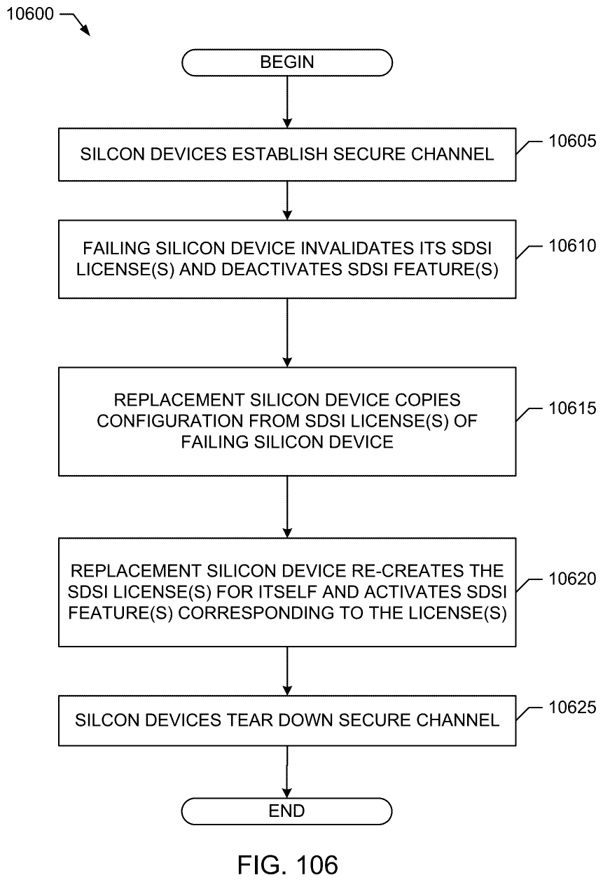

FIG. 106 is a flowchart representative of example machine readable instructions and/or example operations 10600 that may be executed and/or instantiated by processor circuitry to implement another example SDSi license transfer operation disclosed herein, which is based on a secure communication channel being established between the SDSi semiconductor devices involved in the license transfer. For convenience, and without loss of generality, the machine readable instructions and/or operations 10600 of FIG. 106 are described in the context of the example system 9900 of FIG. 99 and, in particular, from the perspective of the SDSi semiconductor device 9905A being a failing SDSi semiconductor device 9905A that is to transfer its node-locked SDSi licenses the SDSi semiconductor device 9905B as a replacement SDSi semiconductor device 9905B. With reference to the preceding figures and associated written descriptions, the machine readable instructions and/or the operations 10600 of FIG. 106 begin at block 10605 at which the failing SDSi semiconductor device 9905A and the replacement SDSi semiconductor device 9905B (e.g., via their respective SDSi asset agent circuitry 9940A-B) establish a secure communication channel. For example, the secure communication channel can be implemented using a secure communication protocol such as SPDM or any other secure protocol. In some examples, as part of setting up the secure channel, at block 10605 the failing SDSi semiconductor device 9905A and the replacement SDSi semiconductor device 9905B will attest each other. Thus, after the processing at block 10605 completes, the secure channel is established, the failing SDSi semiconductor device 9905A and the replacement SDSi semiconductor device 9905B trust each other, and the messages exchanged between them are integrity protected. In some examples, the messages exchanged between the failing SDSi semiconductor device 9905A and the replacement SDSi semiconductor device 9905B may also be encrypted for confidentiality. In some examples, additional software and/or hardware agents, such as a data center orchestrator, may be involved in the process, but those agents need not be trusted. For example, such additional agents may only provide communication and synchronization services. In the illustrated example, the SDSi semiconductor devices 9905A-B (e.g., and, more particularly, their SDSi asset agent circuitry 9940A-B) are considered to be within the trust boundary in which the secure channel is established and license transfer operations are performed. Because of that, in some examples, after the secure channel is established at block 10606, no involvement by the delegated authority agent(s) 9960A-C is needed.

At block 10610, the failing SDSi semiconductor device 9905A (e.g., via its SDSi asset agent circuitry 9940A, such as its license processor 214) invalidates its SDSi license(s) and deactivate(s) the SDSi feature(s) corresponding to the deactivated license(s). At block 10615, the replacement SDSi semiconductor device 9905B (e.g., via its SDSi asset agent circuitry 9940B, such as its license processor 214) asks, via the secure channel, the failing SDSi semiconductor device 9905A (e.g., via its SDSi asset agent circuitry 9940A, such as its license processor 214) for a copy of the configuration of its SDSi license(s) Once replacement SDSi semiconductor device 9905B receives the SDSi configuration of the failing SDSi semiconductor device 9905A via the secure channel, at block 10620, the replacement SDSi semiconductor device 9905B (e.g., via its SDSi asset agent circuitry 9940B, such as its license processor 214) re-creates, using any of the techniques disclosed herein, new SDSi license(s) for itself using the copied configuration, and activates the SDSi feature(s) in the replacement SDSi semiconductor device 9905B corresponding to the new SDSi license(s). At block 10625, the secure channel between the failing SDSi semiconductor device 9905A and the replacement SDSi semiconductor device 9905B is torn down. The machine readable instructions and/or operations 10600 then end.

FIG. 107 is a block diagram of an example processor platform 10700 structured to execute and/or instantiate the machine readable instructions and/or the operations of FIGS. 103, 104, 105 and/or 106 to implement the example orchestrator 9950 and/or one or more of the example distributed agents 9960A-C in the example system 9900 of FIG. 99. The processor platform 10700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 10700 of the illustrated example includes processor circuitry 10712. The processor circuitry 10712 of the illustrated example is hardware. For example, the processor circuitry 10712 can be implemented by one or more integrated circuits, logic circuits, FPGAs, microprocessors, CPUs, GPUs, DSPs, and/or microcontrollers from any desired family or manufacturer. The processor circuitry 10712 may be implemented by one or more semiconductor based (e.g., silicon based) devices. In this example, the processor circuitry 10712 implements the example orchestration circuitry 9950 and/or one or more of the example delegated authority agent(s) 9960A-C

The processor circuitry 10712 of the illustrated example includes a local memory 10713 (e.g., a cache, registers, etc.). The processor circuitry 10712 of the illustrated example is in communication with a main memory including a volatile memory 10714 and a non-volatile memory 10716 by a bus 10718. The volatile memory 10714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 10716 may be implemented by flash memory and/or any other desired type of memory device. Access to the main memory 10714, 10716 of the illustrated example is controlled by a memory controller 10717.

The processor platform 10700 of the illustrated example also includes interface circuitry 10720. The interface circuitry 10720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 10722 are connected to the interface circuitry 10720. The input device(s) 10722 permit(s) a user to enter data and/or commands into the processor circuitry 10712. The input device(s) 10722 can be implemented by, for example, an audio sensor, a microphone, a camera (still or video), a keyboard, a button, a mouse, a touchscreen, a track-pad, a trackball, a trackbar, an isopoint device, a voice recognition system and/or any other human-machine interface. In some examples, the input device(s) 10722 are arranged or otherwise configured to allow the user to control the processor platform 10700 and provide data to the processor platform 10700 using physical gestures, such as, but not limited to, hand or body movements, facial expressions, face recognition, etc.

One or more output devices 10724 are also connected to the interface circuitry 10720 of the illustrated example. The output device(s) 10724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 10720 of the illustrated example, thus, typically includes a graphics driver card, a graphics driver chip, and/or graphics processor circuitry such as a GPU.

The interface circuitry 10720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 10726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 10700 of the illustrated example also includes one or more mass storage devices 10728 to store software and/or data. Examples of such mass storage devices 10728 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 10732, which may be implemented by the machine readable instructions of FIGS. 103-106, may be stored in the mass storage device 10728, in the volatile memory 10714, in the non-volatile memory 10716, and/or on a removable non-transitory computer readable storage medium such as a CD or DVD.

FIG. 108 is a block diagram of an example processor platform 10800 structured to execute and/or instantiate the machine readable instructions and/or the operations of FIGS. 103, 104, 105 and/or 106 to implement one or more of the example SDSi semiconductor devices 9905A-C in the example system 9900 of FIG. 99. The processor platform 10800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 10800 of the illustrated example includes processor circuitry 10812. The processor circuitry 10812 of the illustrated example is hardware. For example, the processor circuitry 10812 can be implemented by one or more integrated circuits, logic circuits, FPGAs, microprocessors, CPUs, GPUs, DSPs, and/or microcontrollers from any desired family or manufacturer. The processor circuitry 10812 may be implemented by one or more semiconductor based (e.g., silicon based) devices. In this example, the processor circuitry 10812 implements one or more of the example SDSi asset agent circuitry 9940A-C for the respective one or more of the SDSi semiconductor devices 9905A-C implemented by the processor platform 10800.

The processor circuitry 10812 of the illustrated example includes a local memory 10813 (e.g., a cache, registers, etc.). The processor circuitry 10812 of the illustrated example is in communication with a main memory including a volatile memory 10814 and a non-volatile memory 10816 by a bus 10818. The volatile memory 10814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 10816 may be implemented by flash memory and/or any other desired type of memory device. Access to the main memory 10814, 10816 of the illustrated example is controlled by a memory controller 10817.

The processor platform 10800 of the illustrated example also includes interface circuitry 10820. The interface circuitry 10820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 10822 are connected to the interface circuitry 10820. The input device(s) 10822 permit(s) a user to enter data and/or commands into the processor circuitry 10812. The input device(s) 10822 can be implemented by, for example, an audio sensor, a microphone, a camera (still or video), a keyboard, a button, a mouse, a touchscreen, a track-pad, a trackball, a trackbar, an isopoint device, a voice recognition system and/or any other human-machine interface. In some examples, the input device(s) 10822 are arranged or otherwise configured to allow the user to control the processor platform 10800 and provide data to the processor platform 10800 using physical gestures, such as, but not limited to, hand or body movements, facial expressions, face recognition, etc.

One or more output devices 10824 are also connected to the interface circuitry 10820 of the illustrated example. The output device(s) 10824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 10820 of the illustrated example, thus, typically includes a graphics driver card, a graphics driver chip, and/or graphics processor circuitry such as a GPU.

The interface circuitry 10820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 10826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 10800 of the illustrated example also includes one or more mass storage devices 10828 to store software and/or data. Examples of such mass storage devices 10828 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 10832, which may be implemented by the machine readable instructions of FIGS. 103, 104, 105 and/or 106, may be stored in the mass storage device 10828, in the volatile memory 10814, in the non-volatile memory 10816, and/or on a removable non-transitory computer readable storage medium such as a CD or DVD.

Transfer of Software Defined Silicon Licenses without a Trusted License Server

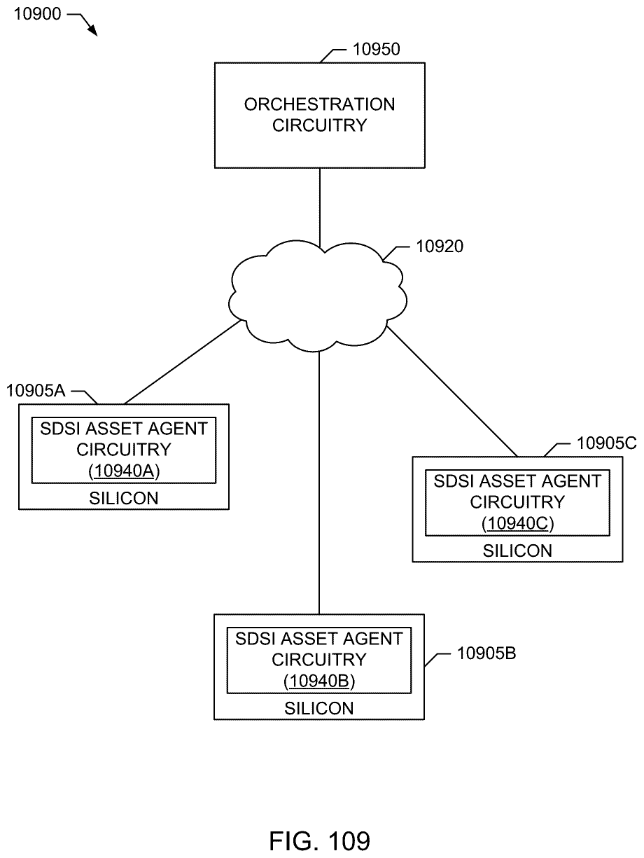

Turning to the figures, FIG. 109 illustrates a block diagram of an example system 10900 that implements the transfer of SDSi licenses among SDSi-enabled products, such as the SDSi semiconductor device 105 described above, without the use of a trusted license server. The example system 10900 of FIG. 109 includes multiple example SDSi semiconductor devices 10905A-C that, as described above, may correspond to any type of silicon products, such as, but not limited to, computer processors, CPUs, IPUs, XPUs, semiconductor chips, silicon hardware devices, etc., as well as circuit boards and/or systems employing such silicon products, etc. In the illustrated example, the SDSi semiconductor devices 10905A-C implement respective SDSi features as described above in connection with the SDSi semiconductor devices 105. As such, each one of the SDSi semiconductor devices 10905A-C includes respective example SDSi asset agent circuitry 10940A-C, which implement an SDSi asset agent such as the SDSi agent 140 described above. The SDSi asset agent circuitry 10940A-C also implement license transfer features, as described in further detail below, for respective ones of the SDSi semiconductor devices 10905A-C. The example system 10900 of FIG. 109 also includes example orchestration circuitry 10950 to implement license transfer features, as described in further detail below. In the illustrated example of FIG. 109, the SDSi semiconductor devices 10905A-C and the orchestration circuitry 10950 are in communication with each other via one or more example networks 10920, such as the example network 120 described above.

In some examples, the system 10900 can correspond to a customer data center, customer manufacturing center, customer data processing site, etc. In some such examples, the SDSi semiconductor devices 10905A-C can be used to implement servers of the customer data center, and the orchestration circuitry 10950 can correspond to and/or be implemented by an orchestrator and/or other enterprise system associated with a customer utilizing the SDSi semiconductor devices 10905A-C. For example, the orchestration circuitry 10950 can be implemented by the example customer enterprise system 115, the example SDSi client agent 272 and/or the example entitlement management service 278 described above.

As such, the elements of the example system 10900 of FIG. 109 may be instantiated (e.g., creating an instance of, bring into being for any length of time, materialize, implement, etc.) by processor circuitry such as a central processing unit executing instructions. Additionally or alternatively, the elements of the example system 10900 of FIG. 109 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 109 may, thus, be instantiated at the same or different times. Some or all of the circuitry may be instantiated, for example, in one or more threads executing concurrently on hardware and/or in series on hardware. Moreover, in some examples, some or all of the circuitry of FIG. 109 may be implemented by microprocessor circuitry executing instructions to implement one or more virtual machines and/or containers. Also, although the example system 10900 of FIG. 109 is illustrated as including three SDSi semiconductor devices 10905A-C and one instance of orchestration circuitry 10950, the system 10900 can include any number of SDSi semiconductor devices 10905A-C and any number of instances of orchestration circuitry 10950.

As indicated above, the example system 10900 implements the transfer of SDSi licenses among the SDSi semiconductor devices 10905A-C without the use of a trusted license server. Silicon manufacturers are developing strategies that provide Silicon as a Service (SiaaS). SDSi technology as disclosed herein, which is also referred to as silicon soft stock keeping unit (SoftSKU) technology, can be used to implement SiaaS. SDSi technology allows for a data center owner, or other silicon customer, to purchase and then enable some features (e.g., additional CPU cores, etc.) in the silicon product (e.g., the SDSi semiconductor devices 10905A-C) which are disabled in the silicon by default. Because features to be enabled can have substantial monetary value, the SDSi feature activation process should be secure. In some examples, such security is achieved by cryptographically binding each license for feature activation to single silicon product (e.g., a single one of the SDSi semiconductor devices 10905A-C).

Although secure, such binding of an SDSi license to single silicon product (e.g., a single one of the SDSi semiconductor devices 10905A-C) can prevent the ability to transfer the license from one silicon product to another silicon product (e.g., from one of the SDSi semiconductor devices 10905A-C to a different one of the SDSi semiconductor devices 10905A-C) without a trusted license server. Also, SDSi licensing techniques that require a given SDSi license to be bound to a single silicon product may require the customer to provide unique identifiers of every silicon product (e.g., every one of the SDSi semiconductor devices 10905A-C) that is to have the ability to activate (e.g., upgrade) features via SDSi technology. However, customer may prefer that SDSi licenses be transferable such that SDSi licenses for different hardware features can be easily moved from one silicon product to another. Also, some customers may not want to provide the silicon manufacturer with the unique identifiers of all silicon products that the customer plans to upgrade using SDSi technology. Thus, SDSi licensing techniques that bind an SDSi license to a given silicon product's unique identifier may be difficult to adapt to a floating licensing model and may result in reduced SDSi licensing security, thereby introducing additional license server costs, etc., which ultimately may result in increased security risks and lower revenue for silicon manufacturers. As a result, data center owners and other silicon customers, as well as silicon manufacturers, may prefer a floating SDSi licensing model for feature activation that allows for a limited number of SDSi licenses for silicon features to be shared among a larger number of silicon products (e.g., the SDSi semiconductor devices 10905A-C).

Also, prior SDSi licensing solutions may rely on one or more trusted license server(s) to manage the licenses. In such an example licensing solution, a license server manages a pool of licenses. Entities (hardware or software) which need to acquire a license or transfer a license to another entity communicate with the license server to obtain the license, or to return and send the license to a new entity, respectively. In both scenarios, a unique product identifier (e.g., a silicon product identifier, such as a protected processor identification number, or PPIN, etc.) is provided so the license is bound to the specific silicon product (e.g., a specific one of the SDSi semiconductor devices 10905A-C).

In some such examples, the license server is located on the customer premises (e.g., the customer's data center, the customer's manufacturing site, etc.) In some examples, the licenser server is hosted by the silicon or software manufacturer. In either example, to secure the SDSi license exchange, the license server(s) may perform digital signing of issued licenses, which requires the license server to protect material cryptographically. To do this, the license server may use some form of trusted execution environment (TEE), and/or a hardware security module (HSM), to secure cryptographic keys and operations needed for signing licenses issued for requesting entities.

Also, if the license server is hosted on the customer premises, the deployment of such infrastructure can be complicated, and may increase costs for both the silicon manufacturer and the customer because TEEs and/or HSMs may need to be installed on customer premises. In addition, even with HSMs and/or TEEs at the customer premises, the license server may still not be fully secure. For example, because license signing may be managed by the software and done on the hardware (e.g., HSMs) of the license server in an environment controlled by the customer, tampering by entities outside the control of the silicon manufacturer may occur. A compromised license server could result in substantial financial loss. To reduce the likelihood of such losses, the silicon manufacturer may reserve a right to periodically audit the license server at the customer premises. However, such auditing may introduce other complications and additional costs for both the silicon manufacturer and the customer.

As another potential limitation, if the license server is hosted by the silicon manufacturer and the customer environment containing the silicon products (e.g., the SDSi semiconductor devices 10905A-C) to upgrade via SDSi technology does not have network connectivity to the silicon manufacturer, then transferring or even acquiring new SDSi licenses may not be possible. Also, if the license server is hosted by the silicon manufacturer and the customer environment does have network connectivity to the silicon manufacturer, then the licensing process may still depend on the quality of the network connectivity, which may be unstable and may introduce delays. In addition, this solution introduces significant performance requirements for the silicon manufacturer's hosting environment. For example, a license server hosted by the silicon manufacturer may need to handle numerous requests from many data centers and/or other customer sites, and may be required to maintain a high level service availability, which may be costly for the silicon manufacturer.

As yet another potential limitation of SDSi licensing solutions in which each license is bound to a single silicon product, such solutions may require that the customer provide unique silicon product identifiers (e.g., PPINs, etc.) at the time the licenses are requested. This may be cumbersome for customers especially if they must request multiple licenses directly from the silicon manufacturer over the Internet or other network.

Instead of deploying a semi-secure license server on customer premises or using a secure license server hosted by the silicon manufacturer, the example system 10900 of FIG. 109 implements a flexible SDSi licensing solution in which one or more, or all, of the SDSi semiconductor devices 10905A-C could act as a license server by itself or in combination. For example, initially, one of the SDSi semiconductor devices 10905A-C, such as the SDSi semiconductor device 10905A, could be provisioned with an SDSi license pool obtained from the silicon manufacturer and from that moment manage that license pool securely without connecting to the silicon manufacturer (e.g., without connectivity to the example silicon manufacturer enterprise system 110). In the example system 10900, the orchestration circuitry 10950 or other orchestrator or, more generally, a customer licensing agent, manages the SDSi license pool(s) at the customer premises (e.g., data center) by, for example, causing the SDSi license pool at the SDSi semiconductor device 10905A to be transferred to another one of the SDSi semiconductor devices 10905A-C, such as the SDSi semiconductor device 10905B, in whole or in part, and/or by causing license(s) in the pool maintained by the SDSi semiconductor device 10905A to be used to activate SDSi feature(s) of the SDSi semiconductor device 10905A itself, etc. In some examples, the SDSi semiconductor devices 10905A-C of the system 10900 include secure cryptographic key management and signing functionality to maintain security of the SDSi license pool(s) provisioned to them.

The flexible SDSi licensing solution implemented by the system 10900 eliminates the need for trusted license servers along with any special hardware, such as HSMs or computers with TEEs, etc., to be deployed on customer premises. The customer licensing agent, such as the orchestration circuitry 10950, used for managing licenses does not need to keep any secrets and therefore may be fully open source. Because of that, the customer licensing agent can be easily integrated into existing data center orchestrators, enterprise management systems, such as the example customer enterprise system 115. Moreover, the lack of secrets to be managed by the customer licensing agent, such as the orchestration circuitry 10950, removes the need for periodic audits done by semiconductor manufacturer.

In the example system 10900 of FIG. 109, there is also no need for network connectivity from the customer site back to the semiconductor manufacturer for license management, so there is no dependency on network connectivity, backend license server availability, etc., for customers to be able to acquire and/or transfer SDSi licenses. As such, flexible SDSi licensing as implemented by the system 10900 can reduce licensing-related infrastructure costs. However, the flexible SDSi licensing solution implemented by the system 10900 maintains high security level because the sensitive licensing operations are executed in the SDSi semiconductor devices 10905A-C, which are well protected.

The flexible SDSi licensing solution implemented by the system 10900 also eliminates the need to provide unique identifiers of all semiconductor products, such as the SDSi semiconductor devices 10905A-C, which are planned to be upgraded. In the system 10900, the customer can provide the semiconductor manufacturer with the unique identifier (ID), such as the PPIN, etc., of just the single one or the SDSi semiconductor devices 10905A-C, such as the SDSi semiconductor device 10905A, on which the SDSi license pool is to be stored initially, and the overall number of SDSi semiconductor devices 10905A-C planned to be upgraded via SDSi licenses. As such, the flexible SDSi licensing solution implemented by the system 10900 can substantially simplify logistics for the customer and reduce privacy concerns.

This flexible SDSi licensing solution implemented by the system 10900 is focused on transferring SDSi licenses for SDSi hardware/firmware features (e.g., such as the number of available cores, the available clock rates, memory, etc.), but the solution can be readily extended to be used with drivers, software applications, as well as hardware features which are not bound to the SDSi semiconductor devices 10905A-C but exist on a larger platform (e.g., servers, devices, etc.) implemented with the SDSi semiconductor devices 10905A-C. As such, the flexible licensing solutions disclosed herein could be used by other software and hardware vendors to manage licenses for other hardware, software, drivers, etc.

To implement flexible SDSi licensing in the example system 10900 of FIG. 109, the SDSi semiconductor devices 10905A-C and the orchestration circuitry 10950 cooperate to implement the following example features: license pool purchase, license pool installation, license acquisition and release, and license pool splitting and transfer. In the illustrated example of FIG. 109, the license pool purchase feature is implemented by the orchestration circuitry 10950 to purchase a pool of floating SDSi licenses, referred to as the SDSi license pool or simply the license pool, from the semiconductor manufacture via a network connection to, for example, the semiconductor manufacture enterprise system 110. Instead of providing unique semiconductor device identifiers (e.g., PPINs) of all the SDSi semiconductor devices 10905A-C which will be upgraded via SDSi technology, the customer in the system 10900 may provide a unique ID of just one device (e.g., the SDSi semiconductor device 10905A) and the number of licenses/devices which will be upgraded.

In the illustrated example of FIG. 109, the license pool installation feature is implemented by the orchestration circuitry 10950 and one or more of the SDSi semiconductor devices 10905A-C to install the SDSi license pool at the customer premises. In the system 10900, instead of installing the license pool on a dedicated license server with a TEE and/or an HSM (like in other licensing solutions), the SDSi license pool is installed directly in one of the SDSi semiconductor devices 10905A-C, such as the SDSi semiconductor device 10905A, thereby removing the need for an expensive, dedicated license server setup.

In the illustrated example of FIG. 109, the license acquisition and release feature is implemented by the orchestration circuitry 10950 and one or more of the SDSi semiconductor devices 10905A-C to acquire SDSi licenses for use and release SDSi licenses after use without network connectivity to the silicon manufacturer. In the system 10900, instead of acquiring and releasing licenses from a dedicated license server, such operations are done directly from the SDSi semiconductor device, such as the SDSi semiconductor device 10905A, which is in possession of the license pool. Activation and deactivation of SDSi features is also done directly on the SDSi semiconductor device, such as the SDSi semiconductor device 10905A, which is in the possession of appropriate SDSi license(s).

In the illustrated example of FIG. 109, the license pool splitting and transfer feature is implemented by the orchestration circuitry 10950 and one or more of the SDSi semiconductor devices 10905A-C to transfer a license pool, or portion thereof, from one of the SDSi semiconductor devices 10905A-C, such as the SDSi semiconductor device 10905A, to another of the SDSi semiconductor devices 10905A-C, such as the SDSi semiconductor device 10905B, in the system 10900. In the system 10900, instead of splitting license pools among multiple dedicated license servers, this can be done among the SDSi semiconductor devices 10905A-C themselves, so no trusted intermediary (e.g., dedicated license server) is required.

In some examples, to implement the flexible SDSi licensing solution in the example system 10900, the SDSi semiconductor devices 10905A-C (or, more specifically, the SDSi asset agent circuitry 10940A-C of the SDSi semiconductor devices 10905A-C, such as through their respective license processors 214) implement an example install license pool operation, an example acquire pool license operation, an example activate feature operation and an example deactivate feature operation, as disclosed in further detail below.

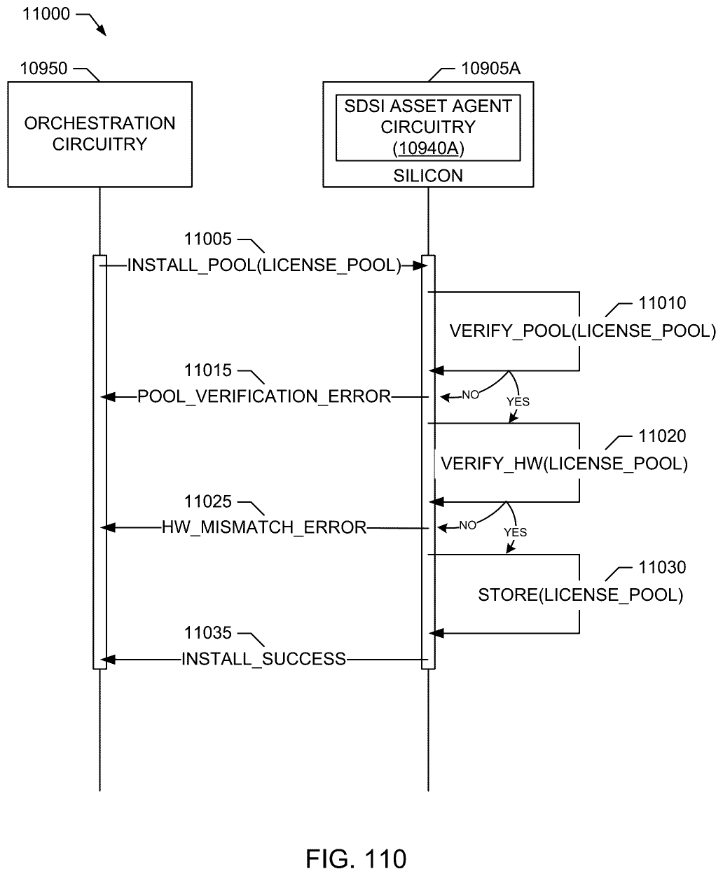

In some examples, the install license pool operation installs a new license pool on a target SDSi semiconductor device 10905A-C. In some examples, a target SDSi semiconductor device 10905A-C accepts a license pool only if the pool is bound to that particular SDSi semiconductor device 10905A-C. In some examples, the license pool may be obtained from the silicon manufacturer or another one of the SDSi semiconductor devices 10905A-C. In some examples, a target SDSi semiconductor device 10905A-C that is the subject of an install license pool operation verifies if the license pool is valid and stores it internally within the SDSi semiconductor device. If validation fails, then the install license pool operation fails. After the license pool is installed on a particular SDSi semiconductor device 10905A-C, then that SDSi semiconductor device may activate and use some features from the pool (e.g., via the activate feature operation described hereinbelow) and/or serve one or more licenses to other ones of the SDSi semiconductor devices 10905A-C (e.g., via the acquire pool operation described hereinbelow). In some examples, if the target SDSi semiconductor device 10905A-C already contains a license pool when a new pool is installed, then both license pools are combined (e.g., merged). An example implementation of the install license pool operation is illustrated in FIG. 110, which is described in further detail below.

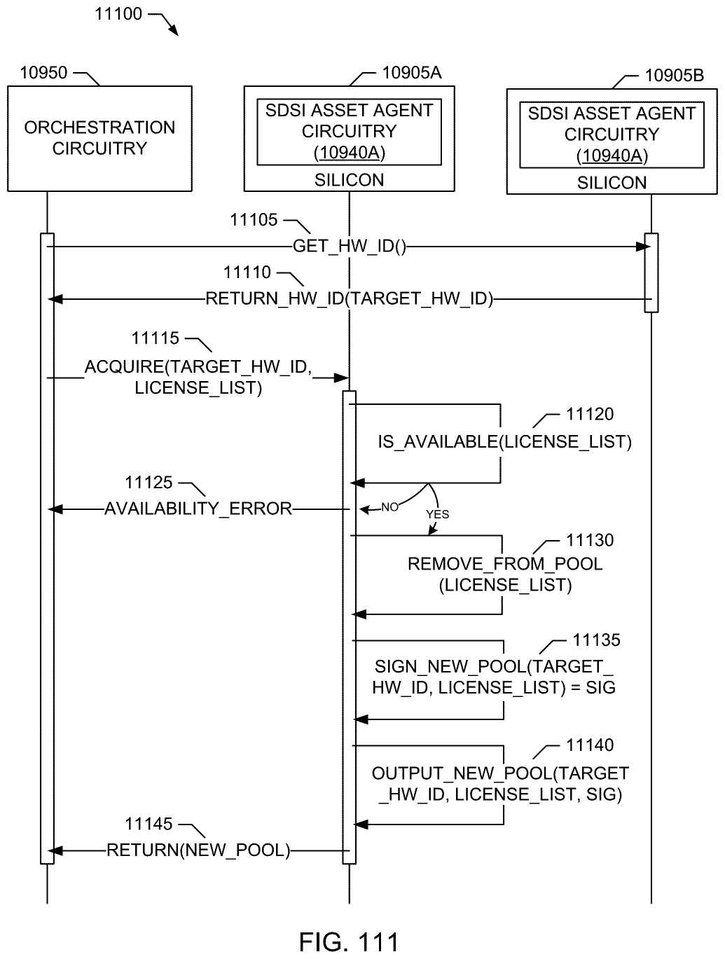

In some examples, the acquire license pool operation removes a requested license pool from a target SDSi semiconductor device 10905A-C and returns the license pool so it can be installed on another SDSi semiconductor device 10905A-C. In some examples, the returned license pool is bound to a particular destination SDSi semiconductor device 10905A-C to which the returned license pool is to be transferred. In some examples, if requested license pool does not exist (e.g., if there is not enough licenses in the pool for requested features), then the acquire license pool operation fails. The caller (e.g., the orchestration circuitry 10950) may request the entire license pool maintained by the target SDSi semiconductor device 10905A-C, which effectively removes the entire pool from that SDSi semiconductor device 10905A-C processor, or the caller (e.g., the orchestration circuitry 10950) may request some part of the pool, which effectively splits the license pool between the target SDSi semiconductor device 10905A-C and the destination SDSi semiconductor device 10905A-C. In the former scenario, the destination SDSi semiconductor device 10905A-C becomes the license server for the system 10900 while the target SDSi semiconductor device 10905A-C stops serving that role. In the latter scenario, both the target SDSi semiconductor device 10905A-C and the destination SDSi semiconductor device 10905A-C become license servers. In some example, such license pool splitting may be continued such that more than two of the SDSi semiconductor devices 10905A-C can act as license servers. An example implementation of the acquire license pool operation is illustrated in FIG. 111, which is described in further detail below.

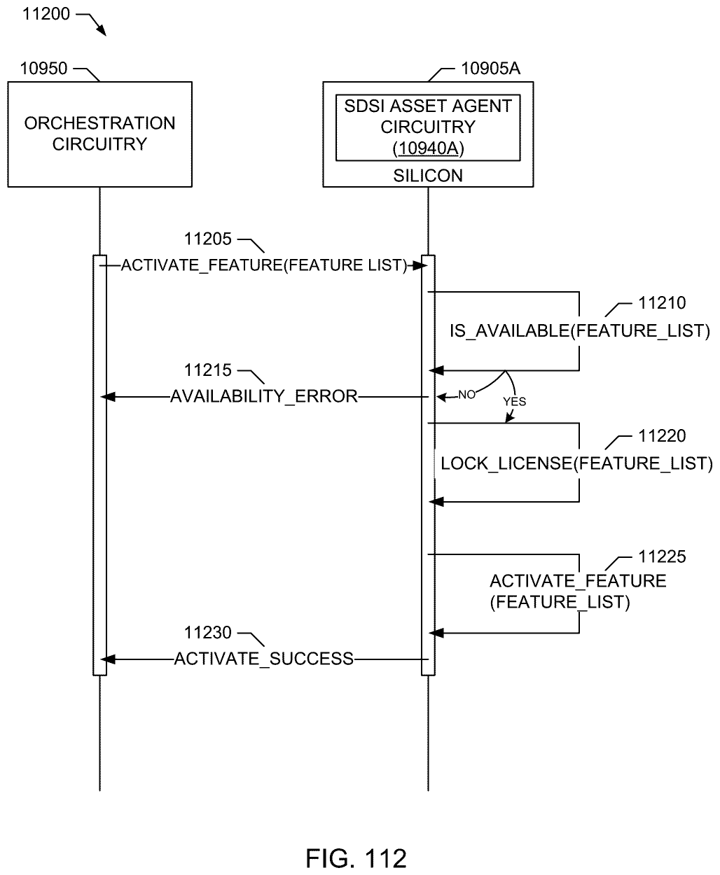

In some examples, the activate feature operation activates one or more SDSi features from the license pool that is available on the target SDSi semiconductor device 10905A-C the call was issued against. If there is no available license(s), then the activate feature operation fails. In some examples, the target SDSi semiconductor device 10905A-C locks the license(s) corresponding to the activated feature(s) so those license(s) cannot be returned by the acquire license pool operation until a deactivate feature operation is performed. An example implementation of the activate feature operation is illustrated in FIG. 112, which is described in further detail below.

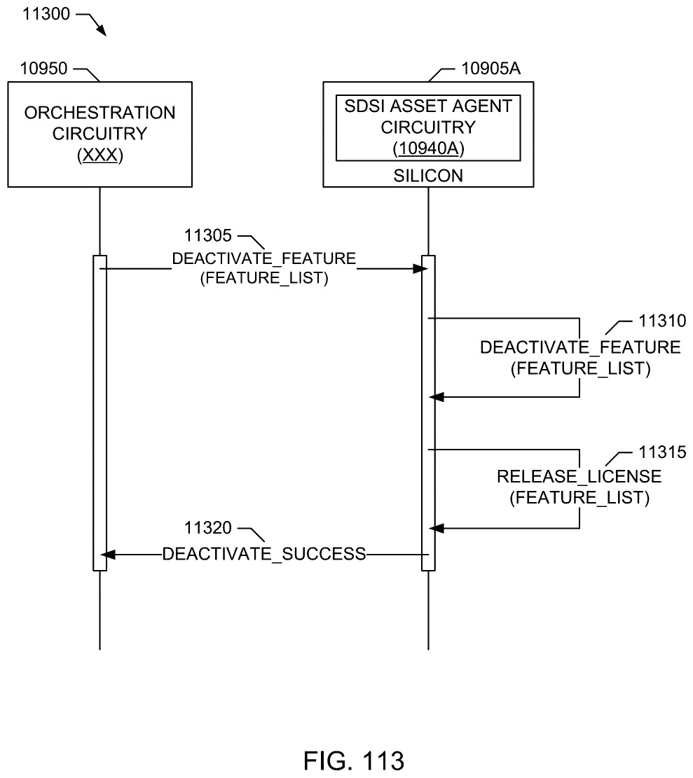

In some examples, the deactivate feature operation deactivates one or more SDSi features on the target SDSi semiconductor device 10905A-C the call was issued against. In some examples, the target SDSi semiconductor device 10905A-C releases the license(s) corresponding to the deactivated feature(s) and returns the released license(s) to the pool managed by that target SDSi semiconductor device 10905A-C. As such, the returned license(s) become available to be activated again via the activate feature operation, and/or can be requested for other SDSi semiconductor devices 10905A-C via the acquire license pool operation. An example implementation of the deactivate feature operation is illustrated in FIG. 113, which is described in further detail below.

In some examples, the license pool is digitally signed document that includes one or more of the following data fields: (i) a target device identifier data field that stores a hardware/device identifier of the silicon product (e.g., the target SDSi semiconductor device 10905A-C) to which the license pool is bound, (ii) a licensed feature data field that stores a list of licensed features that can be activated along with a number of permitted activations for each licensed feature, (iii) and a signature data field that stores digital signature that covers one or more of the other data fields of the license pool.

In some examples, the target device identifier field of the license pool stores a unique hardware identifier of the target one of the SDSi semiconductor devices 10905A-C to which the license pool is bound. This allows the target SDSi semiconductor device 10905A-C to verify if a received license pool is targeted for itself. If there is mismatch such that the hardware identifier stored in the target identifier field does not correspond to the target SDSi semiconductor device 10905A-C, then the target SDSi semiconductor device 10905A-C rejects the license pool. In some examples, a PPIN is used as the unique hardware identifier because it is accessible by the modules/subsystems of the SDSi semiconductor devices 10905A-C to read and it is also imprinted on the physical packages of the SDSi semiconductor device 10905A-C.

In some examples, the licensed feature data field of the license pool stores a list of licensed SDSi features that can be activated along with a permitted (e.g., maximum) number of activations for each SDSi feature. This list forms the actual pool of features/licenses that can be activated by the target SDSi semiconductor device 10905A-C managing this license pool, or requested to be transferred to other ones of the SDSi semiconductor devices 10905A-C. In some examples, the target SDSi semiconductor device 10905A-C managing this license pool tracks the number of activations performed for itself and/or the licenses transferred to other ones of the SDSi semiconductor devices 10905A-C. In some such examples, license transfer is treated as a feature activation by the target SDSi semiconductor device 10905A-C managing this license pool, and once the permitted (e.g., maximum) number of activations for a feature is reached, any new request to activate or transfer another license for that feature is rejected.

In some examples, the signature data field stores a digital signature over one or more, or all, of the other data fields of the license pool. This signature protects the license pool against any modifications by unauthorized entities. In some examples, the target SDSi semiconductor device 10905A-C managing this license pool checks the signature to verify the integrity of the license pool and stops further processing of the license pool if signature validation fails.

In some examples, a license pool may be bound to more than one target SDSi semiconductor device 10905A-C to provide redundancy, enhance integrity, etc. In some such examples, a group of SDSi semiconductor devices 10905A-C will behave as a single logical entity (e.g., by using a voting scheme) when making decisions concerning the use of the license pool.

In some examples, an individual SDSi license for a given feature is split into individually managed parts that require the coordination and cooperation of multiple target SDSi semiconductor device 10905A-C to agree and validate the license through a quorum. For example, an SDSi license for a given feature can be split into three (3) parts, and three of the SDSi semiconductor devices 10905A-C can be provisioned license pools containing a different combination of two of the three parts. Further, the three SDSi semiconductor devices 10905A-C can be permitted to offer just one part of the license to a requestor. In such an example, the three SDSi semiconductor devices 10905A-C would have to agree to provide all three parts to the license, which once agreed upon are served out to the requestor to form the entire license. In some examples, further redundancy can be provided by providing more than three of the SDSi semiconductor devices 10905A-C, such as five of the SDSi semiconductor devices 10905A-C, with license pools containing different combinations of the 2-part sublicenses, and a quorum is of the provisioned SDSi semiconductor devices 10905A-C, such as a quorum of three of those SDSi semiconductor devices 10905A-C, is required to serve out a complete license to a requestor.

In the illustrated example system 10900 of FIG. 109, the orchestration circuitry 10950 is responsible for high-level SDSi license management but does not need to maintain any secret information. In some examples, it is sufficient for the orchestration circuitry 10950 to keep track of the SDSi semiconductor devices 10905A-C with available SDSI licenses and with SDSi licenses locked for use. If a particular one of the SDSi semiconductor devices 10905A-C requires an SDSi feature to be activated, the orchestration circuitry 10950 checks whether that SDSi semiconductor device 10905A-C already has the appropriate SDSi license for the feature. If not, then the orchestration circuitry 10950 initiates a transfer of the appropriate SDSi license from another one of the SDSi semiconductor devices 10905A-C using, for example, the acquire license pool operation and the install license pool operation disclosed herein. Then, the orchestration circuitry 10950 can initiate activation of that SDSi feature on the particular SDSi semiconductor device 10905A-C using the activate feature operation disclosed herein.

FIGS. 110-113 depict ladder diagrams illustrating example implementations of the install license pool operation, the acquire license pool operation, the activate feature operation and the deactivate feature operation disclosed herein. In these example implementations, the orchestration circuitry 10950 is responsible for high-level management of SDSi licenses in the system 10900. As such, in some examples, the orchestration circuitry 10950 does not need be trusted as its role is to facilitate transfer of licenses and/or license pools, and/or to initiate SDSi feature activations and deactivations, but the SDSi semiconductor devices 10905A-C perform the actual SDSi license transfers and feature activations/deactivations. Thus, in some examples, the functionality of the orchestration circuitry 10950 can be additionally or alternatively implemented by any software, agent, etc., structured to implement those license management features.

In the illustrated examples of FIGS. 110-113, any appropriate communication protocol (e.g., Internet protocol (IP), transmission control protocol (TCP), hypertext transfer protocol (HTTP), etc.) can be used to exchange the messages and/or any other communications depicted in the ladder diagrams. In some examples, the integrity of such messages and/or any other communications between the SDSi asset agent circuitry 10940A-C of the SDSi semiconductor devices 10905A-C and/or the orchestration circuitry X150 is protected using secure protocols such as, but not limited to, security protocol and data model (SPDM) or similar protocols if communication is between hardware components, mutual Transport Level Security (mTLS) or similar protocol if communication is between software components, etc.

FIG. 110 depicts a ladder diagram illustrating an example install license pool operation 11000 implemented in accordance with teachings of this disclosure. The example install license pool operation 11000 begins with the orchestration circuitry 10950 using one more move available communication interfaces to send an example install pool message 11005 to a target SDSi semiconductor device on which a license pool is to be installed, which is the SDSi semiconductor device 10905A in the illustrated example. In the illustrated example, the install pool message 11005 includes the license pool to be installed on the target SDSi semiconductor device 10905A. In some examples, the orchestration circuitry 10950 obtains the license pool from the semiconductor manufacturer (e.g., from the manufacturer enterprise system 105), such as when this is the first installation of the particular license pool in the system 10900 at the customer environment, or when the customer decides to increase the number of SDSi licenses in the system 10900, etc. In some examples, the license pool may be acquired from another one of the SDSi semiconductor devices 10905A-C via the acquire license pool operation, which is described in further detail below.

In response to the install pool message 11005, the SDSi asset agent circuitry 10940A (e.g., such as its license processor 214) of the target SDSi semiconductor device 10905A performs an example verify pool operation 11010 to verify the signature in the license pool. In some examples, the SDSi asset agent circuitry 10940A of the target SDSi semiconductor device 10905A performs such verification using a public key corresponding to the private key used to generate the signature. In some examples, the public key is embedded in the target SDSi semiconductor device 10905A. If signature validation fails (corresponding to the “NO” branch out of the verify pool operation 11010), the SDSi asset agent circuitry 10940A of the target SDSi semiconductor device 10905A interrupts and halts processing of the license pool, discards the license pool and returns an example pool verification error message 11015 to the orchestration circuitry 10950.

However, if signature validation is successful (corresponding to the “YES” branch out of the verify pool operation 11010), the SDSi asset agent circuitry 10940A (e.g., such as its license processor 214) of the target SDSi semiconductor device 10905A performs an example verify hardware operation 11020 to verify that the device identifier in the license pool corresponds to the target SDSi semiconductor device 10905A. For example, the SDSi asset agent circuitry 10940A of the target SDSi semiconductor device 10905A may determine whether the unique identifier in the license pool matches the PPIN of the target SDSi semiconductor device 10905A. If verification of the unique identifier fails (corresponding to the “NO” branch out of the verify hardware operation 11020), the SDSi asset agent circuitry 10940A of the target SDSi semiconductor device 10905A interrupts and halts processing of the license pool, discards the license pool and returns an example hardware mismatch error message 11025 to the orchestration circuitry 10950.

However, if verification of the unique identifier is successful (corresponding to the “YES” branch out of the verify hardware operation 11020), the SDSi asset agent circuitry 10940A (e.g., such as its license processor 214) of the target SDSi semiconductor device 10905A performs an example store license pool operation 11030 to store the license pool in the target SDSi semiconductor device 10905A, such that the license pool can be accessed and processed later in response to initiation of acquire license pool, activate feature and/or deactivate feature operations. Then, the SDSi asset agent circuitry 10940A of the target SDSi semiconductor device 10905A returns an example installation success message 11035 to the orchestration circuitry 10950.

FIG. 111 depicts a ladder diagram illustrating an example acquire license pool operation 11100 implemented in accordance with teachings of this disclosure. The example acquire license pool operation 11100 begins with the orchestration circuitry 10950 sending an example get hardware identification message 11105 to a destination SDSi semiconductor device on which a license pool to which a license pool is to be transferred, which is the SDSi semiconductor device 10905B in the illustrated example. The get hardware identification message 11105 is sent to the destination SDSi semiconductor device 10905B to obtain an identifier of the destination SDSi semiconductor device 10905B, such as its PPIN or other another unique identifier. In response, the SDSi asset agent circuitry 10940B (e.g., such as its license processor 214) of the destination SDSi semiconductor device 10905B returns its identifier in an example return hardware identifier message sent to the orchestration circuitry 10950.

After the identifier of the destination SDSi semiconductor device 10905B is obtained, the orchestration circuitry 10950 sends an example acquire license pool request message 11115 to the target SDSi semiconductor device that serves as a license server for the license pool to be transferred, which is the target SDSi semiconductor device 10905A in the illustrated example. In some examples, the identifier of the destination SDSi semiconductor device 10905B and a requested license list that forms the license pool to be transferred is included in the acquire license pool request message 11115. In some examples, the requested license list may specify one or more licenses for a corresponding one or more features which form a license pool to be managed by the destination SDSi semiconductor device 10905B. In some such examples, the requested license list may include the entire license pool managed by the target SDSi semiconductor device 10905A, in which case the destination SDSi semiconductor device 10905B is intended to replace the target SDSi semiconductor device 10905A as the license server for that license pool. In some examples, the requested license list may include a portion, or subset, of the license pool managed by the target SDSi semiconductor device 10905A, in which case the destination SDSi semiconductor device 10905B is intended to work in combination with the target SDSi semiconductor device 10905A to manage the complete license pool. In some examples, the requested license list may contain a single license for a single feature that is to be activated by the destination SDSi semiconductor device 10905B, in which case the destination SDSi semiconductor device 10905B does not act as a license server.

In response to the acquire license pool request message 11115, the SDSi asset agent circuitry 10940A (e.g., such as its license processor 214) of the target SDSi semiconductor device 10905A performs an example license availability verification operation 11120 to check and verify that the requested licenses are available in the license pool managed by the target SDSi semiconductor device 10905A. If license availability verification fails because there are insufficient available licenses in the pool to satisfy the request (corresponding to the “NO” branch out of the license availability verification operation 11120), the SDSi asset agent circuitry 10940A of the target SDSi semiconductor device 10905A interrupts and halts processing of the request, and returns an example license availability error message 11125 to the orchestration circuitry 10950.

However, if license availability verification is successful because there are sufficient available licenses in the pool to satisfy the request (corresponding to the “YES” branch out of the license availability verification operation 11120), then the SDSi asset agent circuitry 10940A (e.g., such as its license processor 214) of the target SDSi semiconductor device 10905A performs an example remove licenses from pool operation 11130 to remove the requested licenses from the license pool managed by the target SDSi semiconductor device 10905A. In the illustrated example, the SDSi asset agent circuitry 10940A (e.g., such as its license processor 214) of the target SDSi semiconductor device 10905A also perform an example sign new pool operation 11135 to build a new license pool payload that includes the requested licenses, the identifier of the destination SDSi semiconductor device 10905B, and a signature formed by signing some or all of the other fields of the payload, such as the requested licenses and/or the identifier of the destination SDSi semiconductor device 10905B. In some examples, the SDSi asset agent circuitry 10940A of the target SDSi semiconductor device 10905A determines the signature based on a private key assigned to and/or stored in the target SDSi semiconductor device 10905A. In this way, the new license pool is bound to the destination SDSi semiconductor device 10905B by inclusion of the identifier of destination SDSi semiconductor device 10905B in the license pool such that the identifier is protected from modification by the signature.

In the illustrated example, the SDSi asset agent circuitry 10940A (e.g., such as its license processor 214) of the target SDSi semiconductor device 10905A further performs an example output new pool operation 11140 that outputs the new license pool, which contains the license list, the identifier of the destination SDSi semiconductor device 10905B, and the signature. The example output new pool operation 11140 also returns the new license pool to the to the orchestration circuitry 10950 in an example return license pool message 11145. By including the identifier of the destination SDSi semiconductor device 10905B in the new license pool and protecting it with the signature of the target SDSi semiconductor device 10905A, the new pool can be restricted to be used by the destination SDSi semiconductor device 10905B and no other device. After the orchestration circuitry 10950 receives the new license pool, the orchestration circuitry 10950 can invoke the install license pool operation 11000 disclosed above to cause the new license pool to be installed on the destination SDSi semiconductor device 10905B.

FIG. 112 depicts a ladder diagram illustrating an example activate feature operation 11200 implemented in accordance with teachings of this disclosure. The example activate feature operation 11200 begins with the orchestration circuitry 10950 identifying a set of one or more features to be activated on a target SDSi semiconductor device, which is the target SDSi semiconductor device 10905A in the illustrated example. In the illustrated example of FIG. 112, the orchestration circuitry 10950 sends an example activate feature request message 11205 containing the list of feature(s) for activation to the target SDSi semiconductor device 10905A. In response to the activate feature request message 11205, the SDSi asset agent circuitry 10940A (e.g., such as its license processor 214) of the target SDSi semiconductor device 10905A performs an example license availability verification operation 11210 to check and verify that the license pool managed by the target SDSi semiconductor device 10905A contains the respective license(s) corresponding to the list of feature(s) for activation. In some examples, the orchestration circuitry 10950 also tracks whether the target SDSi semiconductor device 10905A has a license pool that contains the respective SDSi license(s) needed to activate the SDSi feature(s) included in the list of feature(s) for activation. In some such examples, if the license pool managed by the target SDSi semiconductor device 10905A does not contain the requisite license(s), then the orchestration circuitry 10950 transfers the appropriate license(s) from another one of the SDSi semiconductor device 10950B-C using the example acquire license pool operation 11100 and the example install license pool operation 11000 disclosed. In some such examples, such a license pool transfer must be completed before the activate feature message 11205 is sent to the target SDSi semiconductor device 10905A.

If license availability verification fails because there are insufficient available license(s) in the pool to activate the requested feature(s) (corresponding to the “NO” branch out of the license availability verification operation 11210), the SDSi asset agent circuitry 10940A of the target SDSi semiconductor device 10905A interrupts and halts processing of the request, and returns an example license availability error message 11215 to the orchestration circuitry 10950. However, if license availability verification is successful because there are sufficient available license(s) in the pool to activate the requested feature(s) (corresponding to the “YES” branch out of the license availability verification operation 11210), then the SDSi asset agent circuitry 10940A (e.g., such as its license processor 214) of the target SDSi semiconductor device 10905A performs an example lock license operation 11220 to lock the respective SDSi license(s) corresponding to the SDSi feature(s) to be activated. In some examples, once the respective SDSi license(s) are locked, those license(s) cannot be returned by the example acquire license pool operation 11100 disclosed above, or used by subsequent activate feature operations 11200, until those license(s) are unlocked (e.g., by deactivating the corresponding SDSi feature(s)).

In the illustrated example, the SDSi asset agent circuitry 10940A of the target SDSi semiconductor device 10905A then performs an example activate feature operation 11225 via which the requested SDSi feature(s) corresponding to the locked SDSi license(s) are activated, as disclosed above. The SDSi asset agent circuitry 10940A of the target SDSi semiconductor device 10905A then returns an example activation success message 11230 to notify the orchestration circuitry 10950 that activation of the requested SDSi feature(s) was successful.

FIG. 113 depicts a ladder diagram illustrating an example deactivate feature operation 11300 implemented in accordance with teachings of this disclosure. The example deactivate feature operation 11300 begins with the orchestration circuitry 10950 identifying a set of one or more features to be deactivated on a target SDSi semiconductor device, which is the target SDSi semiconductor device 10905A in the illustrated example. In the illustrated example of FIG. 113, the orchestration circuitry 10950 sends an example deactivate feature request message 11305 containing the list of feature(s) for deactivation to the target SDSi semiconductor device 10905A. In response to the deactivate feature request message 11205, the SDSi asset agent circuitry 10940A (e.g., such as its license processor 214) of the target SDSi semiconductor device 10905A performs an example deactivate feature operation 11310 to deactivate the requested SDSi feature(s) included in the feature deactivation list.

In the illustrated example, the SDSi asset agent circuitry 10940A (e.g., such as its license processor 214) of the target SDSi semiconductor device 10905A also performs an example release license operation 11315 to release, or unlock, the respective SDSi license(s) corresponding to the SDSi feature(s) to be deactivated, thereby returning those license(s) to the license pool managed by the target SDSi semiconductor device 10905A. The license(s) returned to the license pool can then be returned by the example acquire license pool operation 11100 disclosed above, or used by subsequent activate feature operations 11200. In the illustrated example, the SDSi asset agent circuitry 10940A of the target SDSi semiconductor device 10905A then returns an example deactivation success message 11320 to notify the orchestration circuitry 10950 that deactivation of the requested SDSi feature(s) was successful.

In some examples described above, an SDSi license pool is bound to a particular identifier (e.g., PPIN) of a particular target SDSi semiconductor device 10905A-C. In some such examples, a failure of the target SDSi semiconductor device 10905A-C implies an irrevocable loss of the license pool it has been managing. For example, if the memory of the target SDSi semiconductor device 10905A-C cannot be read, this loss is permanent, as there may be no reliable way of proving that the failing/failed SDSi semiconductor device 10905A-C has been managing a license pool, or whether that license pool was already transferred to another destination SDSi semiconductor device 10905A-C.

Hence, in some examples, an SDSi license pool may be bound to more than one target identifier corresponding to more than one target SDSi semiconductor device 10905A-C to provide redundancy (e.g., in a RAID-like scheme). In some such examples, a majority vote is used to determine whether further license transfers (e.g., via the example acquire license pool 11100 disclosed above) and/or license consumption (e.g., via the example activate feature operation 11200 disclosed above) are to be permitted. For example, if an M of N voting scheme is used, and the license pool is assigned to N=3 SDSi semiconductor devices 10905A-C, the subsequent use of the license pool may require at least M=2 of the SDSi semiconductor devices 10905A-C to be present to permit such use. In such examples, the total loss of a license pool is prevented in the case of failure of any single SDSi semiconductor device 10905A-C managing that license pool. Such an example can be extended to even more SDSi semiconductor devices 10905A-C, thereby protecting against failures of more than one of the devices.

In some examples, a license pool contains multiple licenses, and each license is broken into multiple parts/fragments, such as three or more parts/fragments. In some examples, multiple target SDSi semiconductor devices 10905A-C manage the license pool, with each target SDSi semiconductor device 10905A-C storing a subset of the parts/fragments of each license, such as two parts/fragments of each license. Furthermore, a given target SDSi semiconductor device 10905A-C may be constrained to provide just one part/fragment of a given license. In such an example, a minimum of three target SDSi semiconductor devices 10905A-C must be available to each provide one part/fragment of the license. The license is then aggregated and provided to the target machine for activation. In some examples, for backup purposes, a minimum of two additional SDSi semiconductor devices 10905A-C are provisioned to have 2 parts/fragments of each of the licenses, and they may not be the same two parts/fragments.

For example, consider a scenario in which a license pool is assigned to N=3 target SDSi semiconductor devices 10905A-C, and each of the target SDSi semiconductor devices 10905A-C stores two parts/fragments of each license, and each target SDSi semiconductor devices 10905A-C is constrained to provide just one part/fragment of a given license. In some such examples, when the orchestration circuitry 10950 requests a particular SDSi license from the pool, the 3 target SDSi semiconductor devices 10905A-C (e.g., via their respective SDSi asset agent circuitry 10940A-C) set up a secure, authenticated private network for the purpose of generating and aggregating the 3 parts of the license. During the security identification part, any backup SDSi semiconductor devices may also authenticate, but do not participate for the license aggregation. Once the 3 target SDSi semiconductor devices 10905A-C agree and trust each other, they select the first, second and third parts of the license to come from each of the 3 target SDSi semiconductor devices 10905A-C. In some examples, such selections (for the first, second and third parts of the license) may be required to not be the same as the last time a license was provided from the pool. In some examples, if any of the target SDSi semiconductor devices 10905A-C is unable to provide a security identifier or validation, a backup SDSi semiconductor device will provide the authentication.

In some examples, the flexible licensing solutions disclosed herein can be extended to limit the number of license transfers between the SDSi semiconductor devices 10905A-C. Additionally or alternatively, in some examples, flexible licensing solutions disclosed herein can be extended to permit activated SDSi features to expire and become disabled/deactivated automatically after a period of time (e.g., after expiration of a time period). Additionally or alternatively, in some examples, flexible licensing solutions disclosed herein can be extended to provide additional security measures to the messaging/calls exchanged between the SDSi semiconductor devices 10905A-C and the orchestration circuitry 10950. For example, authentication can be implemented by the SDSi semiconductor devices 10905A-C and the orchestration circuitry 10950 to restrict licensing features, such as install license pool operations, acquire license pool operations, activate feature operations, deactivate feature operation, etc., to authenticated entities (e.g., such as authenticated orchestration circuitry, authenticated users of the orchestration circuitry, authenticated SDSi semiconductor devices, etc.). Additionally or alternatively, in some examples, flexible licensing solutions disclosed herein can be extended to provide additional status operations.

The flexible licensing solutions disclosed herein can also be applied to licensing features other than SDSi features, such as software and/or drivers on any processor platform. For example, the flexible licensing solutions disclosed herein may be used to license software applications and/or hardware features which exist in a chipset, a network interface, a compute system, etc. As such, hardware and software vendors can utilize the flexible licensing solutions disclosed herein to license such software applications and/or hardware features after purchase.

While an example manner of implementing the system 10900 is illustrated in FIGS. 109-113, one or more of the elements, processes, and/or devices illustrated in FIGS. 109-113 may be combined, divided, re-arranged, omitted, eliminated, and/or implemented in any other way. Further, the example SDSi semiconductor devices 10905A-C, the example SDSi asset agent circuitry 10940A-C, the example orchestration circuitry 10950, the example network(s) 10920 and/or, more generally, the example system 10900 of FIGS. 109-113, may be implemented by hardware alone or by hardware in combination with software and/or firmware. Thus, for example, any of the example SDSi semiconductor devices 10905A-C, the example SDSi asset agent circuitry 10940A-C, the example orchestration circuitry 10950, the example network(s) 10920, and/or, more generally, the example system 10900, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example system 10900 may include one or more elements, processes, and/or devices in addition to, or instead of, those illustrated in FIGS. 109-113, and/or may include more than one of any or all of the illustrated elements, processes and devices.

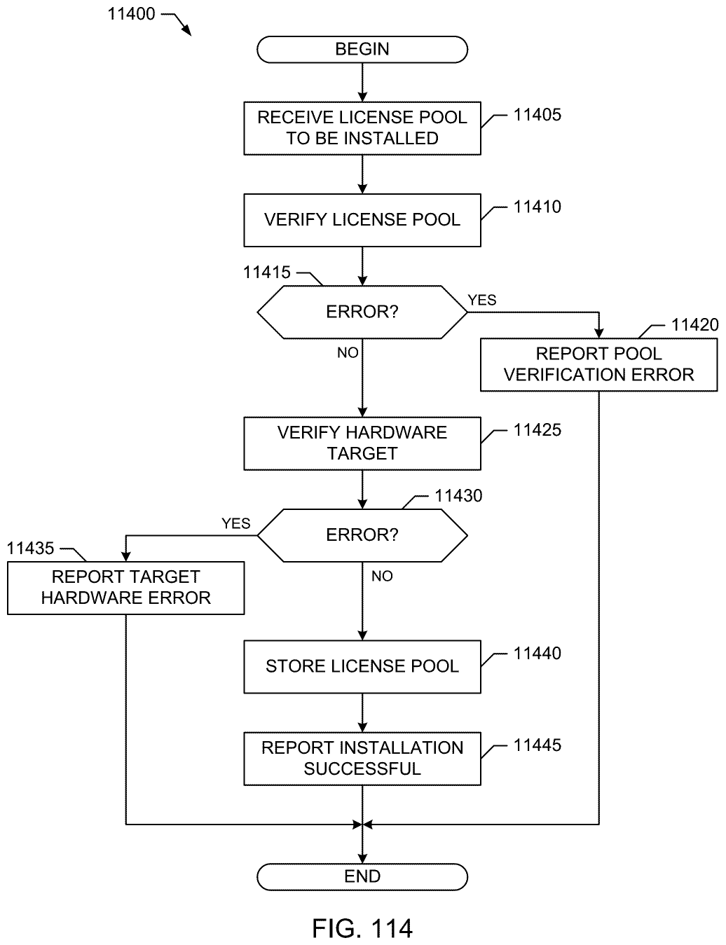

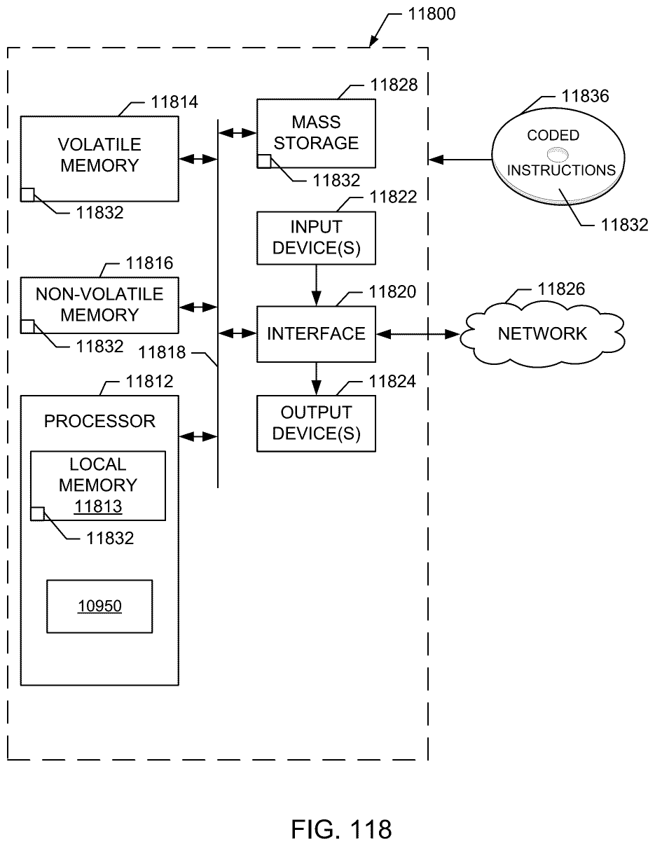

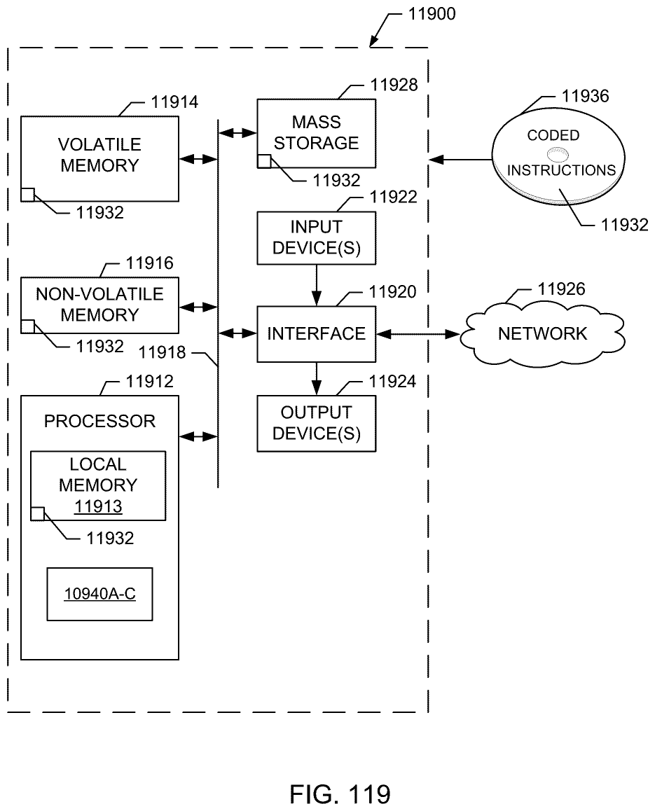

Flowcharts representative of example machine readable instructions which may be executed to configure processor circuitry to implement the example system 10900 of FIGS. 109-113 are shown in FIGS. 114-117. The machine readable instructions may be one or more executable programs or portion(s) of an executable program for execution by processor circuitry, such as the processor circuitry 11812 and/or 11912 shown in the example processor platforms 11800 and/or 11900 discussed below in connection with FIG. 118 and FIG. 119 and/or the example processor circuitry discussed below in connection with FIGS. 150 and/or 151. The program(s) may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program(s) and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program(s) is(are) described with reference to the flowcharts illustrated in FIGS. 114-117, many other methods of implementing the example system 10900 may alternatively be used. For example, the order of execution of the blocks may be changed, and/or some of the blocks described may be changed, eliminated, combined and/or subdivided into multiple blocks. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 114-117 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc. Also, as used herein, the terms “computer readable” and “machine readable” are considered equivalent unless indicated otherwise.

FIGS. 114-117 are flowcharts representative of example implementations of the install license pool operation, the acquire license pool operation, the activate feature operation and the deactivate feature operation used to implement flexible SDSi licensing solutions disclosed herein. In particular, FIG. 114 is a flowchart representative of example machine readable instructions and/or example operations 11400 that may be executed and/or instantiated by processor circuitry to implement the example install license pool operation 11000 disclosed above. For convenience, and without loss of generality, the machine readable instructions and/or operations 11400 of FIG. 114 are described in the context of the example system 10900 of FIG. 109 and, in particular, from the perspective of an example SDSi license pool being provided by the orchestration circuitry 10950 for installation in the target SDSi semiconductor device 10905A. With reference to the preceding figures and associated written descriptions, the machine readable instructions and/or the operations 11400 of FIG. 114 begin at block 11405 at which the SDSi asset agent circuitry 10940A (e.g., such as its license processor 214) of the target SDSi semiconductor device 10905A receives the SDSi license pool from the orchestration circuitry 10950. At block 11410, the SDSi asset agent circuitry 10940A (e.g., such as its license processor 214) of the target SDSi semiconductor device 10905A verifies the integrity of the license pool by, for example, validation a signature in the license pool using a public key maintained by the SDSi asset agent circuitry 10940A of the target SDSi semiconductor device 10905A. For example, the public key for license pool verification may correspond to a private key used by a silicon manufacture to sign the license pool, and may stored in the target SDSi semiconductor device 10905A by the silicon manufacture, provided by the silicon manufacture to the SDSi asset agent circuitry 10940A of the target SDSi semiconductor device 10905A in a secure manner, etc.

At block 11415, the SDSi asset agent circuitry 10940A (e.g., such as its license processor 214) of the target SDSi semiconductor device 10905A determines whether an error occurred during verification of the license pool (e.g., such as whether validation of the license pool signature failed). If a license pool verification error occurred (corresponding to the “YES” branch out of block 11415), then at block 11420 the SDSi asset agent circuitry 10940A (e.g., such as its license processor 214) of the target SDSi semiconductor device 10905A interrupts processing of the license pool and reports a license pool verification error to the orchestration circuitry 10950.

However, if a license pool verification error did not occur (corresponding to the “NO” branch out of block 11415) and, thus, license pool verification was successful, then at block 11425 the SDSi asset agent circuitry 10940A (e.g., such as its license processor 214) of the target SDSi semiconductor device 10905A verifies that the target SDSi semiconductor device 10905A is the proper hardware target for the license pool. For example, at block 11425, the SDSi asset agent circuitry 10940A (e.g., such as its license processor 214) of the target SDSi semiconductor device 10905A may verify that a unique identifier (e.g., PPIN) in the license pool corresponds to the target SDSi semiconductor device 10905A. At block 11430, the SDSi asset agent circuitry 10940A (e.g., such as its license processor 214) of the target SDSi semiconductor device 10905A determines whether an error occurred during hardware target verification of the license pool (e.g., such as whether the unique identifier in the license pool did not match the target SDSi semiconductor device 10905A). If a hardware target verification error occurred (corresponding to the “YES” branch out of block 11430), then at block 11435 the SDSi asset agent circuitry 10940A (e.g., such as its license processor 214) of the target SDSi semiconductor device 10905A interrupts processing of the license pool and reports a hardware target verification error to the orchestration circuitry 10950.

However, if a hardware target verification error did not occur (corresponding to the “NO” branch out of block 11430) and, thus, hardware target verification was successful, then at block 11440 the SDSi asset agent circuitry 10940A (e.g., such as its license processor 214) of the target SDSi semiconductor device 10905A stores the license pool in the target SDSi semiconductor device 10905A, such that the license pool can be accessed and processed later in response to initiation of acquire license pool, activate feature and/or deactivate feature operations. At block 11445, the SDSi asset agent circuitry 10940A (e.g., such as its license processor 214) of the target SDSi semiconductor device 10905A reports installation success to the orchestration circuitry 10950. The machine readable instructions and/or operations 11400 then end.

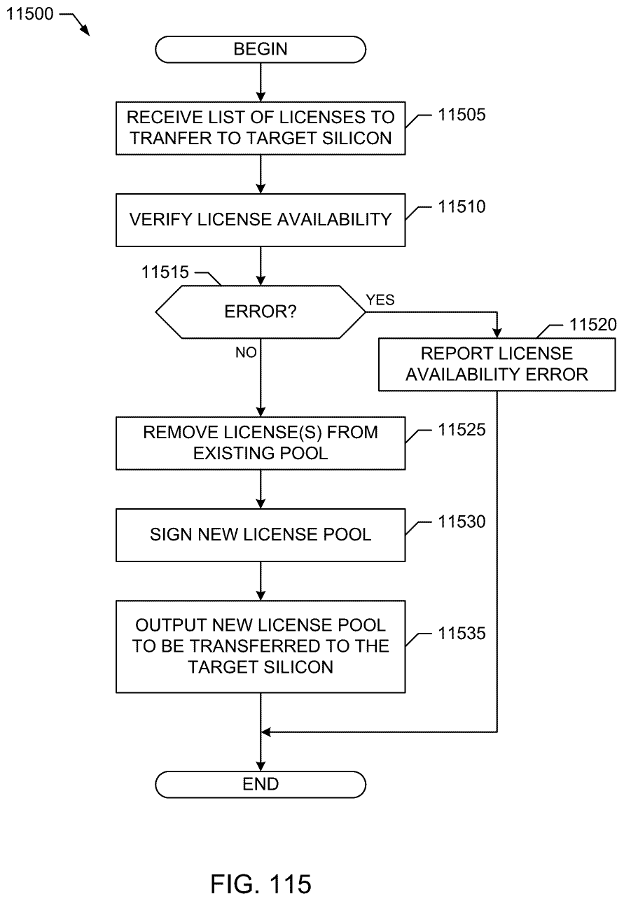

FIG. 115 is a flowchart representative of example machine readable instructions and/or example operations 11500 that may be executed and/or instantiated by processor circuitry to implement the example acquire license pool operation 11100 disclosed above. For convenience, and without loss of generality, the machine readable instructions and/or operations 11500 of FIG. 115 are described in the context of the example system 10900 of FIG. 109 and, in particular, from the perspective of the orchestration circuitry 10950 causing an example SDSi license pool to be acquired from the target SDSi semiconductor device 10905A for transfer to the destination SDSi semiconductor device 10905B. With reference to the preceding figures and associated written descriptions, the machine readable instructions and/or the operations 11500 of FIG. 115 begin at block 11505 at which the SDSi asset agent circuitry 10940A (e.g., such as its license processor 214) of the target SDSi semiconductor device 10905A receives a requested license list from the orchestration circuitry 10950 that specifies one or more SDSi licenses for a corresponding one or more SDSi features that are to form a license pool to be transferred from the target SDSi semiconductor device 10905A to the destination SDSi semiconductor device 10905B. As disclosed above, requested license list may specify a portion, or subset, of the license pool managed by the target SDSi semiconductor device 10905A, or may specify the entire license pool managed by the target SDSi semiconductor device 10905A. As also disclosed above, in some examples, the requested license list, or data accompanying the requested license list, specifies the identifier (e.g., PPIN) of the destination SDSi semiconductor device 10905B to which the license pool specified by the requested license list is to be transferred.

At block 11510, the SDSi asset agent circuitry 10940A (e.g., such as its license processor 214) of the target SDSi semiconductor device 10905A verifies that the SDSi licenses specified in the requested license list are available in the SDSi license pool managed by the target SDSi semiconductor device 10905A. At block 11515, the SDSi asset agent circuitry 10940A (e.g., such as its license processor 214) of the target SDSi semiconductor device 10905A determines whether an error occurred during verification of the availability of the requested licenses. If a license availability error occurred (corresponding to the “YES” branch out of block 11515), then at block 11520 the SDSi asset agent circuitry 10940A (e.g., such as its license processor 214) of the target SDSi semiconductor device 10905A interrupts license acquisition processing and reports a license availability error to the orchestration circuitry 10950.

However, if a license availability error did not occur (corresponding to the “NO” branch out of block 11515) and, thus, the requested SDSi licenses are available, then at block 11525 the SDSi asset agent circuitry 10940A (e.g., such as its license processor 214) of the target SDSi semiconductor device 10905A removes the requested licenses from the license pool managed by the target SDSi semiconductor device 10905A. At block 11530, the SDSi asset agent circuitry 10940A (e.g., such as its license processor 214) of the target SDSi semiconductor device 10905A builds, as described above, a new license pool that includes the requested licenses, the identifier of the destination SDSi semiconductor device 10905B, and a signature formed by signing some or all of the other fields of the new license pool payload, such as the requested licenses and/or the identifier of the destination SDSi semiconductor device 10905B. At block 11535, the SDSi asset agent circuitry 10940A (e.g., such as its license processor 214) of the target SDSi semiconductor device 10905A outputs the new license pool, which contains the requested licenses, the identifier of the destination SDSi semiconductor device 10905B, and the signature, and sends the new license pool to the orchestration circuitry 10950. The machine readable instructions and/or operations 11500 then end. After the orchestration circuitry 10950 receives the new license pool, the orchestration circuitry 10950 can invoke the example machine readable instructions and/or operations 11400 disclosed above to cause the new license pool to be installed on the destination SDSi semiconductor device 10905B.

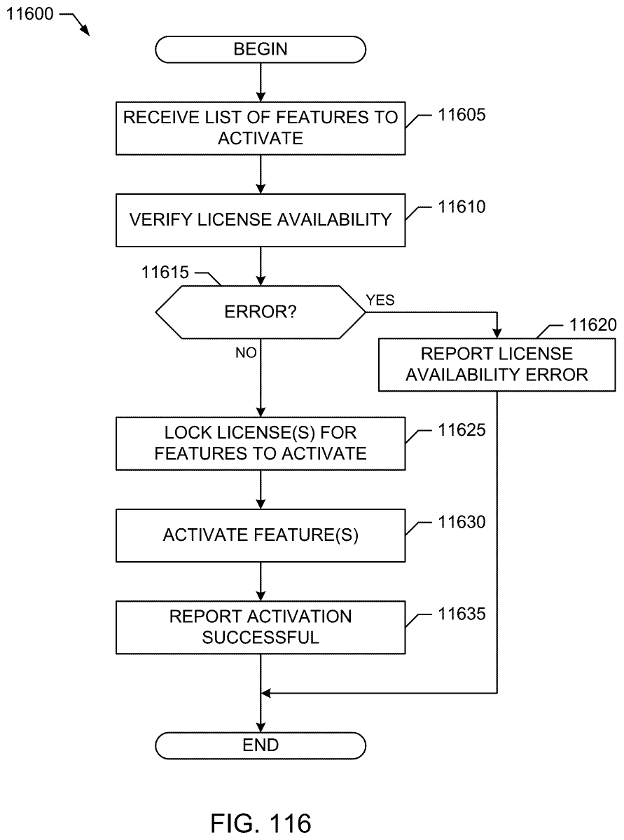

FIG. 116 is a flowchart representative of example machine readable instructions and/or example operations 11600 that may be executed and/or instantiated by processor circuitry to implement the example activate feature operation 11200 disclosed above. For convenience, and without loss of generality, the machine readable instructions and/or operations 11600 of FIG. 116 are described in the context of the example system 10900 of FIG. 109 and, in particular, from the perspective of the orchestration circuitry 10950 causing one or more SDSi licensed features to be activated on the target SDSi semiconductor device 10905A. With reference to the preceding figures and associated written descriptions, the machine readable instructions and/or the operations 11600 of FIG. 116 begin at block 11605 at which the SDSi asset agent circuitry 10940A (e.g., such as its license processor 214) of the target SDSi semiconductor device 10905A receives, from the orchestration circuitry 10950, a list of SDSi feature(s) for activation on the target SDSi semiconductor device 10905A. At block 11610, the SDSi asset agent circuitry 10940A (e.g., such as its license processor 214) of the target SDSi semiconductor device 10905A verifies that the SDSi license(s) for the requested feature(s) for activation are available in the SDSi license pool managed by the target SDSi semiconductor device 10905A. At block 815, the SDSi asset agent circuitry 10940A (e.g., such as its license processor 214) of the target SDSi semiconductor device 10905A determines whether an error occurred during verification of the availability of the requested licenses. If a license availability error occurred (corresponding to the “YES” branch out of block 1095), then at block 11620 the SDSi asset agent circuitry 10940A (e.g., such as its license processor 214) of the target SDSi semiconductor device 10905A interrupts feature activation processing and reports a license availability error to the orchestration circuitry 10950.

However, if a license availability error did not occur (corresponding to the “NO” branch out of block 11615) and, thus, the SDSi license(s) for the requested SDSi feature(s) is(are) available, then at block 11625 the SDSi asset agent circuitry 10940A (e.g., such as its license processor 214) of the target SDSi semiconductor device 10905A locks the respective SDSi license(s) corresponding to the SDSi feature(s) to be activated. At block 11625, the SDSi asset agent circuitry 10940A of the target SDSi semiconductor device 10905A activates the requested SDSi feature(s) corresponding to the locked SDSi license(s), as disclosed above. At block 11635, the SDSi asset agent circuitry 10940A (e.g., such as its license processor 214) of the target SDSi semiconductor device 10905A reports feature activation success to the orchestration circuitry 10950. The machine readable instructions and/or operations 11600 then end.

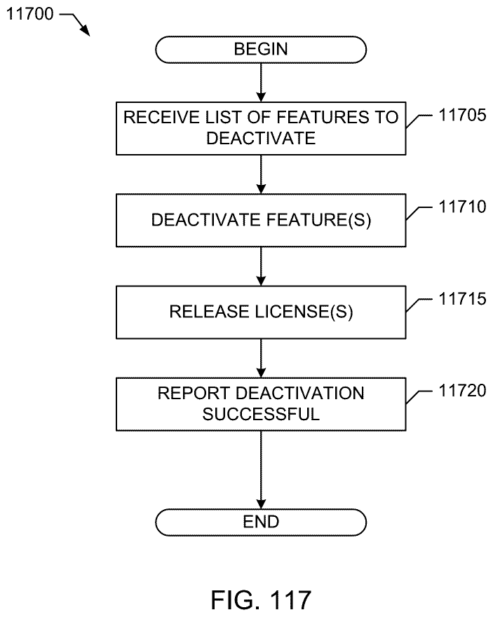

FIG. 117 is a flowchart representative of example machine readable instructions and/or example operations 11700 that may be executed and/or instantiated by processor circuitry to implement the example deactivate feature operation 11300 disclosed above. For convenience, and without loss of generality, the machine readable instructions and/or operations 11700 of FIG. 117 are described in the context of the example system 10900 of FIG. 109 and, in particular, from the perspective of the orchestration circuitry 10950 causing one or more SDSi licensed features to be deactivated on the target SDSi semiconductor device 10905A. With reference to the preceding figures and associated written descriptions, the machine readable instructions and/or the operations 11700 of FIG. 117 begin at block 11705 at which the SDSi asset agent circuitry 10940A (e.g., such as its license processor 214) of the target SDSi semiconductor device 10905A receives, from the orchestration circuitry 10950, a list of SDSi feature(s) for deactivation on the target SDSi semiconductor device 10905A.

At block 11710, the SDSi asset agent circuitry 10940A of the target SDSi semiconductor device 10905A deactivates the requested SDSi feature(s), as disclosed above. At block 11715, the SDSi asset agent circuitry 10940A of the target SDSi semiconductor device 10905A releases, or unlocks, the respective SDSi license(s) corresponding to the deactivated SDSi feature(s), thereby returning those license(s) to the license pool managed by the target SDSi semiconductor device 10905A. At block 11720, the SDSi asset agent circuitry 10940A (e.g., such as its license processor 214) of the target SDSi semiconductor device 10905A reports feature deactivation success to the orchestration circuitry 10950. The machine readable instructions and/or operations 11700 then end.

FIG. 118 is a block diagram of an example processor platform 11800 structured to execute and/or instantiate the machine readable instructions and/or the operations of FIGS. 114, 115, 116 and/or 117 to implement the example orchestrator X150 in the example system 10900 of FIGS. 109-113. The processor platform 11800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 11800 of the illustrated example includes processor circuitry 11812. The processor circuitry 11812 of the illustrated example is hardware. For example, the processor circuitry 11812 can be implemented by one or more integrated circuits, logic circuits, FPGAs, microprocessors, CPUs, GPUs, DSPs, and/or microcontrollers from any desired family or manufacturer. The processor circuitry 11812 may be implemented by one or more semiconductor based (e.g., silicon based) devices. In this example, the processor circuitry 412 implements the example orchestration circuitry 10950.

The processor circuitry 11812 of the illustrated example includes a local memory 11813 (e.g., a cache, registers, etc.). The processor circuitry 11812 of the illustrated example is in communication with a main memory including a volatile memory 11814 and a non-volatile memory 11816 by a bus 11818. The volatile memory 11814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 11816 may be implemented by flash memory and/or any other desired type of memory device. Access to the main memory 11814, 11816 of the illustrated example is controlled by a memory controller 11817.

The processor platform 11800 of the illustrated example also includes interface circuitry 11820. The interface circuitry 11820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 11822 are connected to the interface circuitry 11820. The input device(s) 11822 permit(s) a user to enter data and/or commands into the processor circuitry 11812. The input device(s) 11822 can be implemented by, for example, an audio sensor, a microphone, a camera (still or video), a keyboard, a button, a mouse, a touchscreen, a track-pad, a trackball, a trackbar, an isopoint device, a voice recognition system and/or any other human-machine interface. In some examples, the input device(s) 11822 are arranged or otherwise configured to allow the user to control the processor platform 11800 and provide data to the processor platform 11800 using physical gestures, such as, but not limited to, hand or body movements, facial expressions, face recognition, etc.

One or more output devices 11824 are also connected to the interface circuitry 11820 of the illustrated example. The output device(s) 11824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 11820 of the illustrated example, thus, typically includes a graphics driver card, a graphics driver chip, and/or graphics processor circuitry such as a GPU.

The interface circuitry 11820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 11826, which may correspond to the example network(s) 10920. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 11800 of the illustrated example also includes one or more mass storage devices 11828 to store software and/or data. Examples of such mass storage devices 11828 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 11832, which may be implemented by the machine readable instructions of FIGS. 114, 115, 116 and/or 117, may be stored in the mass storage device 11828, in the volatile memory 11814, in the non-volatile memory 11816, and/or on a removable non-transitory computer readable storage medium such as a CD or DVD.

FIG. 119 is a block diagram of an example processor platform 11900 structured to execute and/or instantiate the machine readable instructions and/or the operations of FIGS. 114, 115, 116 and/or 117 to implement one or more of the example SDSi semiconductor devices 10905A-C in the example system 10900 of FIGS. 109-113. The processor platform 11900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 11900 of the illustrated example includes processor circuitry 11912. The processor circuitry 11912 of the illustrated example is hardware. For example, the processor circuitry 11912 can be implemented by one or more integrated circuits, logic circuits, FPGAs, microprocessors, CPUs, GPUs, DSPs, and/or microcontrollers from any desired family or manufacturer. The processor circuitry 11912 may be implemented by one or more semiconductor based (e.g., silicon based) devices. In this example, the processor circuitry 11912 implements one or more of the example SDSi asset agent circuitry 10940A-C for the respective one or more of the SDSi semiconductor devices 10905A-C implemented by the processor platform 11900.

The processor circuitry 11912 of the illustrated example includes a local memory 11913 (e.g., a cache, registers, etc.). The processor circuitry 11912 of the illustrated example is in communication with a main memory including a volatile memory 11914 and a non-volatile memory 11916 by a bus 11918. The volatile memory 11914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 11916 may be implemented by flash memory and/or any other desired type of memory device. Access to the main memory 11914, 11916 of the illustrated example is controlled by a memory controller 11917.

The processor platform 11900 of the illustrated example also includes interface circuitry 11920. The interface circuitry 11920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 11922 are connected to the interface circuitry 11920. The input device(s) 11922 permit(s) a user to enter data and/or commands into the processor circuitry 11912. The input device(s) 11922 can be implemented by, for example, an audio sensor, a microphone, a camera (still or video), a keyboard, a button, a mouse, a touchscreen, a track-pad, a trackball, a trackbar, an isopoint device, a voice recognition system and/or any other human-machine interface. In some examples, the input device(s) 11922 are arranged or otherwise configured to allow the user to control the processor platform 11900 and provide data to the processor platform 11900 using physical gestures, such as, but not limited to, hand or body movements, facial expressions, face recognition, etc.

One or more output devices 11924 are also connected to the interface circuitry 11920 of the illustrated example. The output device(s) 11924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 11920 of the illustrated example, thus, typically includes a graphics driver card, a graphics driver chip, and/or graphics processor circuitry such as a GPU.

The interface circuitry 11920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 11926, which may correspond to the example network(s) 10920. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 11900 of the illustrated example also includes one or more mass storage devices 11928 to store software and/or data. Examples of such mass storage devices 11928 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 11932, which may be implemented by the machine readable instructions of FIGS. 114, 115, 116 and/or 117, may be stored in the mass storage device 11928, in the volatile memory 11914, in the non-volatile memory 11916, and/or on a removable non-transitory computer readable storage medium such as a CD or DVD.

Community License Generation

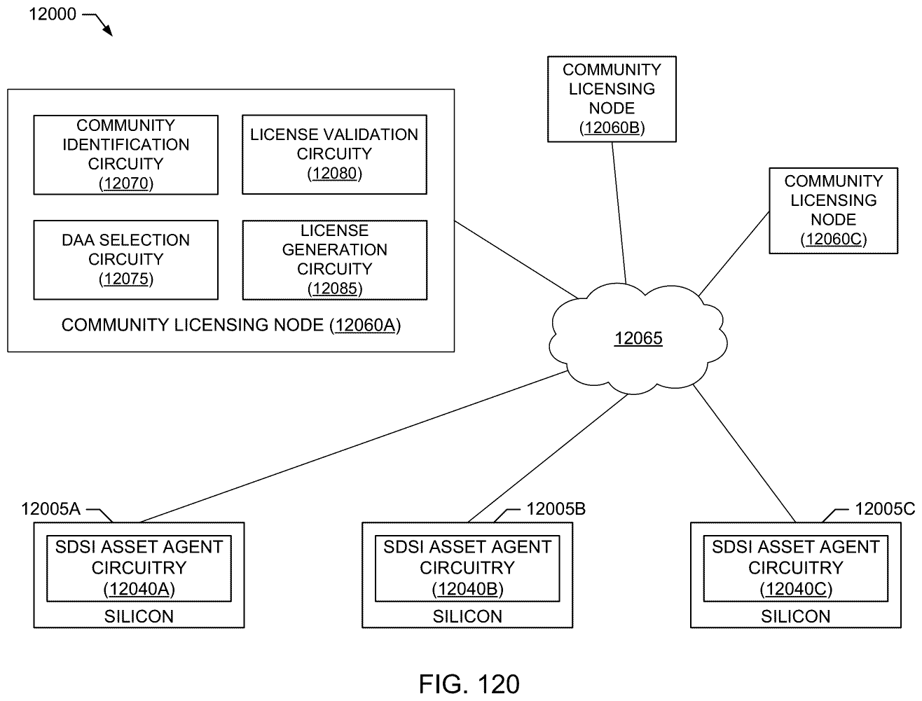

Turning to the figures, FIG. 120 illustrates a block diagram of an example system 12000 that implements community generation of SDSi licenses for SDSi-enabled products, such as the SDSi semiconductor device 105 described above. The example system 12000 of FIG. 120 includes multiple example SDSi semiconductor devices 12005A-C that, as described above, may correspond to any type of silicon products, such as, but not limited to, computer processors, CPUs, IPUs, XPUs, semiconductor chips, silicon hardware devices, etc., as well as circuit boards and/or systems employing such silicon products, etc. In the illustrated example, the SDSi semiconductor devices 12005A-C implement respective SDSi features as described above in connection with the SDSi semiconductor device 105. As such, each one of the SDSi semiconductor devices 12005A-C includes respective SDSi asset agent circuitry 12040A-C, which implement an SDSi asset agent such as the SDSi agent 140 described above.

The example system 12000 of FIG. 120 also includes an example of a community of licensing nodes 12060A-C to implement community generation of SDSi licenses for the SDSi semiconductor devices 12005A-C, as described in further detail below. In the illustrated example of FIG. 120, the SDSi semiconductor devices 12005A-C and the delegated authority agent(s) 12060A-C are in communication with each other via one or more example networks 12065, which may be implemented by any number and/or type(s) of networks, such as a local area network (LAN), a wireless LAN, a cellular network, dedicated communication links—including a dedicated private communication system and protocol, etc., such as the example network 120 described above.

In some examples, the system 12000 can correspond to a customer data center, customer manufacturing center, customer data processing site, etc. In some such examples, the SDSi semiconductor devices 12005A-C can be used to implement servers of the customer data center, and the community licensing nodes 12060A-C can correspond to and/or be implemented by software and/or hardware in the customer data center, customer manufacturing center, customer data processing site, etc. For example, the community licensing nodes 12060A-C can be implemented by software executed by and/or hardware included in one or more compute nodes, such as one or more servers, routers, edge devices, computers, orchestrators, enterprise systems, etc., associated with a customer utilizing the SDSi semiconductor devices 12005A-C. In some examples, one or more of the community licensing nodes 12060A-C is(are) implemented by the SDSi semiconductor devices 12005A-C.

As such, the elements of the example system 12000 of FIG. 120 may be instantiated (e.g., creating an instance of, bring into being for any length of time, materialize, implement, etc.) by processor circuitry such as a central processing unit executing instructions. Additionally or alternatively, the elements of the example system 12000 of FIG. 120 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 120 may, thus, be instantiated at the same or different times. Some or all of the circuitry may be instantiated, for example, in one or more threads executing concurrently on hardware and/or in series on hardware. Moreover, in some examples, some or all of the circuitry of FIG. 120 may be implemented by microprocessor circuitry executing instructions to implement one or more virtual machines and/or containers. Also, although the example system 12000 of FIG. 120 is illustrated as including three SDSi semiconductor devices 12005A-C and three community licensing nodes 12060A-C, the system 12000 can include any number of SDSi semiconductor devices 12005A-C and any number of community licensing nodes 12060A-C.

As indicated above, the example system 12000 implements community generation of SDSi licenses for ones of the SDSi semiconductor devices 12005A-C. In some examples, the network 12065 of the system 12000 isolates and/or otherwise blocks the SDSi semiconductor devices 12005A-C and the community licensing nodes 12060A-C from communicating outside the system 12000. In such examples, the SDSi semiconductor devices 12005A-C are considered land-locked or network-locked, and are unable to access external activation agents and/or resources to obtain SDSi licenses to activate SDSi features supported by the SDSi semiconductor devices 12005A-C. However, at least some prior SDSi licensing solutions rely on licenses being generated and provided by the semiconductor manufacturer, or locally through a secure system owned and managed by the semiconductor manufacturer, which acts as an agent on behalf of the semiconductor manufacturer. But, such prior licensing solutions are problematic where customers have air-gapped or otherwise strictly manage access to the system 12000. If the semiconductor manufacturer is unable to access the SDSi semiconductor devices 12005A-C to enable feature upgrades and interrogate them for the appropriate status information, such prior licensing solutions depend on the customer to provide the required status information, and/or to schedule access to the SDSi semiconductor devices 12005A-C during specific times. Those limitation may result in the customer not being able to upgrade features of the SDSi semiconductor devices 12005A-C, or may require the semiconductor manufacturer to have full trust of the customer but without the ability to verify the customer's actions.

In contrast with such prior solutions, the community licensing nodes 12060A-C of the system 12000 enumerate and establish a local (e.g., intra-datacenter) licensing community with trust and trustworthiness to establish a consensus-based SDSi license generation authority for the purpose of enumerating available SDSi features, understanding previous activation authorization, ensuring compliance, electing a delegation authority agent, provisioning, activating and managing SDSi features, etc. Through a licensing community established by the community licensing nodes 12060A-C, customers can lock down access to their systems 12000 (e.g., their datacenter) by external management entities and still have the ability to upgrade platform features when needed. Furthermore, the semiconductor manufacturer can manage SDSi license distribution according to best business practices and controls, verification, security and providing telemetry and metrics for accounting purposes. However, it should be noted that the community licensing solutions disclosed herein can also be used in scenarios where the system 12000 is not locked down and the SDSi semiconductor devices 12005A-C have external communication access.

In the illustrated example system 12000, the community licensing nodes 12060A-C are implemented with trusted circuitry, such as one or more service processors, one or more sequestered processor, that is trusted and verifiable by the silicon manufacturer. The trusted circuitry can be included in the community licensing nodes 12060A-C at the time of manufacture, and/or provisioned by SDSi feature activation in the field, as disclosed herein. Collectively, the trusted circuitry of the community licensing nodes 12060A-C operates to identify, announce, and integrate the community licensing nodes 12060A-C into a service network, referred to herein as a licensing community. In some examples, this process is autonomic and does not require external intervention or management by the customer or the platform manufacturer.

In the illustrated example, each of the community licensing nodes 12060A-C includes respective trusted circuitry (e.g., a trusted service processor and/or a trusted sequestered processor) which acts as a node-level licensing community manager. In some examples, the trusted circuitry of each of the community licensing nodes 12060A-C implements a southbound interface that provides the ability to reach out to others of the community licensing nodes 12060A-C via the network 12065 to identify and verify their respective trusted circuitry and a licensing community. In the illustrated example, once at least three (or some other (e.g., larger) number of) community licensing nodes 12060A-C are present and included as members of the licensing community, the community licensing nodes 12060A-C of the licensing community collectively elect one of the community licensing nodes 12060A-C to be a delegated authority agent (DAA) capable of acting as a licensing server in the system 12000. In some examples, the DAA functionality on the elected community licensing node 12060A-C is also implemented with that node's trusted circuitry (e.g., the trusted service processor and/or the trusted sequestered processor). The elected community licensing node 12060A-C (also referred to as the DAA of the system 12000) acts as the coordinator for requests from the customer's datacenter (e.g., from an orchestrator and/or other agents operating in the system 12000, from the for SDSi semiconductor devices 12005A-C themselves, etc.) for existing license activations, unclaimed activations, capacity on demand activations, dormant features to describe the landscape, etc.

In the example system 12000, the community licensing nodes 12060A-C each include respective trusted circuitry that includes or otherwise implements respective community identification circuitry, respective DAA selection circuitry, respective license validation circuitry and respective license generation circuitry, which is illustrated as example community identification circuitry 12070, example DAA selection circuitry 12075, example license validation circuitry 12080 and example license generation circuitry 12080 in the example community licensing node 12060A of FIG. 120. In the illustrated example, the community identification circuitry 12070 of the example community licensing node 12060A implements a community identification feature that acquires and validates a licensing community that includes a minimum number of members and a DAA. In some examples, for a licensing community to exist, a minimum number (e.g., three or some other number) of the community licensing nodes 12060A-C with associated trusted circuitry must be present and associated in a licensing community construct. When the minimum number of community members is present and validated as genuine members (e.g., by validating the presence of their respective trusted circuitry), they begin a DAA election process described in further detail below.

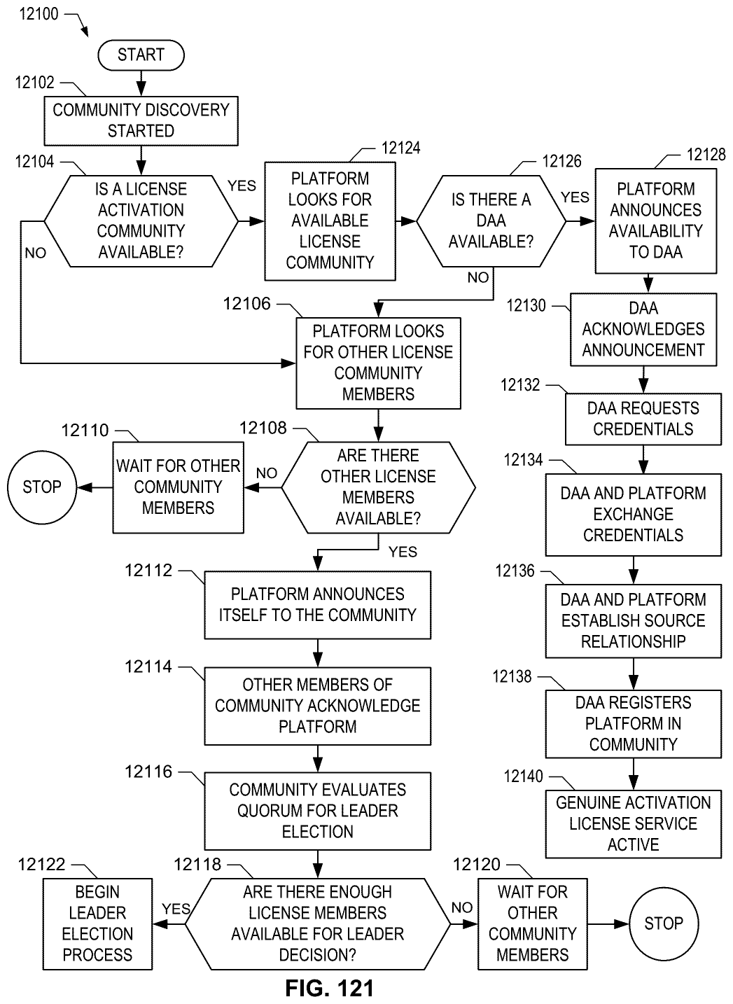

In some examples, when the community licensing node 12060A first arrives in the system 12000 (e.g., when the community licensing node 12060A is powered up, boots and is available on the network 12065), the community identification circuitry 12070 of the community licensing node 12060A searches for an available, established licensing community. If an established licensing community is not available, the community identification circuitry 12070 of the community licensing node 12060A begins searching for other community licensing node 12060B-C to establish a licensing community. When the community identification circuitry 12070 of the community licensing node 12060A finds at least one other community licensing node 12060B-C, the community identification circuitry 12070 establishes a relationship with the community identification circuitry of the other community licensing node 12060B-C to exchange credentials and then continues to wait in a two-member community construct. However, if a two-member community construct is already available when the community licensing node 12060A arrives in the system 12000, then its community identification circuitry 12070 requests membership in the community construct. Once the membership request is approved, the licensing community is formed with the three members and they collectively begin a DAA election procedure. However, if a licensing community is already available when the community licensing node 12060A arrives in the system 12000, then its community identification circuitry 12070 announces itself to the DAA of the established licensing community and establishes a secure relationship with the licensing community to provide license fragment provisioning services, as described in further detail below. Further details concerning operation of the community identification circuitry 12070 are provided below in connection with FIG. 121.

When a licensing community including a minimum number of members, such as the community licensing nodes 12060A-C, is established, the community licensing nodes 12060A-C of the licensing community (e.g., via their respective DAA selection circuitry 12075) collectively proceed with electing one of the community licensing node 12060A-C to be the DAA for the licensing community, as described in further detail below. To help ensure the licensing community has high availability and reliability for the system 12000, and to ensure the stability and quorum of the authorization activities, in some examples the licensing community requires a minimum of five members (or some other number of members greater than a quorum). In the illustrated example, once the minimum number of members is confirmed, the licensing community is established, and secure communication is established among the community licensing nodes 12060A-C in the community. The community licensing nodes 12060A-C in the licensing community then utilize their respective DAA selection circuitry 12075 to begin the DAA election process. For example, the respective DAA selection circuitry 12075 in the community licensing nodes 12060A-C of the licensing community may utilize any collective voting procedure or other election procedure to select the DAA from among the community licensing nodes 12060A-C of the licensing community. In some examples, once the DAA is elected, a service lease time period begins and then the licensing community is able to generate and provision SDSi licenses.

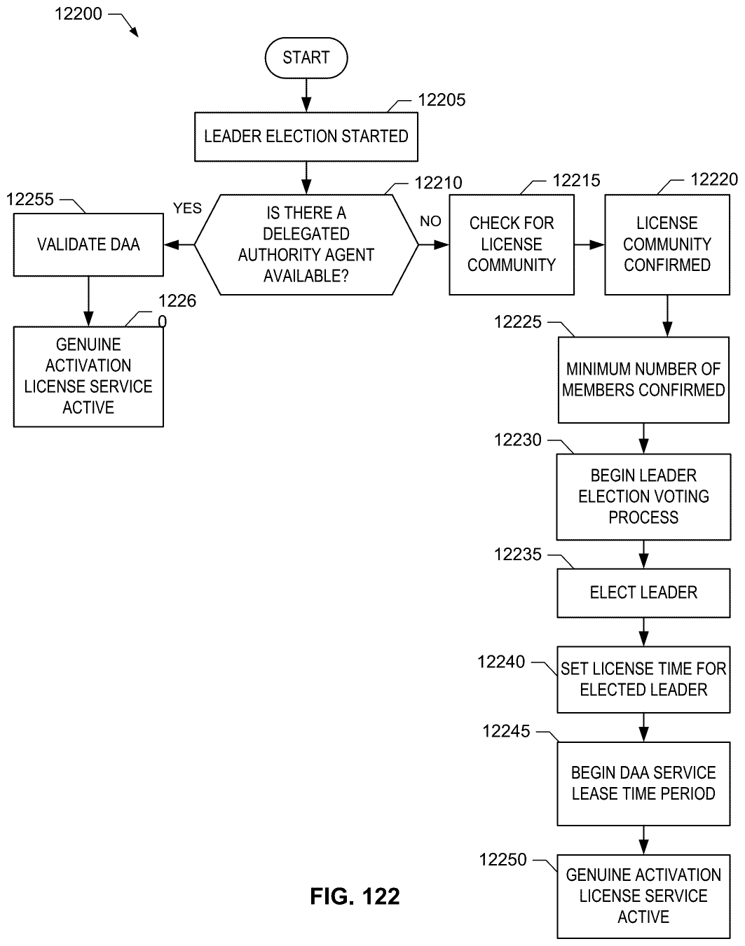

In some examples, when a DAA is not identified, fails to operate or leaves the licensing community, the respective DAA selection circuitry 12075 of the community licensing nodes 12060A-C in the licensing community perform another DAA election, assuming a quorum of members is present in the licensing community. If a quorum is not present, the respective DAA selection circuitry 12075 of the community licensing nodes 12060A-C may invoke the respective community identification circuitry 12070 of the community licensing nodes 12060A-C to form another licensing community that meets the quorum requirements, and then a new DAA is elected. In some examples, when a DAA is not identified or leaves the licensing community, there is no tracking of previous license requests by the other members of the licensing community, so if the DAA becomes unavailable while a license request is being processed composed, that request will need to be resent so the new DAA can process it. In some examples, the licensing community attempts to include more than a quorum of members so that a new DAA can be elected with little to no delay when an existing DAA becomes unavailable. Further details concerning operation of the DAA selection circuitry 12075 are provided below in connection with FIG. 122.

In the illustrated example, the community licensing nodes 12060A-C include respective license validation circuitry 12080 to validate incoming requests for license generation and provisioning (also referred to herein as license requests). For example, assume that the community licensing node 12060A has been elected to be the DAA for a licensing community including the community licensing nodes 12060A-C. In such an example, the DAA selection circuitry 12075 of the community licensing node 12060A advertises itself (e.g., via the network 12065) as the DAA for the system 12000. Incoming SDSi license requests are then sent to the community licensing nodes 12060A and processed by its license validation circuitry 12080. In some examples, the license requests come from the SDSi semiconductor devices 12005A-C. Additionally or alternatively, in some examples, the license requests come from orchestrator(s) and/or other agents operating in the system 12000 on behalf of the SDSi semiconductor devices 12005A-C.

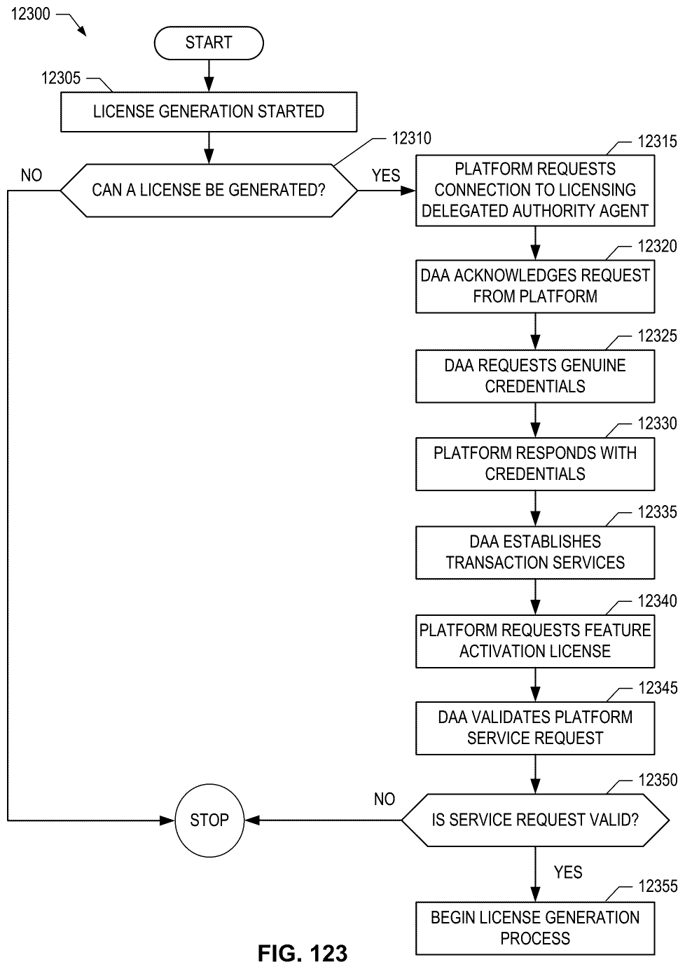

In the illustrated example, the license requests received by the community licensing node 12060A operating as the DAA include credentials to prove that the target one of the SDSi semiconductor devices 12005A-C for which an SDSi license is requested is an authentic, genuine product of the silicon manufacturer. In some examples, the license requests additionally or alternatively include capability information to prove that the target one of the SDSi semiconductor devices 12005A-C for which the SDSi license is requested can supported the SDSi feature(s) associated with the request. In the illustrated example, the license validation circuitry 12080 of the community licensing node 12060A (which is operating as the DAA) receives the incoming license request and attempts to validate the credentials and/or capability information included in or otherwise obtained in association with the request. If the license validation circuitry 12080 determines the license request is valid based on the credentials and/or capability information, the license validation circuitry 12080 then allows license generation to proceed. However, if the license validation circuitry 12080 determines the license request is invalid based on the credentials and/or capability information, the license validation circuitry 12080 denies the license request and, in some examples, severs its connection with the requestor (e.g., in the case that the requestor is the target SDSi semiconductor device itself). Further details concerning operation of the license validation circuitry 12080 are provided below in connection with FIG. 123.

In the illustrated example, the community licensing nodes 12060A-C include respective license generation circuitry 12085 to generate SDSi licenses responsive to validated license requested. For example, assume that the community licensing node 12060A has been elected to be the DAA for a licensing community including the community licensing nodes 12060A-C, and an incoming license request has been validated. In such an example, the license generation circuitry 12085 of the community licensing node 12060A causes an appropriate SDSi license to be generated responsive to the validated license request.

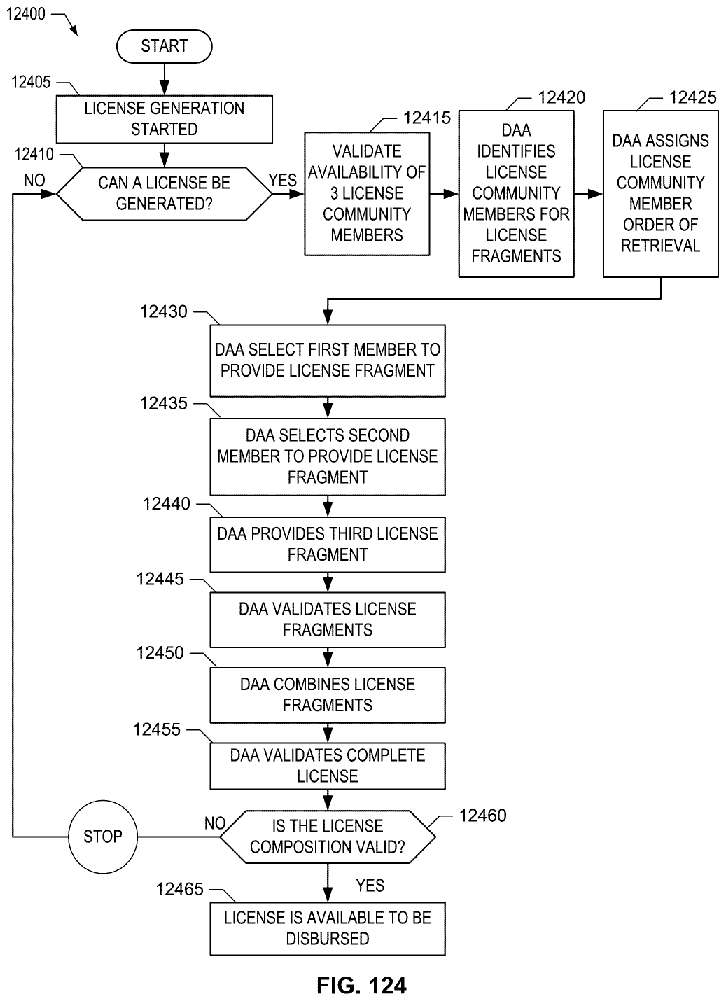

In some examples, the SDSi licenses generated by the licensing community of the system 12000 are composed of three components/parts (or some other number of components/parts), where each component/part is unusable as a license by itself. Furthermore, in some such examples, each one of the community licensing nodes 12060A-C included in the licensing community possesses two components/parts (or some other subset of components/parts) of the complete SDSi licenses, with the two components/parts (or other subset of components/parts) again being unusable by themselves. However, when a quorum of community licensing nodes 12060A-C is present in the licensing community, their respective license generation circuitry 12085 are each able to serve a corresponding component/part of the requested SDSi license, which are assembled by the license generation circuitry 12085 of the DAA (the community licensing node 12060A in the illustrate example) to generate the complete SDSi license responsive to the request. As such, in some examples, the license generation circuitry 12085 of the DAA (the community licensing node 12060A in the illustrate example) initiates license generation by requesting license components/parts from others of the community licensing nodes 12060A-C in the licensing community. In some examples, the license generation circuitry 12085 of the DAA also generates one of the components/parts, and combines the obtained set of license components/parts into the complete SDSi license to be returned in response to the license request. In this way, the respective license generation circuitry 12085 of the community licensing nodes 12060A-C included in the licensing community form a local license authority that can generate SDSi licenses to activate SDSi features in trusted silicon products. Further details concerning operation of the license generation circuitry 12085 are provided below in connection with FIG. 124.

In some examples, after an SDSi license is generated and provisioned to a target SDSi semiconductor device 12005A-C, the license generation circuitry 12085 of the DAA (the community licensing node 12060A in the illustrate example) begins to search for a customer on-premise reconciliation/billing service to announce metering data for the SDSi feature(s) to be activated based on that license (e.g., for validation/billing purposes). In some examples, the customer's billing service is required to respond, in a timely basis, to a query by the DAA and authenticate the access to the service to ensure that the reconciliation/billing service is active and accessible. If such a customer service is not available or expressly limited by the customer, then the license generation circuitry 12085 of the DAA (the community licensing node 12060A in the illustrate example) may throttle or withdraw the SDSi license, thereby causing deactivation of the associated SDSi feature(s) in the target SDSi semiconductor device 12005A-C.

In some examples, proximity of the community licensing nodes 12060A-C can be leveraged to improve communication between and/or authentication of the members of a licensing community. For example, a timing component may be included in the community establishment and/or DAA election procedures described herein. Through use of a timing component, other community licensing node(s) that are remote to the system 12000 could be excluded from joining a licensing community associated with the system 12000 by virtue of not completing the community establishment procedure or the DAA election procedure within a specified time constraint. Physical placement of the community licensing nodes 12060A-C (e.g., such as whether the nodes are in the same server blade, the same rack, the same data center, the same region, etc.) could additionally or alternatively be used as constraints for excluding community licensing node(s) from a licensing community associated with the system 12000. Such constraints can help ensure that the community licensing nodes 12060A-C included in a licensing community associated with the system 12000 have response times and accessibility performance to meet service level agreement (SLA) targets.

While an example manner of implementing the system 12000 is illustrated in FIG. 120, one or more of the elements, processes, and/or devices illustrated in FIG. 120 may be combined, divided, re-arranged, omitted, eliminated, and/or implemented in any other way. Further, the example SDSi semiconductor devices 12005A-C, the example SDSi asset agent circuitry 12040A-C, the example community licensing nodes 12060A-C, the example network 12065, the example community identification circuitry 12070, the example DAA selection circuitry 12075, the example license validation circuitry 12080, the example license generation circuitry 12080 and/or, more generally, the example system 12000 of FIG. 120, may be implemented by hardware alone or by hardware in combination with software and/or firmware. Thus, for example, any of the example SDSi semiconductor devices 12005A-C, the example SDSi asset agent circuitry 12040A-C, the example community licensing nodes 12060A-C, the example network 12065, the example community identification circuitry 12070, the example DAA selection circuitry 12075, the example license validation circuitry 12080, the example license generation circuitry 12080 and/or, more generally, the example system 12000, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example system 12000 may include one or more elements, processes, and/or devices in addition to, or instead of, those illustrated in FIG. 120, and/or may include more than one of any or all of the illustrated elements, processes and devices.

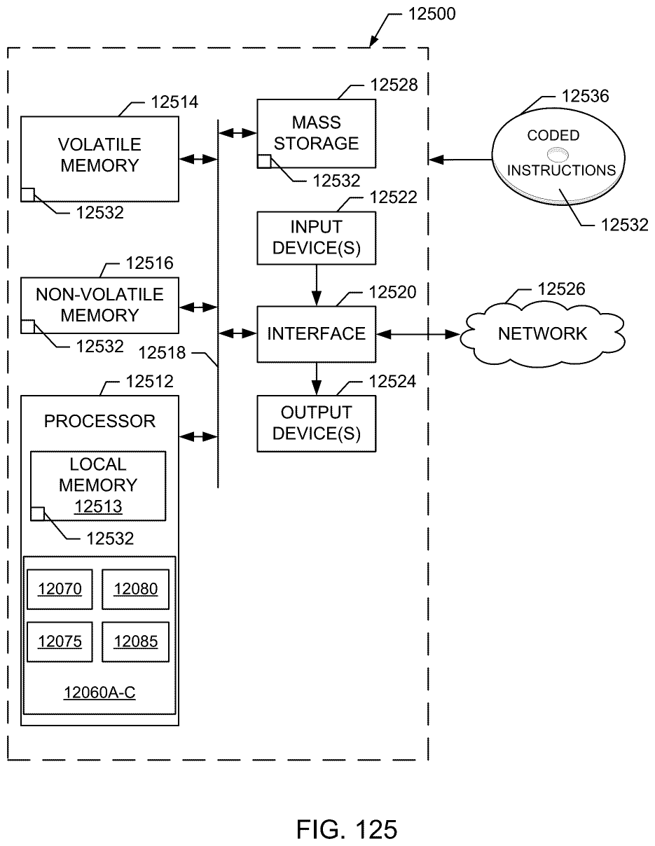

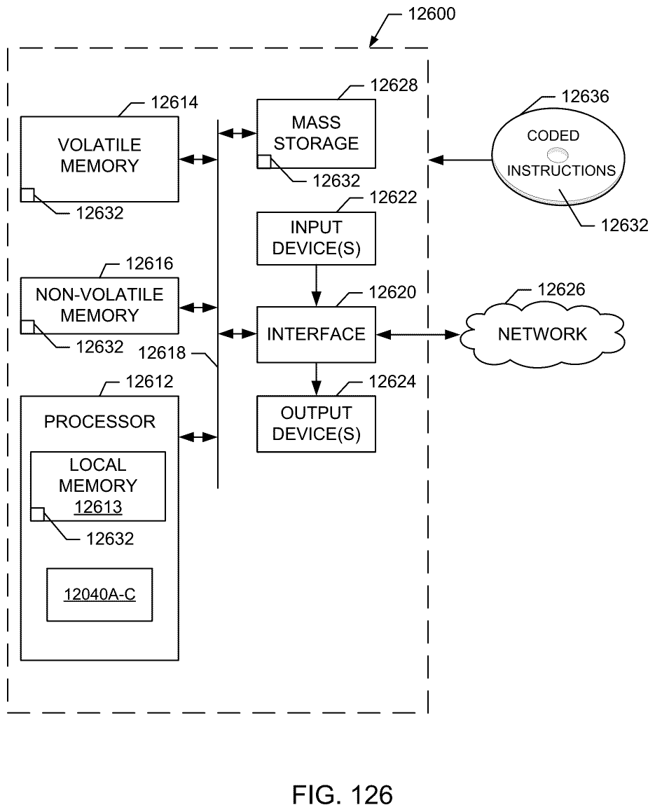

Flowcharts representative of example machine readable instructions which may be executed to configure processor circuitry to implement the example system 12000 are shown in FIGS. 121-124. The machine readable instructions may be one or more executable programs or portion(s) of an executable program for execution by processor circuitry, such as the processor circuitry 12512 and/or 12612 shown in the example processor platforms 12500 and/or 12600 discussed below in connection with FIG. 125 and FIG. 126 and/or the example processor circuitry discussed below in connection with FIGS. 150 and/or 151. The program(s) may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program(s) and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program(s) is(are) described with reference to the flowcharts illustrated in FIGS. 121-124, many other methods of implementing the example system 12000 may alternatively be used. For example, the order of execution of the blocks may be changed, and/or some of the blocks described may be changed, eliminated, combined and/or subdivided into multiple blocks. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 121-124 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc. Also, as used herein, the terms “computer readable” and “machine readable” are considered equivalent unless indicated otherwise.

FIGS. 121-124 are flowcharts representative of example implementations of the example community identification circuitry 12070, the example DAA selection circuitry 12075, the example license validation circuitry 12080, and the example license generation circuitry 12085 of the example community licensing node 12060A disclosed herein. In particular, FIG. 121 is a flowchart representative of example machine readable instructions and/or example operations 12100 that may be executed and/or instantiated by processor circuitry to implement an example community identification procedure with the example community identification circuitry 12070 of the example community licensing node 12060A disclosed above. With reference to the preceding figures and associated written descriptions, the machine readable instructions and/or the operations 12100 of FIG. 121 begin at block 12105 at which the community identification circuitry 12070 employs any appropriate search procedure(s) to identify a collection of community licensing nodes already forming a licensing community in the example system 12000, as described above. At block 12104, the community identification circuitry 12070 determines whether licensing community is available. If a licensing community is not available (corresponding to the “NO” output from block 12104), then at block 12106 the community identification circuitry 12070 employs any appropriate search procedure(s) to identify one or more other community licensing nodes with which to form a licensing community. At block 12104, the community identification circuitry 12070 determines whether another community licensing node is available. If another community licensing node is not available (corresponding to the “NO” output of block 12108), at block 12110 the community identification circuitry 12070 waits for other community licensing node(s) to join the system 12000. In some examples, the machine readable instructions and/or operations 12100 then end, and will be restarted later by the community identification circuitry 12070 to continue attempting to generate a licensing community.

If another community licensing node is available (corresponding to the “YES” output of block 12108), at block 12112 the community identification circuitry 12070 announces itself to the other found community licensing node(s). At block 12114, the community identification circuitry 12070 confirms its announcement has been acknowledged by the other community licensing node(s) and also acknowledges those other community licensing node(s) in return. At block 12116, the community identification circuitry 12070 of the community licensing node 12060 cooperates with the community identification circuitry of the other community licensing node(s) to evaluate whether a quorum (e.g., three or some other number) of community licensing nodes are present. At block 12118, the community identification circuitry 12070 determine whether the evaluation indicates a quorum is present. If a quorum is not present (corresponding to the “NO” output of block 12118), at block 12120 the community identification circuitry 12070 waits for other community licensing node(s) to join the system 12000 to form a quorum. In some examples, the machine readable instructions and/or operations 12100 then end, and will be restarted later by the community identification circuitry 12070 to continue attempting to generate a licensing community. However, if a quorum of community licensing nodes is available (corresponding to the “YES” output of block 12118), at block 12122 the community identification circuitry 12070 invokes the DAA selection circuitry 12075 of the community licensing node 12060A to initiate a DAA selection procedure. An example of such a DAA selection procedure is illustrated in FIG. 122, which is described in further detail below.

Returning to block 12104, if a licensing community is available (corresponding to the “YES” output from block 12104), then at block 12124 the community identification circuitry 12070 determines searches for an elected DAA in the licensing community. At block 12126, the community identification circuitry 12070 determines whether an elected DAA was found. If an elected DAA is not found (corresponding to the “NO” output from block 12126), then control proceeds to block 12106 and block subsequent thereto at which the community identification circuitry 12070 attempts to form a licensing community with an elected DAA, as described above.

However, if an elected DAA is not found (corresponding to the “YES” output from block 12126), then at block 12128 the community identification circuitry 12070 announces the community licensing node 12060A to the community licensing node serving as the DAA in the licensing community. At block 12130, the community identification circuitry 12070 confirms its announcement was acknowledged by the DAA. At block 12132, the community identification circuitry 12070 receives a request from the DAA for credentials of the community licensing node 12060A (e.g., to prove that the community licensing node 12060A is a genuine, trusted silicon product from the silicon manufacturer). At block 12134, the community identification circuitry 12070 exchanges credentials with the DAA. Assuming the credentials are valid, at block 12136 the community identification circuitry 12070 establishes a secure relationship between the community licensing node 12060A and the DAA. At block 12138, the DAA registers the community licensing node 12060A with the existing licensing community in the system 12000. At block 12140, the community identification circuitry 12070 invokes the license generation circuitry 12085 of the community licensing node 12060A to participate in the licensing community of the system 12000. In some examples, the machine readable instructions and/or operations 12100 then end.

FIG. 122 is a flowchart representative of example machine readable instructions and/or example operations 12200 that may be executed and/or instantiated by processor circuitry to implement an example DAA selection procedure with the example DAA selection circuitry 12075 of the example community licensing node 12060A disclosed above. With reference to the preceding figures and associated written descriptions, the machine readable instructions and/or the operations 12200 of FIG. 122 begin at block 12205 at which the DAA selection circuitry 12075 initiates DAA election among the community licensing node included in the licensing community of the system 12000. At block 12210, the DAA selection circuitry 12075 determines whether a DAA has already been elected in the licensing community. If a DAA has not been elected (corresponding to the “NO” output from block 12210), then at block 12215 the DAA selection circuitry 12075 checks that a licensing community still exists in the system 12000 (e.g., by determining whether at least one other community licensing node present in the system 12000). Assuming a licensing community exists, at block 12220 the DAA selection circuitry 12075 confirms the presence of the licensing community in the system 12000.

Next, at block 12225, the DAA selection circuitry 12075 determines whether a quorum of community licensing nodes is present in the licensing community. Assuming a quorum is present, at block 12230, the DAA selection circuitry 12075 initiates a DAA election process in combination with the DAA selection circuitry of the other community licensing nodes in the licensing community. At block 12235, the DAA selection circuitry 12075 evaluates the election results to identify the particular community licensing node that has been elected to be the DAA for the licensing community. In some examples, assuming the community licensing node 12006A was elected such that the DAA selection circuitry 12075 is associated with the DAA, at block 12240 the DAA selection circuitry 12075 sets a lease time (or other time duration) during which the community licensing node 12006A will operate as the DAA for the licensing community in the system 12000. At block 12245, the DAA selection circuitry 12075 monitors the lease time (or other time period) such that, when the lease time (or other time duration) expires in the future, the DAA selection circuitry 12075 will cause the community licensing node 12006A to relinquish its role as the DAA.) At block 12250, the DAA selection circuitry 12075 invokes the license validation circuitry 12080 and the license generation circuitry 12085 of the community licensing node 12060A to permit the community licensing node 12006A to operate as the DAA for the licensing community and generate/provision SDSi licenses in the system 12000. In some examples, the machine readable instructions and/or operations 12200 then end.

Returning to block 12210, if a DAA has been elected (corresponding to the “YES” output from block 12210), then at block 12255 the DAA selection circuitry 12075 exchanges credential with the existing DAA to validate itself with the DAA (e.g., to prove that the community licensing node 12060A is a genuine, trusted silicon product from the silicon manufacturer). At block 12260, the DAA selection circuitry 12075 invokes the license generation circuitry 12085 of the community licensing node 12060A to participate in the licensing community of the system 12000. In some examples, the machine readable instructions and/or operations 12200 then end.

FIG. 123 is a flowchart representative of example machine readable instructions and/or example operations 12300 that may be executed and/or instantiated by processor circuitry to implement an example license validation procedure with the example license validation circuitry 12080 of the example community licensing node 12060A disclosed above. With reference to the preceding figures and associated written descriptions, the machine readable instructions and/or the operations 12300 of FIG. 123 begin at block 12305 at which the license validation circuitry 12080 checks whether the community licensing node 12060A is permitted to operate as the DAA for the licensing community and cause SDSi licenses to be generated/provisioned in the system 12000. At block 12310, the license validation circuitry 12080 determines whether the community licensing node 12060A is permitted to operate as the DAA. If the community licensing node 12060A is not permitted to operate as the DAA (corresponding to the “NO” output from block 12310), then the machine readable instructions and/or operations 12300 then end.

However, if the community licensing node 12060A is permitted to operate as the DAA (corresponding to the “YES” output from block 12310), then at block 12315 the license validation circuitry 12080 receives a connection request from a target SDSi semiconductor device 12005A-C in the system 12000 (or from an orchestrator or other agent operating on behalf of the target SDSi semiconductor device 12005A-C). At block 12320, the license validation circuitry 12080 acknowledges the connection request. At block 12325, the license validation circuitry 12080 requests credentials from the target SDSi semiconductor device 12005A-C (or from the orchestrator or other agent operating on behalf of the target SDSi semiconductor device 12005A-C) to verify that the target SDSi semiconductor device 12005A-C is a genuine, trusted silicon product of the semiconductor manufacturer. At block 12330, the license validation circuitry 12080 receives the credentials for the target SDSi semiconductor device 12005A-C. Assuming the credentials are valid, at block 435 the license validation circuitry 12080 establishes a connection with the target SDSi semiconductor device 12005A-C (or with the orchestrator or other agent operating on behalf of the target SDSi semiconductor device 12005A-C) via which license requests can be made.

At block 12340, the license validation circuitry 12080 receives a license request associated with a target SDSi semiconductor device 12005A-C in the system 12000 (e.g., which may be received from the target SDSi semiconductor device 12005A-C itself or from the orchestrator or other agent operating on behalf of the target SDSi semiconductor device 12005A-C). At block 12345, the license validation circuitry 12080 validates the license request (e.g., by comparing capability information for the target SDSi semiconductor device 12005A-C with the SDSi feature(s) associated with the licensing request). At block 12350, the license validation circuitry 12080 determines whether the license request is valid. If the license request is invalid (corresponding to the “NO” output from block 12350), then the machine readable instructions and/or operations 12300 then end. However, if the license request is valid (corresponding to the “YES” output from block 12350), then at block 12355 the license validation circuitry 12080 invokes the license generation circuitry 12080 of the example community licensing node 12060A to generate the requested SDSi license. An example of such a license generation procedure is illustrated in FIG. 124, which is described in further detail below.

FIG. 124 is a flowchart representative of example machine readable instructions and/or example operations 12400 that may be executed and/or instantiated by processor circuitry to implement an example license generation procedure with the example license generation circuitry 12085 of the example community licensing node 12060A disclosed above. With reference to the preceding figures and associated written descriptions, the machine readable instructions and/or the operations 12400 of FIG. 124 begin at block 12405 at which the license generation circuitry 12085 checks whether the community licensing node 12060A is permitted to operate as the DAA for the licensing community and cause SDSi licenses to be generated/provisioned in the system 12000. At block 12410, the license generation circuitry 12085 determines whether the community licensing node 12060A is permitted to operate as the DAA. If the community licensing node 12060A is not permitted to operate as the DAA (corresponding to the “NO” output from block 12410), then the machine readable instructions and/or operations 12400 then end.

However, if the community licensing node 12060A is permitted to operate as the DAA (corresponding to the “YES” output from block 12410), then at block 12415 the license generation circuitry 12085 validates that a quorum of community licensing nodes 12060A-C are present in the licensing community of the system 12000. Assuming a quorum is present, at block 12420 the license generation circuitry 12085 identifies the ones of the licensing community members (e.g., the ones of the community licensing nodes 12060A-C in the licensing community) that are to provide fragments to be assembled into a requested SDSi license. At block 12425, the license generation circuitry 12085 assigns an order in which to retrieve the license fragments from the identified ones of the licensing community members.

The illustrated example of FIG. 124 assumes that three licensing community members have been identified to each provide a single fragment of the requested SDSi license. Thus, at blocks 12430, 12435 and 12440, the license generation circuitry 12085 obtains the respective license fragments from the three licensing community members in the order assigned at block 12425. At block 12445, the license generation circuitry 12085 validates the license fragments received at blocks 12430, 12435 and 12440 (e.g., to determine that none of the license fragments have been corrupted). At block 12450, the license generation circuitry 12085 assembles the license fragments into a complete license. At block 12455, the license generation circuitry 12085 validates the complete license (e.g., to determine that the different license fragments are the proper ones to form a complete license). At block 12460, the license generation circuitry 12085 determines whether the complete license is valid. If the complete license is not valid (corresponding to the “NO” output from block 12460), then the machine readable instructions and/or operations 12400 then end. However, if the complete license is valid (corresponding to the “YES” output from block 12460), then at block 12465 the license generation circuitry 12085 returns the generated SDSi license in response to the request.

FIG. 125 is a block diagram of an example processor platform 12500 structured to execute and/or instantiate the machine readable instructions and/or the operations of FIGS. 121, 122, 123 and/or 124 to implement one or more of the example community licensing nodes 12060A-C of FIG. 120. The processor platform 12500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 12500 of the illustrated example includes processor circuitry 12512. The processor circuitry 12512 of the illustrated example is hardware. For example, the processor circuitry 12512 can be implemented by one or more integrated circuits, logic circuits, FPGAs, microprocessors, CPUs, GPUs, DSPs, and/or microcontrollers from any desired family or manufacturer. The processor circuitry 12512 may be implemented by one or more semiconductor based (e.g., silicon based) devices. In this example, the processor circuitry Y912 implements one or more of the example community identification circuitry 12070, the example DAA selection circuitry 12075, the example license validation circuitry 12080, and/or the example license generation circuitry 12085 of the one or more example community licensing nodes 12060A-C implemented by the example system 12500.

The processor circuitry 12512 of the illustrated example includes a local memory 12513 (e.g., a cache, registers, etc.). The processor circuitry 12512 of the illustrated example is in communication with a main memory including a volatile memory 12514 and a non-volatile memory 12516 by a bus 12518. The volatile memory 12514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 12516 may be implemented by flash memory and/or any other desired type of memory device. Access to the main memory 12514, 12516 of the illustrated example is controlled by a memory controller 12517.

The processor platform 12500 of the illustrated example also includes interface circuitry 12520. The interface circuitry 12520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 12522 are connected to the interface circuitry 12520. The input device(s) 12522 permit(s) a user to enter data and/or commands into the processor circuitry 12512. The input device(s) 12522 can be implemented by, for example, an audio sensor, a microphone, a camera (still or video), a keyboard, a button, a mouse, a touchscreen, a track-pad, a trackball, a trackbar, an isopoint device, a voice recognition system and/or any other human-machine interface. In some examples, the input device(s) 12522 are arranged or otherwise configured to allow the user to control the processor platform 12500 and provide data to the processor platform 12500 using physical gestures, such as, but not limited to, hand or body movements, facial expressions, face recognition, etc.

One or more output devices 12524 are also connected to the interface circuitry 12520 of the illustrated example. The output device(s) 12524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 12520 of the illustrated example, thus, typically includes a graphics driver card, a graphics driver chip, and/or graphics processor circuitry such as a GPU.

The interface circuitry 12520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 12526. The communication can be by, for example, an Ethernet connection, a digital subscriber line (DSL) connection, a telephone line connection, a coaxial cable system, a satellite system, a line-of-site wireless system, a cellular telephone system, an optical connection, etc. In some examples, the network 12526 implements the example network 12065 of FIG. 120.

The processor platform 12500 of the illustrated example also includes one or more mass storage devices 12528 to store software and/or data. Examples of such mass storage devices 12528 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 12532, which may be implemented by the machine readable instructions of FIGS. 121, 122, 123 and/or 124, may be stored in the mass storage device 12528, in the volatile memory 12514, in the non-volatile memory 12516, and/or on a removable non-transitory computer readable storage medium such as a CD or DVD.

FIG. 126 is a block diagram of an example processor platform 12600 structured to execute and/or instantiate the machine readable instructions and/or the operations of FIGS. 121, 122, 123 and/or 124 to implement one or more of the example SDSi semiconductor devices 12005A-C of FIG. 120. The processor platform 12600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 12600 of the illustrated example includes processor circuitry 12612. The processor circuitry 12612 of the illustrated example is hardware. For example, the processor circuitry 12612 can be implemented by one or more integrated circuits, logic circuits, FPGAs, microprocessors, CPUs, GPUs, DSPs, and/or microcontrollers from any desired family or manufacturer. The processor circuitry 12612 may be implemented by one or more semiconductor based (e.g., silicon based) devices. In this example, the processor circuitry 12612 implements one or more of the SDSi asset agent circuitry 12040A-C of the one or more SDSi semiconductor devices 12005A-C implemented by the example system 12600.

The processor circuitry 12612 of the illustrated example includes a local memory 12613 (e.g., a cache, registers, etc.). The processor circuitry 12612 of the illustrated example is in communication with a main memory including a volatile memory 12614 and a non-volatile memory 12616 by a bus 12618. The volatile memory 12614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 12616 may be implemented by flash memory and/or any other desired type of memory device. Access to the main memory 12614, 12616 of the illustrated example is controlled by a memory controller 12617.

The processor platform 12600 of the illustrated example also includes interface circuitry 12620. The interface circuitry 12620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 12622 are connected to the interface circuitry 12620. The input device(s) 12622 permit(s) a user to enter data and/or commands into the processor circuitry 12612. The input device(s) 12622 can be implemented by, for example, an audio sensor, a microphone, a camera (still or video), a keyboard, a button, a mouse, a touchscreen, a track-pad, a trackball, a trackbar, an isopoint device, a voice recognition system and/or any other human-machine interface. In some examples, the input device(s) 12622 are arranged or otherwise configured to allow the user to control the processor platform 12600 and provide data to the processor platform 12600 using physical gestures, such as, but not limited to, hand or body movements, facial expressions, face recognition, etc.

One or more output devices 12624 are also connected to the interface circuitry 12620 of the illustrated example. The output device(s) 12624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 12620 of the illustrated example, thus, typically includes a graphics driver card, a graphics driver chip, and/or graphics processor circuitry such as a GPU.

The interface circuitry 12620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 12626. The communication can be by, for example, an Ethernet connection, a digital subscriber line (DSL) connection, a telephone line connection, a coaxial cable system, a satellite system, a line-of-site wireless system, a cellular telephone system, an optical connection, etc. In some examples, the network 12626 implements the example network 12065 of FIG. 120.

The processor platform 12600 of the illustrated example also includes one or more mass storage devices 12628 to store software and/or data. Examples of such mass storage devices 12628 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 12632, which may be implemented by the machine readable instructions of FIGS. 121, 122, 123 and/or 124, may be stored in the mass storage device 12628, in the volatile memory 12614, in the non-volatile memory 12616, and/or on a removable non-transitory computer readable storage medium such as a CD or DVD.

Expirable SDSi Licenses via a Reliable Clock

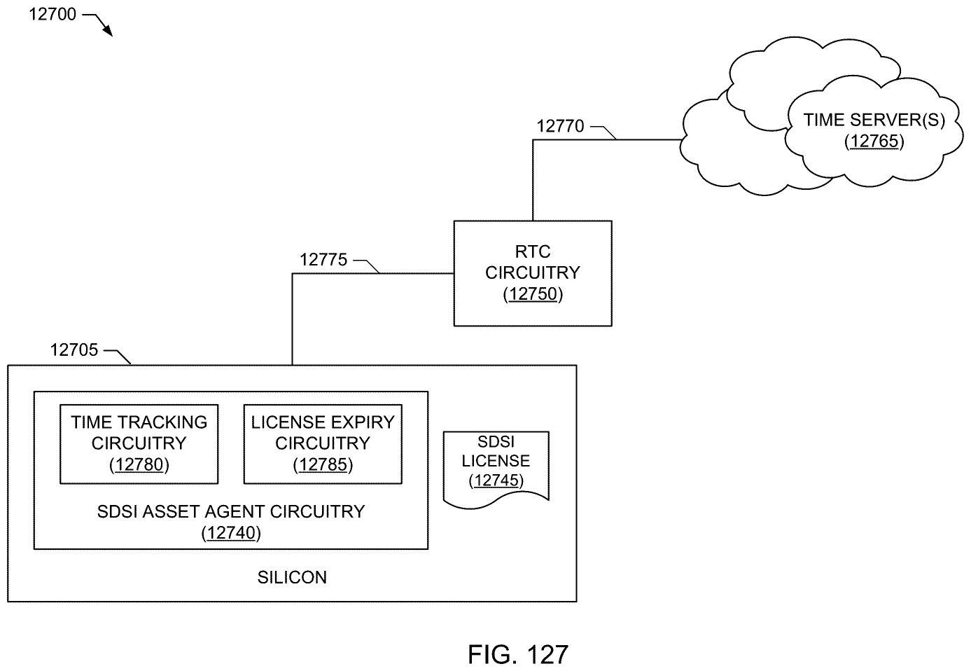

Turning to the figures, FIG. 127 illustrates a block diagram of an example system 12700 that implements time-based expiration of SDSi licenses in SDSi-enabled products, such as the SDSi semiconductor device 105 described above. The example system 12700 of FIG. 127 includes an example SDSi semiconductor device 12705 that, as described above, may correspond to any type of silicon product, such as, but not limited to, a computer processor, a CPU, an IPU, an XPU, a semiconductor chip, a silicon hardware device, etc., as well as a circuit board and/or a system employing such silicon products, etc. In the illustrated example, the SDSi semiconductor device 12705 implements SDSi features as described above in connection with the SDSi semiconductor device 105. As such, the SDSi semiconductor device includes example SDSi asset agent circuitry 12740, which implements an SDSi asset agent such as the SDSi agent 140 described above. The SDSi asset agent circuitry 12740 also implements time-based expiration of SDSi licenses, such as an example SDSi license 12745, assigned to the SDSi semiconductor device 12705, as described in further detail below.

The example system 12700 of FIG. 127 also includes example real-time clock (RTC) circuitry 12755 and one or more example time servers 12765 to implement time-based expiration of SDSi licenses, such as the SDSi license 12745, assigned to the SDSi semiconductor device 12705, as described in further detail below. In the illustrated example of FIG. 127, the RTC circuitry 12755 can be implemented by any circuitry, device, etc., structured to track actual calendar time at a resolution (e.g., 1 second, 1 minute) sufficient to provide an expiration trigger for the SDSi license 12745. In some examples, the RTC circuitry 12755 is implemented in a device, such as a clock, that is separate from the SDSi semiconductor device 12705, as shown in FIG. 127. However, in some examples, the RTC circuitry 12755 is included in the SDSi semiconductor device 12705. For example, the RTC circuitry 12755 can be included in the SDSi asset agent circuitry 12740, can be separate from the SDSi asset agent circuitry 12740, etc.

In the illustrated example, the time servers 12765 can correspond to a central time service or a local time service capable of initializing the RTC circuitry 12755 to any degree of accuracy sufficient to provide the expiration trigger for the SDSi license 12745. For example, the time server(s) 12765 can correspond to a central time service that is accessible via the Internet and calibrated with an atomic clock or other reliable time source. As such, in the illustrated example, the RTC circuitry 12755 communicates with the time servers 12765 via an example communication path 12770. The communication path 12770 can be implemented by any type of communication path, link, network, etc. In some examples, the communication path 12770 is a secure communication path established between the RTC circuitry 12755 and the time server(s) 12765 via one or more security protocols to prevent a rogue actor from intercepting and changing the time information served by the time server(s) 12765 to the RTC circuitry 12755 in an attempt to circumvent time-based expiration of the SDSi license 12745. Additionally or alternatively, in the illustrated example, the SDSi semiconductor device 12705 communicates with the RTC circuitry 12755 via an example communication path 12775, which can be implemented by any type of communication path, link, network, etc. In some examples, the communication path 12775 is a secure communication path established between the SDSi semiconductor device 12705 and the RTC circuitry 12755 via one or more security protocols to prevent a rogue actor from intercepting and changing the time information output by the RTC circuitry 12755 to the SDSi semiconductor device 12705 in an attempt to circumvent time-based expiration of the SDSi license 12745.

As such, the elements of the example system 12700 of FIG. 127 may be instantiated (e.g., creating an instance of, bring into being for any length of time, materialize, implement, etc.) by processor circuitry such as a central processing unit executing instructions. Additionally or alternatively, the elements of the example system 12700 of FIG. 127 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 127 may, thus, be instantiated at the same or different times. Some or all of the circuitry may be instantiated, for example, in one or more threads executing concurrently on hardware and/or in series on hardware. Moreover, in some examples, some or all of the circuitry of FIG. 127 may be implemented by microprocessor circuitry executing instructions to implement one or more virtual machines and/or containers. Also, although the example system 12700 of FIG. 127 is illustrated as including one SDSi semiconductor device 12705, one instance of RTC circuitry 12755, and three time server(s) 12765 the system 12700 can include any number of SDSi semiconductor devices 12705, any number of instances of RTC circuitry 12755, and any number of time server(s) 127.

As indicated above, the example system 12700 implements time-based expiration of SDSi licenses assigned to the SDSi semiconductor device 12705. Unlike prior silicon devices that may not have access to a reliable real-time clock source and, thus, are unable to support timed licenses, in the example system 12700 of FIG. 127, the SDSi semiconductor device 12705 is able to access the RTC circuitry 12755, which provides a reliable real-time clock source that can be used to implement timed licenses. Moreover, in some examples, the real-time values (e.g., calendar values) output from the RTC circuitry 12755 are trustworthy and tamper-proof, thereby instilling confidence in silicon manufacturers and customers that any timed licenses assigned to the SDSi semiconductor device 12705 will be handled properly and expire at the appropriate time. As such, time-based expiration of timed licenses as disclosed herein provides an interference free, set and forget capability for perform SDSi feature upgrades on the SDSi semiconductor device 12705.

In the illustrated example of FIG. 127, the SDSi semiconductor device 12705 (e.g., via its SDSi asset agent circuitry 12740) implements the SDSi license 12745 as an expirable, or timed, license that expires after a particular calendar time is reached. For example, the SDSi license 12745 can be specified to expire at a particular date and time. In the illustrated example of FIG. 127, the RTC circuitry 12755 is a device or circuit that outputs real-time values, also referred to as calendar time values, that correspond to a particular calendar date and time of day. As noted above, in some examples, the RTC circuitry 12755 is included in the SDSi semiconductor device 12705 (e.g., via its SDSi asset agent circuitry 12740). However, in some examples, the RTC circuitry 12755 is separate from the SDSi semiconductor device 12705. For example, the RTC circuitry 12755 can be a clock or other device that is part of a compute platform including the SDSi semiconductor device 12705, or a clock or other device that is part of a data center, or even a service accessible outside of the data center, etc.

In the illustrated example, the time server(s) 12765 implement a central time service capable of initializing and maintaining the RTC circuitry 12755 to a specified degree of accuracy (e.g., 1 millisecond or some other accuracy resolution). In some examples, the time server(s) 12765 can be a single server or a community of servers connected through blockchain or similar mechanisms to ensure there is no single point of failure. Likewise, in some examples, the RTC circuitry 12755 can be implemented by multiple RTC devices that form a blockchain or similar network that provides an authenticated and accurate real-time clock service.

In some examples, the RTC circuitry 12755 implements a certificate mechanism that affirms the real-time clock data (e.g., calendar time data) output from the RTC circuitry 12755 is accurate to a specified degree of accuracy (e.g., 1 millisecond or some other accuracy resolution). In some examples, the RTC circuitry 12755 implements the certificate mechanism in conjunction with the time server(s) 12765 and/or the SDSi semiconductor device 12705 (e.g., via its SDSi asset agent circuitry 12740). In some examples, mechanisms based on non-fungible tokens (NFTs) are used to implement certification of the real-time clock data (e.g., calendar time data) output from the RTC circuitry 12755.

In the illustrated example of FIG. 127, the system 12700 includes the communication path 12770 between the RTC circuitry 12755 and the time server(s) 12765, and the communication path 12775 between the SDSi semiconductor device 12705 and the RTC circuitry 12755. In the illustrated example, the communication path 12770 and the communication path 12775 are secure. For example, such secure connections are verifiable using a platform root of trust (e.g., implemented by a trusted platform module (TPM) device and/or other security service).

In an example process flow to implement expirable licenses in the system 12700 using the reliable clock provided by the RTC circuitry 12755, the RTC circuitry 12755 communicates (e.g., periodically, based on one or more trigger event, according to a schedule, etc., or any combination thereof) with the time server(s) 12765 via the secure communication path 12770 to synchronize operation of the RTC circuitry 12755 with the time service (e.g., a central time service) provided by the time server(s) 12765. In some examples, the RTC circuitry 12755 includes specialized hardware and/or software to provide autonomous connectivity between the RTC circuitry 12755 and the time server(s) 12765. Additionally or alternatively, in some examples, the SDSi semiconductor device 12705 (e.g., via its SDSi asset agent circuitry 12740) and/or specialized hardware and/or software of a compute platform including the SDSi semiconductor device 12705 provide connectivity (e.g., a secure communication path) between the RTC circuitry 12755 and the time server(s) 12765. In some examples, the RTC circuitry 12755 also maintains a certificate chain and outputs a certificate that confirms the clock data output by the RTC circuitry 12755 is trusted and meets an accuracy corresponding to the time service (e.g., the central time service) provided by the time server(s) 12765.

In the illustrated example system 12700 of FIG. 1, the SDSi asset agent circuitry 12740 of the SDSi semiconductor device 12705 includes example time tracking circuitry 12780 that communicates (e.g., via one or more communication interfaces of SDSi semiconductor device 12705 and/or a compute platform including the SDSi semiconductor device 12705) with the RTC circuitry 12755 via the secure communication path 12775 (e.g., periodically, based on one or more trigger event, according to a schedule, etc., or any combination thereof) to obtain the current real-time clock data (e.g., current calendar clock data) output from the RTC circuitry 12755. In some examples, the time tracking circuitry 12780 of the SDSi semiconductor device 12705 also includes one or more counters to track calendar time in between readings of the current real-time clock data (e.g., current calendar clock data) output from the RTC circuitry 12755. For example, the time tracking circuitry 12780 may use the current real-time clock data (e.g., current calendar clock data) read from the RTC circuitry 12755 to initialize the counter(s) of the time tracking circuitry 12780. The time tracking circuitry 12780 may then use its counter(s) to maintain/track calendar time internal to the SDSi semiconductor device 12705 between fetches of real-time clock data (e.g., calendar clock data) from the RTC circuitry 12755.

In the illustrated example system 12700 of FIG. 1, the SDSi asset agent circuitry 12740 of the SDSi semiconductor device 12705 also includes example license expiry circuitry 12785 to compare the current calendar time maintained by the time tracking circuitry 12780 with a license expiry time of the SDSi license 12745. In some examples, the license expiry time is a calendar date and time (e.g., specified by month, date, year, time of day, etc., or any combination thereof) included in the SDSi license 12745 (e.g., as a data field of the SDSi license 12745). In some examples, the license expiry time is a calendar date and time (e.g., specified by month, date, year, time of day, etc., or any combination thereof) provided as metadata with the SDSi license 12745 when the SDSi license 12745 is assigned to the SDSi semiconductor device 12705. In the illustrated example, if the current calendar time maintained by the time tracking circuitry 12780 reaches (e.g., meets or exceeds) the license expiry time, then the license expiry circuitry 12785 determines the SDSi license 12745 is expired and causes the SDSi asset agent circuitry 12740 of the SDSi semiconductor device 12705 to disable the active SDSi feature(s) on the SDSi semiconductor device 12705 that correspond to the expired SDSi license 12745. However, if the current calendar time maintained by the time tracking circuitry 12780 has not reached (e.g., has not met or exceeded) the license expiry time, then the license expiry circuitry 12785 determines the SDSi license 12745 is still valid and the active SDSi feature(s) on the SDSi semiconductor device 12705 that correspond to the SDSi license 12745 are permitted to remain active.

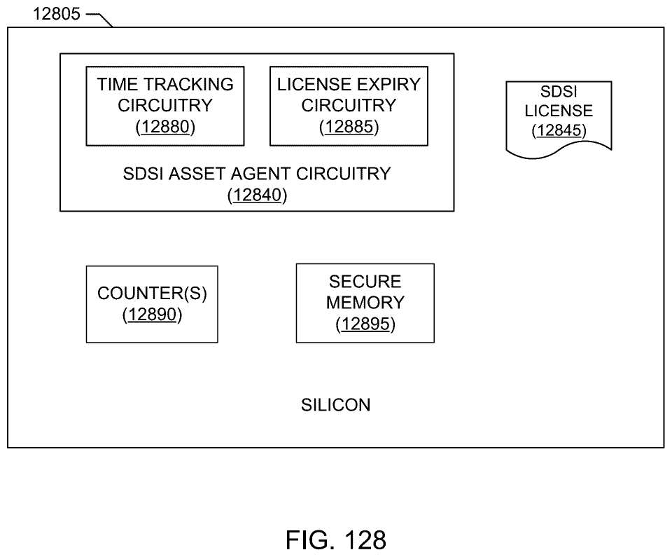

FIG. 128 illustrates another example SDSi semiconductor device 12805 that enables time-based expiration of assigned SDSi license(s). The example SDSi semiconductor device 12805 may correspond to any type of silicon product, such as, but not limited to, a computer processor, a CPU, an IPU, an XPU, a semiconductor chip, a silicon hardware device, etc., as well as a circuit board and/or a system employing such silicon products, etc. In the illustrated example, the SDSi semiconductor device 12805 implements SDSi features as described above in connection with the SDSi semiconductor device 105. As such, the SDSi semiconductor device 12805 of FIG. 128 includes example SDSi asset agent circuitry 12840, which implements an SDSi asset agent, such as the SDSi agent 140 described above, to support activation and deactivation of SDSi feature(s) on the SDSi semiconductor device 12805, as described above. In the illustrated example of FIG. 128, the SDSi asset agent circuitry 12840 of FIG. 128 includes example time tracking circuitry 12880 and example license expiry circuitry 12885 to implement time-based expiration of assigned SDSi license(s).

In the illustrated example of FIG. 128, the time tracking circuitry 12880 and example license expiry circuitry 12885 of the SDSi asset agent circuitry 12840 implement time-based expiration of assigned SDSi license(s) in the SDSi semiconductor device 12805, such as an example SDSi license 245, based on elapsed time, in contrast with time-based license expiration based on calendar time as implemented in the example system 12700 of FIG. 127. Time-based license expiration based on elapsed time, as implemented by the example SDSi semiconductor device 12805 of FIG. 128, can be effective in environments in which network connectivity to time services is unavailable or limited and, thus, real time clock capabilities may not be present. Time-based license expiration based on elapsed time, as implemented by the example SDSi semiconductor device 12805 of FIG. 128, can be effective in data centers and other environments (e.g., such as edge environments) with relatively constant power sources such that power outages are rare or protected using uninterrupted power supplies (UPS), and/or where power outages are acceptable from a business perspective because, during a power outage, the SDSi semiconductor device 12805 is not expected to be in use and, thus, the elapsed time of the outage should not count against the elapsed time of the SDSi license(s) of the SDSi semiconductor device 12805.

In the illustrated example of FIG. 128, the SDSi semiconductor device 12805 (e.g., via its SDSi asset agent circuitry 12840) implements the SDSi license 245 as an expirable, or timed, license that expires after a particular elapsed time has reached. In some examples, the elapsed time is measured from when the SDSi license 245 was installed on the SDSi semiconductor device 12805. In some examples, the elapsed time is measured from when one or more SDSi feature(s) associated with the SDSi license 245 was (were) activated on the SDSi semiconductor device 12805.

In the illustrated example of FIG. 128, the time tracking circuitry 12880 utilizes one or more example counter(s) 12890 and example memory 12895 to track elapsed time. For example, the counter(s) 12890 include an example running counter 12890 that continuously increments once power is applied to the SDSi semiconductor device 12805 (e.g., once the SDSi semiconductor device 12805 is powered on), and the output value of that counter 12890 is stored in the memory 12895. In some examples, the memory 12895 is implemented as a secure memory that is accessible by only the time tracking circuitry 12880 (and possibly other elements of the SDSi asset agent circuitry 12840) to prevent man-in-the-middle attacks. For example, the secure memory 12895 can be implemented by non-volatile random access memory (NVRAM) within the SDSi semiconductor device 12805 and located in a zone of trust that is accessible by only the time tracking circuitry 12880 (and possibly other elements of the SDSi asset agent circuitry 12840). In some examples, the counter(s) 12890 and/or the memory 12895 are included in the SDSi asset agent circuitry 12840 (and, thus, are included in the zone of trust for the SDSi asset agent circuitry 12840). In some examples, the counter(s) 12890 and/or the memory 12895 are included in the SDSi semiconductor device 12805, but are separate from the SDSi asset agent circuitry 12840 and included in a zone of trust that also includes the SDSi asset agent circuitry 12840.

As described above, in the illustrated example of FIG. 128, the counter(s) 12890 include the running counter 12890 that continuously increments once power is applied to the SDSi semiconductor device 12805, and the output value of that counter 12890 is stored in the memory 12895. Furthermore, the running counter 12890 increments at a specific increment rate associated with a corresponding increment period (e.g., such as one increment per second or some other increment rate with some other increment period). Because the increment rate/period of the running counter 12890 is known, the value of the running counter 12890 can be read from the memory 12895 and scaled (e.g., multiplied) by the increment period (or the inverse of the increment rate) to determine the elapsed time during which the SDSi semiconductor device 12805 has been powered (also referred to as the uptime of the SDSi semiconductor device 12805) at any given moment in time.

As described above, the SDSi license 245 is an expirable license that has a license expiry time that is based on elapsed time. In some examples, the license expiry time is an amount of time (e.g., specified as a number of hours, a number of days, a number of weeks, a number of months, a number or years, etc.) included in the SDSi license 12845 (e.g., as a data field of the SDSi license 12845). In some examples, the license expiry time is an amount of time (e.g., specified as a number of hours, a number of days, a number of weeks, a number of months, a number or years, etc.) provided as metadata with the SDSi license 12845 when the SDSi license 12845 is assigned to the SDSi semiconductor device 12805. In some examples, the license expiry time is specified as a number of counter ticks. In some examples, the license expiry time is specified as a calendar/date time that can be converted (e.g., by the license expiry circuitry 12885) to an amount of elapsed time or a number of counter increments (ticks).

In the illustrated example of FIG. 128, the time tracking circuitry 12880 of the SDSi asset agent circuitry 12840 of the SDSi semiconductor device 12805 implements an example time tracking algorithm to track elapsed time associated with the SDSi license 12845 based on the running counter 12890 and the memory 12895. For example, in response to a first trigger event, the time tracking circuitry 12880 reads a first value of the running counter 12890 from the memory 12895. In some examples, the first trigger event corresponds to the action of the SDSi license 12845 being installed on the SDSi semiconductor device 12805 by the SDSi asset agent circuitry 1284. In some examples, the first trigger event corresponds to the initial activation by the SDSi asset agent circuitry 1284 of an SDSi feature associated with the SDSi license 12845 on the SDSi semiconductor device 12805. In either such example, the first value of the running counter 12890 read from the memory 12895 in response to the first trigger event is stored by the time tracking circuitry 12880 (e.g., in the memory 12895) as a start count value of the SDSi license 12845, and/or converted by the time tracking circuitry 12880 into a start time (e.g., by multiplication with the counter increment period, as described above) and stored (e.g., in the memory 12895) as a start time value of the SDSi license 12845.

Subsequently, in response to one or more second trigger event (e.g., which may occur periodically, based on one or more events, based on a schedule, etc., or any combination thereof), the time tracking circuitry 12880 reads a second value of the running counter 12890 from the memory 12895, and computes a difference between the second counter value and the start count value for the SDSi license 12845. The time tracking circuitry 12880 converts this difference between the second counter value and the start count value into an elapsed time of the SDSi license 12845 (e.g., by multiplication with the counter increment period, as described above). In examples in which the time tracking circuitry 12880 stores a start time of the license, the time tracking circuitry 12880 converts the second value of the running counter 12890 read from the memory 12895 into a second time value (e.g., by multiplication with the counter increment period, as described above) and computes a difference between the second time value and the start time value to determine the elapsed time of the SDSi license 12845. In either such example, the time tracking circuitry 12880 is thus able to determine an elapsed time of the SDSi license 12845 at any time a second trigger condition occurs.

In the illustrated example of FIG. 128, license expiry circuitry 12885 of the SDSi asset agent circuitry 12840 generates a second trigger event as described above when the elapsed time of the SDSi license 12845 is to be compared to the license expiry time of the SDSi license 12845. As described above, the license expiry circuitry 12885 may generate such second trigger events periodically, based on one or more events, based on a schedule, etc., or any combination thereof. In response to the second trigger event, the license expiry circuitry 12885 obtains the elapsed time of the SDSi license 12845 from the time tracking circuitry 12880 and compares the elapsed time of the SDSi license 12845 to its license expiry time. If the elapsed time obtained from the time tracking circuitry 12880 for the SDSi license 12845 reaches (e.g., meets or exceeds) the license expiry time, then the license expiry circuitry 12885 determines the SDSi license 12845 is expired and causes the SDSi asset agent circuitry 12840 of the SDSi semiconductor device 12805 to disable the active SDSi feature(s) on the SDSi semiconductor device 12805 that correspond to the expired SDSi license 12845. However, if the elapsed time obtained from the time tracking circuitry 12880 for the SDSi license 12845 has not reached (e.g., has not met or exceeded) the license expiry time, then the license expiry circuitry 12885 determines the SDSi license 12845 is still valid and the active SDSi feature(s) on the SDSi semiconductor device 12805 that correspond to the SDSi license 12845 are permitted to remain active.

The example techniques disclosed herein to implement time-based expiration of licenses can be applied to silicon product features (e.g., CPU features) other than the SDSi features disclosed herein. For example, such other features could be deactivated based on hot unplug methods as defined by the Advanced Configuration and Power Interface (ACPI) specification, hot plug/surprise removal mechanisms as defined by the Peripheral Component Interconnect Express (PCIe) standards, etc. Additionally or alternatively, in some examples, custom software could be used to monitor a status register within the silicon product (e.g., CPU) and check if a feature is allowed to be used, etc. In some such examples, if the monitored status indicates license expiry, then the custom software turns off or stops using the feature accordingly.

In some examples, the SDSi asset agent circuitry (e.g., 12740 or 12840) included in the SDSi semiconductor device (e.g., 12705 or 12805) additionally or alternatively utilizes blockchain technology to manage the SDSi feature license activation. For example, before provision to the customer, the semiconductor manufacturer may cause a first non-fungible token (NFT) to be minted and stored in a public or private blockchain to identify the SDSi semiconductor device (e.g., 12705 or 12805). The first NFT is also referred to as the device identification NFT. In some examples, the SDSi asset agent circuitry (e.g., 12740 or 12840) included in the SDSi semiconductor device (e.g., 12705 or 12805) causes a second NFT to be minted and stored on the blockchain when an SDSi license is installed or activated on the SDSi semiconductor device (e.g., 12705 or 12805). The second NFT is also referred to as the license activation NFT. In some examples, the combination (e.g., join and correlation) of the first and second NFTs (e.g., the device identification and the license activation NFTs) provides proof that the SDSi license was installed/activated on the SDSi semiconductor device (e.g., 12705 or 12805).

In some examples, the semiconductor manufacturer, or other license server or agent, also creates a smart contract for the activation lifecycle of the SDSi license, which sets the time or duration of license activation, and stores the smart contract in the blockchain. Then, the first appearance of the license activation NFT on the blockchain marks the beginning of the clock and the SDSi asset agent circuitry manages the clock according to a blockchain lifecycle assessment (LCA), which is compared to the license expiry time of the SDSi license to determine whether the SDSi license has expired should remain active.

While an example manner of implementing the system 12700 is illustrated in FIG. 127, one or more of the elements, processes, and/or devices illustrated in FIG. 127 may be combined, divided, re-arranged, omitted, eliminated, and/or implemented in any other way. Further, the example SDSi semiconductor device 12705, the example SDSi asset agent circuitry 12740, the example SDSi license 12745, the example RTC circuitry 12755, the example time server(s) 12765, the communication paths 12770 and/or 12775, the example time tracking circuitry 12780, the example license expiry circuitry 12785 and/or, more generally, the example system 12700 of FIG. 127, may be implemented by hardware alone or by hardware in combination with software and/or firmware. Thus, for example, any of the example SDSi semiconductor device 12705, the example SDSi asset agent circuitry 12740, the example SDSi license 12745, the example RTC circuitry 12755, the example time server(s) 12765, the communication paths 12770 and/or 12775, the example time tracking circuitry 12780, the example license expiry circuitry 12785 and/or, more generally, the example system 12700, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example system 12700 may include one or more elements, processes, and/or devices in addition to, or instead of, those illustrated in FIG. 127, and/or may include more than one of any or all of the illustrated elements, processes and devices.

While an example manner of implementing the SDSi semiconductor device 12805 is illustrated in FIG. 128, one or more of the elements, processes, and/or devices illustrated in FIG. 128 may be combined, divided, re-arranged, omitted, eliminated, and/or implemented in any other way. Further, the example SDSi asset agent circuitry 12840, the example SDSi license 12845, the example time tracking circuitry 12880, the example license expiry circuitry 12885, the example counter(s) 12890, the example memory 12895 and/or, more generally, the example SDSi semiconductor device 12805 of FIG. 128, may be implemented by hardware alone or by hardware in combination with software and/or firmware. Thus, for example, any of the example SDSi asset agent circuitry 12840, the example SDSi license 12845, the example time tracking circuitry 12880, the example license expiry circuitry 12885, the example counter(s) 12890, the example memory 12895 and/or, more generally, the example SDSi semiconductor device 12805, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example SDSi semiconductor device 12805 may include one or more elements, processes, and/or devices in addition to, or instead of, those illustrated in FIG. 128, and/or may include more than one of any or all of the illustrated elements, processes and devices.

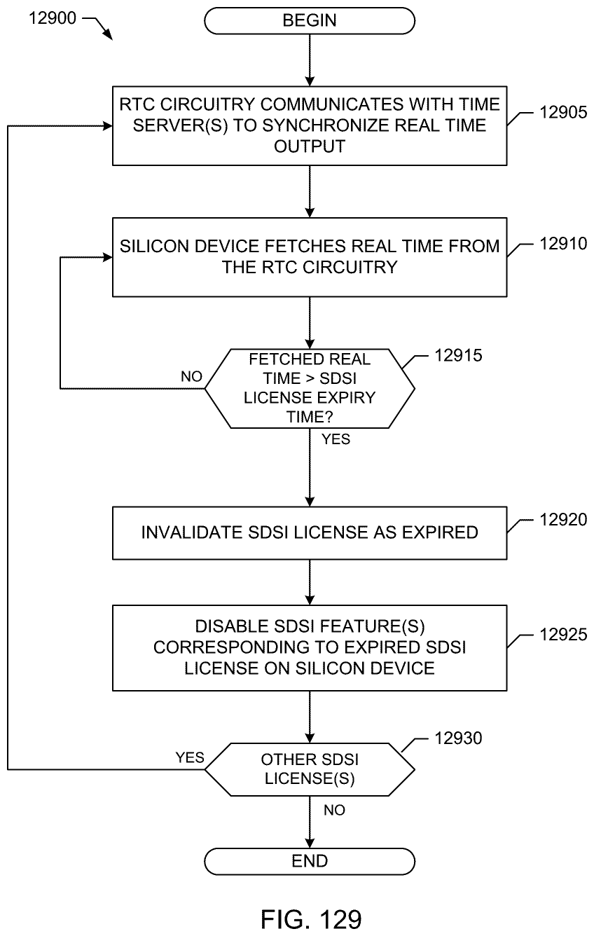

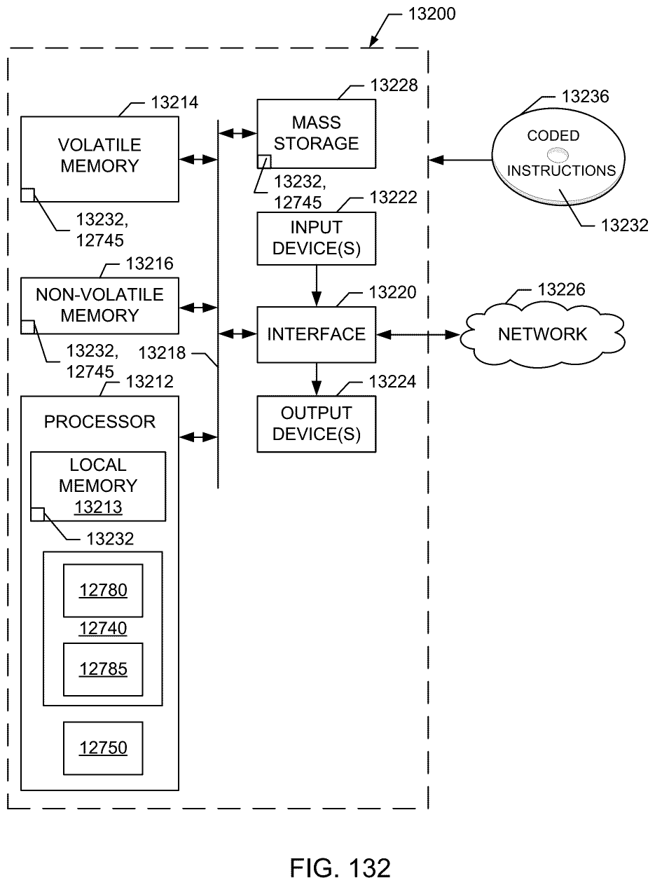

A flowchart representative of example machine readable instructions which may be executed to configure processor circuitry to implement the example system 12700 is shown in FIG. 129. The machine readable instructions may be one or more executable programs or portion(s) of an executable program for execution by processor circuitry, such as the processor circuitry 13212 shown in the example processor platform 13200 discussed below in connection with FIG. 132 and/or the example processor circuitry discussed below in connection with FIGS. 150 and/or 151. The program(s) may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program(s) and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program(s) is(are) described with reference to the flowchart illustrated in FIG. 129, many other methods of implementing the example system 12700 may alternatively be used. For example, the order of execution of the blocks may be changed, and/or some of the blocks described may be changed, eliminated, combined and/or subdivided into multiple blocks. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

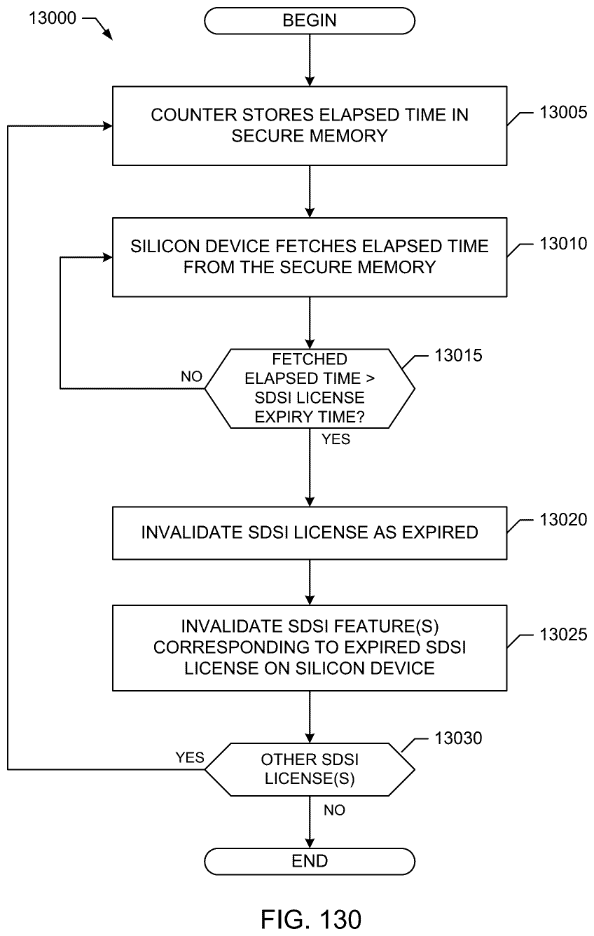

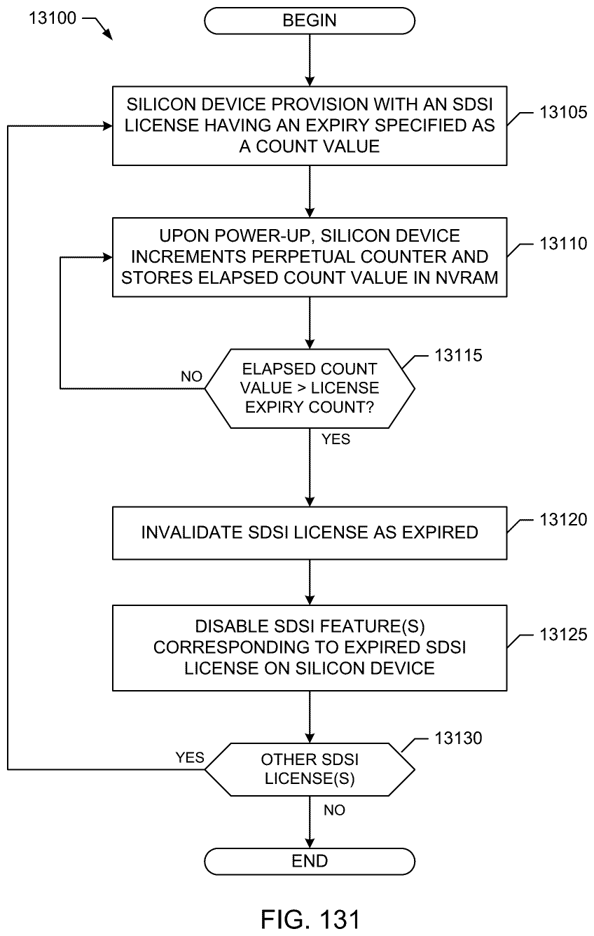

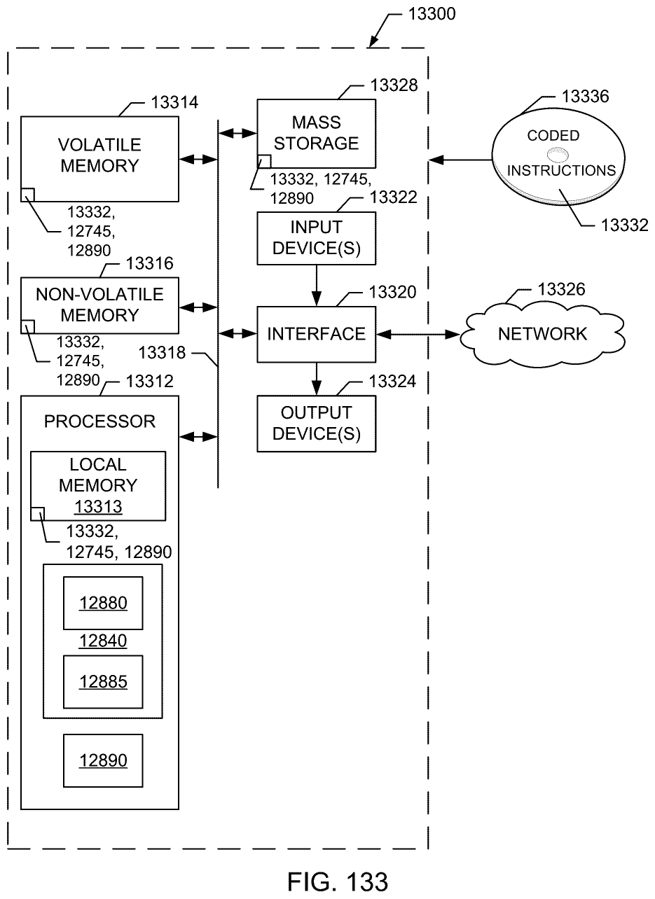

Flowcharts representative of example machine readable instructions which may be executed to configure processor circuitry to implement the example SDSi semiconductor device 12805 are shown in FIGS. 130-131. The machine readable instructions may be one or more executable programs or portion(s) of an executable program for execution by processor circuitry, such as the processor circuitry 13312 shown in the example processor platform 13300 discussed below in connection with FIG. 133 and/or the example processor circuitry discussed below in connection with FIGS. 150 and/or 151. The program(s) may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program(s) and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program(s) is(are) described with reference to the flowcharts illustrated in FIGS. 130-131, many other methods of implementing the example SDSi semiconductor device 12805 may alternatively be used. For example, the order of execution of the blocks may be changed, and/or some of the blocks described may be changed, eliminated, combined and/or subdivided into multiple blocks. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 129-131 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc. Also, as used herein, the terms “computer readable” and “machine readable” are considered equivalent unless indicated otherwise.

FIG. 129 is a flowchart representative of example machine readable instructions and/or example operations 12900 that may be executed and/or instantiated by processor circuitry to implement the example system 12700 disclosed above. With reference to the preceding figures and associated written descriptions, the machine readable instructions and/or the operations 12900 of FIG. 129 begin at block 12905 at which the RTC circuitry 12755 communicates with the time server(s) 12765 synchronize the real-time clock data output from the RTC circuitry 12755 with the time service (e.g., a central time service) provided by the time server(s) 12765, as described above. At block 12910, the time tracking circuitry 12780 of the SDSi asset agent circuitry 12740 of the SDSi semiconductor device 12705 fetches (e.g., reads or otherwise obtains) the current real-time clock data from the RTC circuitry 12755 and uses the fetched clock data to track real-time in the SDSi semiconductor device 12705, as described above.

At block 12915, the license expiry circuitry 12785 of the SDSi asset agent circuitry 12740 of the SDSi semiconductor device 12705 compares a current real-time clock value provided by the time tracking circuitry 12780 with a license expiry time associated with the SDSi license 12745, as described above. If the current real-time clock value has not reached the license expiry time (corresponding to the “NO” output from block 12915), the processing returns to block 12910 to continue obtaining updated real-time clock values to be compared with the license expiry time. However, if the current real-time clock value has reached the license expiry time (corresponding to the “YES” output from block 12915), then at block 12920 the license expiry circuitry 12785 determines the SDSi license 12745 has expired and invalidates it, as described above. At block 12925, the SDSi asset agent circuitry 12740 disables or otherwise invalidates any active SDSi feature(s) associated with the now expired and inactive SDSi license 12745, as described above.

At block 12930, the SDSi asset agent circuitry 12740 determines whether the SDSi semiconductor device 12705 has other SDSi licenses to be processed. If the are other licenses to be processed (corresponding to the “YES” output from block 12930), then processing returns to block 12905 and blocks subsequent thereto. However, if there are no other licenses to be processed (corresponding to the “NO” output from block 12930), the machine readable instructions and/or operations 12900 then end.

FIG. 130 is a flowchart representative of example machine readable instructions and/or example operations 13000 that may be executed and/or instantiated by processor circuitry to implement the example SDSi semiconductor device 12805 disclosed above. With reference to the preceding figures and associated written descriptions, the machine readable instructions and/or the operations 13000 of FIG. 130 begin at block 13005 at which the running counter 12890 of the SDSi semiconductor device 12805 stores its running output count value in the memory 12895 of the SDSi semiconductor device 12805, which is used by the time tracking circuitry 12880 of the SDSi asset agent circuitry 12840 of the SDSi semiconductor device 12805 to track an elapsed time associated with the SDSi license 12845, as described above. At block 13010, the license expiry circuitry 12885 of the SDSi asset agent circuitry 12840 of the SDSi semiconductor device 12805 fetches (e.g., reads of otherwise obtains) the elapsed time of the SDSi license 12845 from the time tracking circuitry 12880, as described above.

At block 13015, the license expiry circuitry 12885 compares the elapsed time of the SDSi license 12845 with a license expiry time associated with the SDSi license 12745, as described above. If the elapsed time has not reached the license expiry time (corresponding to the “NO” output from block 13015), the processing returns to block 13010 to continue obtaining updated elapsed time values to be compared with the license expiry time. However, if the elapsed time has reached the license expiry time (corresponding to the “YES” output from block 13015), then at block 13020 the license expiry circuitry 12885 determines the SDSi license 12845 has expired and invalidates it, as described above. At block 13025, the SDSi asset agent circuitry 12840 disables or otherwise invalidates any active SDSi feature(s) associated with the now expired and inactive SDSi license 12845, as described above.

At block 13030, the SDSi asset agent circuitry 12840 determines whether the SDSi semiconductor device 12805 has other SDSi licenses to be processed. If the are other licenses to be processed (corresponding to the “YES” output from block 13030), then processing returns to block 13005 and blocks subsequent thereto. However, if there are no other licenses to be processed (corresponding to the “NO” output from block 13030), the machine readable instructions and/or operations 13000 then end.

FIG. 131 is a flowchart representative of second example machine readable instructions and/or example operations 13100 that may be executed and/or instantiated by processor circuitry to implement the example SDSi semiconductor device 12805 disclosed above. With reference to the preceding figures and associated written descriptions, the machine readable instructions and/or the operations 13100 of FIG. 131 begin at block 13105 at which the SDSi license 12845 is provisioned (e.g., installed) on the SDSi semiconductor device 12805, as described above. In the illustrated example, the SDSi license 12845 is expirable and includes, or is otherwise associated with (e.g., via metadata), an expiry count that represents an expiry elapsed time that is based on a counter increment period, as described above. For example, the expiry count included in (or associated with) the SDSi license 12845 provisioned at block 13105 can be based on a counter increment period of 1 second (or some other period) and have a value of 1440 (or some other value) that, in this example, would represent that the SDSi license 12845 is to expire after 1440 seconds, or 24 minutes.

At block 13110, the perpetual running counter 12890 of the SDSi semiconductor device 12805 begins incrementing upon power-up of the SDSi semiconductor device 12805, and stores its running output count value in the memory 12895 (e.g., NVRAM) of the SDSi semiconductor device 12805, as described above. As noted above, the running output count value in the memory 12895 represents an elapsed count that can be used by the time tracking circuitry 12880 of the SDSi asset agent circuitry 12840 of the SDSi semiconductor device 12805 to track an elapsed count associated with the SDSi license 12845, as described above. In the illustrated example, the time tracking circuitry 12880 uses a first count value of the running counter 12890 fetched when the SDSi license 12845 is installed/activated as a start count value of the SDSi license 12845, and adds this start count value to the expiry count value specified for the SDSi license 12845 to determine a license expiry count for the SDSi license 12845. At block 13115, the license expiry circuitry 12885 of the SDSi asset agent circuitry 12840 of the SDSi semiconductor device 12805 fetches (e.g., reads of otherwise obtains) the elapsed count of the running counter 12890 from the memory 12895 and compares the elapsed count to the license expiry count for the SDSi license 12845 (e.g., as determined by the time tracking circuitry 12880 based on the start count value of the SDSi license 12845 and the expiry count value specified for the SDSi license 12845, as described above).

If the elapsed count value has not reached the license expiry count (corresponding to the “NO” output from block 13115), then processing returns to block 13110 to continue obtaining updated elapsed count values to be compared with the license expiry count. However, if the elapsed count value has reached the license expiry count (corresponding to the “YES” output from block 13115), then at block 13120 the license expiry circuitry 12885 determines the SDSi license 12845 has expired and invalidates it, as described above. At block 13125, the SDSi asset agent circuitry 12840 disables or otherwise invalidates any active SDSi feature(s) associated with the now expired and inactive SDSi license 12845, as described above.

At block 13130, the SDSi asset agent circuitry 12840 determines whether the SDSi semiconductor device 12805 has other SDSi licenses to be processed. If the are other licenses to be processed (corresponding to the “YES” output from block 13130), then processing returns to block 13105 and blocks subsequent thereto. However, if there are no other licenses to be processed (corresponding to the “NO” output from block 13130), the machine readable instructions and/or operations 13100 then end.

FIG. 132 is a block diagram of an example processor platform 13200 structured to execute and/or instantiate the machine readable instructions and/or the operations of FIG. 129 to implement the example SDSi semiconductor device 12705 and/or the example RTC circuitry 12755 of FIG. 127. The processor platform 13200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 13200 of the illustrated example includes processor circuitry 13212. The processor circuitry 13212 of the illustrated example is hardware. For example, the processor circuitry 13212 can be implemented by one or more integrated circuits, logic circuits, FPGAs, microprocessors, CPUs, GPUs, DSPs, and/or microcontrollers from any desired family or manufacturer. The processor circuitry 13212 may be implemented by one or more semiconductor based (e.g., silicon based) devices. In this example, the processor circuitry 13212 implements one or more of the example SDSi asset agent circuitry 12740, the example RTC circuitry 12755, the example time tracking circuitry 12780, the example license expiry circuitry 12785 in the example SDSi semiconductor device 12705.

The processor circuitry 13212 of the illustrated example includes a local memory 13213 (e.g., a cache, registers, etc.). The processor circuitry 13212 of the illustrated example is in communication with a main memory including a volatile memory 13214 and a non-volatile memory 13216 by a bus 13218. The volatile memory 13214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 13216 may be implemented by flash memory and/or any other desired type of memory device. Access to the main memory 13214, 13216 of the illustrated example is controlled by a memory controller 13217. In some example, the local memory 13213 and/or the volatile memory 13214 store the example SDSi license 12745.

The processor platform 13200 of the illustrated example also includes interface circuitry 13220. The interface circuitry 13220 may be implemented by hardware in accordance with any type of interface standard, such as an Ethernet interface, a universal serial bus (US B) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 13222 are connected to the interface circuitry 13220. The input device(s) 13222 permit(s) a user to enter data and/or commands into the processor circuitry 13212. The input device(s) 13222 can be implemented by, for example, an audio sensor, a microphone, a camera (still or video), a keyboard, a button, a mouse, a touchscreen, a track-pad, a trackball, a trackbar, an isopoint device, a voice recognition system and/or any other human-machine interface. In some examples, the input device(s) 13222 are arranged or otherwise configured to allow the user to control the processor platform 13200 and provide data to the processor platform 13200 using physical gestures, such as, but not limited to, hand or body movements, facial expressions, face recognition, etc.

One or more output devices 13224 are also connected to the interface circuitry 13220 of the illustrated example. The output device(s) 13224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 13220 of the illustrated example, thus, typically includes a graphics driver card, a graphics driver chip, and/or graphics processor circuitry such as a GPU.

The interface circuitry 13220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 13226. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 13200 of the illustrated example also includes one or more mass storage devices 13228 to store software and/or data. Examples of such mass storage devices 13228 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives. In some examples, one or more of the mass storage devices 13228 store the example SDSi license 12745.

The machine readable instructions 13232, which may be implemented by the machine readable instructions of FIG. 129, may be stored in the mass storage device 13228, in the volatile memory 13214, in the non-volatile memory 13216, and/or on a removable non-transitory computer readable storage medium such as a CD or DVD.

FIG. 133 is a block diagram of an example processor platform 13300 structured to execute and/or instantiate the machine readable instructions and/or the operations of FIGS. 130 and/or 131 to implement the example SDSi semiconductor device 12805 of FIG. 128. The processor platform 13300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 13300 of the illustrated example includes processor circuitry 13312. The processor circuitry 13312 of the illustrated example is hardware. For example, the processor circuitry 13312 can be implemented by one or more integrated circuits, logic circuits, FPGAs, microprocessors, CPUs, GPUs, DSPs, and/or microcontrollers from any desired family or manufacturer. The processor circuitry 13312 may be implemented by one or more semiconductor based (e.g., silicon based) devices. In this example, the processor circuitry 13312 implements one or more of the example SDSi asset agent circuitry 12840, the example time tracking circuitry 12880, the example license expiry circuitry 12885 and/or the example counter(s) 12890 of the example SDSi semiconductor device 12705.

The processor circuitry 13312 of the illustrated example includes a local memory 13313 (e.g., a cache, registers, etc.). The processor circuitry 13312 of the illustrated example is in communication with a main memory including a volatile memory 13314 and a non-volatile memory 13316 by a bus 13318. The volatile memory 13314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 13316 may be implemented by flash memory and/or any other desired type of memory device. Access to the main memory 13314, 13316 of the illustrated example is controlled by a memory controller 13317. In some examples, the local memory 13213 and/or the volatile memory 13214 store the example SDSi license 12745 and/or implement the example memory 12895.

The processor platform 13300 of the illustrated example also includes interface circuitry 13320. The interface circuitry 13320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 13322 are connected to the interface circuitry 13320. The input device(s) 13322 permit(s) a user to enter data and/or commands into the processor circuitry 13312. The input device(s) 13322 can be implemented by, for example, an audio sensor, a microphone, a camera (still or video), a keyboard, a button, a mouse, a touchscreen, a track-pad, a trackball, a trackbar, an isopoint device, a voice recognition system and/or any other human-machine interface. In some examples, the input device(s) 13322 are arranged or otherwise configured to allow the user to control the processor platform 13300 and provide data to the processor platform 13300 using physical gestures, such as, but not limited to, hand or body movements, facial expressions, face recognition, etc.

One or more output devices 13324 are also connected to the interface circuitry 13320 of the illustrated example. The output device(s) 13324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 13320 of the illustrated example, thus, typically includes a graphics driver card, a graphics driver chip, and/or graphics processor circuitry such as a GPU.

The interface circuitry 13320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 13326. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 13300 of the illustrated example also includes one or more mass storage devices 13328 to store software and/or data. Examples of such mass storage devices 13328 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives. In some examples, one or more of the mass storage devices 13328 store the example SDSi license 12745 and/or implement the example memory 12895.

The machine readable instructions 13332, which may be implemented by the machine readable instructions of FIGS. 130 and/or 131, may be stored in the mass storage device 13328, in the volatile memory 13314, in the non-volatile memory 13316, and/or on a removable non-transitory computer readable storage medium such as a CD or DVD.

Non-Node Locked Licenses

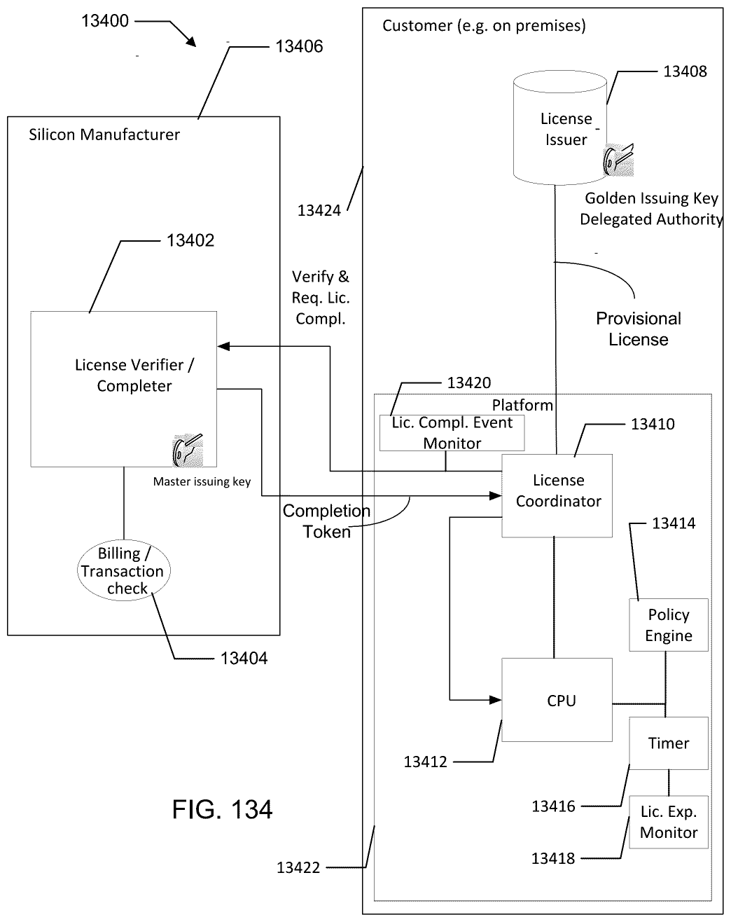

FIG. 134 illustrates a block diagram of an example system K100 to generate provisional hardware upgrade licenses that are not locked to a particular node but are instead assigned and locked to a node at a later time, as described further below. Preferably, a silicon purchaser informs a silicon manufacturer of a target hardware base and feature set desired by the purchaser when an order for silicon is placed. Using this purchaser-specified information, the silicon nodes are manufactured with node-locked licenses. Node-locked licenses, as used herein, refers to node/unit-specific licenses, e.g., licenses that are targeted at a concrete hardware node/unit at the time of purchase. Such licenses need not be fully installed at the time of manufacture but can instead become fully installed at a purchaser's facility, even when the targeted node/unit is offline, using software-defined silicon techniques.

In today's world, datacenters are highly volatile and the hardware/processing needs of a datacenter operator are constantly in-flux. As a result, it is difficult for a silicon customer/purchaser to accurately predict, at the time of order-placement, which of several target hardware bases and/or feature sets will be needed. Further, in OEM manufacturing, an identifier “ID” of a hardware node/unit to be put into, for example, a server, is not typically known until assembly of the server has begun, thus complicating the locking of licenses to a node/unit based on an ID at the time of manufacture of the unit/node. Due to both the customer's desire to defer node lock to the time of installation (e.g., during manufacturing) instead of at the time of order placement, and the realities of OEM manufacturing, the system 13400 of FIG. 134 performs software-defined silicon licensing with non-node locked licenses. As described further below, the non-node locked licenses can be locked to a specific node/unit when the node/unit is at the customer's premises and even while the node/unit is offline. Offline as used in the foregoing sentence refers to implementations in which there is no connectivity (Internet) between the Customer premises and Silicon Manufacturer. In such examples, the equipment at the Customer node/unit operates autonomously (e.g., without the direction of the silicon manufacturer).

The example system 13400 of FIG. 134 includes an example license verifier/completer 13402, and an example billing/transaction checker 13404. As illustrated in FIG. 134, in some examples, the license verifier/completer 13402 and the billing/transaction checker 13404 are operated by a silicon manufacturer as a cloud-based service 13406. The system 13400 further includes an example license issuer 13408, an example license coordinator 13410, an example computer processing unit (CPU) 13412, an example policy engine 13414, an example timer 13416, an example license expiration monitor 13418, and an example license completion event/trigger monitor 13420. In some examples, the license coordinator 13410, the CPU 13412, the policy engine 13414, the timer 13416, the license expiration monitor 13418, and the license completion event monitor 13420 are part of a hardware platform 13422. In some examples, the license issuer 13408 and the hardware platform (with the corresponding components) are located at an example customer facility/premises 13424 operated by a customer of the silicon manufacturer.

In some examples, the customer facility/premises 13424 can correspond to a customer data center, customer manufacturing center, customer data processing site, etc. In some such examples, the example hardware platform 13422 or portions thereof can be software defined silicon (SDSi) semiconductor devices that correspond to servers of the customer data center, and the license issuer 13408 can correspond to and/or be implemented by a backend system of a customer enterprise that is utilizing the SDSi semiconductor devices (e.g., manufacturing electronic devices into which the SDSi semiconductor devices are installed). In the same way, the silicon manufacturing facility 13406 can correspond to any entity that manufactures silicon devices and, in particular, SDSi semiconductor devices. Similarly, the example license verifier/completer 13402 and the example billing transaction/checker 13404 can correspond to any backend service/system of the silicon manufacturer to support the completion of provisional hardware licenses installed by the customer.

As such, the elements of the example system 13400 of FIG. 134 may be instantiated (e.g., creating an instance of, bring into being for any length of time, materialize, implement, etc.) by processor circuitry such as a central processing unit executing instructions. Additionally or alternatively, the elements of the example system 13400 of FIG. 134 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 134 may, thus, be instantiated at the same or different times. Some or all of the circuitry may be instantiated, for example, in one or more threads executing concurrently on hardware and/or in series on hardware. Moreover, in some examples, some or all of the circuitry of FIG. 134 may be implemented by microprocessor circuitry executing instructions to implement one or more virtual machines and/or containers.

In some examples, the example license issuer 13408 is a local entity (e.g., local to the customer facility/premises) that distributes provisional licenses. The license are referred to as provisional because the licenses can only be used provisionally (e.g., for a limited amount of time) until the license is installed in a CPU or other compute device and a completion operation is performed. Due to the fact that these provisional licenses are non-node locked at the time of distribution, the licenses can be considered partial until a completion operation has been performed. The completion operation represents a set of operations by and between the example license verifier 13402, the license coordinator 13410 and the example CPU 13412, as described below. The provisional licenses are further unique in that they are not bound to a particular unit of hardware upon generation of the license but are instead bound to a particular unit of hardware (e.g., the CPU 13412) upon installation in the CPU and upon completion of the license. In some examples, the provisional licenses may be temporarily bound to a particular unit of hardware that is requesting the license, but that binding will be broken if license completion does not occur within a finite amount of time (e.g., upon expiration of the provisional license).

In some examples, the example license issuer K108 has been delegated authority, by, for example, the silicon manufacturer to generate the provisional licenses at its own discretion using an example pre-provisioned golden issuing key 13426. The golden issuing key is certified or provisioned to the License Issuer by the silicon manufacturer and can be validated to generate any number of provisional licenses. In this way, the golden issuing key operates as a master key that is capable of issuing provisional licenses on the customer's premises as opposed to being issued by the silicon manufacturer before being supplied to the customer. The hardware node/unit (e.g., the CPU 13412) is equipped with information needed to verify the golden issuing key and applies limited (temporary) trust to the provisional license. The trust is described in limited in that, although the hardware node/unit CPU 13412 will install the provisional license on a provisional (conditional), the trust is not sufficient to apply the license on a permanent basis without more (e.g., without the completion process described herein). In some examples, the license issuer 13408 can be a community of processing nodes with the authority to generate the provisional licenses. In yet other examples, the license issuer 13408 can be authorized by the silicon manufacturer to use a pre-generated pool of provisional licenses from a backend service of the silicon manufacturer, such as the license verifier/completer 13402.

As indicated above, the example system 13400 implements the generation and issuance of the provisional licenses to be used to enable the activation of hardware features of an SDSi semiconductor devices (e.g., the CPU 13412). As described in detail above, such features are otherwise disabled in the silicon by default. In some examples, the provisional licenses are “non-node locked” in the sense that the provisional hardware licenses are not initially bound to a specific SDSi semiconductor device. In some examples, a provisional license issued by the license issuer 13408 can be installed on a customer node (e.g., the CPU 13412) and will enable operation of a hardware feature associated with the provisional license upon reboot of the customer CPU (e.g., node). In some such examples, the operation of the hardware feature after installation of the provisional license and reboot of the node is limited per information included with (or in) the license. In some examples, the hardware unit/node (e.g., the CPU 13412) reboot is not necessary to activate the features after installation of the provisional license. A completion operation is then required to be performed by a remote entity (e.g., the example silicon license verifier/completer 13402 of the silicon manufacturer) before the provisional license becomes a fully-valid license that can operate without limitations.

In some examples, the example license issuer 13408 may perform digital signing of issued provisional licenses, which requires the license issuer 13408 to protect material cryptographically. To do this, the license issuer 13408 may use some form of trusted execution environment (TEE), and/or a hardware security module (HSM), to secure cryptographic keys and operations needed for signing the provisional licenses to be issued for requesting nodes.

In some examples, the example license issuer 13408 uses an example “golden key” 13426 to generate the provisional licenses. The golden key is determined by the silicon manufacturer and is recognized by the semiconductor devices of the silicon manufacturer as a trusted key source. In some examples, the golden key 13408, when used to generate a provisional license, allows node features that are subject to the provisional license to be activated for a semiconductor device of the corresponding semiconductor device manufacturer on a limited basis, (e.g., for a limited duration of time, for a limited number of operations, etc.). In some examples, when a provisional license is completed (e.g., is transformed into a full license that is locked to a specific node as described further below), the semiconductor device gains access to the features on an on-going basis or for an amount of time dictated by the license, an amount of processing load handled by the CPU 13412, a number of operations performed by the CPU 13412, etc.

In some examples, the example license issuer 13408 queries a local inventory of semiconductor devices that are (or are to be) deployed at the customer facility 13424. Based the results of the query, the license issuer 13408 pre-generates license keys and stores the pre-generated keys for later usage. In some such examples, costs are not incurred by the customer for the pre-generated, provisional licenses nor activation thereof until the provisional license is applied to a node, the node is rebooted and metering of usage of the feature begins for billing purposes.

In some examples, the pre-generated provisional licenses may be generated as node-locked. In some such examples, the provisional licenses include information that identifies a specific node of the customer's inventory to which the license is to be applied. In some such examples, the node-locked license may be used to enable feature activation at the specific node on a limited basis until the provisional license has been completed. In some examples, the provisional licenses are generated as non-node locked. Such non-node locked licenses do not identify any specific nodes to which the provisional licenses are to be applied. In some such examples, the provisional license becomes “node locked” only when (after being applied at a node) the license is completed. Until that time, the provisional license is a “floating” license (e.g., non-node locked).

In some examples, the example license issuer 13408 can be implemented as a discrete group of license serving nodes, each having a different portion of the golden key. In some examples, the different portions of the key are distributed between at least 3 processors and each of the processors has to be queried to gather the corresponding portion of the key and thus, obtain, a license. In some examples, no single processor has access to all 3 portions of the provisional license. In some examples, a broader community of customers can access these delegated authority agents to manage and dispatch the provisional licenses. Once the license is deployed, the feature is activated. In some examples, although activated the feature may not be usable until the node has been rebooted and the license has been completed.

In some examples, the example license coordinator 13410 coordinates the application of a provisional license to a particular node (e.g., the CPU 13412) and further coordinates the completion of the provisional license. In some examples, to perform these activities, the license coordinator 13410 communicates with individual nodes (e.g., CPUs, GPUs, FPGAs, etc.) on the platform 13422 and (directly or indirectly) with devices that are off-platform (e.g., with the license issuer 13408 running in a local data center) (e.g., at a manufacture time of a device (e.g., a server, a controller, etc.) into which the hardware unit/node is being installed) and with the license verifier/completer 13402 (after the hardware platform 13422 is deployed in a target environment (e.g., the customer facility, a data center/facility, etc). In some examples, when, for example, a server is assembled at the customer's premises, the server (or other platform in which the hardware unit/node is installed) is powered on for a manufacturing testing, for firmware/software download, etc. In some examples, when the example platform 13422 powers on, the example license coordinator 13410 can contact the license issuer 13408 and request new licenses. In such examples, the platform 13422 (and/or in some examples, the CPU 13412) is configured to dynamically discover the license pool and request license and/or a target configuration for the platform. In some examples the individual SSKU′able silicon devices (e.g., the CPU 13412) may autonomously contact the license issuer 13408 and discover a desired configuration and/or request the license issuer 13408 to generate a provisional license for the SSKUable devices to utilize. In some examples, the license coordinator 13410 is implemented using a baseboard management controller (BMC), a specialized microcontroller embedded on the motherboard of a computer. The BMC manages the interface between system-management software and platform hardware.

The example CPU 13412 is an SSKU-able component which means that the component is a semiconductor device having one or more features that can be enabled via a hardware license (provisional or non-provisional). The CPU 13412 is capable of taking, for example, a provisional hardware license(s), applying one or more limitations to the feature associated with (e.g., enabled by) the provisional license (e.g., only enabling the features for a limited duration, number of operations, etc.), and completing the license (to become permanent and node-locked). In some examples, upon being supplied to the CPU 13412, the CPU verifies the authenticity/trustworthiness of the provisional license based on the golden issuing key information included in the license and, provided that the provisional license is successfully validated/authenticated, the CPU 13412 installs the provisional license. Installation of the provisional license enables activation of the feature(s) subject to the license and, after reboot of the CPU, allows the feature(s) to become operable. In some examples, post installation of the provisional license onto the CPU 13412 the provisional license is locked to the CPU 13412, at least provisionally. Thus, at this time, the provisional license is node-locked on a provisional basis. However, the provisional license is not permanently locked to the CPU 13412 until the completion operation is executed as described herein. In some examples, the license coordinator 13410 is tasked with validating/authenticating the provisional license. In some such examples, the CPU 13412 has a trust relationship with the license coordinator 13410 that is sufficient to allow the CPU 13412 to depend on the verification by the license coordinator 13410.

The example license verifier/completer 13402 is an off-platform entity (e.g., either a fully remote backend service (e.g., a cloud-based service) operated by the silicon manufacturer, such as Intel, or a local service/community of nodes to which such function has been delegated). The license verifier/completer 13402, when prompted, checks whether a provisional license (e.g., that is installed provisionally in a hardware unit/node (e.g., the example CPU 13412) is valid. The checking for license validity can include: 1) verifying that the provisional license was legitimately issued (e.g., was issued by the license issuer 13408 having the golden issue key supplied by the silicon manufacturer) 2) verifying that the provisional license does not exceed a (pre)purchased quantity of licenses), 3) verifying that the provisional license is unique, and 4) verifying that the provisional license is properly installed on the hardware unit/node (as vouched-for by the hardware unit/node itself inside of a completion request), etc. The license verifier/completer 13402 may also verify any number of other aspects related to the provisional license. In some examples, the operations shown as being performed at (or by) the backend (cloud based) service provided by the silicon manufacturer can be performed by any entity to whom these operations have been delegated by the silicon manufacturer. In some examples, the entity can include a higher-trust component running on-customer premises, a distributed ledger, etc. To provide the silicon manufacturer with reassurances that the provisional licenses issued by a component running on the customer's premises are completed with proper authentication and tracking, such an entity may employ the license verifier/completer 13402 using a hardware security module (HSM), a trusted execution environment (TEE), and/or by running the component in a highly distributed environment such that no single entity has the ability to change the verification/completion records, etc.

In some examples, the billing transaction checker 13404, at the instruction of, for example, the example license verifier/completer 13402, logs the completion event by which the provisional license is converted to a completed, full, node-locked license and other related information. For example, the billing transaction checker 13402 can log a node identifier (“ID”) that is unique to the node to which the license is locked, information describing the license and the hardware features activated thereby, and information identifying the customer that owns the node to which the license is locked. The information logged by the billing transaction checker 13404 can then be used by any backend billing system operated by the silicon manufacturer. In some examples, both pre-paid and post-paid models are supported. For example, the golden key may be already created and billed for the generation of an amount of (“N”) licenses. Also, or alternatively, billing may only occur for licenses that are already deployed and completed.

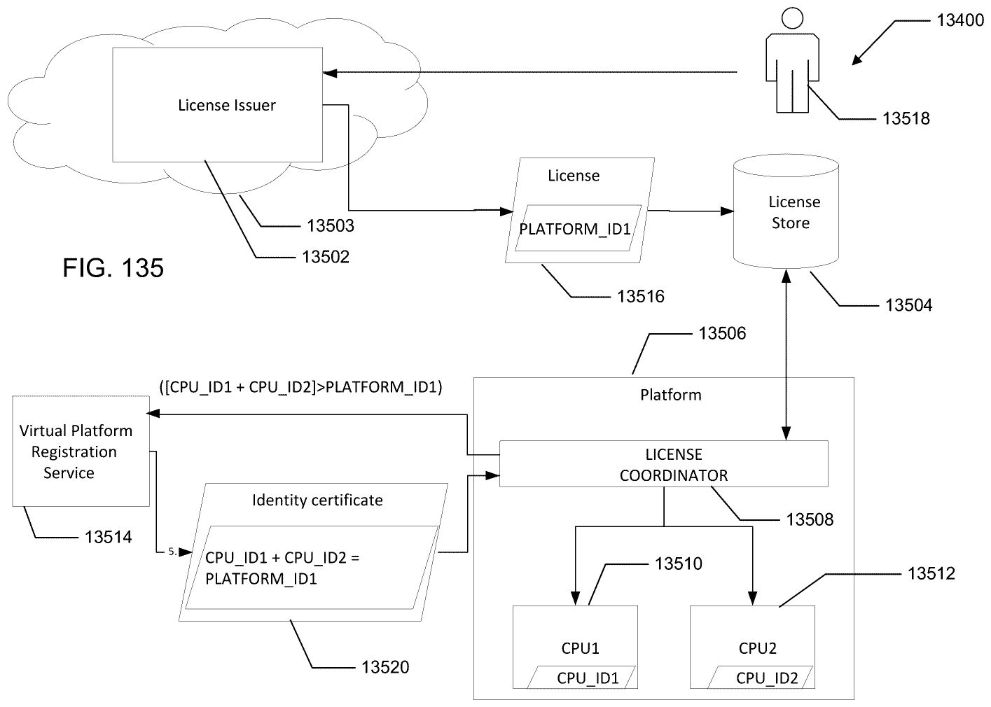

Turning to FIG. 135, an example system 13500 to generate virtual provisional licenses against a virtual (e.g., is not a physical object) hardware unit/node that has been assigned a unique identifier (e.g., a string of alphanumeric characters). At the time of generation of the provisional license, the physical units/nodes that will eventually be associated with the virtual provisional license are not yet known. In some examples, the system 13500 includes an example license issuer 13502 that is accessed via, for example, an example cloud KB203. The system 13500 also includes an example license store 13504, an example hardware platform 13506, an example license coordinator 13508, an example first CPU (CPU_ID1) 13510, an example second CPU (CPU_ID2) 13512, and an example virtual platform registration service 13514. As further illustrated in FIG. KDB2, a virtual node-locked provisional license 13516 is supplied by the example license issuer 13502 to the example license store 13504. In some examples, the virtual provisional license 13516 results from an order placed by a customer 13518.

In the example system 13500, the example license issuer 13502 is configured to issue licenses (e.g., licenses that are intended for a hardware node with a virtual identity (e.g., “PLATFORM_ID1”). The example license store 13504 holds the issued licenses and provides them to the license coordinator 13508 upon request. An example virtual platform registration service 13514 certifies a virtual identity for a hardware unit (or a set thereof, e.g., constituting a logical platform) and issues an example identity certificate 13520.

The identity certificate 13520 allows any entity identified in the certificate (e.g. CPU_ID1, CPU_ID2, etc.) to assume the new identity of PLATFORM_ID1 and apply licenses targeted at PLATFORM_ID1. Each identity certificate is signed, and a node (e.g. CPU_ID1, CPU_ID2, etc.) will only assume an identity for which a valid registration service (e.g., the virtual platform registration service 13514) has issued a certificate such that unauthorized virtual provisional licenses are prevented. Thus, the manner in which the licenses are issued is secure and prevents unauthorized uses of licenses, as long as the virtual platform registration service 13514 abides by pre-established identity certification policies. Exemplary policies may include: 1) a concrete CPU can only be a member of a single virtual platform at a time, 2) only a pre-approved license requestor can request identities from a certain pool—e.g. an OEM can only request identities pre-assigned to the OEM company, 3) all platform components are genuine and in good standing (not revoked or recalled by the manufacturer), etc.

In some examples, physical CPUs (e.g., CPU1 and CPU2) originate a request to the virtual platform registration service 13514. The request includes a request to assign the virtual provisional license to the physical hardware units/nodes (e.g., CPU1 and CPU2) that reside in a physical platform. Thus the request also includes a virtual platform ID and information identifying the physical hardware units/node (e.g., CPU1 and CPU2).

The virtual platform registration service 13514 determines whether the physical hardware units/nodes (e.g., CPU1 and CPU2) are authentic (e.g., proven via a certificate that the units/node were produced by the manufacturer or have a unique ID that is known to the manufacturer. The virtual platform registration service 13514 further verifies that the hardware units/nodes (e.g., CPU1 and CPU2) and not part of any other platform and additionally performs other policy checks including proof of possession, whether there is a possible additional monetization point, etc. The virtual platform registration service then signs and issues an Identity Certificate 13520 for the claimed ID (e.g., the virtual platform ID) and the hardware units/nodes (e.g., CPU1 and CPU2) are permitted to convert the provisional hardware license(s) into non-provisional licenses. Thus, any CPU, having received a valid Identity Certificate is subsequently allowed to *assume* the identity that the CPU has been certified for (e.g., the virtual/alias ID of the virtual platform).

In some examples, the virtual platform registration service 13514 is a backend service operated by a hardware-manufacturer. In some examples, the virtual platform registration service 13514 is a local server or a community of nodes on the hardware platform itself or is on the customer side and operates as an authority that has been delegated by such manufacturer. In some examples, the visual platform registration system 13514 can be implemented as an On-Die Certification Authority. An On-Die Certification Authority is a feature added to hardware and/or to the platform 13506 and is used for issuing trusted certificates. In some examples, the identity certificate can be provisioned when a customer is building a device into which the platform is to be installed. In some examples, the identity certificate can be provisioned at a later time (e.g., upon deployment of the platform in the field).

The operational flow by which a license is issued for a virtual identity generally follows the same flow as the operations indicated for the system 13400 reflected in FIG. 13400 and described in 136 (see below). The primary difference lies in the fact that the example license issuer 13502 issues a virtual provisional license that is targeted for and node-locked to a virtual platform upon being generated. The license becomes node locked by assigning the license for usage on a virtual platform having a virtual platform ID number. The example license coordinator BKD208 of the example platform 13506 requests (and receives) the issued virtual license from the example license store 13504. The virtual license is supplied to the first CPU1 13510 and the second CPU2 13512. The first CPU1 13510 and the second CPU2 13512 install the provisional virtual license(s) and then seek permission for the hardware units/nodes first CPU1 13510 and the second CPU2 13512 to permanently assume the identity of the virtual platform from the virtual platform registration service 13514. As described above, the virtual platform registration service 13514 creates an identity certificate 13520 which identifies the virtual platform PLATFORM_ID1 as including the first CPU1 13510 and the second CPU2 13512. Thereafter, the identity certificate 13520 is supplied to the license coordinator 13508 which supplies the identity certificate to the first CPU1 13510 and the second CPU2 13512 for use in converting the provisional license to a non-provisional (e.g., unconditional) license.

At various times as described herein, connectivity between, for example, the silicon manufacturer and the customer changes. The times when connectivity is available and not available varies depending on the stage of the manufacture/usage of the hardware node/unit. For example, when a customer wants to have a license issuer 13408 on the customer premises, the customer has at least some level of connectivity with the silicon manufacturer so that the golden issuing key and/or virtual node-lock provisional licenses can be transferred from the silicon manufacturer to the customer. This transfer may involve a temporal/one-time communication event that occurs early (e.g., at a time when the customer places an order for a desired number of hardware nodes/units and hardware feature activation license). When the platform is at the customer premises and is being used to assemble/manufacture a device including the hardware node/unit, there is no need for (and likely is not any) connectivity between the customer side and silicon manufacturer side (e.g., the platform is offline). Later, when, for example, the platform is deployed, there is a live connectivity between the hardware platform and the silicon manufacturer. Thus, a key advantage of the systems of FIGS. 134 and 135 is that it allows for the installation of hardware licenses during assembly of a device at a customer premise, even if the customer premises is a dark/offline facility.

While an example manner of implementing the first system 13400 is illustrated in FIG. 134, one or more of the elements, processes, and/or devices illustrated in FIG. 134 may be combined, divided, re-arranged, omitted, eliminated, and/or implemented in any other way. Further, the example system license verifier/completer 13402, the example billing/transaction checker 13404, the example license issuer 13408, the example license coordinator 13410, the example computer processing unit (CPU) 13412, the example policy engine 13414, the example timer 13416, the example license expiration monitor 13418, the example license completion event/trigger monitor 13420, the example hardware platform 13422 and/or, more generally, the example system 13400 of FIG. 134, may be implemented by hardware alone or by hardware in combination with software and/or firmware. Thus, for example, any of the example system license verifier/completer 13402, the example billing/transaction checker 13404, the example license issuer 13408, the example license coordinator 13410, the example computer processing unit (CPU) 13412, the example policy engine 13414, the example timer 13416, the example license expiration monitor 13418, the example license completion event/trigger monitor 13420, the example hardware platform 13422 and/or, more generally, the example system 13400 of FIG. 134, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example system 13400 of FIG. 134 may include one or more elements, processes, and/or devices in addition to, or instead of, those illustrated in FIG. 134 and/or may include more than one of any or all of the illustrated elements, processes and devices.

While an example manner of implementing the second system 13500 is illustrated in FIG. 135, one or more of the elements, processes, and/or devices illustrated in FIG. 135 may be combined, divided, re-arranged, omitted, eliminated, and/or implemented in any other way. Further, the example license issuer 13502, the example license store 13504, the example platform 13506, the example license coordinator 13508, the example CPUs 13510 and/or 13512, the example virtual platform registration service 13514 and/or, more generally, the example system 13500 of FIG. 135, may be implemented by hardware alone or by hardware in combination with software and/or firmware. Thus, for example, any of the example license issuer 13502, the example license store 13504, the example platform 13506, the example license coordinator 13508, the example CPUs 13510 and/or 13512, the example virtual platform registration service 13514 and/or, more generally, the example system 13500 of FIG. 135, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example system 13500 of FIG. 135 may include one or more elements, processes, and/or devices in addition to, or instead of, those illustrated in FIG. 135 and/or may include more than one of any or all of the illustrated elements, processes and devices.

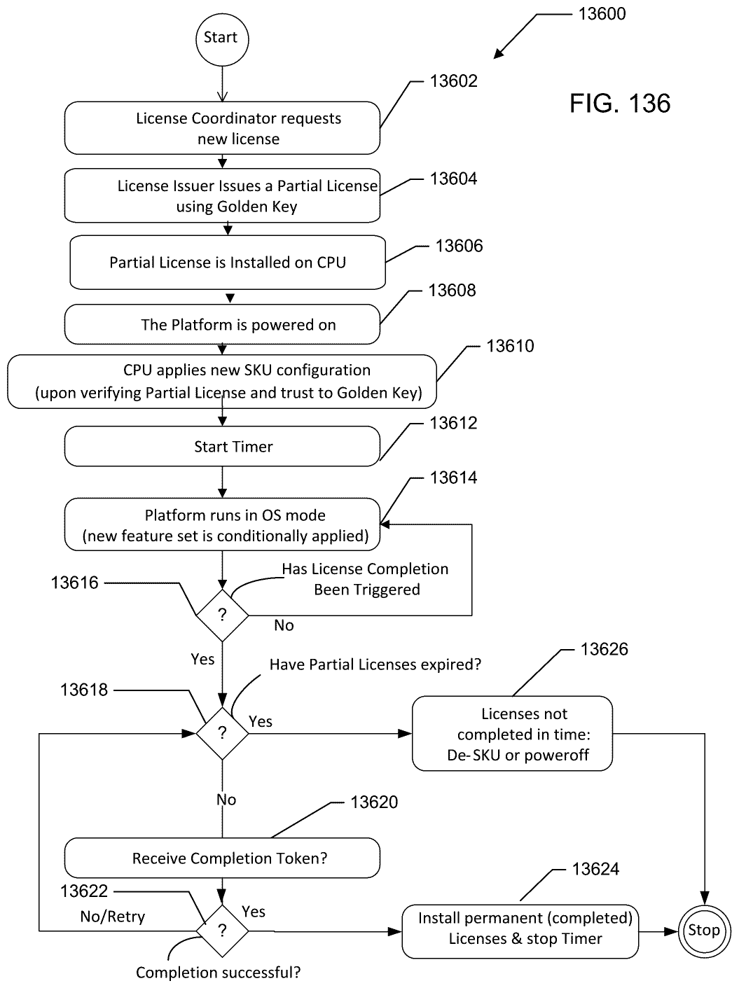

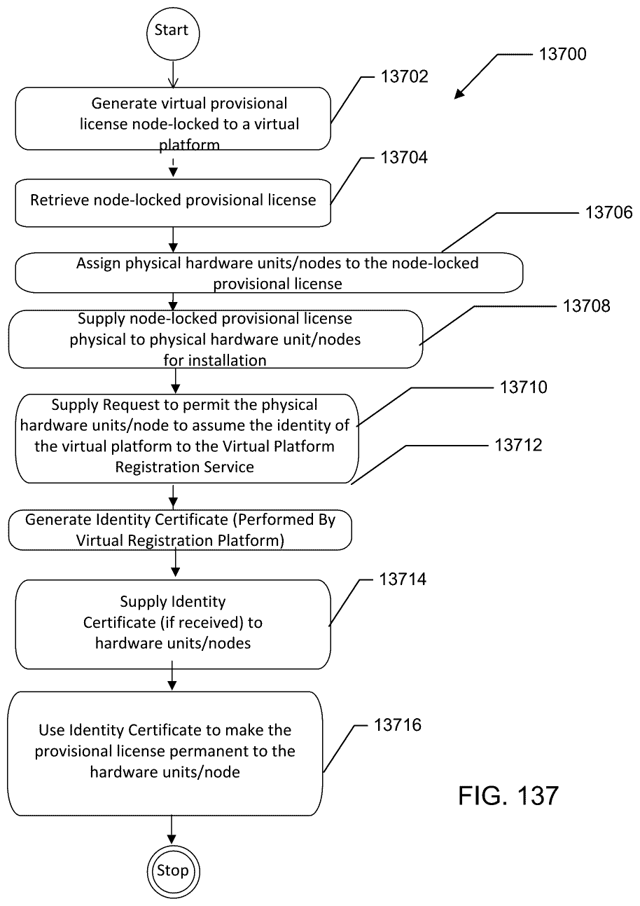

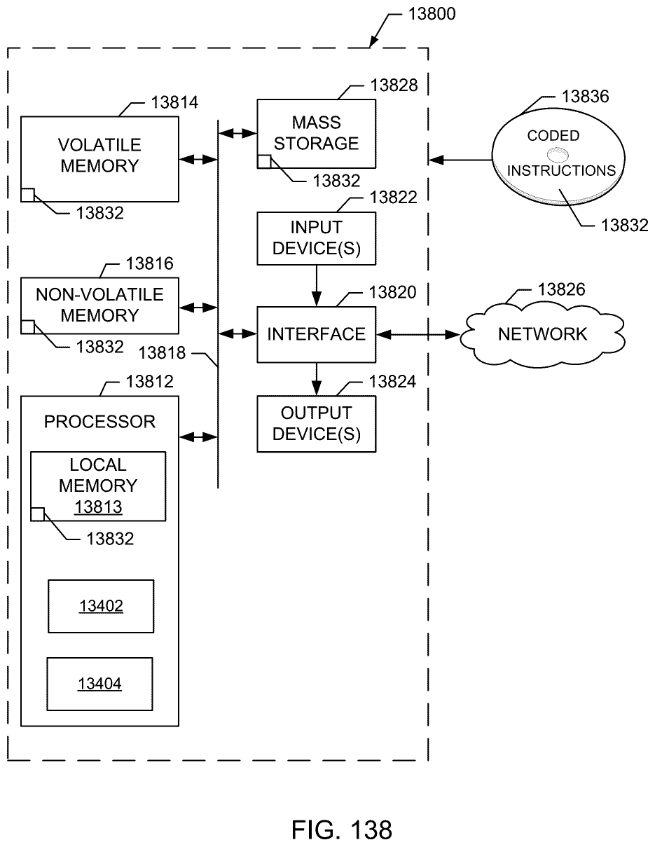

A flowchart representative of example machine readable instructions which may be executed to configure processor circuitry to implement the system 13400 of FIG. 134 is shown in FIG. 136, and a flowchart representative of example machine readable instructions which may be executed to configure processor circuitry to implement the system 13500 of FIG. 135 is shown in FIG. 137. The machine readable instructions may be one or more executable programs or portion(s) of an executable program for execution by processor circuitry, such as the processor circuitry 13812, 13912, 14012 AND/PR 14112 shown in the example processor platforms 13800, 13900, 14000 and/or 14100 discussed below in connection with FIGS. 138-141 and/or the example processor circuitry discussed below in connection with FIGS. 150 and/or 151. The program(s) may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program(s) and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program(s) is(are) described with reference to the flowchart illustrated in FIG. 136, and the flowchart illustrated in FIG. 137 many other methods of implementing the example system 134 and the example system 135 may alternatively be used. For example, the order of execution of the blocks may be changed, and/or some of the blocks described may be changed, eliminated, combined and/or subdivided into multiple blocks. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 136 and FIG. 137 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media. Also, as used herein, the terms “computer readable” and “machine readable” are considered equivalent unless indicated otherwise.

FIG. 136 is a flowchart representative of example machine readable instructions and/or example operations 13600 that may be executed and/or instantiated by processor circuitry to implement the non-node locked licensing system of FIG. 134. With reference to the preceding figures and associated written descriptions, the machine readable instructions and/or the operations 13600 of FIG. 136 begin at block 13602, at which the license coordinator 13400 (or any other on-platform or off-platform agent capable of making a license request) requests a new provisional license from the license issuer 13408. In response, the license issuer 13408 grants a provisional license (see block 13604) to the license coordinator. As described above, in some examples, the license issuer 13408 issues the provisional license to be bound to the CPU 13412 for which the provisional license is targeted. In some examples, the license pool issues the provisional license as a non-node license in that the provisional license is not bound to any particular node but is instead “floating.” In cases in which the provisional license is floating, the provisional license can become bound to the CPU at the time of completion of the license.

Either the example license issuer 13408 or the license coordinator 13410 supplies the provisional license to the CPU 13412 and the CPU 13412 installs the provisional license (see block 13606). In some examples, before installing the provisional license, the CPU 13412 verifies that the golden key associated with the provisional license is valid and may take any number of other actions to verify the validity of the provisional license as described above.

At a later time (a possibly much later time (e.g., a deploy time), the platform 13422 (including the CPU 13412) boots (or reboots or otherwise powers on) (e.g., in the field) (see block 13608). Prior to powering on the platform, the CPU may be idle and the platform may appear to be “off” but the license coordinator is typically still active and able to communicate with both on-platform and off-platform devices. Upon booting up, the CPU 13412 applies the new SKU configuration associated with the provisional license such that corresponding new feature set is enabled (see block 13610). In some examples, the CPU 13412 verifies the authenticity of the provisional license, based on the golden key, after booting up instead of upon installation. Since the license is still incomplete at this time, the example policy engine 13414 within the hardware platform KBD 122 applies the provisional conditions to the license. In some examples, the policy engine 13414 can start a timer (also referred to as the completion timer 13416) (see block 13612). In some examples, the policy engine 13414 can measure other metrics, such as a volume of data processed by the CPU 13412 as of the activation of the new feature set, an amount of load processed by the CPU 13412 as of the activation of the new feature set, a number of power cycles executed as of the activation of the new feature set, etc. Until that metric is satisfied, the platform 13422 boots in a standard manner all the way up to the operating system and thereafter operates with the new feature set available (see block 13614). In some examples, a license completion event monitor 13420 checks for the presence of a completion trigger when the platform 13422 is operating (see block 13616). For security purposes and to ensure that invalid (uncompleted licenses are not permitted to operation beyond the expiration point of the provisional license, the monitors 13420 and KBD 118 are typically part of the CPU 13412 (although shown as residing outside of the CPU in FIG. 134). When a completion trigger has not yet occurred, flow returns to block 13614. When the completion event monitor 13420 detects the completion trigger, the example license expiration monitor 13418 determines whether the provisional license is still valid or has instead expired (see block 13618). If the provisional license has expired (as determined by the license expiration monitor 13418) the CPU 13412 and/or the platform 13422 will de-SKU and immediately power off and/or take other protective/remediation actions (see block 13626). After the shut down or other redemiative measures are taken, the method of the flowchart 13600 ends.

Provided that the provisional license has not yet expired (as determined at block 13616), either of the license coordinator 13410 (e.g., a BMC) or the operating system itself (e.g., the CPU 13412), executes to performs operations to obtain the authorization needed to complete the provisional license (see block 13620). In some examples, the operations include invoking a protocol with the license verifier/completer 13402 by which the authorization to complete the provisional license is requested/granted. If the license verifier/completer 13402 successfully verifies that the provisional license can be completed, the license verifier/completer 13402 issues a Completion Token to the license coordinator 13400. If the necessary authorizations are received (as verified at block 13622), the CPU 13412 performs the actions needed to permanently install the license and also stops the timer 13416 (see block 13624). In some examples, the receipt of a completion token by the CPU is an indication that the license is cleared for conversion from a provisional license to a complete license. In some examples, at least one of the actions taken by the CPU 13412 to complete the conversion of the provisional license includes installing the completion token. Once the license has been installed as permanent, the method represented by the flowchart of 136 ends.

If, the provisional license expires (as determined by the license expiration monitor) (see block 13618) before the completion operation is successful, the license coordinator 13410 and/or the CPU 13412 takes actions to De-SKU and/or power off (see block 13626). In some examples, the provisional license can expire before successful completion due to intermittent connectivity issues, due to the platform not reacting properly to the completion triggering event, or due to the verifier rejecting the request for completion.

Note that, a legitimate/genuine platform, upon notification (from the license verifier) that the request to convert the provisional license to a full license has been denied, would de-SKU immediately. In the event that the platform asking to convert the provisional license is fraudulent and not abiding by the protocol, as long as the hardware itself is able to enforce the provisional license conditions (e.g., timer), such a platform is prevented from attempting to extend the provisional license infinitely, as the hardware-enforced provisional timer (e.g., the timer) will automatically expire if completion does not occur before expiry.

FIG. 137 is a flowchart representative of example machine readable instructions and/or example operations 13700 that may be executed and/or instantiated by processor circuitry to implement the virtual provisional licensing system of FIG. 135. With reference to the preceding figures and associated written descriptions, the machine readable instructions and/or the operations 13700 of FIG. 137 begin at block 13602, at which the license issuer 13502 (or any other on-platform or off-platform agent capable of making a license request) generates a new node-locked license for a virtual platform to which hardware units/nodes have not yet been assigned. In some examples, the new node-locked license is generated in response to a request/order initiated by a customer. The example license issuer 13502 which may reside in the cloud 13503 transmits the license to an example license store KBD 204. The example license store may be associated with the customer who initiated the order or may be a repository for licenses associated with multiple customers. In some examples, the example license coordinator 13508 retrieves the provisional license for the virtual platform (PLATFORM_ID1) from the license store KBD 204 (see block 13704). The license coordinator 13508 assigns the provisional license to two (or any number of hardware units/nodes) hardware nodes (e.g., CPU_ID1 and CPU_ID2) (see block 13706). In addition, the license coordinator 13508 supplies the provisional license to the hardware nodes (e.g., CPU_ID1 and CPU_ID2) for installation (see block 13708). The hardware nodes (e.g., CPU_ID1 and CPU_ID2) take the same measures described for the CPU 13412 of FIG. 134 in 136 to install the license and to take measures to ensure that the licenses are only installed on a temporary basis pending completion of the particle license and are thus, not repeated here. At block KFC 212, the example virtual platform registration service 13514 generates an example identity certificate (13520 of FIG. 135). The license coordinator 13508 responds to receipt of the identity certificate by supplying the certificates to the hardware nodes identified on the certified (in this example, CPU_ID1 and CPU_ID2) (see block KFC 214). The CPU_ID1 and CPU_ID2 respond to the certificate by completing the licenses. Upon completion, the licenses are bound to the CPU_ID1 and CPU_ID2 (see block KFC 216). As described with reference to FIG. 136, the CPU_ID1 and CPU_ID2 take measures to ensure that the provisional license hasn't expired before performing the completion and thus, such actions, are not described here. After the block 13716, the method ends.

FIG. 138 is a block diagram of an example processor platform 13800 structured to execute and/or instantiate the machine readable instructions and/or the operations of FIG. 136 to implement the example system license verifier/completer 13402 and/or the example billing/transaction checker 13404 of the example system 13400 of FIG. 134. The processor platform 13800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 13800 of the illustrated example includes processor circuitry 13812. The processor circuitry 13812 of the illustrated example is hardware. For example, the processor circuitry 13812 can be implemented by one or more integrated circuits, logic circuits, FPGAs, microprocessors, CPUs, GPUs, DSPs, and/or microcontrollers from any desired family or manufacturer. The processor circuitry 13812 may be implemented by one or more semiconductor based (e.g., silicon based) devices. In this example, the processor circuitry 13812 implements the example system license verifier/completer 13402 and/or the example billing/transaction checker 13404.

The processor circuitry 13812 of the illustrated example includes a local memory 13813 (e.g., a cache, registers, etc.). The processor circuitry 13812 of the illustrated example is in communication with a main memory including a volatile memory 13814 and a non-volatile memory 13816 by a bus 13818. The volatile memory 13814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 13816 may be implemented by flash memory and/or any other desired type of memory device. Access to the main memory 13814, 13816 of the illustrated example is controlled by a memory controller 13817.

The processor platform 13800 of the illustrated example also includes interface circuitry 13820. The interface circuitry 13820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 13822 are connected to the interface circuitry 13820. The input device(s) 13822 permit(s) a user to enter data and/or commands into the processor circuitry 13812. The input device(s) 13822 can be implemented by, for example, an audio sensor, a microphone, a camera (still or video), a keyboard, a button, a mouse, a touchscreen, a track-pad, a trackball, a trackbar, an isopoint device, a voice recognition system and/or any other human-machine interface. In some examples, the input device(s) 13822 are arranged or otherwise configured to allow the user to control the processor platform 13800 and provide data to the processor platform 13800 using physical gestures, such as, but not limited to, hand or body movements, facial expressions, face recognition, etc.

One or more output devices 13824 are also connected to the interface circuitry 13820 of the illustrated example. The output device(s) 13824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 13820 of the illustrated example, thus, typically includes a graphics driver card, a graphics driver chip, and/or graphics processor circuitry such as a GPU.

The interface circuitry 13820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 13826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 13800 of the illustrated example also includes one or more mass storage devices 13828 to store software and/or data. Examples of such mass storage devices 13828 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 13832, which may be implemented by the machine readable instructions of FIG. 136, may be stored in the mass storage device 13828, in the volatile memory 13814, in the non-volatile memory 13816, and/or on a removable non-transitory computer readable storage medium such as a CD or DVD.

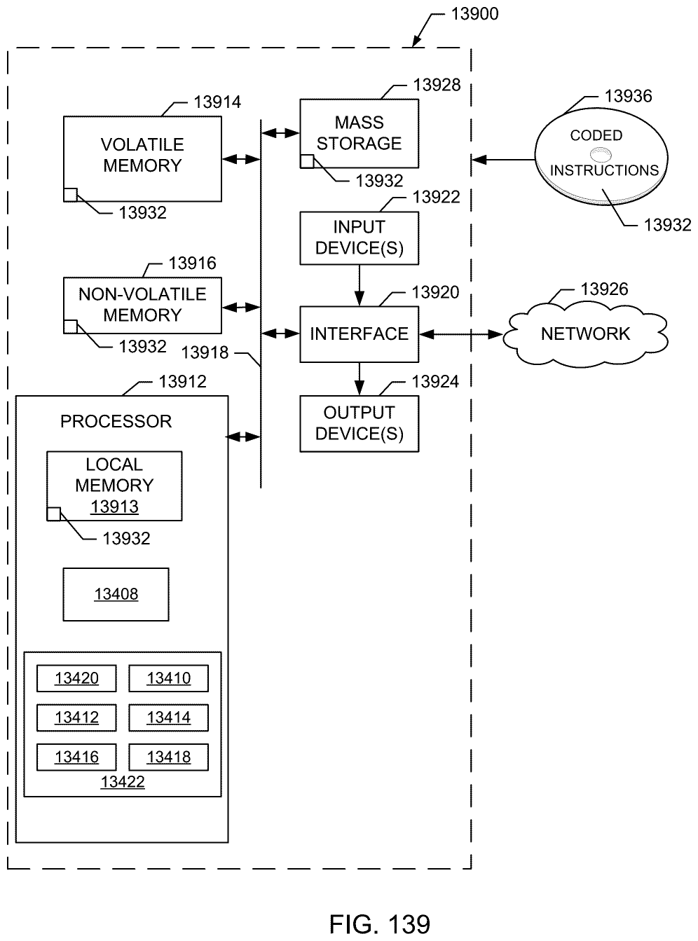

FIG. 139 is a block diagram of an example processor platform 13900 structured to execute and/or instantiate the machine readable instructions and/or the operations of FIG. 136 to implement the example license issuer 13408 and/or the example hardware platform 13422 of the example system 13400 of FIG. 134. The processor platform 13900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 13900 of the illustrated example includes processor circuitry 13912. The processor circuitry 13912 of the illustrated example is hardware. For example, the processor circuitry 13912 can be implemented by one or more integrated circuits, logic circuits, FPGAs, microprocessors, CPUs, GPUs, DSPs, and/or microcontrollers from any desired family or manufacturer. The processor circuitry 13912 may be implemented by one or more semiconductor based (e.g., silicon based) devices. In this example, the processor circuitry 13912 implements the example license issuer 13408 and/or the example license coordinator 13410, the example CPU 13412, the example policy engine 13414, the example timer 13416, the example license expiration monitor 13418 and/or the example license completion event/trigger monitor 13420 of the example hardware platform 13422.

The processor circuitry 13912 of the illustrated example includes a local memory 13913 (e.g., a cache, registers, etc.). The processor circuitry 13912 of the illustrated example is in communication with a main memory including a volatile memory 13914 and a non-volatile memory 13916 by a bus 13918. The volatile memory 13914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 13916 may be implemented by flash memory and/or any other desired type of memory device. Access to the main memory 13914, 13916 of the illustrated example is controlled by a memory controller 13917.

The processor platform 13900 of the illustrated example also includes interface circuitry 13920. The interface circuitry 13920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 13922 are connected to the interface circuitry 13920. The input device(s) 13922 permit(s) a user to enter data and/or commands into the processor circuitry 13912. The input device(s) 13922 can be implemented by, for example, an audio sensor, a microphone, a camera (still or video), a keyboard, a button, a mouse, a touchscreen, a track-pad, a trackball, a trackbar, an isopoint device, a voice recognition system and/or any other human-machine interface. In some examples, the input device(s) 13922 are arranged or otherwise configured to allow the user to control the processor platform 13900 and provide data to the processor platform 13900 using physical gestures, such as, but not limited to, hand or body movements, facial expressions, face recognition, etc.

One or more output devices 13924 are also connected to the interface circuitry 13920 of the illustrated example. The output device(s) 13924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 13920 of the illustrated example, thus, typically includes a graphics driver card, a graphics driver chip, and/or graphics processor circuitry such as a GPU.

The interface circuitry 13920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 13926. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 13900 of the illustrated example also includes one or more mass storage devices 13928 to store software and/or data. Examples of such mass storage devices 13928 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 13932, which may be implemented by the machine readable instructions of FIG. 136, may be stored in the mass storage device 13928, in the volatile memory 13914, in the non-volatile memory 13916, and/or on a removable non-transitory computer readable storage medium such as a CD or DVD.

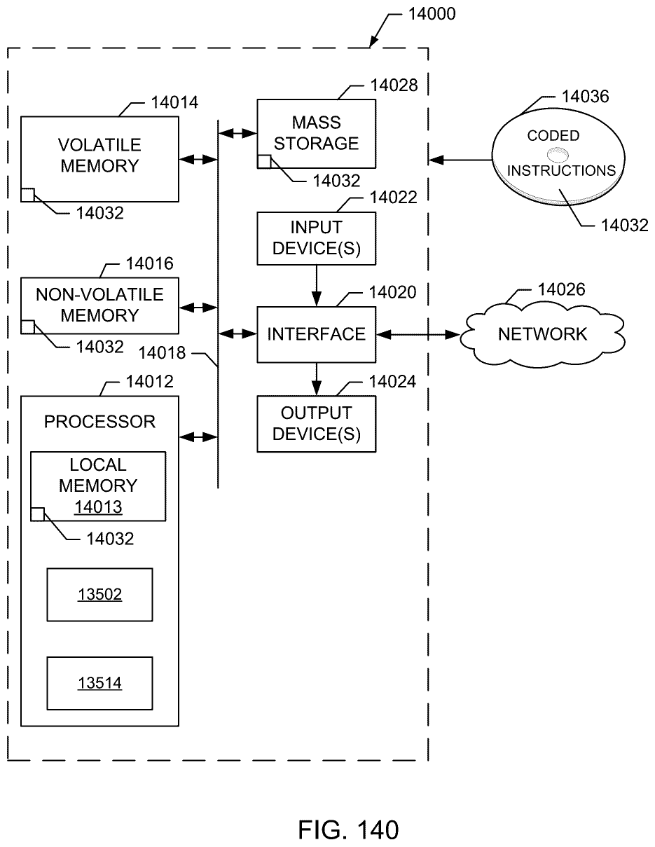

FIG. 140 is a block diagram of an example processor platform 14000 structured to execute and/or instantiate the machine readable instructions and/or the operations of FIG. KFP2 to implement the example license issuer 13502 and/or the example virtual platform registration service 13514 of the example system 13500 of FIG. 135. The processor platform 14000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 14000 of the illustrated example includes processor circuitry 14012. The processor circuitry 14012 of the illustrated example is hardware. For example, the processor circuitry 14012 can be implemented by one or more integrated circuits, logic circuits, FPGAs, microprocessors, CPUs, GPUs, DSPs, and/or microcontrollers from any desired family or manufacturer. The processor circuitry 14012 may be implemented by one or more semiconductor based (e.g., silicon based) devices. In this example, the processor circuitry 14012 implements the example license issuer 13502 and/or the example virtual platform registration service 13514.

The processor circuitry 14012 of the illustrated example includes a local memory 14013 (e.g., a cache, registers, etc.). The processor circuitry 14012 of the illustrated example is in communication with a main memory including a volatile memory 14014 and a non-volatile memory 14016 by a bus 14018. The volatile memory 14014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 14016 may be implemented by flash memory and/or any other desired type of memory device. Access to the main memory 14014, 14016 of the illustrated example is controlled by a memory controller 14017.

The processor platform 14000 of the illustrated example also includes interface circuitry 14020. The interface circuitry 14020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 14022 are connected to the interface circuitry 14020. The input device(s) 14022 permit(s) a user to enter data and/or commands into the processor circuitry 14012. The input device(s) 14022 can be implemented by, for example, an audio sensor, a microphone, a camera (still or video), a keyboard, a button, a mouse, a touchscreen, a track-pad, a trackball, a trackbar, an isopoint device, a voice recognition system and/or any other human-machine interface. In some examples, the input device(s) 14022 are arranged or otherwise configured to allow the user to control the processor platform 14000 and provide data to the processor platform 14000 using physical gestures, such as, but not limited to, hand or body movements, facial expressions, face recognition, etc.

One or more output devices 14024 are also connected to the interface circuitry 14020 of the illustrated example. The output device(s) 14024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 14020 of the illustrated example, thus, typically includes a graphics driver card, a graphics driver chip, and/or graphics processor circuitry such as a GPU.

The interface circuitry 14020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 14026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 14000 of the illustrated example also includes one or more mass storage devices 14028 to store software and/or data. Examples of such mass storage devices 14028 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 14032, which may be implemented by the machine readable instructions of FIG. KFP2, may be stored in the mass storage device 14028, in the volatile memory 14014, in the non-volatile memory 14016, and/or on a removable non-transitory computer readable storage medium such as a CD or DVD.

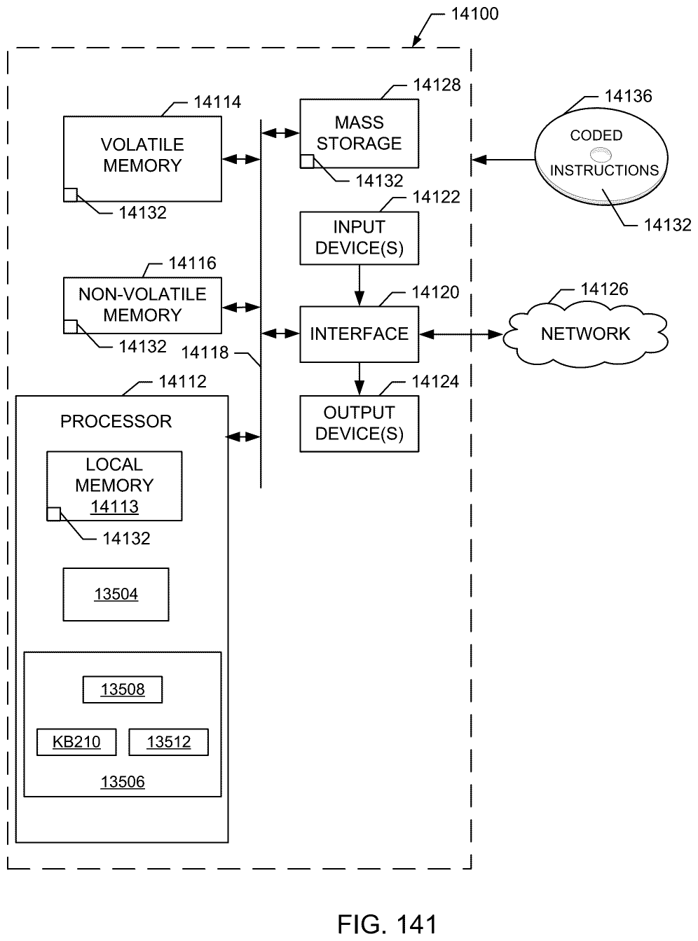

FIG. 141 is a block diagram of an example processor platform 14100 structured to execute and/or instantiate the machine readable instructions and/or the operations of FIG. KFP2 to implement the example license store 13504 and/or the example platform 13506 of the example system 13500 of FIG. 135. The processor platform 14100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 14100 of the illustrated example includes processor circuitry 14112. The processor circuitry 14112 of the illustrated example is hardware. For example, the processor circuitry 14112 can be implemented by one or more integrated circuits, logic circuits, FPGAs, microprocessors, CPUs, GPUs, DSPs, and/or microcontrollers from any desired family or manufacturer. The processor circuitry 14112 may be implemented by one or more semiconductor based (e.g., silicon based) devices. In this example, the processor circuitry 14112 implements the example license store 13504 and/or the example license coordinator 13508, the example CPU 13510 and/or the example CPU 13510 of the example platform 13506 of the example system 13500.

The processor circuitry 14112 of the illustrated example includes a local memory 14113 (e.g., a cache, registers, etc.). The processor circuitry 14112 of the illustrated example is in communication with a main memory including a volatile memory 14114 and a non-volatile memory 14116 by a bus 14118. The volatile memory 14114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 14116 may be implemented by flash memory and/or any other desired type of memory device. Access to the main memory 14114, 14116 of the illustrated example is controlled by a memory controller 14117.

The processor platform 14100 of the illustrated example also includes interface circuitry 14120. The interface circuitry 14120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 14122 are connected to the interface circuitry 14120. The input device(s) 14122 permit(s) a user to enter data and/or commands into the processor circuitry 14112. The input device(s) 14122 can be implemented by, for example, an audio sensor, a microphone, a camera (still or video), a keyboard, a button, a mouse, a touchscreen, a track-pad, a trackball, a trackbar, an isopoint device, a voice recognition system and/or any other human-machine interface. In some examples, the input device(s) 14122 are arranged or otherwise configured to allow the user to control the processor platform 14100 and provide data to the processor platform 14100 using physical gestures, such as, but not limited to, hand or body movements, facial expressions, face recognition, etc.

One or more output devices 14124 are also connected to the interface circuitry 14120 of the illustrated example. The output device(s) 14124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 14120 of the illustrated example, thus, typically includes a graphics driver card, a graphics driver chip, and/or graphics processor circuitry such as a GPU.

The interface circuitry 14120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 14126. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 14100 of the illustrated example also includes one or more mass storage devices 14128 to store software and/or data. Examples of such mass storage devices 14128 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 14132, which may be implemented by the machine readable instructions of FIG. KFP2, may be stored in the mass storage device 14128, in the volatile memory 14114, in the non-volatile memory 14116, and/or on a removable non-transitory computer readable storage medium such as a CD or DVD.

From the foregoing, it will be appreciated that example systems, methods, apparatus, and articles of manufacture have been disclosed that enable the issuance and installation of non-node locked hardware licenses. Disclosed systems, methods, apparatus, and articles of manufacture improve the efficiency of using a computing device by enabling the issuance of floating hardware licenses (e.g., non-node locked) that can, at a later time, be locked to a node. Disclosed systems, methods, apparatus, and articles of manufacture are accordingly directed to one or more improvement(s) in the operation of a machine such as a computer or other electronic and/or mechanical device.

Non-Node Locked Licenses via Blockchain

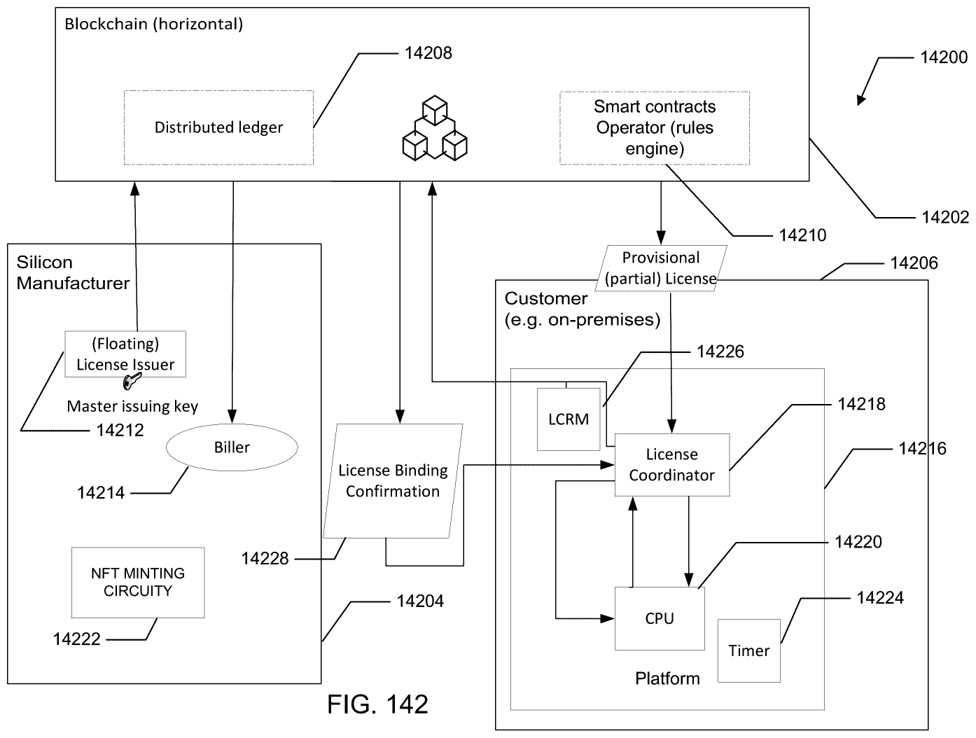

FIG. 142 illustrates a block diagram of an example system 14200 to generate hardware upgrade license that is not assigned to a particular hardware node at the time that the hardware node is manufactured or at the time that that provisional license is generated but at a time occurring after the hardware upgrade license has been provisioned. Conventionally, a silicon purchaser/customer informs a silicon manufacturer of a target hardware base and feature set desired by the purchaser/customer when an order for silicon is placed. Using this purchaser-specified information, the silicon nodes are manufactured to node-locked licenses. Node-locked licenses, as used herein, refers to node/unit-specific licenses, e.g., licenses that are targeted at a specific, concrete hardware node/unit at the time of purchase of the license. Such licenses need not be fully installed at the time of manufacture but can instead become fully installed at a purchaser's facility, even when the targeted node/unit is offline, using software-defined silicon techniques.

In today's world, datacenters are highly volatile and the hardware/processing needs of a datacenter operator are constantly in-flux. As a result, it is difficult and sometimes impossible for a silicon customer/purchaser to accurately predict, at the time of order-placement, which of several target hardware bases and/or feature sets will be needed. Further, in OEM manufacturing, an identifier “ID” of a hardware node/unit to be put into, for example, a server, is not typically known until assembly of the server has begun, thus complicating the locking of licenses to a node/unit based on an ID at the time of manufacture of the unit/node. Due to both the customer's desire to defer license-to-node lock to the time of installation (e.g., during manufacturing) instead of at the time of order placement, and the realities of OEM manufacturing, the system 14200 of FIG. 142 performs software-defined silicon licensing with non-node locked licenses. As described further below, the non-node locked licenses can be locked to a specific node/unit when the node/unit is at the customer's premises. In some cases, a hardware platform located at the customer's premises need not even contact the manufacturer to convert a partial license to a complete license.

In some examples, the system 14200 uses blockchain to allow the usage of partial non-node locked licenses in environments in which pre-generated node-locked licenses are not feasible (e.g., OxM manufacturing). Due, in part, to the distributed nature, blockchain provides fault tolerance as well as rapid license acquisition/confirmation, while eliminating the need to communicate with a centralized manufacturer. In addition, the system 14200 provides allows a customer to establish a usable and valid non node locked license without having to disclose anything about a feature being license or a customer/purchaser of a silicon device in which the license is deployed. Furthermore, and as described further below, a non-fungible token minted on a hardware platform and minted for hardware platform specific licenses provides traceability, asset security and management without the visibility needed in current licensing mechanisms. Thus, the system 14200 provides licensing that preserves privacy while maintaining contract adherence.

As a result, the system 14200 avoids having to communicate with a silicon chip developer/manufacturer when converting a partial license to a complete license via the usage of blockchain. In some examples, verification is performed at a backend system of the customer/purchaser via blockchain. In some examples, verification is performed by a distributed blockchain that contains local/community content, thereby ensuring that a community license is available as a function for a smart contract at a supervisory level. In some such examples, the license availability is controlled by a community of nodes participating in the blockchain. Rules that are used to determine if a license is available (and whether such a license can be used by those nodes), are referred to as smart contract(s). In some such examples, each local node (e.g., each node at the customer's facility/premises) becomes an executive node that is authorized to implement the function for a smart contract at a supervisory level. In some such examples, the silicon chip manufacturer's backend system can be used to ensure license compliance and to reconcile billing via periodic connection with the machines/devices in the customer environment, in some example, by inspecting the blockchain. In still further examples, blockchain can be used to establish authenticated provenance during manufacture of the system on a chip (“SOC”) (e.g., a node implemented as a system on a chip). The blockchain, in such further examples, can be used as a foundation to execute and track downstream SOC lifecycle events (e.g., automated license negotiation, feature activation, SOC verification, etc.). In yet other examples, a non-fungible token is minted on a hardware platform to provide tokenized security on blockchain, thereby ensuring digitally signed ownership that provides both asset security and the management of license transfers, if desired.

The example system 14200 of FIG. 142 includes an example blockchain 14202 of which both an example silicon manufacturer 14204 and an example customer premises 14206 are part. In some examples, the blockchain 14202 includes an example distributed ledger 14208 and an example smart contracts operator/rules engine 14210. The silicon manufacturer 14204 includes an example floating license issuer 14212, and an example biller 14214. The customer premises 14206 include an example hardware platform 14216 having an example license coordinator 14218, and an example hardware node 14220 (e.g., computer processing unit (“CPU”), graphics processing unit (“GPU”), etc. As described in greater detail below, the blockchain 14202 is used in place of a database for recording licenses being deployed in a customer facility/premises.

The example rule engine (e.g., the smart contracts operator) verifies that a license application to a node is valid. In some examples, the distributed ledger operates to record hardware platform lifecycle records and license assignments (current and past). In some examples, the rule engine can be implemented using, for example, smart contracts.

The example silicon manufacturer produces SSKU-able parts (e.g., Intel manufacturing CPUs) 14202. A SSKU-able part is a semiconductor device having hardware features that can be enabled via a license applied to the device during any point in the supply chain of the device. In some examples, the example floating point license issuer 14212 registers, on the blockchain 14202, each hardware node/unit that is produced and assigns each such hardware node/unit an identity (e.g., an “ID” number). In some examples, such registering activity is performed at the time that the hardware node/unit is manufactured. In some examples, the example floating license issuer 14212 also creates floating licenses and store references to the floating licenses on the blockchain 14202. Alternatively or additionally, the silicon manufacturer 14204 can include example non-fungible token (“NFT”) minting circuitry 14222 that mints an NFT on each hardware node/unit that is manufactured. In some such examples, the NFT is used via the example blockchain 14202 to manage asset ownership and security, as described further below. In some examples, the floating licenses can be issued by the silicon manufacturer directly, or indirectly, via a delegated authority, a community of nodes, or issued “via the blockchain itself” (i.e., generated by one of the participating nodes, made authentic by fulfilling a corresponding smart contract criteria, and confirmed via a quorum of nodes).

The example silicon manufacturer 14204 collects revenue from the SSKU-able features applied to the manufacturer-produced hardware. As a result, the manufacturer receives license generation/node binding information generated within the blockchain. In some examples, this includes receiving an amount of crypto-currency each time a license is installed (if all the transactions are reconciled in virtual currency). In some examples, this may include taking “physical-world” actions based on actions occurring in the blockchain, (e.g., creating an invoice for the customer).

In some examples, the customer facility 14206 can correspond to a customer data center, customer manufacturing center, customer data processing site, etc. In some such examples, the example hardware platform 14216 or portions thereof can be software defined silicon (SDSi) semiconductor devices that correspond to servers of the customer data center. In the same way, the silicon manufacturing facility 14204 can correspond to any entity that manufactures silicon devices and, in particular, SDSi semiconductor devices.

As such, the elements of the example system 14200 of FIG. 142 may be instantiated (e.g., creating an instance of, bring into being for any length of time, materialize, implement, etc.) by processor circuitry such as a central processing unit executing instructions. Additionally or alternatively, the elements of the example system 14200 of FIG. 142 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 142 may, thus, be instantiated at the same or different times. Some or all of the circuitry may be instantiated, for example, in one or more threads executing concurrently on hardware and/or in series on hardware. Moreover, in some examples, some or all of the circuitry of FIG. 142 may be implemented by microprocessor circuitry executing instructions to implement one or more virtual machines and/or containers.

In some examples, the example customer builds and/or operates the example platform 14216 (or a set of platforms) on which the silicon from the silicon chip manufacturer is disposed. In some examples, the license coordinator 14218 or any backend system at the customer facility BKD306 queries the example blockchain 14202 for available Floating/Provisional Licenses. In some examples, a query for such floating/provisional licenses can prompt the nodes of the blockchain (e.g., nodes participating the creation and maintenance of the blockchain 14202) to generate such license). The blockchain 14202 responds by supplying a floating/provisional license to the license coordinator 14218 of the platform 14216. The license coordinator 14216 supplies the floating/provisional license to the example CPU 14220 which installs the floating license(s). In some examples, before installing (or as part of the installing operation), the example CPU 14220 determines one or more limitations associated with provisional/floating license and/or identified in the floating/provisional license. The CPU 14220 takes any actions necessary to ensure that the limitations are not exceeded. The CPU 14220 also sends, to the example license coordinator 14218, a request for confirmation that the license is valid. In some examples, the hardware feature activation licenses can be pre-generated by the silicon chip manufacturer and the blockchain can be tasked with managing the allocation/distribution of the licenses.

The example license coordinator KBD 318 provides the request for validation to the example blockchain 14202. In some examples, the request includes a request for ownership information (e.g., the owner of the CPU) and includes an installation status (e.g., an indication as to whether the floating provisional license is installed). The example distributed ledger 14208 of the blockchain 14202 responds to the request with a license binding confirmation that indicates that the license can be completed and is confirmed as being bound to the CPU 14220. In some examples, the licensing binding confirmation includes a number (“N”) of the last blocks of the blockchain 14202. In some examples, for performance reasons, when local on-CPU verification is being requested, the number N is not likely to include a full blockchain dataset. Instead, a certified snapshot (e.g. the hardware manufacturer is creating a “trusted” snapshot of the chain every N blocks) and the delta from the certified snapshot, is transmitted as the confirmation. In some examples, the confirmation may not include blockchain verification itself, but rather require N signatures of M chain members (e.g., a signing event kicked off by a smart contract). In some such examples, the blockchain validity check is delegated to the participating nodes (e.g., the signing chain members).

Additional/Alternate Modes of Operation:

In some examples, the authority to determine which features shall be enabled (via license) on the hardware node/unit is not solely determined by the customer but can also be determined by the example blockchain 14202 (or any other another entity properly authorized as the configuration owner) (e.g., via a smart contract), or a consensus of nodes can determine the feature sets for a platform (e.g., the example platform 14216). The contract itself can also be minted as a non fungible token (“NFT”) and transferred between entities. In some such examples, the NFT operates as a digital rights record (e.g., the rights to a SSKUable hardware feature set. By its nature an NFT a unique and non-interchangeable digital ledger that can be purchased/sold between entities but retain their uniqueness because an NFT cannot be duplicated. Being in possession of an NFT can be proven using a blockchain record and owning the NFT, in these examples, gives the owner of the NFT the right to enable/activate the hardware feature set carried in the NFT on a platform of the owner.

In some examples, the example platform 14218 may autonomously query the blockchain 14202 on an as needed basis, thus removing the need for communication brokerage by the customer. For example, in a Cloud Service Provider (CSP) environment (esp. in an infrastructure-as-a-service model), the actual user of the server (or VM/VMM) (e.g., hardware node/unit) can decide the currently SKU'ed configuration, and not the CSP.

While an example manner of implementing the system 14200 is illustrated in FIG. 142, one or more of the elements, processes, and/or devices illustrated in FIG. 142 may be combined, divided, re-arranged, omitted, eliminated, and/or implemented in any other way. Further, the example floating license issuer 14212, the example biller 14214, the example NFT) minting circuitry 14222, the example hardware platform 14216, the example license coordinator 14218, the example hardware node 14220, the example timer 14224, the example LCRM 14226 and/or, more generally, the example system 14200 of FIG. 142, may be implemented by hardware alone or by hardware in combination with software and/or firmware. Thus, for example, any of the example floating license issuer 14212, the example biller 14214, the example NFT minting circuitry 14222, the example hardware platform 14216, the example license coordinator 14218, the example hardware node 14220, the example timer 14224, the example LCRM 14226 and/or, more generally, the example system 14200, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example system 14200 may include one or more elements, processes, and/or devices in addition to, or instead of, those illustrated in FIG. 142, and/or may include more than one of any or all of the illustrated elements, processes and devices.

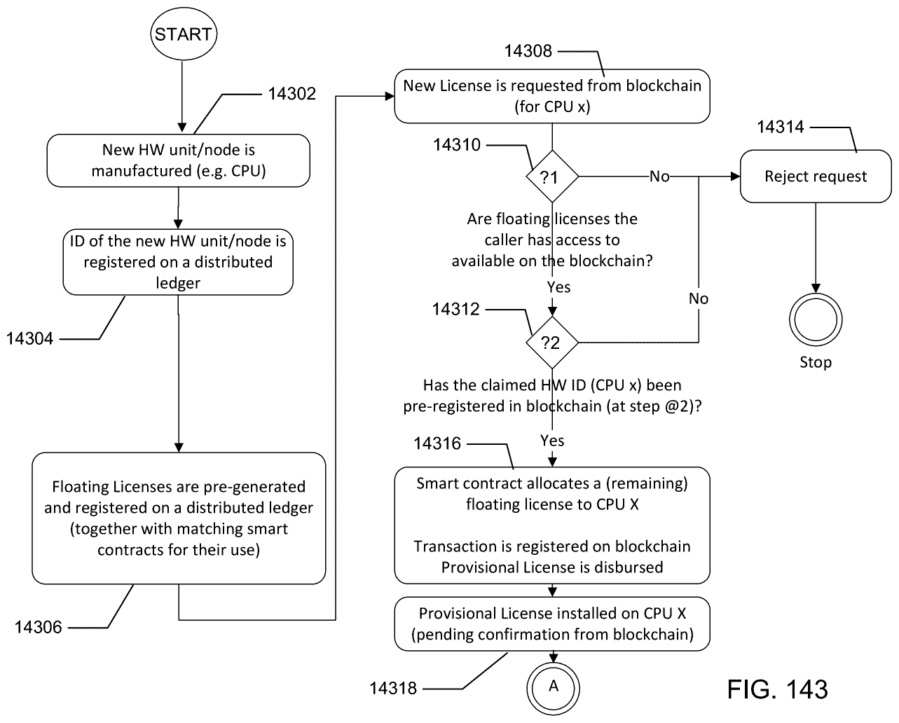

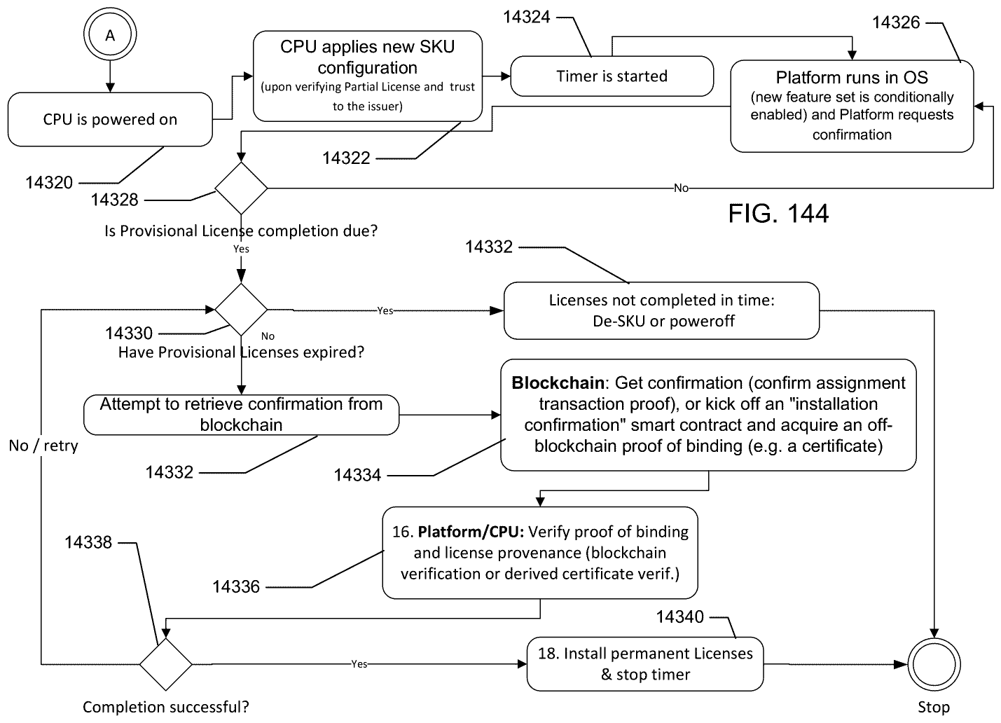

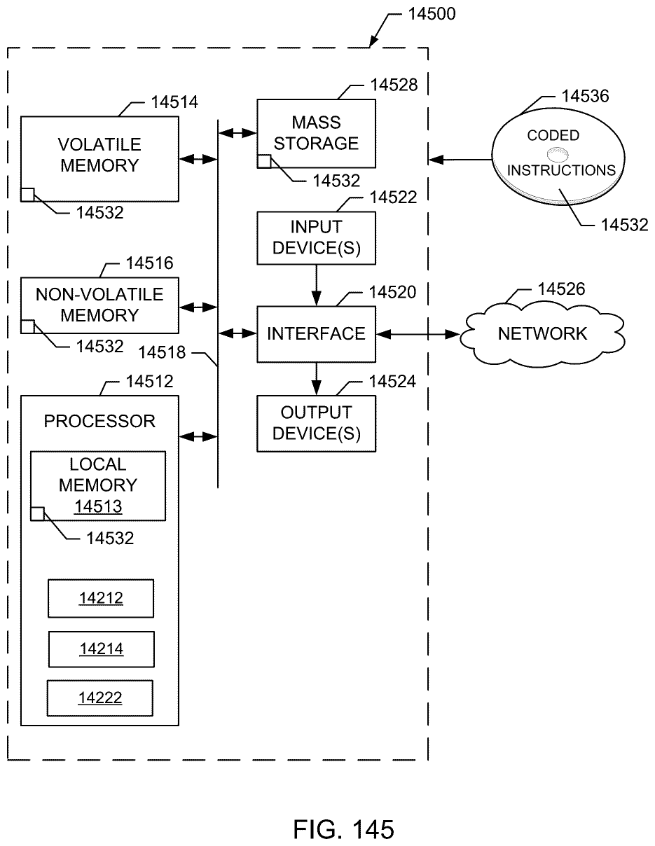

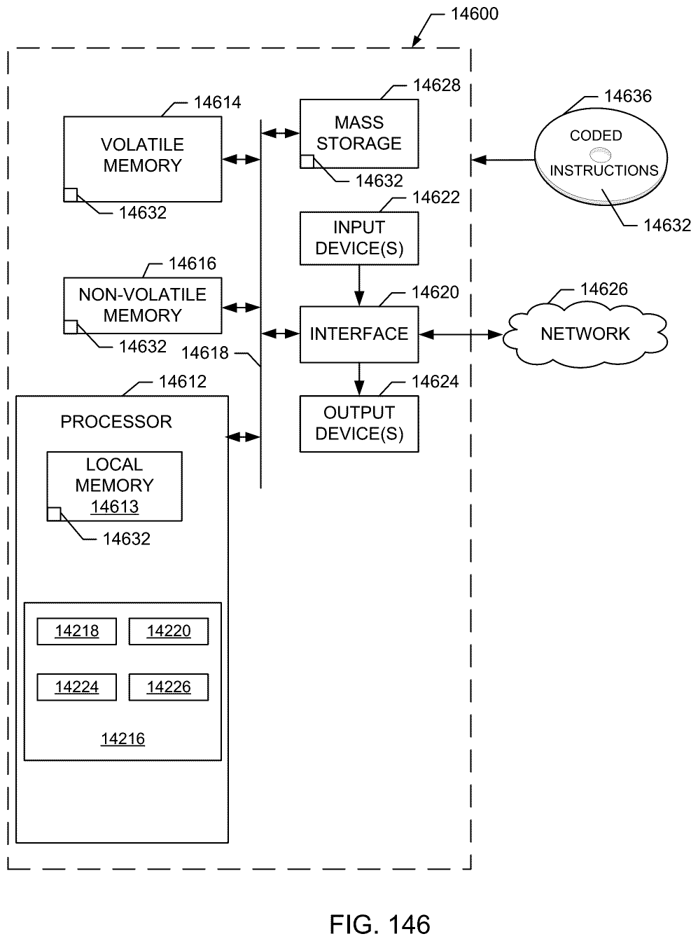

Flowcharts representative of example machine readable instructions which may be executed to configure processor circuitry to implement the system 14200 are shown in FIGS. 143-144. The machine readable instructions may be one or more executable programs or portion(s) of an executable program for execution by processor circuitry, such as the processor circuitry 14512 and/or 14612 shown in the example processor platforms 14500 and/or 14600 discussed below in connection with FIGS. 145 and 146 and/or the example processor circuitry discussed below in connection with FIGS. 150 and/or 151. The program(s) may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program(s) and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program(s) is(are) described with reference to the flowchart illustrated in FIGS. 143 and 144, many other methods of implementing the example system 14200 may alternatively be used. For example, the order of execution of the blocks may be changed, and/or some of the blocks described may be changed, eliminated, combined and/or subdivided into multiple blocks. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 143 and 144 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media. Also, as used herein, the terms “computer readable” and “machine readable” are considered equivalent unless indicated otherwise.

FIGS. 143 and 144 is a flowchart representative of example machine readable instructions and/or example operations 14300A and 14300B that may be executed and/or instantiated by processor circuitry to implement the system 14200 of FIG. 142. With reference to the preceding figures and associated written descriptions, the machine readable instructions and/or the operations 14300A and 14300B of FIGS. 143 and 144 begin at block 14302, at which a new hardware unit/node is manufactured by the silicon manufacturer. A unique identifier of the new hardware unit/node is registered on the example distributed ledger 14208 of the example blockchain 14202 (see block 14304). In some examples, the blocks 14302 and KFC 304 are performed at (or near) the time of manufacture of the hardware unit/node.

In some examples, the new hardware unit/node (e.g., CPUP) on the blockchain can be used as the start of a chain of custody, and the blockchain can be used, for example, to register ownership transfers, as the physical asset progresses (e.g, the CPU) through a supply chain.

In some examples, the pre-registration of the hardware unit/node (e.g., CPU) is not required. In some such examples, the flowchart begins after the block 14304 and details about the new hardware unit/node, including a unique inventory part number, and/or a device's root of trust certificate are available off-blockchain (as is performed for SDSi, when PPIN identifiers are used.)

At a block 14306, the floating license issuer 14212 pre-generates floating license. In some examples, the pre-generated floating licenses are “floating” in that the licenses are not assigned to any particular hardware unit/node upon generation. Further, the floating license issuer 14212 can pre-generate the floating licenses at any of several points in time including, for example, at the time of unit/node manufacture, only when an actual need for such a floating license is demonstrated (e.g., typically via a business process kicking-off license generation). In some such examples, a Customer can request acquisition of a pool of a number (“N”) Floating Licenses. Such a request can be served by the Silicon Manufacturer and the custody of resulting Floating Licenses can be assigned to the Customer for further dispositioning (a monetary transaction may accompany this). In other examples, the floating license issuer 14212 can generate Floating Licenses just-in-time (e.g., upon request), via the example blockchain 14202. In some such examples, fulfilling a set of criteria described in a smart contract can be used to authorize the operation, and the resulting Floating License(s) may be proved genuine by the distributed ledger 14208, or a kick-off a License Generation event at an off-blockchain generator (e.g., Silicon Manufacturer-operated license issuer). In yet other examples, the floating license issuer 14212 can generate the floating licenses at a time that the example platform 14218 is assembled (or deployed, or is in need of the new feature set via a SSKU license). In some examples, a floating license can be temporarily used to activate a hardware feature set on a SSKUable hardware node and then can be returned to a license pool for usage by a different node at a different time.

Next, at a block 14308, the example license coordinator KBD 318 of the example platform 14216 requests a floating license from the example blockchain 14202. The blockchain 14202 and the rules embedded within (e.g., the smart contracts 14210) ensure that: a) Floating Licenses are available to the requesting Customer (e.g., the party having custody of the platform 14218) (see block 14310), b) the target hardware unit/node (e.g., the CPU 14220 is genuine (i.e. has been pre-registered by the manufacturer (see block 14312, and, in some examples, that c) determine whether the requestor is privileged/authorized to make the request on the platform (i.e. is the platform owner). In some examples, if the platform is registered off-blockchain, the provenance and ownership of the blockchain can be checked using methods such as ID (e.g., PPIN) lookup and ownership check, or, in some instances, skipped entirely. If the answer to the criteria evaluated at the block 14310 (represented by “?1”) or the block 14312 (represented by “?2”) is no, then the request for the floating license is rejected at the block 14314 and the method of flowchart 14300A and 14300B halts/ends.

At a block 14316, the example blockchain 14202 assigns one of the Floating Licenses to a concrete hardware unit/node (e.g., the CPU 14220) and a this transactions is registered on the blockchain 14202. The floating license is referred to as a provisional license (until such time as the license is locked to the CPU 14220). The license is not truly “floating” because the blockchain 14202 holds a permanent assignment of the license. However, the license remains the same binary artifact as generated earlier in the flowchart (see block 14306). From the perspective of the hardware unit/node (e.g., CPU 14220), the license still appears as a “floating license.”

The license is installed on the hardware unit/node (e.g., the CPU 14220) (see block 14318 using existing methods (e.g., in the same way an Intel SDSi Agent installed a license). Note the installation is allowed, because of the inherent trust between the CPU 14220 and the floating license issuer 14212, (pre)established at silicon manufacture.

At a block 14320, the example hardware node/unit (e.g., the CPU 14220) boots up/powers which causes the CPU 14220 to apply the new SKU configuration associated with the provisional license (see block 14322). In some examples, before applying the new SKU configuration, the example CPU verifies the provisional license.

To ensure that the license is verified/confirmed before the license expires, the example CPU 14220 sets a timer 14224 (see block 14324) corresponding to an amount of time that the license is provisionally (temporarily) active. In some examples, the timer 14224 can be implemented as a counter when the criteria used to limit usage of the license is a metric such as CPU usage, data transferred volume, power consumption, etc. The example platform 14216 runs at the operating system level and the new hardware feature set associated with the new SKU configuration is functioning. The functioning of the hardware feature set is only temporary though, as the permanent ability to the use the feature set is dependent upon the verification and a node-locking confirmation (via the example blockchain 14202) as described further below.

In some examples, when the platform 14216 is running, the example CPU 14220 and/or the example license coordinator 14218 requests proof from the example blockchain 14202 that the license is in good standing and further requests that the license be bound to the CPU 14220 (also at the block 14326). Thereafter, a license confirmation request monitor (“LCRM”) 14226 monitors the output of the license coordinator 14218 to detect transmission of the request for the license confirmation to the blockchain 14202 (see block 14328). If the request has not yet been detected, the flow returns to the block 14326. When the request is detected, the flow progresses to the block 14330 at which the license expiration monitor KBD determines whether the provisional license has expired.

When the provisional license(s) have expired, the request has not been received in sufficient time to complete the provisional license (e.g., convert the provisional license to a complete/permanent license) and the platform and/or the CPU de-SKUs or powers off (see block 14332) and, thereafter, the flowchart ends/halts. When the provisional license(s) have not yet expired, the platform 14216 retrieves the confirmation from the blockchain 14202 (see block KFC 334) which causes the blockchain 14202 to confirm the assignment and proof of the transaction by which the license was purchased by customer (see block 14334).

In some examples, a full blockchain transaction verification (including downloading a snapshot of all transactions on-blockchain and following the path block-by-block), may not be feasible for large deployments and constrained local resource set (esp. if this operation was to execute in one of the resource-constrained IP blocks of the CPU). In some such examples, the currently valid state of the (official/non-forked) blockchain may be periodically snapshotted by a high-trust entity (e.g., a trusted third party in the role of a notary, a silicon manufacturer themselves, or a quorum of privileged nodes), and published in a pre-determined location. The publication allows the platform 14216 to download and verify only a desired number of block (e.g., “N”, where N is small) taken since last snapshot, or in some examples, the integrity of a single block, and, thus, not be required to follow the full transaction log since blockchain setup.

In lieu of retrieving confirmation from the blockchain, the attempt to confirm the license and determine proof of the transaction by which the customer purchased the license, the blockchain 14202 (may kick off (via a smart contract) an off-blockchain certificate generation (e.g., x.509 cert, possibly counter-signed by multiple nodes), thus allowing an on-platform verification without the need of the platform 14216 to participate in the blockchain 14202 and understand its structure.

At a block 14336, the example platform 14216 and/or the example CPU 14220 receives the license binding confirmation 14228 (also referred to as a completion token (proof of legitimate license binding), verifies the authenticity of the license binding confirmation 14228. Provided that the license binding confirmation is deemed valid (as determined at block 14338), the license is converted from provisional to permanent, the license is permanently installed (see block KFC 340), the timer 14224 is stopped, and the flowchart ends/halts. If the license binding confirmation is not deemed valid (as determined at block 14338), the flow returns to the block 14322, where the CPU and/or platform again check to determine whether the provisional license expired. Flow proceeds from the block 14330 as described above.

The flowchart 14300A and 14300B assume the example blockchain 14202 has been pre-established and the relevant parties (e.g., Silicon Manufacturer and Customer) are the blockchain members. Any existing techniques may be used to setup the blockchain.

In some examples, the blocks 14302 and 304 can be performed at a time of manufacture of the hardware node (e.g., the CPU). In some examples, the block 14306 can be performed at the time of manufacture, upon request by a customer or “just-in-time” using the blockchain smart contracts. In some examples, the blocks 14308-14318 can be performed when a platform on/in which the hardware unit is to be disposed is being assembled by a customer of the hardware node (e.g., CPU). In some examples, the blocks illustrated on 144 can be performed at platform run-time (e.g., when the assembled platform is installed/deployed in the field).

FIG. 145 is a block diagram of an example processor platform 14500 structured to execute and/or instantiate the machine readable instructions and/or the operations of FIGS. 143 and/or 144 to implement the example floating license issuer 14212, the example biller 14214, the example NFT minting circuitry 14222 of the example system 14200 of FIG. 142. The processor platform 14500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 14500 of the illustrated example includes processor circuitry 14512. The processor circuitry 14512 of the illustrated example is hardware. For example, the processor circuitry 14512 can be implemented by one or more integrated circuits, logic circuits, FPGAs, microprocessors, CPUs, GPUs, DSPs, and/or microcontrollers from any desired family or manufacturer. The processor circuitry 14512 may be implemented by one or more semiconductor based (e.g., silicon based) devices. In this example, the processor circuitry 14512 implements the example floating license issuer 14212, the example biller 14214, the example NFT minting circuitry 14222 of the example system 14200.

The processor circuitry 14512 of the illustrated example includes a local memory 14513 (e.g., a cache, registers, etc.). The processor circuitry 14512 of the illustrated example is in communication with a main memory including a volatile memory 14514 and a non-volatile memory 14516 by a bus 14518. The volatile memory 14514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 14516 may be implemented by flash memory and/or any other desired type of memory device. Access to the main memory 14514, 14516 of the illustrated example is controlled by a memory controller 14517.

The processor platform 14500 of the illustrated example also includes interface circuitry 14520. The interface circuitry 14520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 14522 are connected to the interface circuitry 14520. The input device(s) 14522 permit(s) a user to enter data and/or commands into the processor circuitry 14512. The input device(s) 14522 can be implemented by, for example, an audio sensor, a microphone, a camera (still or video), a keyboard, a button, a mouse, a touchscreen, a track-pad, a trackball, a trackbar, an isopoint device, a voice recognition system and/or any other human-machine interface. In some examples, the input device(s) 14522 are arranged or otherwise configured to allow the user to control the processor platform 14500 and provide data to the processor platform 14500 using physical gestures, such as, but not limited to, hand or body movements, facial expressions, face recognition, etc.

One or more output devices 14524 are also connected to the interface circuitry 14520 of the illustrated example. The output device(s) 14524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 14520 of the illustrated example, thus, typically includes a graphics driver card, a graphics driver chip, and/or graphics processor circuitry such as a GPU.

The interface circuitry 14520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 14526. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 14500 of the illustrated example also includes one or more mass storage devices 14528 to store software and/or data. Examples of such mass storage devices 14528 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 14532, which may be implemented by the machine readable instructions of FIGS. 143 and/or 144, may be stored in the mass storage device 14528, in the volatile memory 14514, in the non-volatile memory 14516, and/or on a removable non-transitory computer readable storage medium such as a CD or DVD.

FIG. 146 is a block diagram of an example processor platform 14600 structured to execute and/or instantiate the machine readable instructions and/or the operations of FIGS. 143 and/or 144 to implement the example hardware platform 14216 of FIG. 142. The processor platform 14600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 14600 of the illustrated example includes processor circuitry 14612. The processor circuitry 14612 of the illustrated example is hardware. For example, the processor circuitry 14612 can be implemented by one or more integrated circuits, logic circuits, FPGAs, microprocessors, CPUs, GPUs, DSPs, and/or microcontrollers from any desired family or manufacturer. The processor circuitry 14612 may be implemented by one or more semiconductor based (e.g., silicon based) devices. In this example, the processor circuitry 14612 implements the example license coordinator 14218, the example hardware node 14220, the example timer 14224 and/or the example LCRM 14226 of the example hardware platform 14216.

The processor circuitry 14612 of the illustrated example includes a local memory 14613 (e.g., a cache, registers, etc.). The processor circuitry 14612 of the illustrated example is in communication with a main memory including a volatile memory 14614 and a non-volatile memory 14616 by a bus 14618. The volatile memory 14614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 14616 may be implemented by flash memory and/or any other desired type of memory device. Access to the main memory 14614, 14616 of the illustrated example is controlled by a memory controller 14617.

The processor platform 14600 of the illustrated example also includes interface circuitry 14620. The interface circuitry 14620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 14622 are connected to the interface circuitry 14620. The input device(s) 14622 permit(s) a user to enter data and/or commands into the processor circuitry 14612. The input device(s) 14622 can be implemented by, for example, an audio sensor, a microphone, a camera (still or video), a keyboard, a button, a mouse, a touchscreen, a track-pad, a trackball, a trackbar, an isopoint device, a voice recognition system and/or any other human-machine interface. In some examples, the input device(s) 14622 are arranged or otherwise configured to allow the user to control the processor platform 14600 and provide data to the processor platform 14600 using physical gestures, such as, but not limited to, hand or body movements, facial expressions, face recognition, etc.

One or more output devices 14624 are also connected to the interface circuitry 14620 of the illustrated example. The output device(s) 14624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 14620 of the illustrated example, thus, typically includes a graphics driver card, a graphics driver chip, and/or graphics processor circuitry such as a GPU.

The interface circuitry 14620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 14626. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 14600 of the illustrated example also includes one or more mass storage devices 14628 to store software and/or data. Examples of such mass storage devices 14628 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 14632, which may be implemented by the machine readable instructions of FIGS. 143 and/or 144, may be stored in the mass storage device 14628, in the volatile memory 14614, in the non-volatile memory 14616, and/or on a removable non-transitory computer readable storage medium such as a CD or DVD.

From the foregoing, it will be appreciated that example systems, methods, apparatus, and articles of manufacture have been disclosed that generate and distributed non-node locked license via blockchain. Disclosed systems, methods, apparatus, and articles of manufacture improve the efficiency of using a computing device by allowing a customer of a silicon manufacturer to buy hardware licenses just in time or at a time of deployment without having to know which hardware devices will be target for license deployment. The ability to make such license purchases in this manner enhances the ability of the customer to build compute systems and compute devices better suited to the needs of users of the compute systems and compute devices. Removing the need to license hardware for a hardware unit/device at the time of silicon manufacture allows the customer to provide better compute systems and compute devices that enhance the user experience. Further, because the system described herein is supported by blockchain, the installed hardware licenses are ensured to be legitimate and secure, thereby enhancing the security of the compute systems and compute devices having the silicon manufacturer's hardware licenses installed therein. Disclosed systems, methods, apparatus, and articles of manufacture are accordingly directed to one or more improvement(s) in the operation of a machine such as a computer or other electronic and/or mechanical device.

Activating Hardware Features with a Pre-Generated Hardware License

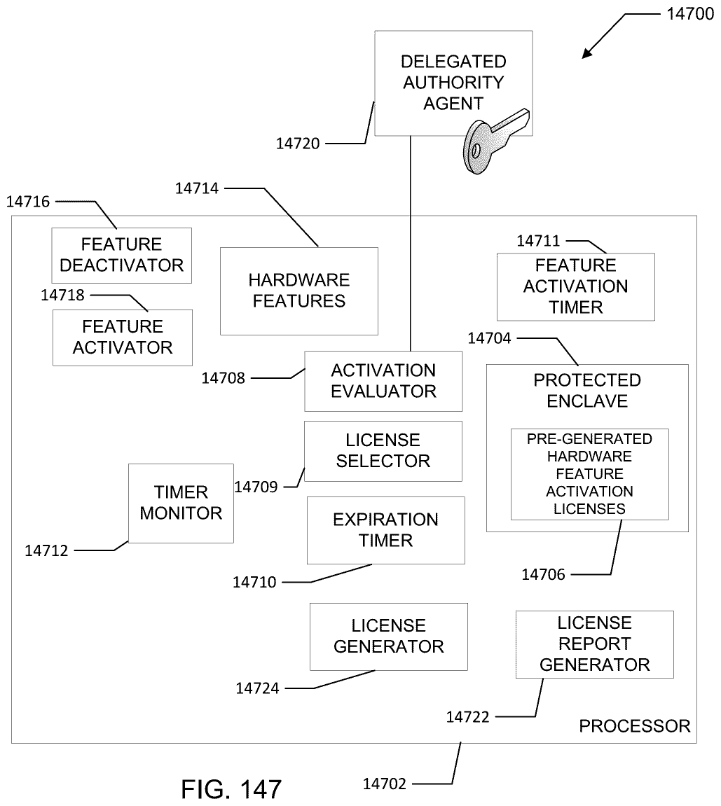

FIG. 147 illustrates a block diagram of an example system 14700 to activate hardware features using pre-populated license, as described further below. The system provides for a processor that includes previously populated (“pre-populated”) hardware licenses. At a time when the processor is physically transferred by for example, a silicon manufacturer to a purchaser, the processor includes hardware features that are activated as well as hardware features that not activated. The processor is capable of evaluating when a non-activated hardware feature is to be activated and locates (from among a set of pre-populated licenses) a pre-populated license corresponding to that hardware feature. The processor then proceeds to use the license to activate the feature, at least temporarily, until the activation of the license can be verified. Thus, the processor is able to select and install a hardware license to activate a corresponding feature even while located in an isolated environment (e.g., an environment that is not, at the time of the license installation, in communication with an outside entity (e.g., with the manufacturer, or even a delegated agent of the manufacturer). The ability to perform such a license installation is especially useful for customers (owners of the processors) that landlock their hardware systems and/or when access to a backend licensing system operated by the manufacturer is limited or unavailable.

Current techniques to provide access to hardware upgrades can include generating licenses at a manufacturer's facility or backend system based on unique CPU identifiers provided by a customer (purchaser of the CPU). Activation codes and the licenses are supplied back to the customer who must then distribute the activation codes accordingly. For air gapped environments this process can be very cumbersome and expensive due to the need for the customer to transfer unique CPU identifiers from an isolated environment and then receive activation codes for the same isolated environment. The process also tends to be error prone and introduces security risks.

The example system 14700 of FIG. 147 includes an example processor 14702, an example protected enclave 14704, example pre-generated feature activation licenses 14706, an example activation evaluator 14708, an example license selector 14709, an example license expiration timer 14710, an example feature activation timer 14711, an example timer monitor 14712, example hardware features 14714, an example feature deactivator 14716, an example feature activator 14718, an example license report generator 14722, and an example license generator 14724. In some examples, the processor 14702 is in communication with an example licensing authority (e.g., a backend system of the manufacturer of the processor) or a delegated licensing authority 14720. The processor 14702, by virtue of having the hardware feature activation licenses is referred to as being “pre-populated” with licenses when supplied by the manufacturer to a customer/purchaser. In some examples, the licenses are generated by the manufacturer or can instead be generated and stored in the processor at any point in a supply chain to the customer. The example processor can be manufactured to include software defined silicon (SDSi) semiconductor devices that bear the hardware features to be activated. In some examples, a customer may order the processor to be delivered with only a small number of features activated, with the knowledge that a fuller set of features are forecasted to be activated. In some such examples, the customer can activate the features on demand using the pre-generated hardware licenses (also referred to herein as pre-generated hardware feature activation licenses).

The elements of the example system 14700 of FIG. 147 may be instantiated (e.g., creating an instance of, bring into being for any length of time, materialize, implement, etc.) by processor circuitry such as a central processing unit executing instructions. Additionally or alternatively, the elements of the example system 14700 of FIG. 147 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 147 may, thus, be instantiated at the same or different times. Some or all of the circuitry may be instantiated, for example, in one or more threads executing concurrently on hardware and/or in series on hardware. Moreover, in some examples, some or all of the circuitry of FIG. 147 may be implemented by microprocessor circuitry executing instructions to implement one or more virtual machines and/or containers.

As described, the example protected enclave 14704 securely stores on or more pre-generated hardware licenses 14706. The protected enclave 14704 can be implemented by any secure storage technology that ensures that only a properly credentialed device (e.g., the example license selector 14709). In some examples, the example activation evaluator 14708 evaluates whether a feature needs to be activated. The evaluation can be based on any of a variety of events including, but not limited to, to a time, a calendar clock date, an amount of CPU resources being utilized, an amount of processing load, an amount of processing cycles, etc. For illustration purposes only, the activation evaluator 14708 of FIG. 147 evaluates the example feature activation timer 14711 to determine when a hardware features is to be activated.

In some examples, an external event sent by, for example, the delegated authority agent 14720 can cause the activation evaluator 14708 to determine that a feature is to be activated. The delegated authority agent can, in some examples, include an additional key (e.g., a cryptographic key) that is to be used to unlock and/or validate a license(s). This key can have limited scope of use. For example, usage of the key may be limited to: occurring a specified number of times, occurring within a specified period, occurring only on specific hardware SKU, only by a specific customer, etc. Using the additional key unlock the license prevents unauthorized license unlocking, and limiting the scope of usage of the key reduces any negative impact that may occur if the key were to be compromised.

In some examples, a feature may be activated only when an additional trusted agent (which can be implemented with external software) confirms the activation is permitted. In some examples, the license can specify that the feature can be activated for a specific period but that confirmation of the license by an external agent (e.g., the example delegated authority agent 14720) must be done within specified period of time or the license will be deactivated.

When the example activation evaluator (or other agent) determines that a feature is to be activated, the example license selector 14709 is notified and is informed of the identity of the feature to be activate. The license selector 14709 then accesses the protected enclave to retrieve the license and provides any activation codes included in the license to the example feature activator 14718 which operates to activate the hardware feature(s) 14714 corresponding to the license. In some examples, when a license is used to activate a hardware feature, the example license report generator is notified of the activation and thereafter includes information concerning the activation in a report to be transmitted to the manufacturer for billing/reconciliation.

In some examples, an event that triggers a feature evaluation and/or a corresponding feature activation may be based on a policy condition in addition to any other criteria (e.g., a dormant (pre-populated) license is activated only when a platform associated with the processor 14702 platform meets a set of established criteria). Example criteria can include extension of the system to more than a designated number of CPUs, a particular genuine operating system (OS) or software package is installed or run (e.g., is proven to the CPU by the OS using an attestation technique. In some examples, the CPU may a pre-populated license to enable a feature (e.g., additional frequency) based on the operation of a genuine OS/VMM/software). In some such examples, the license may be enabled for as long as the system meets the policy criteria and disabled the moment it fails to do so. In some such examples, the expiration timer 14700 can be configured to monitor the additional criteria.

In some examples, the example processor 102 is not equipped with the example protected enclave 14704 nor the example pre-generated hardware feature licenses 14706. In some such examples, when the example activation evaluator 14708 determines that a features needs to be activated, the example license generator 14724 is notified. In response the license generator 14724 generates the license for the needed feature, and/or or the license may be generated by a community based distributed delegated agent (described herein) or may utilize any of the other processes described herein to generate a license.

In some examples, when the feature is activated, the example expiration timer 14710 is set to track a duration of time that has passed since the activation. In some examples, the timer monitor 14712 monitors the expiration timer 14710 and, if the duration exceeds or otherwise satisfies a license expiration time, the feature deactivator 14716 is notified and responds to the notification by deactivating the relevant feature. In some examples, provided that the license selector 14709 and/or the example activation evaluator 14708 has received a confirmation from, for example, the delegated authority agent 14720 (or from the manufacturer), before the duration has exceeded (or otherwise satisfied) the license expiration time, then the expiration timer is stopped and the feature is permitted to remain activated going forward. Although, in the example system of FIG. 147, an expiration timer 14708 and timer monitor 14712 are illustrated, any other measure (number of operations, number of processing cycles, amount of load processed, etc.), measuring device, and monitor may be used to determine when the license has expired.

While an example manner of implementing the first processor 14702 is illustrated in FIG. 147, one or more of the elements, processes, and/or devices illustrated in FIG. 147 may be combined, divided, re-arranged, omitted, eliminated, and/or implemented in any other way. Further, the example protected enclave 14704, the example activation evaluator 14708, the example license selector 14709, the example license expiration timer 14710, the example feature activation timer 14711, the example timer monitor 14712, the example hardware features 14714, the example feature deactivator 14716, the example feature activator 14718, the example license report generator 14722, the example license generator 14724 and/or, more generally, the example processor 14702 of FIG. 147, may be implemented by hardware alone or by hardware in combination with software and/or firmware. Thus, for example, any of the example protected enclave 14704, the example activation evaluator 14708, the example license selector 14709, the example license expiration timer 14710, the example feature activation timer 14711, the example timer monitor 14712, the example hardware features 14714, the example feature deactivator 14716, the example feature activator 14718, the example license report generator 14722, the example license generator 14724 and/or, more generally, the example processor 14702 of FIG. 147, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example processor 14702 of FIG. 147 may include one or more elements, processes, and/or devices in addition to, or instead of, those illustrated in FIG. 147 and/or may include more than one of any or all of the illustrated elements, processes and devices.

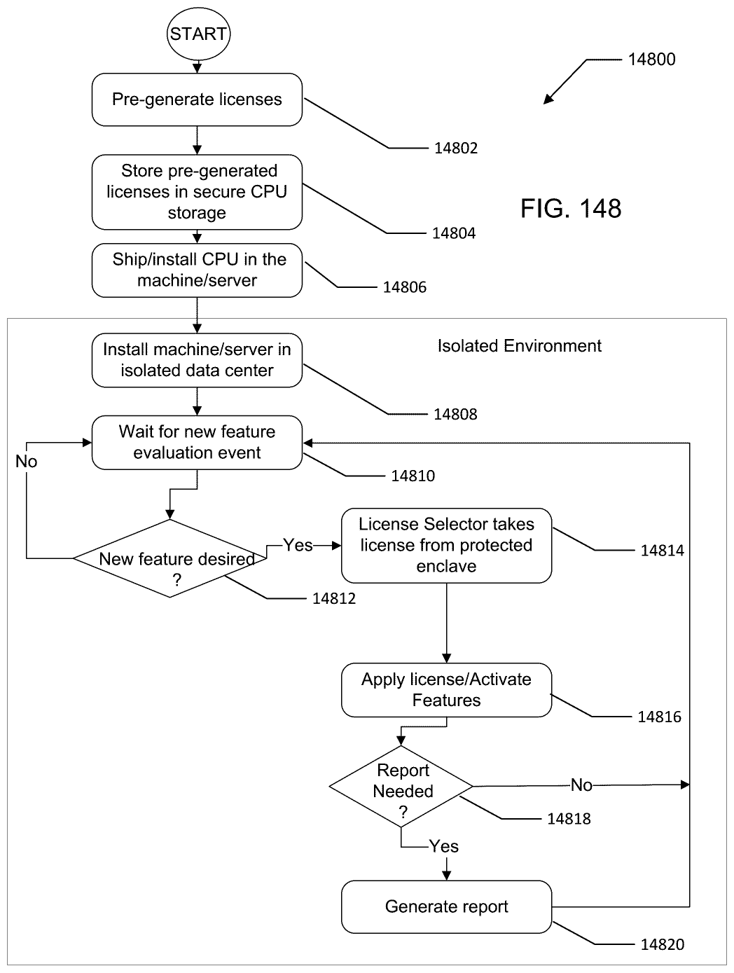

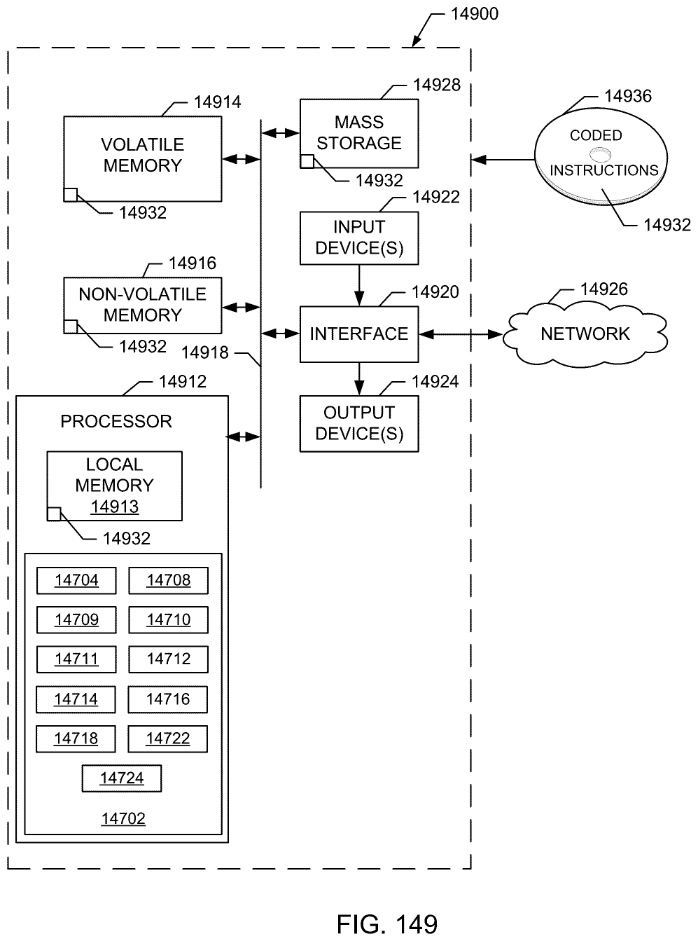

A flowchart representative of example machine readable instructions which may be executed to configure processor circuitry to implement the system 14700 of FIG. 147 is shown in FIG. 148. The machine readable instructions may be one or more executable programs or portion(s) of an executable program for execution by processor circuitry, such as the processor circuitry 14912 shown in the example processor platform 14900 discussed below in connection with FIG. 149 and/or the example processor circuitry discussed below in connection with FIGS. 150 and/or 151. The program(s) may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program(s) and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program(s) is(are) described with reference to the flowchart illustrated in FIG. 148, many other methods of implementing the example system 14700 may alternatively be used. For example, the order of execution of the blocks may be changed, and/or some of the blocks described may be changed, eliminated, combined and/or subdivided into multiple blocks. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 148 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media. Also, as used herein, the terms “computer readable” and “machine readable” are considered equivalent unless indicated otherwise.

FIG. 148 is a flowchart representative of example machine readable instructions and/or example operations 14800 that may be executed and/or instantiated by processor circuitry to implement the system of FIG. 147. With reference to the preceding figures and associated written descriptions, the machine readable instructions and/or the operations 14800 of FIG. 148 begin at block 14702, at which the license are pre-generated, based on, for example, an order supplied by a customer. The pre-generated licenses are stored in the example protected enclave 14704 (block 14804), and the hardware unit/node (e.g., the example CPU 14702 is shipped outside of the facility where the licenses were generated (see block 14806). Note that, when the example CPU 102 is not equipped with pre-generated licenses, but instead generates the licenses internally, the blocks 14804 and 14806 are not performed.

The example CPU 14702 is installed in a machine/server which is situated, for example, in an isolated data center (or any other isolated environment). The example feature evaluator 14708 evaluates the need for a new feature activation (see block 14810). If not, then flow returns to the block 14810 to wait until the evaluator determines a feature is needed. In some examples, the new feature is to be activated (as determined at a block 14812) and the license selector 14814 takes the relevant/corresponding license from the example protected enclave 14704) (see block 14814). The license is then applied by the feature activator such that the feature is activated (see block 216). The activation of the feature can include any of the other operations performed to confirm the license and to deactivate the license when it cannot be confirmed as described above with respect to FIG. 147. Next, the example license report generator 14722 determines whether a report concerning the license is to be generated (see block 218). If so, the report is generated (see block 14820) and flow returns to the block 14810 at which a new feature evaluation event is anticipated. At some point, the report is transmitted to the manufacturer for use in billing and reconciliation of the hardware licenses that have been installed to activate the corresponding features. It is noted that in examples in which the CPU 14702 is not equipped with a protected enclave 14704 nor pre-generated licenses 14706, the action taken at the block 14814 is replaced with the generation of the license by the example license generator 14724.

FIG. 149 is a block diagram of an example processor platform 14900 structured to execute and/or instantiate the machine readable instructions and/or the operations of FIG. 148 to implement the processor 14702 of FIG. 147. The processor platform 14900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 14900 of the illustrated example includes processor circuitry 14912. The processor circuitry 14912 of the illustrated example is hardware. For example, the processor circuitry 14912 can be implemented by one or more integrated circuits, logic circuits, FPGAs, microprocessors, CPUs, GPUs, DSPs, and/or microcontrollers from any desired family or manufacturer. The processor circuitry 14912 may be implemented by one or more semiconductor based (e.g., silicon based) devices. In this example, the processor circuitry 14912 implements the example protected enclave 14704, the example activation evaluator 14708, the example license selector 14709, the example license expiration timer 14710, the example feature activation timer 14711, the example timer monitor 14712, the example hardware features 14714, the example feature deactivator 14716, the example feature activator 14718, the example license report generator 14722 and/or the example license generator 14724 of the example processor 14702.

The processor circuitry 14912 of the illustrated example includes a local memory 14913 (e.g., a cache, registers, etc.). The processor circuitry 14912 of the illustrated example is in communication with a main memory including a volatile memory 14914 and a non-volatile memory 14916 by a bus 14918. The volatile memory 14914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 14916 may be implemented by flash memory and/or any other desired type of memory device. Access to the main memory 14914, 14916 of the illustrated example is controlled by a memory controller 14917.

The processor platform 14900 of the illustrated example also includes interface circuitry 14920. The interface circuitry 14920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 14922 are connected to the interface circuitry 14920. The input device(s) 14922 permit(s) a user to enter data and/or commands into the processor circuitry 14912. The input device(s) 14922 can be implemented by, for example, an audio sensor, a microphone, a camera (still or video), a keyboard, a button, a mouse, a touchscreen, a track-pad, a trackball, a trackbar, an isopoint device, a voice recognition system and/or any other human-machine interface. In some examples, the input device(s) 14922 are arranged or otherwise configured to allow the user to control the processor platform 14900 and provide data to the processor platform 14900 using physical gestures, such as, but not limited to, hand or body movements, facial expressions, face recognition, etc.

One or more output devices 14924 are also connected to the interface circuitry 14920 of the illustrated example. The output device(s) 14924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 14920 of the illustrated example, thus, typically includes a graphics driver card, a graphics driver chip, and/or graphics processor circuitry such as a GPU.

The interface circuitry 14920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 14926. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 14900 of the illustrated example also includes one or more mass storage devices 14928 to store software and/or data. Examples of such mass storage devices 14928 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 14932, which may be implemented by the machine readable instructions of FIG. 148, may be stored in the mass storage device 14928, in the volatile memory 14914, in the non-volatile memory 14916, and/or on a removable non-transitory computer readable storage medium such as a CD or DVD.

From the foregoing, it will be appreciated that example systems, methods, apparatus, and articles of manufacture have been disclosed that enable the issuance and installation of non-node locked hardware licenses. Disclosed systems, methods, apparatus, and articles of manufacture improve the efficiency of using a computing device by enabling the issuance of floating hardware licenses (e.g., non-node locked) that can, at a later time, be locked to a node. Disclosed systems, methods, apparatus, and articles of manufacture are accordingly directed to one or more improvement(s) in the operation of a machine such as a computer or other electronic and/or mechanical device.

FIG. 150 is a block diagram of an example implementation of the processor circuitry 3512, 3612, 3712, 3812, 3912, 4012, 4112, 4212, 4312, 4412, 6412, 6512, 6612, 7112, 7812, 8612, 9412, 9712, 9812, 10712, 10812, 11812, 11912, 12512, 12612, 13212, 13312, 13812, 13912, 14012, 14112, 14512, 14612, and/or 14912 of FIGS. 35-44, 64-66, 71, 78, 86, 94, 97, 98, 107, 108, 118, 119, 125, 126, 132, 133, 138, 139, 140, 141, 145, 146, and/or 149. In this example, the processor circuitry 3512, 3612, 3712, 3812, 3912, 4012, 4112, 4212, 4312, 4412, 6412, 6512, 6612, 7112, 7812, 8612, 9412, 9712, 9812, 10712, 10812, 11812, 11912, 12512, 12612, 13212, 13312, 13812, 13912, 14012, 14112, 14512, 14612, and/or 14912 of FIGS. 35-44, 64-66, 71, 78, 86, 94, 97, 98, 107, 108, 118, 119, 125, 126, 132, 133, 138, 139, 140, 141, 145, 146, and/or 149 is/are implemented by a microprocessor 15000. For example, the microprocessor 15000 may be a general purpose microprocessor (e.g., general purpose microprocessor circuitry). The microprocessor 15000 executes some or all of the machine readable instructions of the flowcharts of FIGS. 69, 70, 74-77, 80-85, 88-93, 96, 103-106, 114-117, 121-124, 129-131, 136, 137, 143, 144, 148 to effectively instantiate the processor circuitry 3512, 3612, 3712, 3812, 3912, 4012, 4112, 4212, 4312, 4412, 6412, 6512, 6612, 7112, 7812, 8612, 9412, 9712, 9812, 10712, 10812, 11812, 11912, 12512, 12612, 13212, 13312, 13812, 13912, 14012, 14112, 14512, 14612, and/or 14912 as logic circuits to perform the operations corresponding to those machine readable instructions. In some such examples, the processor circuitry 3512, 3612, 3712, 3812, 3912, 4012, 4112, 4212, 4312, 4412, 6412, 6512, 6612, 7112, 7812, 8612, 9412, 9712, 9812, 10712, 10812, 11812, 11912, 12512, 12612, 13212, 13312, 13812, 13912, 14012, 14112, 14512, 14612, and/or 14912 is instantiated by the hardware circuits of the microprocessor 15000 in combination with the instructions. For example, the microprocessor 15000 may be implemented by multi-core hardware circuitry such as a CPU, a DSP, a GPU, an XPU, etc. Although it may include any number of example cores 15002 (e.g., 1 core), the microprocessor 15000 of this example is a multi-core semiconductor device including N cores. The cores 15002 of the microprocessor 15000 may operate independently or may cooperate to execute machine readable instructions. For example, machine code corresponding to a firmware program, an embedded software program, or a software program may be executed by one of the cores 15002 or may be executed by multiple ones of the cores 15002 at the same or different times. In some examples, the machine code corresponding to the firmware program, the embedded software program, or the software program is split into threads and executed in parallel by two or more of the cores 15002. The software program may correspond to a portion or all of the machine readable instructions and/or operations represented by the flowcharts of FIGS. 69, 70, 74-77, 80-85, 88-93, 96, 103-106, 114-117, 121-124, 129-131, 136, 137, 143, 144, 148.

The cores 15002 may communicate by a first example bus 15004. In some examples, the first bus 15004 may be implemented by a communication bus to effectuate communication associated with one(s) of the cores 15002. For example, the first bus 15004 may be implemented by at least one of an Inter-Integrated Circuit (I2C) bus, a Serial Peripheral Interface (SPI) bus, a PCI bus, or a PCIe bus. Additionally or alternatively, the first bus 15004 may be implemented by any other type of computing or electrical bus. The cores 15002 may obtain data, instructions, and/or signals from one or more external devices by example interface circuitry 15006. The cores 15002 may output data, instructions, and/or signals to the one or more external devices by the interface circuitry 15006. Although the cores 15002 of this example include example local memory 15020 (e.g., Level 1 (L1) cache that may be split into an L1 data cache and an L1 instruction cache), the microprocessor 15000 also includes example shared memory 15010 that may be shared by the cores (e.g., Level 2 (L2 cache)) for high-speed access to data and/or instructions. Data and/or instructions may be transferred (e.g., shared) by writing to and/or reading from the shared memory 15010. The local memory 15020 of each of the cores 15002 and the shared memory 15010 may be part of a hierarchy of storage devices including multiple levels of cache memory and the main memory (e.g., the main memory 3514, 3516 of FIG. 35, the main memory 3614, 3616 of FIG. 36, etc.). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 15002 may be referred to as a CPU, DSP, GPU, etc., or any other type of hardware circuitry. Each core 15002 includes control unit circuitry 15014, arithmetic and logic (AL) circuitry (sometimes referred to as an ALU) 15016, a plurality of registers 15018, the local memory 15020, and a second example bus 15022. Other structures may be present. For example, each core 15002 may include vector unit circuitry, single instruction multiple data (SIMD) unit circuitry, load/store unit (LSU) circuitry, branch/jump unit circuitry, floating-point unit (FPU) circuitry, etc. The control unit circuitry 15014 includes semiconductor-based circuits structured to control (e.g., coordinate) data movement within the corresponding core 15002. The AL circuitry 15016 includes semiconductor-based circuits structured to perform one or more mathematic and/or logic operations on the data within the corresponding core 15002. The AL circuitry 15016 of some examples performs integer based operations. In other examples, the AL circuitry 15016 also performs floating point operations. In yet other examples, the AL circuitry 15016 may include first AL circuitry that performs integer based operations and second AL circuitry that performs floating point operations. In some examples, the AL circuitry 15016 may be referred to as an Arithmetic Logic Unit (ALU). The registers 15018 are semiconductor-based structures to store data and/or instructions such as results of one or more of the operations performed by the AL circuitry 15016 of the corresponding core 15002. For example, the registers 15018 may include vector register(s), SIMD register(s), general purpose register(s), flag register(s), segment register(s), machine specific register(s), instruction pointer register(s), control register(s), debug register(s), memory management register(s), machine check register(s), etc. The registers 15018 may be arranged in a bank as shown in FIG. 150. Alternatively, the registers 15018 may be organized in any other arrangement, format, or structure including distributed throughout the core 15002 to shorten access time. The second bus 15022 may be implemented by at least one of an I2C bus, a SPI bus, a PCI bus, or a PCIe bus

Each core 15002 and/or, more generally, the microprocessor 15000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 15000 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

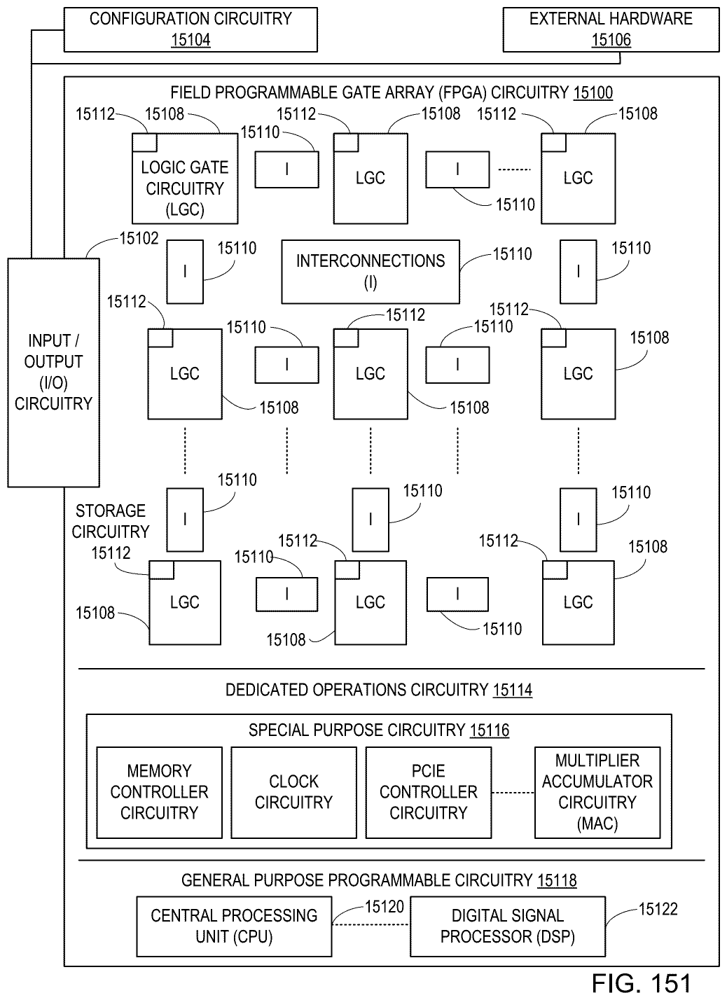

FIG. 151 is a block diagram of another example implementation of the processor circuitry 3512, 3612, 3712, 3812, 3912, 4012, 4112, 4212, 4312, 4412, 6412, 6512, 6612, 7112, 7812, 8612, 9412, 9712, 9812, 10712, 10812, 11812, 11912, 12512, 12612, 13212, 13312, 13812, 13912, 14012, 14112, 14512, 14612, and/or 14912 of FIGS. 35-44, 64-66, 71, 78, 86, 94, 97, 98, 107, 108, 118, 119, 125, 126, 132, 133, 138, 139, 140, 141, 145, 146, and/or 149. In this example, the processor circuitry 3512, 3612, 3712, 3812, 3912, 4012, 4112, 4212, 4312, 4412, 6412, 6512, 6612, 7112, 7812, 8612, 9412, 9712, 9812, 10712, 10812, 11812, 11912, 12512, 12612, 13212, 13312, 13812, 13912, 14012, 14112, 14512, 14612, and/or 14912 is/are implemented by FPGA circuitry 15100. For example, the FPGA circuitry 15100 may be implemented by an FPGA. The FPGA circuitry 15100 can be used, for example, to perform operations that could otherwise be performed by the example microprocessor 15000 of FIG. 150 executing corresponding machine readable instructions. However, once configured, the FPGA circuitry 15100 instantiates the machine readable instructions in hardware and, thus, can often execute the operations faster than they could be performed by a general purpose microprocessor executing the corresponding software.

More specifically, in contrast to the microprocessor 15000 of FIG. 150 described above (which is a general purpose device that may be programmed to execute some or all of the machine readable instructions represented by the flowcharts of FIGS. 69, 70, 74-77, 80-85, 88-93, 96, 103-106, 114-117, 121-124, 129-131, 136, 137, 143, 144, 148 but whose interconnections and logic circuitry are fixed once fabricated), the FPGA circuitry 15100 of the example of FIG. 151 includes interconnections and logic circuitry that may be configured and/or interconnected in different ways after fabrication to instantiate, for example, some or all of the machine readable instructions represented by the flowcharts of FIGS. 69, 70, 74-77, 80-85, 88-93, 96, 103-106, 114-117, 121-124, 129-131, 136, 137, 143, 144, 148. In particular, the FPGA circuitry 15100 may be thought of as an array of logic gates, interconnections, and switches. The switches can be programmed to change how the logic gates are interconnected by the interconnections, effectively forming one or more dedicated logic circuits (unless and until the FPGA circuitry 15100 is reprogrammed). The configured logic circuits enable the logic gates to cooperate in different ways to perform different operations on data received by input circuitry. Those operations may correspond to some or all of the software represented by the flowcharts of FIGS. 69, 70, 74-77, 80-85, 88-93, 96, 103-106, 114-117, 121-124, 129-131, 136, 137, 143, 144, 148. As such, the FPGA circuitry 15100 may be structured to effectively instantiate some or all of the machine readable instructions of the flowcharts of FIGS. 69, 70, 74-77, 80-85, 88-93, 96, 103-106, 114-117, 121-124, 129-131, 136, 137, 143, 144, 148 as dedicated logic circuits to perform the operations corresponding to those software instructions in a dedicated manner analogous to an ASIC. Therefore, the FPGA circuitry 15100 may perform the operations corresponding to the some or all of the machine readable instructions of FIGS. 69, 70, 74-77, 80-85, 88-93, 96, 103-106, 114-117, 121-124, 129-131, 136, 137, 143, 144, 148 faster than the general purpose microprocessor can execute the same.

In the example of FIG. 151, the FPGA circuitry 15100 is structured to be programmed (and/or reprogrammed one or more times) by an end user by a hardware description language (HDL) such as Verilog. The FPGA circuitry 15100 of FIG. 151, includes example input/output (I/O) circuitry 15102 to obtain and/or output data to/from example configuration circuitry 15104 and/or external hardware 15106. For example, the configuration circuitry 15104 may be implemented by interface circuitry that may obtain machine readable instructions to configure the FPGA circuitry 15100, or portion(s) thereof. In some such examples, the configuration circuitry 15104 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 15106 may be implemented by external hardware circuitry. For example, the external hardware 15106 may be implemented by the microprocessor 15000 of FIG. 150. The FPGA circuitry 15100 also includes an array of example logic gate circuitry 15108, a plurality of example configurable interconnections 15110, and example storage circuitry 15112. The logic gate circuitry 15108 and the configurable interconnections 15110 are configurable to instantiate one or more operations that may correspond to at least some of the machine readable instructions of FIGS. 69, 70, 74-77, 80-85, 88-93, 96, 103-106, 114-117, 121-124, 129-131, 136, 137, 143, 144, 148 and/or other desired operations. The logic gate circuitry 15108 shown in FIG. 151 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 15108 to enable configuration of the electrical structures and/or the logic gates to form circuits to perform desired operations. The logic gate circuitry 15108 may include other electrical structures such as look-up tables (LUTs), registers (e.g., flip-flops or latches), multiplexers, etc.

The configurable interconnections 15110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 15108 to program desired logic circuits.

The storage circuitry 15112 of the illustrated example is structured to store result(s) of the one or more of the operations performed by corresponding logic gates. The storage circuitry 15112 may be implemented by registers or the like. In the illustrated example, the storage circuitry 15112 is distributed amongst the logic gate circuitry 15108 to facilitate access and increase execution speed.

The example FPGA circuitry 15100 of FIG. 151 also includes example Dedicated Operations Circuitry 15114. In this example, the Dedicated Operations Circuitry 15114 includes special purpose circuitry 15116 that may be invoked to implement commonly used functions to avoid the need to program those functions in the field. Examples of such special purpose circuitry 15116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 15100 may also include example general purpose programmable circuitry 15118 such as an example CPU 15120 and/or an example DSP 15122. Other general purpose programmable circuitry 15118 may additionally or alternatively be present such as a GPU, an XPU, etc., that can be programmed to perform other operations.

Although FIGS. 150 and 151 illustrate two example implementations of the processor circuitry 3512, 3612, 3712, 3812, 3912, 4012, 4112, 4212, 4312, 4412, 6412, 6512, 6612, 7112, 7812, 8612, 9412, 9712, 9812, 10712, 10812, 11812, 11912, 12512, 12612, 13212, 13312, 13812, 13912, 14012, 14112, 14512, 14612, and/or 14912 of FIGS. 35-44, 64-66, 71, 78, 86, 94, 97, 98, 107, 108, 118, 119, 125, 126, 132, 133, 138, 139, 140, 141, 145, 146, and/or 149, many other approaches are contemplated. For example, as mentioned above, modern FPGA circuitry may include an on-board CPU, such as one or more of the example CPU 15120 of FIG. 151. Therefore, the processor circuitry 3512, 3612, 3712, 3812, 3912, 4012, 4112, 4212, 4312, 4412, 6412, 6512, 6612, 7112, 7812, 8612, 9412, 9712, 9812, 10712, 10812, 11812, 11912, 12512, 12612, 13212, 13312, 13812, 13912, 14012, 14112, 14512, 14612, and/or 14912 of FIGS. 35-44, 64-66, 71, 78, 86, 94, 97, 98, 107, 108, 118, 119, 125, 126, 132, 133, 138, 139, 140, 141, 145, 146, and/or 149 may additionally be implemented by combining the example microprocessor 15000 of FIG. 150 and the example FPGA circuitry 15100 of FIG. 151. In some such hybrid examples, a first portion of the machine readable instructions represented by the flowcharts of FIGS. 69, 70, 74-77, 80-85, 88-93, 96, 103-106, 114-117, 121-124, 129-131, 136, 137, 143, 144, 148 may be executed by one or more of the cores 15002 of FIG. 150, a second portion of the machine readable instructions represented by the flowcharts of FIGS. 69, 70, 74-77, 80-85, 88-93, 96, 103-106, 114-117, 121-124, 129-131, 136, 137, 143, 144, 148 may be executed by the FPGA circuitry 15100 of FIG. 151, and/or a third portion of the machine readable instructions represented by the flowcharts of FIGS. 69, 70, 74-77, 80-85, 88-93, 96, 103-106, 114-117, 121-124, 129-131, 136, 137, 143, 144, 148 may be executed by an ASIC. It should be understood that some or all of the processor circuitry 3512, 3612, 3712, 3812, 3912, 4012, 4112, 4212, 4312, 4412, 6412, 6512, 6612, 7112, 7812, 8612, 9412, 9712, 9812, 10712, 10812, 11812, 11912, 12512, 12612, 13212, 13312, 13812, 13912, 14012, 14112, 14512, 14612, and/or 14912 of FIGS. 35-44, 64-66, 71, 78, 86, 94, 97, 98, 107, 108, 118, 119, 125, 126, 132, 133, 138, 139, 140, 141, 145, 146, and/or 149 may, thus, be instantiated at the same or different times. Some or all of the circuitry may be instantiated, for example, in one or more threads executing concurrently and/or in series. Moreover, in some examples, some or all of the processor circuitry 3512, 3612, 3712, 3812, 3912, 4012, 4112, 4212, 4312, 4412, 6412, 6512, 6612, 7112, 7812, 8612, 9412, 9712, 9812, 10712, 10812, 11812, 11912, 12512, 12612, 13212, 13312, 13812, 13912, 14012, 14112, 14512, 14612, and/or 14912 of FIGS. 35-44, 64-66, 71, 78, 86, 94, 97, 98, 107, 108, 118, 119, 125, 126, 132, 133, 138, 139, 140, 141, 145, 146, and/or 149 may be implemented within one or more virtual machines and/or containers executing on the microprocessor.

In some examples, the processor circuitry 3512, 3612, 3712, 3812, 3912, 4012, 4112, 4212, 4312, 4412, 6412, 6512, 6612, 7112, 7812, 8612, 9412, 9712, 9812, 10712, 10812, 11812, 11912, 12512, 12612, 13212, 13312, 13812, 13912, 14012, 14112, 14512, 14612, and/or 14912 of FIGS. 35-44, 64-66, 71, 78, 86, 94, 97, 98, 107, 108, 118, 119, 125, 126, 132, 133, 138, 139, 140, 141, 145, 146, and/or 149 may be in one or more packages. For example, the microprocessor 15000 of FIG. 150 and/or the FPGA circuitry 15100 of FIG. 151 may be in one or more packages. In some examples, an XPU may be implemented by the processor circuitry 3512, 3612, 3712, 3812, 3912, 4012, 4112, 4212, 4312, 4412, 6412, 6512, 6612, 7112, 7812, 8612, 9412, 9712, 9812, 10712, 10812, 11812, 11912, 12512, 12612, 13212, 13312, 13812, 13912, 14012, 14112, 14512, 14612, and/or 14912 of FIGS. 35-44, 64-66, 71, 78, 86, 94, 97, 98, 107, 108, 118, 119, 125, 126, 132, 133, 138, 139, 140, 141, 145, 146, and/or 149, which may be in one or more packages. For example, the XPU may include a CPU in one package, a DSP in another package, a GPU in yet another package, and an FPGA in still yet another package.

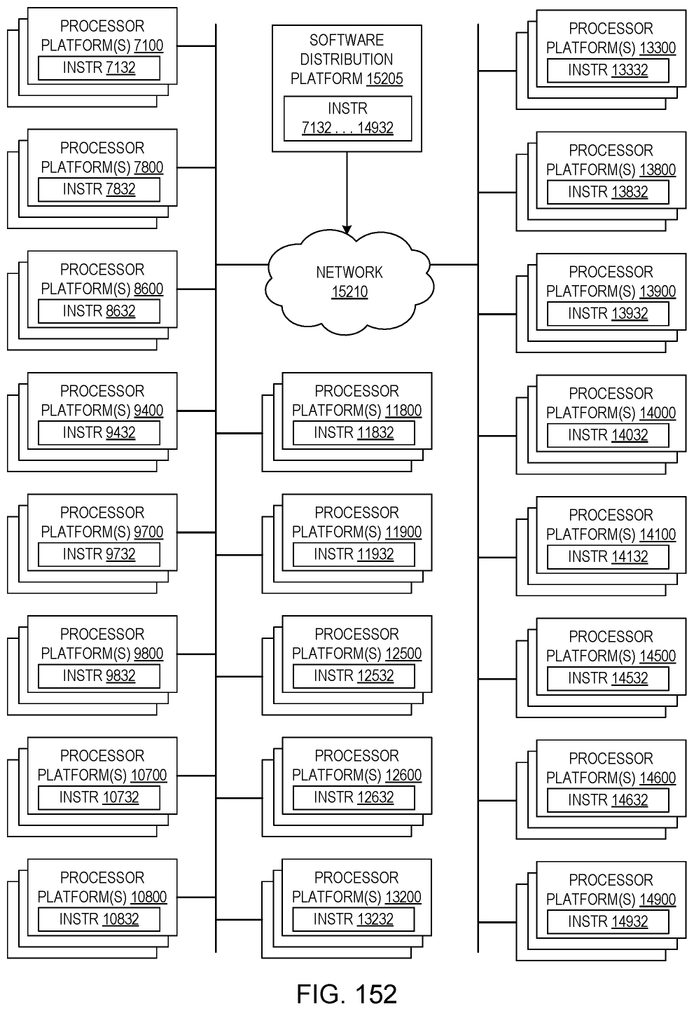

A block diagram illustrating an example software distribution platform 15205 to distribute software such as the example machine readable instructions 7132, 7832, 8632, 9432, 9732, 9832, 10732, 10832, 11832, 11932, 12532, 12632, 13232, 13332, 13832, 13932, 14032, 14132, 14532, 14632, 14932 of FIGS. 71, 78, 86, 94, 97, 98, 107, 108, 118, 119, 125, 126, 132, 133, 138, 139, 140, 141, 145, 146, and/or 149 to hardware devices owned and/or operated by third parties is illustrated in FIG. 152. The example software distribution platform 15205 may be implemented by any computer server, data facility, cloud service, etc., capable of storing and transmitting software to other computing devices. The third parties may be customers of the entity owning and/or operating the software distribution platform 15205. For example, the entity that owns and/or operates the software distribution platform 15205 may be a developer, a seller, and/or a licensor of software such as the example machine readable instructions 7132, 7832, 8632, 9432, 9732, 9832, 10732, 10832, 11832, 11932, 12532, 12632, 13232, 13332, 13832, 13932, 14032, 14132, 14532, 14632, 14932 of FIGS. 71, 78, 86, 94, 97, 98, 107, 108, 118, 119, 125, 126, 132, 133, 138, 139, 140, 141, 145, 146, and/or 149. The third parties may be consumers, users, retailers, OEMs, etc., who purchase and/or license the software for use and/or re-sale and/or sub-licensing. In the illustrated example, the software distribution platform 15205 includes one or more servers and one or more storage devices. The storage devices store the machine readable instructions 7132, 7832, 8632, 9432, 9732, 9832, 10732, 10832, 11832, 11932, 12532, 12632, 13232, 13332, 13832, 13932, 14032, 14132, 14532, 14632, 14932, which may correspond to the example machine readable instructions 6900, 7000, 7400, 7500, 7600, 7700, 8000, 8100, 8200, 8300, 8400, 8500, 8800, 8900, 9000, 9100, 9200, 9300, 9600, 10300, 10400, 10500, 10600, 11400, 11500, 11600, 11700, 12100, 12200, 12300, 12400, 12900, 13000, 13100, 13600, 13700, 14300, 14400, 14800 of FIGS. 69, 70, 74-77, 80-85, 88-93, 96, 103-106, 114-117, 121-124, 129-131, 136, 137, 143, 144, 148, as described above. The one or more servers of the example software distribution platform 15205 are in communication with an example network 15210, which may correspond to any one or more of the Internet and/or any of the example networks 7126, 7826, 8626, 9426, 9726, 9826, 10726, 10826, 11826, 11926, 12526, 12626, 12626, 13326, 13826, 13926, 14026, 14126, 14526, 14626, 14926 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 7132, 7832, 8632, 9432, 9732, 9832, 10732, 10832, 11832, 11932, 12532, 12632, 13232, 13332, 13832, 13932, 14032, 14132, 14532, 14632, 14932 from the software distribution platform 15205. For example, the software, which may correspond to the example machine readable instructions 6900, 7000, 7400, 7500, 7600, 7700, 8000, 8100, 8200, 8300, 8400, 8500, 8800, 8900, 9000, 9100, 9200, 9300, 9600, 10300, 10400, 10500, 10600, 11400, 11500, 11600, 11700, 12100, 12200, 12300, 12400, 12900, 13000, 13100, 13600, 13700, 14300, 14400, 14800 of FIGS. 69, 70, 74-77, 80-85, 88-93, 96, 103-106, 114-117, 121-124, 129-131, 136, 137, 143, 144, 148, may be downloaded to one(s) of the example processor platforms 7100, 7800, 8600, 9400, 9700, 9800, 10700, 10800, 11800, 11900, 12500, 12600, 10000, 13300, 13800, 13900, 14000, 14100, 14500, 14600, 14900, which is to execute the machine readable instructions 7132, 7832, 8632, 9432, 9732, 9832, 10732, 10832, 11832, 11932, 12532, 12632, 13232, 13332, 13832, 13932, 14032, 14132, 14532, 14632, 14932 to implement device(s) described herein. In some examples, one or more servers of the software distribution platform 15205 periodically offer, transmit, and/or force updates to the software (e.g., the example machine readable instructions 7132, 7832, 8632, 9432, 9732, 9832, 10732, 10832, 11832, 11932, 12532, 12632, 13232, 13332, 13832, 13932, 14032, 14132, 14532, 14632, 14932 of FIGS. 71, 78, 86, 94, 97, 98, 107, 108, 118, 119, 125, 126, 132, 133, 138, 139, 140, 141, 145, 146, and/or 149) to ensure improvements, patches, updates, etc., are distributed and applied to the software at the end user devices.

Example methods, apparatus, systems, and articles of manufacture to implement license management for software-defined silicon are disclosed herein. Further examples and combinations thereof include the following:

Example 1 includes a method comprising storing data associated with a first server in secure storage, the data including at least one of first features, a license, or a virtual machine (VM) state associated with the first server, the first features associated with a semiconductor device of the first server configurable to provide the first features, the license to activate the first features, the VM state associated with a VM hosted by the first server, the VM executing a workload, identifying a second server with second features configurable to ones of the first features, reconfiguring the second server based on the first features, and in response to migrating the VM from the first server to the second server, executing the workload on the VM of the second server based on the at least one of the first features, the license, or the VM state.

Example 2 includes the method of example 1, wherein the secure storage is a trusted execution environment of a third server.

Example 3 includes the method of example 1, further including generating a recommendation to improve execution of the workload, the recommendation including a change of one or more of the first features, and determining to migrate the VM based on the recommendation.

Example 4 includes the method of example 1, further including obtaining the license from the secure storage, and deploying the license on the second server to activate the first features on the second server.

Example 5 includes the method of example 1, further including obtaining the VM state from the secure storage, the VM state including at least one of a hardware counter, a software counter, or a progress of execution of the workload, and deploying the VM state on the second server to resume execution of the workload.

Example 6 includes the method of example 1, wherein the data is first data, and the method further including reconfiguring the first server based on a change of the first features, storing second data associated with the second server in the secure storage, the second data including the license or the VM state associated with the second server, and migrating the VM from the second server to the first server.

Example 7 includes the method of example 6, further including obtaining the license from the secure storage, obtaining the VM state from the secure storage, the VM state including at least one of a hardware counter, a software counter, or a progress of execution of the workload, deploying the license on the first server to activate the change of the first features on the first server, and deploying the VM state on the first server to resume execution of the workload.

Example 8 includes a method comprising classifying, with a first machine learning (ML) model, a workload executed by a semiconductor device with first features based on telemetry data, the semiconductor device including configurable circuitry, determining a difference based on a current progress of the workload and a predicted progress of the workload, determining, with the first ML model or a second ML model, a recommendation for the configurable circuitry to change one or more of the first features to one or more second features, the recommendation based on the difference satisfying a threshold, and executing the workload with the semiconductor device based on the one or more second features.

Example 9 includes the method of example 8, further including obtaining the telemetry data from at least one of the semiconductor device, a server including the semiconductor device, or a platform including the server.

Example 10 includes the method of example 8, further including obtaining telemetry data from the semiconductor device, the telemetry data including at least one of a characteristic of the workload or a sequence of workloads including the workload, the sequence of workloads to indicate one or more dependencies amongst the workloads.

Example 11 includes the method of example 8, further including obtaining the telemetry data from the semiconductor device, the telemetry data including at least one of a utilization of a resource of the semiconductor device or a utilization threshold specified by a service level agreement.

Example 12 includes the method of example 8, wherein the semiconductor device is executing the workload with a first resource, and further including determining that the current progress is less than the predicted progress based on the difference, generating the recommendation to include activating a second resource to execute the workload, the one or more second features to activate the second resource, and executing the workload with at least one of the first resource or the second resource.

Example 13 includes the method of example 8, wherein the semiconductor device is executing the workload with a first resource and a second resource, and further including determining that the current progress is greater than the predicted progress based on the difference, generating the recommendation to include deactivating the second resource, the one or more second features to deactivate the second resource, and executing the workload with the first resource.

Example 14 includes the method of example 13, further including crediting a platform counter based on the deactivating of the second resource, the platform counter associated with a service level agreement.

Example 15 includes the method of example 8, further including extracting hardware reliability data associated with a first hardware resource of the semiconductor device from the telemetry data, determining whether a utilization threshold associated with the first hardware resource is satisfied, activating, with the configurable circuitry, a second hardware resource of the semiconductor device, and deactivating, with the configurable circuitry, the first hardware resource.

Example 16 includes the method of example 15, further including pausing execution of the workload on the first hardware resource, and resuming execution of the workload on the second hardware resource.

Example 17 includes the method of example 8, wherein the one or more first features and the one or more second features are associated with hardware circuitry or a virtual resource, the virtual resource including a virtual machine or a container.

Example 18 includes the method of example 8, wherein the semiconductor device is a first semiconductor device, and further including identifying a second semiconductor device based on the first semiconductor device not configurable for the one or more second features, the second semiconductor device configured or configurable for the one or more second features, ceasing execution of the workload by the first semiconductor device, and executing the workload on the second semiconductor device using the one or more second features.

Example 19 includes a method comprising determining, by executing a machine learning model on a semiconductor device including configurable circuitry, a recommendation for the configurable circuitry to change a first feature of the semiconductor device to a second feature based on telemetry data, the telemetry data associated with a workload executed by the semiconductor device using the first feature, changing the first feature to a second feature based on a computational cost budget allocated to the semiconductor device being greater than a computational cost to change the first feature to the second feature, and executing the workload with the semiconductor device using the second feature.

Example 20 includes the method of example 19, further including obtaining the telemetry data from at least one of hardware circuitry, firmware, or a Basic Input/Output System (BIOS) of the semiconductor device, the hardware circuitry including the configurable circuitry, and determining that at least one of a performance of the semiconductor device or a type of the workload has changed at a second time with respect to a first time prior to the second time based on the telemetry data.

Example 21 includes the method of example 19, wherein the recommendation is determined based on a determination that a change in performance of the semiconductor device satisfies a threshold.

Example 22 includes the method of example 19, wherein the recommendation is a first recommendation, the telemetry data is first telemetry data, and further including consuming the computational cost to cause the configurable circuitry to change the first feature to the second feature by deactivating the first feature and activating the second feature, obtaining second telemetry data associated with the workload executed by the semiconductor device with the second feature, and determining, by executing the machine learning model on the semiconductor device, a second recommendation for the configurable circuitry to change the second feature of the semiconductor device to a third feature based on the second telemetry data.

Example 23 includes the method of example 22, further including determining that a performance of the semiconductor device based on the third feature satisfies a threshold.

Example 24 includes the method of example 19, further including identifying a resource of the semiconductor device to upgrade based on an output from the machine learning model, identifying the computational cost to perform the upgrade, and acquiring a cryptographic token representative of the computational cost from a datastore.

Example 25 includes the method of example 19, further including pausing execution of the workload, performing an upgrade of the semiconductor device from the first feature to the second feature, and resuming execution of the workload after the upgrade.

Example 26 includes the method of example 19, further including consuming a first quantity of computational cost corresponding to a completed portion of the workload using the first feature, and generating a second quantity of computational cost corresponding to a time period in which a third feature of the semiconductor device is disabled.

Example 27 includes the method of example 19, further including determining that a feature token has been requested by the semiconductor device, receiving the feature token from a feature token issuer, and storing the feature token in a trusted execution environment of the semiconductor device.

Example 28 includes the method of example 19, further including consuming a feature token to activate the second feature corresponding to the feature token, and removing the feature token from the semiconductor device.

Example 29 includes the method of example 28, wherein the feature token is a non-fungible token recorded in a blockchain.

Example 30 includes a method comprising installing an agent at a semiconductor device, the semiconductor device including configurable circuitry, executing the agent to at least one of provision a license to the semiconductor device or execute a service associated with the semiconductor device, the license to enable activation or deactivation of a feature of the semiconductor device via the configurable circuitry, and after the at least one of the provisioning of the license or execution of the service, uninstalling the agent from the semiconductor device.

Example 31 includes the method of example 30, further including installing an executable file including the agent in a trusted execution environment.

Example 32 includes the method of example 30, further including collecting telemetry data associated with the semiconductor device, and executing the service to transmit a portion of the telemetry data to a server.

Example 33 includes the method of example 32, further including determining whether a time period specified by a service level agreement (SLA) has elapsed, invoking an executable file in a trusted execution environment (TEE) to install the agent external to the TEE based on determining that the time period has elapsed, and after executing the service, uninstalling the agent external to the TEE.

Example 34 includes the method of example 33, further including, after uninstalling the agent external to TEE, invoking the executable file in the TEE to install the agent external to the TEE based on determining that that the time period has elapsed.

Example 35 includes the method of example 30, further including, after uninstalling the agent, obtaining the agent from a server to execute another instance of the service.

Example 36 includes the method of example 30, further including activating the feature after the provisioning of the license, and executing a workload with the semiconductor device utilizing the feature.

Example 37 includes the method of example 30, further including, in response to determining that the at least one of the provisioning of the license or execution of the service is not successful, generating a data log at the semiconductor device to record an error of the provisioning of the license or execution of the service.

Example 38 includes a method to manage semiconductor device failures, the method comprising collecting telemetry data from a plurality of semiconductor devices, processing the telemetry data to at least one of detect a failure associated with a first one of the semiconductor devices or predict the failure associated with the first one of the semiconductor devices, the first one of the semiconductor devices having a first set of one or more features, the first set of one or more features activated based on a corresponding first set of one or more licenses, and identifying a second one of the semiconductor devices to replace the first one of the semiconductor devices, the second one of the semiconductor devices having a second set of one or more features to replace the first set of one or more features, the second set of one or more features to be activated based on a corresponding second set of one or more licenses.

Example 39 includes the method of example 38, wherein the processing of the telemetry data is based on a machine learning algorithm.

Example 40 includes the method of example 39, further including, in response to detecting a failure of a first one of the semiconductor devices accessing historical telemetry data collected from the first one of the semiconductor devices, and updating the machine learning algorithm based on the historical telemetry data.

Example 41 includes the method of example 38, wherein the processing of the telemetry data is performed by a compute device different from the plurality of semiconductor devices.

Example 42 includes the method of example 38, further including deactivating the first set of one or more features on the first one of the semiconductor devices, and activating the second set of one or more features on the second one of the semiconductor devices.

Example 43 includes the method of example 38, further including processing, at a third one of the semiconductor devices, telemetry data collected at the third one of the of the semiconductor devices to at least one of detect a failure associated with a first subcomponent of the third one of the semiconductor devices or predict the failure associated with the subcomponent of the third one of the semiconductor devices, the first subcomponent to implement a third set of one or more features, the third set of one or more features activated based on a corresponding third set of one or more licenses, and identify a second subcomponent of the third one of the semiconductor devices to implement the third set of one or more features.

Example 44 includes the method of example 43, further including using the third set of one or more licenses to cause the second subcomponent to activate the third set of one or more features.

Example 45 includes a method to transfer feature licenses among semiconductor devices, the method comprising detecting a license transfer event associated with a first one of the semiconductor devices, creating a second feature license based on a configuration of a first feature license associated with the first one of the semiconductor devices, sending first information to the first one of the semiconductor devices to cause the first one of the semiconductor devices to invalidate the first feature license and deactivate a first feature associated with the first feature license, and sending second information to a second one of the semiconductor devices to cause the second one of the semiconductor devices to install the second feature license and activate a second feature associated with the second feature license.

Example 46 includes the method of example 45, wherein the first information is sent to the first one of the semiconductor devices in response to a first polling message from the first one of the semiconductor devices, and the second information is sent to the second one of the semiconductor devices in response to a second polling message from the second one of the semiconductor devices.

Example 47 includes the method of example 45, wherein the first information is pushed to the first one of the semiconductor devices, and the second information is pushed to the second one of the semiconductor devices.

Example 48 includes the method of example 45, wherein the license transfer event corresponds to a detected failure condition associated with the first one of the semiconductor devices.

Example 49 includes the method of example 48, wherein the detected failure detection is indicated in a received message.

Example 50 includes the method of example 49, wherein the received message includes instructions to transfer the first feature license from the first one of the semiconductor devices to the second one of the semiconductor devices.

Example 51 includes a method to transfer feature licenses among semiconductor devices, the method comprising storing an unlocked feature license from a first one of the semiconductor devices, the unlocked feature license previously assigned to the first one of the semiconductor devices, reassigning the unlocked feature license to a second one of the semiconductor devices, and providing the re-assigned feature license to the second one of the semiconductor devices to cause the assigned feature license to be installed on the second one of the semiconductor devices.

Example 52 includes the method of example 51, wherein the unlocked feature license is associated with a transfer key, and reassigning the unlocked feature license to the second one of the semiconductor devices includes embedding an identifier of the second one of the semiconductor devices in the unlocked feature license, and signing the unlocked feature license and the identifier with the transfer key.

Example 53 includes the method of example 52, wherein the unlocked feature license and the transfer key are signed by a second key associated with the first one of the semiconductor devices.

Example 54 includes the method of example 52, further including discarding the transfer key after the re-assigned feature license is provided to the second one of the semiconductor devices.

Example 55 includes the method of example 51, wherein the identifier is a protected processor inventory number of the second one of the semiconductor devices.

Example 56 includes the method of example 51, wherein a number of reassignments of the unlocked feature license is restricted.

Example 57 includes the method of example 56, wherein the number of reassignments of the unlocked feature license is restricted be once.

Example 58 includes a method to transfer feature licenses among semiconductor devices, the method comprising establishing a secure channel between a first one of the semiconductor devices and a second of the semiconductor devices, invalidating, at the first one of the semiconductor devices, a first feature license on the first one of the semiconductor devices, copying a configuration of the first feature license to a second one of the semiconductor devices via the secure channel, and creating, at the second one of the semiconductor devices, a second feature license based on the copied configuration.

Example 59 includes the method of example 58, further including deactivating a first feature on the first one of the semiconductor devices, the first feature corresponding to the first feature license.

Example 60 includes the method of example 58, further including activating a second feature on the second one of the semiconductor devices, the second feature corresponding to the second feature license.

Example 61 includes the method of example 58, further including tearing down the secure channel after the copying of the configuration of the first feature license to the second one of the semiconductor devices.

Example 62 includes a method to manage a license pool associated with a plurality of semiconductor devices, the method comprising receiving the license pool at a first one of the semiconductor devices, the license pool including a device identifier, the license pool including licenses that permit activation of features of the plurality of semiconductor devices, installing the license pool on the first one of the semiconductor devices in response to a determination that the device identifier corresponds to the first one of the semiconductor devices, and halting processing of the license pool in response to a determination that the device identifier does not correspond to the first one of the semiconductor devices.

Example 63 includes the method of example 62, wherein the device identifier is a protected processor identification number.

Example 64 includes the method of example 62, further including discarding the license pool in response to the determination that the device identifier does not correspond to the first one of the semiconductor devices.

Example 65 includes the method of example 62, wherein the license pool is a first license pool, and further including, after the installing of the first license pool on the first one of the semiconductor devices receiving, at the first one of the semiconductor devices, a request to acquire one or more licenses of the first license pool for a second one of the semiconductor devices, determine whether the one or more licenses of the first license pool are available, and in response to a determination that the one or more licenses of the first license pool are available, (i) removing the one or more licenses from the license pool, (ii) creating a second license pool including the one or more licenses, and (iii) outputting the second license pool.

Example 66 includes the method of example 65, wherein the device identifier is a first device identifier, the request includes a second device identifier corresponding to the second one of the semiconductor devices, and further including determining a signature based on the second device identifier and a key associated with the first one of the semiconductor devices, wherein the second license pool includes the one or more license, the second device identifier and the signature.

Example 67 includes the method of example 65, further including halting processing of the request in response to a determination that the one or more licenses of the first license pool are not available.

Example 68 includes the method of example 65, wherein the one or more licenses correspond to a subset of the licenses included in the first license pool.

Example 69 includes the method of example 65, wherein the one or more licenses correspond to all of the licenses included in the first license pool.

Example 70 includes the method of example 62, further including, after the installing of the license pool on the first one of the semiconductor devices receiving, at the first one of the semiconductor devices, a request to activate a first feature of the first one of the semiconductor devices, determining whether the a first license corresponding to the first feature is available in the license pool on the first one of the semiconductor devices, and in response to a determination that the first license is available in the license pool, (i) locking the first license in the license pool, and (ii) activating the first feature of the first one of the semiconductor devices.

Example 71 includes the method of example 70, further including halting processing of the request in response to a determination that the first license is not available in the license pool.

Example 72 includes the method of example 70, further including, after activating the first feature on the first one of the semiconductor devices receiving, at the first one of the semiconductor devices, a request to deactivate the first feature, releasing the first license to cause the first license to be available in the license pool, and deactivating the first feature of the first one of the semiconductor device.

Example 73 includes a method to license generation community for a system including one or more semiconductor devices, the method comprising identifying a plurality of compute nodes to form a licensing community in the system, selecting one of the compute nodes to be a delegated authority agent for the licensing community, and combining a plurality of license fragments to form a license associated with at least one feature to be activated on a first one of the one or more semiconductor devices, respective ones of the license fragments obtained from corresponding ones of the compute nodes.

Example 74 includes the method of example 73, further including provisioning the license to the first one of the one or more semiconductor devices.

Example 75 includes the method of example 73, wherein ones of the compute nodes include respective trusted circuitry associated with a manufacturer of the one or more semiconductor devices.

Example 76 includes the method of example 73, wherein the selecting of the one of the compute nodes to be the delegated authority agent for the licensing community includes participating in a collective voting procedure among the plurality of compute nodes to select the one of the compute nodes to be the delegated authority agent for the licensing community.

Example 77 includes the method of example 73, further including accessing a request to generate the license, the request from at least one of (i) the first one of the one or more semiconductor devices, or (ii) an agent of the first one of the one or more semiconductor devices, wherein the combining of the plurality of license fragments to form the license is responsive to the request.

Example 78 includes the method of example 77, further including obtaining credentials for the first one of the one or more semiconductor devices, and validating the credentials to determine whether the request is valid, wherein the combining of the plurality of license fragments to form the license is also responsive to the request being valid.

Example 79 includes the method of example 77, wherein the credentials are to indicate whether the first one of the one or more semiconductor devices is a trusted silicon product.

Example 80 includes the method of example 77, further including obtaining capability information for the first one of the one or more semiconductor devices, and comparing the capability information with the at least one feature associated to determine whether the request is valid.

Example 81 includes the method of example 73, wherein the selected one of the compute nodes is to relinquish being the delegated authority agent for the licensing community after expiration of a time period.

Example 82 includes the method of example 73, further including determining whether a quorum of compute nodes is present in the licensing community.

Example 83 includes a method to process a feature license installed in a semiconductor device, the method comprising obtaining real-time clock data from real-time clock circuitry, tracking calendar time in the semiconductor device based on the real-time clock data, and comparing the calendar time with a license expiry time of the feature license to determine whether the feature license has expired.

Example 84 includes the method of example 83, wherein the real-time clock circuitry is synchronized with a time service accessible from one or more time servers.

Example 85 includes the method of example 83, wherein the license expiry time is specified in the feature license.

Example 86 includes the method of example 83, further including determining the feature license is expired in response to the calendar time having at least reached the license expiry time.

Example 87 includes the method of example 86, further including deactivating a feature of the semiconductor device in response to determining the feature license is expired, the feature associated with the feature license.

Example 88 includes the method of example 83, wherein the tracking of the calendar time includes initializing a counter based on the real-time clock data from real-time clock circuitry, and utilizing the counter to track the calendar time in the semiconductor device.

Example 89 includes the method of example 83, wherein the real-time clock circuitry is separate from the semiconductor device, and the real-time clock data is obtained from the real-time clock circuitry via a secure communication path.

Example 90 includes a method to process a feature license installed in a semiconductor device, the method comprising storing a first value of a counter in memory in response to a first trigger event, determining an elapsed time associated with the feature license based on the first value of the counter and a second value of the counter, the second value of the counter obtained in response to a second trigger event, and comparing the elapsed time with a license expiry time of the feature license to determine whether the feature license has expired.

Example 91 includes the method of example 90, wherein the first trigger event corresponds to installation of the feature license in the semiconductor device.

Example 92 includes the method of example 90, wherein the first trigger event corresponds to activation of a feature of the semiconductor device, the feature associated with the feature license.

Example 93 includes the method of example 90, wherein the counter begins to increment when the semiconductor device is powered on.

Example 94 includes the method of example 90, wherein the license expiry time is specified in the feature license.

Example 95 includes the method of example 90, further including determining the feature license is expired in response to the elapsed time having at least reached the license expiry time.

Example 96 includes the method of example 95, further including deactivating a feature of the semiconductor device in response to determining the feature license is expired, the feature associated with the feature license.

Example 97 includes a method comprising retrieving from an off-platform node, a provisional license, the provisional license retrieved in response to a request for the provisional license, generating, at a first on-platform node, a first completion request to complete the provisional license, the first completion request to be transmitted to an off-platform license verifying circuitry, the first completion request including an identifier of a second on-platform node, the request for completion prompted by second processing circuitry of the second on-platform node on which the provisional license is installed, and the provisional license, when installed, to enable a hardware feature available on the second on-platform node on a temporary basis, and supplying a completion token, received from the off-platform license verifying circuitry, to the second processing circuitry, the second processing circuitry to use the completion token to convert the provisional license to a complete license that is bound to the second on-platform node.

Example 98 includes the method of example 97, including verifying authenticity of the provisional license at the second on-platform node, when the authenticity is verified, installing, at the second on-platform node, the provisional license to enable the hardware feature, and generating a second completion request, at the second on-platform node, to complete the provisional license, the second completion request to be transmitted to the first on-platform node and to include an identifier of the second on-platform node.

Example 99 includes the method of example 98, including when the authenticity is verified, determining, with the second processing circuitry of the second on-platform node, one or more limitations in the provisional license that are to limit usage of the hardware features corresponding to the provisional license, and limiting the usage of the hardware features based on the limitations, the one or more limitations to allow usage of the hardware features on the temporary basis.

Example 100 includes the method of example 98, including determining, with the second processing circuitry of the second on-platform node, based on a license expiration monitor, whether the limitations are met or exceeded, and provided that the completion token is received before the limitations are met or exceeded, using the completion token to convert the provisional license to a complete license, the completion token to cause the complete license to be bound to the second on-platform node.

Example 101 includes the method of example 98, wherein the limitations are based on at least one of a duration of time, a number of power cycles, or an amount of load to be processed.

Example 102 includes the method of example 101, wherein the limitations are associated with a policy engine.

Example 103 includes the method of example 98, including after installing the provisional license, reboot, with the second processing circuitry, the second on-platform node, the reboot to cause the hardware features to be enabled.

Example 104 includes the method of example 97, wherein the off-platform license verifying circuitry is associated with a manufacturer of the platform, and the off-platform license verifying circuitry generates the completion token based on a master license issuing key.

Example 105 includes the method of example 98, wherein the request for the provisional license includes the identifier of the second-on platform node, and the provisional license, when retrieved from the off-platform node, is provisionally bound to the second on-platform node based on the identifier.

Example 106 includes the method of example 98, wherein the provisional license, when retrieved from the off-platform node, is not bound to any node.

Example 107 includes a method comprising registering a plurality of hardware nodes with a blockchain, a manufacturer of the hardware nodes and one or more customers of the manufacturer being registered members of the blockchain, the hardware nodes being semiconductor devices having hardware features that can be enabled via a hardware license, generating a plurality of floating hardware licenses, the floating hardware licenses, when installed in one or more of the hardware nodes, to temporarily enable hardware features associated with the one or more of the hardware nodes, the floating licenses not targeted for installation on any specific hardware node at the time of generation, and registering the floating hardware licenses with the blockchain, the floating hardware licenses to be distributed to one or more of the customers upon request, and respective ones of the floating licenses to become permanent and bound to respective ones of the hardware nodes upon completion of the respective licenses via an exchange between the hardware nodes and the blockchain.

Example 108 includes the method of example 107, including minting a non-fungible token on each of the plurality of hardware nodes, the registering of the plurality of hardware nodes with the blockchain to include supplying information regarding the non-fungible tokens minted onto the hardware nodes.

Example 109 includes the method of example 107, wherein the registering of the hardware nodes with the blockchain includes assigning each of the hardware nodes a unique identifier.

Example 110 includes the method of example 107, including tracking license generation and node binding information generated by the blockchain, and taking one or more actions to be compensated by the one or more of the customers based on the license generation and node binding information.

Example 111 includes the method of example 110, wherein the one or more actions including accepting an amount of crypto-currency when the tracking license generation and node binding information indicates that a license has been installed.

Example 112 includes the method of example 110, wherein the one or more actions including generating an invoice to bill the one or more of the customers.

Example 113 includes the method of example 107, wherein the generating of the plurality of floating licenses occurs at any of i) a time of manufacture of the one or more hardware nodes, ii) a time at which the plurality of floating licenses are requested by the one or more customers, iii) at a time when a set of criteria described in a smart contract are satisfied, v) a time during kick-off a license generation event at an off-blockchain generator, vi) a time of deployment of the hardware nodes in a platform assembled by at least one of the one or more customers.

Example 114 includes a method comprising recording hardware node registration information on a distributed ledger, the hardware node registration information supplied by a manufacturer of hardware nodes, the hardware nodes being semiconductor devices having hardware features that can be enabled via a hardware license, the hardware node registration information to include a unique identifier of a hardware node associated with the hardware node registration information, recording a floating hardware license on the distributed ledger, the floating license not targeted for installation on any specific hardware node at the time of generation, and the floating license generated by the manufacturer, supplying the floating license to a hardware platform on which the hardware node is installed in response to a request for the floating license, the request for the floating license generated at the hardware platform, verifying the authenticity of the floating license and the hardware node in response to a request for verification of the floating license generated at the platform, the request for verification to include the unique identifier of the hardware node on which the floating license is installed, and based on the verifying, converting the floating license to a permanent license by binding the license to the hardware node using the unique identifier of the hardware node.

Example 115 includes the method of example 114, wherein the converting of the floating hardware license to a permanent license includes generating a license binding confirmation, the license binding confirmation to be used by the hardware node to remove restrictions on using a set of features subject to the permanent license.

Example 116 includes the method of example 114, wherein the hardware node registration information identifies a non-fungible token minted on the hardware node, and the verifying of the authenticity of the hardware node is based on the non-fungible token.

Example 117 includes the method of example 114, wherein the recording of the hardware node registration information on the distributed ledger includes assigning each of the hardware nodes a unique identifier.

Example 118 includes the method of example 114, including generating license transaction information about the binding of the floating license to the hardware node, and supplying the license transaction information to the manufacturer.

Example 119 includes the method of example 114, wherein the verifying of the authenticity of the hardware node includes determining whether the hardware node was previously registered with the distributed ledger by the manufacturer, and determining that an owner of the platform is authorized to make the request via the platform.

Example 120 includes a method comprising evaluating, with processing circuitry of a hardware node, whether to activate a hardware feature of a hardware node, when the evaluation indicates the hardware feature is to be activated, obtaining a license corresponding to the hardware feature, the license at least one of (i) stored in a protected enclave of the hardware node at a time of manufacture of the hardware node or (ii) generated by the hardware node, and activating the feature based on the license.

Example 121 includes the method of example 120, wherein the hardware node includes a license generator to generate the license and the license generator has been given authority to generate the licenses by a silicon manufacturer.

Example 122 includes the method of example 120, further including determining, based on the license, a limitation to be placed on the hardware feature to be activated, and limiting the usage of the hardware feature based on the limitation.

Example 123 includes the method of example 122, wherein the limitation includes at least one of (i) a duration of time, (ii) a number of operations executed by the hardware node, (iii) an amount of load being processed by the hardware node, or (iv) a number of processing cycles executed by the hardware node.

Example 124 includes the method of example 122, further including determining whether the limitation has been satisfied, and when the limitation has been satisfied, deactivating the hardware feature.

Example 125 includes the method of example 122, further including determining whether the license has been validated by an off-platform device, when the license is determined to have not been validated, deactivating the hardware feature, and when the license is determined to have been validated, stop limiting the usage of the hardware feature.

Example 126 includes the method of example 125, wherein the off-platform device is a delegated authority agent, and the platform device is designated by the silicon manufacture as having the authority to validate the license.

Example 127 includes the method of example 120, wherein the hardware node includes software defined silicon to implement the hardware feature, the hardware feature being deactivated at the time of manufacture and upon delivery to a customer.

Example 128 includes the method of example 120, wherein the hardware node is offline during the activating of the hardware feature, the method further including opening a communication link with an off-platform device, and requesting, from the off-platform device, validation of the license.

Example 129 includes the method of example 120, wherein the evaluating whether to activate the features is based on a communication from an off-platform device.

Example 130 includes a method comprising retrieving from an off-platform node, a provisional license, the provisional license retrieved in response to a first request, the first request for the provisional license, the provisional license bound to a virtual platform and the provisional license to provisionally enable a hardware feature of a semiconductor device, supplying the provisional license to one or more on-platform nodes depending on terms of the provisional license, the provisional license to be installed on the one or more on-platform nodes, generating a second request, the second request to allow the one or more on-platform nodes to assume an identity of the virtual platform, the request to be supplied to a virtual platform registration service, and supplying an identity certificate to the one or more on-platform nodes, the identity certificate received from the virtual platform registration service in response to the second request, and the identity certificate to be used by the one or more on-platform nodes to convert the provisional license to a non-provisional license.

Example 131 includes the method of example 130, including restricting usage of the provisional license in compliance with a metric identified in the provisional license, the restricting usage to be performed by the one or more on-platform nodes, and disabling the hardware feature when a level of the metric is satisfied, before the identity certificate has been received by the one or more on-platform nodes.

Example 132 includes the method of example 131, wherein the metric is based on at least one of a duration of time, a number of power cycles, or an amount of load to be processed, by the one or more on-platform nodes.

Example 133 includes the method of example 130, wherein the identity certificate is issued by the virtual platform registration service in compliance with pre-established identity certification policies.

Example 134 includes the method of example 133, wherein the pre-established identity certification policies include at least one of ensuring that the one or more platform nodes are not assigned to any other virtual platform, ensuring the second request is generated by an approved license requestor, or ensuring the components of the platform are authentic and in good standing with the manufacturer of the components.

Example 135 is an apparatus comprising configurable circuitry to least one of execute or instantiate machine readable instructions to perform the method of any of examples 1-134.

Example 136 is an apparatus comprising at least one memory, machine readable instructions, and processor circuitry to at least one of execute or instantiate the machine readable instructions to perform the method of any of examples 1-134.

Example 137 is an apparatus comprising means to perform the method of any of

examples 1-134.

Example 136 is at least one machine readable storage comprising machine

readable instructions to perform the method of any of examples 1-134.

Example 139 is a system to perform the method of any of examples 1-134. Example 140 is an apparatus comprising processor circuitry to perform the method of any of examples 1-134.

Example 141 is edge server processor circuitry to perform the method of any of examples 1-134.

Example 142 is edge cloud processor circuitry to perform the method of any of examples 1-134.

Example 143 is edge node processor circuitry to perform the method of any of examples 1-134.

Example 144 is edge gateway processor circuitry to perform the method of any of examples 1-134.

Example 145 is edge switch processor circuitry to perform the method of any of examples 1-134.

Example 146 is an XPU to perform the method of any of examples 1-134.

Example 147 is an Infrastructure Processing Unit to perform the method of any of examples 1-134.

Example 148 is an apparatus comprising network interface circuitry to perform the method of any of examples 1-134.

Example 149 is an apparatus comprising one or more edge gateways to perform the method of any of examples 1-134.

Example 150 is an apparatus comprising one or more edge switches to perform the method of any of examples 1-134.

Example 151 is an apparatus comprising at least one of one or more edge gateways or one or more edge switches to perform the method of any of examples 1-134.

Example 152 is an apparatus comprising acceleration circuitry to perform the method of any of examples 1-134.

Example 153 is an apparatus comprising one or more graphics processor units to perform the method of any of examples 1-134.

Example 154 is an apparatus comprising one or more vision processor units to perform the method of any of examples 1-134.

Example 155 is an apparatus comprising one or more Artificial Intelligence processors to perform the method of any of examples 1-134.

Example 156 is an apparatus comprising one or more machine learning processors to perform the method of any of examples 1-134.

Example 157 is an apparatus comprising one or more neural network processors to perform the method of any of examples 1-134.

Example 158 is an apparatus comprising one or more digital signal processors to perform the method of any of examples 1-134.

Example 159 is an apparatus comprising one or more general purpose processors to perform the method of any of examples 1-134.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. A method comprising:
storing data associated with a first server in secure storage, the data including at least one of first features, a license, or a virtual machine (VM) state associated with the first server, the first features associated with a semiconductor device of the first server configurable to provide the first features, the license to activate the first features, the VM state associated with a VM hosted by the first server, the VM executing a workload;
identifying a second server with second features configurable to ones of the first features;
reconfiguring the second server based on the first features; and
in response to migrating the VM from the first server to the second server, executing the workload on the VM of the second server based on the at least one of the first features, the license, or the VM state.

2. The method of claim 1, wherein the secure storage is a trusted execution environment of a third server.

3. The method of claim 1, further including:
generating a recommendation to improve execution of the workload, the recommendation including a change of one or more of the first features; and
determining to migrate the VM based on the recommendation.

4. The method of claim 1, further including:
obtaining the license from the secure storage; and
deploying the license on the second server to activate the first features on the second server.

5. The method of claim 1, further including:
obtaining the VM state from the secure storage, the VM state including at least one of a hardware counter, a software counter, or a progress of execution of the workload; and
deploying the VM state on the second server to resume execution of the workload.

6. The method of claim 1, wherein the data is first data, and the method further including:
reconfiguring the first server based on a change of the first features;
storing second data associated with the second server in the secure storage, the second data including the license or the VM state associated with the second server; and
migrating the VM from the second server to the first server.

7. The method of claim 6, further including:
obtaining the license from the secure storage;
obtaining the VM state from the secure storage, the VM state including at least one of a hardware counter, a software counter, or a progress of execution of the workload;
deploying the license on the first server to activate the change of the first features on the first server; and
deploying the VM state on the first server to resume execution of the workload.

8-164. (canceled)

165. An apparatus comprising:
memory;
machine readable instructions, and
processor circuitry to utilize the machine readable instructions to:
store data associated with a first server in secure storage, the data including at least one of first features, a license, or a virtual machine (VM) state associated with the first server, the first features associated with a semiconductor device of the first server configurable to provide the first features, the license to activate the first features, the VM state associated with a VM hosted by the first server, the VM executing a workload;
identify a second server with second features configurable to ones of the first features;
reconfigure the second server based on the first features; and
in response to migrating the VM from the first server to the second server, execute the workload on the VM of the second server based on the at least one of the first features, the license, or the VM state.

166. The apparatus of claim 165, wherein the secure storage is a trusted execution environment of a third server.

167. The apparatus of claim 165, wherein the processor circuitry is to:
generate a recommendation to improve execution of the workload, the recommendation including a change of one or more of the first features; and
determine to migrate the VM based on the recommendation.

168. The apparatus of claim 165, wherein the processor circuitry is to:
obtain the license from the secure storage; and
deploy the license on the second server to activate the first features on the second server.

169. The apparatus of claim 165, wherein the processor circuitry is to:
obtain the VM state from the secure storage, the VM state including at least one of a hardware counter, a software counter, or a progress of execution of the workload; and
deploy the VM state on the second server to resume execution of the workload.

170. The apparatus of claim 165, wherein the data is first data, and the processor circuitry is to:
reconfigure the first server based on a change of the first features;
store second data associated with the second server in the secure storage, the second data including the license or the VM state associated with the second server; and
migrate the VM from the second server to the first server.

171. The apparatus of claim 170, wherein the processor circuitry is to:
obtain the license from the secure storage;
obtain the VM state from the secure storage, the VM state including at least one of a hardware counter, a software counter, or a progress of execution of the workload;
deploy the license on the first server to activate the change of the first features on the first server; and
deploy the VM state on the first server to resume execution of the workload.

172. At least one machine-readable storage medium comprising machine-readable instructions to cause processor circuitry to at least:
store data associated with a first server in secure storage, the data including at least one of first features, a license, or a virtual machine (VM) state associated with the first server, the first features associated with a semiconductor device of the first server configurable to provide the first features, the license to activate the first features, the VM state associated with a VM hosted by the first server, the VM executing a workload;
identify a second server with second features configurable to ones of the first features;
reconfigure the second server based on the first features; and
in response to migrating the VM from the first server to the second server, execute the workload on the VM of the second server based on the at least one of the first features, the license, or the VM state.

173. The at least one machine-readable storage medium of claim 172, wherein the instructions are to cause the processor circuitry to:
generate a recommendation to improve execution of the workload, the recommendation including a change of one or more of the first features; and
determine to migrate the VM based on the recommendation.

174. The at least one machine-readable storage medium of claim 172, wherein the instructions are to cause the processor circuitry to:
obtain the license from the secure storage; and
deploy the license on the second server to activate the first features on the second server.

175. The at least one machine-readable storage medium of claim 172, wherein the instructions are to cause the processor circuitry to:
obtain the VM state from the secure storage, the VM state including at least one of a hardware counter, a software counter, or a progress of execution of the workload; and
deploy the VM state on the second server to resume execution of the workload.

176. The at least one machine-readable storage medium of claim 172, wherein the data is first data, and the instructions are to cause the processor circuitry to:
reconfigure the first server based on a change of the first features;
store second data associated with the second server in the secure storage, the second data including the license or the VM state associated with the second server; and
migrate the VM from the second server to the first server.

177. The at least one machine-readable storage medium of claim 176, wherein the instructions are to cause the processor circuitry to:
obtain the license from the secure storage;
obtain the VM state from the secure storage, the VM state including at least one of a hardware counter, a software counter, or a progress of execution of the workload;
deploy the license on the first server to activate the change of the first features on the first server; and
deploy the VM state on the first server to resume execution of the workload.
